(19) United States
(12) Patent Application Publication
(10) Pub. No.: US 2009/0172035 A1
(43) Pub. Date: Jul. 2, 2009

(54) SYSTEM AND METHOD FOR CAPTURING AND STORING CASINO INFORMATION IN A RELATIONAL DATABASE SYSTEM

(76) Inventors: Pieter Lessing, Los Angeles, CA (US); David Hubbard, Greensboro, GA (US); Mark Crosby, Venice, CA (US)

Correspondence Address: JAMES M. STOVER;TERADATA CORPORATION, 2835 MIAMI VILLAGE DRIVE, MIAMISBURG, OH, 45342, US

(21) Appl. No.: 12/339,983

(22) Filed: Dec. 19, 2008

Related U.S. Application Data
(60) Provisional application No. 61/018,154, filed on Dec. 31, 2007.

(51) Int. Cl. G06F 17/30

(52) U.S. Cl. 707/104.1; 707/E17.045

(57) ABSTRACT

A database management system for a hospitality or gaming business. The database management system comprises a database for storing information concerning customers of the hospitality or gaming business, customer activities, and products and services provided by the hospitality or gaming business. Data is stored and organized within the database in accordance with a logical data model comprising a plurality of entities and relationships organized within subject areas defining the manner in which information concerning casino customers, casino comps or rewards, and gaming sessions engaged in by the casino customers is stored and organized within the database.

### CROSS REFERENCE TO RELATED APPLICATIONS

This application claims priority under 35 U.S.C. §119(e) to the following co-pending and commonly-assigned patent application, which is incorporated herein by reference:

Provisional Patent Application Ser. No. 61/018,154, entitled “SYSTEM AND METHOD FOR CAPTURING AND STORING CASINO INFORMATION IN A RELATIONAL DATABASE SYSTEM”; filed on Dec. 31, 2007 by Pieter Lessing, David W. Hubbard, and Mark L. Crosby.

This application is related to the following co-pending and commonly-assigned patent applications, which are incorporated by reference herein:

application Ser. No. 10/027,967, entitled “SYSTEM AND METHOD FOR CAPTURING AND STORING BUSINESS INFORMATION FOR THE TRAVEL AND TRANSPORTION INDUSTRIES”; filed on Dec. 21, 2001 by Pieter Lessing, William Black, John Kumar, David Hubbard, and Kim Nguyen-Hargett;

application Ser. No. 10/888,765, entitled “SYSTEM AND METHOD FOR CAPTURING, STORING AND ANALYZING REVENUE MANAGEMENT INFORMATION FOR THE TRAVEL AND TRANSPORTATION INDUSTRIES”; filed on Jul. 9, 2004 by Pieter Lessing, David W. Hubbard and Sreedhar Srikant; and

application Ser. No. 11/016,002; entitled “SYSTEM AND METHOD FOR CAPTURING, STORING AND ANALYZING TRANSACTION AND INTERACTION INFORMATION FOR THE HOSPITALITY AND GAMING INDUSTRIES”; filed on Dec. 17, 2004 by Sreedhar Srikant, Norman C. Nicholl, Gregory P. Churak, and Pieter Lessing.

### FIELD OF THE INVENTION

The present invention relates generally to Data Warehouse solutions, and more particularly, to systems and methods for capturing, storing and using detailed transaction and interaction information for the casino and gaming industries. Still more particularly, the present invention is related to a data model to logically model the key business information needs of casinos and gaming venues from an enterprise perspective.

### BACKGROUND OF THE INVENTION

The Enterprise Data Warehouse (EDW) has proved a strategic weapon for most modern organizations. It should be active, dynamic and flexible in order to cope with changing business requirements. It should provide a strategic background to support changing consumer-provider relationships.

The foundation of the enterprise data warehouse is a comprehensive and responsive logical data model addressing challenges in the near future without compromising existing business processes. A logical data model is a graphical representation of the way data is organized in a data warehouse environment. The logical data model specifically defines which individual data elements can be stored and how they relate to one another to provide a model of the business information. The data model ultimately defines which business questions can be answered from the data warehouse and thus determines the business value of the entire decision support system.

A properly designed LDM provides a foundation for more effective sales, marketing and customer management and supports the customer relationship management (CRM) requirements related to identifying, acquiring, retaining and growing valuable customers. A logical data model for the casino and gaming industries reflects the operating principles and policies of these industries and provides the underlying structure for the data imported into the data warehouse, providing. The enterprise data warehouse, organized in accordance with this logical data model, provides support to an enterprise's critical business decision-making needs, and real-time analysis of customers and casino activity.

### BRIEF DESCRIPTION OF THE DRAWINGS

The present invention is illustrated by way of example, and not by limitation, in the Figures of the accompanying drawings, wherein elements having the same reference numeral designations represent like elements throughout and wherein:

FIG. 1 provides an overview of the hardware components of a data warehouse system;

FIG. 2 illustrates the core, industry, revenue management, and casino segments supported by a travel and hospitality logical data model, in accordance with the preferred embodiment of the present invention;

FIGS. 3A through 3R, taken together, provide a conceptual data model view of a travel and hospitality logical data model (LDM) illustrating the most important entities in the LDM and how they generally relate to each other, in accordance with the preferred embodiment of the present invention;

FIG. 4 illustrates an entity-relationship diagram of the ACCOUNT (DEFINITION) Subject Area of the logical data model in accordance with the preferred embodiment of the present invention;

FIG. 5 illustrates an entity-relationship diagram of the ACCOUNT (LOYALTY) Subject Area of the logical data model in accordance with the preferred embodiment of the present invention;

FIG. 6 illustrates an entity-relationship diagram of the ADDRESS Subject Area of the logical data model in accordance with the preferred embodiment of the present invention;

FIG. 7 illustrates an entity-relationship diagram of the ADDRESS (GEOGRAPHY) Subject Area of the logical data model in accordance with the preferred embodiment of the present invention;

FIG. 8 illustrates an entity-relationship diagram of the ASSOCIATE LABOR Subject Area of the logical data model in accordance with the preferred embodiment of the present invention;

FIG. 9 illustrates an entity-relationship diagram of the CASINO (OVERVIEW) Subject Area of the logical data model in accordance with the preferred embodiment of the present invention;

FIG. 10 illustrates an entity-relationship diagram of the CASINO COMPS Subject Area of the logical data model in accordance with the preferred embodiment of the present invention;

FIG. 11 illustrates an entity-relationship diagram of the CASINO GAME SESSIONS Subject Area of the logical data model in accordance with the preferred embodiment of the present invention;

FIG. 12 illustrates an entity-relationship diagram of the DEMOGRAPHICS Subject Area of the logical data model in accordance with the preferred embodiment of the present invention;

FIG. 13 illustrates an entity-relationship diagram of the EQUIPMENT Subject Area of the logical data model in accordance with the preferred embodiment of the present invention;

FIG. 14 illustrates an entity-relationship diagram of the HOSPITALITY GROUP EVENT Subject Area of the logical data model in accordance with the preferred embodiment of the present invention;

FIG. 15 illustrates an entity-relationship diagram of the LOCATION (OVERVIEW) Subject Area of the logical data model in accordance with the preferred embodiment of the present invention;

FIG. 16 illustrates an entity-relationship diagram of the PARTY Subject Area of the logical data model in accordance with the preferred embodiment of the present invention;

FIG. 17 illustrates an entity-relationship diagram of the PRIVACY Subject Area of the logical data model in accordance with the preferred embodiment of the present invention;

FIG. 18 illustrates an entity-relationship diagram of the PROMOTION Subject Area of the logical data model in accordance with the preferred embodiment of the present invention;

FIG. 19 illustrates an entity-relationship diagram of the QUALITY FEEDBACK Subject Area of the logical data model in accordance with the preferred embodiment of the present invention;

FIG. 20 illustrates an entity-relationship diagram of the TIME PERIOD Subject Area of the logical data model in accordance with the preferred embodiment of the present invention; and

FIG. 21 illustrates an entity-relationship diagram of the WEB VISIT Subject Area of the logical data model in accordance with the preferred embodiment of the present invention.

### BEST MODE FOR CARRYING OUT THE INVENTION

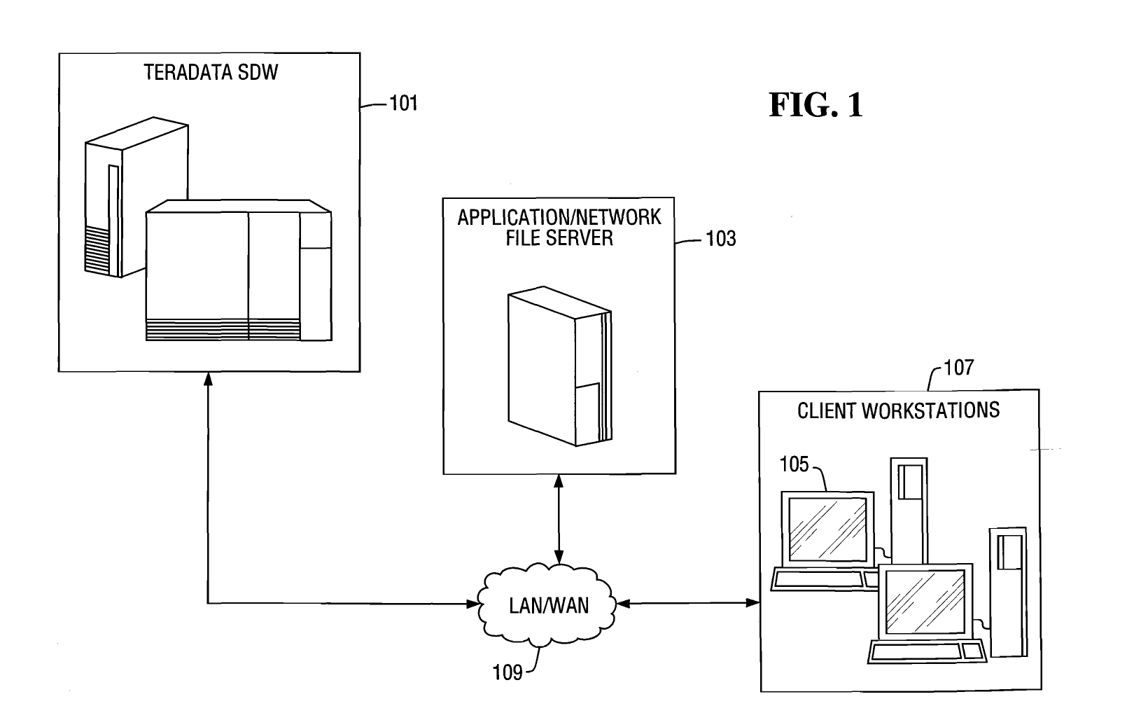

FIG. 1 provides an overview of the hardware required for a data warehouse solution solution. The basic components consist of a Teradata Corporation Scalable Data Warehouse 101, an administrative server 103 supporting analytic and operations applications, and client and administrative workstations 105 and 107, respectively. The components communicate with each other through a Local Area Network (LAN) or Wide Area Network (WAN), identified by reference numeral 109.

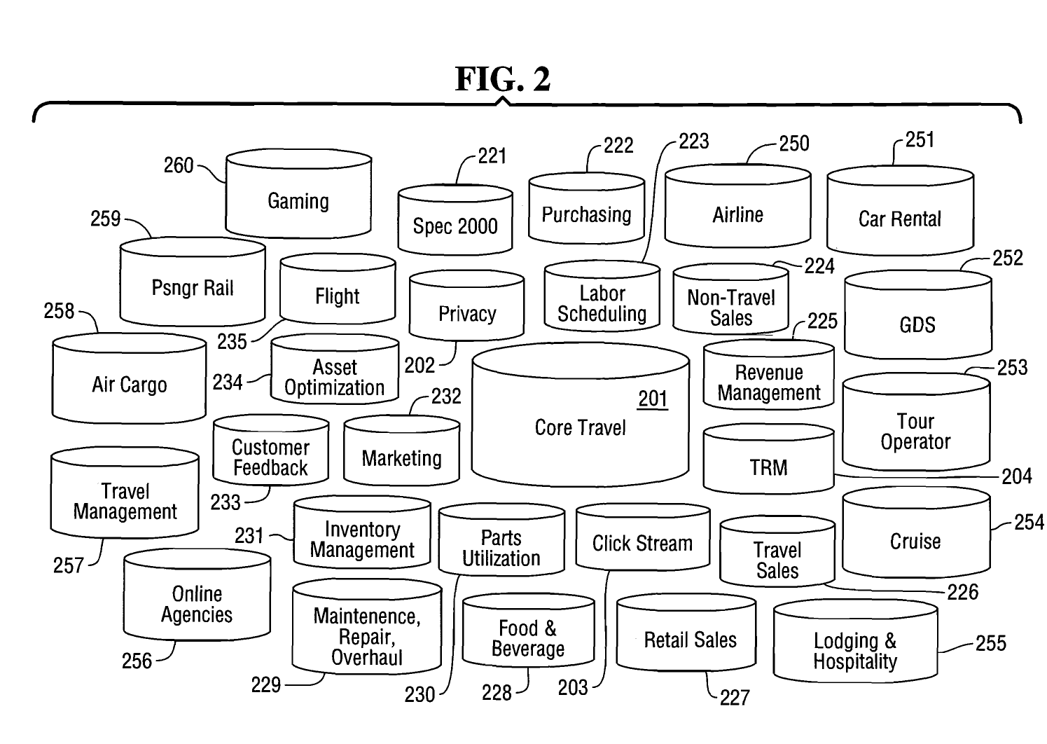

A travel and hospitality industry customer-centric warehouse is established on the Teradata Scalable Data Warehouse 101 as defined by the logical data model (LDM) described below. The logical data model is a consumer-centric data model supporting Revenue Management, Financial Management, Customer Relationship Management, Privacy and Click Stream analysis. It can serve as the base for a full enterprise data warehouse implemented at the client's site. The model has been designed in a modular fashion so non-relevant components can be removed without impacting the consistency of the model. It's an integrated, subject-oriented base of strategic business information that serves as a single source of decision support, providing the travel and provider with the ability to make simple reports or sophisticated information analysis. FIG. 2 shows the travel and hospitality core, industry, and revenue management segments supported by the LDM. Core segments include Core Travel 201, Privacy 202, Click Stream 203 and TRM 204. Travel and Hospitality segments include Spec 2000 221; Purchasing 222; Labor Scheduling 223; Non-Travel Sales 224; Revenue Management 225; Travel Sales 226; Retail Sales 227; Food & Beverage 228; Maintenance, Repair, Overhaul 229; Parts Utilization 230; Inventory Management 231; Marketing 232; Customer Feedback 233; Asset Optimization 234; and Flight 235. Industry segments include Airline 250, Car rental 251, GDS 252, Tour Operator 253, Cruise 254, Lodging & Hospitality 255, Online Agencies 256, Travel Management 257, Air Cargo 258, Passenger Rail 259, and Gaming 260.

### Logical Data Model Design Basics

As stated earlier, a properly designed logical data model provides a foundation for more effective sales, marketing, and operations management and supports the customer relationship management requirements related to identifying, acquiring, retaining and growing valuable customers.

A logical data model (LDM) is an abstract construct that is physically realized in the database or data warehouse. The data model provides an architecture for the information that will be included in a data warehouse. The database provides the physical realization of that architecture in a form that can be efficiently maintained and used. There may well be some differences between the logical data model and the final database design. The database may include some tables (summary tables, etc.) or columns that have no direct correlation in the logical data model. Elements in the logical model may be grouped differently in the physical database.

A logical data model is organized by Subject Areas, each comprised of numerous Entities, Attributes and Relationships. The data model hierarchy includes one or more Subject Areas. Each Subject Area includes one or more Entities or Tables, each having Attributes and Relationships. Each Attribute describes a fact about an Entity. Relationships between two or more Entities are further defined by Cardinality. The Relationships define which entities are connected to other entities and the cardinality of the relationships. Each of these elements will be described in greater detail below.

### Subject Area

A subject area is a subset of objects taken from the universe of data objects for a particular line of business or industry that focus on a particular Business Process. Typically, a subject area is created to help manage large data architectures that may encompass multiple business processes or business subjects. This is the highest-level data concept within a conceptual entity/relationship (E/R) model. Working with subject areas is especially useful when designing and maintaining a large or complex data model. Dividing the enterprise into several distinct subject areas allows different groups within an organization to concentrate on the processes and functions pertinent to their business area.

### Entity

An Entity represents a person, place, thing, concept, or event (e.g. PARTY, ACCOUNT, PRODUCT, etc.). It represents something for which the business has the means and the desire to collect and store data. An Entity must have distinguishable occurrences, e.g., one must be able to uniquely identify each occurrence of an entity with a primary key (e.g. Party Identifier, Account Identifier, Invoice Number, etc.). An Entity is typically named with a unique singular noun or noun phrase (e.g., PARTY, TRANSPORTED PASSENGER, etc.) that describes one occurrence of the Entity and cannot be used for any other Entity. It should be exclusive of every other Entity in the database. An Entity cannot appear more than once in the conceptual entity/relationship (E/R) model. Each Entity may have relationships to other Entities residing in its own Subject Area or in other Subject Areas.

### Attribute

An Attribute is a data fact about an Entity or Relationship. It is a logical (not physical) construct. It is data in its atomic form. In other words, it is the lowest level of information that still has business meaning without further decomposition. An example would be FIRST NAME, or LAST NAME. An example of an invalid attribute would be PERSON NAME if it includes both the first and last names, as this could be further decomposed into the separate, definable (first name, last name) data facts.

### Relationship

A Relationship is an association that links occurrences of one or more Entities. A Relationship must connect at least one Entity. If only one Entity is connected, the Relationship is said to be Recursive. A Relationship is described by a noun or passive verb or verb phase that describes the action taken in the Relationship. A Relationship represent a static state of being between the occurrences of the Entities it connects. Relationships are not intended to represent processes or data flows. They cannot be linked to another Relationships. They may optionally represent future, present, and/or past relatedness. The time frame must be explicitly defined in the data definition. Relationships may contain attributes. In a normalized model, a Relationship containing Attributes will result in the creation of an Entity.

### Cardinality

In order for a data model to be considered accurate, it must contain both the maximum and minimum number of Entity occurrences expected. This is controlled by rules of cardinality, which describes a relationship between two Entities based on how many occurrences of one Entity type may exist relative to the occurrence of the other Entity. Typically, it is a ratio, commonly depicted as a one-to-one (1:1); one-to-many (1:N); and many-to-many (M:N) relationship.

The maximum cardinality may be an infinite number or a fixed number but never zero. The minimum cardinality may be zero, or some other positive number, but it must be less than or equal to the maximum cardinality for the same relationship.

The logical data model for the E-Business will now be described in more detail. The logical data model uses IDEF1X modeling conventions, as shown in Table 1.

TABLE 1
Entity Conventions

| Convention | Definition |
|---|---|
| 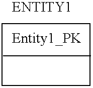 | Independent entity. An entity is depicted as a box, with its name above the box in singular, uppercase form. Square-boxed entities are independent. They rely on no other entity for their identification. Primary keys are attributes that uniquely identify the entity. Primary keys are shown at the top of the box, separated from other listed attributes by a horizontal line. |
| 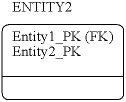 | Dependent entity. Round-cornered entities are dependent on one or more entities for their identification. (FK) following the primary key attribute indicates a foreign key-an attribute in the entity that is the primary key in another, closely related entity. |
| 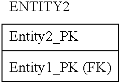 | An independent entity may also include a foreign key as a “non-primary key foreign key”. A non-primary key foreign key is shown below the horizontal line separating primary key attributes from other entity attributes. |

Relationship and cardinality conventions are shown in Table 2.

TABLE 2
Relationship/Cardinality Conventions

| Convention | Definition |
|---|---|
| 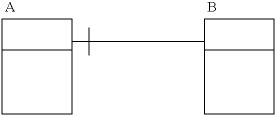 | A single line at the end of a relationship link means that a single record entity B is related to only one record in entity A.. |
| 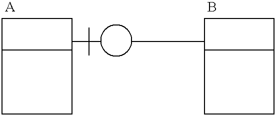 | A circle indicates that the presence of a linked record in entity A is optional. |
| 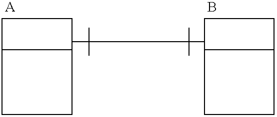 | One-to-one relationship. |
| 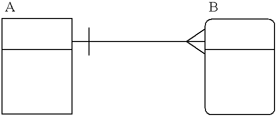 | One-to-many relationship. The crow's foot symbol means that more than one instance of an entity is associated with another entity. |
| 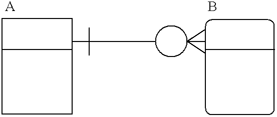 | One-to-zero-one-or-more relationship. A circle with a crow's feet symbol means there may be zero, one, or many instances of the entity associated with the other entity. |
| 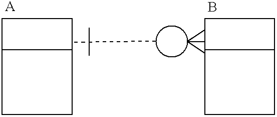 | A dotted relationship line indicates that the identity of entity B is not linked to entity A. |

### Travel and Hospitality Logical Data Model

The Travel and Hospitality Data Model (LDM) is a large data model composed of a large number of tables. To effectively view and understand the data model, the data tables have been logically organized into smaller groups called subject areas. Each subject area is comprised of a set of tables that contain information relevant to a particular entity. In addition, the subject areas address particular business questions.

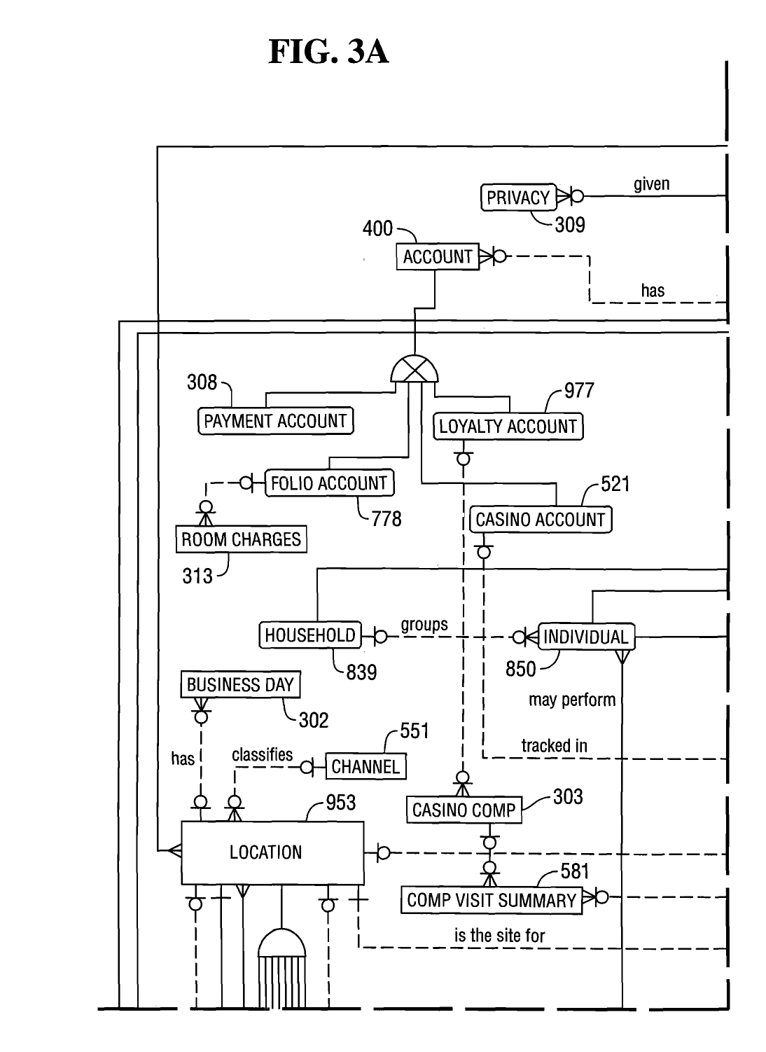

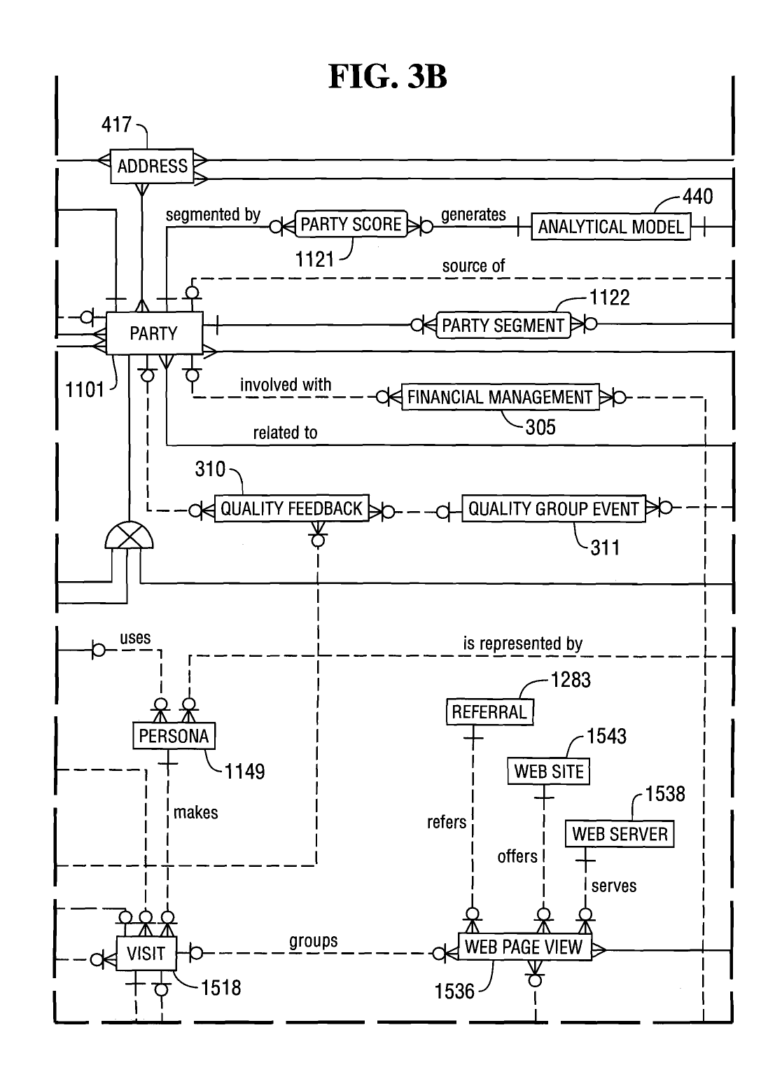

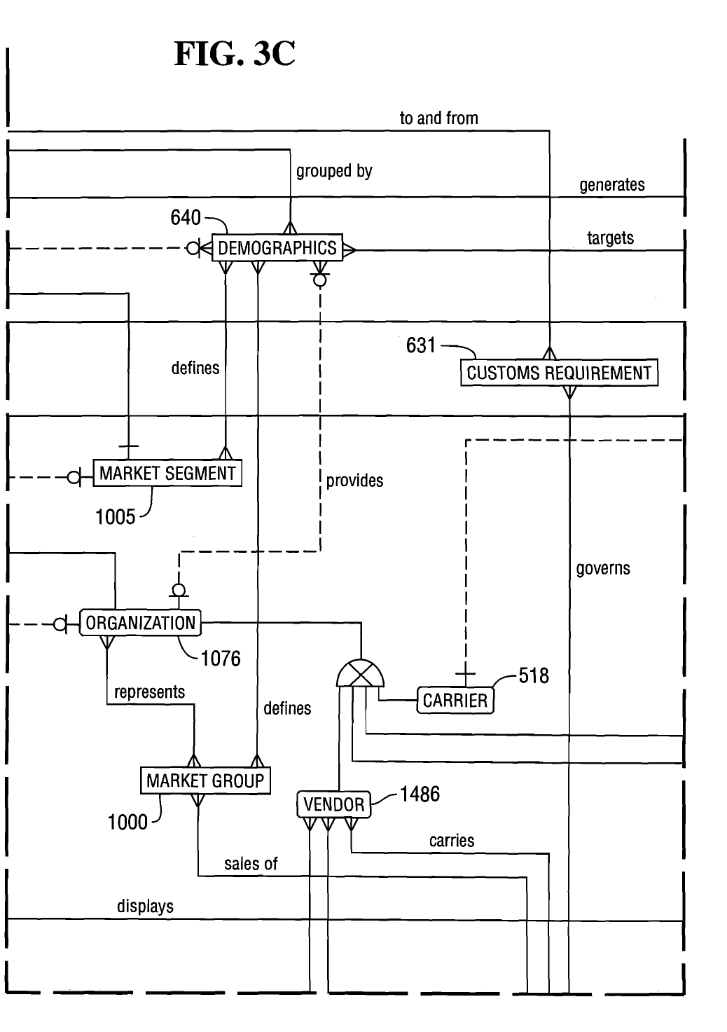

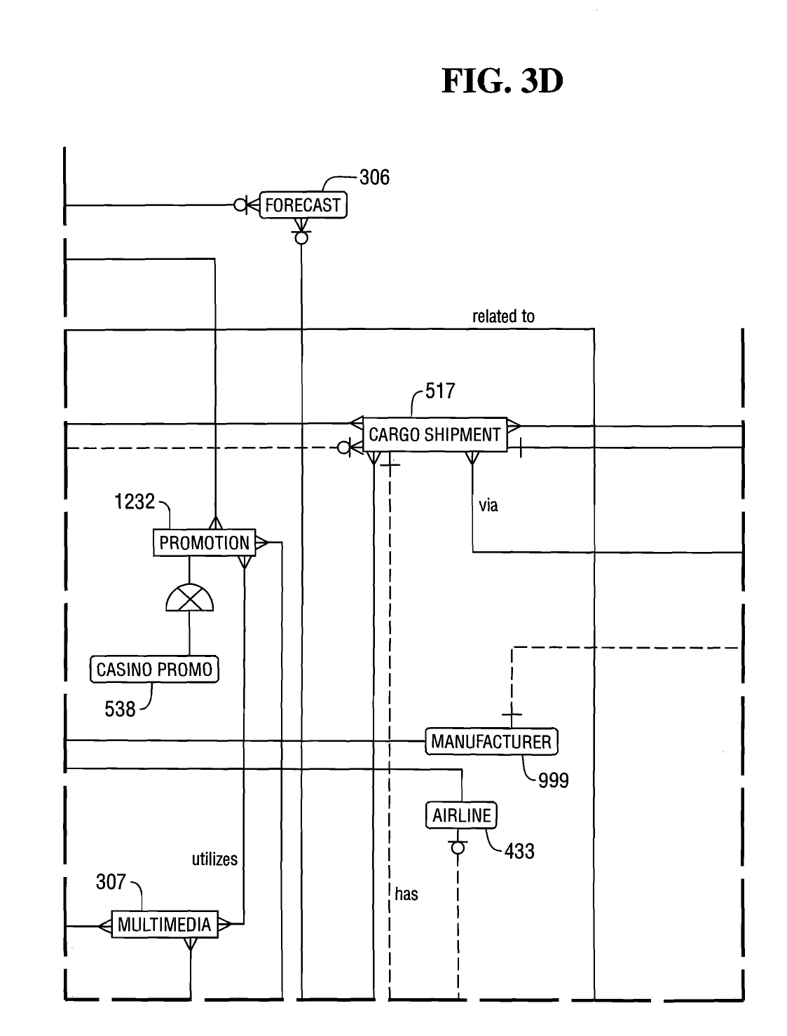

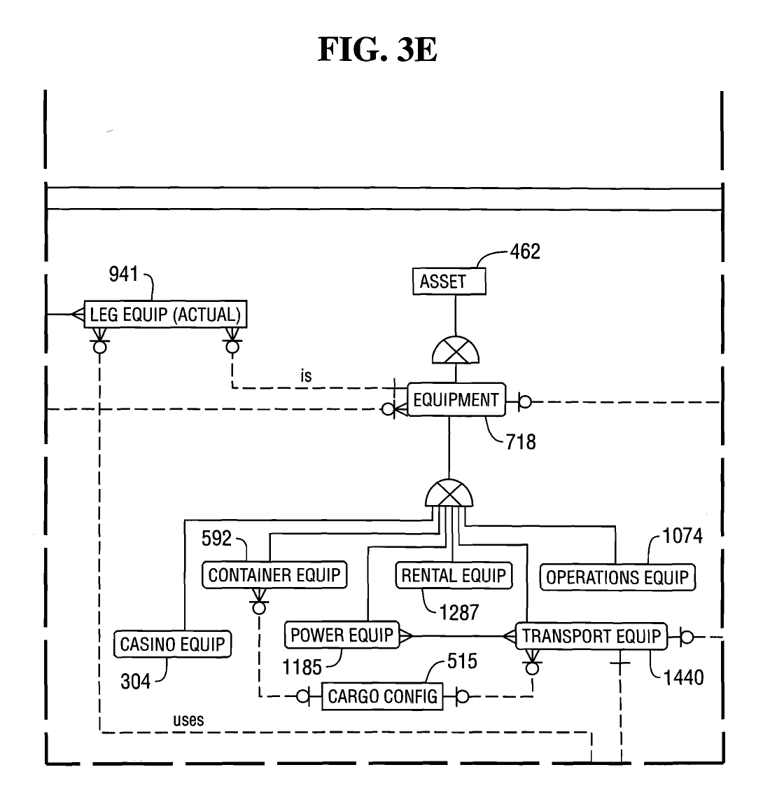

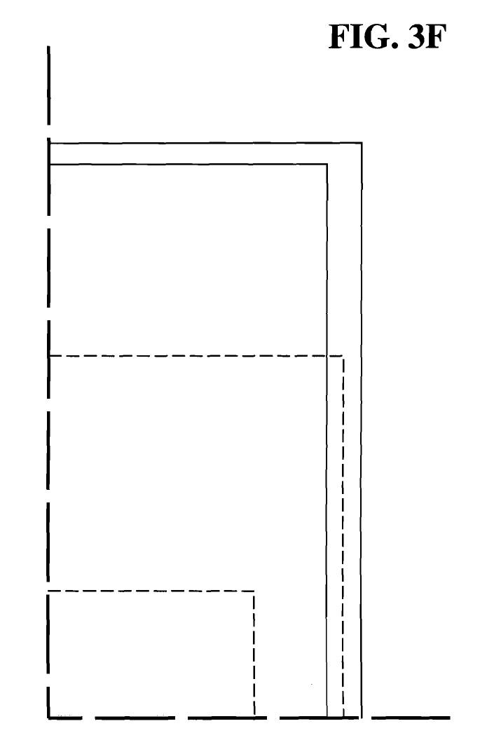

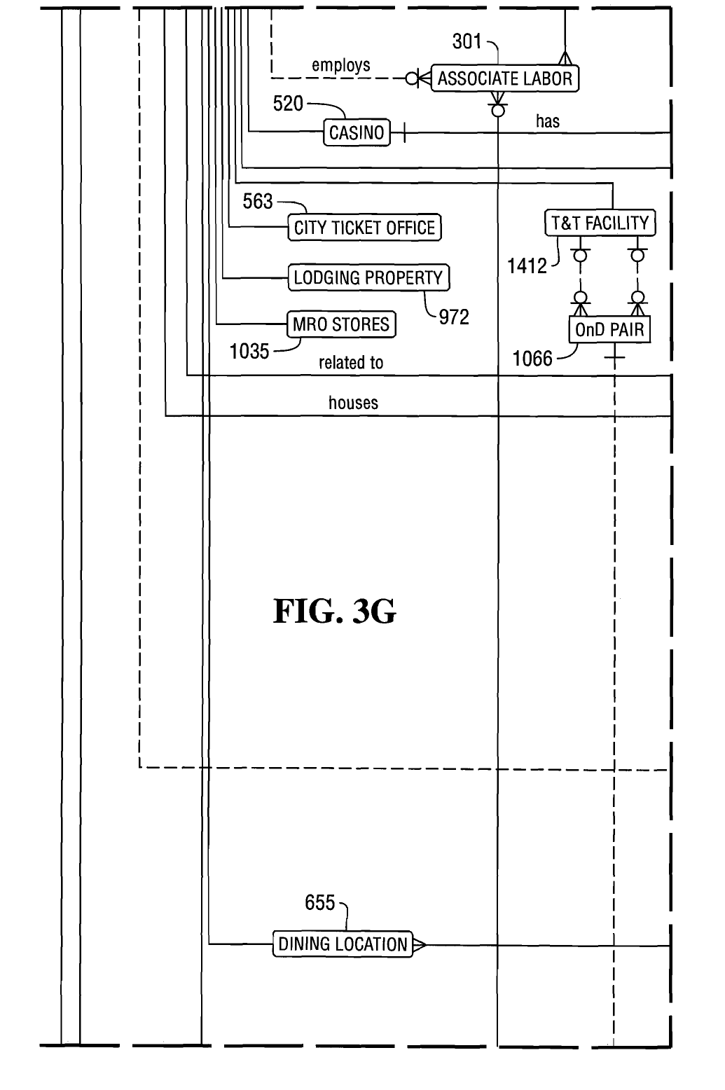

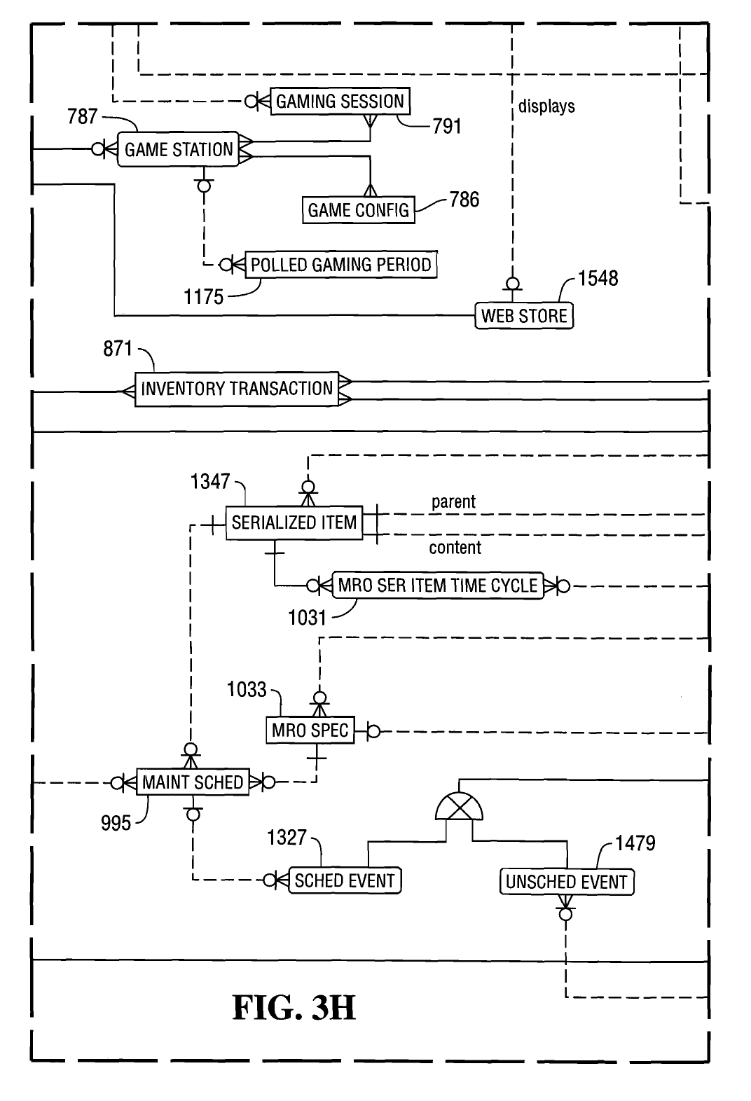

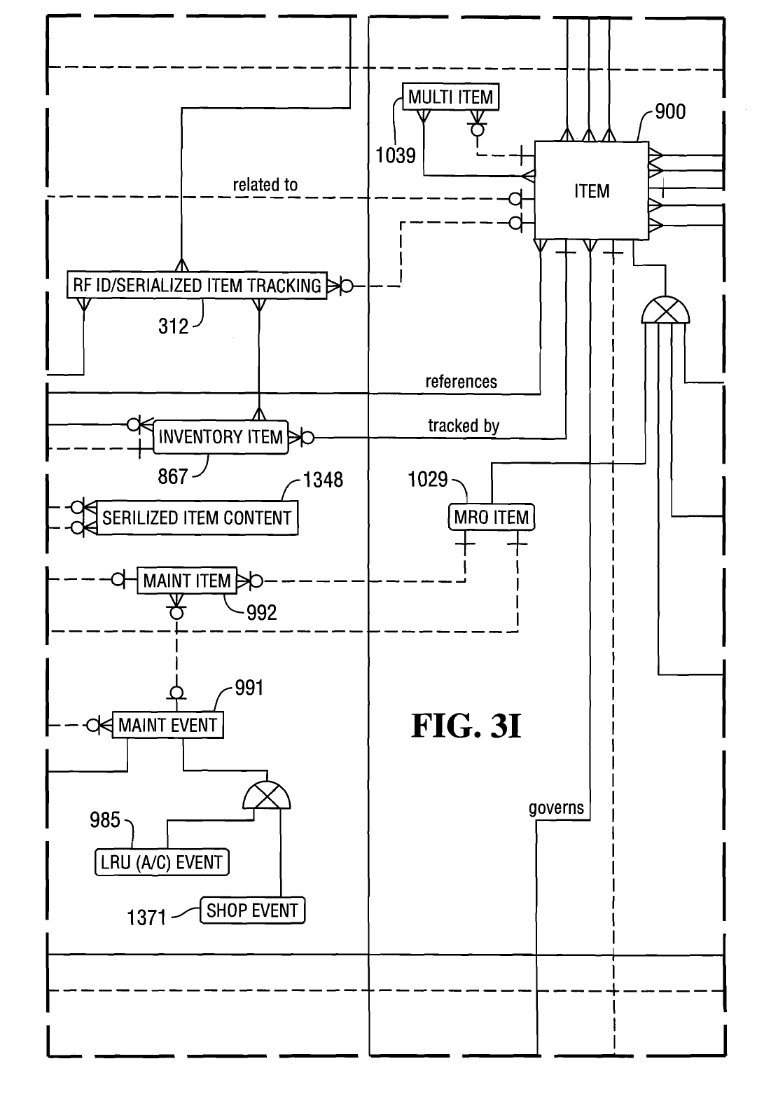

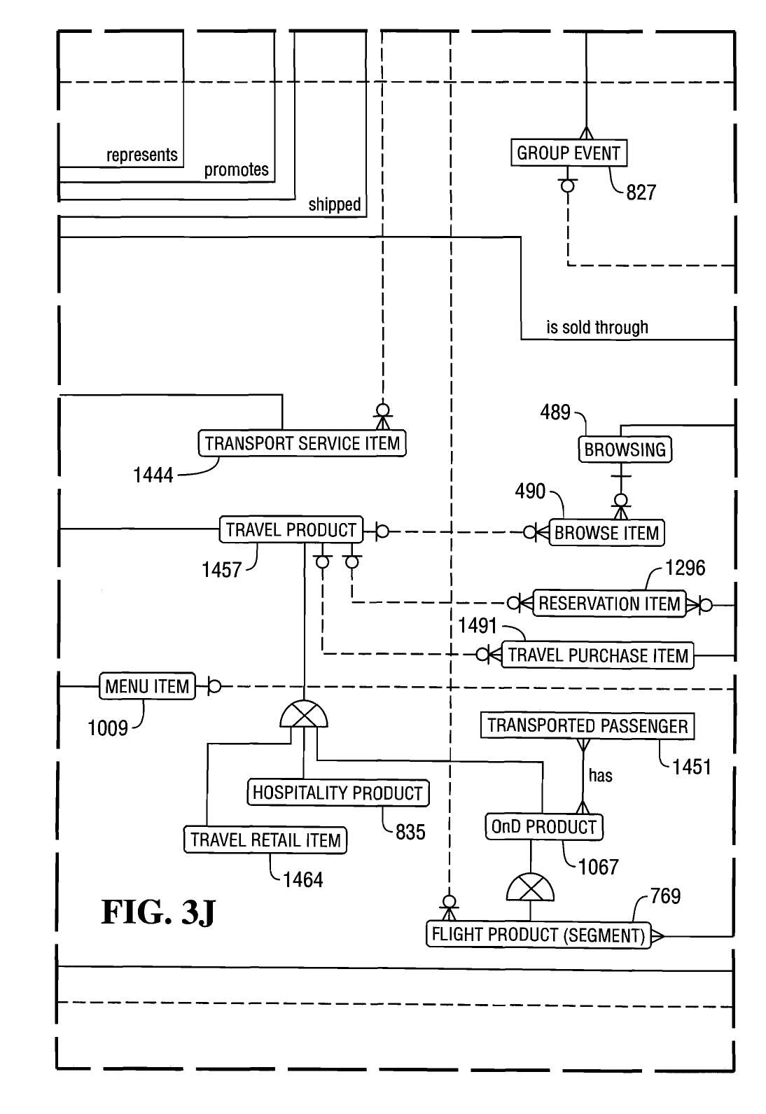

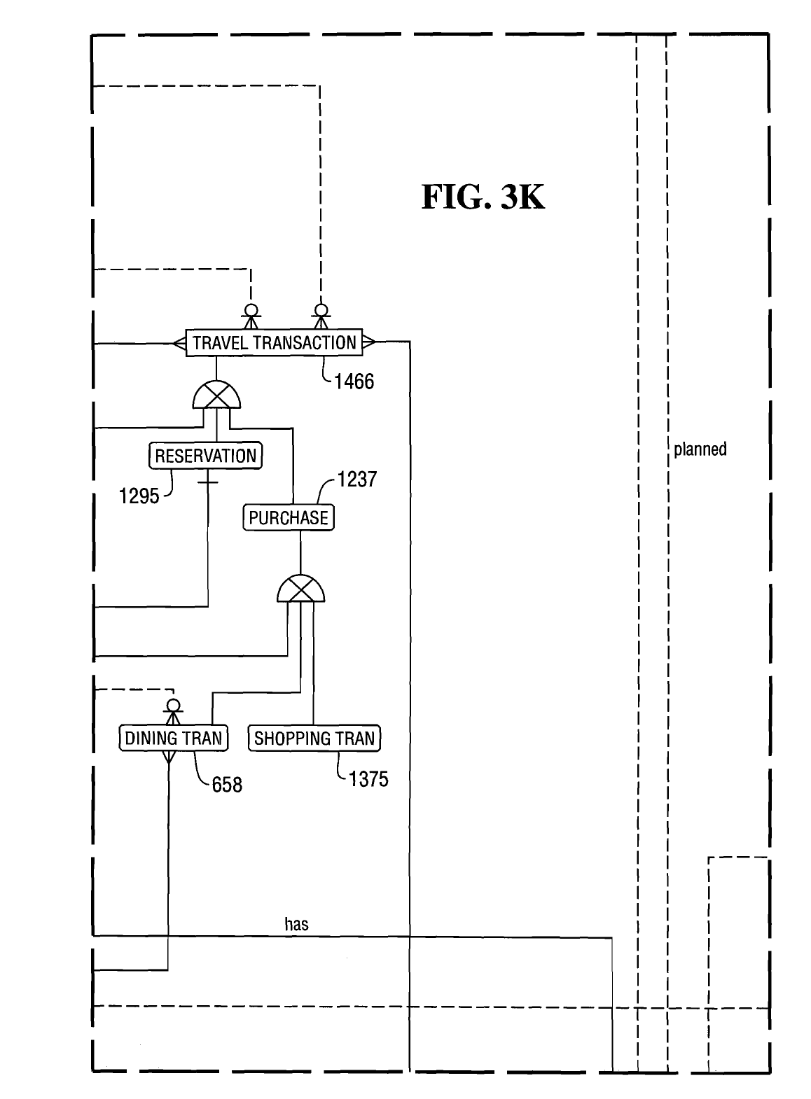

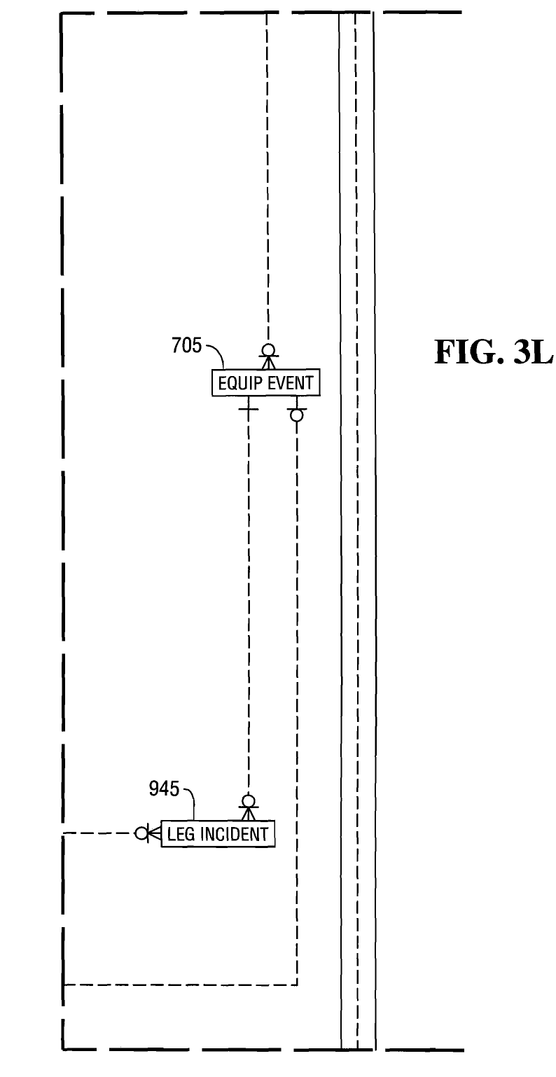

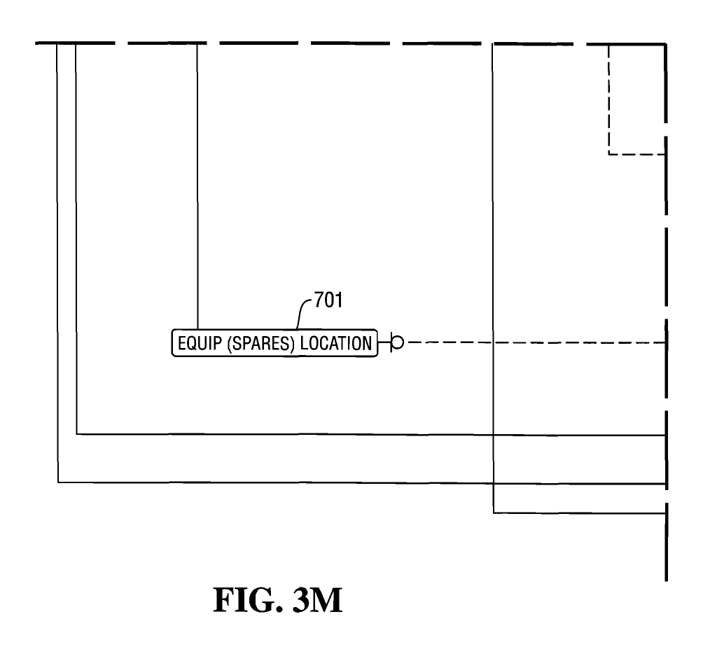

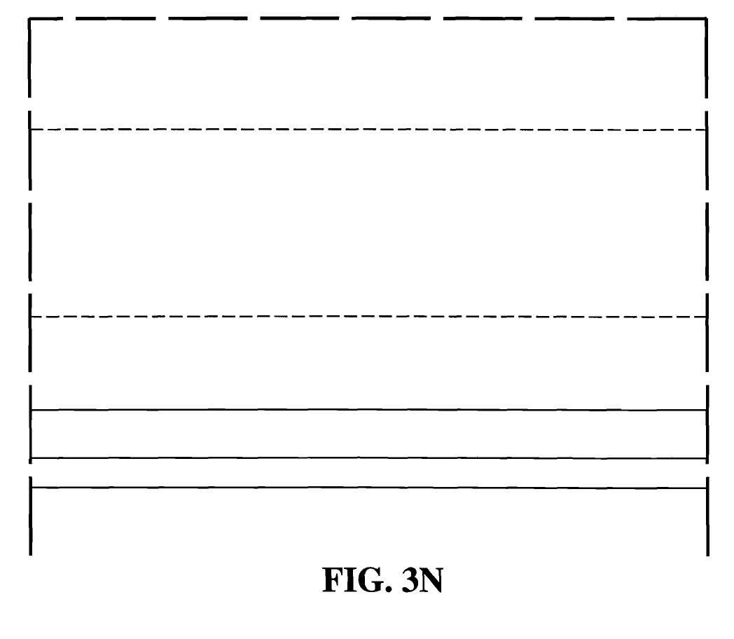

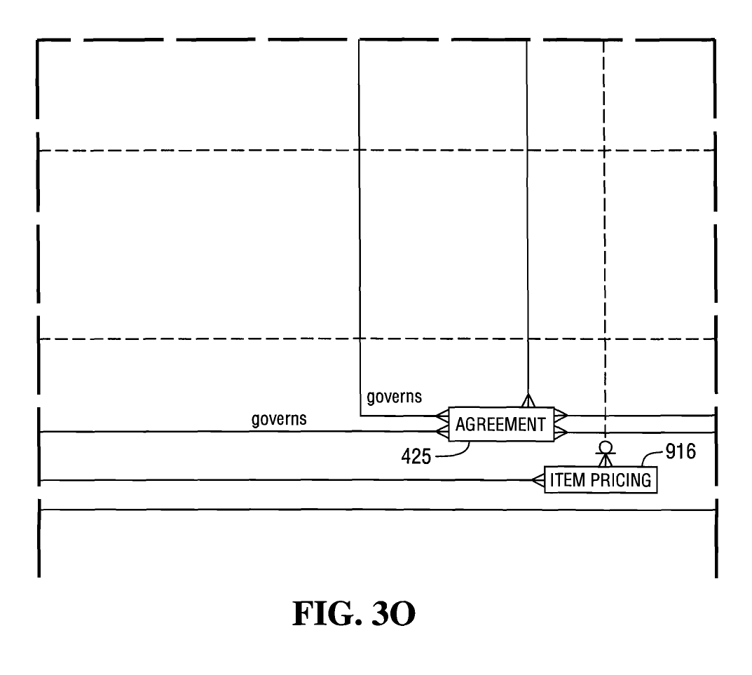

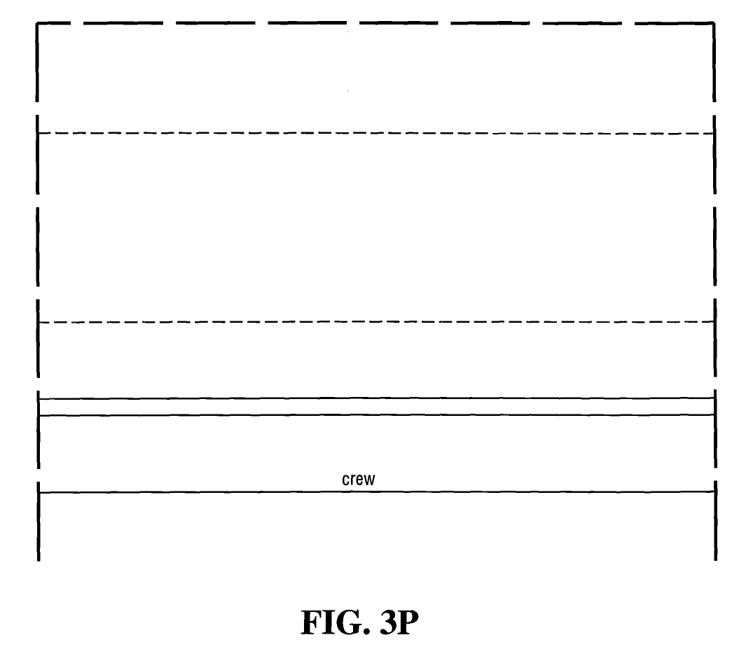

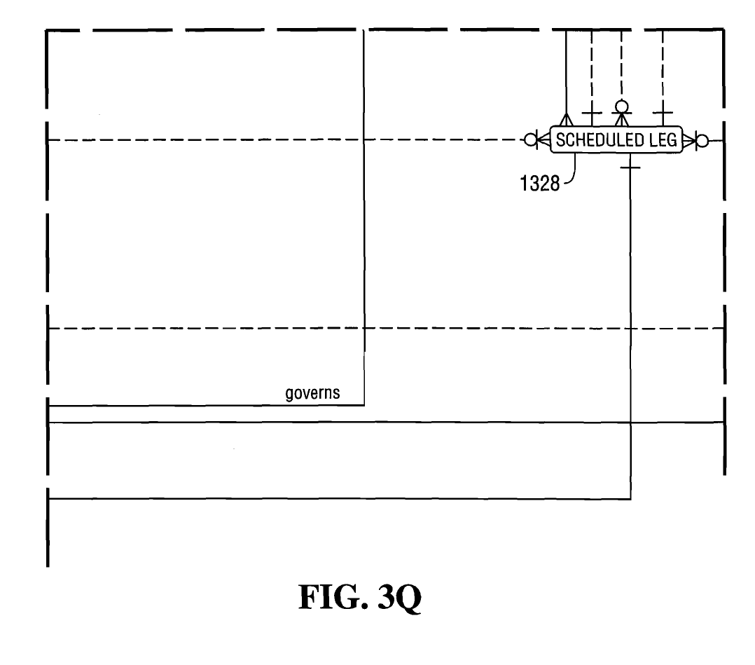

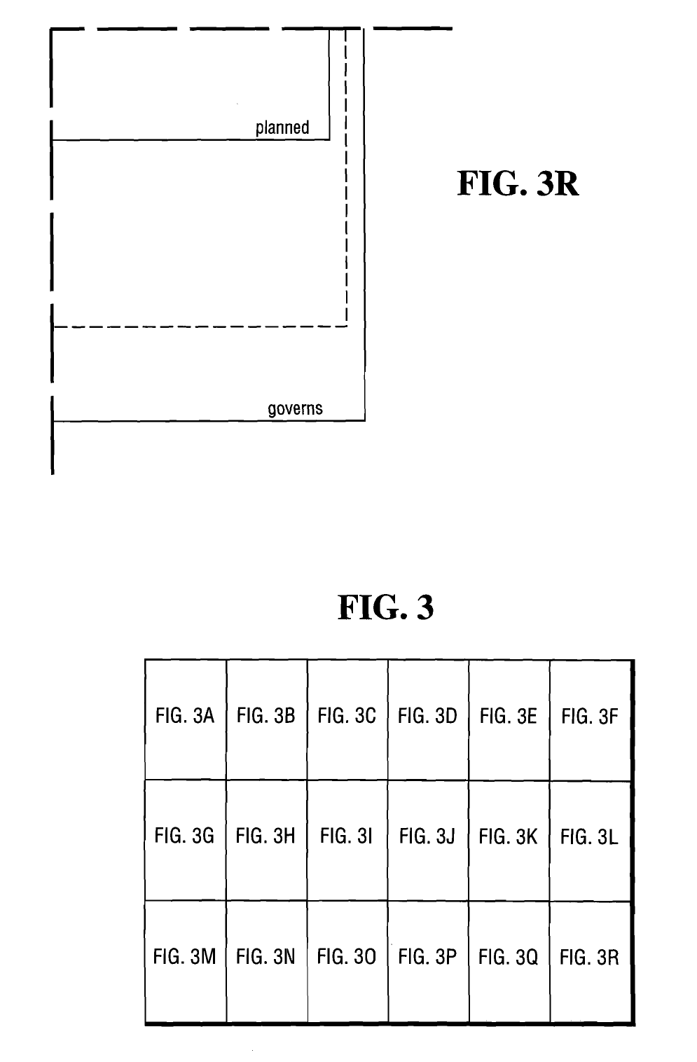

The Travel and Hospitality Data Model Logical Data Model is presented in a conceptual view in FIGS. 3A through 3R. This view provides an overall high-level understanding of the major entities and how they relate to each other. This conceptual level forms the foundation for the remaining views. Its purpose is to show the most important entities in the logical data model and how they generally relate to each other.

The Conceptual View is derived directly from the Travel and Hospitality Data Model Logical Data Model by selecting the most important entities from every subject area, being sure that at least one entity from each subject area was selected and distilling the relationships among the selected entities, while still maintaining the general nature of the way the entities relate to each other. During this process, intervening entities were abstracted into relationships. Many-to-many relationships were used where appropriate. Several entities shown in the Conceptual View represent a subject area or combination of entities within a subject area. The result is a simple, easy to understand diagram that conveys the general content of the underlying logical data model.

For ease of use and understanding, the Travel and Hospitality Logical Data Model has been divided into numerous subject areas identified in Appendix A.

### Casino and Gaming Subject Areas

Casino operators have a real need to be able to monitor their environments. This includes the capability to know which customers are currently in-house and what gaming they are engaged in. All of the equipment such as slot machines and table games must provide a detailed view of current activity and provide for historical trends and statistics. VIP customers must be immediately recognized and catered to according to their value to the Enterprise and their gaming maturity. Faulty or failing equipment must be identified and quickly repaired. Customer Relationship Management capabilities must provide for customer compensation awards and usage and for loyalty rating and points. Sweepstakes management permits customers to participate using a variety of methods. Casinos have a pressing need to monitor and analyze a myriad of details that stem from the gaming activities which include customers' game and table preferences, wagering strategies, wins, jackpots and losses, sweepstake entries and wins, buy-ins, pay-outs, turnover, theoretical statistics against which to measure customer and casino performance and many more such types of key business information. Following are some key issues which Casinos must understand to bring the best value to the business.

### Patron Value Measurement

Casinos must understand the true profitability of each patron from a multi-dimensional view. That means understanding the gaming behavior of different patrons so a patron can be compared to profitable segments and a determination made as to how to raise their profitability to the casino. This involves understanding their gaming activity at the casino, the cost to the casino in terms of comps and other marketing costs to get the patron to visit the casino and finally understanding their non-gaming spend while on the property. This area enables casino operators to better understand the attributes of their highest value patrons and ensure that they receive the highest level of service and attention. This allows the casino operators to optimize labor skills and allow scheduling around peak high value patron activity periods. By understanding the gaming and non-gaming profiles of their best customers, the casinos can also target other lower value patrons and work to move them toward these higher profit activities.

Measurement involves a detailed analysis of the types of games played, services utilized, number of games played, time spent per session by patrons and tender utilized for each patron visit. In addition, all non-gaming activity and spending activity will be captured so detail analysis can take place. A visit profile will be developed for each patron visit based on frequency, probability and profitability of each game mix and non-gaming activities. Listed below are some examples of the analysis with this approach:
Coin In and Profitability Analysis for the Top 10 Games in Coin In by Game Trait, for the Top 20% Profitable patrons by Venue
Patron Segment Propensity (Lift) and Performance Analysis by Patron Profit Decile Segment for Games by Game Trait by Venue
Patron Segment Propensity (Lift) Analysis by Patron Profit Decile Segment by Game by Venue
Game and Profit Analysis by Patron Postal Code by Game Trait by Venue
Avg. Coin In and Profitability by Visit by Patron Postal Code for Game Trait by Venue
Avg. Coin In per Visit vs. Avg. Profitability
Avg. Comp Costs per Visit by Patron Postal Code

### Patron Retention

The casino operator needs to determine the factors that lead to the defection of its top patrons. Once these factors are determined, data mining techniques can be utilized to see if these factors are influencing any current high-level patrons to identify them as potential candidates for defection. Detailed analysis like the examples below can be performed to understand the prospects to target for retention:
Define customer defection and find the exact customer defection rate
Identify “at risk” customers and likely attrition factors and defection characteristics
Measure and predict loyal, disloyal and fraudulent customer behavior
Identify migration patterns and segment customers based on churn factors
Rank current customers by likelihood to defect

### Increase Patron Frequency (Promotional Analysis)

The casino needs to optimize its marketing efforts. It should promote games that drive the highest margin visits by patrons and eliminate games and services that drive low-margin visits by patrons. Casinos have a need to perform a detailed analysis of the types of games played, services utilized, number of games played, time spent per session by patrons for each patron visit in response to a promotion. The Model needs to show game mix played per visit compared to target game mix analyzed and promoted and provide input to promotion effectiveness by providing promotional impact on frequency of play, affinity of promo game to non-promoted game for each patron responding to a given promotion. Listed below are some examples of the promotional analysis with this approach:
Promotional Effectiveness Analysis by Manufacturer, Venue, Pre Weeks vs. Promotion Weeks
Post-Promotional Impact Analysis by Manufacturer, Pre Weeks vs. Post-Promo
Promoted Single Game Driver Only Visit Analysis by Game for Manufacturer, for Venue
Single Game Type Only Venue by Manufacturer for All Promoted Games
Affinity and Visit Performance Analysis of Promoted Game, by Affinity Game by Venue
Promotional Game to Affinity Game-Trait Analysis by Affinity Slot Banks, by Venue
Promotional Game Trait Affinity Analysis by Affinity Categories, for Game Trait by Venue
Promotional Play to Total Play vs. Promotional Profitability to Total Profitability by Day for All Promoted Games by Venue
Promotional Game Propensity and Performance Analysis by Game by Game Trait, for the Top 20% Profitable Guests by Venue
Guest Segment Propensity (Lift) and Performance Analysis by Guest Profit Decile Segment for Promoted Games by Game Trait by Venue
Guest Segment Propensity (Lift) Analysis by Guest Profit Decile Segment by Game by Venue
Promotional Coin In and Profitability Analysis by Guest Postal Code, by Game Trait by Venue
Promotional Game and Profit Analysis by Guest Postal Code by Game Trait by Venue
Promotional Avg. Coin In and Profitability by Visit by Guest Postal Code for Game Trait by Venue
Promotional Game and Profitability Analysis by Day for All Promoted Games by Venue

### Patron Acquisition

The casino operator needs to identify potential high value patrons and understand how best to attract them to the casino. They will be able to do the following:
Find highly qualified prospects for new patron acquisition campaigns
Reduce the cost of acquiring a new patron by using the right acquisition channel and then drive or direct more traffic to that channel
Cost-effectively reach new prospects and drive revenue by converting prospects into patrons.
Target new patrons most likely to gamble with key offerings that complement casino objectives

The Model enables detailed analysis such as the examples shown below that can then be performed to understand the best new prospects to target as future patrons:
Analyze behavioral and demographic characteristics of most profitable patron segments
Develop scoring and profile for attributes and characteristics of desirable patrons
Analyze external patron data for sources to identify target patrons for acquisition
Analyze channel penetration and patron referral patterns
Identify new prospects that correlate to existing profitable patron profiles
Identify new prospect that can enhance current casino profitability

### Slot Optimization

The benefit of Slot Optimization is higher margin on slot machines. It allows the casino operator to populate the casino floor with the machines that patrons want to use most while negotiating the most favorable terms from the slot machine vendors. The overall benefit will be higher producing slot machines with lower overall costs which mean increased slot machine profitability.

The casino operator needs to analyze performance of slot machines by various slot attributes and identify which slot machines are candidates for deletion from the casino floor. These means collecting detail data on each slot machine's performance from a variety of perspectives. Some examples of this slot analysis are:
Revenue & Coin-In Trend Reporting by Time Period
Revenue Trend Reporting by Geography, Machine or Machine Attribute
Profitability by Time, Geography, Machine or Machine Attribute
Profitability Analysis by Row and Cross Column Combinations
Comparison Analysis: Sales TY vs. LY
Denomination Analysis
Best/Worst Analysis by Machine, Geography, Time or Attribute

In order to negotiate better terms with Slot Machine vendors, the casino company needs detail data regarding the performance of the company's slot machines. Some examples of Slot Manufacture analysis follows:
Manufacturer Analysis by Game, Geography, Time and/or Trait (Manufacturer Sales and Profitability Performance)
Manufacturer Analysis by Game, Geography, Time and/or Trait (Manufacturer Performance by Game and Game Attribute)
Manufacturer Performance Analysis by Game Position
Manufacturer Analysis by Game, Geography, Time and/or Trait (Coin In vs. Plan Comparison by Game & Game Attribute by Manufacturer)
Manufacturer Scorecard Performance Monitoring

Key gaming content in the Model includes detailed support for the following:

Casino Group Events and Junkets. Customers are provided travel arrangements to visit a Casino from a distant city or cities for a specified series of dates. The Casino expects to gain revenue from the events and have expenses, commissions and other event parameters that help to define their expected Net profit. The Group Events and Junkets become part of the Casino and Gaming Model history and such information may be used in future for Marketing and Analysis.

Detailed Player Gaming Session History per Round. Whenever a gaming customer plays at a slot machine, table game or other type of gaming activity, the details of his play are placed into The Model to provide the Casino the capability of analyzing all of the activities that occurred. The Model provides for a “per round” level of detail that includes the type of game being played and the specific machine or table being used, the sequence of and total number of rounds played, all information about wagers and adds, jackpots, etc. Casinos can focus on player techniques and wagering tendencies as well as support a well-rounded management of the Customer Relationship with the Casino.

Detailed Player Gaming Session History. As well as a per Round perspective, The Model also provides a higher level of aggregation for the “game session.” These statistics provide even more capabilities for business analysis that gives keen insight into the long-term trends that affect the Casino's profitability and Customers' marketability. At this level The Model provides details of customer session Wins and Losses including Jackpots, Buy-in, Pay-out, Turnover, Theoretical and Average Wins, Lifetime Wins, Losses, Comps and loyalty earnings as well as the Casino Rating of each Customer. The Model includes game configuration particulars such as manual payments of Jackpots, Hopper Fills, Game Type and specific Configuration in use at the time of each session.

Detailed Player Accounting. A detailed accounting of each Player (customer) is provided in The Model which tracks all money transactions including Marker Issues (linked to specific gaming sessions), Debt Repayment or Written Off, Front Deposits, approvals of Credit with specified Limits and Collateral and a Balance History.

Player Comps (Compensation). During play or as part of a larger Promotional effort, Casinos provide compensation to Customers in the form of “comps” (a reward) to encourage the Customers' continued patronage. Comps may be “points” given and recorded in the Customer's Loyalty Account or as a physical coupon or other ticket format. The comps may be drawn upon to pay for various activities or services offered by the Casino and may be part of the Customer's Folio Account. All details are recorded in The Model in the form of related transactions.

Multiple Configurations of Slot and Table Games. In order to maximize their Customer's enjoyment and the Casino's profits, all gaming machines and tables may be configured in different ways. Slot machines may offer different games and game types and may offer (or not) Progressive game play. Settings may be changed “on the fly” in some machines or manually in others providing the Casino a means to record different Theoretical Percentages, Maximum and Minimum wagers, Denomination, Number of Players per game or per the House and all recorded in The Model keeping all changes over time for immediate and future analysis.

Player Alert. Casinos need to know about their Customers' voluntary Disassociations or other bans on Customers imposed by the Casino or the State or Territory in which the Casino is located. In addition to supporting the Casino's need to comply with local regulatory bodies, the Casino may also record any other types of alerts that apply to Customers such as bad Markers, Returned Checks and Limitations. The model provides for historical details giving the Casino the ability for immediate or long-term analysis of Customer status.

Equipment Instances. When gaming machines or tables are placed into service, the Casino must track each one separately over the life of its operations in the specific location to which it is allotted within the Casino. The layout of games throughout the Casino may be reconfigured as needed and faithfully recorded in The model complete with historical details providing both instant and long-term analysis of games. This permits the Casino to find which locations and machines bring the most profit and/or Customer enjoyment thus helping to maximize the overall operational plan. This area of interest records many historical details of game machines, their configurations and Themes, the Manufacturers, Series and Serial Numbers, and In-Service and Retire dates.

Equipment Maintenance. It is critical for a Casino to know not only where all gaming equipment is located within the Casino, but also which machines are out-of-service or have been “flagged” as broken and when they will be returned to service. The Model permits real-time notification of Customer-Identified failures (available as a “call” button on some machines) and also tracks equipment that is pulled out-of-service, who repairs the equipment and why and how long the machine was “down” for repairs.

Near Real-Time Game Session Monitoring. In modern Casinos is often found a security center that runs a full-time monitoring of all Customers and Game play that occurs on the premises. The Model provides for great detail surrounding each Game Session (at either Slots or Tables) which is necessary for the Casino to monitor its revenue and gaming session details. Detailed data outlined further may be aggregated at regular, flexible intervals which allow the spotting of trends, anomalies, special circumstances, VIP customers gaming progress, etc. This area tracks such data as Game Configurations, Player Counts, Minimum, Maximum and Average Bets, Jackpots, Number of Rounds Played, Theoretical and Actual Win Amounts, Buy-in, Turnover and Payout, Wagers and Adds, Statistics, Round and Session Start and End dates and times. All of this data may be viewed per Gaming Machine or Table or aggregated as needed for advanced analysis.

Sweepstakes. In order to effectively market to its Customers, Casino offer promotions in the form of Sweepstakes which customers may enter. The Model records overall campaign details such as expected Revenue (the Goal), the specific Promotion being offered, relationship to specific Gaming Sessions and Customer Visit as well as linkages to Loyalty Accounts maintained for the Customers' benefits.

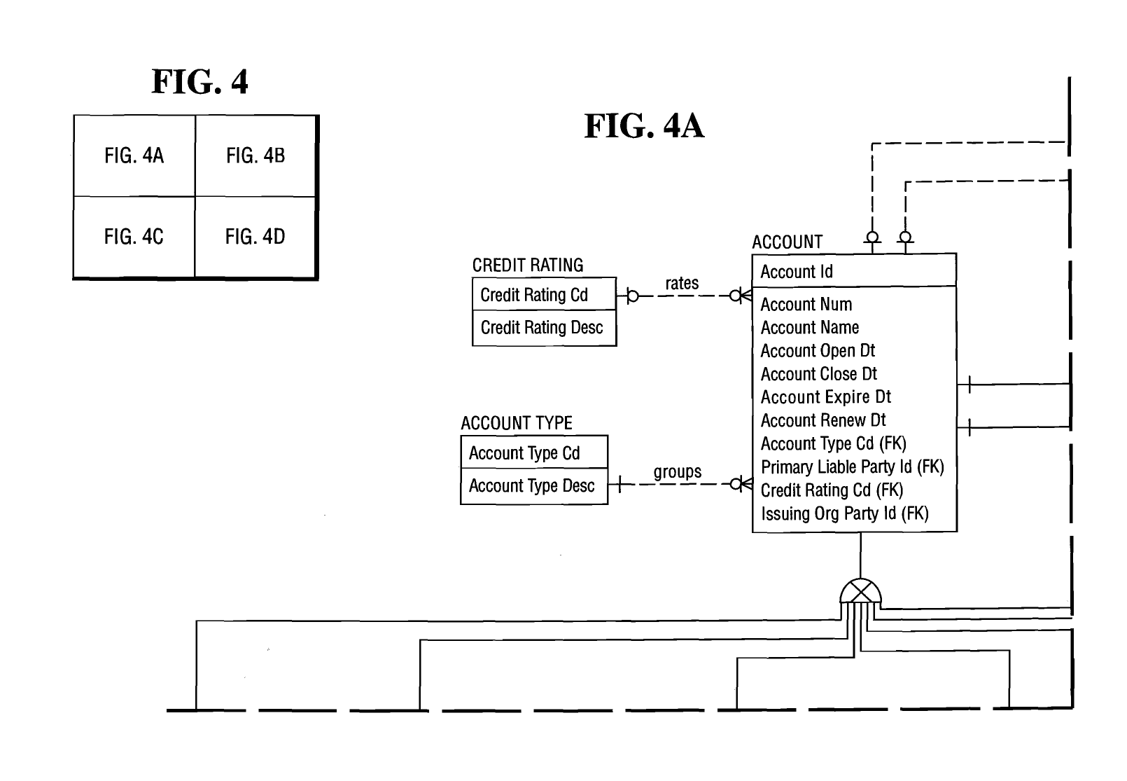

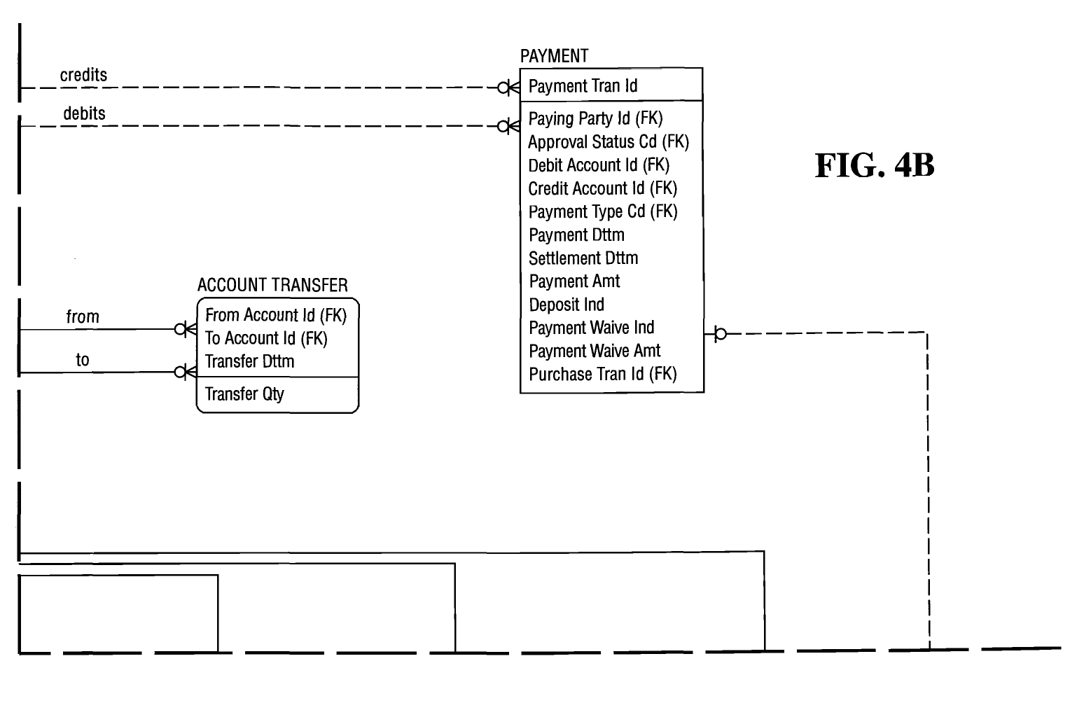

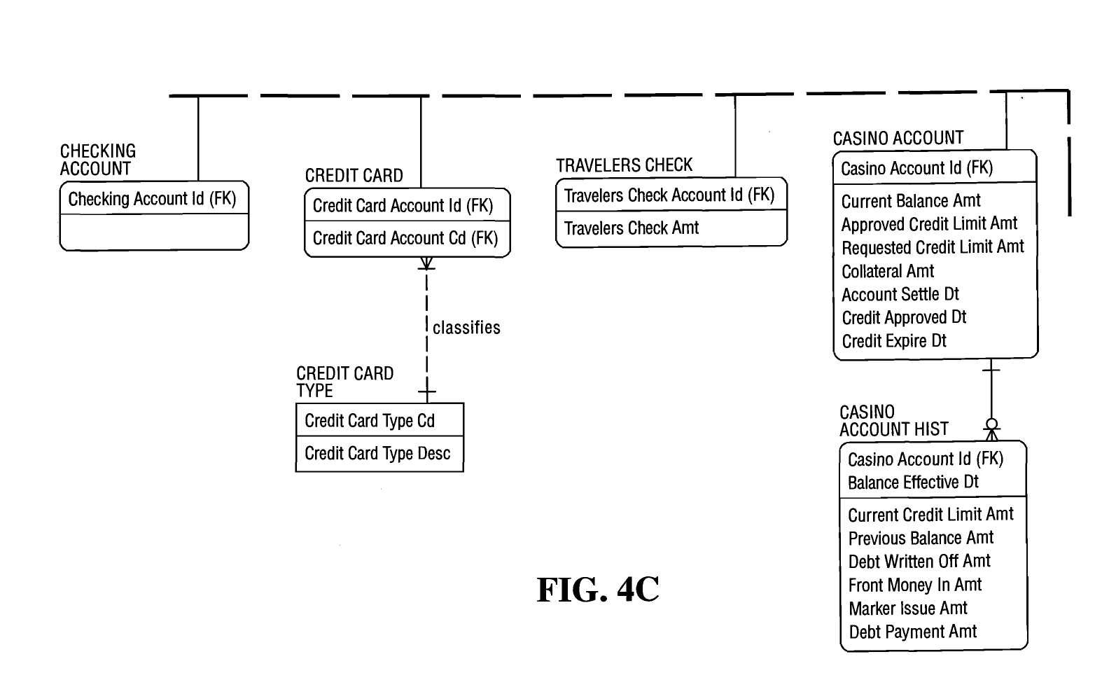

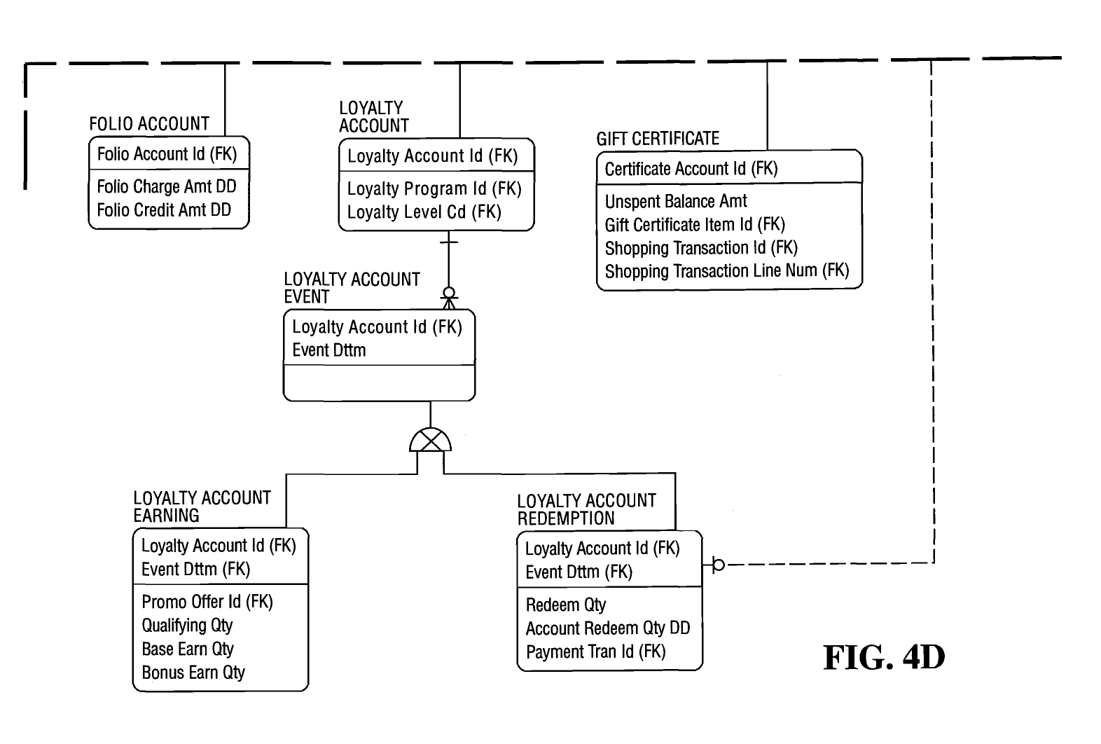

Incorporation of the foregoing, key subject matter provides a strong and varied business information foundation for the casino and gaming venue. The Travel and Hospitality Logical Data Model includes subject areas developed to logically model these key business information needs. These subject areas, as well as the entities included within the subject area, are illustrated in FIGS. 4 through 21. There is some natural overlap between the subject areas, i.e., an entity may appear in multiple subject areas if it has direct relationships with entities in multiple subject areas.

The subject areas modeling the key business information needs of casinos and gaming venues, and shown in FIGS. 4 through 21 include the:

ACCOUNT (DEFINITION) Subject Area, illustrated in FIG. 4;

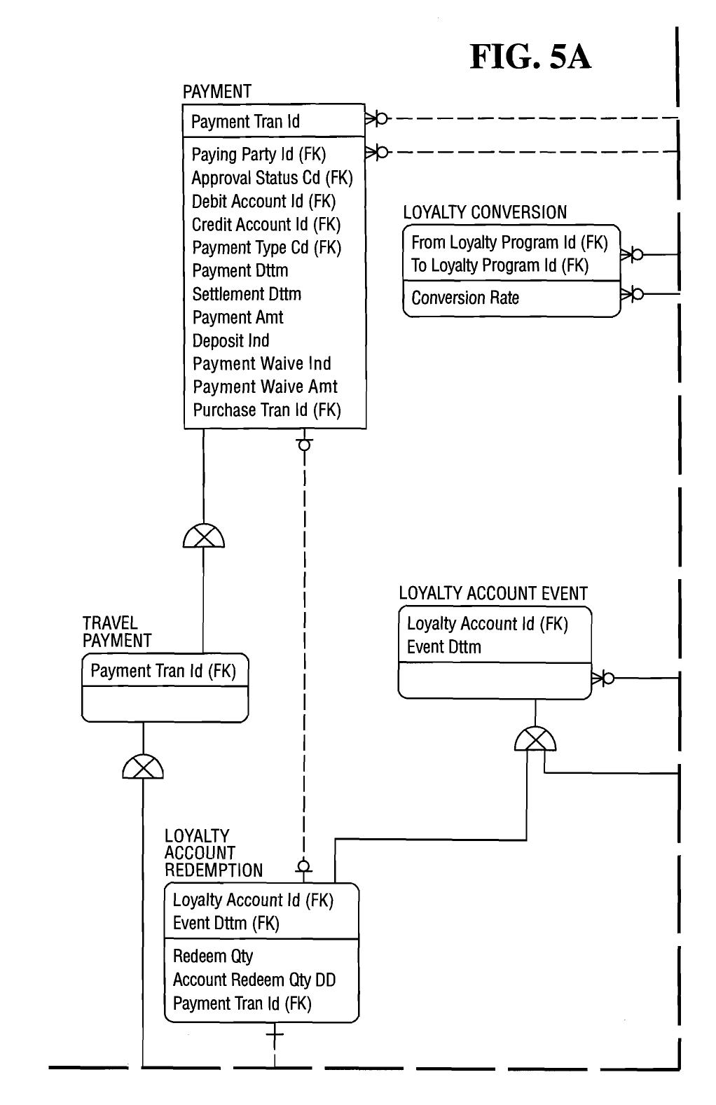

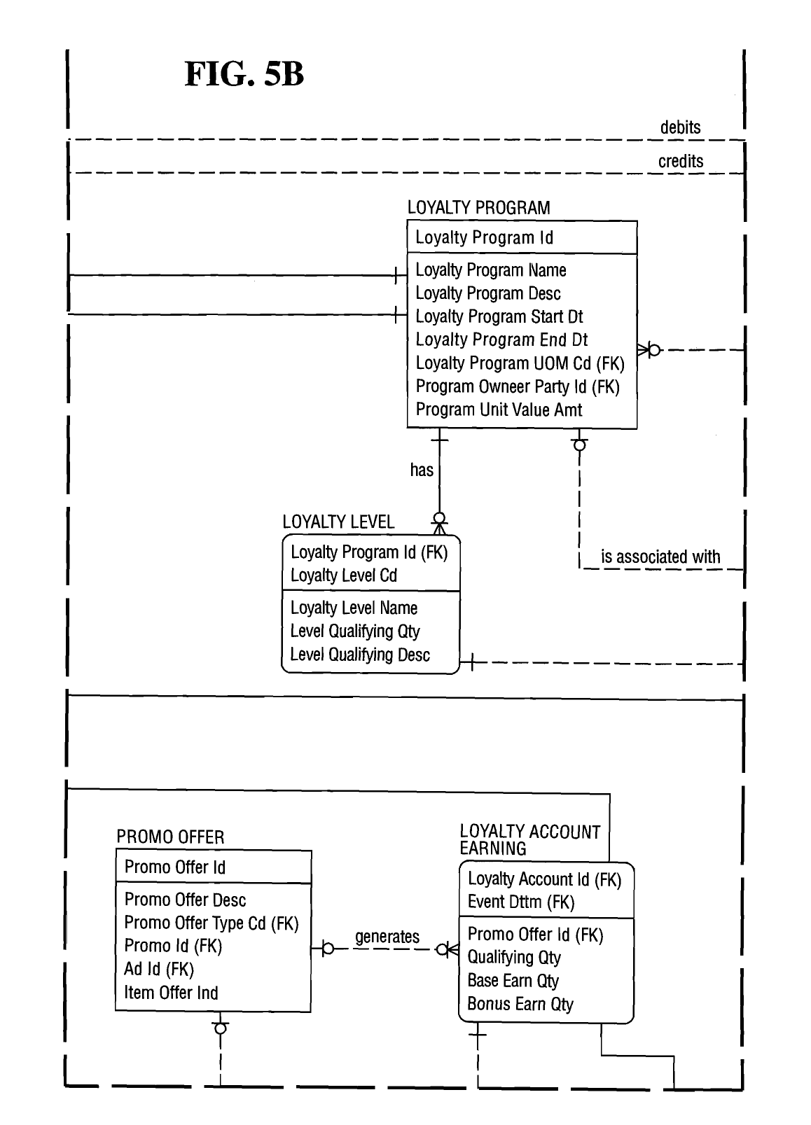

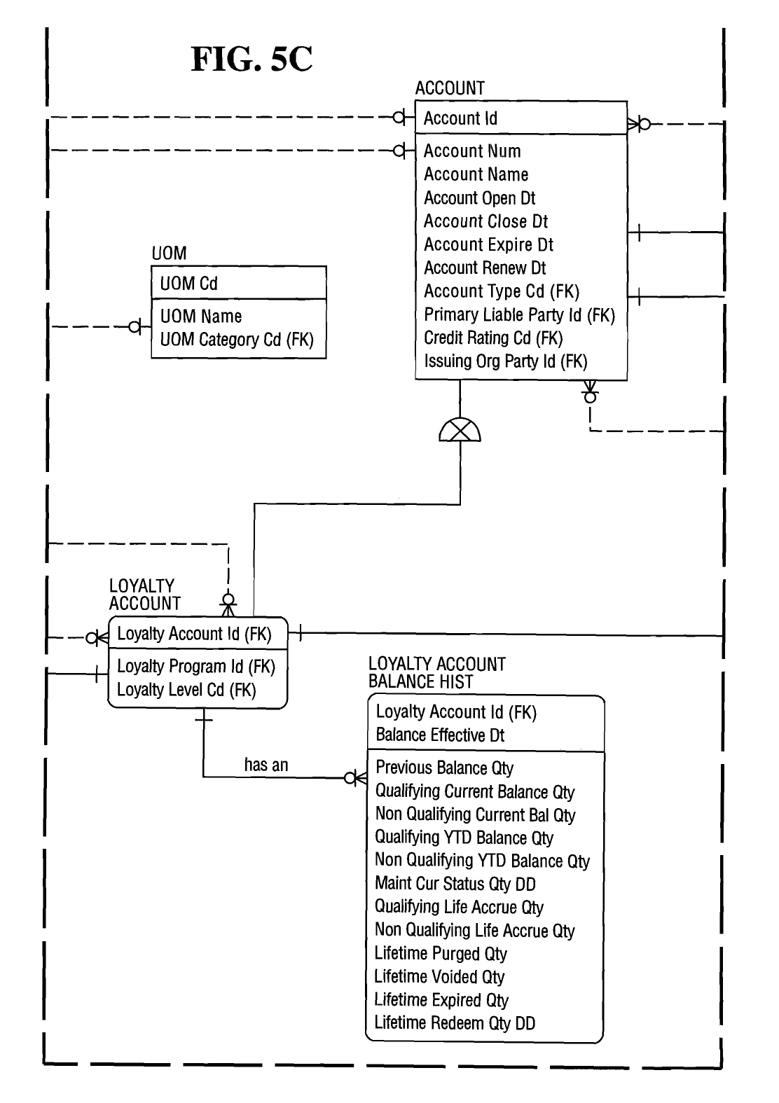

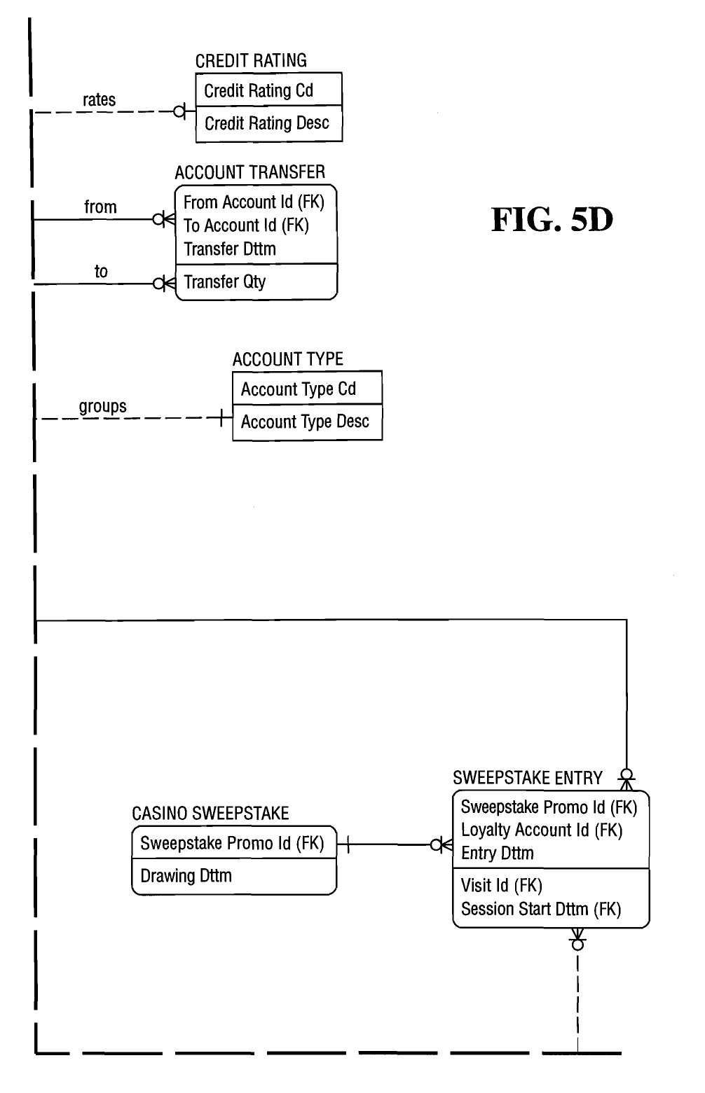

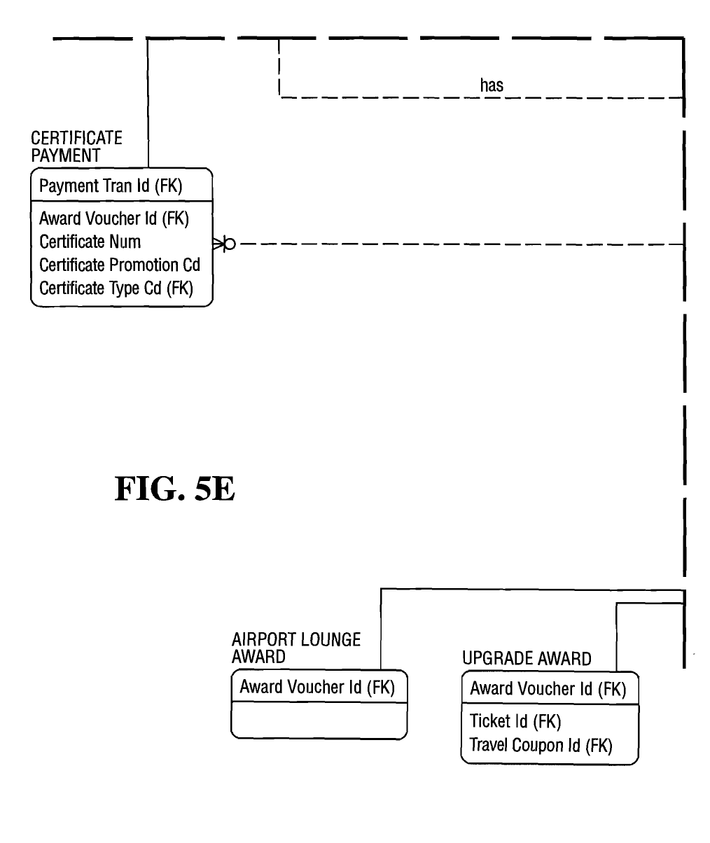

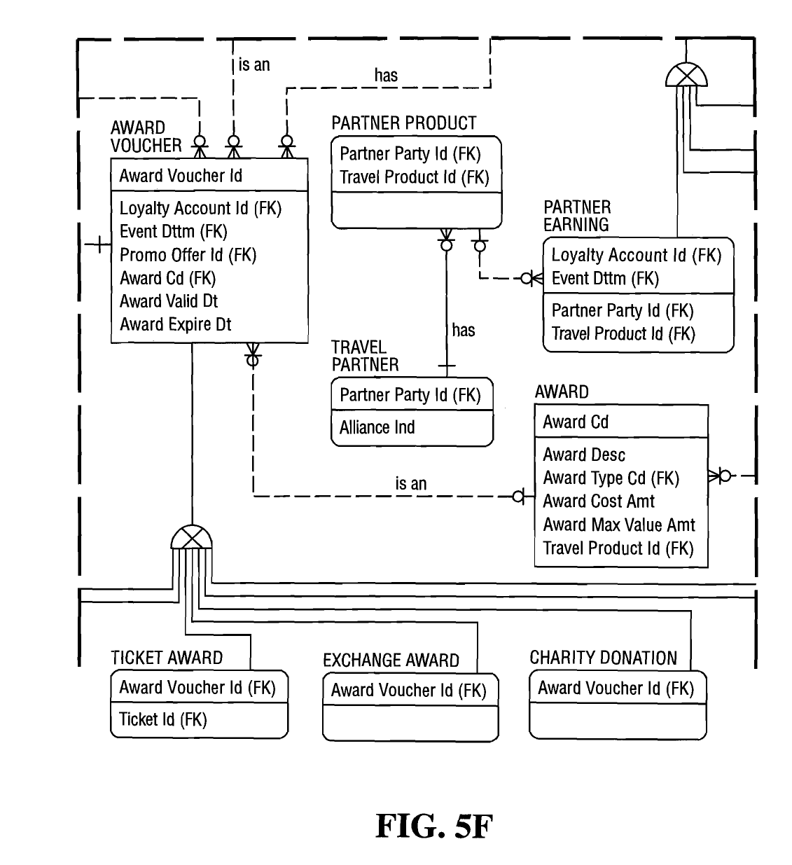

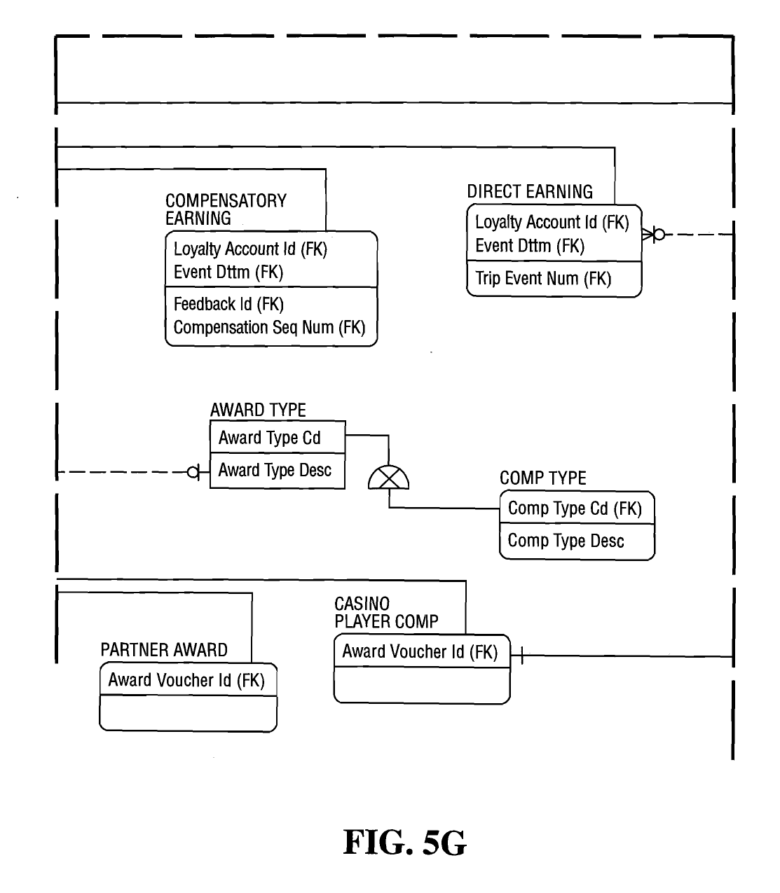

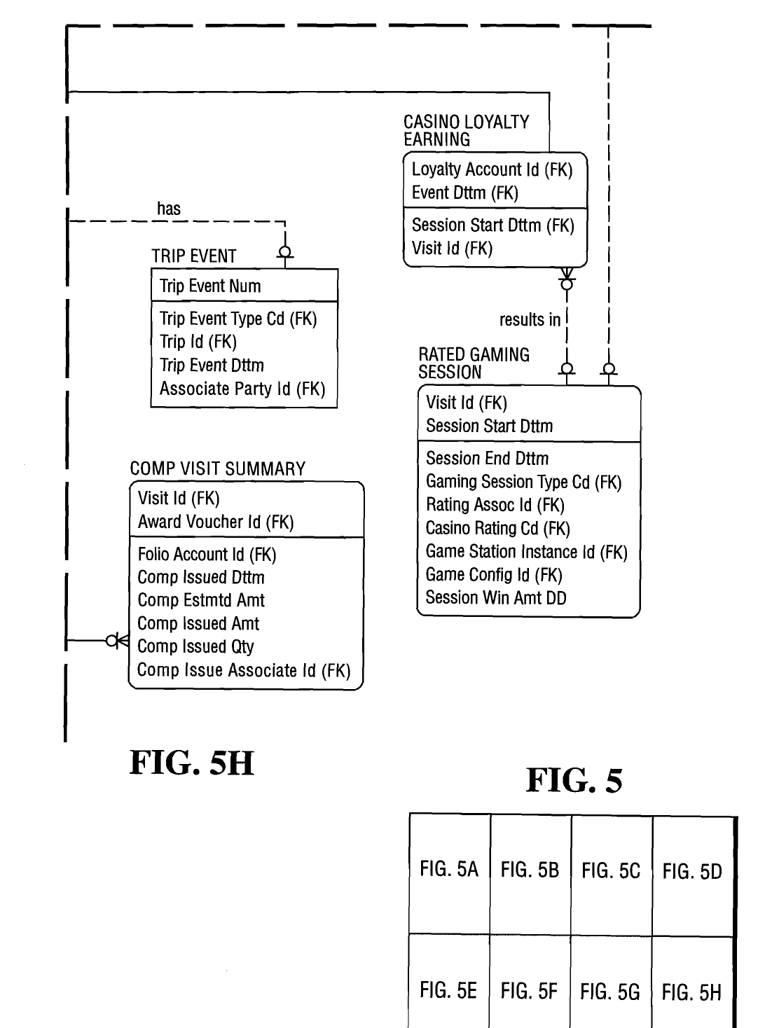

ACCOUNT (LOYALTY) Subject Area, illustrated in FIG. 5;

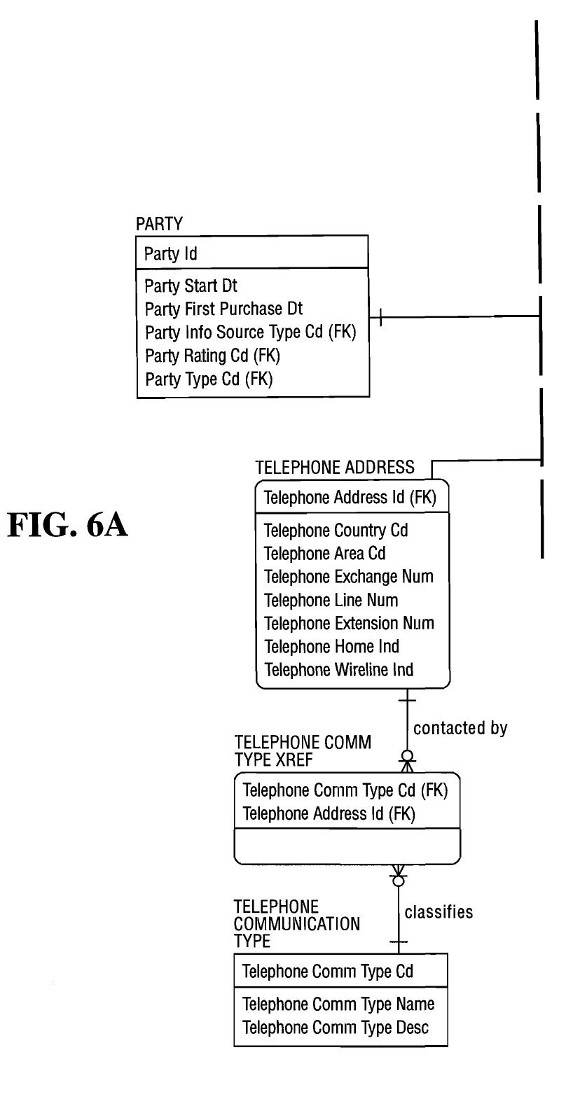

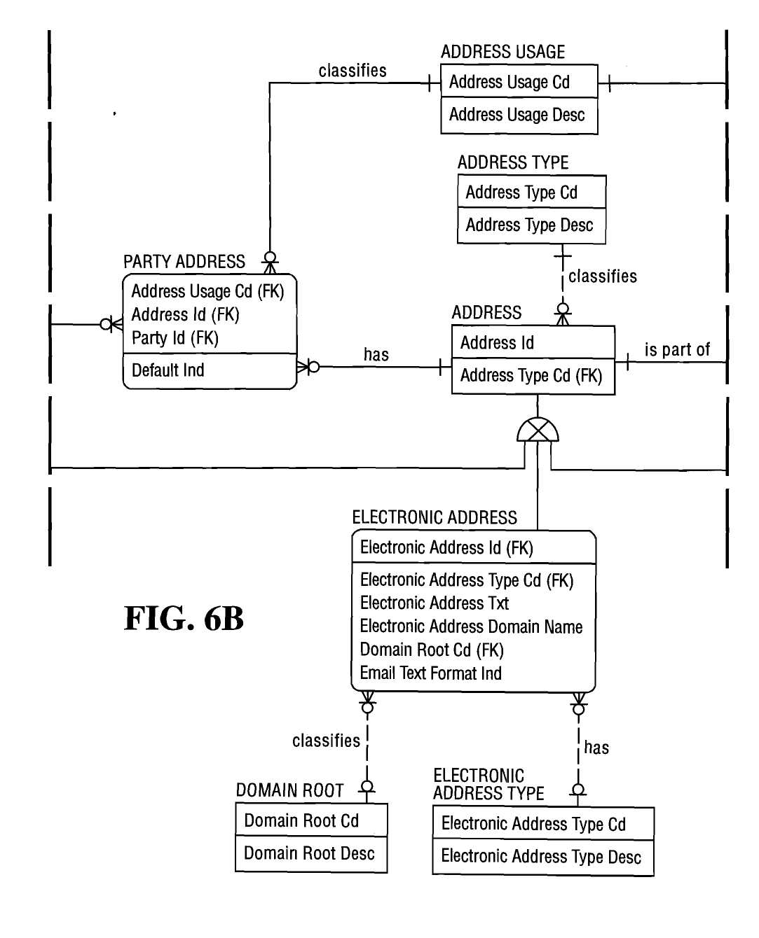

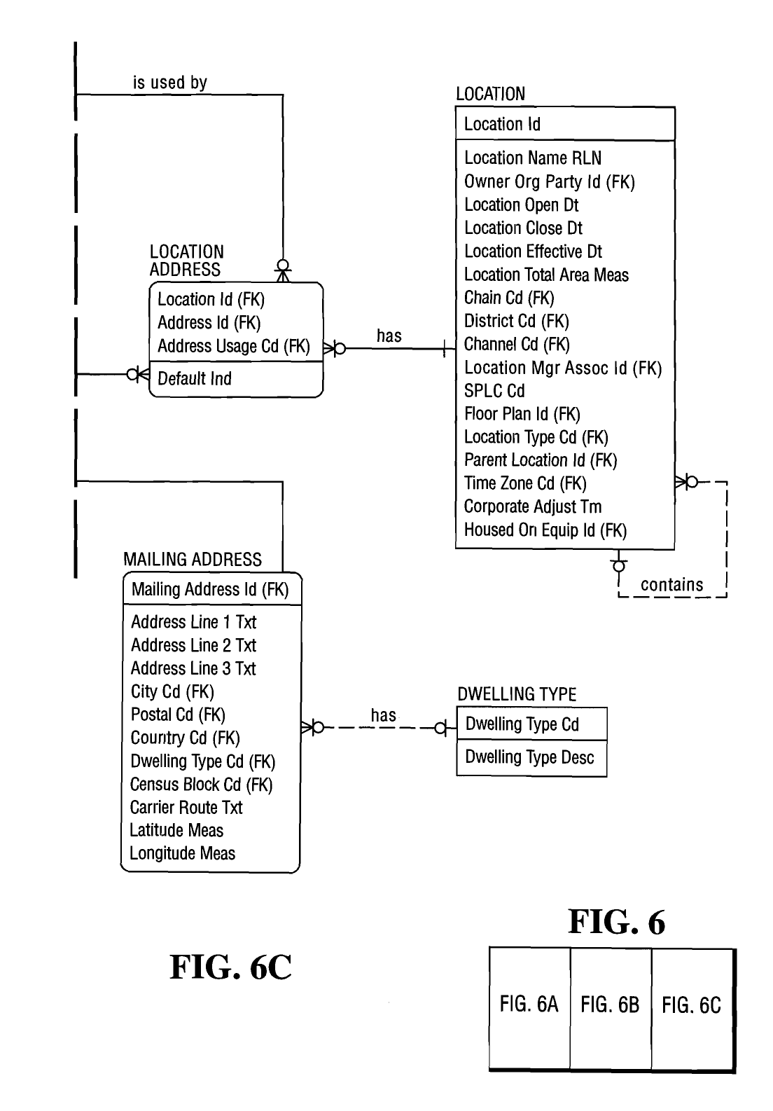

ADDRESS Subject Area, illustrated in FIG. 6;

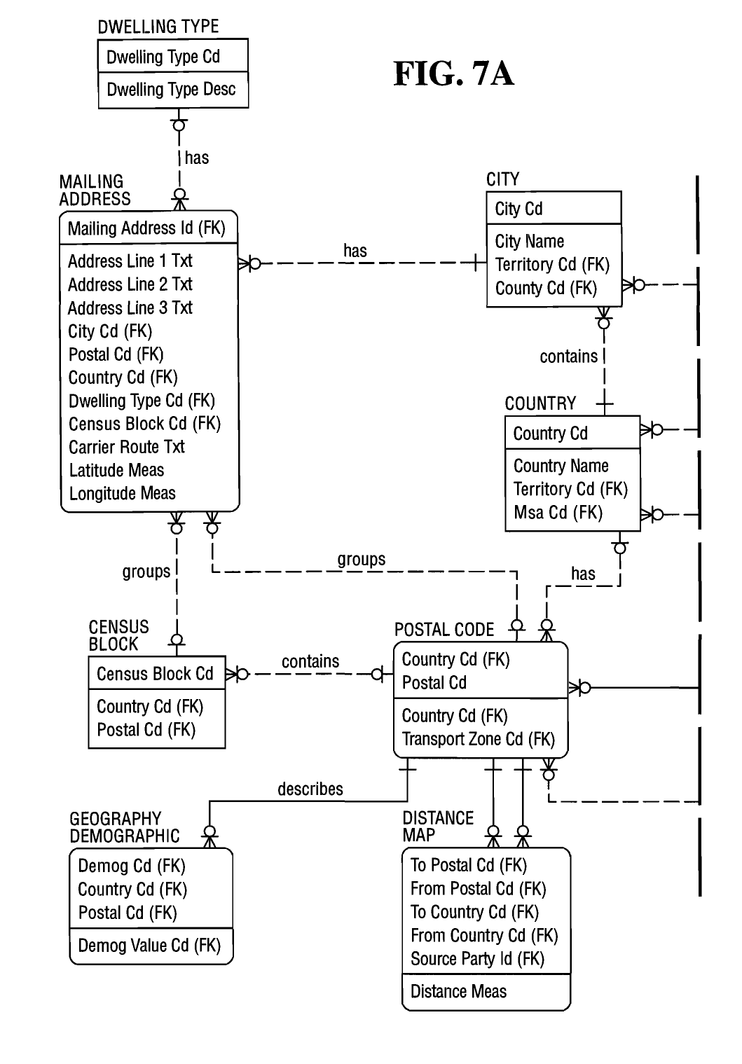

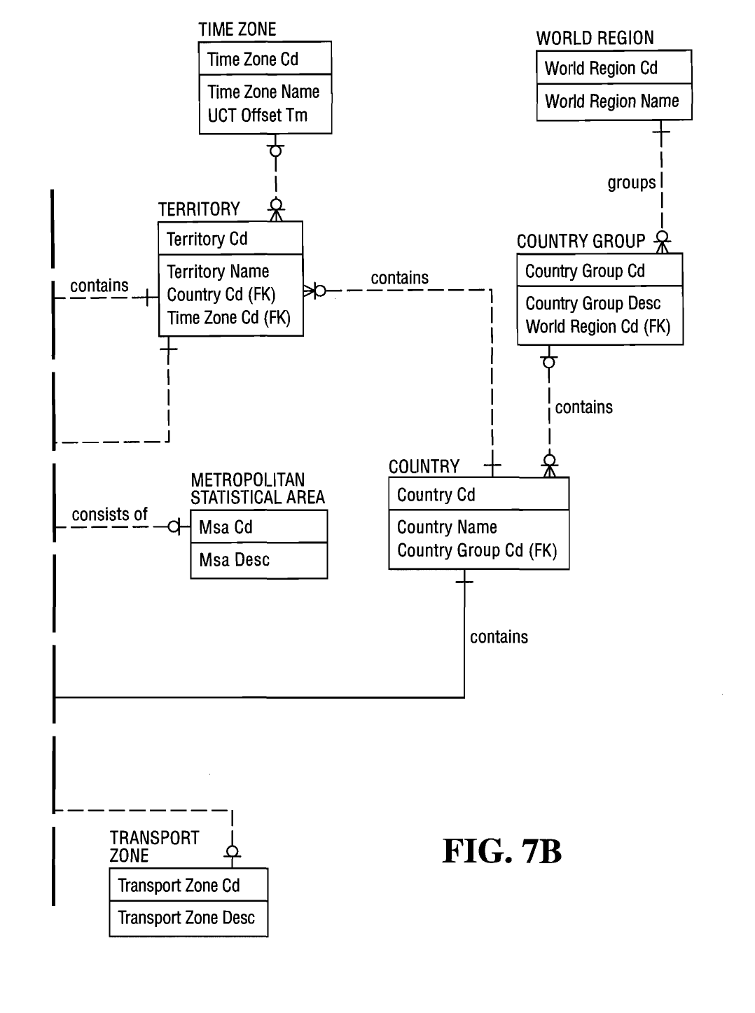

ADDRESS (GEOGRAPHY) Subject Area, illustrated in FIG. 7;

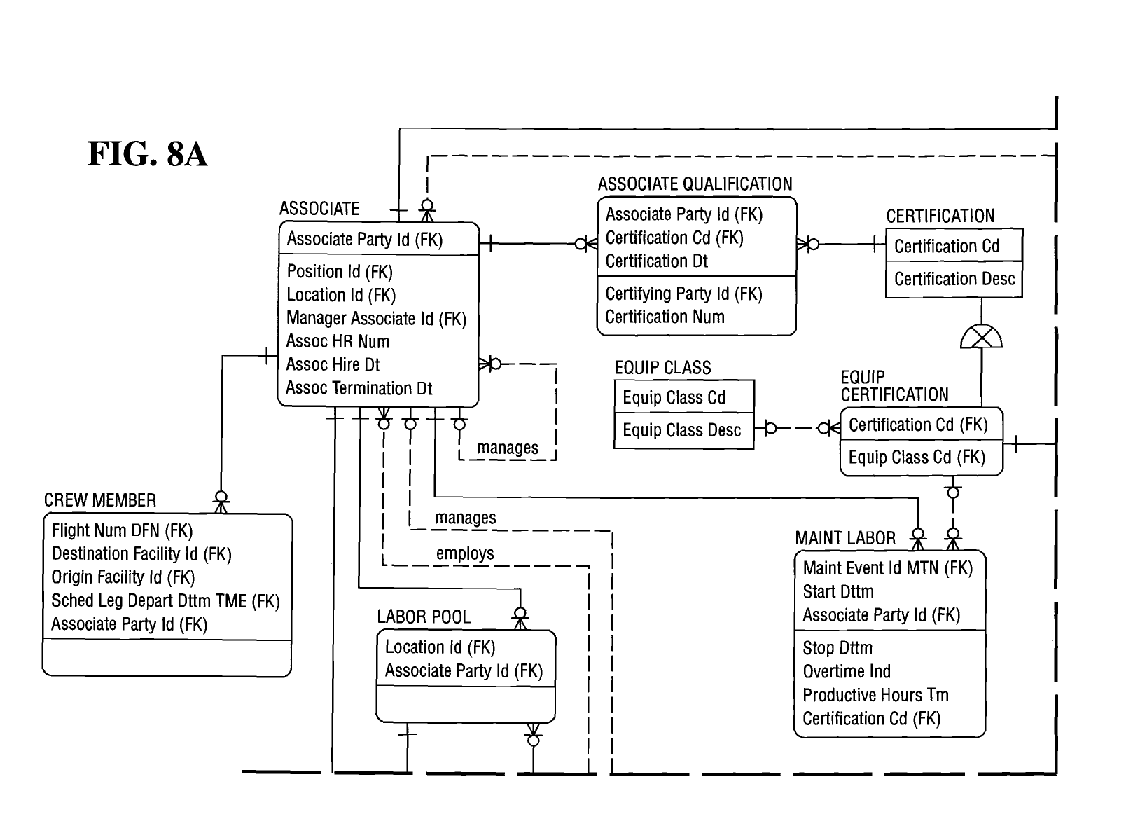

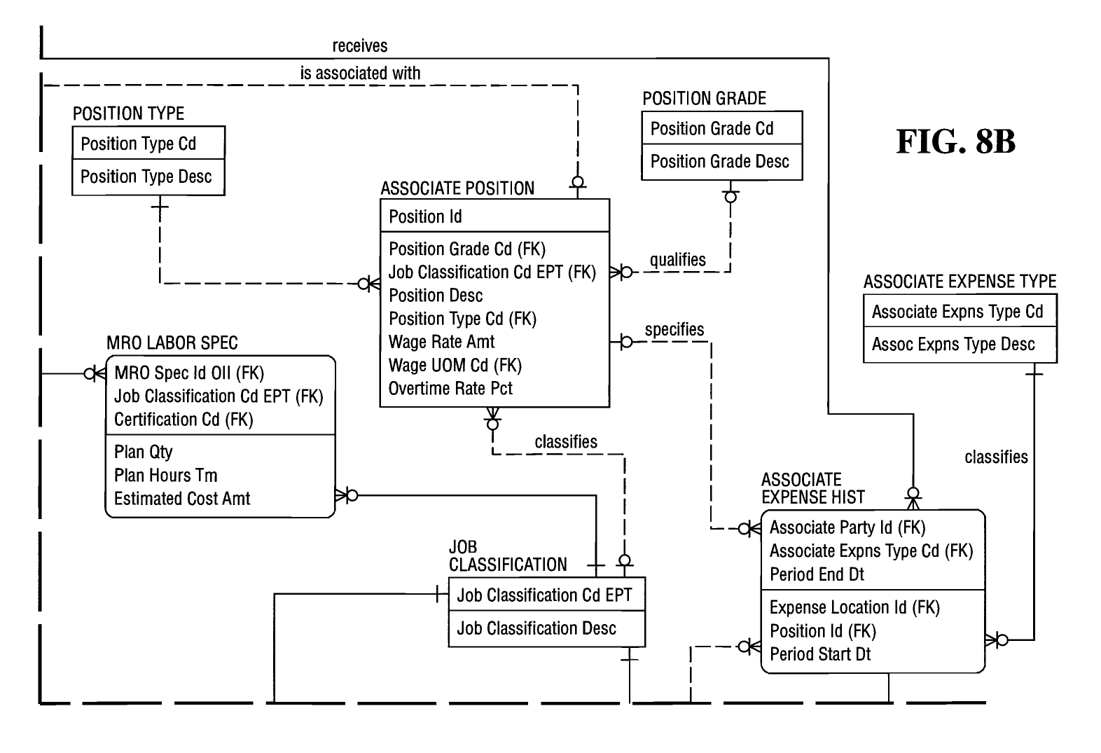

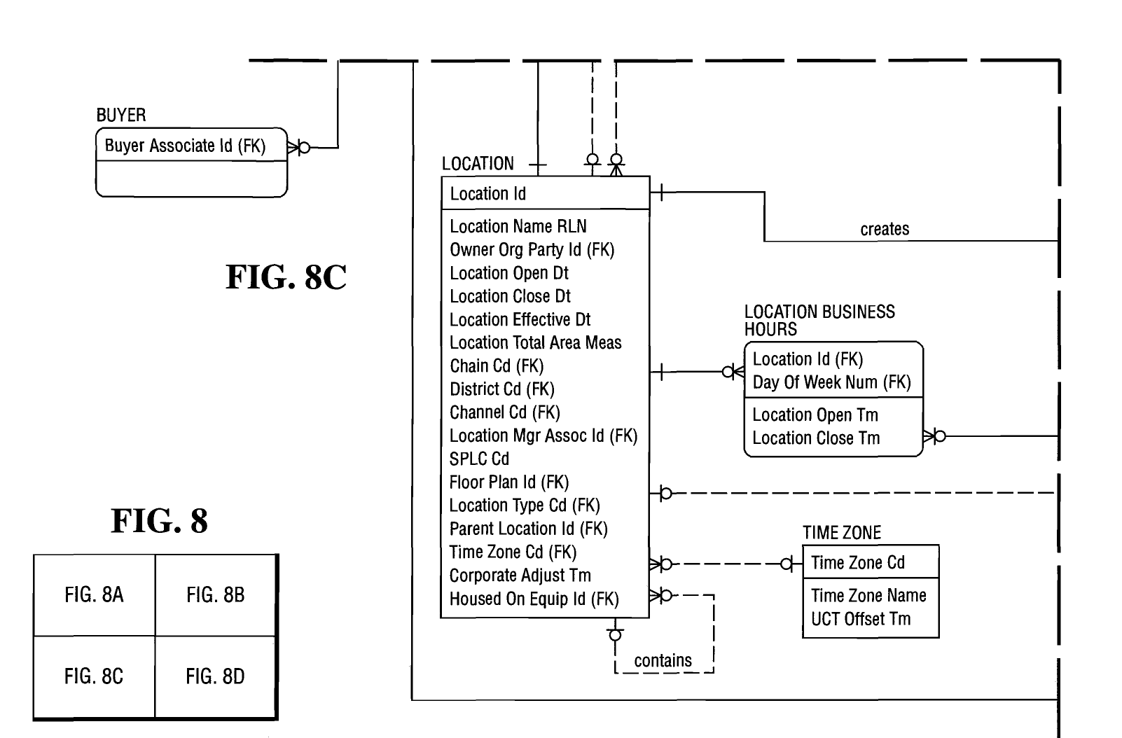

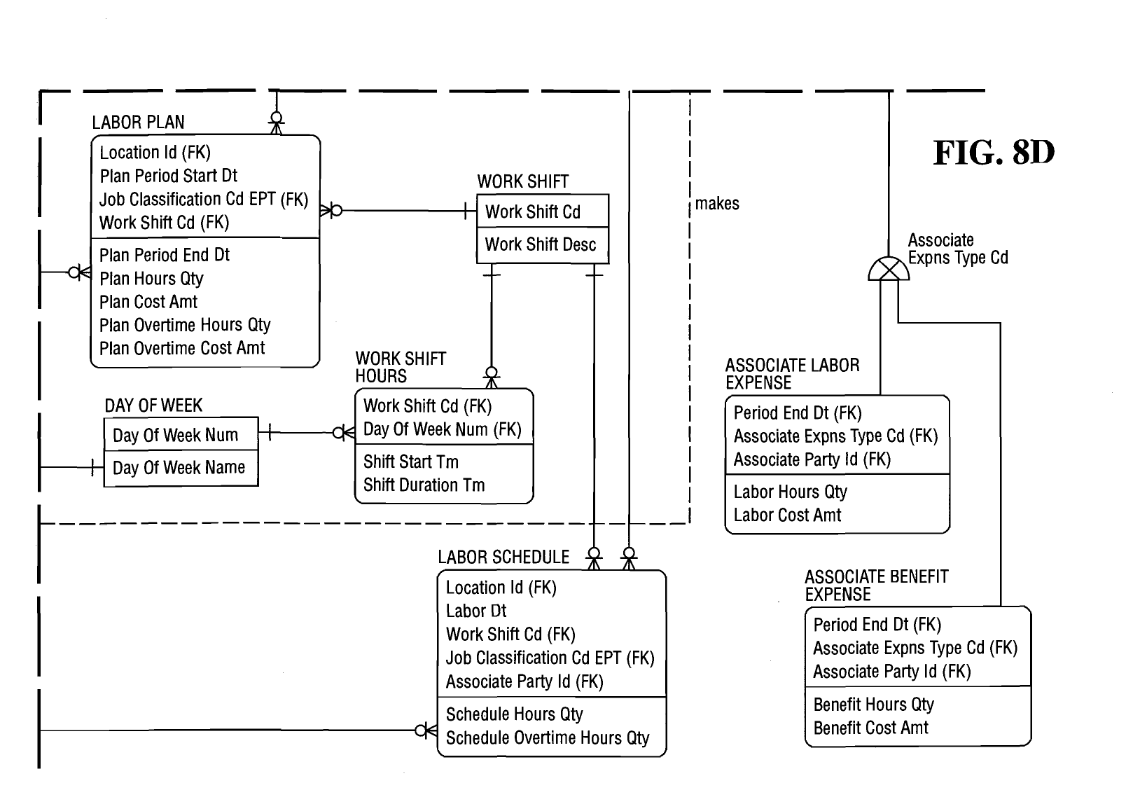

ASSOCIATE LABOR Subject Area, illustrated in FIG. 8;

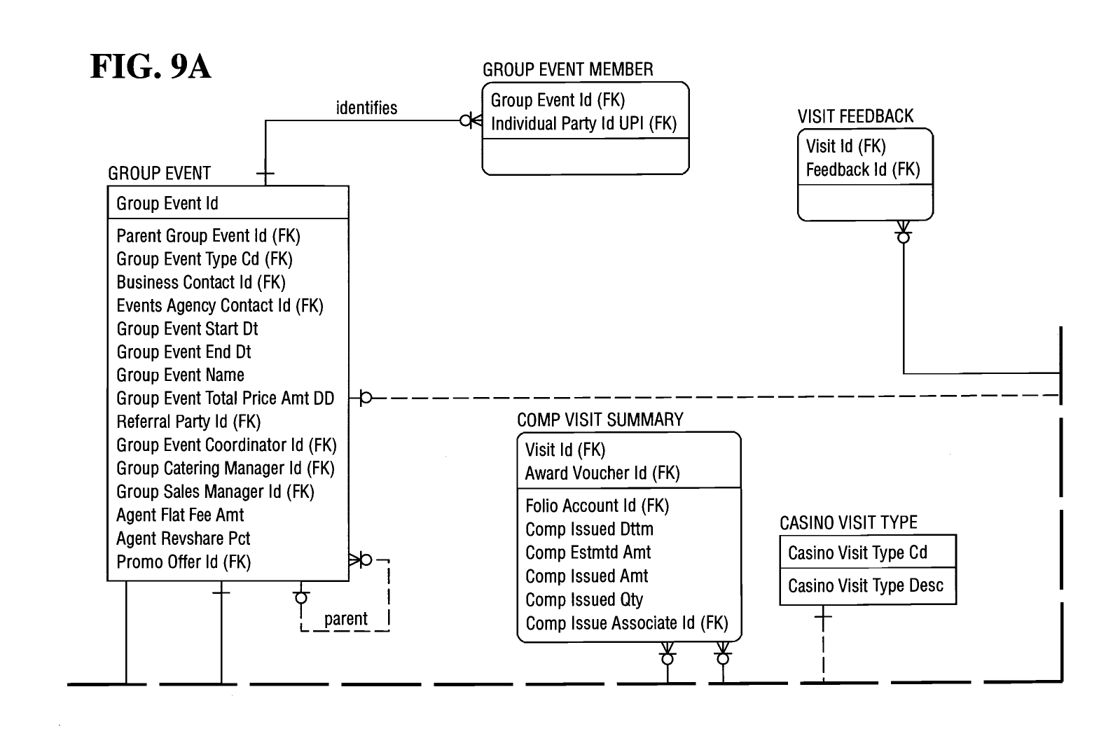

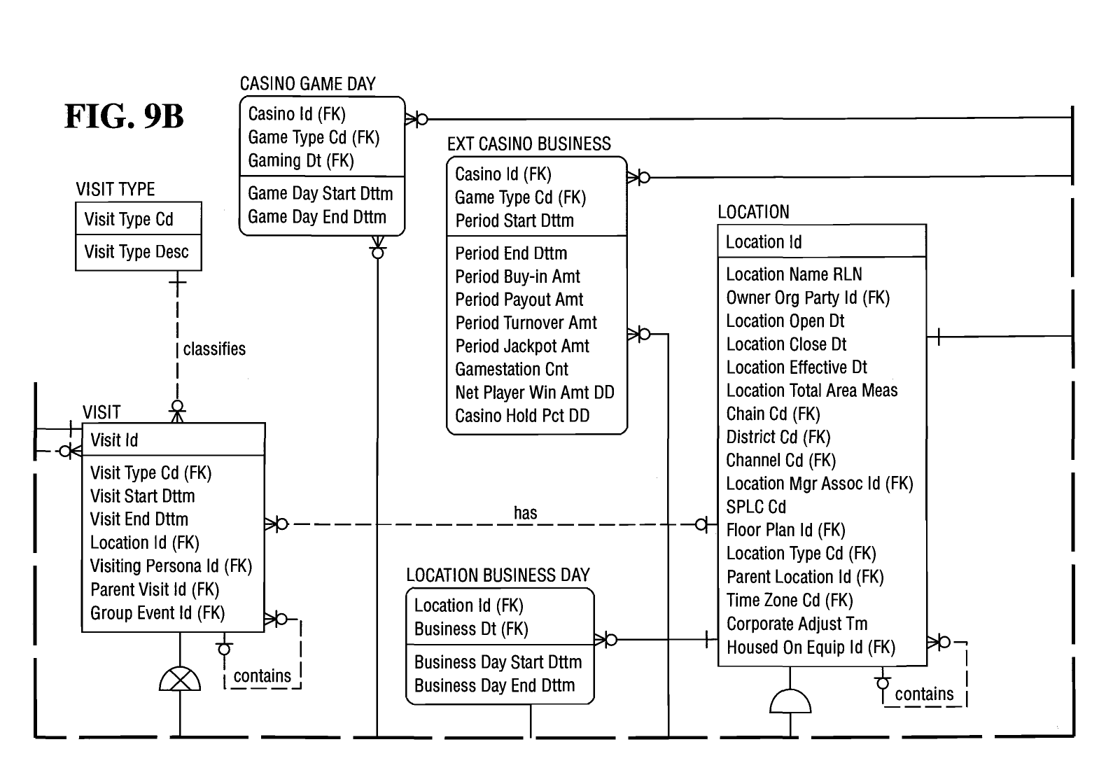

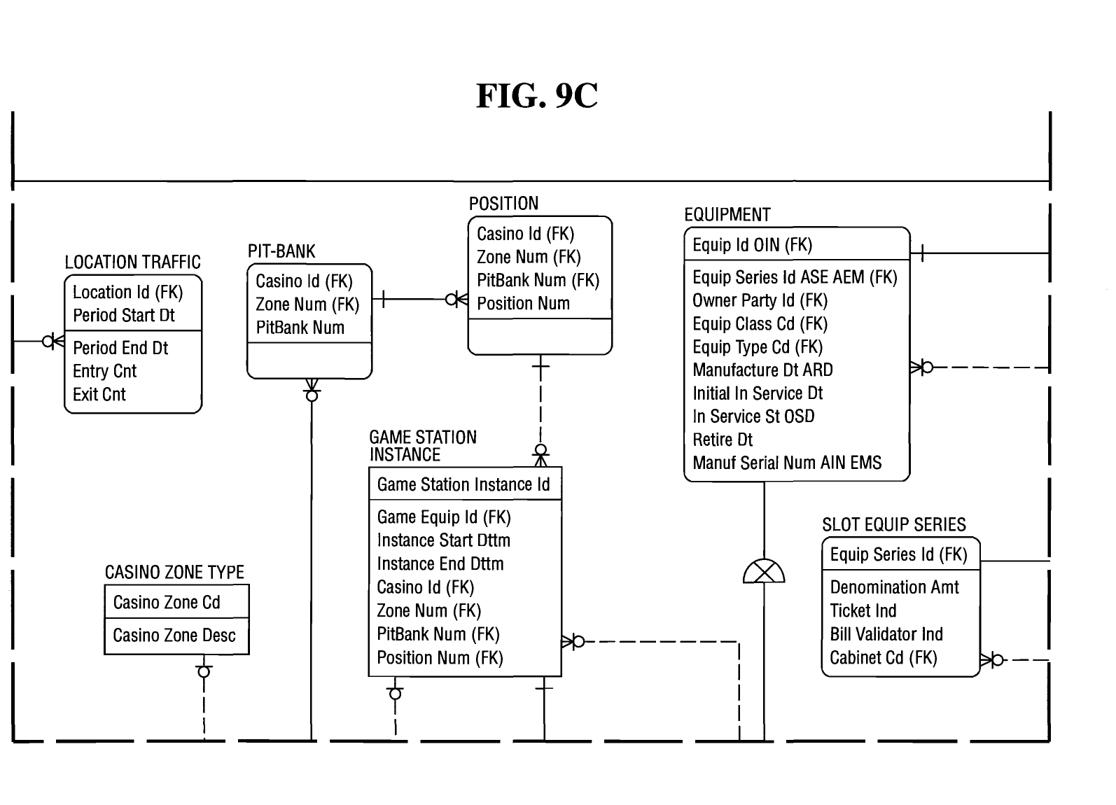

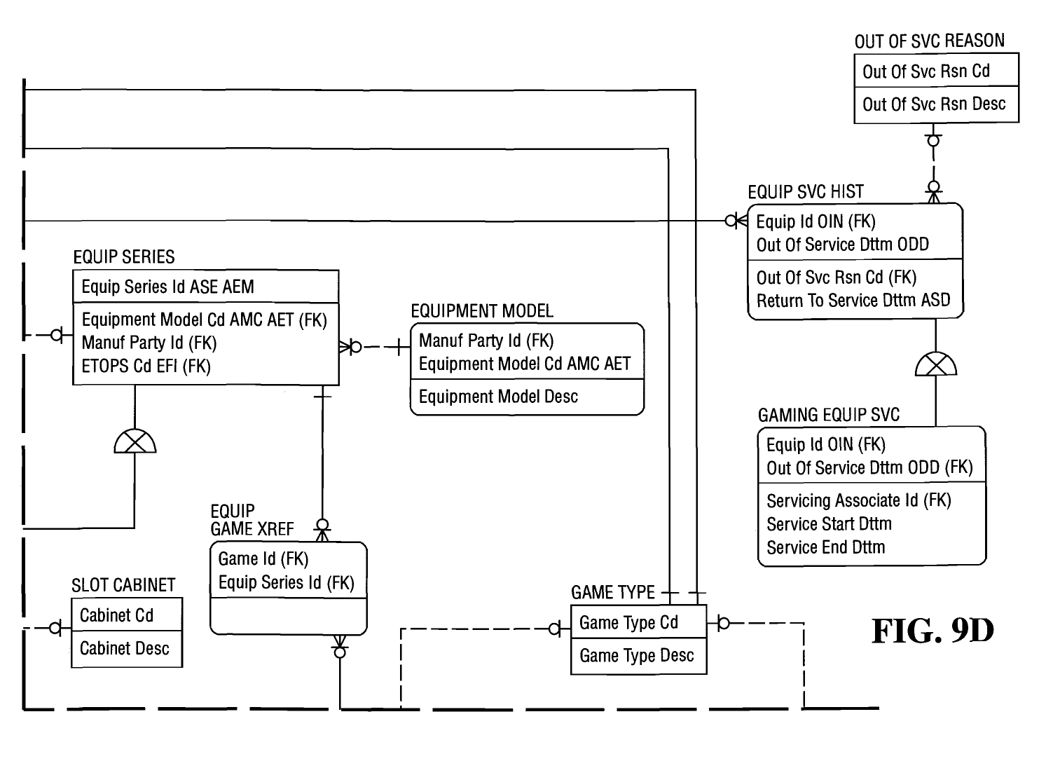

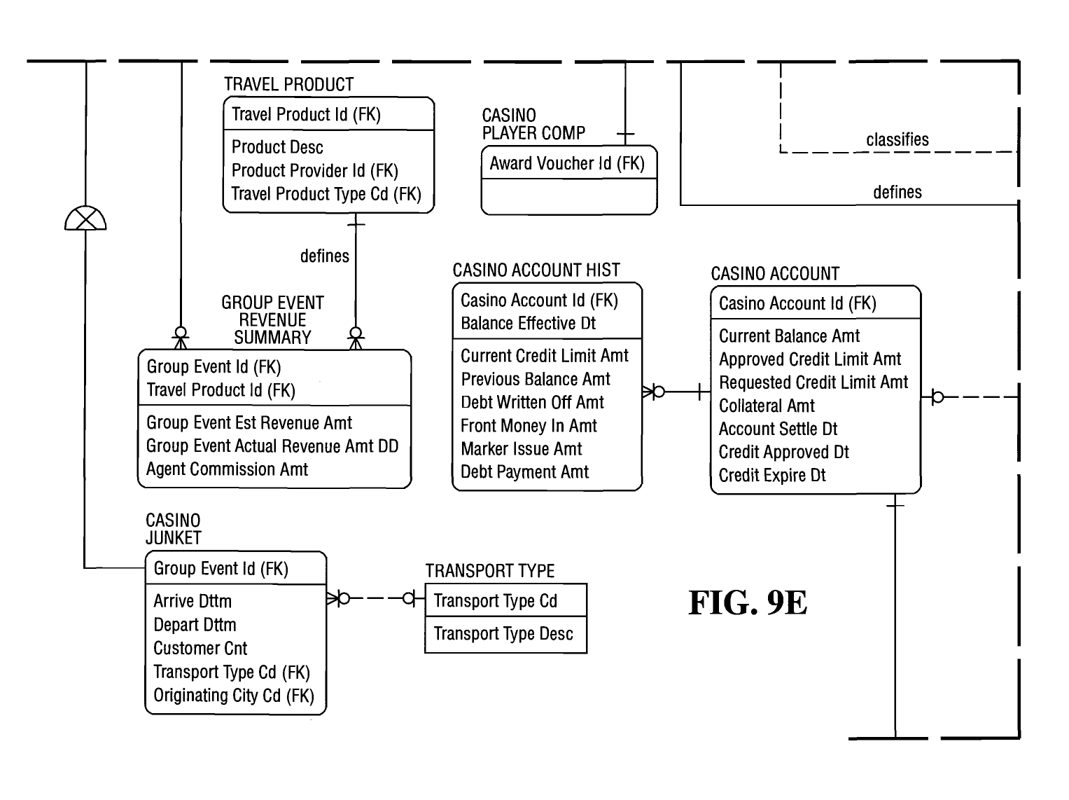

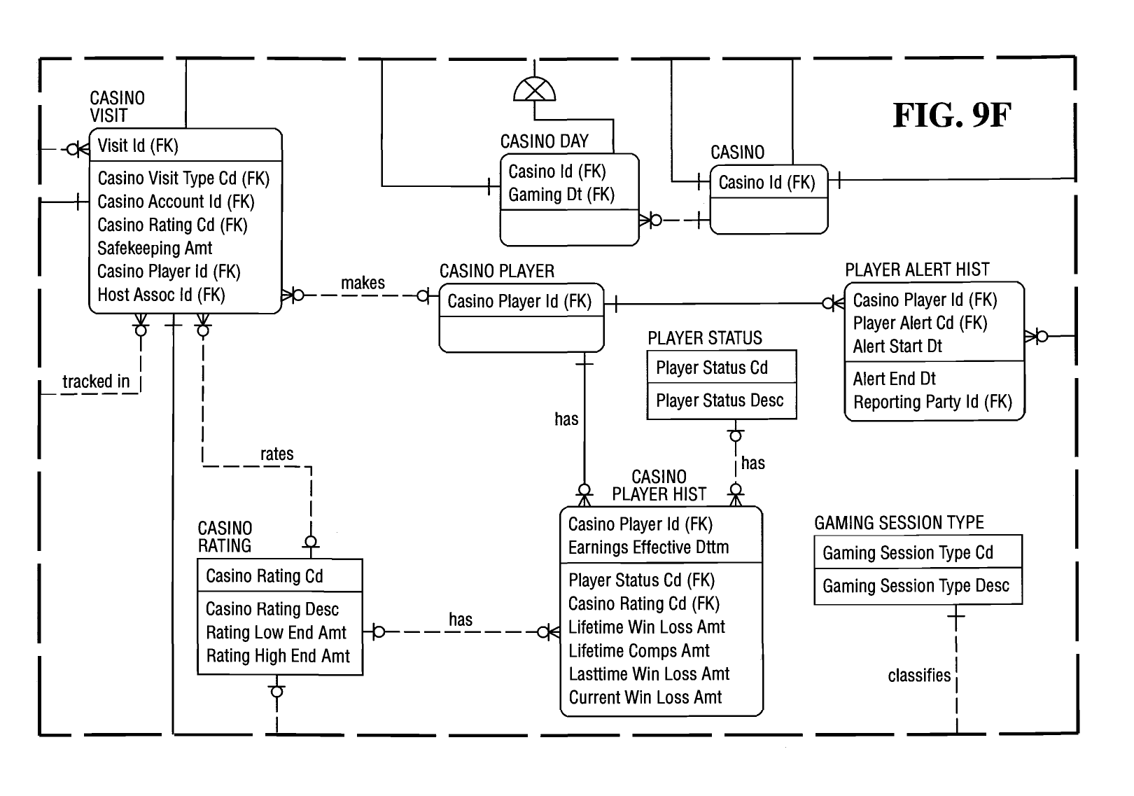

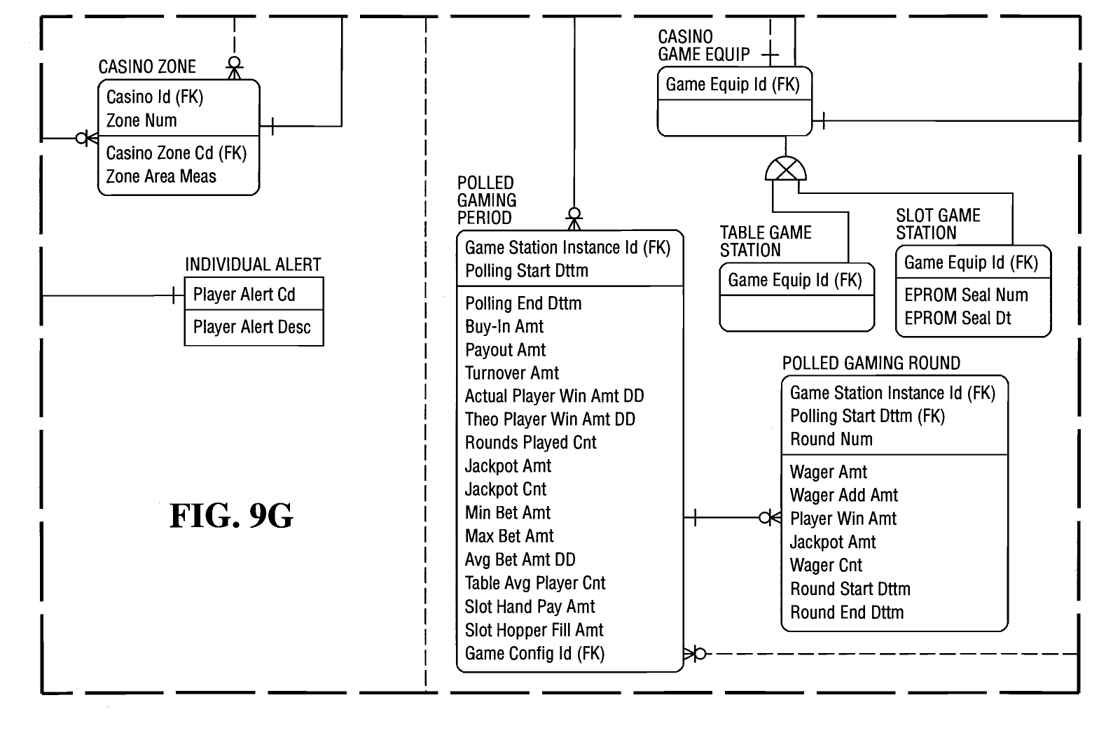

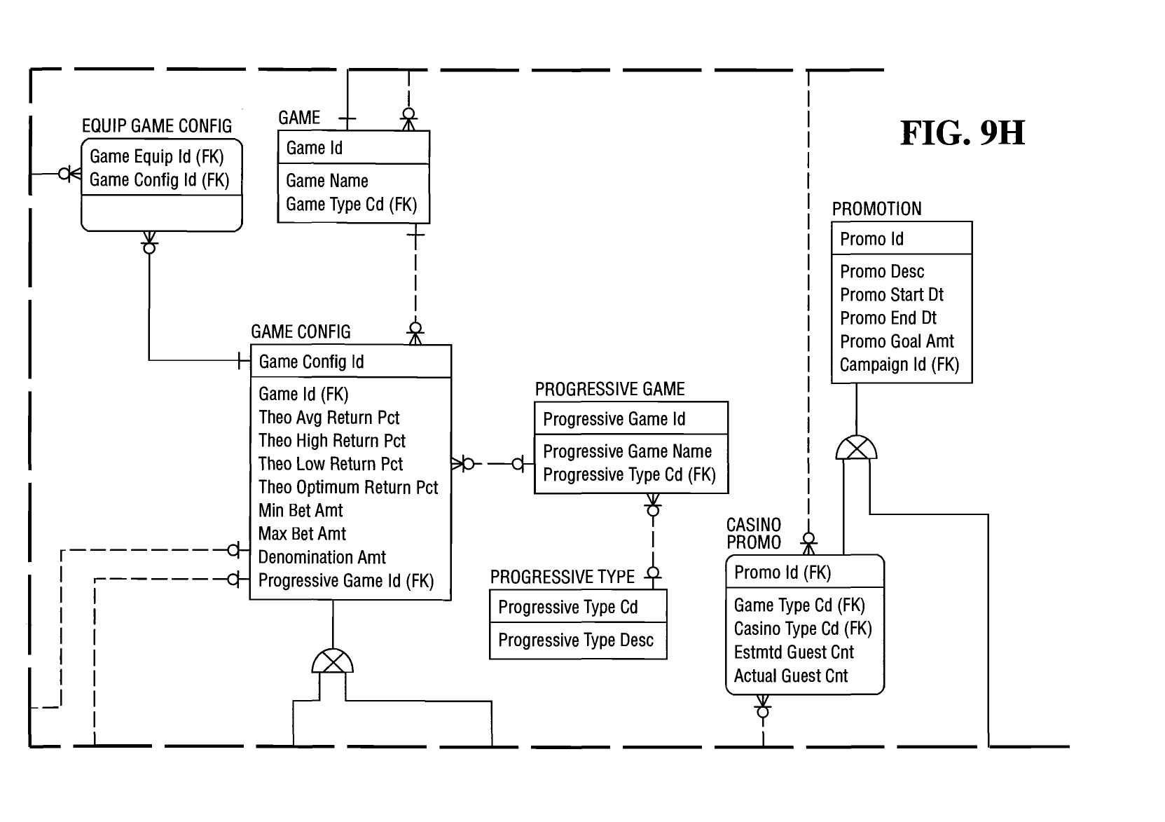

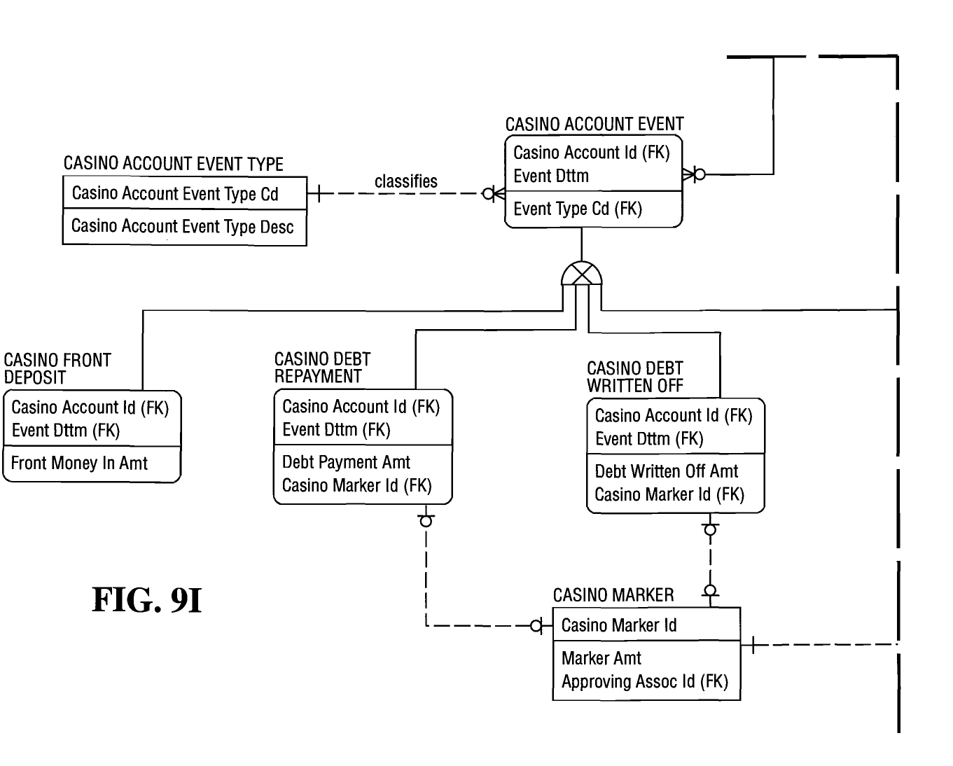

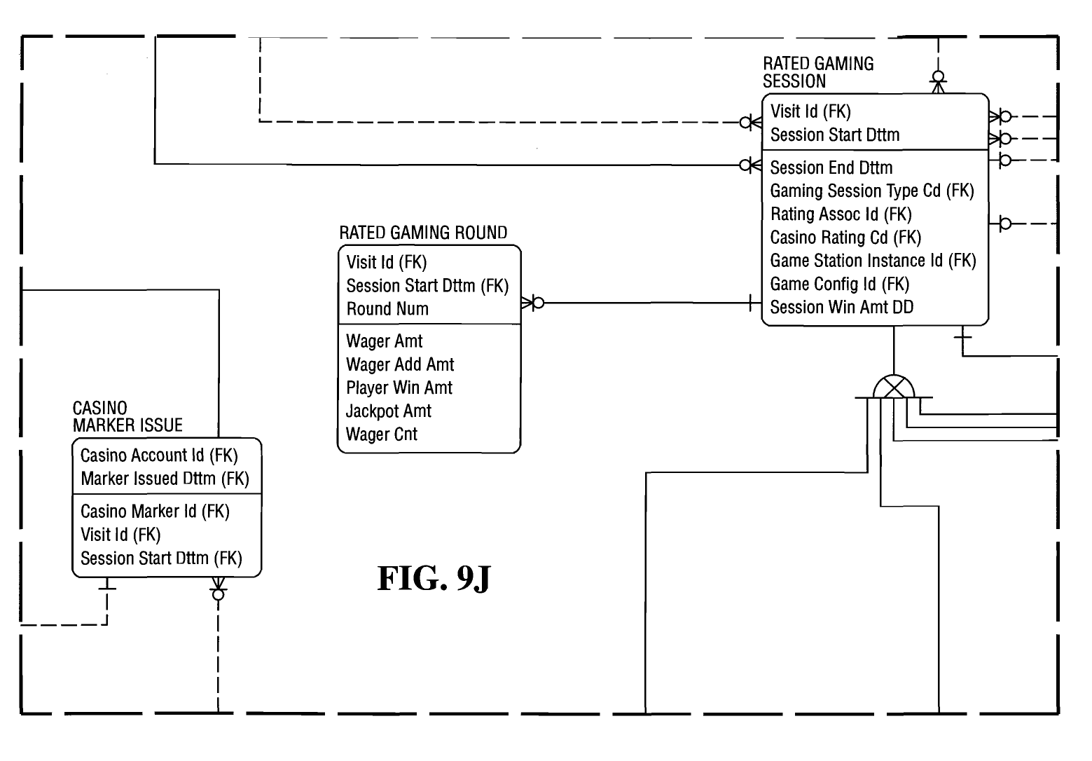

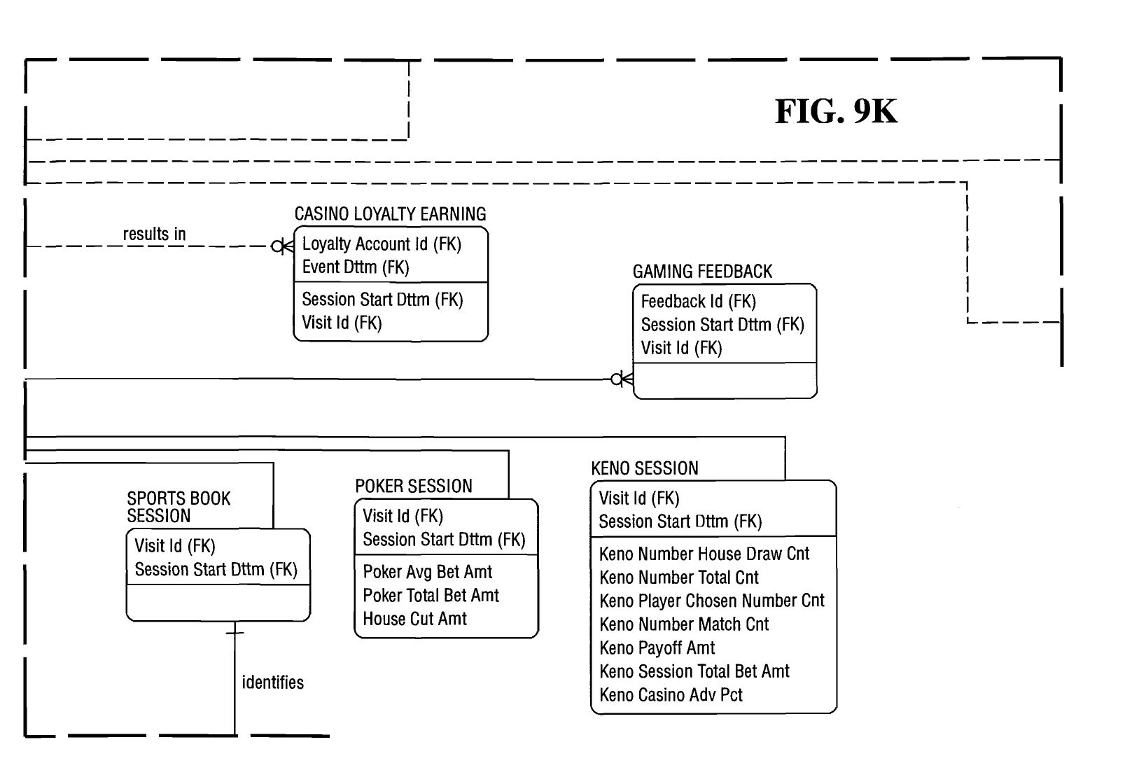

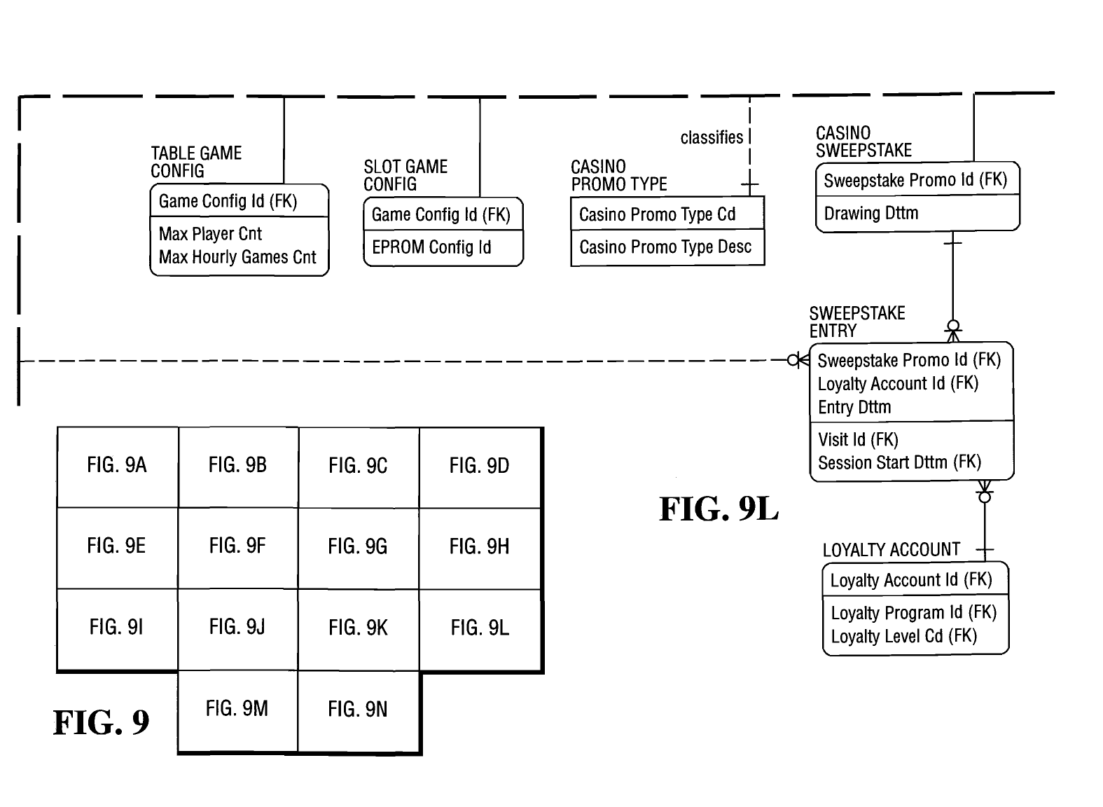

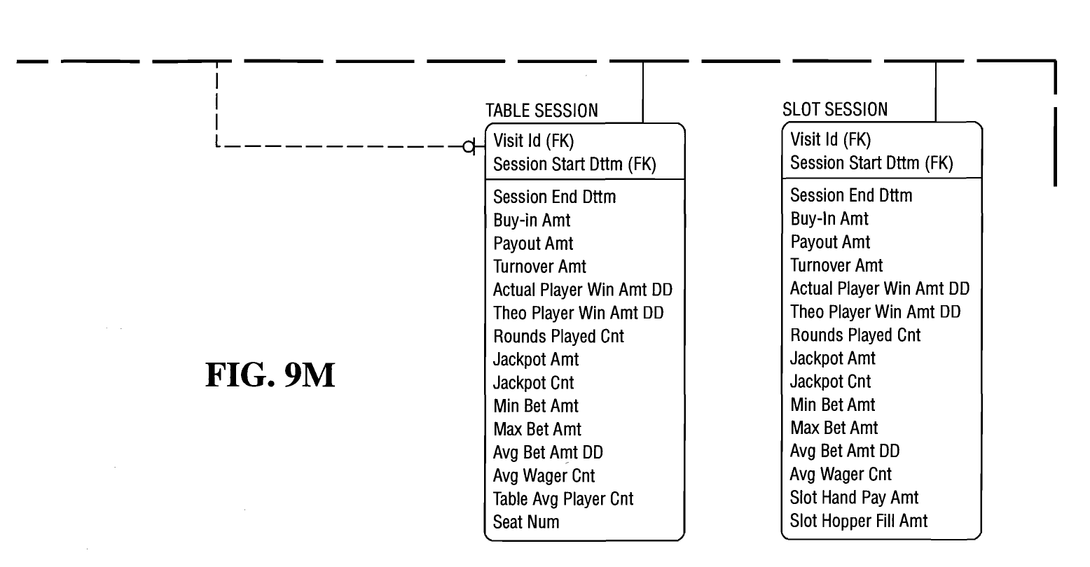

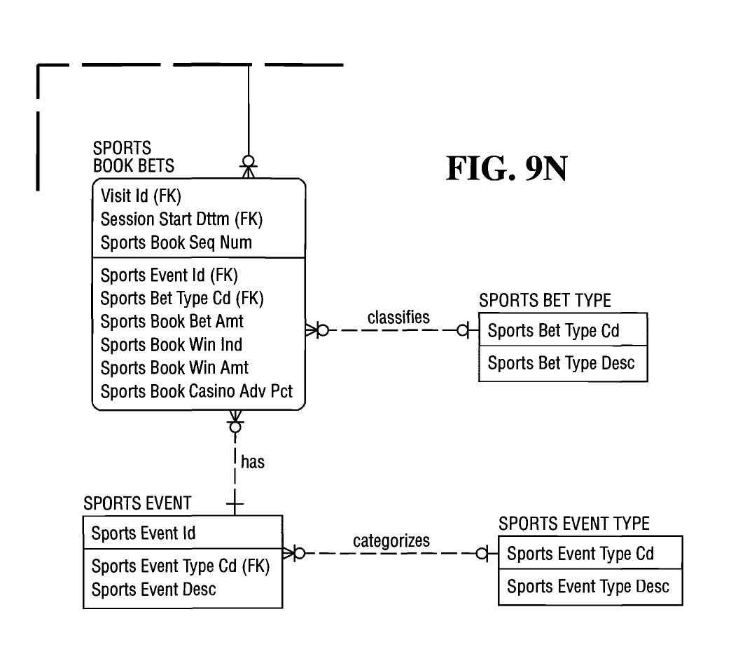

CASINO (OVERVIEW) Subject Area, illustrated in FIG. 9;

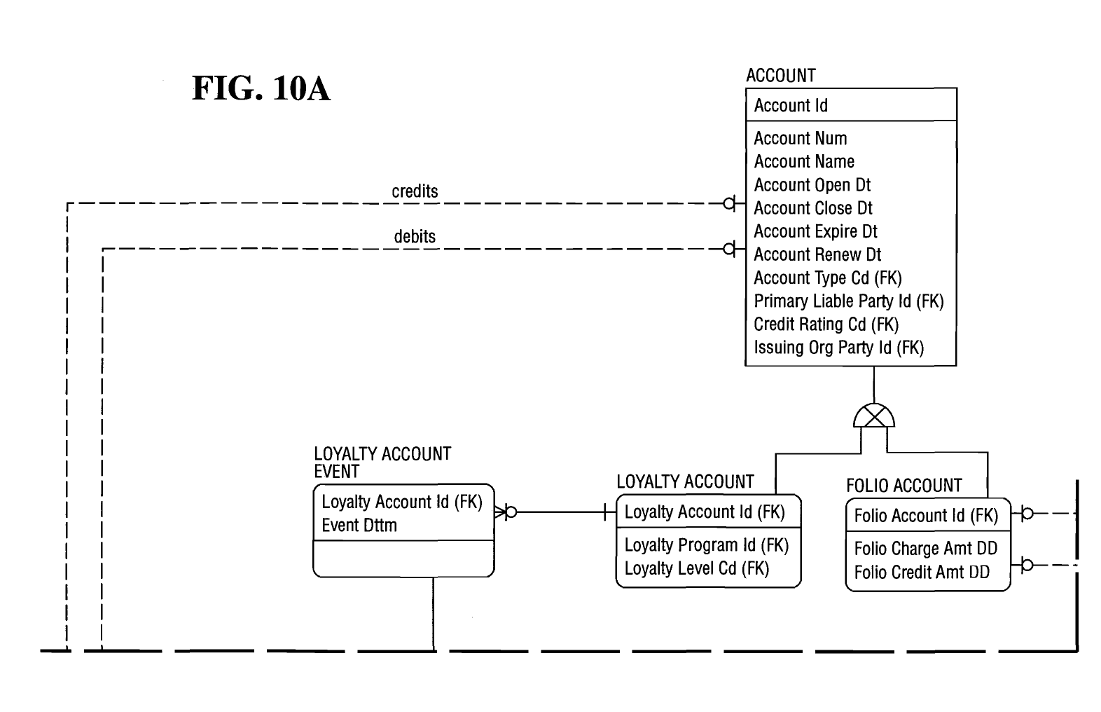

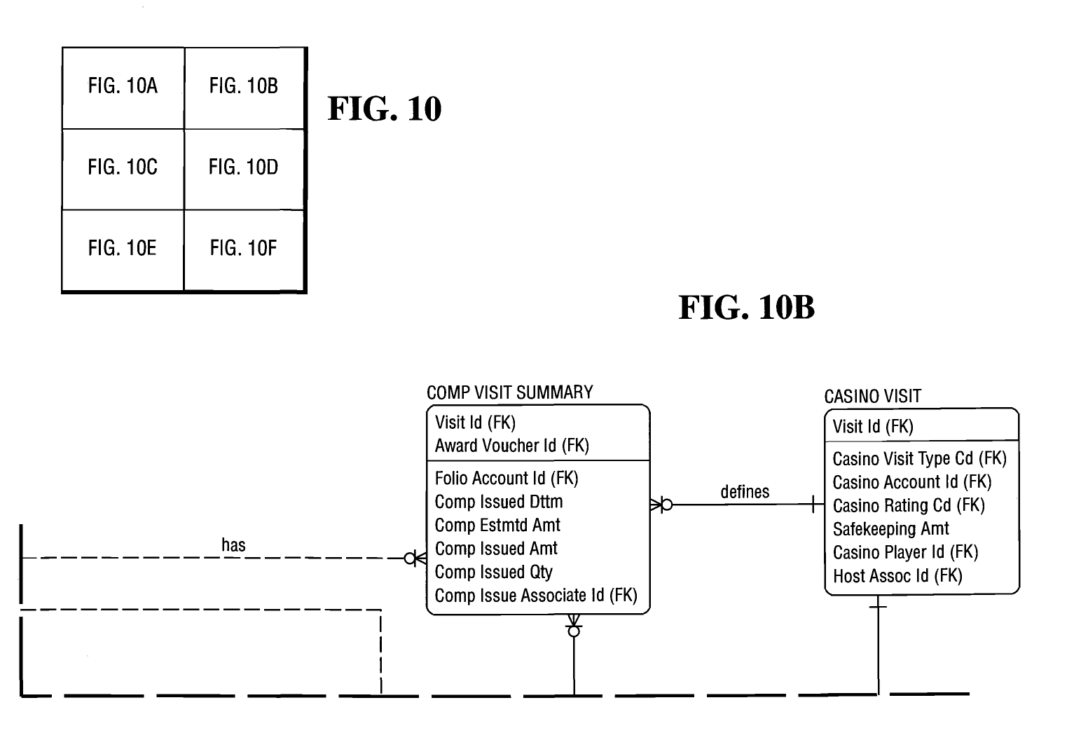

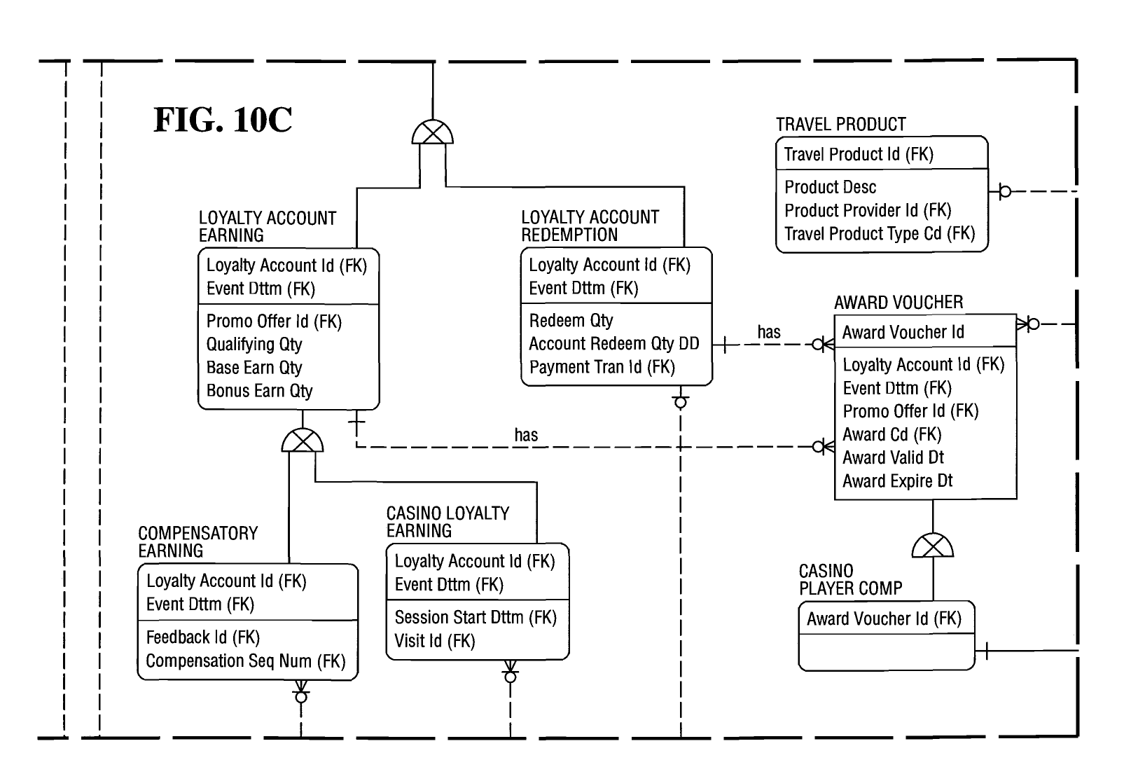

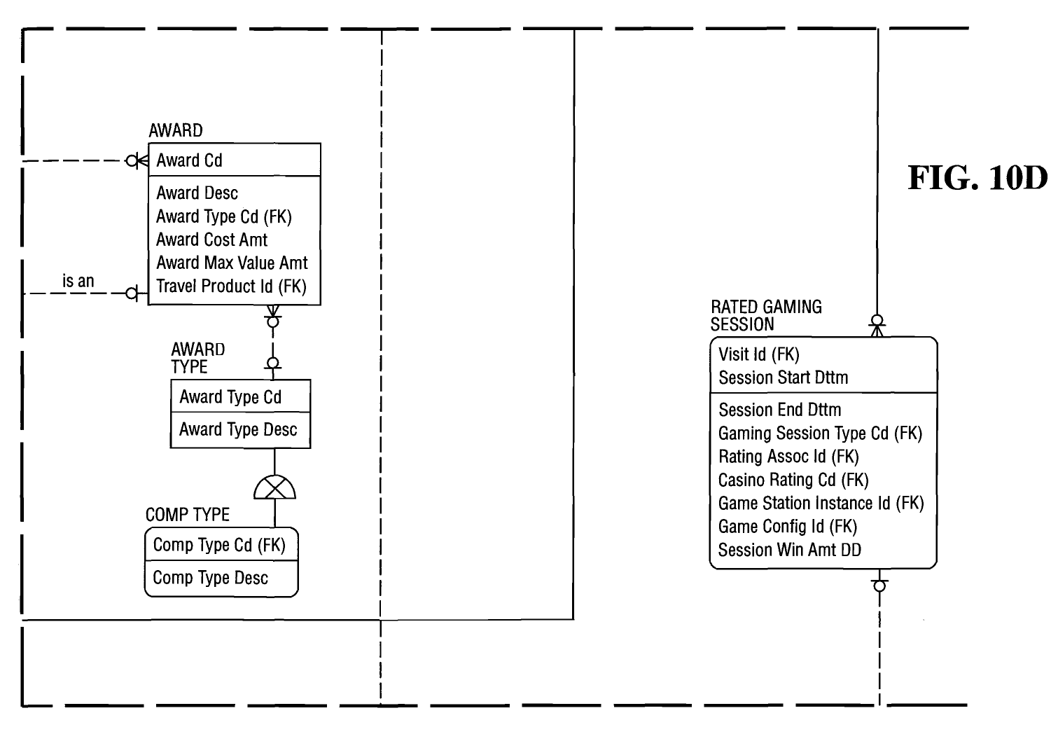

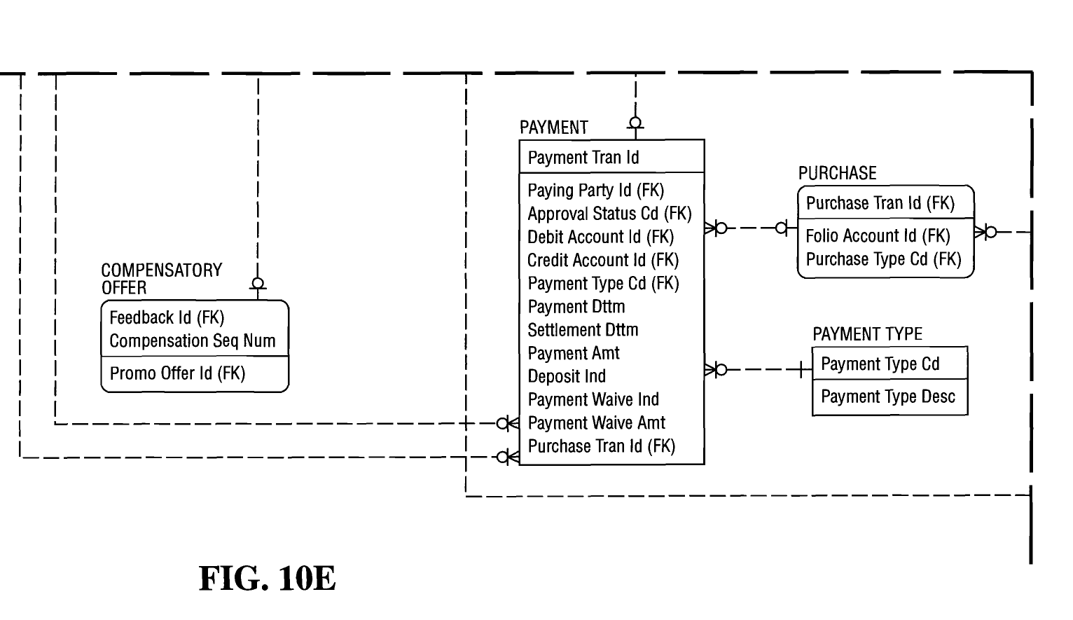

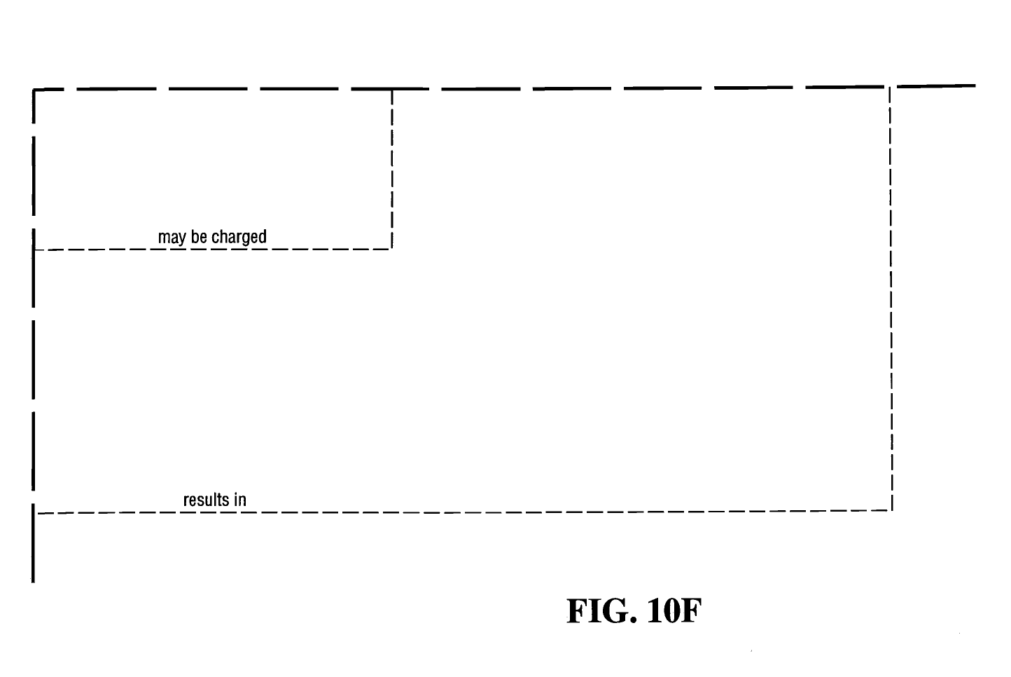

CASINO COMPS Subject Area, illustrated in FIG. 10;

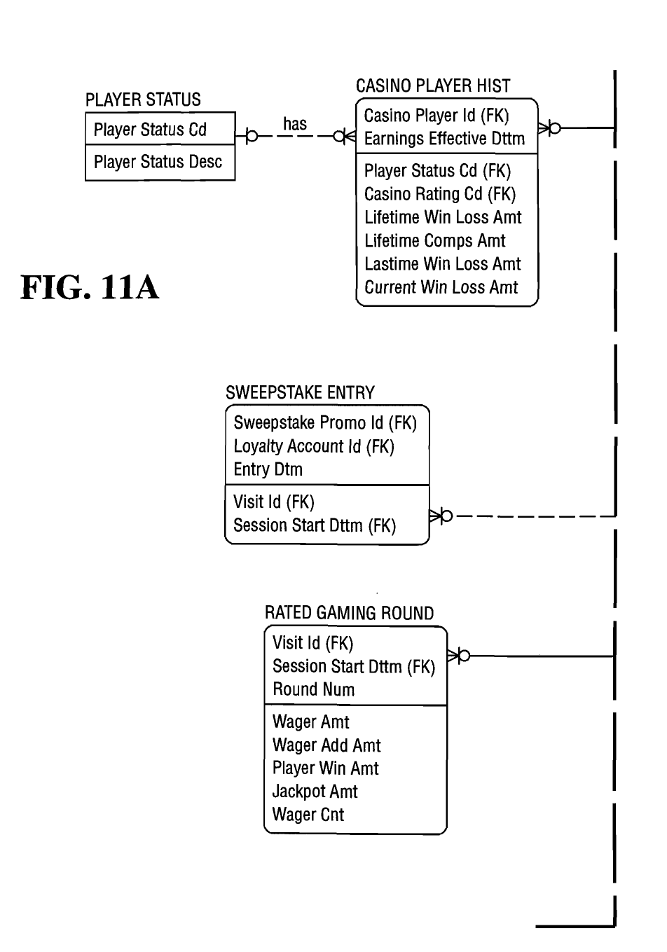

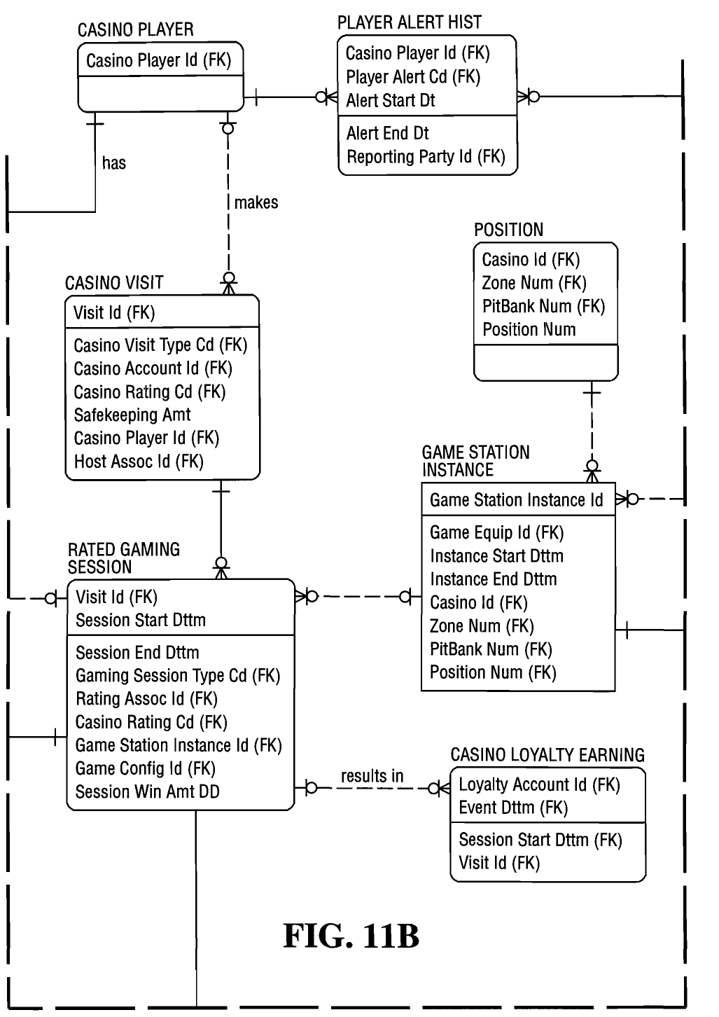

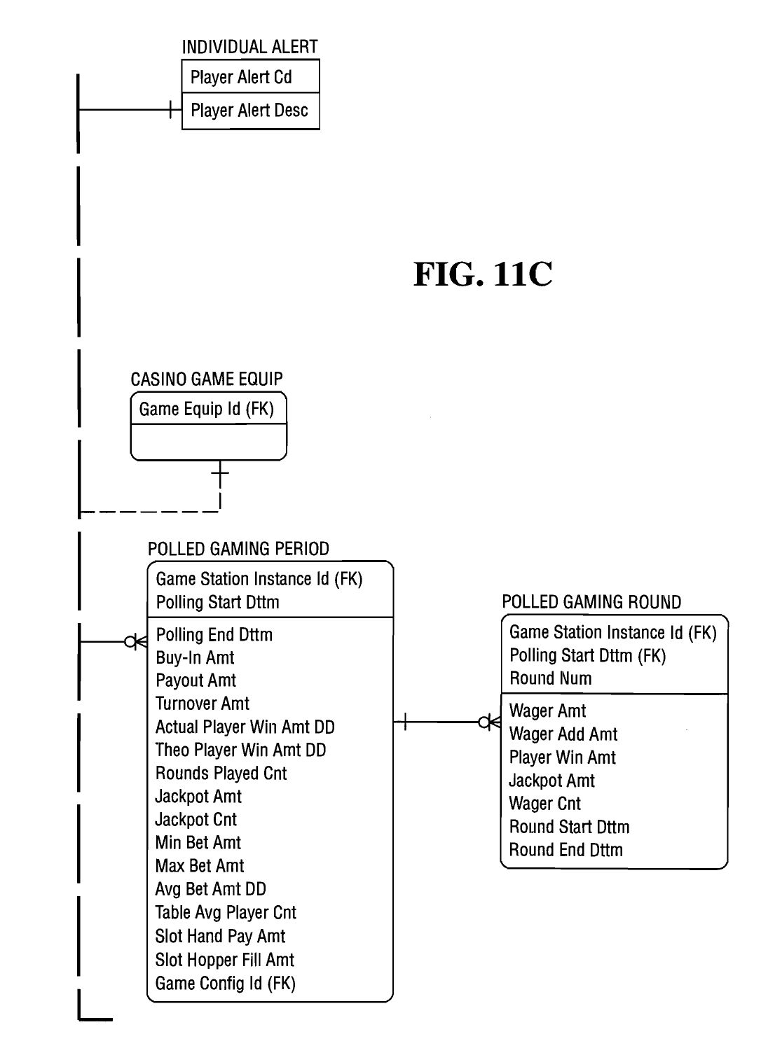

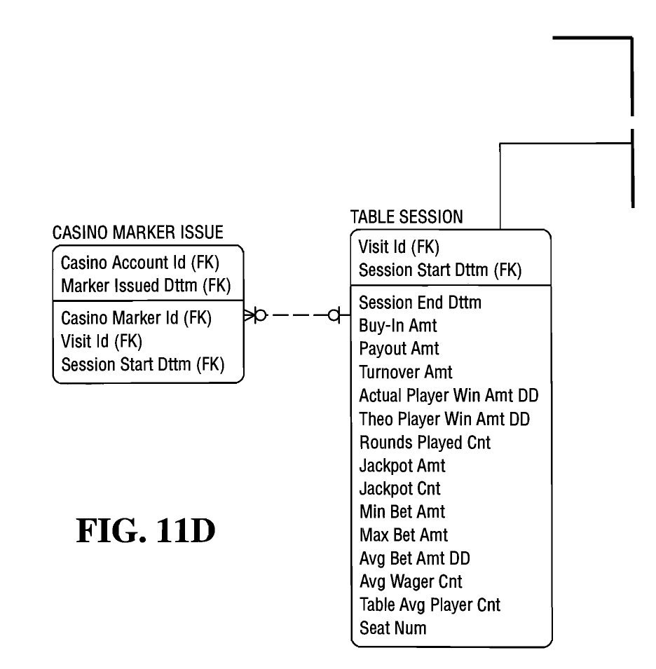

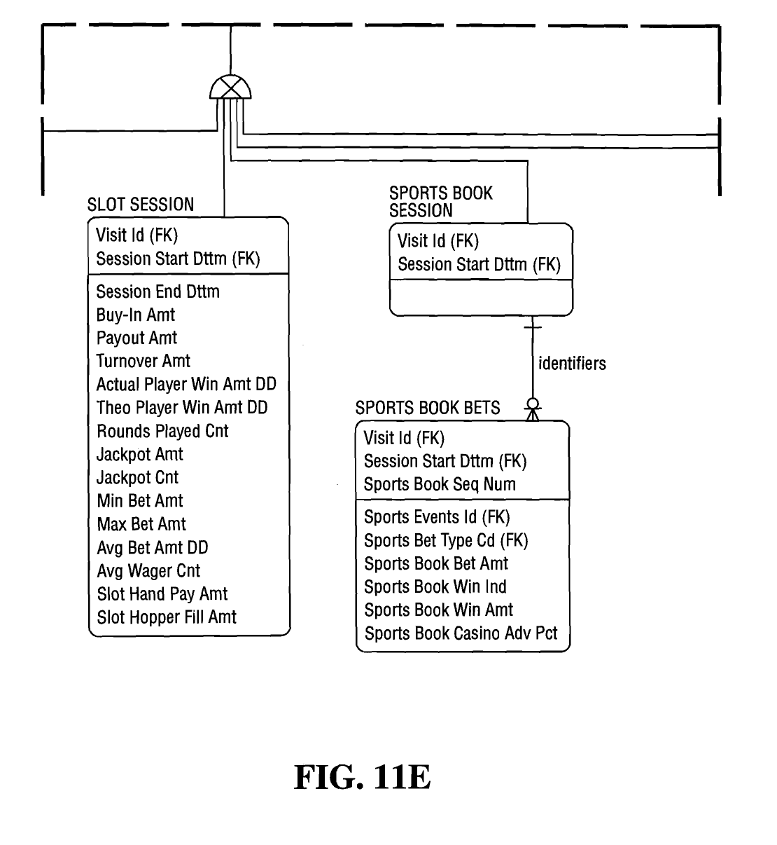

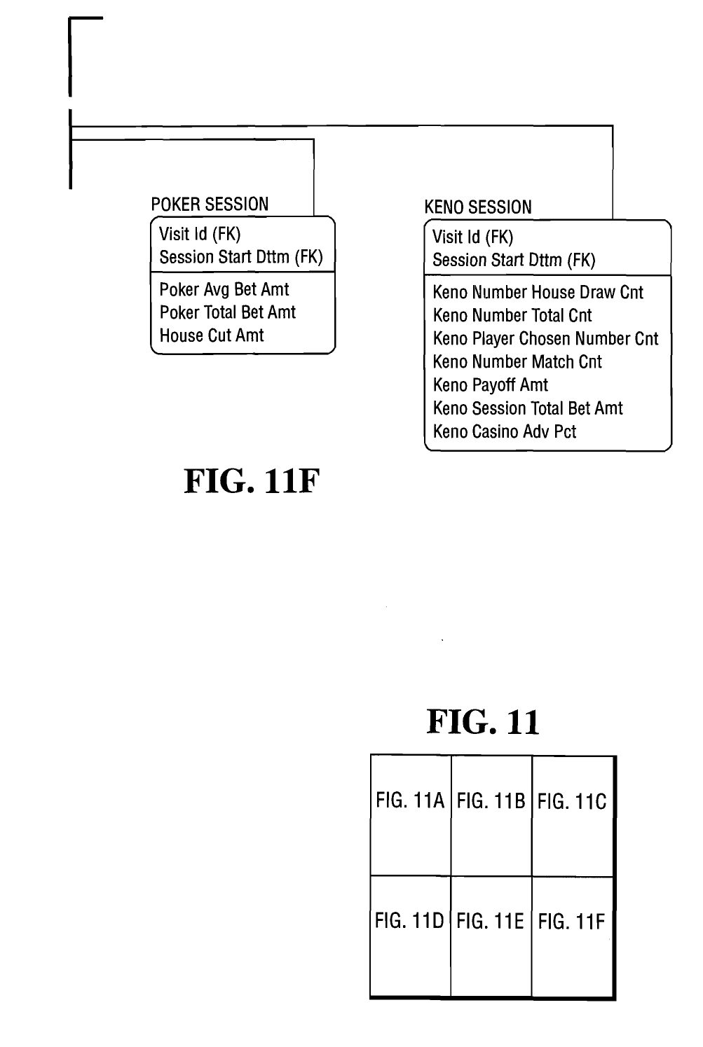

CASINO GAME SESSIONS Subject Area, illustrated in FIG. 11;

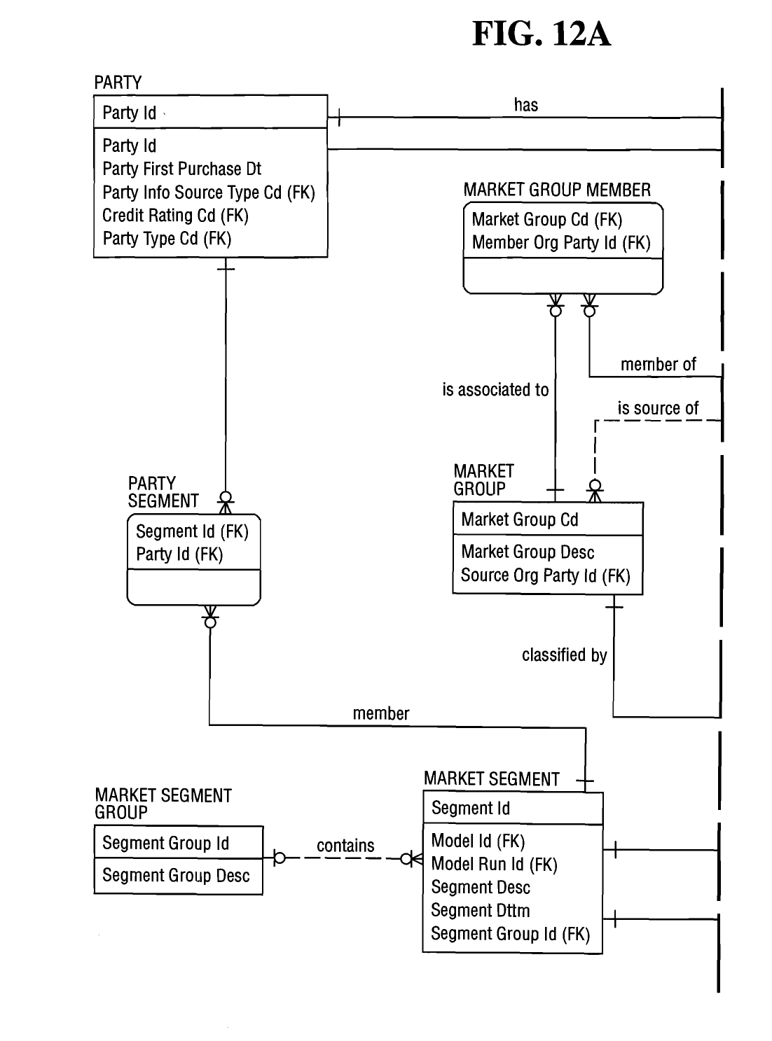

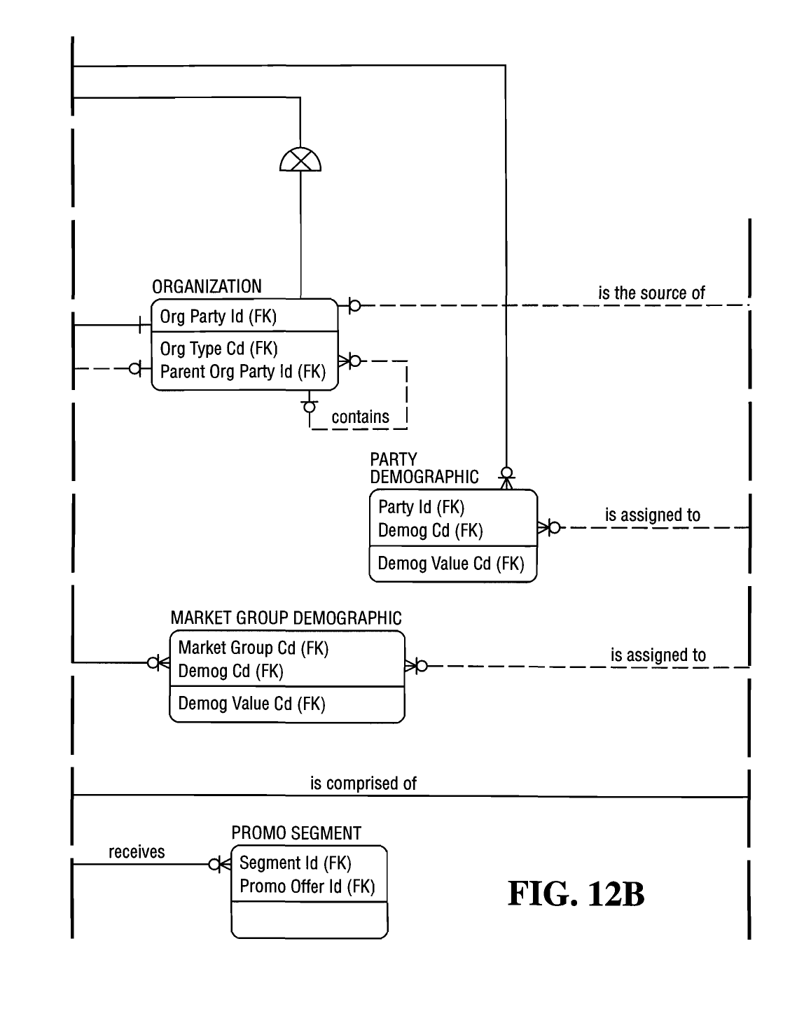

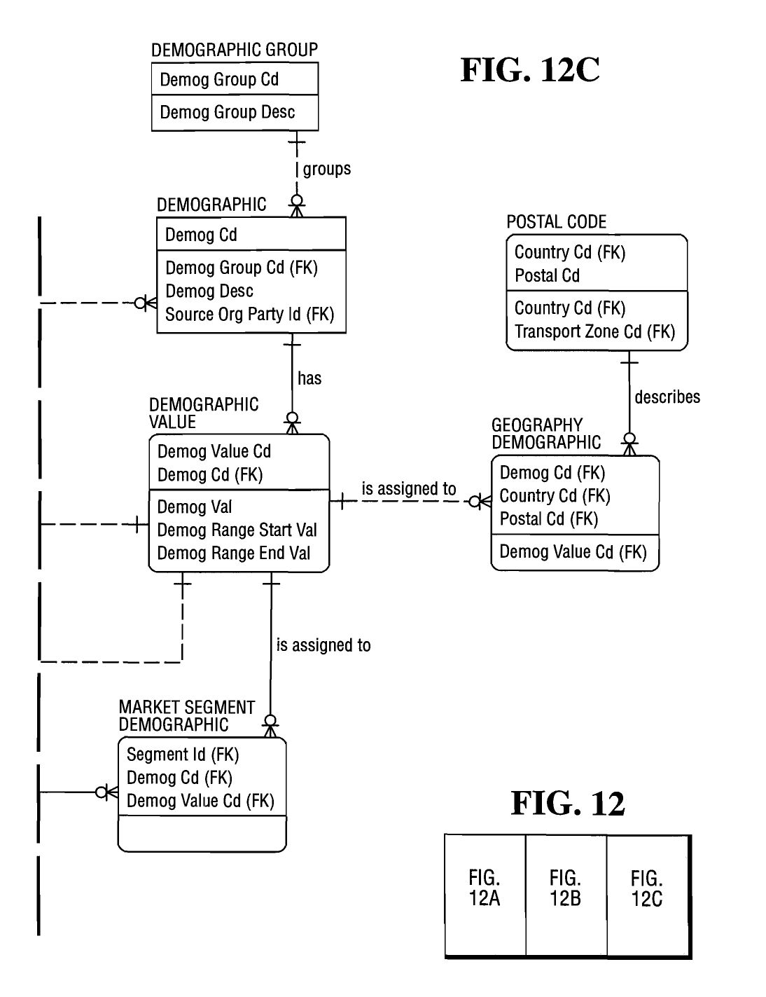

DEMOGRAPHICS Subject Area, illustrated in FIG. 12;

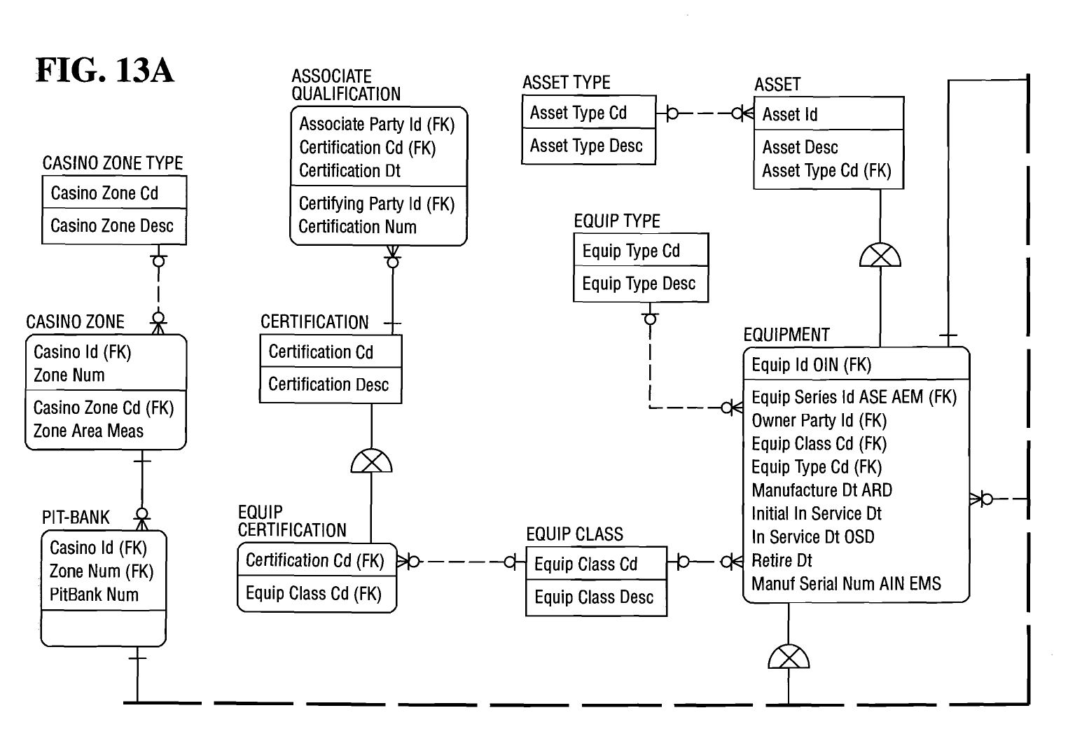

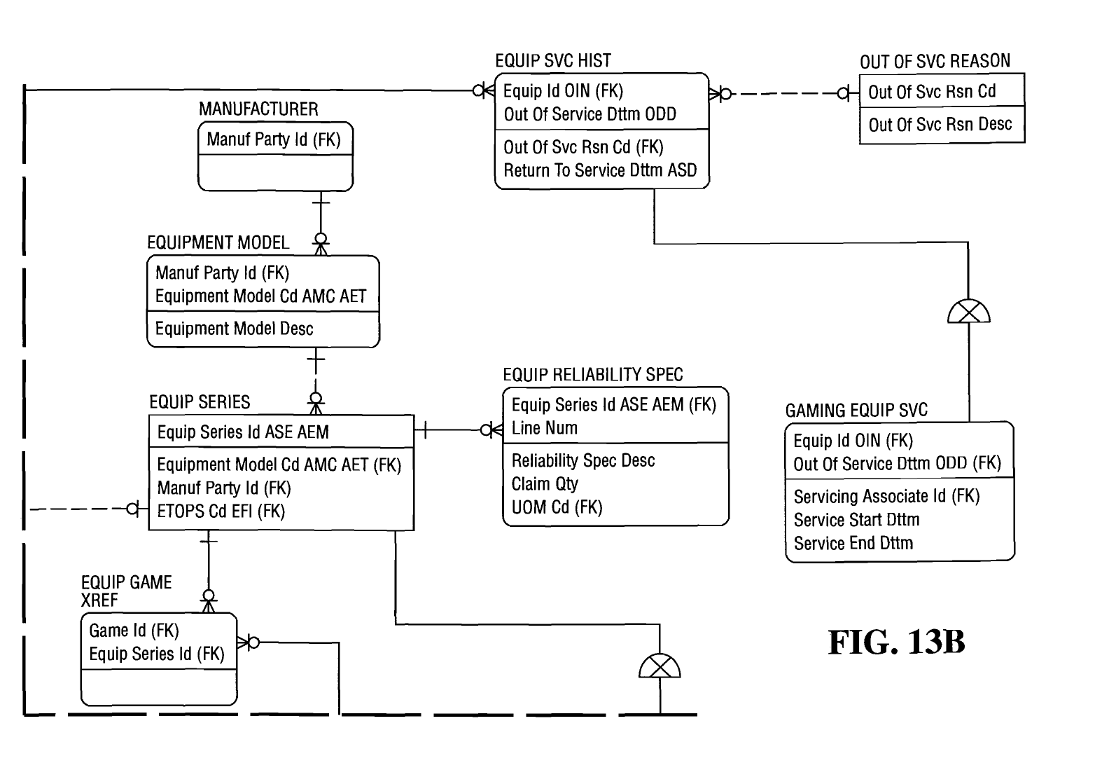

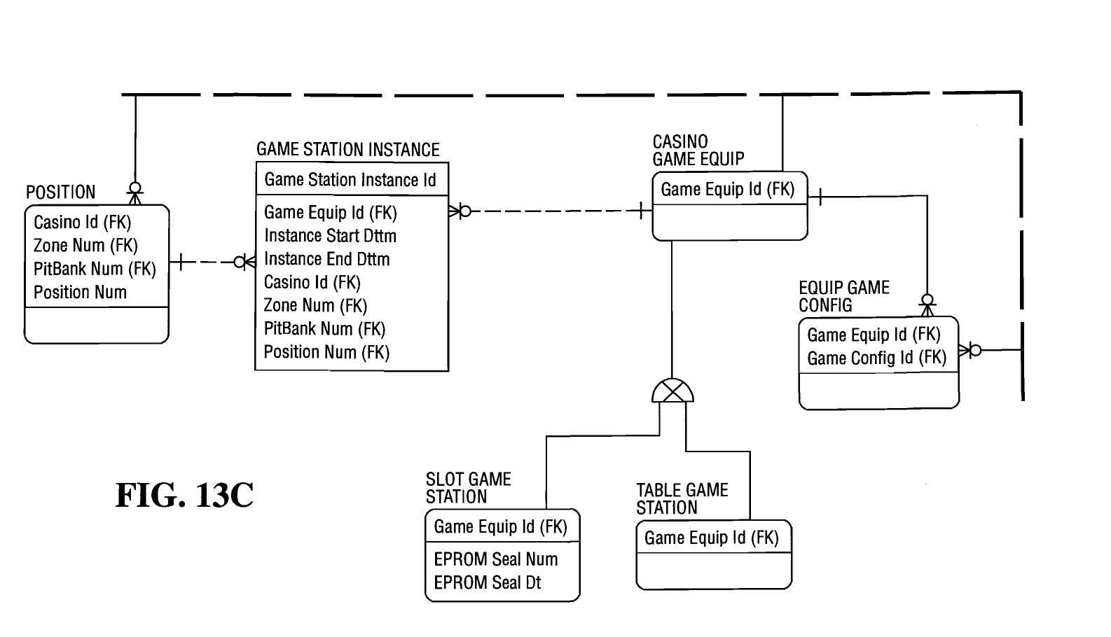

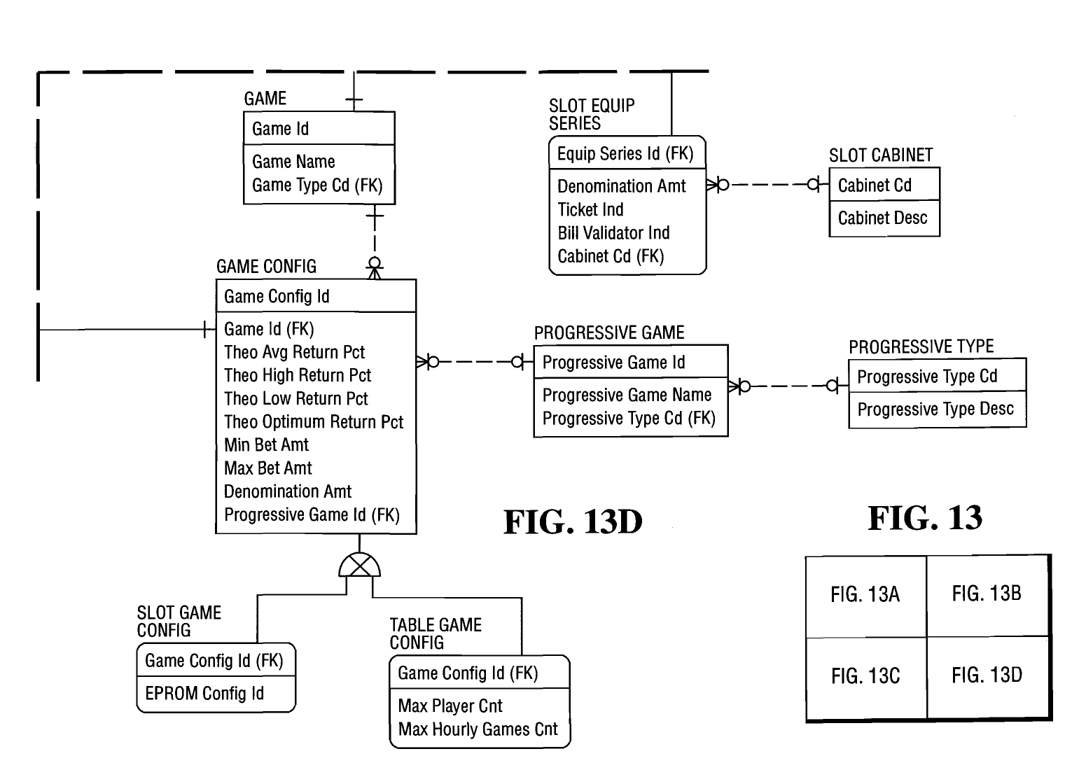

EQUIPMENT Subject Area, illustrated in FIG. 13;

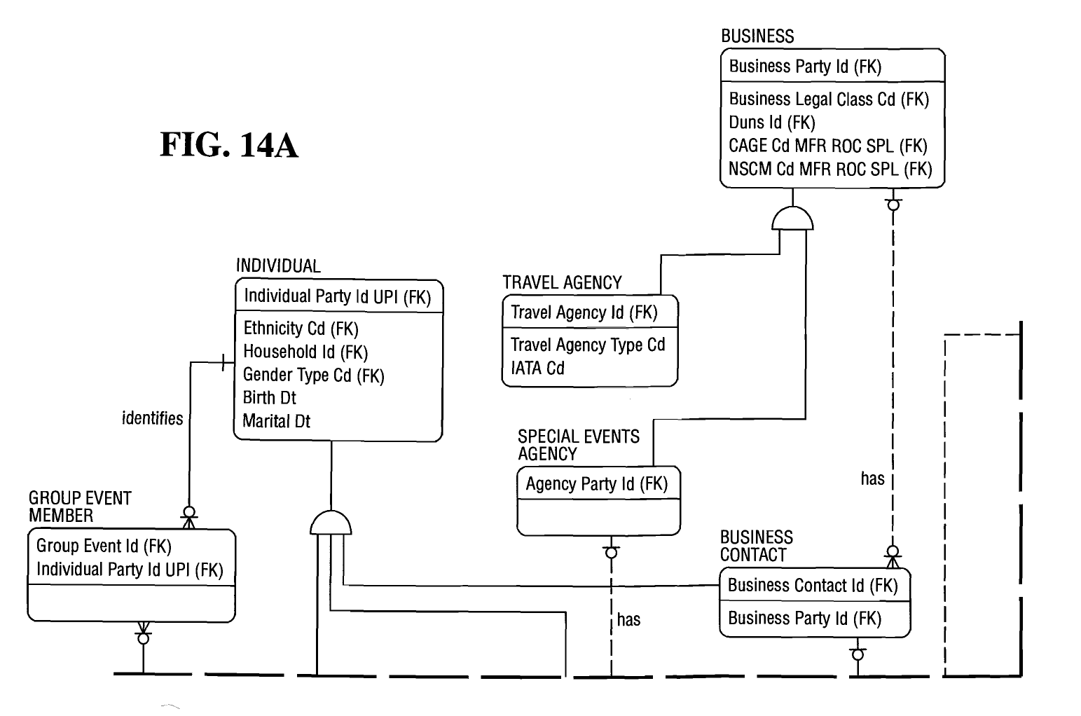

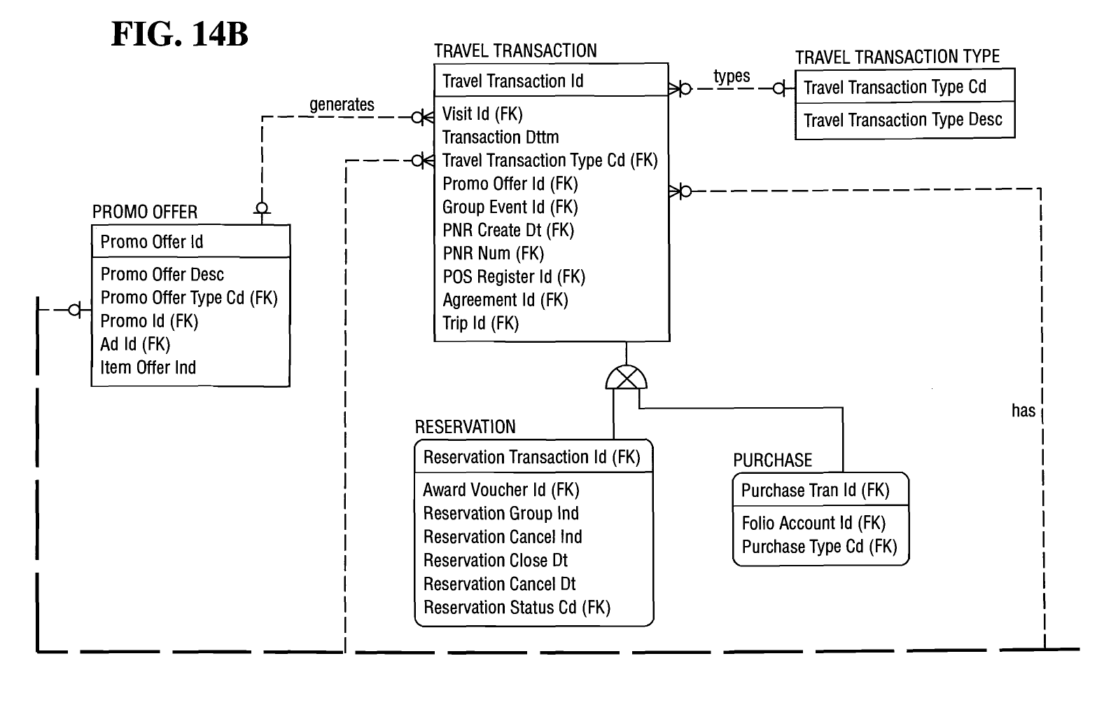

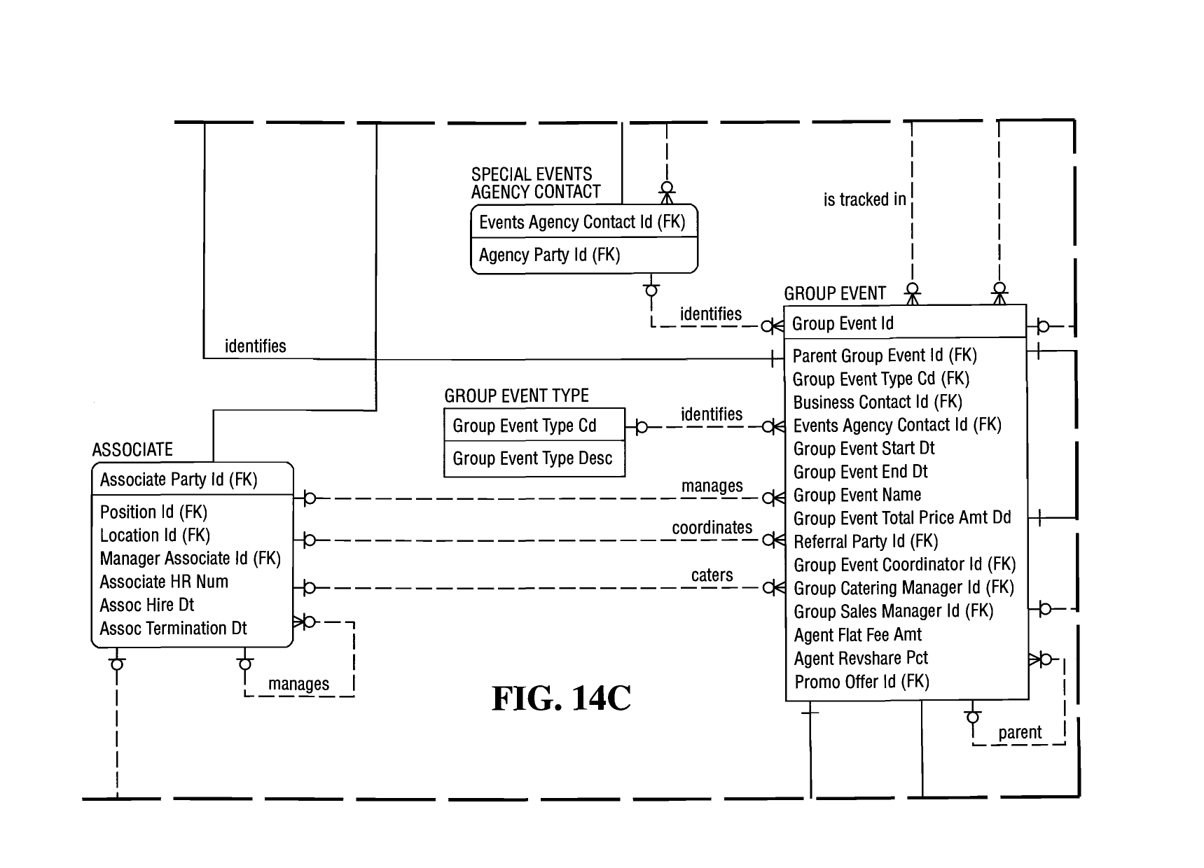

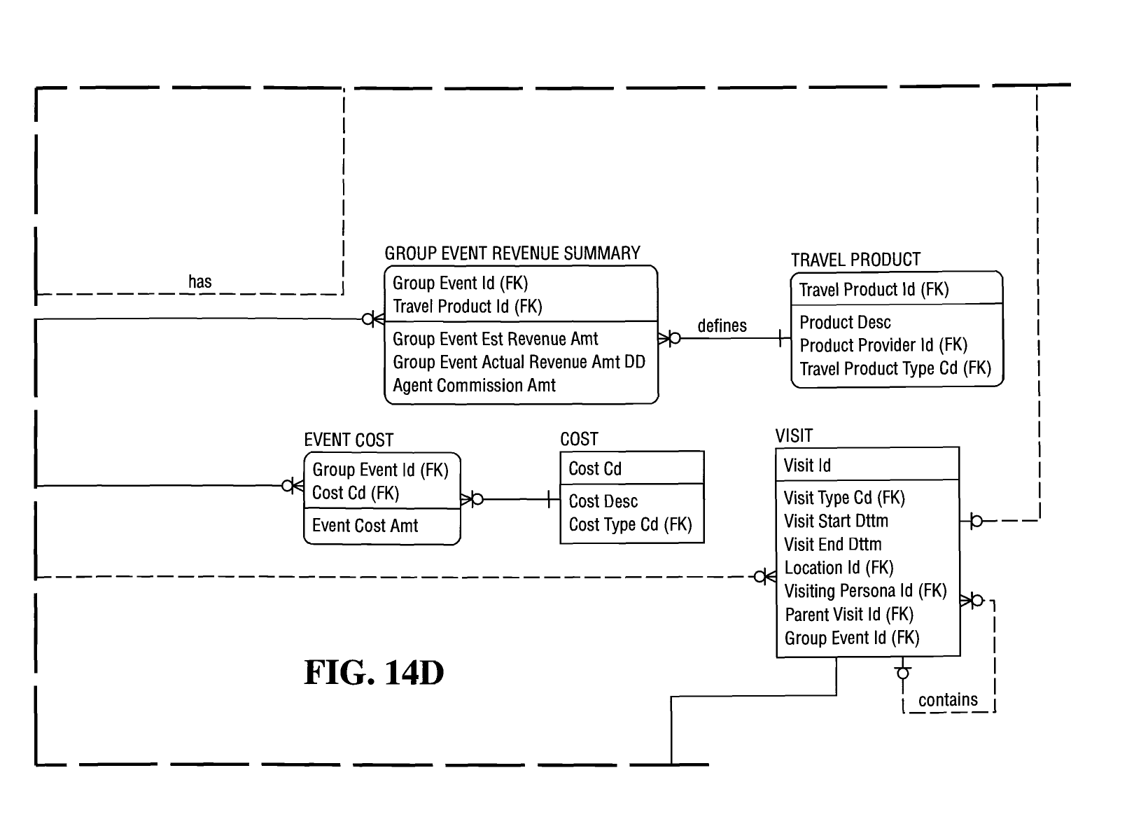

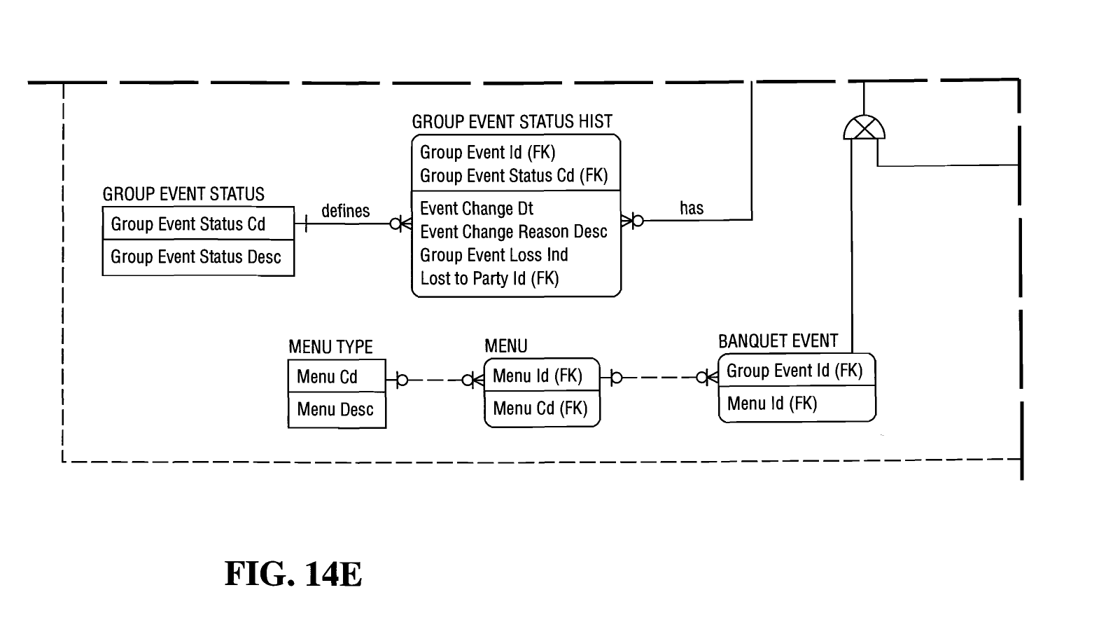

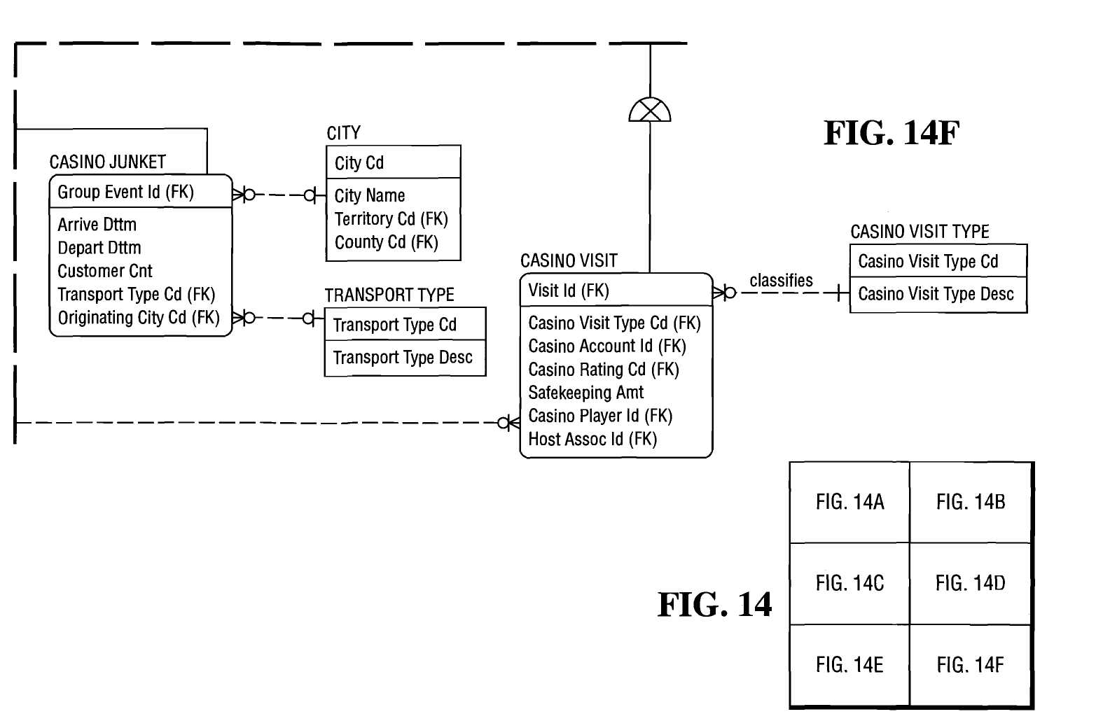

HOSPITALITY GROUP EVENT Subject Area, illustrated in FIG. 14;

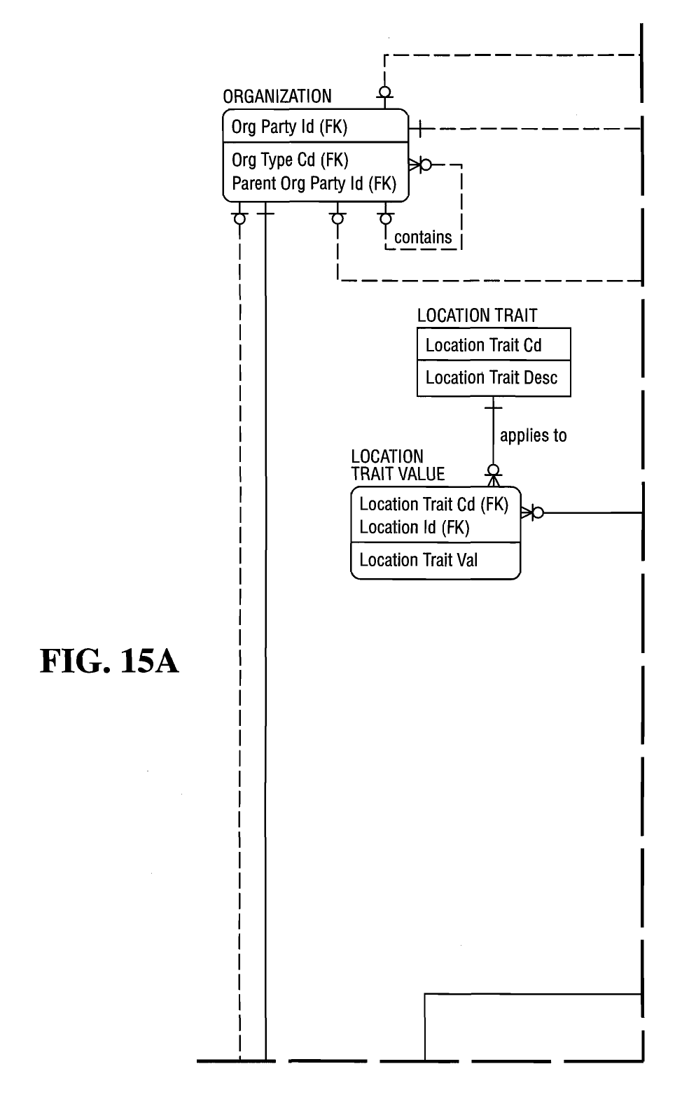

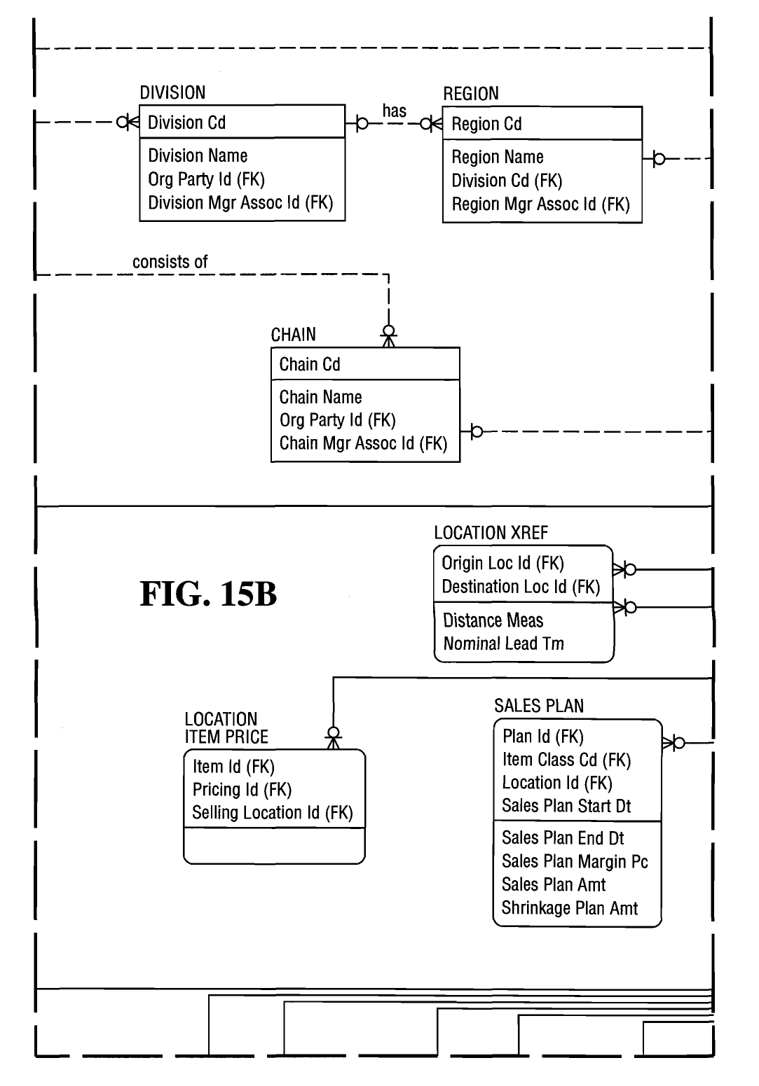

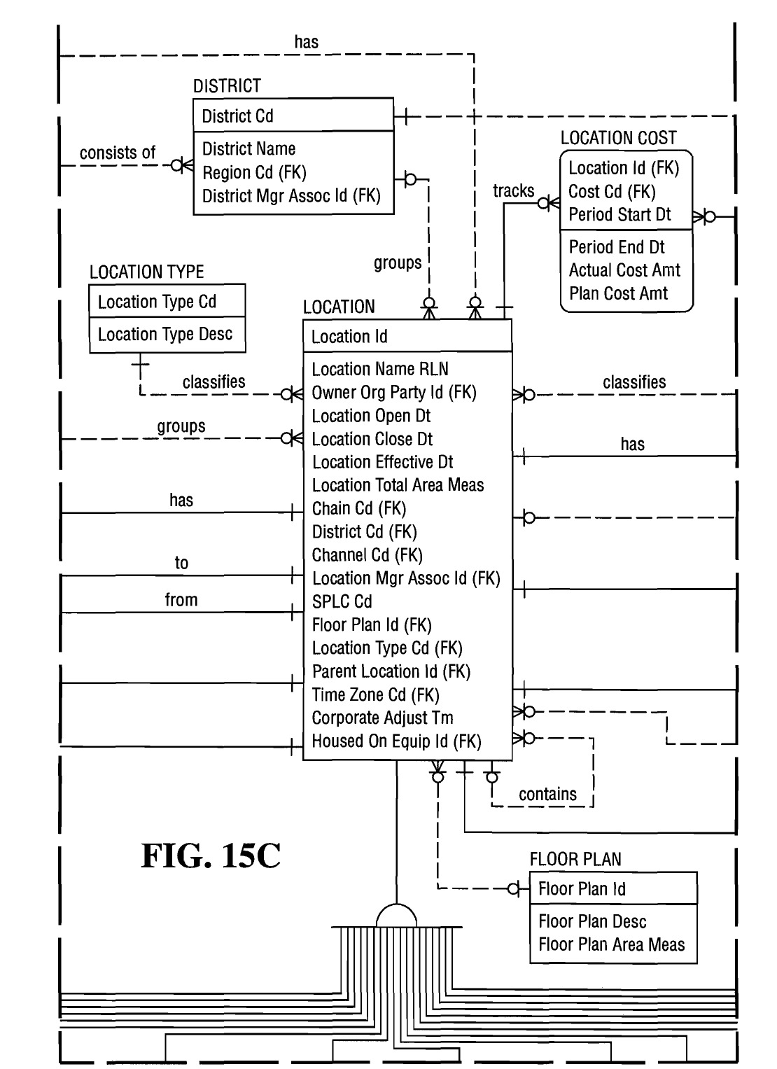

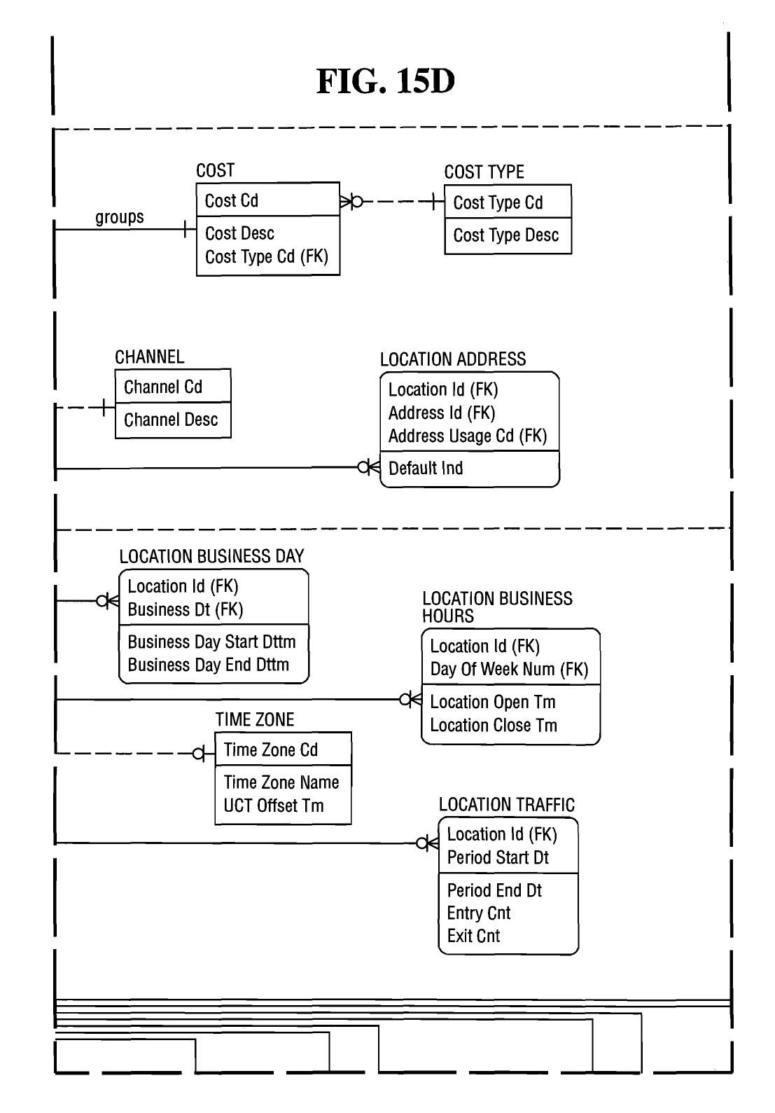

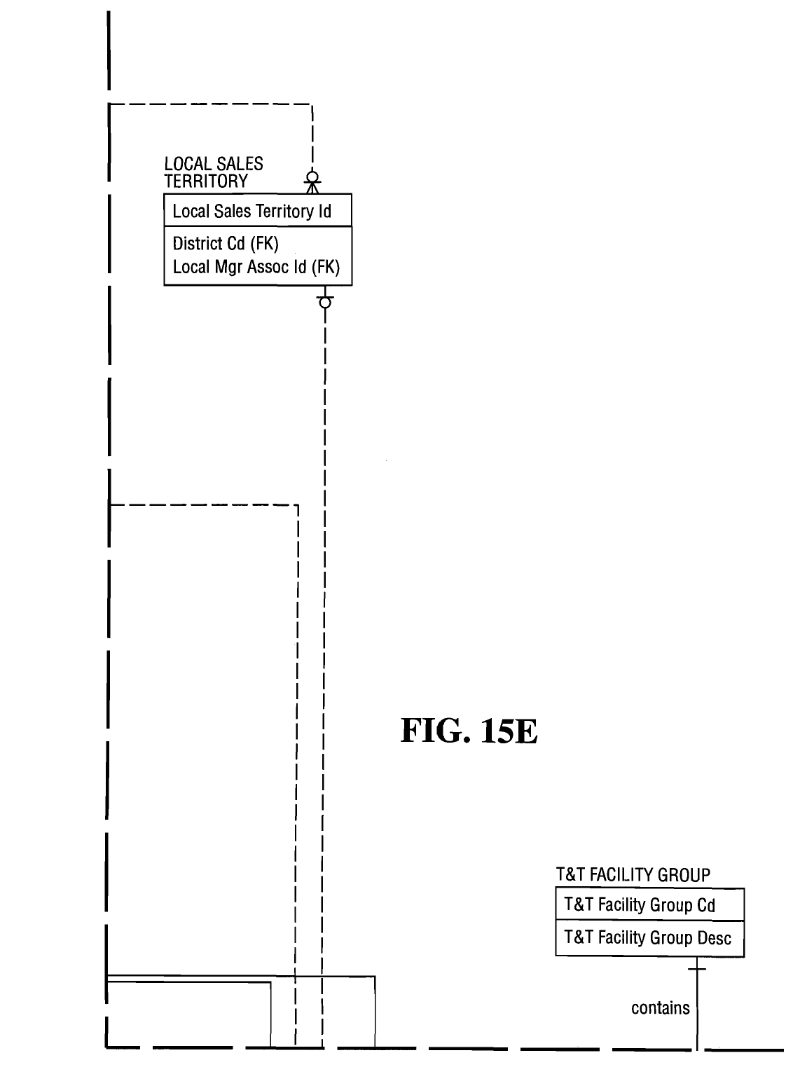

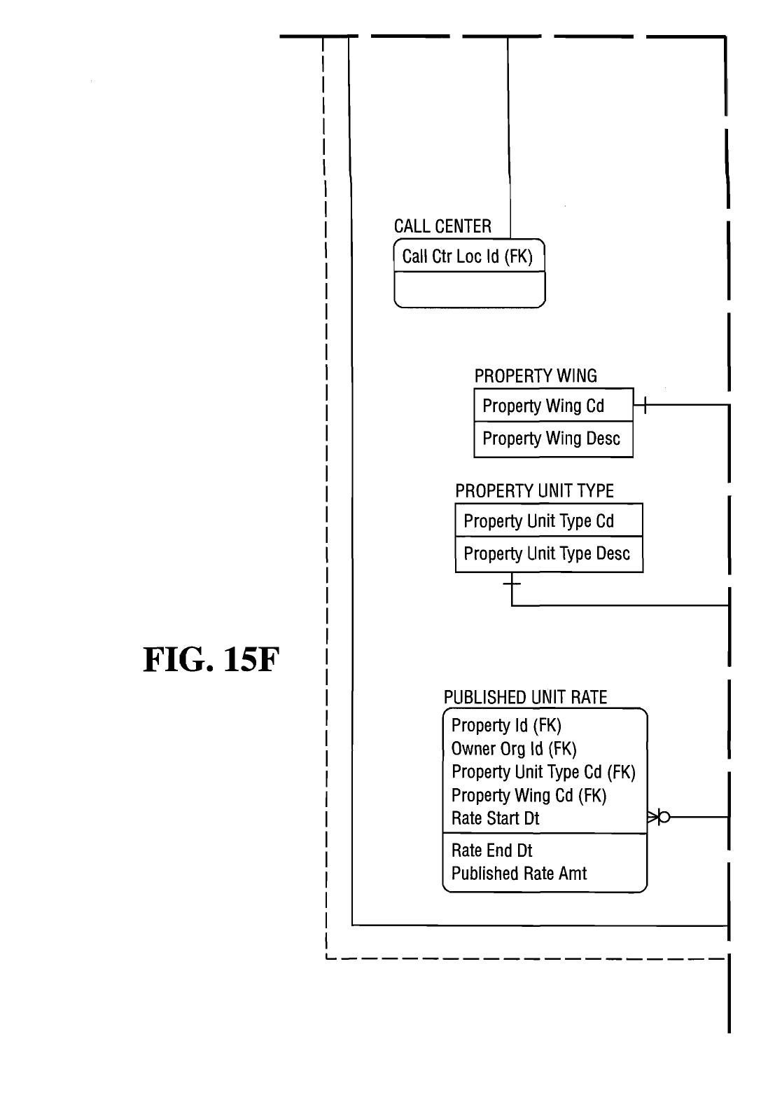

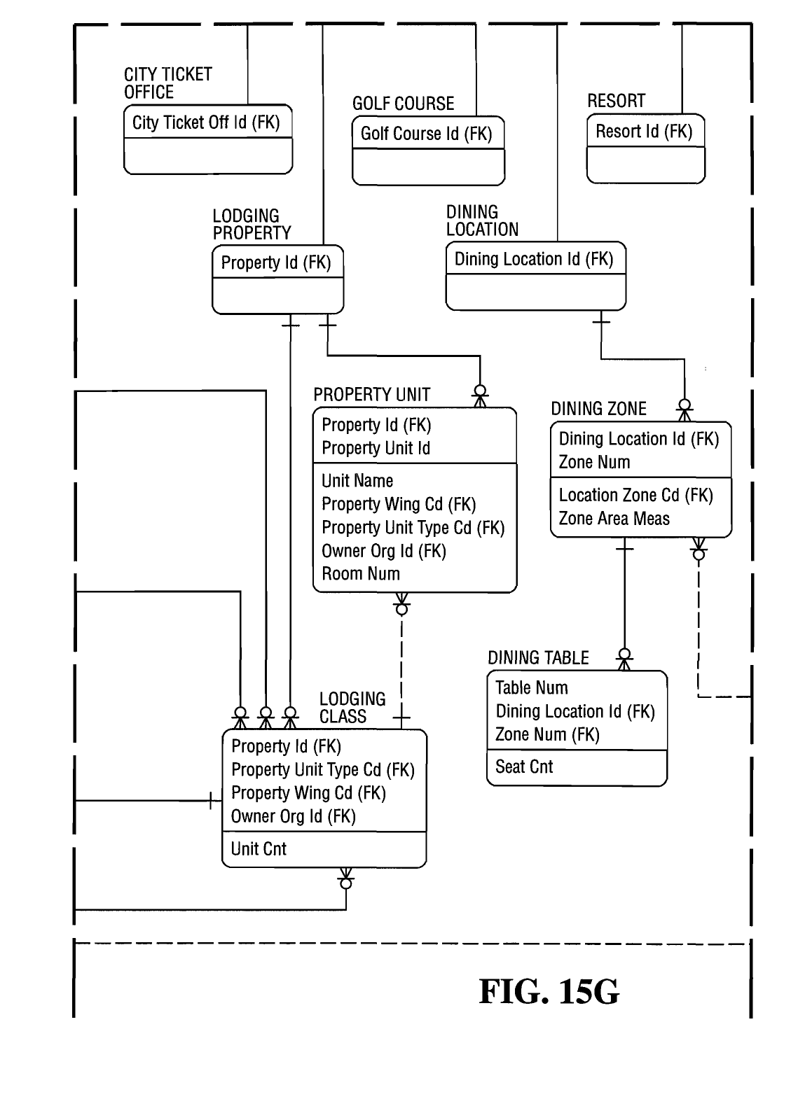

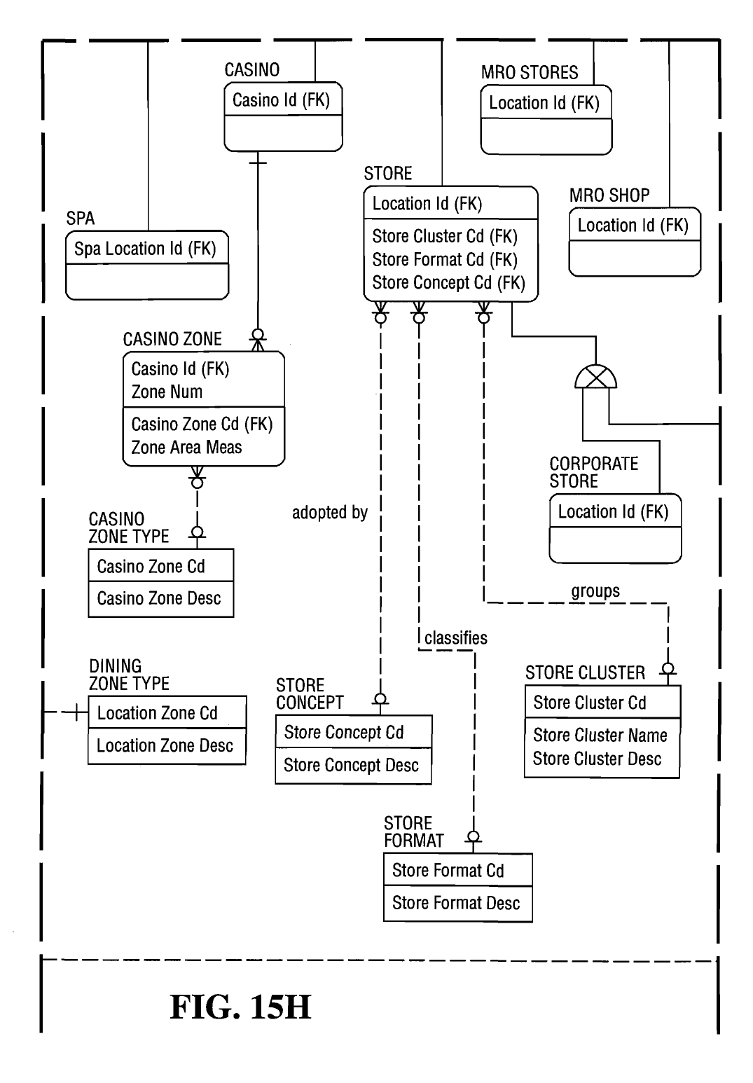

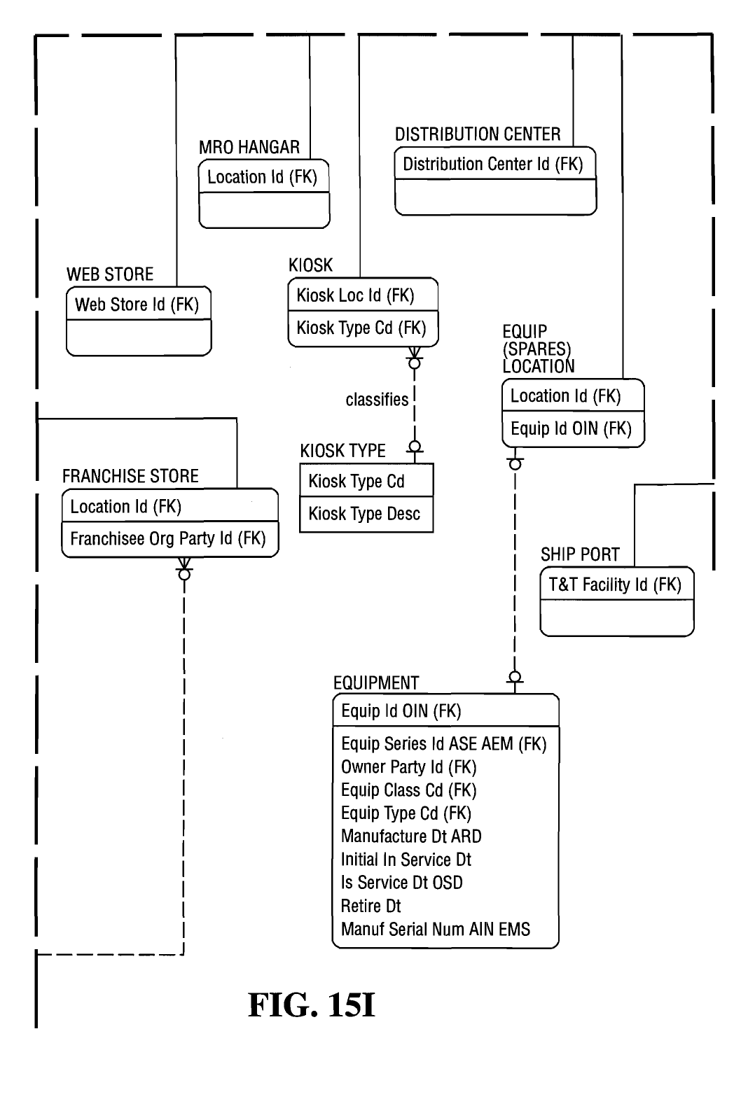

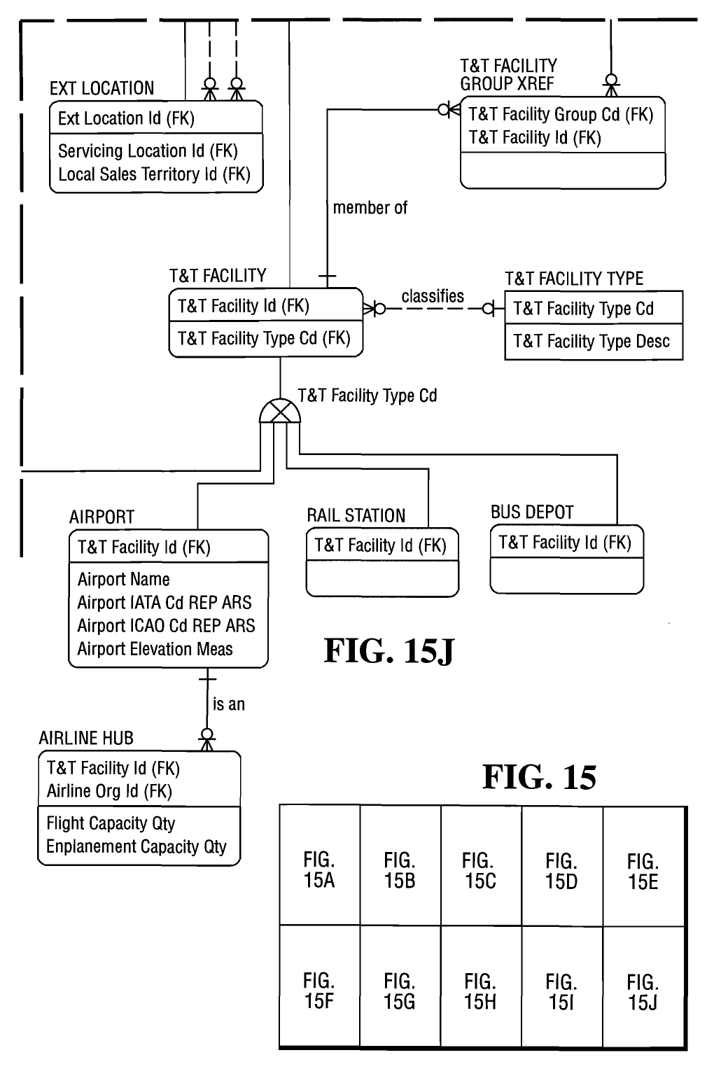

LOCATION (OVERVIEW) Subject Area, illustrated in FIG. 15;

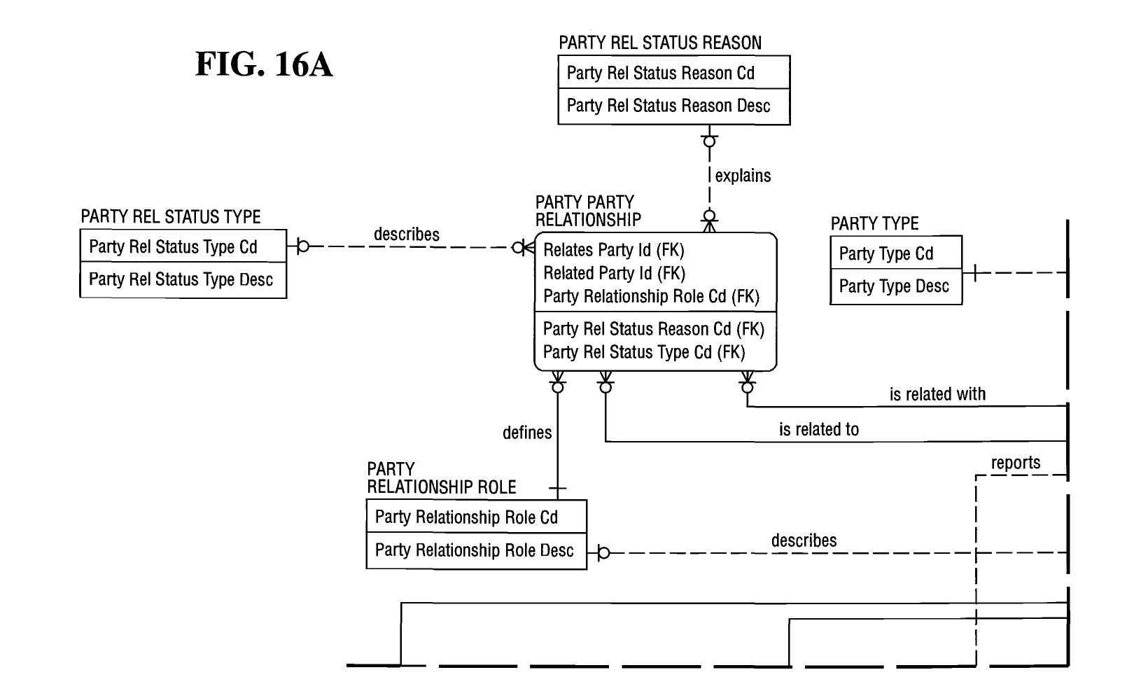

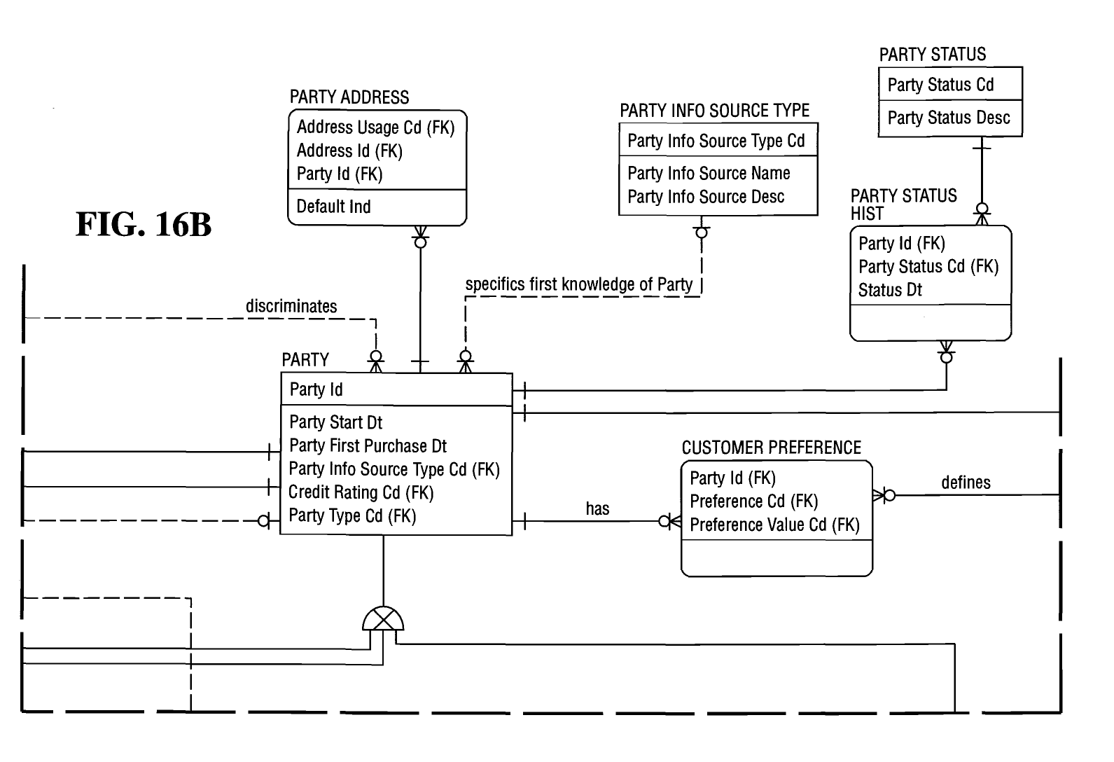

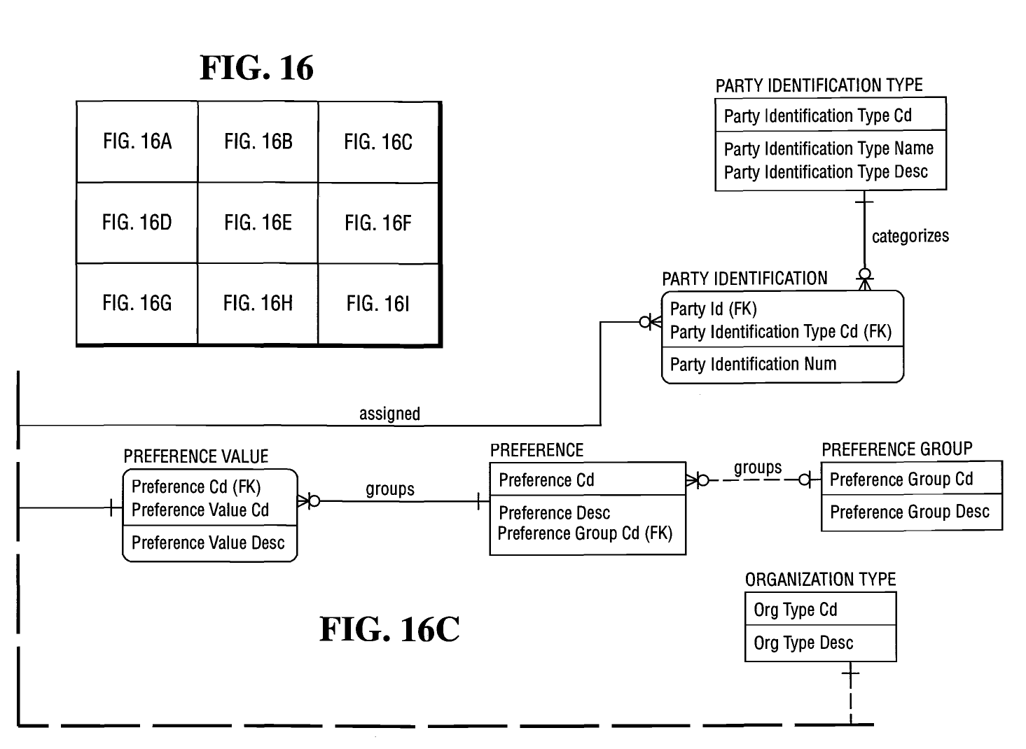

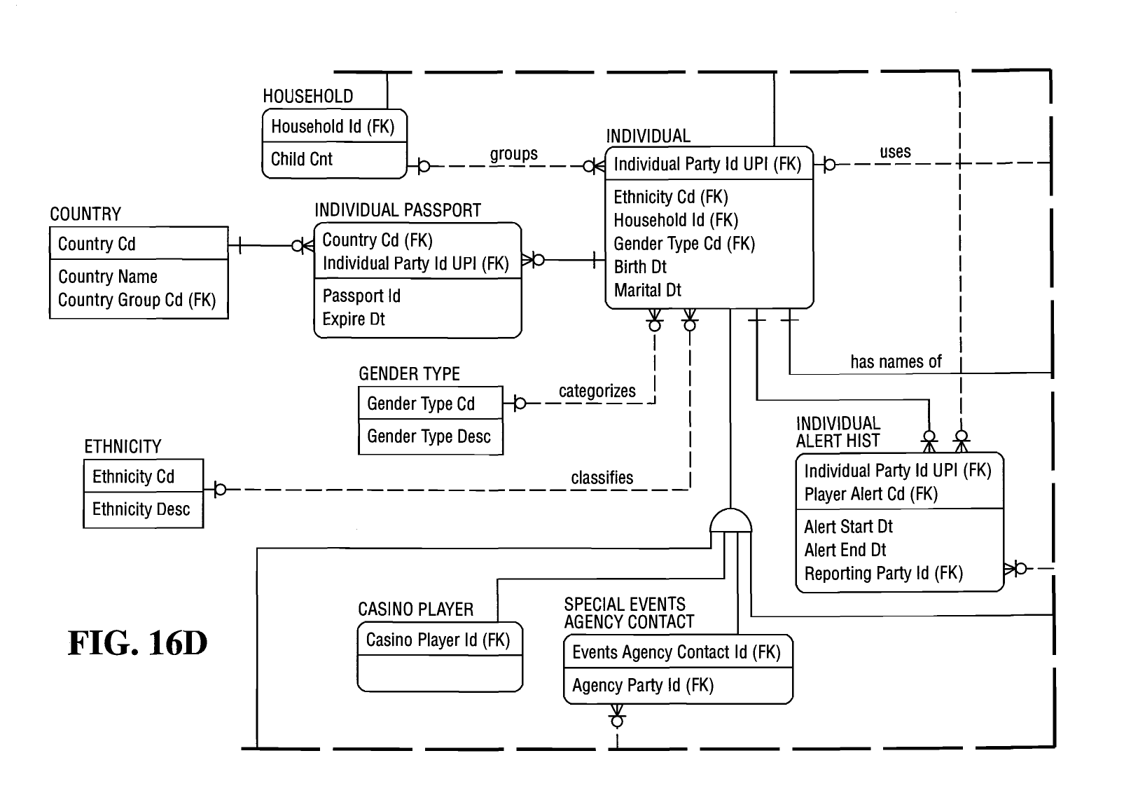

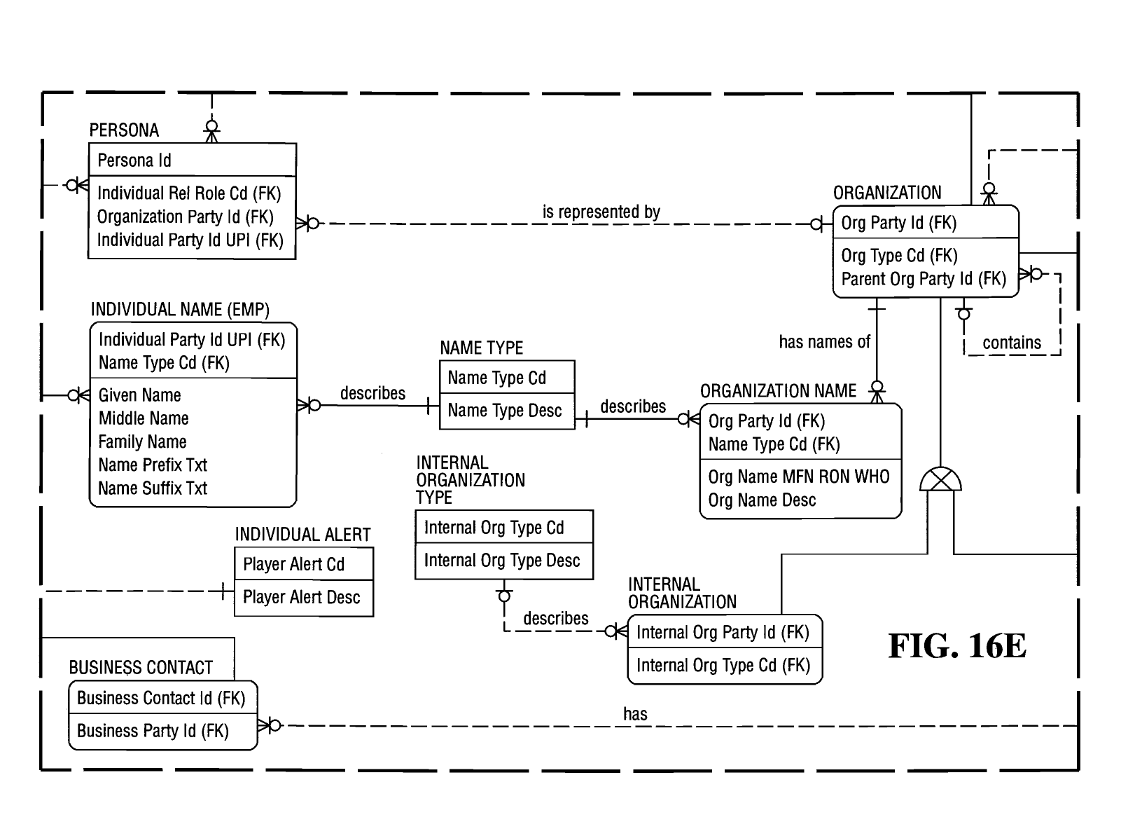

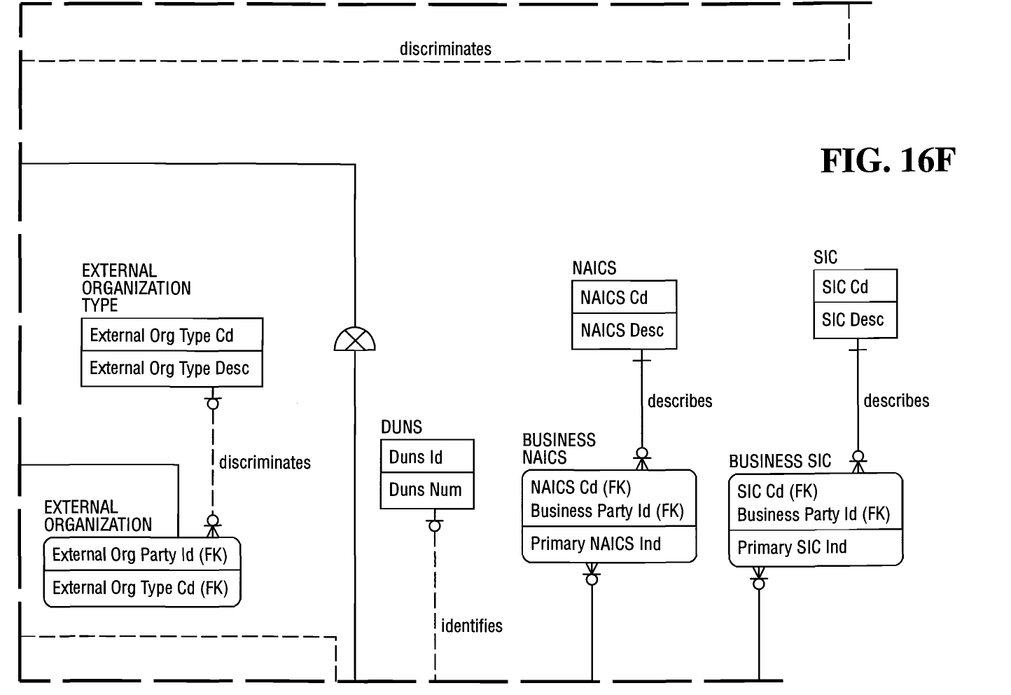

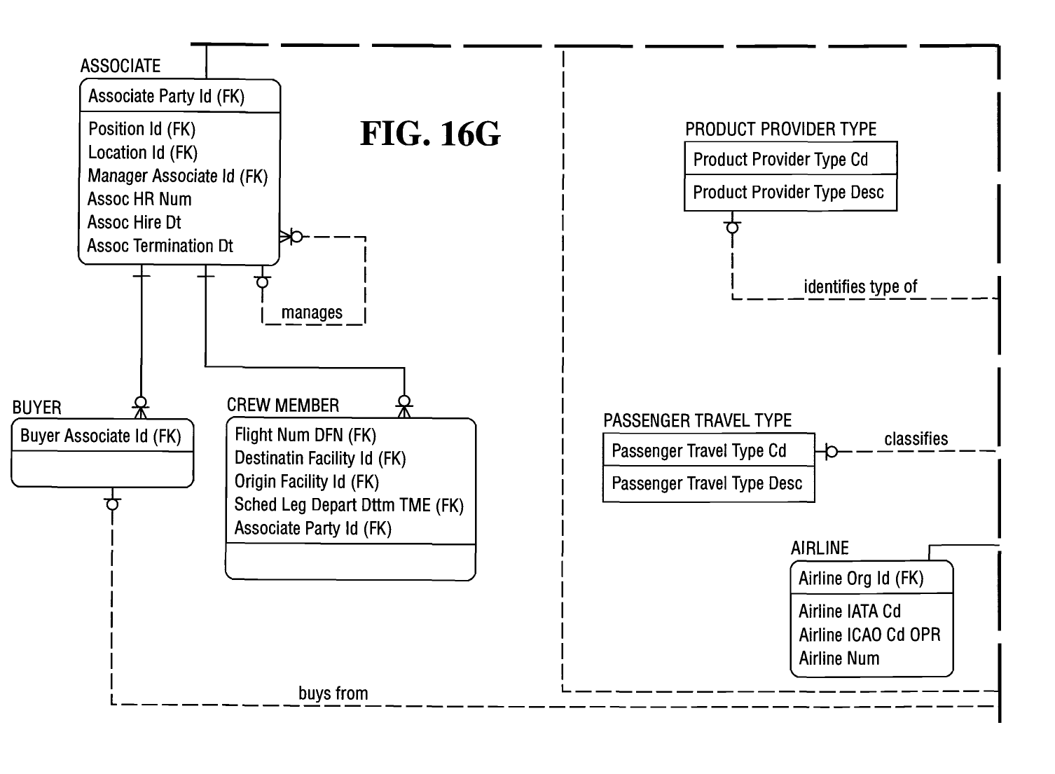

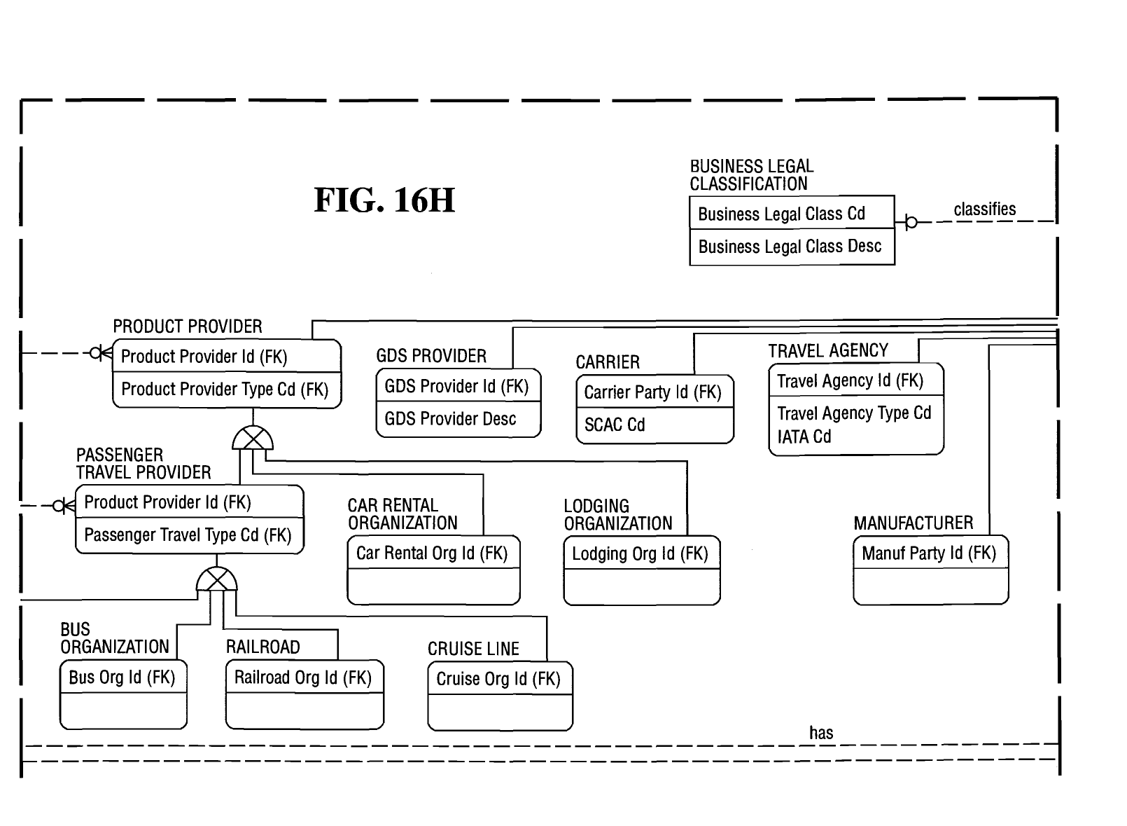

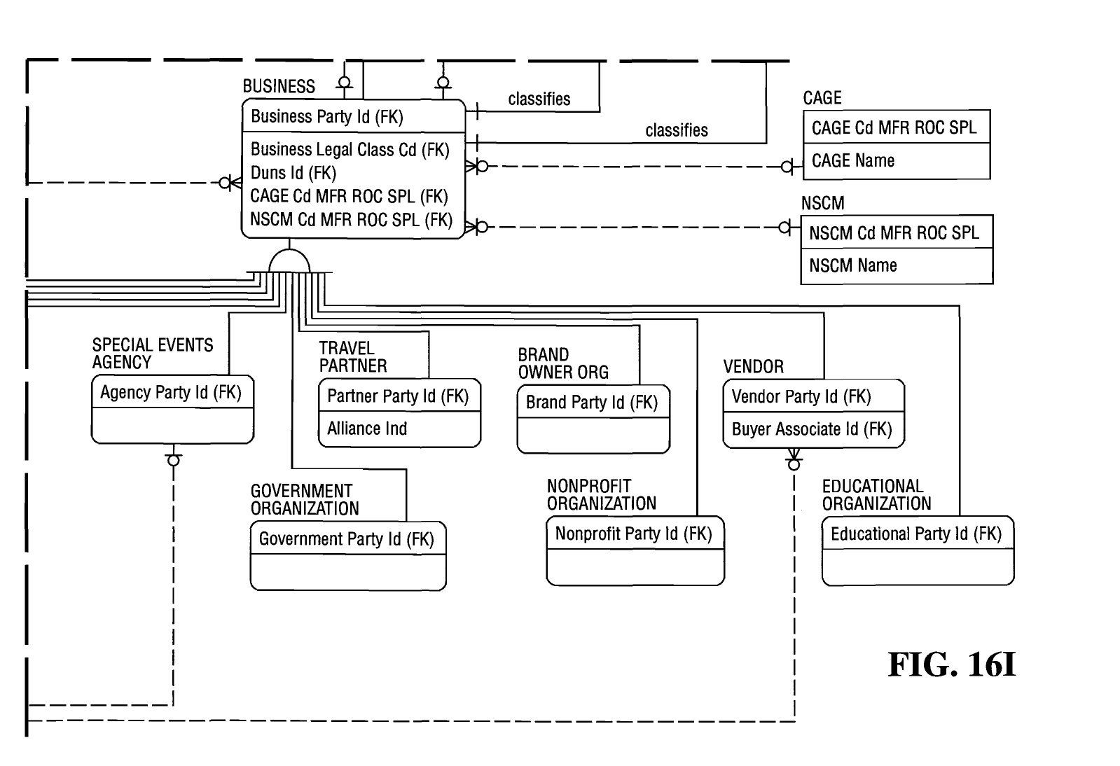

PARTY Subject Area, illustrated in FIG. 16;

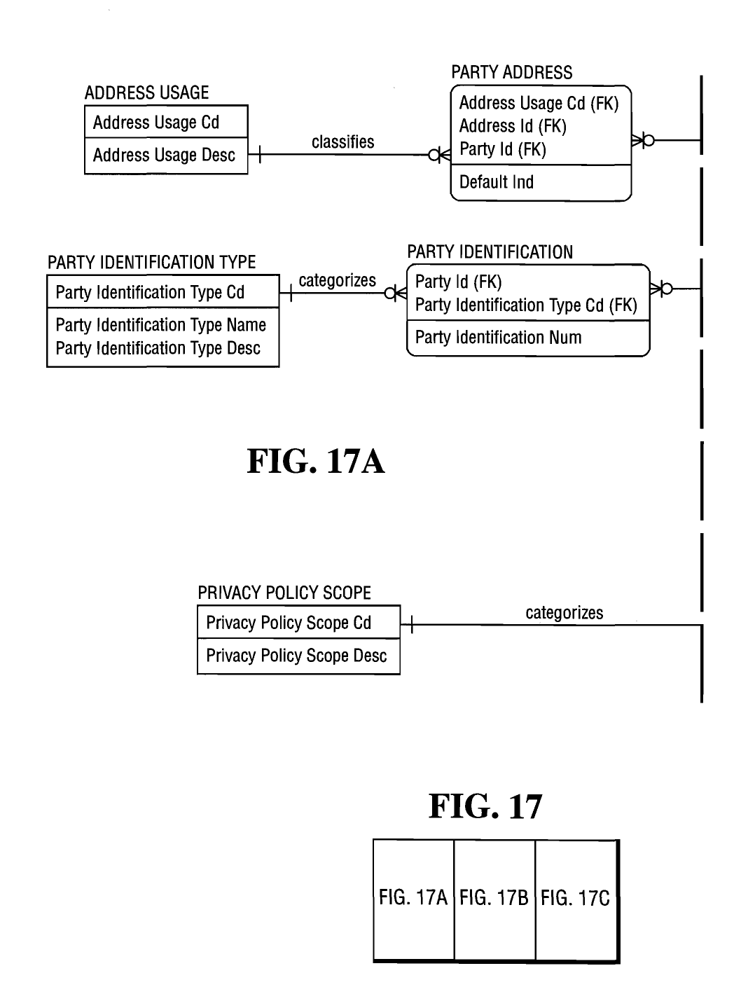

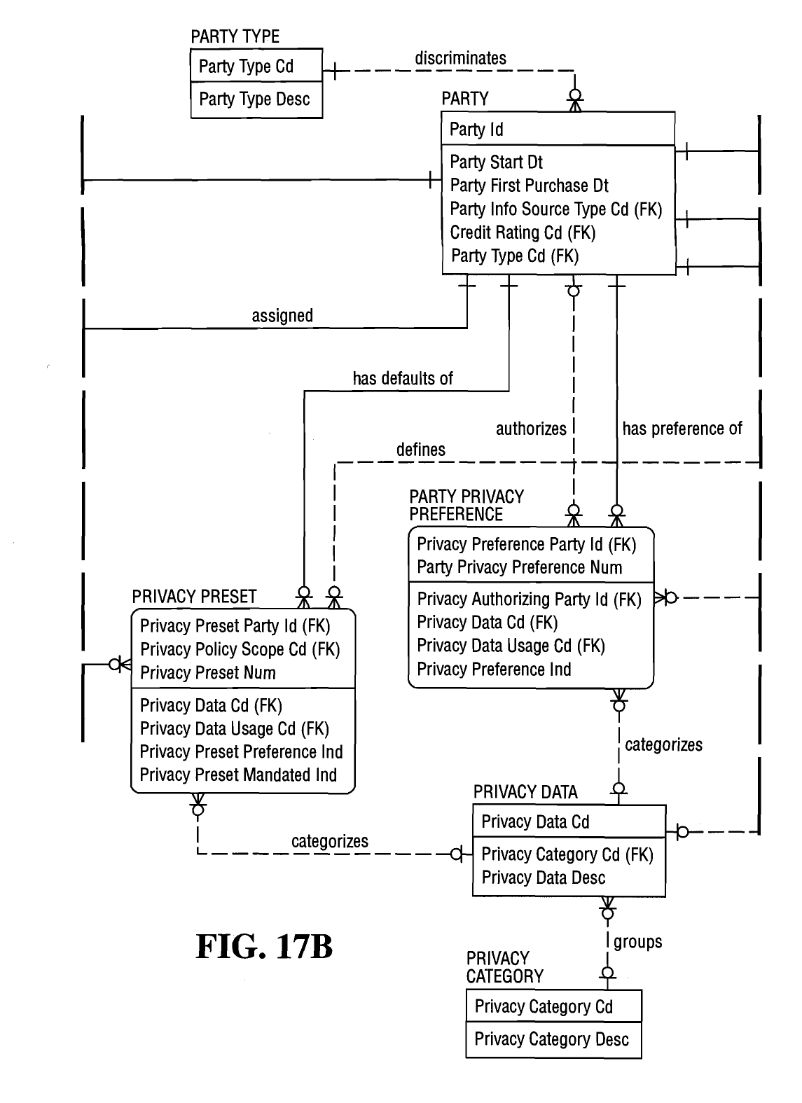

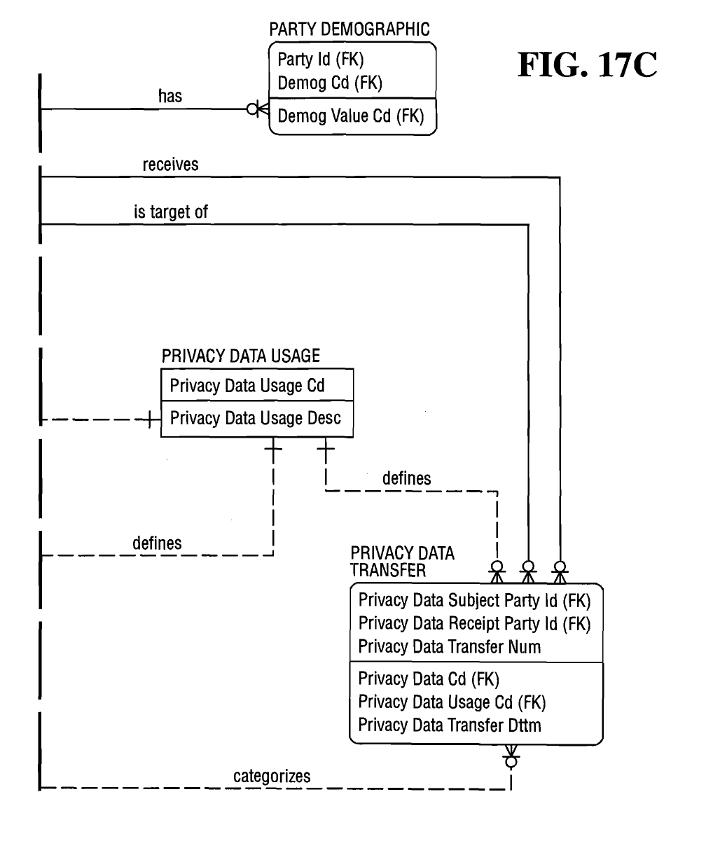

PRIVACY Subject Area, illustrated in FIG. 17;

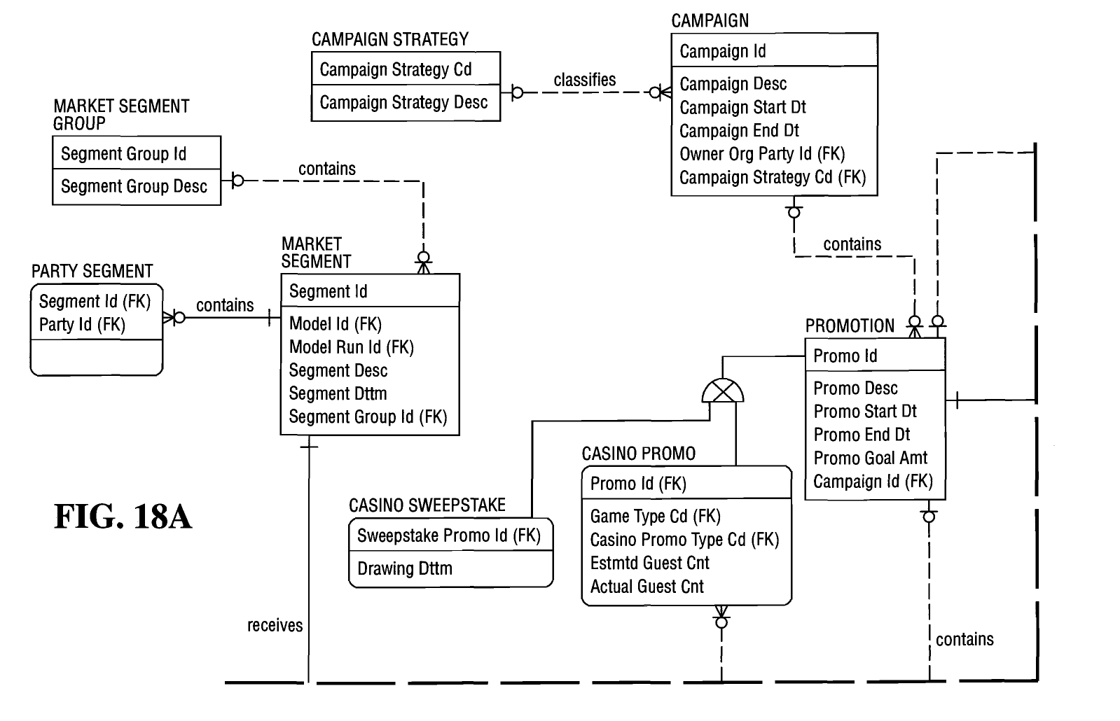

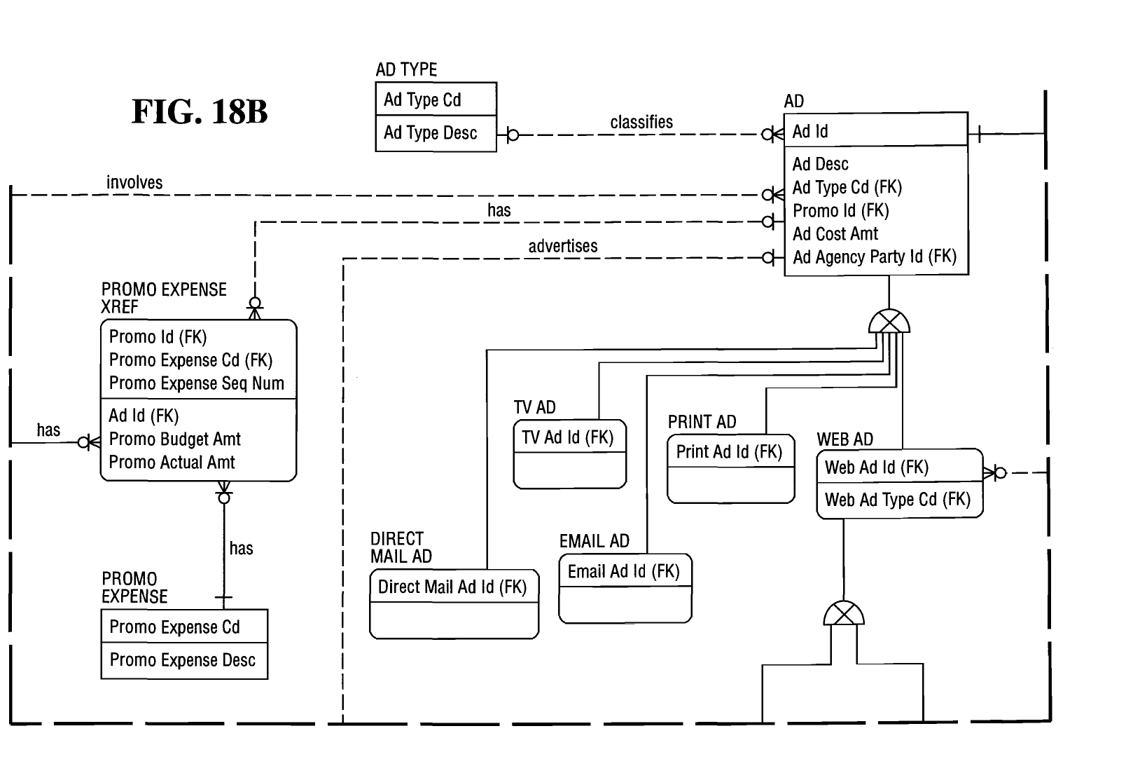

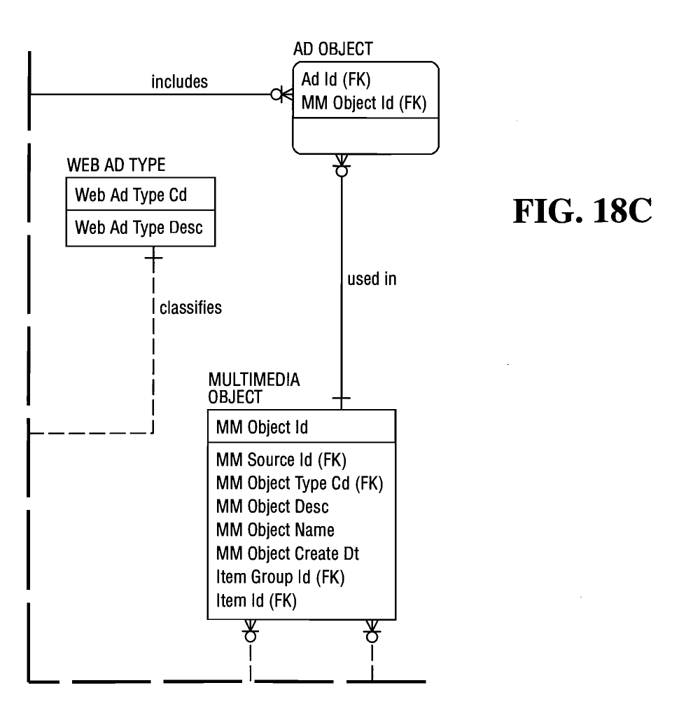

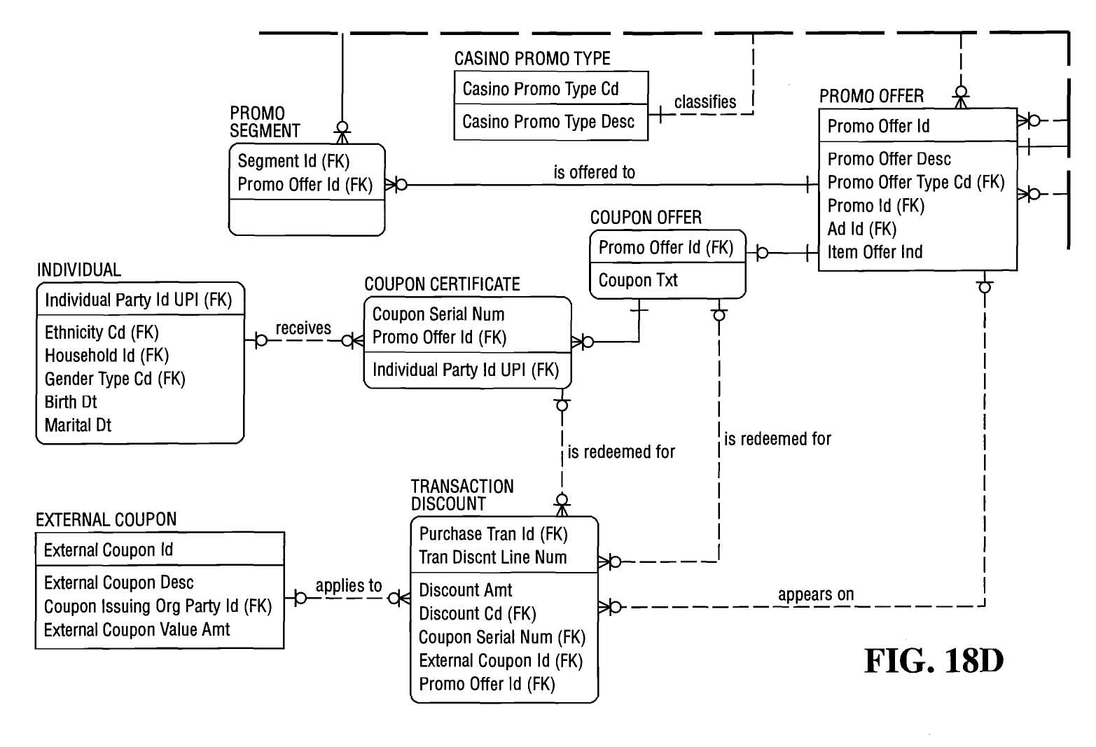

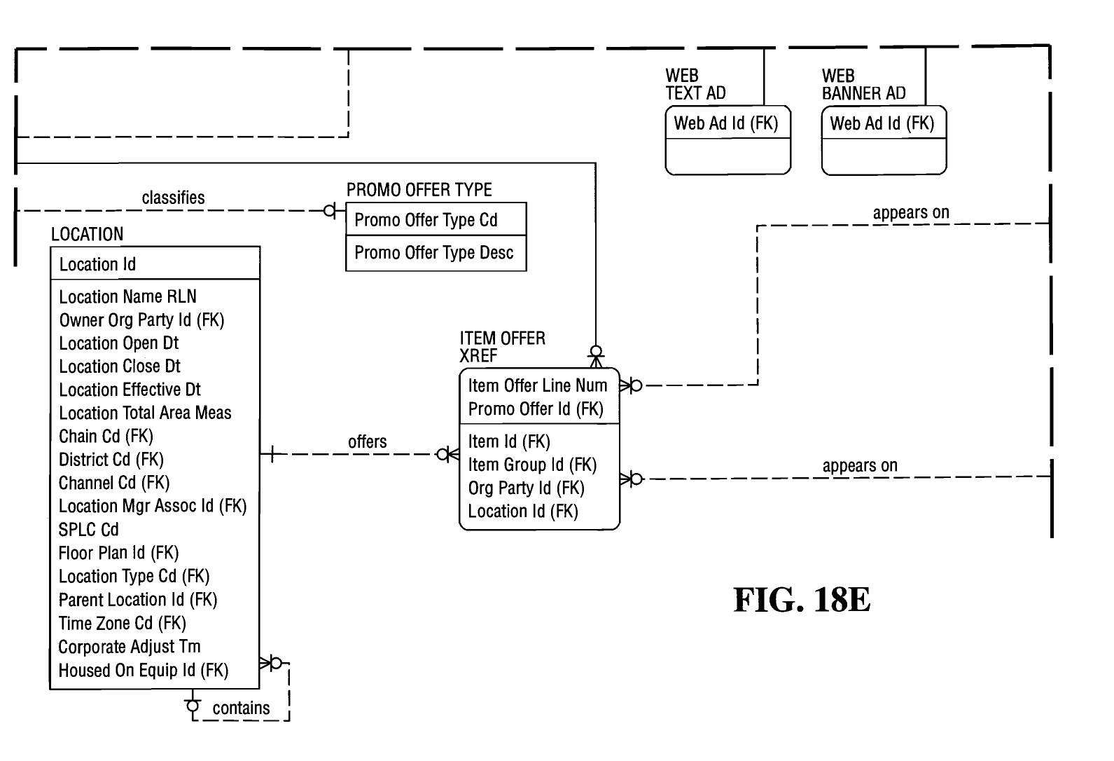

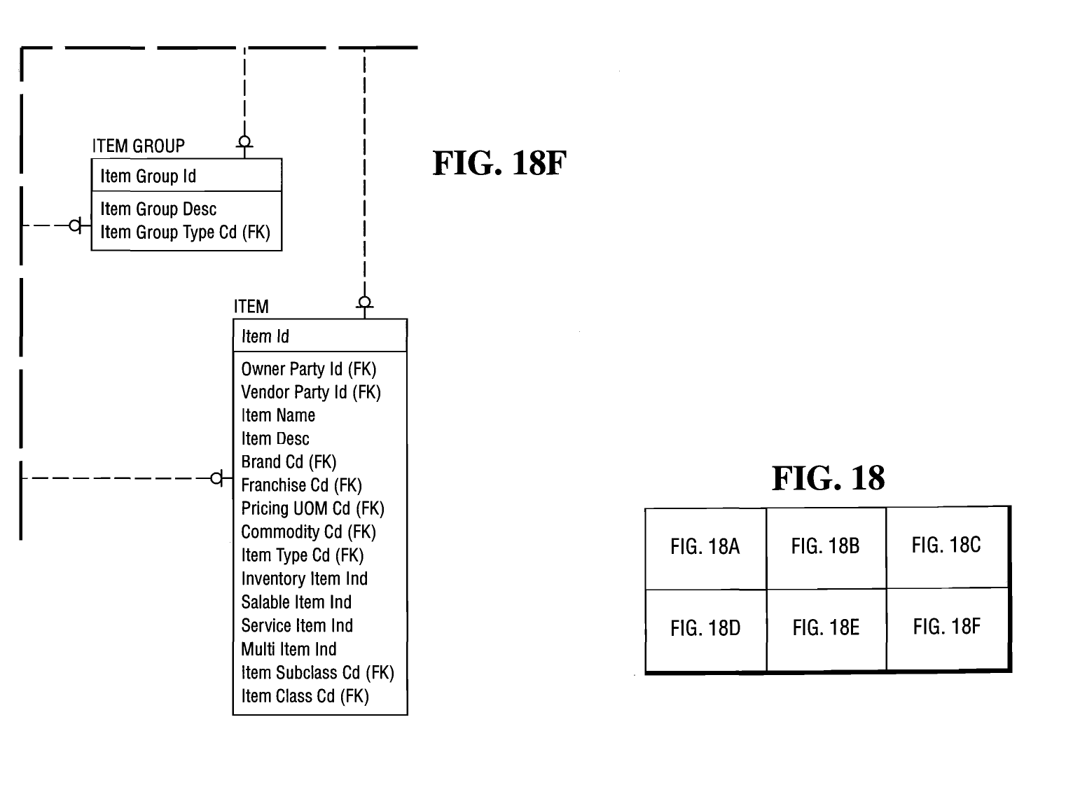

PROMOTION Subject Area, illustrated in FIG. 18;

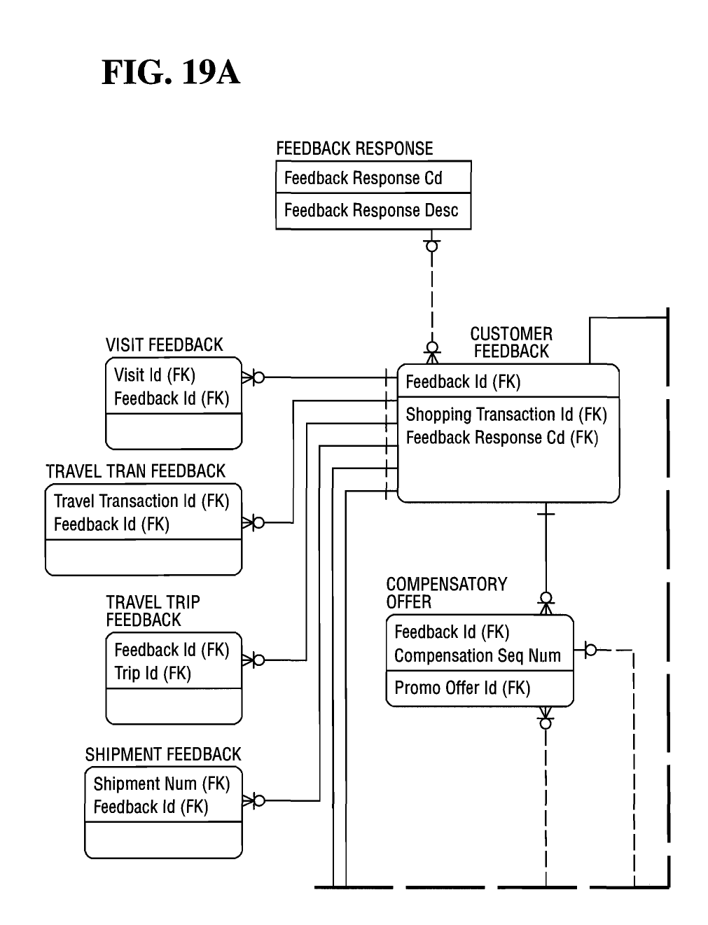

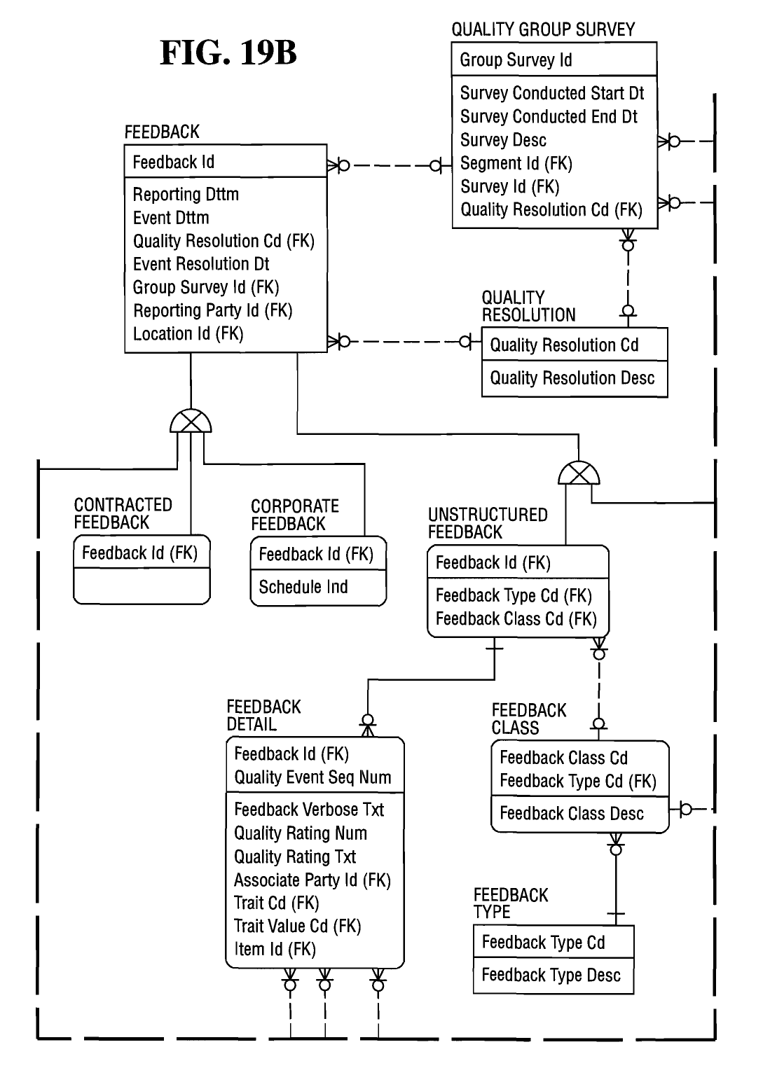

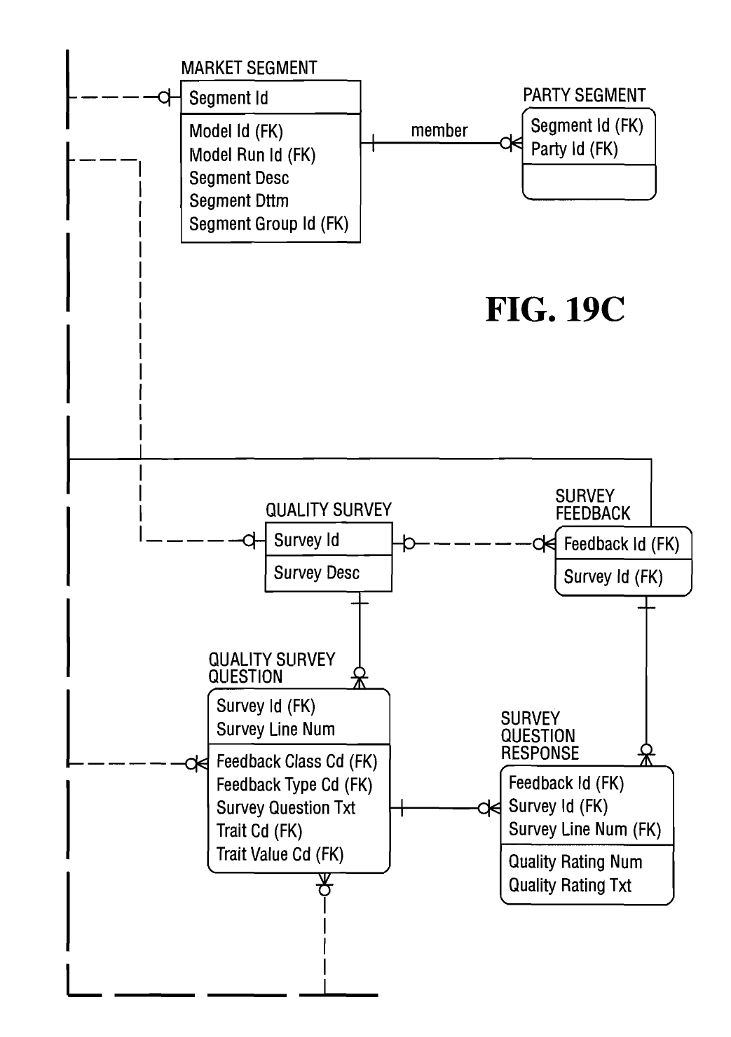

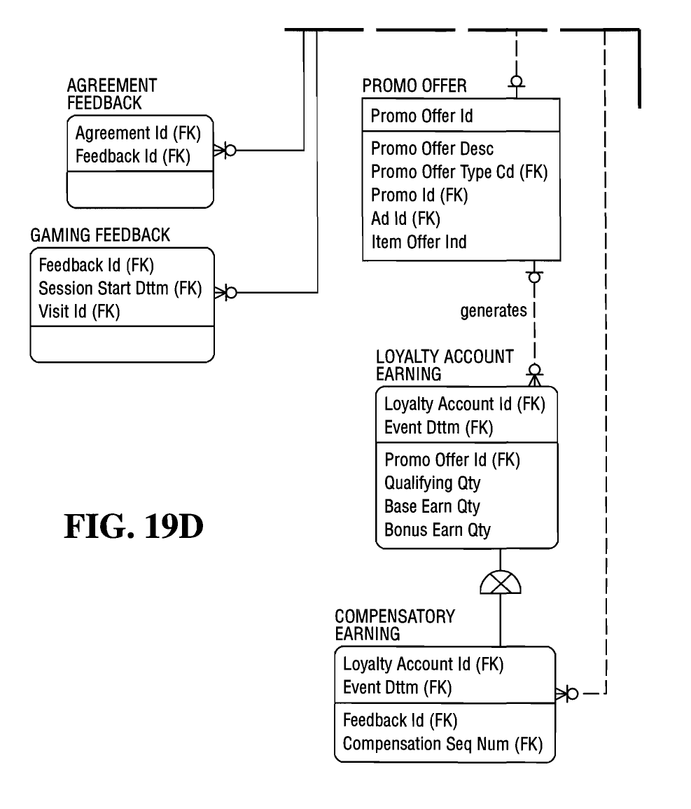

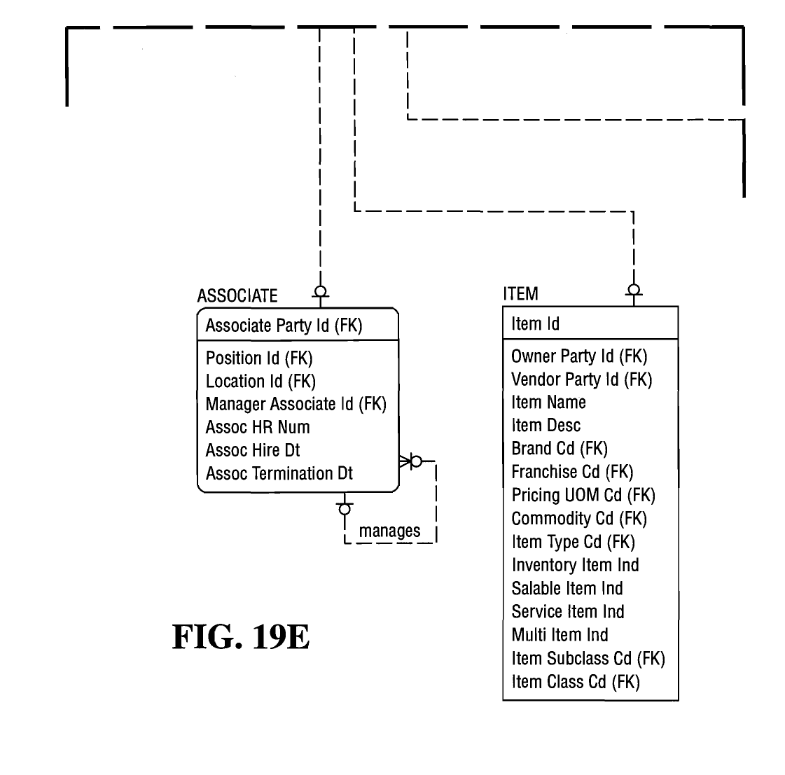

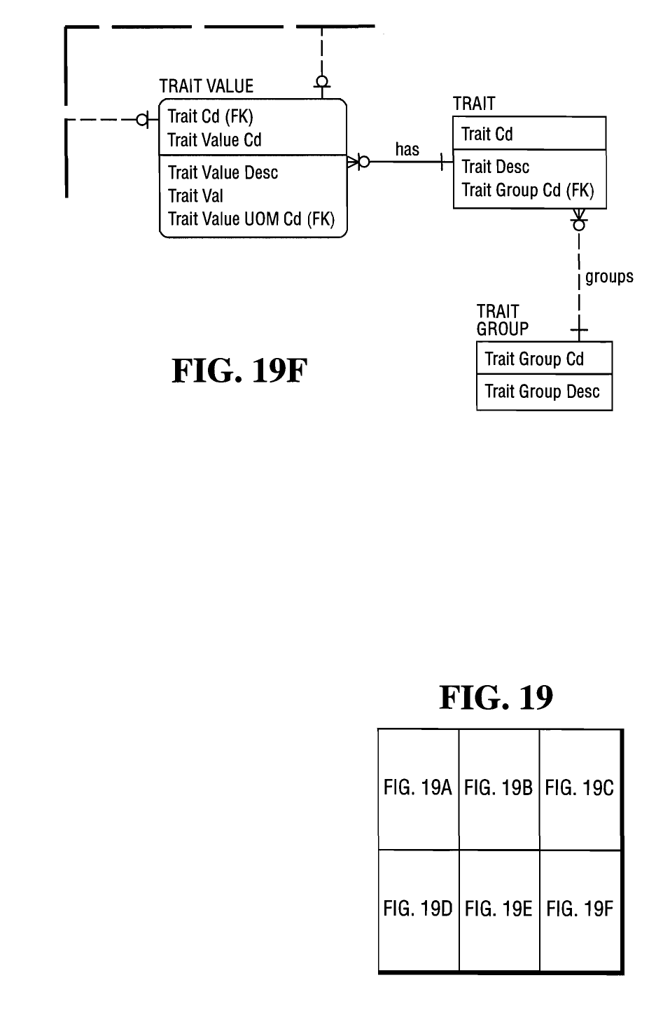

QUALITY FEEDBACK Subject Area, illustrated in FIG. 19;

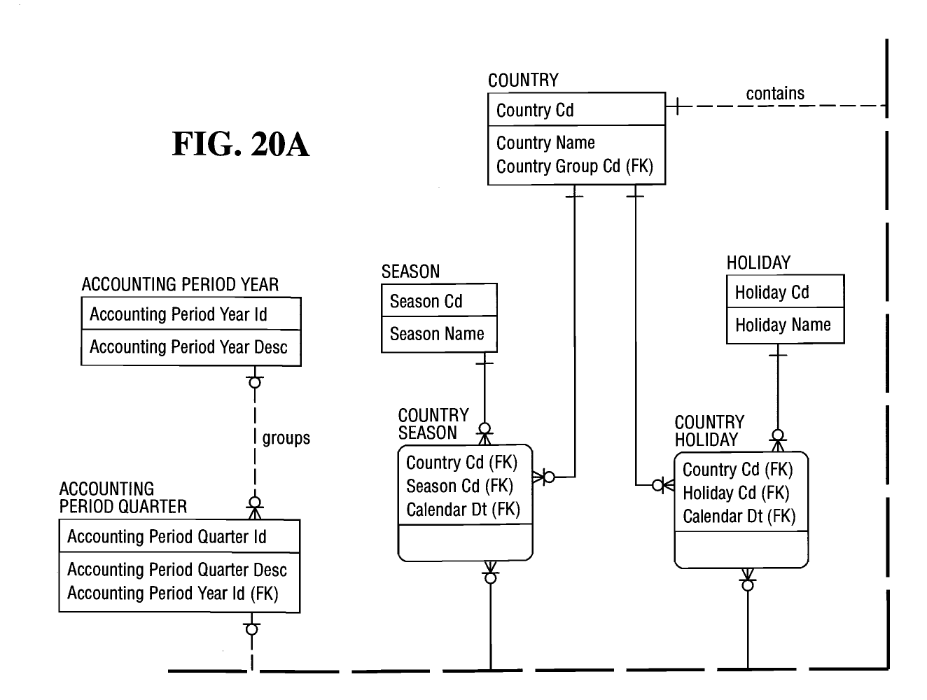

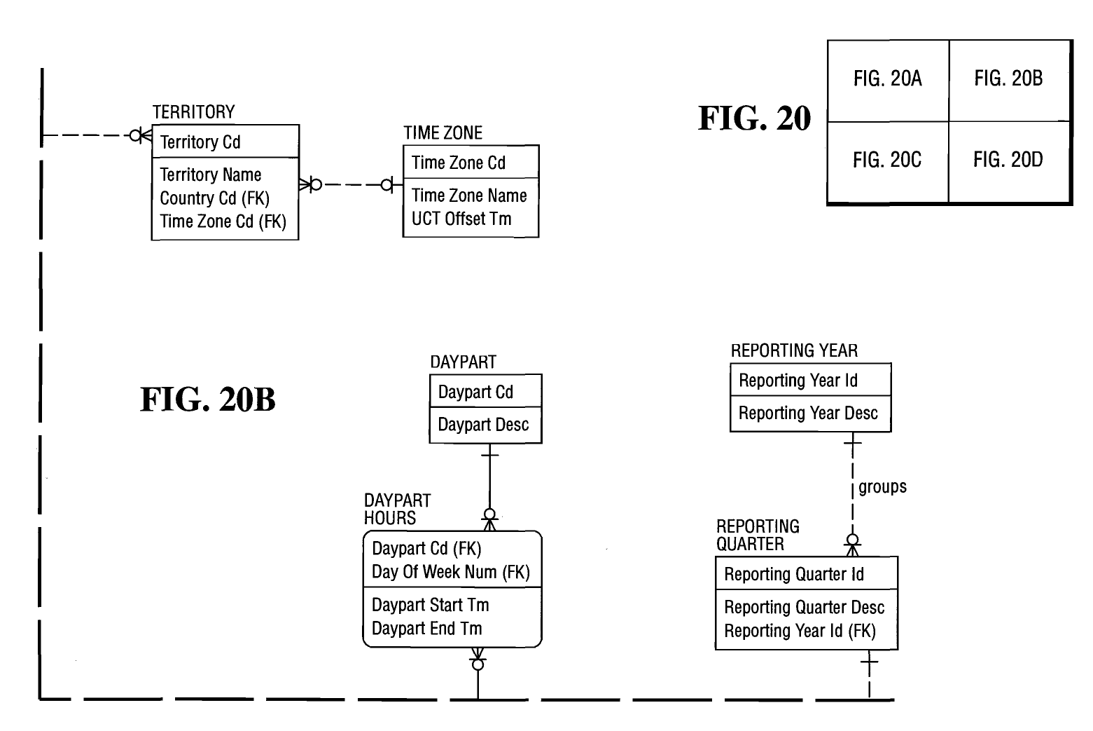

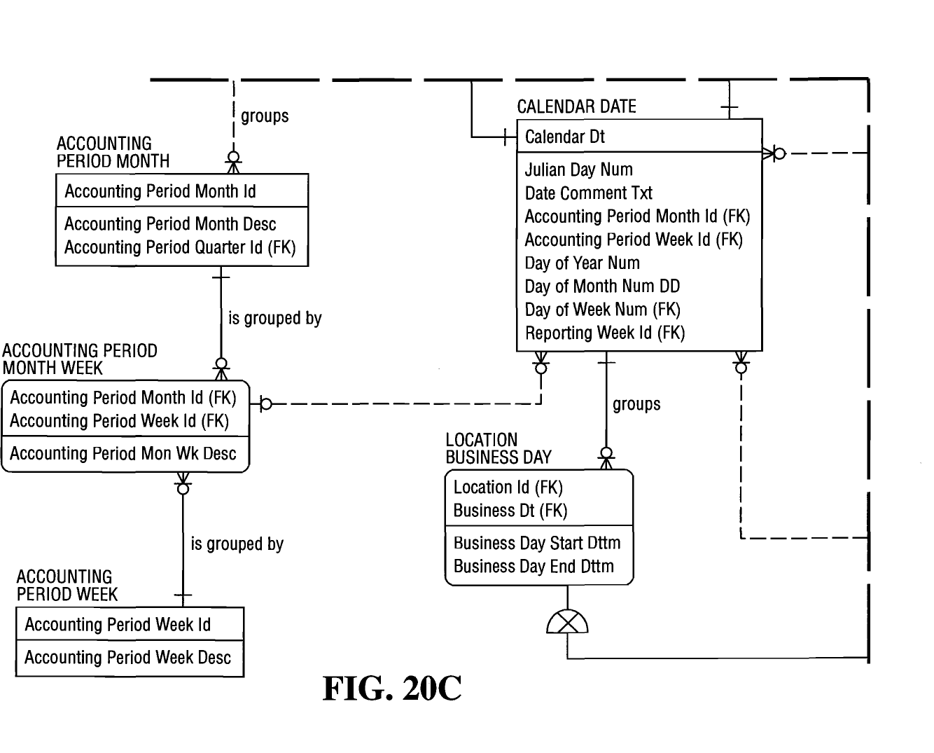

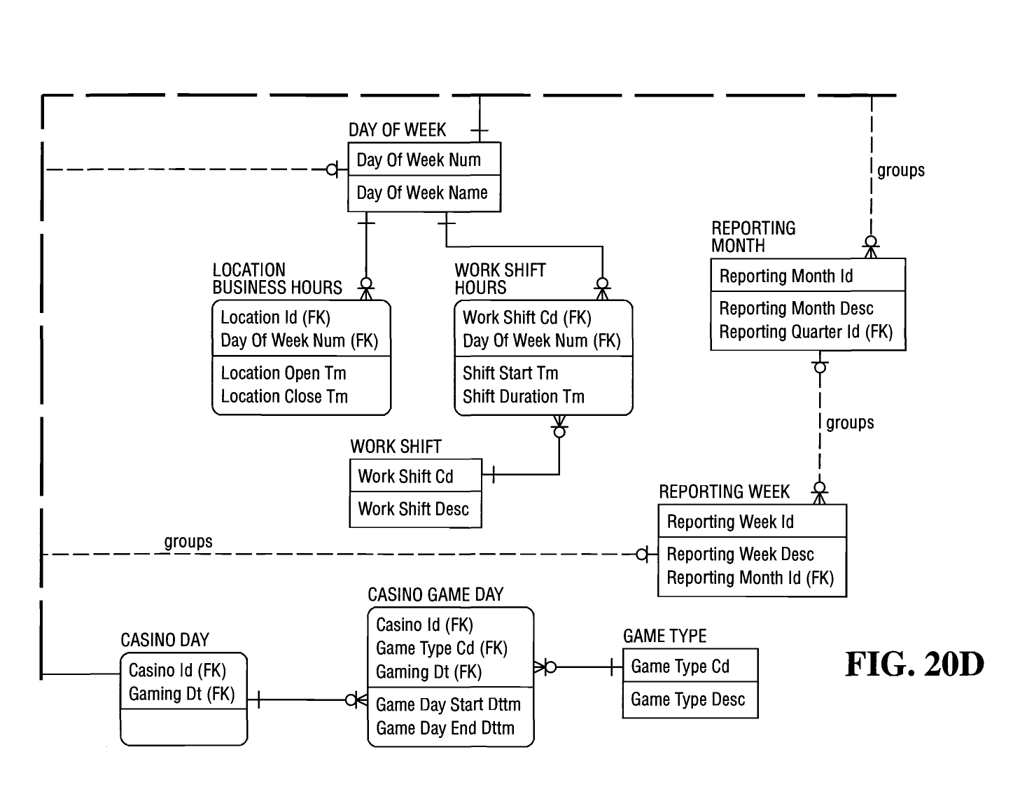

TIME PERIOD Subject Area, illustrated in FIG. 20; and

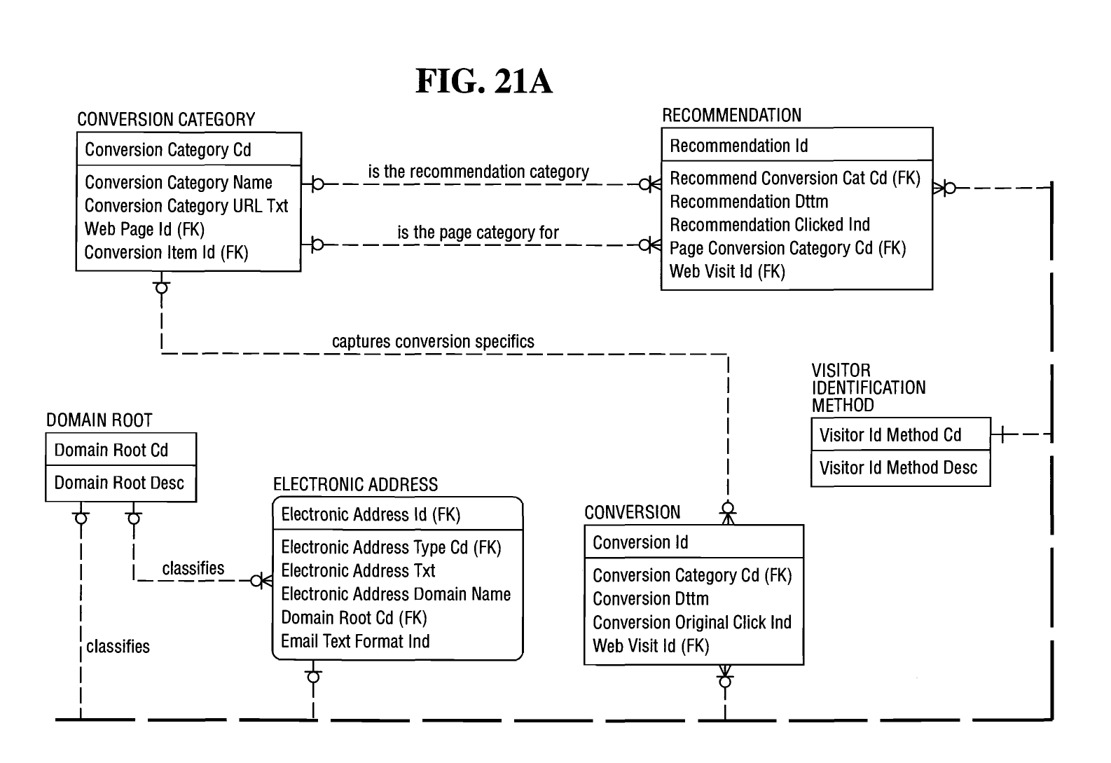

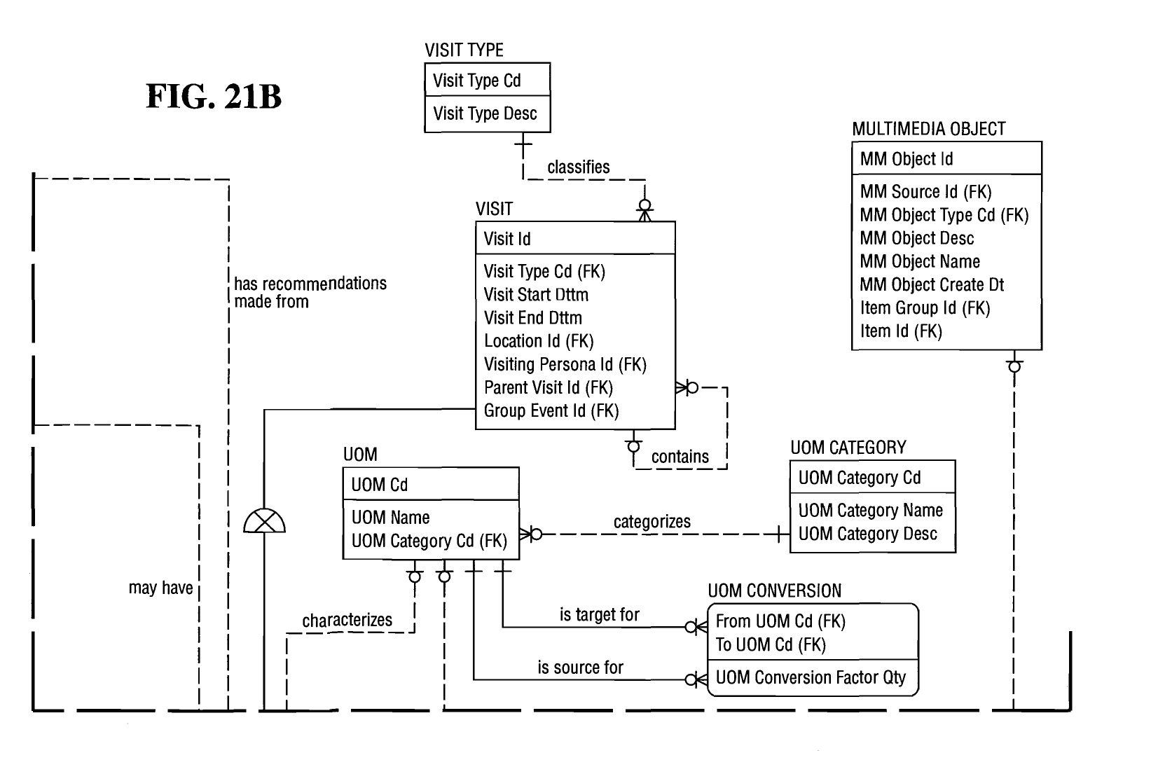

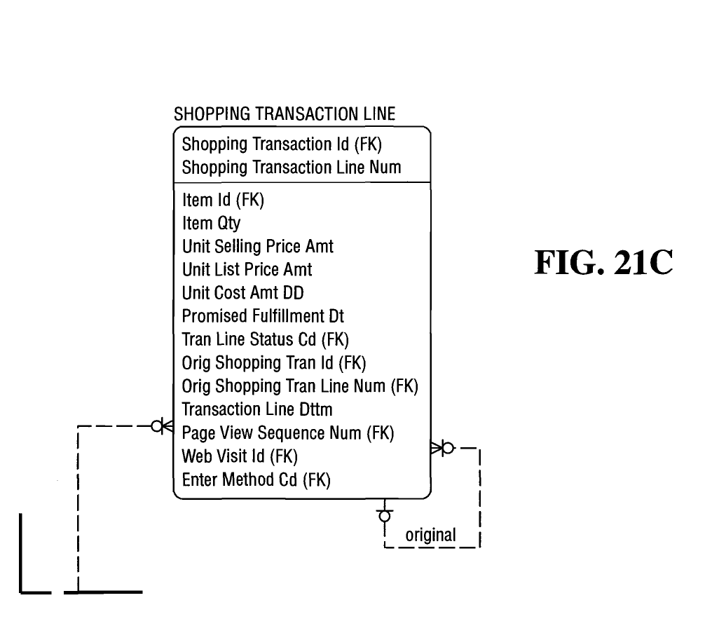

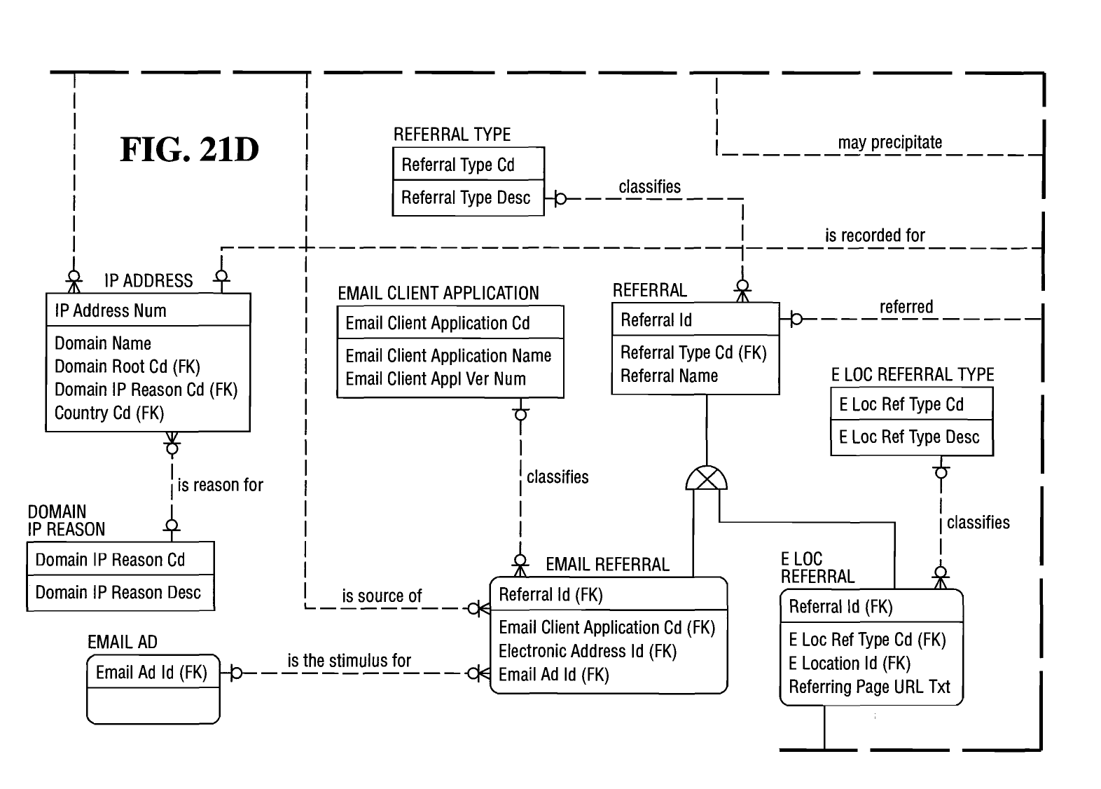

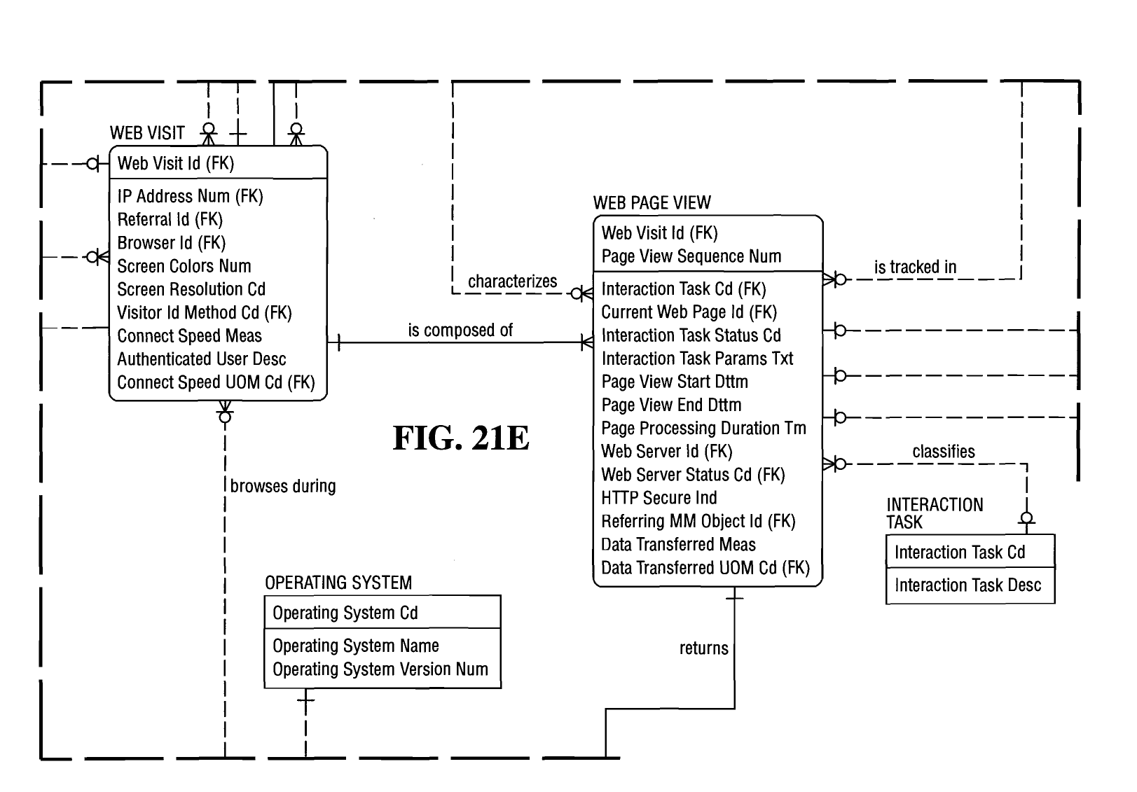

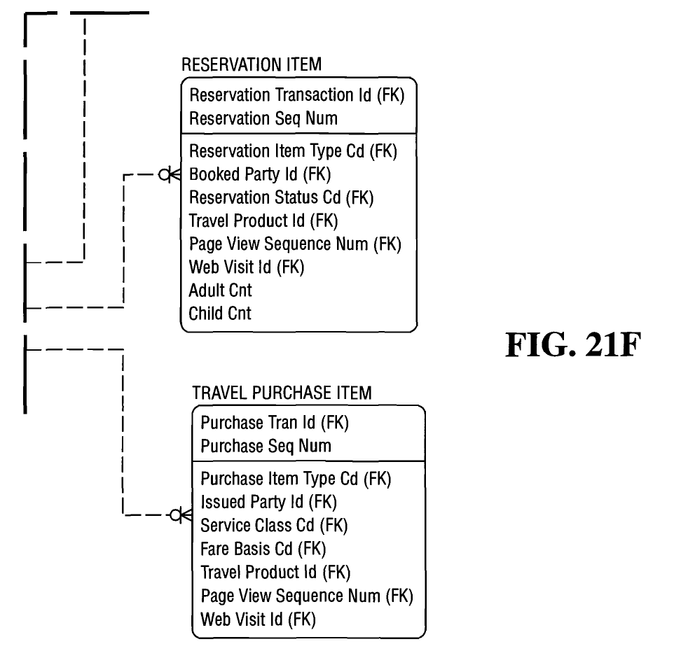

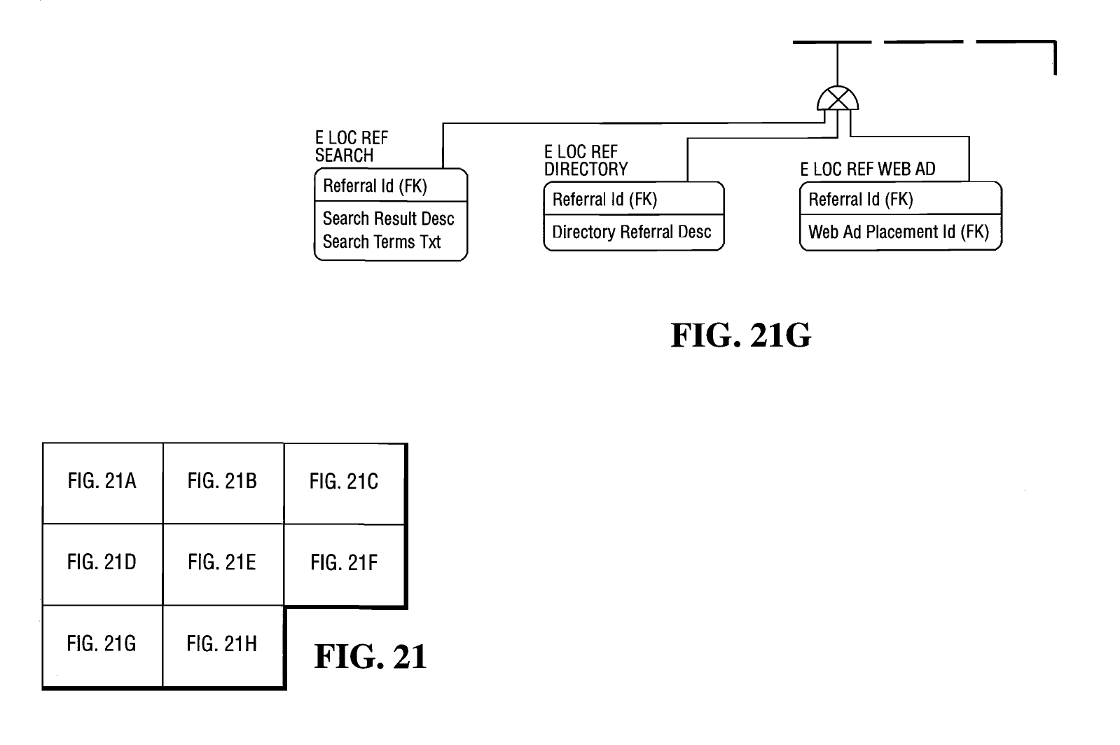

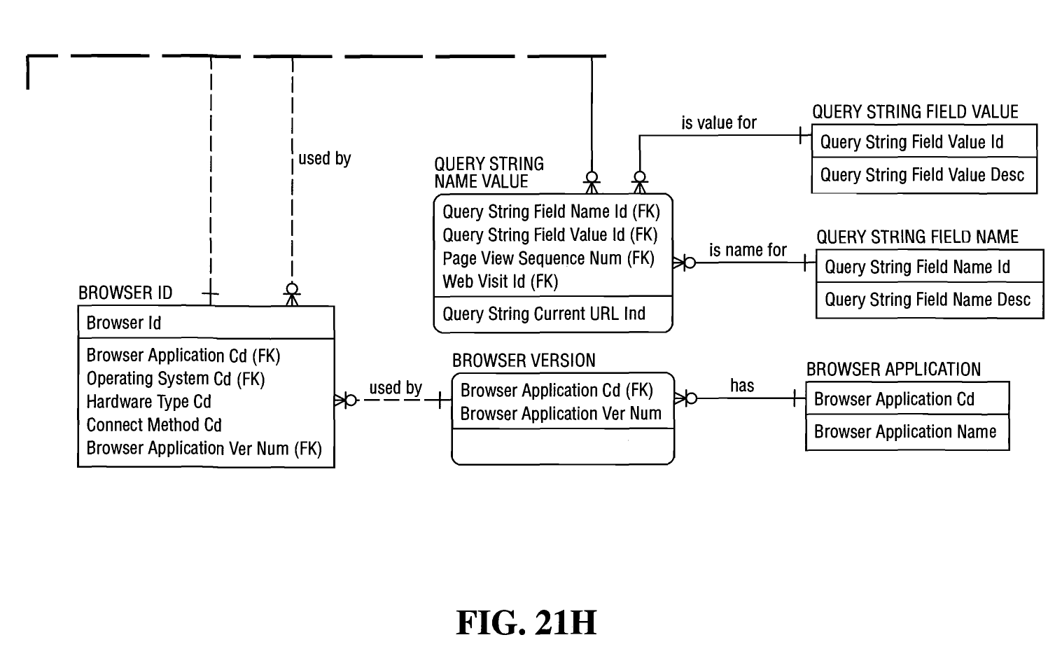

WEB VISIT Subject Area, illustrated in FIG. 21.

The core areas of interest in modeling the business information needs of casinos and gaming venues are the casino specific diagrams of the CASINO (OVERVIEW), CASINO COMPS, CASINO GAME SESSIONS, and EQUIPMENT (CASINO) subject areas shown in FIGS. 9, 10, 11, and 13, respectively. The remaining diagrams are important to allow enterprise warehouse analysis by relating casino and gaming information to other relevant business information and events for a more complete picture of casino information:

A listing of all the entities included within the logical data model, and those included in the subject areas illustrated in FIGS. 4 through 21, together with a brief description of each entity, is provided in Appendix B. A listing of all the attributes included within the entities listed in Appendix B, and those shown in FIGS. 4 through 21, together with a brief description of each attribute, is provided in Appendix C.

APPENDIX A
Subject Area Definitions

| Subject Area | Definition |
|---|---|
| ACCOUNT (DEFINITION) | This Subject Area specifies the ACCOUNTs used by customers to make payments for |
| | products or services. The model captures a history of all purchases made and how |
| | paid to enable in-depth analyses and detail tracking. |
| | Loyalty accounts in this area track the accumulation and redemption of “points” that |
| | are awarded to consumers by the Enterprise or by Enterprise Partners. See the |
| | ACCOUNT (LOYALTY) subject area for additional information. |
| | By means of Folio accounts, business transactions for which payment has not yet |
| | been made (as in the case of a hotel stay) may be grouped and consolidated. |
| | A Casino account (for purposes of gambling) is a specialized one that may reflect a |
| | line of credit and/or funds deposited by gamers. |
| | Gift Certificates are Serialized Items which are sold to customers who then use the |
| | certificate value to purchase goods and services. Value may be added to a Gift |
| | Certificate account permitting ongoing usage and tracking of consumer purchase |
| | behavior. |
| | A key feature here is the ability to apply and track transfers between those accounts |
| | which are maintained by the Enterprise such as Loyalty, Folio and Gift Certificate, etc., |
| | accounts. |
| | Also represented here are the familiar Checking and Credit Card accounts and |
| | Traveler's Checks. |
| ACCOUNT (LOYALTY) | Details the Accounts used for tracking loyalty relationships. It contains award balances |
| | associated with customer loyalty programs (such as frequent flyer programs, casino |
| | rewards, etc.), and allows customers to redeem awards based on points earned via |
| | money spent, miles flown, trip segments traveled, hotel stays, etc. |
| | Provision has also been made to handle award balance transfers from partners and |
| | their various award programs. Most current award options are built into the model. If |
| | your customer has additional award options, they will need to be added. These |
| | awards can be reflected in an actual award certificate or an electronic version of one. |
| | See ACCOUNT (DEFINITION) Subject Area. |
| ADDRESS (CONTACT) | Captures all business information that can be used for communicating with customers, |
| | households and organizations (both internal and external to the Enterprise). |
| | Each unique occurrence of an Address may represent a physical address (e.g. street. |
| | post office box, parcel of land, cell tower location, etc.), a telephone number, or an |
| | electronic address (e.g. e-mail, FTP, or URL). |
| | Every individual person, household or organization may be referred to by one or more |
| | addresses. This permits building up a rich variety of methods for contacting these |
| | parties. Promotional material may be provided, for example, via an e-mail or by a |
| | customer service representative placing a telephone call to a prospective or continuing |
| | customer. |
| | While there is no direct relationship between this subject area and the PRIVACY |
| | subject area, contact with parties may be governed by privacy policies set by the |
| | Enterprise and/or by the consumer. See the PRIVACY subject area for additional |
| | information. |
| | Note, Internet Protocol addresses are modeled separately in the entity IP ADDRESS |
| | within the Web related subject areas. |
| ADDRESS (GEOGRAPHY) | Shows the relationships between various terrestrial groupings or areas. At the highest |
| | level, World Region may identify large areas such as continents, multi-country |
| | associations (European Union, North America, e.g.), etc. Countries may be grouped |
| | as needed and each Country may contain many Territories which may, in turn, contain |
| | Counties and/or Cities. |
| | Distance between any two Postal Codes is provided as a Distance Map primarily as an |
| | aid to determining transportation rates. |
| | Mailing Address is also shown in the ADDRESS subject areas - it represents a discrete |
| | Postal Service address that may be used for communicating with Parties, Households |
| | or Locations (Enterprise facilities). Optionally, Mailing Address may represent other |
| | types of locations that do not receive parcels or mail such as Telecommunication |
| | towers, etc., using the Latitude and Longitude to specify the location. |
| | Note: One example of geographic modeling is provided and it is recognized that this |
| | may not satisfy all situations. Customize this area as needed to fit customer |
| | requirements. |
| AGREEMENT | Delineates the specific AGREEMENTs between Parties concerning prices, products, |
| | terms and conditions. This area shows a very flexible way of handling the myriad |
| | details that may be involved with agreements. For example, to limit liability, set |
| | discounts for valued customers, or to establish special handling for shipping particular |
| | items. |
| | An Agreement can be related to a Rate Structure (complete re-usable “Price List”). |
| | Included in the agreement modeling are all of the parties (individuals or organizations) |
| | and the role each plays in an agreement. |
| | Customer feedback regarding Agreements is also captured. See the QUALITY |
| | FEEDBACK subject area for additional information. |
| ASSOCIATE LABOR | Used for planning and tracking Associate benefits, labor and related expenses (as |
| | opposed to HR type functions), this area also identifies the special qualifications and |
| | certifications which employees possess. |
| | An ASSOCIATE is an individual who is part of the internal organization of the |
| | Enterprise. |
| | The Associate entity has been modeled as a subtype of the Individual entity (See |
| | PARTY Subject Area). All information that Associates have in common with Individuals |
| | (human beings) will be housed accordingly in the Individual entity, instead of the |
| | Associate entity, for example, name, birth date, or gender. |
| | Additionally, this allows for Associates to behave as customers without creating any |
| | redundancy. |
| | The training level or certification level of an Associate is also captured so that checks |
| | can be made to see if the Associate is qualified to operate various equipment (i.e. fork |
| | lift, pilot certified on a specific aircraft type) or work on various equipment (like a flight |
| | attendant qualified to work 747-300s or a mechanic who is certified to work on a |
| | specific make and model of landing gear.) |
| CARGO (OVERVIEW) | Presents an overview of the information required to support Air Cargo operations at an |
| | Enterprise. |
| | It details the actual transporting of a Shipment, including all tracking information, legs |
| | and routes traveled and the Equipment utilized. |
| | This Subject Area is robust enough to support a dedicated Transportation Services |
| | organization. Enterprises with lesser needs may populate only select entities, as |
| | needed (such as the tracking status information). |
| CARGO ALLOCATION PLAN | This Subject Area deals with the allocation planning for an air cargo shipment. This |
| | means that space on specific flight(s) may be reserved in advance so that the |
| | shipment can be accommodated. |
| | Provided are business information required to perform allocation planning for an air |
| | cargo shipment: the content of the Shipment, the Pieces (or Handling Units) that make |
| | up a Shipment (either as Container or ULD types or loose freight), the Parties involved, |
| | Transportation Services requested, Class Rating of the Shipment, OnD Pairs required, |
| | scheduled legs requested, etc. |
| | This Subject Area is robust enough to support a dedicated Transportation Services |
| | organization. Enterprises with lesser needs may populate only select entities, as |
| | needed (such as the tracking status information). |
| CARGO REGULATION | Specifies the rules and regulations of transporting goods across borders. It specifically |
| | identifies the official information to be provided to the controlling Authority. |
| | It is possible to have regulations for both the importing and the exporting of goods, as |
| | well as covering goods only transiting. |
| | It also details the specialized Equipment required for Commodities with Special |
| | Handling Requirements (HazMat, etc.). |
| | Note: The structure supports the adherence to Customs Requirements when moving |
| | goods across Country borders. If needed the structure can be enhanced to cover non- |
| | Country (i.e. State or Province) borders and non-Customs compliance rules & |
| | regulations. |
| CARGO SALES | This Subject Area supports information regarding a specific Shipment. |
| | It details the content of the Shipment, the Pieces (or Handling Units) that make up a |
| | Shipment, the actual Items contained therein, the Parties involved, Transportation |
| | Services requested, Shipping Rates, Shipping Costs, etc. |
| | This Subject Area is robust enough to support a dedicated Transportation Services |
| | organization. Enterprises with lesser needs may populate only select entities, as |
| | needed. |
| | The WAY BILL is the internal document used by an airline or air freight company for |
| | internal tracking of a shipment. Way Bill Adjustments are made when a discrepancy is |
| | found between the information supplied by the shipping PARTY and the actual |
| | Shipment (i.e., Difference in Weight, Volume or Shipment Class Rating) or other |
| | circumstances such as bad debt write-off, etc. |
| CARGO TRANSPORT | Details the actual transporting of a Shipment, including all tracking information, legs |
| | and routes traveled and the Equipment utilized. |
| | This Subject Area is robust enough to support a dedicated Transportation Services |
| | organization. Enterprises with lesser needs may populate only select entities, as |
| | needed (such as the tracking status information). |
| CASINO (OVERVIEW) | This subject area deals with various interactions of a Casino Player during a Casino |
| | Visit. Casino Visit is modeled as a sub-type of the more generic Visit and the various |
| | Gaming Sessions are, in turn, related to a Casino Visit - and they refer to a period of |
| | time spent by a Casino Players at a specific Casino Game Station. |
| | Table & Slot Sessions are the various gambling avenues and are based at Casino |
| | Game Stations. Casino Markers represent a credit line that the Casino Player can |
| | utilize during certain Table Sessions. |
| | Casino Comps are complimentary rewards given to Casino Players to attract them to |
| | Casinos. Another way to encourage more Casino Visits is to offer Casino Promotions. |
| | A Player Earnings History captures the overall earnings of a Casino Player. |
| CASINO COMPS | Casino Comps are rewards given to valued customers in return for certain amount, |
| | duration, or frequency of Casino Gaming activity. Typical Comps can be Room |
| | Upgrades, free Dinner, Show, etc, This Subject Area tracks the issuing and redemption |
| | of Comps. |
| CASINO GAME SESSIONS | Focuses on Casino Player Sessions and the aggregated polling for analytical |
| | purposes. |
| DEMOGRAPHICS | This Subject Area represents categories and grouping schemes used to classify |
| | customers for marketing purposes. Multiple representations of segmentation schemes |
| | can be represented simultaneously. Some examples include: Customer Worth/Value |
| | Segments, Lifecycle/Lifestyle Groups, and Geography groups. |
| EQUIPMENT (CASINO) | Represents the actual equipment used by the Enterprise. Equipment is typically |
| | considered to be a type of fixed asset, and refers to specific individual pieces of |
| | Equipment (as opposed to a Class or Type of Equipment). Each piece of equipment is |
| | serialized and tracked over its life. |
| | CASINO GAME EQUIP is a subtype of Equipment that typically represents a table or |
| | device where CASINO PLAYERs gamble resulting in “wins” or “losses”. This Subject |
| | Area captures the Configurations defined, Installation position, and links to the Service |
| | history. |
| EQUIPMENT (MRO CONTENT) | This Subject Area supports information pertaining to the content of Maintenance, |
| | Repair and Operations (MRO) Equipment owned or leased by the Enterprise. |
| | The Equipment Series Content entity details the MRO Items that are configured in a |
| | specific Equipment Series as manufactured. This is the generic “parts list,” as |
| | differentiated from the specific (real, physical) Serialized Items that are related to a |
| | specific piece of Equipment. |
| | The Equip Serialized Content entity details a history of Serialized Items (individually |
| | uniquely identifiable) that have been part of a specific piece of Equipment. This entity |
| | contains a start date and time and end date and time to identify the range of time a |
| | specific serialized Item was part of a specific piece of equipment and also provides a |
| | history of all previous pieces of equipment in which the Item had been installed. The |
| | position on the piece of equipment is also identified. |
| | The MRO Ser Item Time Cycle entity captures the elapsed Time and/or count of |
| | Cycles since a prior MRO Time/Cycle Event (see MRO Time Cycle entity for examples |
| | of these events). If the Maintenance information is present and complete (See the |
| | MRO MAINT EVENT subject area), most of this information should/may be derivable. |
| | MRO Ser Item Time Cycle is of most use when Equipment is purchased used - in |
| | which case the Time and Cycle information should be provided by the selling party |
| | (since it would not be derivable). |
| | Note: The three character tags found as part of the Entity and Attribute names |
| | correspond to the TEI field found in Spec 2000. When populated, these data fields will |
| | be used to construct the data portion of a Spec 2000 message. |
| EQUIPMENT (TRAVEL) | Represents the actual equipment used by the Enterprise. Equipment is typically |
| | considered to be a type of fixed asset, and refers to specific individual pieces of |
| | Equipment (as opposed to a Class or Type of Equipment). Each piece of equipment is |
| | serialized and tracked over its life. |
| | Equipment breaks out into five basic subtypes. |
| | CONTAINER EQUIP represents the various containers used for shipping by the |
| | Enterprise. These could take the form of Unit Load Devices (ULD) used by the airlines |
| | or large containers used by shipping companies for land, rail or sea freight. |
| | RENTAL EQUIP represents various equipment rented to customers by the enterprise |
| | such as Rental Cars, Rental Trucks, sports equipment, etc. |
| | OPERATIONS EQUIP represents Equipment used in the operation of the enterprise |
| | such as Handling Equipment - forklift, etc, MRO Tool - oscilloscope, etc. These are |
| | high priced Fixed Assets with unique identification. |
| | POWER EQUIP represents Power Generating Equipment like Aircraft Engines, Aux |
| | Power Units (APU), etc. |
| | TRANSPORT EQUIP represents equipment used in the physical transportation of |
| | passengers and/or goods. These may be powered or non-powered (towed) such as |
| | Aircraft, Bus, Ship, Truck, Tractor, Trailer, Refrigerated Railcar, etc. |
| | Provisions have been made to capture both the passenger and cargo configurations of |
| | Transport Equipment for use in calculating transport capacity. This configuration |
| | information will determine the number of passengers carried as well as the amount of |
| | cargo that can be carried by a specific piece of Transport Equipment. |
| | Note: The three character tags found as part of the Entity and Attribute names |
| | correspond to the TEI field found in Spec 2000. When populated, these data fields will |
| | be used to construct the data portion of a Spec 2000 message. |
| EQUIPMENT EVENT | This Subject Area details an incident of interest associated with a specific piece of |
| | Transport Equipment. Routine observations may also be captured, but a more typical |
| | use is to capture anomalies. These exceptions may be related to the Equipment (such |
| | as an error message) or external to the equipment (weather conditions causing a delay |
| | or diversion) |
| | These events can be Human (Pilot, Driver, Baggage Handler, etc.) or System (onboard |
| | diagnostic computer) recorded. |
| | Log information contains Equipment Id, Incident date and time, Log entry date and |
| | time, reporting party ID, etc. |
| | A Maintenance Event is often associated with an Equipment Event that results from |
| | Equipment malfunction. |
| | Note: The three character tags found as part of the Entity and Attribute names |
| | correspond to the TEI field found in Spec 2000. When populated, these data fields will |
| | be used to construct the data portion of a Spec 2000 message. |
| FM.AP AR PA INVOICE | This subject area contains information related to various types of billing documents or |
| | Invoices encountered by a business. Invoices are presented to a bill-to-party as a |
| | request for payment for goods sold or services rendered. This Subject Area links the |
| | Invoice detail back to the originating business transactions for verification and |
| | analytical purposes. |
| | The INVOICE entity captures information about an Invoice such as Invoice Date, Host |
| | Invoice Number, Payment Terms, and Freight Terms. |
| | Accounts Payable (AP) Invoices are received from vendors for goods purchased. |
| | Accounts Receivable (AR) Invoices are sent to customers for goods sold. |
| | Project Accounting (PA) Draft Invoices are processed thru AR for projects billable to |
| | customers. |
| FM.AP INVOICE | This subject area describes the details around amounts owed to a supplier for goods |
| | and services purchased. The Accounts Payable sub-ledger holds details for these |
| | transactions including reimbursable expenses (employee expense reports) and |
| | recurring expenses. |
| | AP Invoice types include one time expenses, reimbursable expenses, and recurring |
| | expenses. |
| | AP Invoice Lines are related to Vendor Purchase Order Lines. |
| | Vendor Receipt Line compares AP Invoice quantity with Vendor PO quantity. |
| | Accounts Payable sub-ledger details are reported to the General Ledger via Ledger |
| | Batch. |
| FM.AP PAYMENT | This subject area holds payment details for AP Invoices. Payments are the partial or |
| | complete discharge of the invoice obligation, typically by its settlement in the form of a |
| | transfer of funds. Payments may be applied against obligations represented by one or |
| | more Invoices. |
| | Payment Account represents the bank or credit card account used to transfer funds. |
| | Payment Schedule defines the expected payment due dates for AP Invoices, based on |
| | Invoice Payment Terms. |
| | Payment Term Type specifies the due date and discount date for payment of a |
| | transaction. |
| | AP Invoices are often processed in a Ledger Batch for reporting to the General Ledger. |
| FM.AR INVOICE | This subject area describes the details around amounts billed to customers for goods |
| | and services sold. Summary Accounts Receivable amounts as well as sales and |
| | revenue amounts from the AR sub-ledger are recorded to the company's General |
| | Ledger. |
| FM.AR PAYMENT AND | This subject area describes the details around the process of converting Accounts |
| COLLECTION | Receivable to Cash. Payments may be received for AR Invoices, as well as interest |
| | earned, rents receivable, or periodic products and services provided. Collection |
| | activity includes any action a company takes to solicit settlement of AR obligations. |
| FM.FA FIXED ASSET | This subject area holds information needed to track the addition and disposal of the |
| | tangible property of the business. Also holds information needed to calculate and |
| | record the depreciation of an asset, including term, depreciation methods, accounting |
| | cycle, costs and residual values. |
| FM.GL.ASSET ACCOUNT | Everything a business owns is usually referred to as Assets. These range from cash |
| | and investments to natural resources such as land, timber, etc. For accounting |
| | purposes these are usually classified under three groups: Current Assets, Fixed |
| | Assets and Other Assets. Asset Account refers to a type of General Ledger Account |
| | used to track the value of these assets. |
| FM.GL.CHART OF ACCOUNT | GL Chart of Accounts Balances are actual amounts experienced through some point in |
| BALANCE | time, or budgeted amounts projected for a financial plan. Companies maintain only |
| | one record of actual amounts, but may define multiple financial plans and maintain |
| | balances for each financial plan instance. |
| | GL Chart of Accounts Balance amounts are stored for defined groups of GL segments. |
| | GL segments - accounts, sub accounts, internal departments, products, projects, etc. - |
| | relate to areas of the business which the company wants to track. GL segments are |
| | identified by unique segment ids that are combined or concatenated into segment |
| | groups to represent a valid GL Chart of Accounts number. GL Chart of Account |
| | numbers will vary in number of segments and length from company to company, but |
| | each GL segment group should contain only 1 instance of each segment id. |
| | Companies define their own GL Chart of Account numbers and Chart of Accounts, or |
| | list of accounts tracked by their accounting system, to capture the specific information |
| | required to meet the financial reporting needs of their business. Note that GL Chart of |
| | Accounts Balances may be tracked in multiple currencies. |
| | Note: The model enforces that each GL Segment Group contains a different Segment |
| | Category. However, the model does not restrict the GL Segment Group from |
| | containing multiple GL Segments from the same Segment Category. The business |
| | rule of restricting each GL segment group to contain only one instance of each |
| | segment category should be enforced in the Operational System before loading to the |
| | EDW. |
| FM.GL.EQUITY ACCOUNT | Equity is the shareholders' stake in any company/business. EQUITY ACCOUNT is a |
| | type of General Ledger account that tracks the equity amount. |
| | EQUITY ACCOUNT is mainly used to track the dividends paid out to shareholders |
| | (external equity) and the amount of retained earnings (internal equity) that a company |
| | re-invests back in the business. |
| FM.GL.EXPENSE ACCOUNT | Expense is the amount spent by a company in running the business and producing |
| | goods or services. An EXPENSE ACCOUNT is a type of General Ledger Account that |
| | keeps track of these expenses. |
| | Some of the typical expenses are SALARY, WAGES, BENEFITS, INTEREST |
| | EXPENSE, etc. |
| | Depending on the type of company, it may involve lesser or more categories. |
| FM.GL.GENERAL LEDGER | The General Ledger is a collection of all accounts used by a company or business. |
| ACCOUNT | Previously as the name suggests, the General Ledger was a collection of books that |
| | was used to physically record accounting transactions. Over time these transactions |
| | are recorded and stored by using computer software. |
| | There are five main types of GL ACCOUNTs. They are ASSET ACCOUNT, LIABILITY |
| | ACCOUNT, EXPENSE ACCOUNT, REVENUE ACCOUNT and EQUITY ACCOUNT. |
| | Each account in turn may have sub-ledgers. For example, ASSET ACCOUNT |
| | consists of FIXED ASSET or CURRENT ASSET, etc. |
| | The GL ACCOUNTs are shared by various Internal Organizations within a company. |
| FM.GL.JOURNAL ENTRY | When manual accounting systems were the norm, transactions were first recorded in |
| | the Journal and then “posted” to the ledger. The Journal is a record of accounting |
| | transactions in the order of occurrence. Supporting information referencing the events |
| | or items affected is recorded in the Journal as an entry. |
| | A journal entry is the operational record created in a general ledger system. |
| | Usually journal entries are batch processed into the general ledger system by the |
| | feeder systems. For example, a company's expense reimbursement system likely |
| | interfaces with the general ledger on a periodic cycle, resulting in a batch posting |
| | of journal entries. |
| | A journal entry has one header and multiple lines. |
| | Each JOURNAL ENTRY LINE will have a monetary amount that can be translated |
| | to accommodate the company's standard currency. |
| | A large company will likely have many SETs OF BOOKS to track journal entries. |
| | This is a mechanism to help manage the accounting process. |
| | An internal organization will use many GL ACCOUNTs to record transactions, but |
| | only one set of books. |
| FM.GL.LIABILITY ACCOUNT | The LIABILITIES of a company are the amounts it owes to other parties or |
| | organizations. |
| | CURRENT LIABILITY refers to those debts that are due within one year. |
| | The SHORT TERM DEBT refers to the principal amounts of loan due in the year. |
| | The Interest is reflected as an expense (EXPENSE subject area, INTEREST |
| | EXPENSE). |
| FM.GL.PRODUCT SEGMENT | The GL Product Segment is associated with GL Accounts in segment groups to track |
| | and report financial product information. The GL Reporting Product represents the |
| | level of detail and hierarchy required to support financial reporting requirements. The |
| | GL Reporting Product is related to the company's products and services as defined in |
| | the ITEM subject area. |
| FM.GL.PROJECT SEGMENT | The GL Project Segment is associated with GL Accounts in segment groups to track |
| | and report financial project information. The GL Project Segment is used to track |
| | details of any type of business project activity. |
| FM.GL.REVENUE ACCOUNT | Revenue (sometimes referred to as income) refers to the amount of money earned by |
| | a company. |
| | INTEREST INCOME is the amount due from investments |
| | OTHER REVENUE is the amount due from one time sale of assets or any other |
| | one-time revenue such as from re-structuring or re-organization. |
| FM.GL.SUB ACCOUNT | The GL Sub Account Segment is associated with GL Accounts in segment groups to |
| | track and report financial transactions for a company. GL Sub Accounts provide further |
| | classification detail to the main GL Accounts. For example, Selling Expense Account |
| | can be further categorized into Wage and Salary Expense, Employee Benefit Expense, |
| | etc. Sub Accounts can be used in both the general ledger and subsidiary ledger |
| | transactions. |
| FM.PA PROJECT | Project Accounting (PA) provides more granularity around project financial information |
| | than a General Ledger. PA focuses on maintaining control over revenues, costs, |
| | resources, and assets directly associated with a project. A project can be any set of |
| | related business activities for which a company wishes to track financial information. |
| | Project expenses may include associates' time and expense reports, vendor expenses, |
| | and capital expenses. Project revenue is generated when project expenses are |
| | billable to a customer. PA generates the detailed information needed to create a |
| | customer invoice, but the invoice is actually processed through the billing function of |
| | Accounts Receivable. |
| | Within PA, budgets by project, resource, task, etc. may be maintained separately from |
| | the General Ledger budget. PA supports project reporting by task, resource, vendor, |
| | and customer for different currencies and time periods. In some cases, PA tracks |
| | projects by specific project reporting periods, which may be separate from a company's |
| | accounting period. |
| FM.PA PROJECT RESOURCE | This subject area tracks items and individuals assigned to a scheduled task in a project |
| | plan. The cost and billable rates associated with these Items and Individuals will be |
| | used in the Project Financial Plan. |
| FM.PARTY | Specifies some additional Party information that may be needed for Financial |
| | Management solutions. |
| FM.PO PROCUREMENT | This subject area represents information related to the process of acquiring the goods |
| | (materials, parts, supplies, equipment) required to run the business. PO Procurement |
| | covers the process from requisition to order, to tracking receipts and returns. Also |
| | includes how that information relates to other parts of the business - for instance, the |
| | fulfillment of customer orders. |
| FM.PO PROCUREMENT RECEIPT | The PO PROCUREMENT RECEIPT Subject Area tracks the actual receipt of items |
| | ordered for comparison to the Purchase Order and related AP Invoice. It also allows |
| | for analysis as to whether the original due dates for the receipt were actually met. |
| FM.PO PROCUREMENT RETURN | This subject area holds information about transactions where the receiving PARTY |
| | sends back to the vendor or supplier Item(s) that were previously received. |
| HOSPITALITY DINING | This Subject Area supports all the aspects of the dining experience: dining |
| TRANSACTION | reservations, dining transactions, menu items, ingredients that make up the menu |
| | items and the detailed guest check. |
| | Tracks the person (Associate) who served the customer(s) and such details as the |
| | table number and zone (or area) within the establishment and the number of guests in |
| | the party. Carryout is also supported. |
| HOSPITALITY GROUP EVENT | This Subject Area represents an organized set of activities hosted by the enterprise to |
| | serve the needs of a Group Client. Various Parties involved in such a transaction are |
| | explicitly modeled. They can be also modeled in a more abstract fashion (see Party |
| | Tran Role in the TRAVEL TRANSACTION (OVERVIEW) subject area). Both |
| | approaches are presented in the model and the appropriate methodology could be |
| | adopted as per client needs. |
| HOSPITALITY RETAIL PURCHASE | Models transactions of non-travel products such as retail items (magazines, souvenirs, |
| | t-shirts, etc.) along with payment made by customers/guests. As such, these are not |
| | reflected in the TRAVEL PURCHASE subject area. For a pure retailer, it also covers |
| | additional areas as can be seen by the examples below. |
| | Within a Retail Purchase, we have the area representing food (Dining Transaction) and |
| | other retail, non-food concepts (Shopping Transaction associated entities) |
| | The term “Retail Purchase” for this subject area was chosen as best fitting the cross- |
| | channel concept. We could not use the term “order” since it has no real meaning in the |
| | P.O.S. (store) world, and the terms “market basket” or “P.O.S. transaction” do not fit |
| | the Web and catalog channels. |
| | The concept of Retail Purchase is used for the following: |
| | Web: Wish List Registry (as in Wedding Registry, etc.), Order, etc. |
| | Store: Market Basket/P.O.S. Sale, Layaway, Reservation, etc. |
| | Catalog: Order |
| | Dining Transactions are modeled minimally in this version to take into account the food |
| | service facilities/amenities available at a Hotel/Resort. This section can be extended |
| | along similar lines to the modeling of non-food entities (Shopping Transaction and |
| | related entities) as per customer requirements. |
| HOSPITALITY ROOM CHARGES | Groups together all financial transactions and activities that can tie back to a Room |
| | (Folio) in one area. This provides a comprehensive view of a customer spend during a |
| | Visit. |
| INVENTORY (EXTERNAL) | Describes the adjustments to Inventory where at least one EXTERNAL Location is |
| | involved. Control of Inventory is transferred to or from a Third Party and Inventory is |
| | adjusted accordingly. |
| | Example: |
| | Allocation (Fulfillment) due to Sales |
| | Sales Returns |
| | Vendor Receipts |
| | Vendor Returns |
| | Captures physical and calculated stock levels and value. Additionally, provides for |
| | controlling in-stock and replenishment levels. |
| | Inventory is a company's merchandise, raw materials, and finished and unfinished |
| | products which have not yet been sold or consumed. It can be individually valued by |
| | several different means, including cost or current market value, and collectively by |
| | FIFO (First in, first out), LIFO (Last in, first out) or other techniques. |
| | In the Maintenance, Repair Overhaul (MRO) Industry, this inventory can also represent |
| | maintenance parts, components, sub-assemblies, etc. This subject area would deal |
| | with these items as they were acquired by the airline or sold to another airline or MRO |
| | company. |
| INVENTORY (INTERNAL) | Outlines the adjustments to Inventory where only internal Locations are involved. |
| | Control of Inventory is not transferred to or from a Third Party, rather maintained by the |
| | Enterprise. |
| | Example: |
| | Inventory Transfers |
| | Audit Adjustments |
| | Wastage |
| | Inventory Request by a location (such as a MRO Shop) - note that in this case no |
| | stock level adjustment will be made until the actual transfer take place |
| | Captures physical and calculated stock levels and value. Additionally, provides for |
| | controlling in-stock and replenishment levels. |
| | Inventory is a company's merchandise, raw materials, and finished and unfinished |
| | products which have not yet been sold or consumed. It can be individually valued by |
| | several different means, including cost or current market value, and collectively by |
| | FIFO (First in, first out), LIFO (Last in, first out) or other techniques. |
| | In the Maintenance, Repair, and Overhaul (MRO) Industry, this inventory can also |
| | represent maintenance parts, components, sub-assemblies, etc. that are being tracked |
| | either as spare parts or as parts under repair in a shop facility. This subject area |
| | enables tracking of these items as they are moved between maintenance facilities or |
| | stores locations or discarded as scrap. It also tracks the use of parts as they are |
| | incorporated into a new inventory item such as a component or sub-assembly. |
| INVENTORY (MRO) | This Subject Area delineates the adjustments to Inventory associated with |
| | Maintenance Event activity. Specifically these Inventory items are Maintenance, |
| | Repair, and Overhaul (MRO) ITEMs, items that are used or consumed during MRO |
| | activities. These Inventory adjustments may take place as a result of Line |
| | Maintenance, Hangar Maintenance or Overhaul/Repair activity. |
| | Note: The three character tags found as part of the Entity and Attribute names |
| | correspond to the TEI field found in Spec 2000. When populated, these data fields will |
| | be used to construct the data portion of a Spec 2000 message. |
| INVOICE | Supports INVOICING for Purchases and Sales. |
| | An Invoice is a request for payment for services rendered or goods provided. |
| | The Subject Area also covers the Invoicing of Transportation Services (see shaded |
| | entities). |
| | This Subject Area links the Invoice detail back to the originating business transactions |
| | for verification and analytical purposes. |
| ITEM (CARGO) | This Subject Area supports Items that deal with the Shipment of goods. In this case, |
| | an item can also represent a specific service offered by an Air Cargo provider. |
| | Transport Service Items define the Special Handling (accessorial) Services and |
| | Transport Services offered by the Air Cargo provider. The combination of these |
| | selected by the customer determine the pricing for a particular Shipment. |
| ITEM (DEFINITION) | An Item is a grouping of one or more products, parts or services and the optional, |
| | corresponding price plan, rate structure or unit charge that may be used by the |
| | organization for the purpose of generating revenue. An Item is what a customer |
| | purchases or subscribes to, and/or what the Enterprise use to carry out its operations. |
| | This section is richly modeled permitting each Item to exhibit an unlimited number of |
| | traits (color, size, weight, etc.), to maintain cost and price histories, to be grouped in |
| | higher-level categorizations, to be associated with standardized commodities, etc. |
| | Items may also be grouped to permit specialized analyses as needed. |
| | A Sales Plan is provided to permit forward planning for all salable products and |
| | services. |
| | Multi Item and its associated Entities identify an Item (MRO item, product or service) |
| | which is comprised of other Items. These may be major system assemblies (serialized |
| | or not), travel packages, or gift packs, etc. |
| | Inventory Item and its associated Entities help identify specific Items for inventory |
| | management. Serialized Item and its associated Entities identify specific items, their |
| | serial numbers and content. |
| ITEM (HOSPITALITY) | Highlights the Travel Products covered by the Hospitality segment of the Travel |
| | Business. This will include a breakout of various Hospitality Products such as: |
| | Lodging Products - i.e. Rooms, Suites, etc |
| | Hospitality Activities - e.g. golf, tennis, theater, etc. |
| | Hospitality Rental Items - e.g. Beach Umbrellas, Cars, etc. |
| | Hospitality Retail Items - e.g. Logo Shirts, Souvenirs, etc. |
| | Hospitality Services - e.g. Massage, Golf Lesson, etc. |
| | Gift Certificate Items - e.g. Certificates for various hospitality products and |
| | services. |
| | Menu Item Ingredients are shown in detail and associated with specific Menu items so |
| | that cost can be established for various restaurant offers. |
| ITEM (MRO) | Supports Items that are used in the Maintenance, Repair, and Operations of an |
| | enterprise. MRO Items are parts, sub-assemblies, components, etc., associated with |
| | the maintenance of aircraft, trains, ships, etc. |
| | This Subject Area supports Spec 2000 developed by the ATA for communication of |
| | maintenance activities between an airline and the airframe and engine manufacturers. |
| | Spec 2000 defines the specific identification techniques to be used to uniquely identify |
| | a part used in the maintenance operation. This Subject Area supports both the Spec |
| | 2000 and traditional approach to uniquely identifying Serialized Parts. |
| | Multi Item and its associated Entities identify an Item which is comprised of other |
| | Items. This can be used to identify all parts associated with a component or |
| | components and parts associated with a sub-assembly like a landing gear. |
| | Note: The three character tags found as part of the Entity and Attribute names |
| | correspond to the TEI field found in Spec 2000. When populated, these data fields will |
| | be used to construct the data portion of a Spec 2000 message. |
| ITEM (OnD) | Presents the actual product or services sold through the Travel Transaction. |
| | The Flight Product is defined by the legs and segments which make up the flight |
| | between the Origin and Destination (OnD). Legs reflect the actual flights from one |
| | take off to one landing. |
| | Segments are used by the marketing department to define Products that can be sold. |
| | For example, a flight from LA to New York City with a stop in Chicago would have two |
| | legs - LA to Chicago and Chicago to New York City and three segments - LA to |
| | Chicago, Chicago to New York City and LA to New York City. Legs are used by the |
| | Operations departments while Segments are used by Sales and Marketing. |
| | Support is provided for Code Share flights by the Flight Codeshare entity. This allows |
| | airlines to assign their flight numbers to other airline flights and treat them as their own. |
| | Segment Flown (Summary) and Leg Flown (Summary) provide the history required to |
| | support Revenue Management by an airline. |
| ITEM (OVERVIEW) | This Subject Area details all the Items of interest to the enterprise. |
| | An Item may be salable (as in the case of goods and services sold to customers) or |
| | not (bulk items, or items used by the enterprise, not for resale). |
| | A salable item may be a service performed by the Enterprise for a customer OR a |
| | physical or virtual item provided to the customer. |
| | Salable Items may be purchased by the customer via a Travel Transaction. |
| | In dining establishments, An Item may be an Ingredient (raw material) that is used |
| | (typically along with other ingredients) to create a Menu Item. An Ingredient is not |
| | salable to customers by itself. |
| | Items that need to be warehoused are represented by the Inventory Item entity. |
| | Item supports both high level Bulk (Wholesale) Items, as well as the lowest level for |
| | which inventory is tracked and sales records are kept. It can sometimes be analogous |
| | to a SKU (Stock Keeping Unit). |
| | Item characteristics are described via the generic Item Trait structure. Specific Item |
| | characteristics (color, style, etc.) are not shown as attributes since they do not apply to |
| | all items. |
| | Note: The color-coded entities represent Sub-Industry-Specific information that will not |
| | apply to all Enterprises. |
| | Travel Products are further sub divided into Origin and Destination Products, travel |
| | related items like lift tickets, etc. and Hospitality Products such as hotel rooms, spa |
| | services, restaurants, etc. Since the Travel Product entity is recursive, many distinct |
| | Travel Offers can be built for sale that include a wide variety of Travel Products. |
| | Items treated as parts for Airline Maintenance are defined as MRO Items and are |
| | tracked as inventory within the airline. See ITEM (MRO) Subject area for more details. |
| | Transport Service Items define the Special Handling Services and Transport Services |
| | offered by the Air Cargo provider. |
| ITEM PRICING | Supports Item Pricing and Costing. The inclusion of effective dates allows for historical |
| | (and future) pricing information to be captured. |
| | The Pricing Id is used to define a “set of conditions” for which a single price applies for |
| | a specific date range. |
| | Note: You typically have multiple Pricing Ids (and prices) for the same Item. This can |
| | be due to: |
| | date (price change over time) |
| | condition set (different price by channel, region, etc.) |
| | volume scale (lower price based on volume purchase) |
| | A set of Pricing Ids and Items can be collected in a Rate Structure than can in turn be |
| | made available to Customers. |
| | Note: Since the Item entity allows for the capture of 3rd Party Items (like that of a |
| | Competitor), this structure will also allow the capture of 3rd Party pricing information |
| | (such as Competitors, Suppliers, etc.), in addition to the enterprise's own pricing |
| | structure. |
| | Note: The levels at which this is done may differ by enterprise. |
| | Support is provided for pricing of Shipments. Pricing is based on two components, the |
| | Transport Rate and rates for any Special Services performed. The Transport Rate is |
| | determined by a number of factors: |
| | The Class Rating of the items to be shipped. The rating is based on the |
| | “transportability” of the goods, which in turn is determined by density, stowability, |
| | ease of handling, and liability. |
| | The weight and volume of the item being shipped. |
| | The distance the item is being shipped. |
| | The mode (i.e. air, truck, sea, etc.) being utilized to ship the Item. |
| | The Weight Break involved. If a shipment is close to a weight break, the cost of |
| | the lower of the two rates must be used. |
| | Pricing for Special Services is set by the shipping Party. |
| LOCATION (AIRLINE) | Highlights the various LOCATIONs associated with the operation of an Airline. It |
| | defines specific Airline owned, leased or used facilities where they do business and |
| | interact with customers. Locations external to the Enterprise can also be captured |
| | (such as Travel and Transportation facilities, Competitor and Partner Locations, etc.). |
| | These facilities can be physical or virtual. |
| | It also details the T&T Facility associated with the product or service, e.g., the |
| | departure and arrival Airport for customers traveling by plane. |
| | Various Maintenance, Repair, and Overhaul (MRO) facilities are defined to support |
| | Airline MRO activities. These include MRO Stores, MRO Hangar and MRO Shop. |
| | The Equip (Spares) Location allows an airline to assign various spares to a particular |
| | aircraft to be used as an Inventory Location to house or store Parts (Items) and allows |
| | all Inventory Transactions to operate on this virtual Location. |
| | Note: The three character tags found as part of the Entity and Attribute names |
| | correspond to the TEI field found in Spec 2000. When populated, these data fields will |
| | be used to construct the data portion of a Spec 2000 message. |
| LOCATION (DEFINITION) | This Subject Area is used in conjunction with the Address subject areas to define |
| | specific enterprise owned, leased or used facilities where business is done and |
| | interaction with customers occurs. Locations external to the Enterprise can also be |
| | captured (such as Travel and Transportation facilities, Competitor and Partner |
| | Locations, etc.). These facilities can be physical or virtual. |
| | At the highest level, Locations may be grouped together for administrative or reporting |
| | purposes. While one example of a Location hierarchy is provided, it may be |
| | customized as needed to satisfy customer needs. Local Sales Territories are also |
| | provided. |
| | Locations may be contained inside another location (Airline Counter inside an Airport; |
| | Restaurant in a Hotel, etc.) or may be “owned” by another Location, e.g., subsidiaries |
| | owned by a parent Location. |
| | A cost structure tracks all planned and actual costs that apply to each Location. These |
| | may be grouped by categories for administrative needs or analyses. |
| | For internal transfer of inventory a cross-reference provides lead-time and distance |
| | between any two Locations. |
| LOCATION | Highlights the various Locations associated with Hospitality and Gaming. It defines |
| (HOSPITALITY/CASINO) | specific Enterprise owned, leased or used facilities where Hospitality and Gaming |
| | companies do business and interact with customers. These facilities can be physical |
| | or virtual. |
| | Support is provided for Lodging properties to show their property configurations, wings, |
| | room offerings and rates. |
| | Gaming facility layout is defined by the series of Casino entities, tying all gaming tables |
| | and machines, etc., to specific zones within a Casino |
| | Restaurant layout analysis is supported by the series of Dining entities, grouping areas |
| | of interest (counter, bar, etc.) within discrete zones in a Restaurant. |
| | Locations may be co-located with or inside other locations, such as a Casino and |
| | Restaurant inside a Hotel. Each location is identified by an Owner, for example, a |
| | Franchise Coffee Shop owned by the Franchisee located in a Casino owned by the |
| | Casino operator. |
| LOCATION (OVERVIEW) | This Subject Area provides an overview of the various Locations associated with an |
| | Enterprise. It is used in conjunction with the Address subject areas to define specific |
| | enterprise owned, leased or used facilities where business is done and interaction with |
| | customers occurs. Locations external to the Enterprise can also be captured (such as |
| | Travel and Transportation facilities, Competitor and Partner Locations, etc.). These |
| | facilities can be physical or virtual. |
| | Lodging Properties, Resorts and Casinos are some of the Locations used for gaming |
| | and hospitality. |
| | This area also details the T&T (Travel and Transport) Facilities associated with a |
| | product or service. For example, the departure and arrival Airports for a particular |
| | Flight Product.. |
| MODEL SCORE & FORECAST | This Subject Area supports information regarding the Analytical Models used to |
| | predict, cluster, or classify information that is typically used in Data Mining and |
| | Knowledge Discovery. For example, A Model that describes the propensity for a |
| | customer to defect given a previous set of circumstances. |
| MRO MAINT EVENT | Captures Maintenance Events required to support an Enterprise's MRO Operations. |
| | The objective is to minimize equipment down time and ensure that the equipment, the |
| | proper maintenance personnel (those qualified to do the work) and the proper parts |
| | and tools required to perform the maintenance activity are scheduled to be at the right |
| | place at the proper time to do the prescribed maintenance. |
| | Both Line Maintenance Activities and Shop Maintenance Activities are supported in |
| | this Subject Area. |
| | Scheduled and Unscheduled maintenance events are supported with Scheduled |
| | maintenance driven by Maintenance Specifications (MRO Spec) |
| | Note: The three character tags found as part of the Entity and Attribute names |
| | correspond to the TEI field found in Spec 2000. When populated, these data fields will |
| | be used to construct the data portion of a Spec 2000 message. |
| MRO MAINT SPEC | Houses the Maintenance Specifications defined for the upkeep of various pieces of |
| | Equipment operated by the Enterprise. Details the specifications for all maintenance |
| | activities such as removal, repair, installation, etc., together with the associated |
| | expected resource requirements. |
| | These specifications are typically provided by the Equipment Manufacturer, Internal |
| | Engineering Group, or outside Safety/Oversight Groups. |
| | MRO Spec represents Specifications for the proper and timely maintenance of |
| | Equipment including such items as Service Bulletins, MRO Specs to attain additional |
| | levels of Certification for an Item or piece of Equipment, Detail lists of standard |
| | maintenance tasks that make up a Maintenance Check Level such as an A, B or C |
| | Check and Maintenance procedures for various non-scheduled maintenance tasks. |
| | Note: The three character tags found as part of the Entity and Attribute names |
| | correspond to the TEI field found in Spec 2000. When populated, these data fields will |
| | be used to construct the data portion of a Spec 2000 message. |
| MULTIMEDIA | This Subject Area models the various multimedia elements that the enterprise uses to |
| | construct (mainly) marketing collateral. |
| | Multimedia Object refers to various multimedia elements that can be used to construct |
| | a web page, advertisement, catalog, etc. Multimedia Objects may be identified with |
| | Items (products or services) or Item Groups as necessary. |
| | For example: images (pictures or graphics, etc.), text, video, audio, etc., may be |
| | represented. |
| PARTY | This Subject Area contains the core of basic information about each customer or |
| | potential customer known by the company. The Party entity (that can be an Individual, |
| | Household, or Organization) is a powerful construct that allows an enterprise to market |
| | or sell to any or all of the above, without the need for additional relationships at the |
| | subtype level. The main purpose is to track the customer lifecycle and allow a |
| | company to know who their customers are and how they used products and services. |
| | It also contains information on their business partners and suppliers. |
| PRIVACY | The Privacy Subject Area deals with customer privacy, the ability to “opt-in” or “opt-out” |
| | of personal data collection and use and to “opt-out” of disclosure to third parties. The |
| | “direct marketing” opt-out should therefore be considered beneficial in terms of |
| | improving customer satisfaction and decreasing marketing costs. |
| | Note: Typically, privacy preferences will be established for Individuals. However, they |
| | may also be established for Households or Organizations. |
| PROMOTION | This Subject Area contains information about advertising campaigns and product or |
| | service promotions conducted by the company, tracking specific target groups and |
| | evaluating campaign effectiveness via customer responses. |
| | Each Promotion has one or more corresponding PROMO OFFERs that feature |
| | everything from discounted rates to specially priced services and awards. Often these |
| | are used in conjunction with specific CRM offers to highly targeted MARKET |
| | SEGMENTs of their customer base. |
| QUALITY FEEDBACK | This Subject Area is used to capture feedback received by the enterprise (typically |
| | regarding the quality of it products and services), in an effort to improve the same. |
| | The feedback can be planned: |
| | Contracting a third party to contact individuals and solicit feedback |
| | Periodic inspections and ‘mystery shopper’ activities conducted by the enterprise |
| | Soliciting feedback from Customers (satisfaction & rating cards, etc.) |
| | The feedback can be spontaneous: |
| | consumers contacting the enterprise |
| | The type of feedback can be free format (such as a customer call or email received), or |
| | structured (as in surveys). |
| | Note: This Subject Area concentrates on feedback that is both actionable and |
| | classifiable. |
| | The Unstructured Feedback structure captures ‘non-formal’ interactions that are |
| | typically difficult to encode (as opposed to ‘formal’ interactions, such as orders, |
| | payments, etc.). These interactions are typically ‘free form’ (phone conversations, |
| | letters, etc.). Attributes are provided to enable summary representative standard codes |
| | to describe the essence of the contact to make analysis possible. |
| | Feedback and Customer contacts that can only be represented in verbose text, without |
| | any classification, is difficult/impossible to analyze in a data warehouse environment |
| | (but it will obviously still have value to the analyst that reviews that specific individual |
| | case) |
| RFID/SERIALIZED ITEM | This Subject Area provides a view of all aspects of Serialized Item tracking present in |
| TRACKING | the model in one convenient place. |
| | The primary reason for creating this content was to support the emerging use of RFID |
| | (Radio Frequency Identification) Technology. To translate well in the RFID universe, |
| | the current industry agreed standard of EPC (Electronic Product Code) is shown as a |
| | way of tagging Serialized Items. |
| | EPC Note: The Electronic Product Code (EPC) is a unique number that identifies a |
| | specific item, case, pallet, or object) in the supply chain. The EPC is stored on a radio |
| | frequency identification (RFID) tag, which combines a silicon chip and an antenna. |
| | Once the EPC is retrieved from the tag, it can be associated with dynamic data such |
| | as from where an item originated or the date of its production. Much like a Global |
| | Trade Item Number (GTIN) or Vehicle Identification Number (VIN), the EPC is the key |
| | that unlocks the power of the information systems that are part of the EPC global |
| | Network (from http://www.epcglobalinc.org). |
| | The important thing to realize is that this structure can be used to accommodate ANY |
| | implementation of Serialized Item tracking - it need not use RFID technology. |
| | The Subject Area tracks the four different types of movement of Serialized Items: |
| | 1. Movement to & from our Suppliers (top left area) |
| | 2. Movement in between our Internal Locations (top right area) |
| | 3. Movement to & from our Customers (bottom area) |
| | 4. Tracking of Shipments during Transportation (bottom area, tan shaded entities). |
| | Supports tracking at the package/container level (Piece), as well as at the content |
| | level (Shipment Line Item). |
| | All of these Serialized Tracking entities also appear on their respective Subject Areas - |
| | see the ITEM, INVENTORY, SALES (INTERNAL), and CARGO Subject Areas for |
| | more context. |
| | Note: The model represents the case of unique serial numbers for both the Serialized |
| | Item entity and the EPC Item entity. If there is a need to represent non-unique serial |
| | numbers, a small adjustment would need to be made by adding a Quantity attribute to |
| | all Serialized Item instances - this quantity attribute is obviously not needed in the case |
| | of unique serial numbers - since the quantity for any serial number will always be 1. |
| | Note2: The naming choice of EPC (“Electronic Product Code”) by the EPC Global |
| | Network is somewhat misleading, since it need not refer to a “Product”, and their |
| | usage of “EPC Number” (“Electronic Product Code Number”) is less than elegant, so it |
| | is not copied here. |
| TIME PERIOD | This subject area can be used to map country specific holidays/events, climate and |
| | sales seasons. Additionally, it can be used to map into the enterprise's accounting and |
| | fiscal time periods. |
| | CALENDAR DATE |
| | Keep in mind that this structure can be used to map whatever time structure the |
| | retailer uses into CALENDAR DATEs. These time periods can be non-standard, for |
| | example, alternating 4- and 5-week months, weeks that start on Wednesdays. |
| TRAVEL OnD PERFORMANCE | This Subject Area depicts the ultimate resolution of a Scheduled Leg. This Subject |
| | Area is tied closely to the Travel Trip Event Subject Area. Provision has been made in |
| | this Subject Area to track various Leg Incidents in case some irregular operation takes |
| | place for a specific OnD Product. |
| TRAVEL PNR OPERATIONS | This Subject Area can be used to capture the raw/unparsed PNR (Passenger Name |
| | Record) information from the operational reservation system. It can be useful to have |
| | this information in the Data Warehouse for specialized PNR Decode needs, or where |
| | the original PNR “of record” is needed. |
| | This subject area maps the actual PNR data captured as part of PNR decode and |
| | allows the image of the PNR to be stored in the warehouse for later evaluation and |
| | display. |
| | Detail PNR data is used in the Revenue Management area and can be used by |
| | customer service to access PNR data for PNRs that have been deleted from the |
| | Reservations system. |
| | The bulk of the “decoded” PNR (Passenger Reservation) information is provided in a |
| | clear, relational form in the Subject Areas dealing with RESERVATIONs and |
| | PURCHASEs. This Subject Area is provided to satisfy customer requests to us to |
| | provide the ability to mine the “raw” source PNR data after it has been purged from the |
| | Reservation system. This will allow the retrieval of previously non-decoded information |
| | if needed. |
| TRAVEL PURCHASE | This area covers transactions & payments of travel products such as Lodging Product, |
| | Flight Product, Golf Product, Spa Service, etc. It also represents the “ticketing” aspect |
| | of passenger travel. |
| TRAVEL RESERVATION | This Subject Area deals with making reservations (or “bookings”) for travel. The |
| | Reservation is held until Payment is made or it expires. The model supports Travel |
| | Reservations (For eg., Cruise Line Reservations, Lodging Reservations, Airline |
| | Reservations, etc) and Activity Reservations (Limo, Spa, Golf, etc). |
| | Support is provided for SPECIAL REQUESTs and CUSTOMER PREFERENCEs. The |
| | CUSTOMER PREFERENCEs are linked to the profile information in the PARTY |
| | Subject Area. CUSTOMER PREFERENCEs are long term values set by customers to |
| | reflect their preferences. These would include items such as seating or meal |
| | preferences. SPECIAL REQUESTs would apply for this reservation only. These would |
| | include wheel chair request, traveling with a bicycle, or traveling with an animal. |
| | The QUOTED CHARGE entity is required to hold the multiple associated charges of |
| | the RESERVATION ITEM quoted to the consumer. These prices change on a minute |
| | to minute basis due to the Yield Management routines at work so a record of what is |
| | quoted to a customer for a specific reservation is important. |
| TRAVEL TRANSACTION | This Subject Area represents the actual transaction with the customer for a travel |
| (OVERVIEW) | package or service. The concept of a VISIT reflects a customer's interaction with the |
| | Product Provider at a specific Location. It can reflect a web site visit, a visit to the |
| | Casino, a call to the Reservation Center or a physical visit to a City Ticket Office or |
| | Airport Ticket Office. |
| | The concept of “Transaction Role” is introduced to identify a Party's role in the |
| | transaction. This could be the person making the reservation, the travel agent they are |
| | using, the party paying for the trip, the person(s) taking the trip, etc. |
| | The TRAVEL TRANSACTION Subject Area relates the three main aspects of the travel |
| | transaction: BROWSE, RESERVATION and PURCHASE. The activities for |
| | RESERVATION and PURCHASE are covered in more detail in the TRAVEL |
| | RESERVATION and TRAVEL PURCHASE Subject Areas. |
| TRAVEL TRIP EVENT | Records the pre-travel Check-in Event, Boarding Event, and post travel (lost luggage, |
| | for example) experiences of travelers. |
| | Each aspect of the en-route experience is covered by different entities. |
| | It also includes the pre-stay and actual stay information about Hospitality customers. |
| | The Lodging series of entities capture this activity from check-in and changes (room |
| | changes, etc.), to check-out. |
| | As the basis for improvement of the guest experience, Feedback (compliments or |
| | complaints, etc.) from a traveler/guest is captured and linked to a specific event |
| | experienced by the customer. |
| VENDOR (SUPPLIER) | This area deals with a type of ORGANIZATION that supplies ITEMs to the Enterprise |
| | for resale or internal use. |
| | This area models purchase orders made to the VENDOR and receipt of the ITEMs in |
| | return. Additionally VENDORs may provide FULFILLMENT of the ITEMs to the |
| | customer (drop ship). |
| | Return of ITEMs to the VENDOR is supported in the VENDOR RETURN entity with the |
| | VENDOR RETURN REASON being tracked as key part of this business entity. |
| | Monetary allowances made to the Enterprise by VENDORs are recorded in VENDOR |
| | ALLOWANCE. |
| | RECEIPTS PLAN provides future planning of purchases to be made from the |
| | VENDOR. This business entity is supported as part of the INVENTORY Subject Area. |
| WEB OPERATIONS | Represents aspects of running and maintaining the servers and the web pages that |
| | support the enterprise-owned web site. This subject area is highly operational in |
| | nature and includes information on server activity (including status codes), the |
| | software running on the servers, users who log onto the server and the pages viewed |
| | by web site visitors. |
| WEB SITE | The Web Site structures the presentation of information for consumer perusal and use. |
| | The information represents all web pages (with navigation hierarchy represented) and |
| | multimedia objects (including advertising) for the enterprise-owned sites and also |
| | represents external web sites (3rd party) and the advertising the enterprise places on |
| | those sites. |
| WEB VISIT | Describes all aspects of “Clickstream” information - data that is captured during a |
| | consumer's visit to a virtual location such as a Web Store or Kiosk. This extensive |
| | area provides much information about a customer's visit whether they purchase or not. |
| | “Wish List”, “Shopping Cart/Bag”, and “Order”: |
| | All three of these concepts are represented by the Shopping Transaction (and Line) |
| | entities. They also pertain to Travel Reservation Items and Travel Purchase Items. |
| | The model represents the state at the end of the Visit, and it also tracks on which Web |
| | Page a customer was when they placed an Item into the virtual shopping cart. |

APPENDIX B
Entity Definitions

| Entity | Entity Definition |
|---|---|
| ACCOUNT | An account established by a PARTY with an ORGANIZATION typically to |
| | facilitate and enable the transfer of funds. |
| | Also used for the purpose of rendering bills and receiving payments by |
| | collecting moneys owed for business transactions by a PARTY. Can also be |
| | used to track “loyalty” activities, in the form of a LOYALTY ACCOUNT. |
| ACCOUNT TRANSFER | Used for tracking any assignment of ACCOUNTs to another. |
| | Example: |
| | A manager may carry over the FOLIO ACCOUNTs from his associates on |
| | a business trip to his own. |
| | Transfer of frequent flier miles between two account holders, etc. |
| ACCOUNT TYPE | Describes a kind of ACCOUNT. |
| | Example: Checking, Credit Card, Loyalty, etc. |
| ACCOUNTING PERIOD MONTH | This entity defines the calendar dates that are contained within a given |
| | accounting month. |
| ACCOUNTING PERIOD MONTH WEEK | This entity defines the calendar dates that are contained within a given |
| | accounting week in a month. |
| ACCOUNTING PERIOD QUARTER | This entity defines the calendar dates that are contained within a given |
| | accounting quarter. |
| ACCOUNTING PERIOD WEEK | This entity defines the calendar dates that are contained within a given |
| | accounting week. |
| ACCOUNTING PERIOD YEAR | The entity that indicates what calendar dates comprise a given accounting |
| | year. |
| ACCOUNTS PAYABLE | The entity that provides details of ACCOUNTS PAYABLE for a company. |
| | ACCOUNTS PAYABLE records how much a company owes suppliers for the |
| | purchase of supplies or services on credit. |
| ACCOUNTS RECEIVABLE | The entity that provides details for the ACCOUNTS RECEIVABLE accounts. |
| | ACCOUNTS RECEIVABLE are the PAYMENTs a company expects to collect |
| | from a PARTY, generally from a completed transaction of sales or services |
| | rendered. ACCOUNTS RECEIVABLE accounts are types of current assets. |
| ACCRUED LIABILITY ACCOUNT | The entity that provides details for the accrued liabilities. Accrued liabilities |
| | recognize expenses incurred during the accounting period but not yet paid. |
| ACTIVITY PURCHASE ITEM | Represents an Item or Service that is purchased and includes an activity such |
| | as a Golf Product, Spa Service, etc |
| ACTIVITY RESERVATION ITEM | Tracks information regarding any kind of activity reservation (golf, spa, limo, |
| | dining, etc). |
| | This is information that pertains only to the specific reservation, as opposed to |
| | the actual Item that was reserved. |
| ACTIVITY TYPE | Categorizes the type of activity - dining, golf, spa, etc |
| AD | A marketing message aimed at a segment of consumers. Usually mentions |
| | specific products or services. Can be placed in magazines, on web pages, |
| | television, etc. |
| AD OBJECT | An associative entity that tracks MULTIMEDIA OBJECTs involved in the |
| | creation of an AD |
| AD TYPE | Discriminates between types of ADs such as Radio, TV, Web, etc. |
| ADDRESS | An ADDRESS provides a means of communications such as postal address, |
| | telephone number, or electronic address (e.g. e-mail). An ADDRESS may |
| | also represent a physical mailing location (e.g. street, post office box). |
| ADDRESS TYPE | Indicates if an ADDRESS is a MAILING ADDRESS, ELECTRONIC, or |
| | TELEPHONE. |
| ADDRESS USAGE | The way an ADDRESS is used in a specific instance, usually by a PARTY. |
| | Example: market to, bill to, ship to, customer service, etc. |
| ADJUSTMENT REASON | Specific reason for an adjustment within ADJUSTMENT TYPE. |
| | Example: |
| | For ADJUSTMENT TYPE of “Goodwill” we can have reasons of: |
| | packaging lightly damaged |
| | driver late |
| | item damaged |
| | wrong item |
| | For ADJUSTMENT TYPE of “Bad Debt” we can have ADJUSTMENT |
| | REASON of: |
| | Company out of business |
| | Customer refuses to pay |
| | For ADJUSTMENT TYPE of “Rating change” we can have ADJUSTMENT |
| | REASON of: |
| | Weight differs from stated |
| | PIECE not Classed properly on the Bill of Lading |
| ADJUSTMENT TYPE | A High level classification of why an adjustment was made. Also see |
| | ADJUSTMENT REASON. |
| | Example: |
| | Goodwill |
| | Debit |
| | Rating change |
| | Bad debt |
| | Increase adjustment |
| ADVERTISING AND PROMOTION ACCT | Sales brochures, promotional events, advertising. |
| AGREED TERM | A specific term that forms part of a specific AGREEMENT. |
| | Examples: |
| | Discount of 5% |
| | Max Liability of x amount |
| | Payment Term is 30 days |
| | etc. |
| AGREEMENT | Defines the specific AGREEMENT with a specific PARTY relative to prices, |
| | terms and conditions. |
| | Example: |
| | A recent agreement for volume discounts with MidTown Freight |
| | Forwarding Services for shipment of specific types of commodities |
| | replaces the previous Agreement with that customer which ended last |
| | month. |
| | Priority Unloading and Customs Clearing (An Accessorial or Special |
| | Service) is guaranteed for all shipments by J&J Services. |
| AGREEMENT FEEDBACK | Feedback received from a PARTY related to an AGREEMENT. |
| | Example: Customer provided feedback on existing Agreement Volume Pricing. |
| AGREEMENT PRICING | Defines the specific Pricing RATE STRUCTURE that is referenced in an |
| | AGREEMENT with a PARTY (typically a customer). |
| AGREEMENT STATUS | Defines the status of an Agreement. |
| | Example: |
| | Active, Cancelled, Expired. |
| AGREEMENT STATUS HIST | Defines the status change for a specific Agreement. |
| | Example: |
| | 2/4/1999 Active |
| | 6/6/2005 Cancelled |
| AGREEMENT TERM | A specific term that forms part of an AGREEMENT. |
| | This allows for re-use of identical Agreement Terms in multiple Agreements. |
| | Examples: |
| | Late Delivery Penalty of 0.5% |
| | Max Liability of x amount |
| | Volume discounts |
| | Negotiated Rates |
| | Due Dates |
| | Payment Terms are 30 days |
| | etc. |
| AGREEMENT TERM TYPE | The type of term that can be specified in an AGREEMENT. |
| | Examples: |
| | Late Delivery fine |
| | Max Liability |
| | Specialized Billing |
| | Special Handling services |
| | Exclusivity Clause |
| | Payment Terms |
| | Freight Terms (who pays for shipping) |
| | etc. |
| AGREEMENT TYPE | Indicates the specific type of AGREEMENT. |
| | Example: |
| | Pricing Agreement |
| | Delivery Agreement. |
| AIRCRAFT | This entity reflects a specific airplane used to transport passengers and goods. |
| AIRLINE | A company that transports cargo and/or passengers via air for profit. |
| | Listed by the U.S. Department of Transportation (DOT) and the International |
| | Air Transport Authority (IATA). |
| AIRLINE HUB | This entity contains capacity statistics by airline for any major airport or airline |
| | center of operations (hub). |
| AIRLINE RESERVATION | This entity represents the intention (reservation) made by a passenger to |
| | purchase an airline ticket for the purpose of boarding a Revenue Flight |
| | between City Markets. |
| AIRLINE TICKET | This entity represents the Ticket issued to a passenger |
| | for the purpose of boarding a Revenue Flight between |
| | cities. |
| AIRPORT | Locations or Facilities where Air Transportation originates and terminates and |
| | where passengers and/or cargo are taken on (or offloaded). |
| AIRPORT LOUNGE AWARD | This entity is a subtype of Award Certificate and allows a specific airline |
| | customer to gain access to the VIP LOUNGE. |
| AMORTIZATION METHOD | This reference entity contains the method or type of gradual and periodic |
| | reduction (amortization) of any amount, such as the periodic write-down of the |
| | cost of an intangible asset or periodic payment of debt. |
| ANALYTICAL MODEL | Describes a process used to predict, cluster, or classify information. Typically |
| | used in Data Mining and Knowledge Discovery. |
| | Examples: Booking Forecast, MRO Forecast, Customer Scoring and |
| | Segmentation, a model that describes the propensity of a customer to engage |
| | in a particular activity etc. |
| AP INVOICE | This entity identifies an INVOICE or billing document received by the company |
| | from a third party VENDOR as a request for PAYMENT for goods purchased |
| | or services received. The AP INVOICE entity captures transaction information |
| | such as Invoice Date, Host Invoice Number, Payment Terms, and Freight |
| | Terms. |
| | Detailed information about AP INVOICEs and amounts owed to third party |
| | VENDORS is tracked in the Account Payable sub ledger. Summary Accounts |
| | Payable amounts as well as expense amounts from the AP sub ledger are |
| | recorded to the company's General Ledger. |
| | Accounts Payable appears on the company's balance sheet as a current |
| | liability, since the expectation is the liability will be paid in less than a year. |
| | When accounts payable are paid off, it represents a negative cash flow for the |
| | company. |
| AP INVOICE EXPENSE | This entity is a sub-type of AP INVOICE. It is one of four sub-types. The other |
| | three are AP REIMBURSABLE EXPENSES, AP RECURRING EXPENSE and |
| | OTHER INVOICE EXPENSEs. |
| | AP INVOICE EXPENSE pertains to INVOICEs for costs incurred to operate |
| | the company and billed to the company directly by the VENDOR, such as |
| | manufacturing materials and FIXED ASSETs. |
| AP INVOICE LINE | AP INVOICE LINEs provide line item billing details for Items or Services |
| | purchased by the company. This entity identifies detailed information related to |
| | the lines on a specific AP INVOICE. |
| | AP INVOICE LINE includes information such as the quantity and unit of |
| | measure for the invoice line item, as well as description. |
| AP INVOICE LINE AMOUNT | This entity relates the invoice line with the monetary value amount for the line |
| | item, such as tax amount or freight line amount. The amounts are recorded in |
| | transaction, local accounting and global currencies. |
| AP INVOICE LINE PAYMENT | Further classifies an Invoice Line Payment as a remittance related to a specific |
| | line item on an Accounts Payable invoice. |
| AP INVOICE LINE STATUS ASSIGN | This entity tracks the status of an AP INVOICE LINE, such as cancelled, |
| | approved, pending, send, etc. |
| AP INVOICE TYPE | This entity defines the type of AP INVOICE such as AP Invoice Expense, AP |
| | Reimbursable Expense (Employee Expense Reports), AP Recurring Expense, |
| | or Other Invoice Expense. |
| AP RECURRING EXPENSE | This entity is a sub-type of AP INVOICE. It is one of four sub-types. The other |
| | three are AP REIMBURSABLE EXPENSEs, AP RECURRING EXPENSE and |
| | OTHER INVOICE EXPENSEs. |
| | AP RECURRING EXPENSE pertains to periodic business expenses for which |
| | the company may not receive an INVOICE for each period, such as rent. |
| AP REIMBURSABLE EXPENSE | This entity is a sub-type of AP INVOICE. It is one of four sub-types. The other |
| | three are AP REIMBURSABLE EXPENSES, AP RECURRING EXPENSE and |
| | OTHER INVOICE EXPENSEs. |
| | AP REIMBURSABLE EXPENSE pertains to expenses submitted for |
| | reimbursement via employee expense reports. Expense reports cover the |
| | purchase of goods and services to operate on behalf of the company, such as |
| | travel expenses. |
| APPROVAL STATUS | The outcome of a request for approval of a non-cash transaction from a |
| | financial ORGANIZATION. |
| | Example: “confirm id of INDIVIDUAL”, “deny purchase”, etc. |
| AR COLLECTION ACTIVITY | This entity contains AR scheduled payment activity information. |
| | There is one instance for each scheduled payment for each activity type and |
| | each occurred date. |
| | AR COLLECTION ACTIVITY includes any action a company takes to solicit |
| | settlement of AR INVOICE obligations. Customer contact by phone, written |
| | notices or Dunning Letters are common actions taken to pursue PAYMENT of |
| | unpaid INVOICEs. |
| AR COLLECTION ACTIVITY TYPE | This entity classifies the types of AR COLLECTION ACTIVITY. |
| | For example: dispute, customer contacted, follow-up, etc. |
| AR INVOICE | This entity identifies an INVOICE or billing document issued by the company to |
| | a third party Customer as a request for PAYMENT for goods sold or services |
| | rendered. The AR INVOICE entity captures transaction information about |
| | such as Invoice Date, Host Invoice Number, Payment Terms, and Freight |
| | Terms. |
| | Detailed information about AR INVOICEs and amounts owed by third party |
| | customers is tracked in the Account Receivable sub ledger. Summary |
| | Accounts Receivable amounts as well as sales and revenue amounts from the |
| | AR sub ledger are recorded to the company's General Ledger. |
| | Accounts Receivable appears on the company's balance sheet as a current |
| | asset, since it is expected these amounts can be collected in less than a year. |
| | When accounts receivable are collected, it represents a positive cash flow for |
| | the company. |
| AR INVOICE LINE | This table has one row per AR INVOICE LINE. Line type can be item line, tax |
| | line, or freight. Records the quantities ordered, invoiced, and credited along |
| | with the unit price. |
| AR INVOICE LINE AMOUNT | This associative entity relates the AR INVOICE LINE AMOUNT with the |
| | amounts for the AR INVOICE LINE item, such as tax amount, freight line |
| | amount, as defined in the Invoice Amount Type Cd. The amounts are recorded |
| | in transaction, local accounting and global currencies. |
| AR INVOICE LINE QUANTITY | Defines quantity and unit of measure by various types of quantities to a |
| | specific AR INVOICE LINE. Examples of quantity types are credited, invoiced |
| | and ordered. |
| AR INVOICE LINE RECEIPT | Further classifies an Invoice Line Payment as an amount collected related to a |
| | specific line item on an Accounts Receivable Invoice. |
| AR INVOICE LINE TYPE | Table to hold all the line types for the INVOICEs in AR. Defines the type of |
| | invoice line. Examples: “Chargeback”, “Charges”, “Freight”, “Line”, “DM- |
| | Reversal”, and “Tax”. |
| AR INVOICE REASON TYPE | This minor entity defines the reason for invoicing. |
| | Examples are: |
| | AR Billing Error |
| | Cancellation - Customer cancellation of an order |
| | Contracts - Contract Lines have been billed |
| | Credit And Rebill |
| | Duplicate Billing |
| | Foreign - Foreign interface credit memo |
| | Free Product - Invoiced for free product in error |
| | Invalid Claim |
| | Late Payment Finance Charge |
| | Order Entry Error - Order admin. entry error |
| | Product Return |
| | Sales Tax Error - Sales tax billing error |
| | Shipping And Handling - Billed for shipping and handling in error |
| | Wrong Freight - Incorrect freight was charged |
| | Wrong Tax Rate - Incorrect tax rate was used. |
| AR INVOICE TYPE | Contains the list of all the In Use AR INVOICE TYPEs. |
| | Examples of Invoice Types are Invoice, Invoice Local, Invoice State, and |
| | Projects Credit Memo. |
| ASN | Advance Shipping Notice. A notice (typically an electronic transmission used in |
| | EDI) to notify the recipient of a Shipment that the Shipment has shipped (or is |
| | about to). |
| | Links to a detailed Shipment entity. |
| ASSET | Specific asset owned by the enterprise. |
| | Example: |
| | Boeing 737 model 300 Tail Number N3232 |
| | Unit Load Device Serial Num 3234 for a Boeing 757 |
| | Framostat Test Equipment Ser #34344. |
| | Hospitality Example: |
| | HiDef A/V Projector - Asset ID 2004567 |
| | Multi-Line Slot Machine Serial Number FG-567304 |
| ASSET ACCOUNT | The entity that indicates a general ledger account is an ASSET ACCOUNT. |
| | These accounts represent tangible or intangible property owned by a company |
| | or business. Types of ASSET ACCOUNTs include cash, accounts receivable, |
| | and inventory. |
| ASSET ACCOUNT TYPE | The entity that identifies the type of asset like fixed asset, current asset, or |
| | other asset. |
| ASSET TYPE | Describes the particular kind of ASSET. |
| | Example: Handling Equipment, Transport Equipment, Aircraft, etc. |
| ASSOCIATE | An individual who works under the direct control of the enterprise such as |
| | Employees, Contractors, Temporary Workers, etc. |
| ASSOCIATE BENEFIT EXPENSE | A history of an ASSOCIATE's non-productive hours and costs for a type of |
| | benefit. |
| | Example: sick, vacation, training, jury duty, for a specific period at a specific |
| | LOCATION. |
| ASSOCIATE EXPENSE HIST | A summary or history of all labor and benefit expenses related to the |
| | employment of an ASSOCIATE for a given period by expense type. |
| | Note: This is an example of History/Summary that can be kept if the atomic |
| | level information is not available. The granularity can be changed if required |
| | (adding work shift, etc. if needed). |
| | In this example, it is also assumed that the time period selected would be |
| | granular enough to allocate the expenses for a given period to a single |
| | location or department. |
| ASSOCIATE EXPENSE TYPE | Indicates the specific type of expenses involving an ASSOCIATE. |
| | Example: |
| | Vacation |
| | Sick Leave |
| | Danger Pay |
| | Overtime |
| | etc. |
| ASSOCIATE LABOR EXPENSE | A history of an ASSOCIATE's labor hours and cost for a type of hours, e.g. |
| | regular, overtime, holiday, for a specific period at a specific LOCATION. |
| | This structure can also be used to capture expenses made in the period, but |
| | not linked to hours, such as bonus, commission, etc. |
| ASSOCIATE POSITION | Denotes the specific position of the employee. |
| | Example: |
| | Dock Manager, Fulltime Cashier Level 2, Fork Lift driver, Black Jack Dealer, |
| | Sr. Manager of Accounting, Assistant Manager of Customer Service, Sales |
| | etc. |
| | Note: We allow for multiple associates to have the same associate position. If |
| | the requirement is for it to be unique, the relationship from associate to |
| | associate position should be changed to be 1:1 instead of 1:m. |
| ASSOCIATE QUALIFICATION | Details all Certifiable Qualification obtained by an Associate. Also captures |
| | Date obtained & Certifying Party. |
| | Example: |
| | Degree in Electronic Engineering |
| | Passed Ethics and Compliance HR Course |
| | Certification to drive vehicles up to a certain tonnage or size |
| | Certification to perform tear down and rebuild activities on specific types |
| | of equipment |
| | Certification to inspect the safety aspects of a class of equipment |
| | Casino/Gaming Example: |
| | Qualified to deal Black Jack in the state of Nevada |
| | MRO Industry Example: |
| | The level of certification required for the Associate (Mechanic) to be |
| | qualified to perform the associated maintenance activity. |
| | This certification level is often set by a federal agency like the FAA in order to |
| | ensure safety standards. |
| AUDIT TRANSACTION | A Type of Inventory Adjustment Transaction. |
| | Describes a stock adjustment prompted by a physical inspection of inventory |
| | that differed from what was expected. |
| | Typically a Stock Count. This count usually reveals actual levels of inventory |
| | that is different from what is expected, requiring item stock adjustments to be |
| | made to reflect the new actual counts. |
| | Note: It can also be used in ‘non-official’ stock count situations, e.g. when |
| | attempting to transfer 20 in stock items, it is found that none are actually |
| | present. This delta can now be recorded using this entity. |
| AVAILABLE CASH ACCOUNT | The entity that provides details for the AVAILABLE CASH ACCOUNTs or cash |
| | on hand. These asset accounts represent any cash in currency, checks, |
| | marketable securities or near cash items. AVAILABLE CASH ACCOUNTs are |
| | types of current assets. |
| AWARD | The entity that represents an award presented to, or requested by the |
| | customer as a result of redemption of loyalty points (or provided as |
| | compensation by the enterprise for having provided poor service). |
| | Example: |
| | Domestic First Class Round Trip Airfare, |
| | Presidential Suite Hotel Room |
| | 1 Class Upgrade (Flight/Hotel) |
| | Free Dinner for Two |
| | Hospitality Example: |
| | Complementary Hotel Stay |
| | Complementary Event Tickets |
| | etc. |
| AWARD TYPE | Groups Awards by Type. |
| | Example: |
| | Airport Lounge Award, |
| | Hotel Class Upgrade Award, |
| | Flight Class Upgrade Award, |
| | Dining, |
| | Entertainment, |
| | etc. |
| AWARD VOUCHER | The actual Loyalty Award or type of Award requested, issued, and eventually |
| | redeemed by a customer. |
| | Can be manifested in a serialized Award Certificate, Casino Comp, etc. |
| | NOTE: A Loyalty Award can be obtained as either a direct Earning (such as |
| | rewarding a special achievement, promotion, (Casino) Comp, etc.), OR as a |
| | redemption (such as when loyalty points are redeemed for an Loyalty Award) |
| BAGGAGE CHECK | The entity that reflects the act of placing baggage in the care of the |
| | transportation provider to transport in a separate baggage compartment at the |
| | time of CHECK-IN |
| BAL SHEET GL MAIN ACCOUNT TYPE | The entity that indicates the types of general ledger accounts are on the |
| | Balance Sheet financial statement. Examples are asset account, liability |
| | account and equity account. |
| BALANCE SHEET GL MAIN ACCOUNT | The entity that indicates a general ledger account is in the Balance Sheet |
| | statement category. Types of this category include Asset, Liability and Equity |
| | Accounts. |
| BANK DRAFT | This entity contains information for BANK DRAFTs used for a PAYMENT. It is |
| | related to PAYMENT by PAYMENT ACCOUNT and PAYMENT BANK DRAFT |
| | ASSIGN. |
| | A BANK DRAFT is a negotiable instrument drawn against funds deposited to a |
| | PAYMENT ACCOUNT, to pay a specified monetary amount to a specific |
| | PARTY upon demand. |
| BANQUET EVENT | Contains Group Event information that only pertains to Banquets. |
| BOARDING DENIED | The entity that reflects the act of denying boarding to a passenger by a travel |
| | provider at the time of CHECK-IN |
| BOARDING EVENT | The entity that reflects the customer's act of boarding an aircraft for a specific |
| | FLIGHT SEGMENT. It follows a CHECK-IN EVENT and requires a boarding |
| | coupon. The boarding coupon contains class and seating information as well |
| | as the flight and departure information. |
| BOOKING CLASS | A grouping of FARE BASIS codes for the purpose of accepting and controlling |
| | bookings in its reservations system. Ideally, the reservations system booking |
| | classes would have a one-to-one correspondence with the number of fare- |
| | basis codes (and price levels) on each flight, such that seat availability limits |
| | could be established for each price level. Most airline reservations systems, |
| | however, are limited in the number of bookings classes they use for any one |
| | flight, meaning that airlines must combine multiple fare-basis codes into one |
| | booking class. This problem is, of course, exacerbated by the fact that each |
| | flight also carries passengers from many different O&D markets, each with its |
| | own set of potentially different fare-basis codes. |
| BORDER EVENT | Captures the Customs (or Regulatory) compliance events at Border Crossings. |
| | Example: |
| | 24 Import Notification |
| | Customs Hold |
| BRAND | A unique name created by an ORGANIZATION to build customer recognition |
| | and affinity for a group of related ITEMs. Some ORGANIZATIONs own many |
| | BRANDs, while others build their Corporate name into a BRAND. |
| | Example: |
| | Wonder Bra (owned by Victoria's Secret) |
| | Coca-Cola, Sprite, Evian, Fanta, Minute Maid, Tab (all owned by Coca- |
| | Cola) |
| | Note: As in the above Coca-Cola example, the Brand Owner may also create |
| | a Brand from their own name. |
| BRAND OWNER ORG | The ORGANIZATION that created, owns, and controls a specific BRAND. It is |
| | a subtype of PARTY. |
| | Example: |
| | Victoria's Secret (owns Brand: Wonder Bra) |
| | Coca-Cola (owns Brands: Coca-Cola, Sprite, Evian, Fanta, Minute Maid, |
| | Tab, etc.) |
| | Note: As in the above Coca-Cola example, the Brand Owner may also create |
| | a Brand from their own name. |
| BROWSE | A type of TRAVEL TRANSACTION that captures what Travel Products have |
| | been looked at but not reserved or purchased. |
| BROWSE ITEM | The specific items viewed as part of a BROWSE session by a customer. |
| BROWSER APPLICATION | Web browser application being used. Example: Microsoft Internet Explorer, |
| | WebTV, Netscape Navigator, Mozilla, etc. |
| BROWSER ID | Defines a specific instance of a unique Web Browsing Application on a specific |
| | computer. This identifier is placed in the actual browser used by the visitor |
| | (typically) in the form of a “cookie”. This technique allows the enterprise to |
| | track and identify the browsing specifics of this ‘tagged’ browser application. |
| | Note that since the browser application is tagged (not the user or the |
| | computer), that: |
| | We cannot tell the difference between multiple individuals using the same |
| | browser application. A browser application in a public place (like a library/ |
| | internet cafe) may have only 1 Browser Id, but hundreds of individual |
| | visitors. |
| | If multiple browsers exist on a PC, the will have multiple BROWSER IDs |
| | Even with these restrictions, this is a valuable technique for: |
| | tracking visitors who do not identify themselves, |
| | recognizing known visitors who choose to not log in and self-identify when |
| | starting a new visit. |
| BROWSER VERSION | Version of web browser application a being used. Examples: Microsoft Internet |
| | Explorer 6.0, WebTV 1.0, Netscape Navigator 6.0, etc. |
| BUS | This entity reflects a ground based vehicle used for transporting multiple |
| | customers and/or goods. |
| BUS DEPOT | The domain of locations where Bus Transportation occurs, |
| | Example: Where Buses depart and arrive and passengers board or get off |
| | buses. |
| BUS ORGANIZATION | This entity reflects the domain of Bus Transportation Carriers as listed with the |
| | Department of Transportation (DOT) and the International Association of |
| | Public Transport. |
| BUS PRODUCT | All of the published city markets providing bus transportation services by Bus |
| | Organization. |
| BUS TICKET | This entity represents the Ticket issued to a passenger for the purpose of |
| | boarding. |
| BUSINESS | A formal organization that is a legal entity (e.g. has a tax status with the |
| | government) consisting of one or more individuals formed for the purpose of |
| | conducting business or providing a service. |
| BUSINESS CONTACT | The INDIVIDUAL from the Group Client responsible for the GROUP EVENT |
| | and who serves as the point of contact between the enterprise and Group |
| | Client. |
| BUSINESS LEGAL CLASSIFICATION | The domain of codes used in the legal classification of the businesses. |
| | Examples are: |
| | Sole proprietor |
| | Partnership |
| | Limited Partnership |
| | Master limited Partnerships |
| | Corporation |
| | Subchapter |
| | S-Corporation |
| | Non-Profit |
| | Trusts |
| BUSINESS NAICS | The association of a business to one or more North American Industry |
| | Classification (NAICS) codes. A business may have multiple NAICS codes |
| | with one primary classification. |
| BUSINESS SIC | The association of a business to one or more standard industry classification |
| | (SIC) codes. A business may have multiple SIC codes with one primary |
| | classification. |
| BUYER | An ASSOCIATE whose duty it is to make purchasing and planning decisions |
| | for a group of ITEMs. |
| | Example: Hugh R is responsible for planning and purchasing “MRO |
| | Consumables”; Peter H. is responsible for planning and purchasing for the |
| | Item Class “Cosmetics.” |
| CAGE | Commercial and Government Entity (CAGE) Code is a 5 digit code that |
| | identifies companies doing or wishing to do business with the (United States) |
| | Federal Government. Typically the codes, administered by Defense Logistics |
| | Information Service, include U.S., Canadian and NATO CAGE Codes. |
| | Note: This example is specific to the U.S. The non-US equivalent is the NATO |
| | NSCM Code. |
| | Spec2000: Spec 2000 has adopted the CAGE/NSCM codes as a standardized |
| | way to identify Spec 2000 users. |
| | In Spec 2000, CAGE/NSCM Codes are used to identify Manufacturers, |
| | Suppliers and Repair Agencies. Both CAGE and NSCM codes are assigned |
| | by the Defense Logistics Services Center (DLSC) |
| CALENDAR DATE | Allows for the grouping of Gregorian dates by any period defined by the |
| | enterprise. The attributes shown here represent possible rollup periods. |
| CALL CENTER | A subtype of LOCATION. Typically a facility for customers to contact the |
| | enterprise via telephone to place orders, to obtain tracking and tracing |
| | information, as well as where customer service support or customer |
| | reservation is provided. |
| CAMPAIGN | A campaign is a concentrated effort to retain, acquire or consolidate customers |
| | or to build an image. It has a specific start and end date and typically consists |
| | of multiple promotions. The goal of a campaign is usually to enhance the |
| | image of the enterprise, and/or drive more business and/or obtain more |
| | customers. |
| | Example: Sony launches a 3-month campaign to build brand awareness. They |
| | create several consumer oriented promotions, TV ADs, etc. to support the |
| | campaign. |
| | Your Airlines launches a 6-month campaign for Business Class non-stop |
| | coast-to-coast flights, etc. |
| CAMPAIGN STRATEGY | The business objective or strategy of the Campaign. |
| | Example: Increase sales of snowmobiles in America east of the rocky |
| | mountains. |
| CANCELLED CNX | A subtype entity of LEG INCIDENT entity detailing a scheduled leg that was |
| | cancelled. |
| CAPACITY MEASURE | Indicates a capacity measure to be attributed to Cargo Equipment |
| | Example: |
| | Volume (inside) |
| | Volume (exterior) |
| | Maximum Net Weight (loaded) |
| | Tare Weight (empty) |
| | Height (exterior) |
| | Height (Interior) |
| | etc. |
| CAR RENTAL ORGANIZATION | This entity reflects the domain of Car Rental Agencies for both U.S. and |
| | International locations. |
| CAR RENTAL RESERVATION | This entity represents the intention (reservation) made by a customer to rent a |
| | passenger vehicle or truck for a specified period in a designated market. |
| CARGO CAPACITY | Specifies all the capacity measures for a specific Cargo Configuration for a |
| | Transportation Vehicle. |
| CARGO CONFIG | A specific configuration established within a piece of Transportation equipment |
| | for Cargo/Freight usage. |
| CARGO CONTAINER CONFIG | The count of Containers of a specific type that may be used in a particular |
| | Cargo Configuration. |
| | Note: A Transportation Vehicle with a specific Cargo Configuration (or Cargo |
| | Space) may have several different combinations of Cargo Containers that can |
| | be fitted in the same space (since 2 or more smaller containers may fit in the |
| | exact same space as one larger Container). These are indicated by Version |
| | Numbers. |
| | Example: 4 type 1 and 4 type 2 ULDs configured for a Boeing 737 extended |
| | distance model, etc. |
| CARGO SHIPMENT | Goods picked up at the same time and transported from one shipper at one |
| | origin to one receiver at one destination. |
| | Note: Shipping Date is not an attribute of this Entity - See Shipping Event |
| | instead. |
| CARRIER | A transportation company that is engaged in transporting products or items |
| | from one location to another for hire. This can include Parcel Delivery, LTL |
| | and TL trucking companies. |
| | Examples: |
| | Yellow Freight, |
| | FedEx, |
| | UPS, |
| | Roadway, |
| | Arkansas Best Freight, |
| | Reddaway, |
| | Bestway |
| | The term “Carrier” may also apply to Air Carriers, either Commercial Airlines or |
| | Air Cargo Carriers, in the case of Air Cargo. |
| CARRIER FORECAST | Used for future projections & forecasts for a given ITEM (SERVICE) to be |
| | provided by a given CARRIER in the case of Interline Transportation. |
| | Accommodates multiple simultaneous methods and forecast sources. Can |
| | also house the “actual” quantity to compare against “forecast”. |
| | NOTE: This information is externally supplied by the CARRIER to the |
| | enterprise. It is of great value to compare an enterprise's forecast with a |
| | partner CARRIER's forecast. Any significant delta indicates potential resource |
| | allocation problems. |
| CASINO | A sub-type of LOCATION where customers VISIT for gambling and |
| | entertainment. |
| CASINO ACCOUNT | This is an account issued by a CASINO to aid CASINO PLAYERS to gamble |
| | on credit. This structure is also used to keep track of ‘front money’ deposited |
| | by customers who then draw on this (their own money) during table sessions. |
| | Note: The balance can be negative (indicating the amount of money owed to |
| | the casino) or positive (the amount of player money being held by the casino) |
| CASINO ACCOUNT EVENT | A specific set of actions that increase or decrease the balance of a CASINO |
| | ACCOUNT. |
| CASINO ACCOUNT EVENT TYPE | Classifies the different CASINO ACCOUNT EVENTs such as marker issue, |
| | debt repayment, etc. |
| CASINO ACCOUNT HIST | A history of all credit and debit amounts associated with a CASINO |
| | ACCOUNT. This is an example of a physicalized/history construct that would |
| | be needed if all information since inception is not available. |
| CASINO DAY | There is often a requirement for a Business Day to span Calendar Days, such |
| | as when business transacted after midnight (the next calendar day) needs to |
| | be grouped together with business transacted prior to midnight as a cohesive |
| | “Business Day.” |
| | This entity specifies all the Casino Gaming Days. How these Gaming Days are |
| | derived from Calendar date/timestamps are specified in this entity's Supertype. |
| CASINO DEBT REPAYMENT | Tracks payments made by players to settle their debt and/or pay off markers. |
| CASINO DEBT WRITTEN OFF | The event denoting debt being cancelled or forgiven from an account as a loss |
| | to the CASINO |
| CASINO FRONT DEPOSIT | Money that the CASINO PLAYER deposited as “Front money deposit” and is |
| | currently available to the CASINO PLAYER to draw against. |
| | Typically used by players who do not want to carry a large sum of cash, and |
| | do not want (or can not get) casino credit. |
| CASINO GAME DAY | This is a further breakdown of the Casino Day concept. |
| | It is used in areas where Casino Days can differ by Game Type (such as New |
| | Jersey). In this case, the Casino Day for a given Game Type will override the |
| | Casino Day defined at the Property (Casino) level. |
| CASINO GAME EQUIP | A Specific table or device where CASINO PLAYERs gamble resulting in “wins” |
| | or “losses.” |
| | Example: |
| | Bally 3 wheel $1 Slot Machine Asset ID 384372 |
| CASINO JUNKET | A Group Event by a Casino to bring in a group of Customers for a specific |
| | period of time. Often arranged via a Third Party that is compensated by |
| | headcount or a share of the generated revenue/profit. |
| CASINO LOYALTY EARNING | Credits or points earned as a result of GAMING SESSIONs |
| CASINO MARKER | A line of credit issued to a CASINO PLAYER against a CASINO CREDIT |
| | ACCOUNT. It is a counter check made out to the CASINO and signed by the |
| | CASINO PLAYER. |
| CASINO MARKER ISSUE | The event denoting the issue of a CASINO MARKER to a CASINO PLAYER, |
| | tallied against a CASINO ACCOUNT |
| CASINO PLAYER | An INDIVIDUAL who is specifically identified to play/gamble in a CASINO |
| | facility. |
| CASINO PLAYER COMP | CASINO COMP (for Complimentary) is the Casino's way of rewarding loyal |
| | customers by issuing free “perks.” Typically, the amount of COMP is |
| | calculated by the amount of money spent (or the “turnover” during gaming) by |
| | the customer irrespective of wins or losses. |
| CASINO PLAYER HIST | A history of all earnings & status changes associated with a CASINO |
| | PLAYER. It tracks earnings and maintains current as well as lifetime balances |
| | along with player ratings and status. |
| | Note: This is an example of a physicalized/history construct that would be |
| | needed if all information since inception is not kept. |
| CASINO PROMO | This is an invitation only gathering of guests that could be part of a GROUP |
| | EVENT or a PROMOTION EVENT hosted by the CASINO. |
| CASINO PROMO TYPE | Categorizes the various CASINO PROMOs such as VIP poker game, Amateur |
| | Blackjack Tournament, etc. |
| CASINO RATING | A measure or ranking of the CASINO PLAYER applied to a CASINO VISIT |
| | (and/or a specific GAMING SESSION). Typically the ranking depends on the |
| | amount of money used in the bet, how many bets were placed, speed at which |
| | the bets are placed, etc. |
| CASINO SWEEPSTAKE | A Type of Promotion where customers can enter to win prizes. |
| CASINO VISIT | A period of time that a CASINO PLAYER spends at a CASINO. |
| CASINO VISIT TYPE | Classifies the CASINO VISIT. |
| | Example: VIP, Promo, Personal, Group, Tournament, etc. |
| CASINO ZONE | Describes a sub area within a CASINO. |
| | Example: |
| | The VIP/High Roller area. |
| | Note: If the ‘sub area’ can ‘independently’ conduct business (let's say a |
| | restaurant inside a casino, or a pharmacy inside a supermarket, then it should |
| | be a LOCATION, not a ZONE |
| | Note: This entity can also be made recursive if nested Zones are required. |
| | That way it can also be used to, let's say, record the different Decks in a |
| | Cruise Ship used for gaming, and the VIP area on a specific Deck. |
| CASINO ZONE TYPE | Describes a type of sub area within a LOCATION. |
| | Example: The VIP/High Roller area within a casino; the smoking section (or |
| | bar area) within a restaurant. |
| | Note: If the ‘sub area’ can ‘independently’ conduct business (let's say a |
| | restaurant inside a casino, or a pharmacy inside a supermarket, then it should |
| | be a LOCATION, not a ZONE |
| CENSUS BLOCK | A grouping of ADDRESSes used by the government, which reflects statistical |
| | information based on polls, surveys, or market research. Usually a subset of |
| | POSTAL CODE. |
| | Example: A grouping of 3 member HOUSEHOLDs in a small geographical |
| | area. |
| CERTIFICATE PAYMENT | This entity is a sub-type of payment and represents a method of payment for |
| | the acquisition of a Ticket. |
| | It represents specific redemption certificates used to purchase a Ticket such |
| | as Award Certificate, or when a flight is overbooked and a passenger gives up |
| | a confirmed seat in return for a Free Ticket. |
| | Example: Mileage Redemption, Free Ticket, etc. |
| CERTIFICATE TYPE | Types of redemption certificates used to purchase a Ticket such as Award |
| | Certificate, or when a flight is overbooked and a passenger gives up a |
| | confirmed seat in return for a Free Ticket. |
| | Example: Mileage Redemption, Free Ticket, etc. |
| CERTIFICATION | Specifies a Qualification that is substantiated by an official certification. |
| | Note: If a hierarchical Grouping of Certifications is required, this entity can be |
| | enhanced to be recursive. |
| | Example: |
| | Degree in Electronic Engineering |
| | Passed Ethics and Compliance HR Course |
| | Certification to drive vehicles up to a certain tonnage or size |
| | Certification to perform tear down and rebuild activities on specific types |
| | of equipment |
| | Certification to inspect the safety aspects of a class of equipment |
| | Casino/Gaming Example: |
| | Certification to deal Black Jack in the state of Nevada |
| | MRO Industry Example: |
| | The level of certification required for the Associate (Mechanic) to be |
| | qualified to perform the associated maintenance activity. |
| | This certification level is often set by a federal agency like the FAA in |
| | order to ensure safety standards. |
| CHAIN | Represents all stores owned by a Corporation or retail Organization, which |
| | perform the same retail business activity using the same consumer brand |
| | identity. |
| | For the Lodging industry, This can also apply to all Hotels or Casinos owned |
| | and branded alike by a Corporation |
| | Retail Example: Sam's Club and Wal-Mart Stores are two CHAINs of the Wal- |
| | Mart Corporation |
| | Hotel Example: Marriott Courtyard and Resident Inn Hotel by Marriott are two |
| | CHAINs of the Marriott Corporation. |
| CHANNEL | The various venues in which Items or Services are sold. |
| | Locations (facilities) belong to 1 specific Channel. A specific Item or Service |
| | price may vary across Channels. |
| | Example: Internet, Call Center, Over the Counter (In-Person Point of Sale.) |
| CHANNEL USAGE TYPE | This minor entity describes the usage of the channels. For example, |
| | marketing, sales, electronic, etc. |
| CHARGE TYPE | A type of charge that is in addition to the Item or Service that was bought or |
| | sold. |
| | Travel Example: Transfer Fee, Landing Tax, Shipping, Handling, Insurance, |
| | Expedited Shipping, (Customs) Duty, Meal ticket, surcharge for bringing a pet, |
| | etc. |
| | Note: For the Cargo Industry, Shipping and handling would not be considered |
| | “Charges”, since it actually represent the Services sold by the Enterprise. |
| CHARITY DONATION | The sub-type for redemption certificates used to contribute airline mileage to |
| | charitable organizations. |
| CHART OF ACCOUNT | This entity allows the grouping of CHART OF ACCOUNT SEGMENTs to |
| | represent the structure of a CHART OF ACCOUNTs number. |
| CHART OF ACCOUNT BALANCE | The entity that indicates the actual account balance amounts for defined |
| | groups of CHART OF ACCOUNT SEGMENTs. CHART OF ACCOUNT |
| | SEGMENTs identify areas of the business the company wants to track - |
| | accounts, sub accounts, internal departments, products, etc. - that when |
| | combined or concatenated into segment groups represent valid GL account |
| | numbers. |
| CHART OF ACCOUNT SEGMENT | This entity identifies individual segments that when combined compose a |
| | company's accounts. |
| CHART OF ACCOUNT SEGMENT XREF | This entity associates CHART OF ACCOUNT SEGMENT Ids with a CHART |
| | OF ACCOUNT. |
| CHECK OUT METHOD | Classifies the check-out process - Counter/Front Desk, Telephone, Television, |
| | Express, Kiosk, etc. |
| CHECKING ACCOUNT | An agreement between a PARTY and a financial ORGANIZATION to establish |
| | an account to draw funds against using a checkbook. |
| | Example: Bank of America VIP Plus Checking Account #333-444-333 |
| CHECKPOINT | The recording of a progress event for a given shipment. |
| | Example: |
| | Departure Scan |
| | Arrival Scan |
| | etc. |
| CITY | A geographical region within a TERRITORY. Can also be a hamlet, village, |
| | township, etc. |
| | Example: Los Angeles, Dijon, etc. |
| CITY TICKET OFFICE | Travel ticket office located in any given city at a location other than a |
| | Travel/Transportation Location |
| CLAIM | The entity that represents a request for reimbursement by a customer due to a |
| | failure to fulfill a transportation agreement or a shortage or damage to cargo. |
| | Each of these situations would result in a CLAIM being filed by the receiver of |
| | the item against the transportation company. |
| | Examples: |
| | Item was damaged in transit and must be replaced. |
| | Item was delivered two days later than contracted time of delivery, so a |
| | penalty must be paid by the carrier. |
| CLAIM REASON | The entity that identifies the reason for a claim against a transportation |
| | company. |
| | Example: |
| | for CLAIM TYPE “Loss” this could be: |
| | Theft |
| | Misplaced, etc. |
| | for CLAIM TYPE “Damage” this could be: |
| | Water |
| | Destroyed |
| | Salvage |
| | Contaminated, etc. |
| CLAIM STATUS | A unique code that reflects the status or resolution of a claim. |
| | Example: |
| | Open |
| | Paid |
| | Partial Paid |
| | Denied |
| CLAIM TYPE | The entity that identifies the high level type of claim. |
| | Example: |
| | Loss |
| | Damage |
| CLASS RATING | The entity that identifies the different classifications used by transportation |
| | companies to classify ITEMS for SHIPMENT for rating/pricing purposes. |
| | The rating is based on the “transportability” of the goods, which in turn is |
| | determined by density, stowability, ease of handling, and liability. |
| | Some Rating Systems could be a simple formula involving dimensions and |
| | weight, without regard for the actual content type or commodity to be |
| | transported. |
| | Example: |
| | One Rating system is as defined by the National Motor Freight Traffic |
| | Association - see www.nmfta.org for more information. |
| | Class 50 |
| | Class 500 |
| | (18 different classes are used by the trucking industry) |
| CLASSIC SER ITEM | Captures Serialized Items in a S2000 environment that pre-dates S2000 |
| | identifier assignment. |
| | This implies that the existing Serial Number (“Classic”) may not be unique |
| | across multiple Items or Parties, and a Universal (S2000 compliant) Serial |
| | Number was assigned. |
| COA SEGMENT CATEGORY | The entity describes a COA SEGMENT CATEGORY. Examples: GL Main |
| | Account, GL Account Sub GL Account, GL Account Project, GL Project, etc. |
| COA SEGMENT GROUP CATEGORY | This entity allows a COA SEGMENT CATEGORY to be associated with a |
| | CHART OF ACCOUNT. Each CHART OF ACCOUNT may contain only one |
| | of each COA SEGMENT CATEGORY. |
| CODE FORMAT | Identifies a codification system or standard used to identify items. |
| | Example: |
| | Global Trade Item Numbers (GTIN), |
| | Universal Product Code (UPC), |
| | European Article Number (EAN.) |
| | Japanese Article Numbering (JAN), etc. |
| | Note: a single item can have multiple scan codes (even in the same scan code |
| | class) |
| CODE SHARE BASIS | Identifies the business agreement regarding fares for a codeshare flight. |
| | A codeshare is an association between one airline's scheduled flight and |
| | another airline's representation of the same flight, using different flight |
| | numbers, codeshare partnerships and agreements; where codeshare means |
| | either airline can sell and issue tickets on its own company ticket stock. |
| COLLECTION STATUS TYPE | This minor entity identifies the types of COLLECTION STATUS TYPE such as |
| | past due 1-30 days, past due 31-60 days, past due 61-90 days, charged off, in |
| | collections, promised to pay, payment received or current (not past due). |
| COMMODITY | A scheme for classifying products and services using a recognized third-party |
| | classification method. Enables a common reference for business-to-business |
| | usage, electronic catalogs, search engines and economic reporting/ |
| | comparison purposes, etc. |
| | The Commodity classification of an Item can be used to help determine |
| | transportation rates, hazardous material information, customs implications, etc. |
| | Example: |
| | UNSPSC Classification Scheme: |
| | === |
| | The United Nations Standard Products and Services Classification (UNSPSC) |
| | is an open global coding system that classifies products and services. |
| | Example coding for the UNSPSC: |
| | 10.10.20.01 Elephants |
| | 25.20.21.00 Flight instrumentation |
| | 27.11.17.15 Torque wrenches |
| | 27.13.15.12 Pneumatic screwdriver |
| | 31.16.15.00 Screws |
| | 53.13.16.19 Cosmetics |
| | 71.12.30.02. Integrated operation, engineering, modification, |
| | maintenance services |
| | 73.13.16.08 Cold storage services |
| | 78.10.15.00 Air cargo transport |
| | 78.10.15.01 Domestic air cargo transport |
| | 78.10.22.04 Letter or small parcel worldwide delivery services |
| | 90.11.18.00 Hotel rooms |
| | 90.15.19.01 Casinos |
| | NMFC Classification Scheme: |
| | === |
| | The National Motor Freight Classification (NMFC) code used to identify |
| | specific freight by a pre-defined code and class defined by the National Motor |
| | Freight Traffic Association. Used to determine CLASS RATING, liability |
| | information, hazardous material designation, etc. |
| | See www.nmfta.org for more information. |
| | Note: |
| | Models a single, chosen, third-party standard for commodity identification. If |
| | multiple standards need to be accommodated the model will need to be |
| | enhanced to include, at least, a “Scheme” entity as identifying parent to |
| | COMMODITY (the third-party source, or creator/owner of the classification |
| | system, should be included in the primary key of this “Scheme” entity |
| | permitting the use of multiple classification schemes as needed by the |
| | Enterprise). In addition an associative entity for ITEM-to-COMMODITY should |
| | be added. |
| COMMODITY EQUIP | Cross Reference defining the specialized Equipment required to transport |
| | certain Commodity Groups of Items. |
| | Example: |
| | Hazardous Materials, Items needing Refrigeration, etc. |
| COMMODITY GROUP | A hierarchical grouping of Commodity classifications that may have as many |
| | levels as needed to fully code the classification scheme. |
| | Example: |
| | The United Nations Standard Products and Services Classification (UNSPSC) |
| | is an open global coding system that classifies products and services. |
| | Example group coding for the UNSPSC: |
| | 50.00.00.00 - Food Beverage and Tobacco Products (Parent group) |
| | Family - 50.11.00.00 - Meat and Poultry Products (immediate child group) |
| | class - 50.11.15.00 - Meat and poultry (lower-level child group) |
| | In the Commodity entity are found the lowest-level commodities themselves: |
| | commodity - 50.11.15.10 Fresh meat or poultry |
| | commodity - 50.11.15.11 Frozen meat or poultry |
| | Usage Note: the model shows two entities to illustrate both the lowest-level |
| | commodity and the higher-level groups that are possible. It is entirely feasible |
| | to utilize a single entity similar to this Commodity Group entity and include all |
| | levels of the commodity classification standard within and having a single |
| | relationship to the Item entity. |
| COMMON STOCK ACCOUNT | The entity that identifies a general ledger equity account as common stock. |
| | Common stocks are units of ownership of a public corporation. Common |
| | stock, the most frequently issued class of stock, usually provides a voting right |
| | but is secondary to preferred stock in dividend and liquidation rights. |
| COMMON STOCK ACCOUNT TYPE | The entity that identifies the type of common stock accounts. Types of |
| | common stock include voting stock and non-voting stock. |
| COMP TYPE | Classifies the various types of COMPs such as room, food & beverage, etc. |
| | Example: |
| | Hotel Room |
| | Food & Beverage |
| | Show Tickets |
| | etc. |
| COMP VISIT SUMMARY | This entity contains COMPs that have been issued to a CASINO PLAYER. |
| | These may or may not be utilized (and consequently may or may not reflect on |
| | a FOLIO) |
| COMPENSATORY EARNING | Segment credits, points, and other earnings given as compensation to a |
| | customer by Customer Service. Usually as a result of a service incident or |
| | complaint. |
| COMPENSATORY OFFER | An Offer (or Offers) made to a customer as compensation for feedback |
| | received. This could be to reward the customer for taking the time to provide |
| | feedback, or to compensate the customer for a less than perfect experience |
| | with the enterprise. |
| CONFIGURATION TRANSACTION | A Type of Inventory Adjustment Transaction. |
| | Describes the process where Inventory Items are ‘reconfigured’ by breaking |
| | bulk items into component items, or (conversely) consolidating Items into bulk. |
| | In an MRO environment, the CONFIGURATION TRANSACTION may be used |
| | to convert a collection of parts (ITEMs) into a component. The reverse may |
| | also apply when a component is broken down into a collection of parts (ITEMs) |
| | that will be returned to inventory for use as spares. |
| | Note: When a bulk item is broken into its component items, there will be |
| | several related transactions: 1 to decrease the bulk item count and a |
| | transaction to increase the component item count for each component item |
| | created. |
| | Likewise in the case where component items are ‘bulked up’ or consolidated, |
| | where the opposite process will take place. |
| | Note: A similar construct can be used to do other inventory item “conversions” |
| | where items are transformed into different items - e.g. components or |
| | ingredients are combined to create new (typically) sellable items. |
| CONSOL INVOICE SUMMARY | This entity contains summary account information as of this summary date. |
| | Even though the information is technically derivable from the separate invoices |
| | that compose the CONSOLIDATED INVOICE, it is included here because |
| | companies commonly require tracking of payments and balances at the |
| | CONSOLIDATED INVOICE level. |
| CONSOLIDATED INVOICE | A CONSOLIDATED INVOICE represents a collection of multiple INVOICEs for |
| | single payment or customer billing. |
| CONSOLIDATED INVOICE STATUS | This entity tracks the status of a CONSOLIDATED INVOICE, such as |
| | cancelled, approved, pending, send, hold, release, etc. |
| CONSUMPTION TRANSACTION | A Type of Inventory Adjustment Transaction. |
| | A reduction in inventory due to Consumption or Usage by the Enterprise. This |
| | is useful in instances where inventory for customer sales are co-mingled with |
| | inventory for internal use. |
| | Example: Cleaning & Office Supplies are sold to Customers, but also used |
| | internally. |
| CONTAINER CAPACITY | The specific measures of the overall capacity of a cargo/freight container. |
| | Note: a container may have multiple measurements, e.g., dimension, weight, |
| | external, internal, etc. |
| CONTAINER CLASS | The Class of container equipment such as Unit Load Device (ULD), |
| | Refrigerated Container, Steel Pallet, etc. |
| | Example: |
| | For Container Type ULD, Classes could be: |
| | AKH - Lower Deck Container, |
| | H - Horse Stalls, |
| | P1P/PAG - Lower Deck Pallet, |
| | AKE - Container, |
| | N - Certified Aircraft Pallet Net, |
| | J - Thermal Non-Structural Igloo, |
| | DQF/LD8 - Lower Deck Container |
| | V - Automobile Transport Equipment, |
| | etc. |
| CONTAINER CONTOUR | Defines the shape or contour of the Container. Most often used for Containers |
| | used for Air Cargo (and specifically, ULDs) |
| | Used so the shape of the Container fits the curvature/topology of the |
| | Transportation Equipment interior. |
| CONTAINER EQUIP | A specific piece of equipment used as a container to move or transport |
| | baggage, cargo/freight. |
| | Example: ULD #6734-7856a, 20′ × 40′ Refrigerated Container ZX90132-14, |
| | Steel Cage Pallet 78-B23-91, etc. |
| CONTAINER ESTIMATE | An estimate of the weight and volume of a future Shipment at the Container |
| | Class level. |
| | This is used to do Capacity Planning. |
| CONTAINER TYPE | The type of container equipment such as Unit Load Device (ULD), Shipping |
| | Container, Truck Trailer, etc. |
| CONTRACTED FEEDBACK | Feedback collected by a contracted third Party on behalf of the enterprise. |
| CONVERSION | Represents the successful result of a recommendation provided by a |
| | recommendation engine such as that provided by BeFree. A recommendation |
| | is considered successful if a user clicks on the recommendation. A purchase |
| | need not be made in order for a recommendation to be considered a |
| | Conversion. |
| | (Analyst Note: This table is present to support integration with |
| | recommendation engines and does not imply this solution functions as a |
| | recommendation engine). |
| | The information contained in this entity is derivable and is provided to support |
| | various 3rd party E-Commerce applications. |
| | Source-> Recommendation DB. |
| CONVERSION CATEGORY | Contains information concerning the linkage between recommended Offerings |
| | and the Web Page that the Offering was displayed on. |
| | Example: An offer for a beach umbrella is found on web page #67824435 that |
| | offers seasonal specials. |
| CORPORATE FEEDBACK | Feedback collected by the enterprise in a pro-active manner (customers or |
| | individuals contacted by the enterprise, instead of the other way around). |
| | Example: |
| | enterprise pro-actively surveys customers |
| | a ‘mystery shopper’ activity (associates pretending to be customers) |
| CORPORATE STORE | A STORE that is owned and operated by the enterprise (as opposed to a |
| | Franchised Third Party). |
| | Note: CORPORATE STORE and FRANCHISE STORE entities are provided |
| | as separate subtype entities to allow for future expansion. Specifically, it |
| | allows for: |
| | the placement of specific franchisee vs. corporate attributes |
| | relating other entities in the model to one of these specific subtypes, if |
| | desired |
| COST | Denotes the types of COSTs the enterprise expends. |
| | Example: The expenditure items can include: Fuel, Equipment Maintenance, |
| | Rent, Service Charge, Heat and Electricity, Distribution, Repairs, Facility |
| | Maintenance and Grounds, Security, Cleaning, Refuse, Communication - |
| | Telephone, Mail, FedEx, Bank Charges, Stationery and Supplies, Labor, |
| | Purchase Price (at Cost) for Items actually resold, Raw Materials used, etc. |
| COST OF SALES ACCOUNT | This entity identifies an expense account as a cost of sales. Cost of Sales |
| | represents expenses a company incurs to purchase products or services that it |
| | sells. Cost of Sales expenses include labor costs, raw materials, overhead, |
| | etc. |
| COST TYPE | Classifies the different COSTs into logical groupings. |
| | Example: Maintenance, Labor, Utilities, Purchase Price, Raw Materials, etc. |
| COUNTRY | A geo-political region with sovereign governing. |
| | Example: U.S.A., Canada, Denmark, etc. |
| COUNTRY GROUP | A grouping of countries. |
| | Example: |
| | Eastern Europe |
| | Micronesia |
| | etc. |
| COUNTRY HOLIDAY | Specifies the Dates that are part of a given Holiday for a given Country. |
| | Can be a single, annual date, or a date range. |
| | Note: Even though a date range is supported, a date range construct (with |
| | Start and End Date attributes) is not used, because a Holiday is most often a |
| | single day. |
| COUNTRY SEASON | Specifies the Dates that are part of a given Season for a given Country. |
| | Note: If no attributes are to be recorded for individual days in a season, and |
| | the days are contiguous, the Season can also be modeled using a range |
| | construct (using a Start and End Date) |
| COUNTY | A geographic region within a TERRITORY. |
| | Example: Los Angeles County |
| COUPON CERTIFICATE | A specific instance of a COUPON that is trackable through a unique number. |
| | The intent is to provide targeted INDIVIDUALs with trackable COUPONs to be |
| | able to identify the customer at redemption time (even if the redemption |
| | transaction is cash) |
| | Example: A direct mail piece with a specific OFFER, containing a barcode with |
| | a unique code, or an individualized e-mail code. |
| COUPON OFFER | A PROMO OFFER devised by the Enterprise where a specific code or token |
| | need to be shown, mentioned, or ‘redeemed’ (physically or virtually) to receive |
| | the mentioned incentive. Can be serialized to track individual instances. |
| | Example: |
| | A printed offer that can be cut out and redeemed, |
| | an insert in the Sunday Paper, |
| | a code e-mailed to an INDIVIDUAL. |
| CREDIT CARD | A physical card issued by an ORGANIZATION, enabling customers to make |
| | purchases on credit. |
| | Example: Citibank Platinum Visa |
| CREDIT CARD TYPE | Identifies the bank or company that issued the Credit Card together with the |
| | premium level of the card. |
| | Example: CitiCards Platinum Select; MBNA America Bank Visa Platinum |
| | Plus; Citibank Diners Club International, etc. |
| CREDIT RATING | Internal or external ways of classifying a PARTY's or a PAYMENT |
| | ACCOUNT's credit worthiness. |
| | Example: Do not extend credit to this person, low risk, high risk, TRW score. |
| CREW MEMBER | The individual(s) that are operating (driving, flying, etc.) the transportation |
| | equipment or hosting (Flight Attendant, Steward, Purser, Conductor, etc.) |
| | during a specific SCHEDULED LEG. |
| | Example: Jack E. is a steward on Flight 238 departing 9:44am from Los |
| | Angeles International Airport bound for Seattle-Tacoma International Airport. |
| CRUISE LINE | This entity reflects the domain of Shipboard Passenger Carriers as listed with |
| | the Department of Transportation (DOT) and the International Maritime |
| | Organization. |
| | Example: |
| | Royal Caribbean International, |
| | Carnival Cruise Line, |
| | Orient Lines, |
| | etc. |
| CRUISE LINE RESERVATION | This entity represents the intention (reservation) made by a passenger to |
| | purchase a cruise for the purpose of boarding a ship and sailing to a specified |
| | destination. |
| CRUISE LINE TICKET | This entity represents the Ticket issued to a passenger for the purpose of |
| | boarding a specified cruise ship in order to sail to a specified destination. |
| CRUISE PRODUCT | All of the published destinations and ports of call provided for sale by a |
| | particular CRUISE LINE. |
| CURRENCY | This entity identifies the name for the system of money. Example: US Dollars, |
| | Canadian Dollars, Japanese Yen, etc. |
| CURRENCY TRANSLATION RATE | The entity that indicates the conversion rates for translating from/to company's |
| | global (or base) currency and other currencies. |
| CURRENCY TRANSLATION RATE TYPE | The entity that indicates the type of currency translation. Possible examples |
| | may be: |
| | Monthly Average Rate |
| | End of Period Rate |
| | Daily Rate |
| | etc. |
| CURRENT ASSET ACCOUNT | The entity that indicates assets of a company that could be liquidated or |
| | converted to cash in less than one year. CURRENT ASSET ACCOUNTs |
| | provide a source of funds for ongoing operations and are important to |
| | investors in the event the company goes bankrupt. |
| CURRENT ASSET ACCOUNT TYPE | The entity that identifies the type of current asset like available cash, prepaid |
| | expenses, inventory, accounts receivable, or securities. |
| CURRENT LIABILITY ACCOUNT | The entity that indicates the types of CURRENT LIABILITY ACCOUNTs, or |
| | liabilities owed by a company that are due within one year. |
| CURRENT LIABILITY ACCOUNT TYPE | The entity that identifies the type of CURRENT LIABILITY ACCOUNTs. Types |
| | of current liabilities include accrued liability, deferred revenue, short-term debt, |
| | current long-term debt, income taxes and accounts payable. |
| CURRENT LONG TERM DEBT ACCOUNT | The entity that provides details for the current long-term debt. Long-term debt |
| | is the principal on the long-term debt due in the next year. |
| CUSTOMER FEEDBACK | Feedback received directly from a customer, where the customer or individual |
| | contacted the enterprise. |
| | Can be regarding an existing order, agreement, shipment, etc. |
| | Example: |
| | customer informs enterprise that they can get better terms from a |
| | competitor |
| | customer called the enterprise after a visit or product order |
| | customer completed a survey form available in an enterprise location |
| | Note: If needed, individual subtype entities can be created for each type of |
| | business transaction feedback or contact that is collected (Agreements, Sales, |
| | Orders, Shipments, etc.) |
| | See the Quality Feedback Subject Area for more information. |
| CUSTOMER PREFERENCE | The actual detailed information collected about individual customer |
| | preferences. |
| | Example: seating preferences = aisle, bed size = king, smoking = no |
| | Note: These are global preferences that span multiple travel transactions. |
| CUSTOMS FORM | Defines a set of information to be provided to a Controlling Authority for the |
| | importing or exporting of specific goods between countries. |
| CUSTOMS FORM PRESENTED | Captures the Sets of Regulatory information (Forms) presented to the |
| | Controlling Authority to enable this Border Crossing. |
| CUSTOMS FORM TYPE | Indicates if the Form governs Imports, Exports, or goods In Transit |
| CUSTOMS REQUIREMENT | Specifies the rules and regulations of transporting goods over borders. |
| | Specifically mentions the official information to be provided to the Controlling |
| | Authority. |
| | It is possible to have regulations for both the importing and exporting of goods, |
| | as well as covering goods only transiting. |
| | Note: The structure supports the adherence to Customs Requirement when |
| | moving goods across Country borders. If needed the structure can be |
| | enhanced to cover non-Country (i.e. State or Province) borders and non- |
| | Customs compliance rules & regulations. |
| DAY OF WEEK | Indicates the seven days of the week. |
| | Example: Monday, Tuesday, etc. |
| DAYPART | A Subdivision of a day. Convenient to group segments of business activity with |
| | similar activity levels. This detail level of time period information allows an |
| | enterprise to analyze customer sales transaction activity as well as associate |
| | labor activity at a granular level within a given day. |
| | Example: |
| | Pre-Opening |
| | Early Morning |
| | Morning |
| | Lunch |
| | Afternoon |
| | etc. |
| | Note: This is typically a time division smaller than a work shift. |
| | Also note that Dayparts can change depending on the day of the week (but |
| | Mon-Fri is typically similarly defined) |
| DAYPART HOURS | The start and end time that defines a DAYPART depending on the DAY OF |
| | WEEK. |
| | Example: |
| | For Monday: |
| | 4a-6a = Pre Opening |
| | 6a-9a = Early Morning |
| | 9a-12n = Morning |
| | 12n-1p = Lunch |
| | 2p-4p = Afternoon |
| | etc. |
| DEFERRED CHARGE ACCOUNT | The entity that provides details for deferred charges. These are expenditures |
| | that will be gradually written off over a future period of time. |
| DEFERRED INCOME TAX ACCOUNT | The entity that provides details for the deferred income taxes. Deferred income |
| | taxes are the tax liabilities a company may postpone paying until some future |
| | time. |
| DEFERRED REVENUE ACCOUNT | The entity that provides details for the deferred revenue. Deferred revenue is |
| | sales or revenues the company has been paid but has not yet earned, such as |
| | advance deposits on a contract. |
| DELAYED DLY | A subtype entity of LEG INCIDENT entity showing the total minutes a |
| | scheduled leg was delayed from its original schedule. |
| DELIVERY | The actual delivery/acceptance of a shipment by the Receiver Party |
| | (Consignee). |
| DEMOGRAPHIC | Information describing a PARTY, a geographic area, PARTYs in a geographic |
| | area, etc. DEMOGRAPHICs are commonly purchased from 3rd party |
| | vendors, but may also be directly acquired by the enterprise through surveys, |
| | registration, warranty programs, loyalty programs, etc. |
| | Examples- |
| | PARTY: Income Level, Credit Rating, Number of children, etc. |
| | Geography: Average temperature in January, etc. |
| | PARTYs in a Geographic Area: Typical household size, Number of |
| | automobiles, etc. |
| | Market: Number of facilities that opened for business last year. |
| DEMOGRAPHIC GROUP | A clustering of related DEMOGRAPHICs |
| | Example: Financial (contains Income Level, debt, etc.) |
| DEMOGRAPHIC VALUE | The actual value of a DEMOGRAPHIC, which can be a range or a single |
| | value. |
| | Example: |
| | Income level = ‘Between $40,000 and $49,999’ |
| | Number of children = 2 |
| | Number of new retail facilities opened last year = 8 |
| | Note: It is assumed in the model that the use of Demog Range Start Val and |
| | Demog Range End Val are, together, mutually exclusive with Demog Val. |
| | That is, if the demographic value is unique then use Demog Val. However, if |
| | the values are ranged, use the two range value attributes instead. |
| DENIED REASON | The reason that boarding was denied to a ticketed passenger. |
| DEPARTMENT | Represents a broad group of merchandise appealing to a particular |
| | CUSTOMER's needs or the Enterprise's administrative needs. A |
| | DEPARTMENT represents one of the highest if not the highest product |
| | hierarchy levels in a retail organization. The actual naming convention for |
| | ITEM hierarchy may vary across organizations. |
| | Example: A DEPARTMENT may be end use based, e.g. Overnight Shipping, |
| | or may be VENDOR based, e.g. Harrah's weekend packages. The scope of a |
| | DEPARTMENT will largely depend on the size of the organization but might |
| | typically cover 20-30 manageable categories. |
| DEPRECIABLE ASSET ACCOUNT | The entity that identifies the DEPRECIABLE ASSET ACCOUNT. |
| | DEPRECIABLE FIXED ASSETs include property, plant and equipment. |
| DEPRECIABLE ASSET ACCT PAYABLE | This associative entity provides details of ACCOUNTS PAYABLE for a |
| | company and identifies the depreciable fixed asset general ledger account. |
| DEPRECIABLE ASSET DEPRECIATION | This entity identifies the DEPRECIATION METHOD that can be used for a |
| | given DEPRECIABLE FIXED ASSET. |
| DEPRECIABLE ASSET TYPE | This entity identifies the type of depreciable asset like property, equipment or |
| | plant. |
| DEPRECIABLE EQUIPMENT | This entity defines details for the DEPRECIABLE EQUIPMENT accounts. |
| | DEPRECIABLE EQUIPMENTs are used to perform company business and is |
| | a type of a DEPRECIABLE FIXED ASSET. |
| DEPRECIABLE FIXED ASSET | The entity that identifies a DEPRECIABLE FIXED ASSET. |
| DEPRECIABLE PROPERTY | The entity that provides details for the property accounts. DEPRECIABLE |
| | PROPERTY is a type of a DEPRECIABLE FIXED ASSET. |
| DEPRECIATION AMOUNT | This entity identifies the monetary amounts associated with a DEPRECIATION |
| | AMOUNT. |
| DEPRECIATION AND AMORT ACCT | Allocation of the cost of an asset over a period of time for accounting and tax |
| | purposes. Depreciation is also defined as a decline in value of a property due |
| | to wear and tear or obsolescence. For example, equipment and furniture are |
| | depreciated, software is amortized. |
| DEPRECIATION METHOD | The entity that indicates the method used for depreciating the fixed and |
| | depreciable asset. These methods are used to allocate the acquisition cost of |
| | the asset over their depreciable life. Depreciation reduces taxable income but |
| | does not affect cash. |
| | Examples of depreciation methods are: |
| | Straight line depreciation |
| | Accelerated Depreciation |
| | Double Declining Balance |
| | Sum of the Years Digits. |
| DINING LOCATION | A sub-type of LOCATION used for the sale/consumption of food & drinks. For |
| | example, Bars, Bakeries, Cafes, Restaurants, etc. |
| DINING RESERVATION | A sub-type of ACTIVITY RESERVATION ITEM that captures information about |
| | DINING reservations. |
| DINING TABLE | The level at which food services are ordered and provided (served). It is |
| | typically (but not always) a physical table with one or more seats. Special |
| | entries can represent ‘non-table’ areas such as a bar counter. |
| | It applies mainly to sit-down establishments with table service, but can also be |
| | used by establishments with counter service to capture the capacity of the |
| | store. |
| | Hospitality/Food Services Industry Specific. |
| DINING TRANSACTION | A subtype of RETAIL PURCHASE representing customer transactions |
| | involving the purchase/consumption of one or more MENU ITEMs. This is |
| | open ended to include various types of dining establishments such as |
| | restaurants, bars, pubs, cafes, bakeries, etc |
| DINING TRANSACTION LINE | Captures the MENU ITEMs purchased/ordered by a customer in a DINING |
| | TRANSACTION |
| DINING ZONE | Defines subdivisions inside a Dining Location. |
| | Example: |
| | smoking, non-smoking, bar, patio, kitchen, etc. |
| DINING ZONE STAFF | Specifies the Staff scheduled to work a specific shift on a specific day in a |
| | specific dining zone. |
| | Example: |
| | On Jan 22: |
| | Jack & Jill will be the bar personnel |
| | Jim & Tammy will be the servers for Zone 6 (Tables 12 thru 20) |
| | etc. |
| DINING ZONE TYPE | Defines types of (usually contiguous) areas in a Dining Location. |
| | Example: |
| | smoking, non-smoking, bar, patio, kitchen, etc. |
| DIRECT EARNING | Segment credits and points award earnings resulting from customer's use of |
| | travel related services. |
| | Example: frequent flier miles is awarded typically after verifying a FLIGHT |
| | CHECK IN EVENT while hotel frequent stay points is typically after verifying a |
| | LODGING CHECK OUT EVENT |
| DIRECT MAIL AD | An AD that can be delivered to a customer via direct mail. |
| | Example: |
| | A mailing is sent to customers with an offer for a tax preparation |
| | application together with a limited time coupon for a discount. |
| | A mailing is sent to customers with an offer for a 20% discount on all |
| | travel to Hawaii for the next 30 days |
| DISASTER | This is a subtype entity of the LEG INCIDENT entity that describes an event |
| | that has negative results. |
| | Example: Plane Crash. |
| DISCOUNT | The types of reasons why the total tender required for a given sale may be |
| | reduced. May be based on the total transaction or can be ITEM specific. |
| | Example: 3% discount on all goods for Loyalty Card holder. |
| | $0.25 discount coupon for one purchased item. |
| DISCOUNT TYPE | Denotes types of DISCOUNTs which reduce the price that is normally |
| | charged. |
| | Example: a reduction to a Loyalty Card holder for being a good customer. |
| | A Coupon discount. |
| DISTANCE MAP | Allows for capture of distances between two POSTAL CODEs. Can be |
| | obtained from a 3rd party (i.e., Rand Mc Nally) or self generated. |
| | NOTE: This information is mainly used to determine transportation rates |
| | between different locations, so “zone to zone” accuracy is acceptable (as |
| | opposed to “point to point”). |
| DISTRIBUTION CENTER | A type of LOCATION where items are stored and may sometimes be bought |
| | directly by customers. A physical LOCATION where merchandise is received |
| | from VENDORs or suppliers and temporarily held for the purpose of being |
| | packaged to fulfill STORE orders or STORE allocation plans and then |
| | distributed to the STOREs. |
| | A DISTRIBUTION CENTER may also act as temporary-holding point to |
| | receive return goods from STOREs, which will then be returned to the |
| | supplying VENDOR. |
| | A DISTRIBUTION CENTER may also serve as a distribution point for a |
| | Distributor. A physical LOCATION where merchandise is received from |
| | VENDORs or suppliers and temporarily held for the purpose of distribution to |
| | wholesale or retail customers. |
| DISTRICT | A grouping of LOCATIONs that fall within a specific geographic area. A |
| | DISTRICT is used to organize groups of LOCATION's for the purposes of |
| | planning, reporting and analysis. |
| DIVERTED DIV | This is a subtype of the LEG INCIDENT entity that shows the new destination |
| | (diverted) travel facility for a SCHEDULED LEG that was rerouted from its |
| | original destination. |
| DIVIDEND EQUITY ACCOUNT | The entity that identifies the type of dividend equity. Types of dividend equities |
| | are common stock and preferred stock. |
| DIVIDEND EQUITY ACCOUNT TYPE | The entity that identifies the type of dividend for DIVIDEND EQUITY |
| | ACCOUNTs. Types of dividend equities are common stock and preferred |
| | stock. |
| DIVISION | Represents an administrative grouping of REGIONs. Also represents an |
| | administrative grouping of DEPARTMENTs. DIVISIONs exist to further cluster |
| | business activities into groups for administrative or organizational reporting |
| | purposes. A DIVISION often represents the highest LOCATION or ITEM |
| | hierarchy level in an organization. The actual naming convention for a |
| | LOCATION or an ITEM hierarchy may vary across organizations. |
| DOCUMENT TYPE | This entity defines a collection of information. For example, transport |
| | documents can include documents such as manifests, bills of lading and |
| | import/export documents. Transport documents can be associated with a |
| | conveyance over one or many legs of the trip. |
| DOMAIN IP REASON | Specifies the type of relationship that may exist between an IP Address and a |
| | Domain. |
| | Examples: |
| | IP Address of linking Server |
| | Valid IP Addresses for a Domain. |
| DOMAIN ROOT | The extension name of the domain server. |
| | Examples: |
| | .com |
| | .net |
| | .org. |
| | Source-> Web Log |
| DUNNING LETTER | This entity contains information related to debt collection letters, or DUNNING |
| | LETTERs. These dunning notices are sent to bill-to parties when PAYMENTs |
| | are past due. |
| DUNNING LEVEL TYPE | The DUNNING LEVEL TYPE placed on this item on the printed |
| | correspondence (Dunning or Collection Letter). Examples: first, second, or |
| | final notice, etc. |
| DUNS | Dun & Bradstreet information pertaining to a particular business. |
| DWELLING TYPE | Identifies a type dwelling. example: single family, multi-family, etc. |
| E LOC REF DIRECTORY | Information about an internet directory listing that a customer used for |
| | accessing a WEB SITE. |
| | Example: For instance a customer could access yahoo and then go to the |
| | ‘business section’ and then to ‘wholesalers’ to finally select ‘Wholesaler A’. |
| | The corresponding directory listing information will be |
| | www.yahoo.com/business/wholesalers/ |
| E LOC REF SEARCH | An entity used to capture the outcome of an internet search that was in turn |
| | used by a customer to access a web site. |
| | Example: if you conduct search on yahoo for blue sweaters, the search term |
| | gets embedded in the new URL created (www.yahoo.com/?p=blue+sweaters). |
| | If the search results in an Enterprise's page, then the referral URL will have |
| | the search information in it. |
| E LOC REF WEB AD | An entity used to capture information about WEB ADs that were used by |
| | customers to access the web site. The entity also has a relationship to |
| | information relevant to WEB ADs such as start and end dates and cost |
| | information. |
| | Example: an Ad for a VirusScanning application the enterprise offers is placed |
| | on the Yahoo web site. A visitor to Yahoo sees that offer, clicks on it and is |
| | referred to the enterprise web site's VirusScanning application product page. |
| E LOC REFERRAL TYPE | An entity used for classifying E LOCATION referrals into various sub-types. |
| | Example: Searches, Web Ads, Directories, etc. |
| E LOCATION | An entity used to describe an internet location within an E SITE. |
| | Example: the /clothing/women's section in a proprietary system (such as AOL) |
| | or shopping.yahoo.com/Computers (on yahoo) |
| E LOCATION REFERRAL | An entity used to track E LOCATIONs that provide different referral |
| | mechanisms such as banner ads, directory listing, etc to a customer for |
| | accessing a web site |
| | Example: an electronic location could be a web site such as www.yahoo.com |
| | or a location within a proprietary web browsing system such as AOL. Note that |
| | with proprietary systems, we may not get a finer granularity of information as |
| | compared to web pages |
| E LOCATION TYPE | An entity used to classify E LOCATIONs. This is similar to the WEB PAGE |
| | TYPE entity that classifies WEB PAGEs, the only difference being that WEB |
| | PAGEs refer to internal pages of an Enterprise and the E LOCATION refers to |
| | external web pages (Yahoo) or proprietary systems (AOL) |
| | For example: Home page, Category page, Products page, Order page, Help |
| | page, Search page |
| E SITE | An electronic site refers to an external web site such as www.yahoo.com or a |
| | proprietary site developed for subscribers such as the AOL system |
| E SITE TYPE | An entity used for classifying different types of web sites such as portals, |
| | aggregators, ISPs, etc. |
| EARNING STATEMENT TYPE | This entity contains a Vendor's 1099 Type. |
| | A 1099 classification scheme is used in the United States for types of |
| | payments. Each 1099 form has one or more payment types. A 1099 supplier |
| | may receive payments from more than one type. The 1099-MISC form has the |
| | following types: rents, royalties, prizes and awards, federal income tax |
| | withheld, fishing boat proceeds, medical and health care payments, non- |
| | employee compensation, and substitute payments in lieu of dividends or |
| | interest. Payables records 1099 payments by type so that you can report them |
| | according to IRS requirements. |
| | Note: U.S.A. centric - replace with appropriate localized content as needed. |
| EDUCATIONAL ORGANIZATION | A type of ORGANIZATION dealing mainly with education. |
| | Example: University of California - Los Angeles, Venice High School, Acme |
| | College, etc. |
| ELECTRONIC ADDRESS | A non-physical/virtual ADDRESS. Could be an e-mail, ftp, URL, etc. |
| | Example: clark@kryptonite.com, ftp.att.net/bob, etc. |
| ELECTRONIC ADDRESS TYPE | Specifies the type of ELECTRONIC ADDRESS, such as e-mail, ftp, or URL. |
| EMAIL AD | An AD that can be delivered to a customer via e-mail. |
| | Example: An e-mail is sent to customers with an offer for a tax preparation |
| | application together with an embedded link to the appropriate web page that |
| | the recipient may click. |
| EMAIL CLIENT APPLICATION | Represents the email application used by a client to read and send email |
| | Example: Eudora, Microsoft Outlook Express 5.0, etc. |
| EMAIL REFERRAL | This entity is used to capture information about any uniform resource locator |
| | embedded in emails that were used to access a web site. Email referrals |
| | could be due to PROMOTIONs, WEB ADs or other methods. See EMAIL AD. |
| | Example: A customer using the Microsoft Outlook Email client clicks a link |
| | (http://enterprisedeliveries.com) in an Email which refers the customer to a |
| | web page that offers a discount on groceries (Ad #9902547) delivered to the |
| | customer's home. |
| EMPLOYEE BENEFIT ACCT | Pension, health care, unemployment & other employee benefit. |
| EMPLOYEE RELATED EXPENSE ACCT | Meals, entertainment, education, relocation & other employee expenses. |
| ENTER METHOD | Indicates whether an item was identified by scanning in, receiving a radio |
| | frequency signal (using RF Id), manually keying in, selected via a menu list |
| | (i.e., in-house or customer web based selection entry), etc. |
| | Example: |
| | scanned optically |
| | received via radio frequency |
| | key entry |
| | menu list selected |
| | etc. |
| EQUIP (SPARES) LOCATION | Redefines Equipment as a ‘virtual’ Location. |
| | This allows Equipment to be used as Inventory Locations to house or store |
| | Parts (Items) and allows all Inventory Transactions to operate on these virtual |
| | Locations. |
| | Note: The attributes of the Location Supertype will typically not be populated |
| | for these ‘virtual’ Locations. |
| | Example: Aircraft having Tail Number WRX-1092 carries several spare Parts. |
| EQUIP CERTIFICATION | Specifies a certification level required to perform specific functions on specific |
| | classes of equipment. |
| | Example: |
| | Certification to drive vehicles up to a certain tonnage or size |
| | Certification to perform tear down and rebuild activities on specific types |
| | of engines |
| | Certification to inspect the safety aspects of a class of equipment |
| | Hospitality Example: |
| | The level of certification required to perform a specific function in a |
| | casino, i.e. State Certified Slot Machine service technician, etc. |
| | MRO Industry Example: |
| | The level of certification required for the Associate (Mechanic) to be |
| | qualified to perform the associated maintenance activity. |
| | This certification level is often set by a federal agency like the FAA in |
| | order to ensure safety standards. |
| EQUIP CLASS | Describes the Class of EQUIPMENT for skills certification; commodity |
| | handling; associate/crew training; licensing purposes. |
| | Example: |
| | For Airline: |
| | Boeing 777 Model X certified for ETOPS/over water |
| | For MRO: |
| | Framostat DeLuxeTest Equipment |
| | For Trucking Industry: |
| | Class A Truck |
| | Class B Haz-Mat |
| | Double (2 trailers) |
| | Triple (3 trailers) |
| EQUIP ERROR MSG | The Error Message generated or displayed by the Equipment in case of an |
| | Equipment Event. |
| EQUIP EVENT | Captures any incident of interest that happens to Transportation Equipment. |
| | Routine observations may also be captured, but typical use is to capture |
| | anomalies. These exceptions may be related to the Equipment (such as an |
| | error message) or external to the equipment (weather conditions causing a |
| | delay or diversion) |
| | These event can be Human (Pilot, Driver, Baggage Handler, etc.) or System |
| | (onboard diagnostic computer) recorded. |
| | Example: |
| | Aircraft Pilot notices a warning light. |
| EQUIP EVENT MSG | Messages and codes generated by Equipment when unusual/discrepancy |
| | events occur. |
| EQUIP GAME CONFIG | Specifies the actual Game Configurations currently supported (playable) on |
| | this game station. |
| | Note that multiple game configurations can be active at the same time, due to |
| | multi-game game stations. |
| EQUIP GAME XREF | Specifies all the games that this equipment or game station is capable of |
| | playing/supporting. |
| | The actual current configuration needs to be checked to see the games |
| | actually active/installed/being played at any given point in time. |
| EQUIP LOG ENTRY (OEI) | Captures the Log Entries associated with Equipment Events. Can be used to |
| | group all Incident Costs associated with the Event. |
| | Note: This Entity is also useful in environments where not all Log Entries are |
| | considered Equipment Events. |
| EQUIP RELIABILITY SPEC | Manufacturer's reliability specifications for the Equipment Series. |
| | This can be compared to the actuals experienced. |
| | Example: |
| | 10,000 cycles, 1400 hours, etc. |
| EQUIP SERIALIZED CONTENT | A history of Serialized Items (individually uniquely identifiable) that is part of a |
| | specific piece of Equipment. |
| EQUIP SERIES | Represents different possible Equipment Configurations within a specific |
| | Model (often called a Series) |
| | Aircraft Example: |
| | For Equipment Model Boeing 747, we may have: |
| | B747-200 |
| | B747-400 |
| | B747-400F |
| | B747-ER |
| EQUIP SERIES CONTENT | The number of Items that are configured in a specific Equipment Series as |
| | manufactured. |
| | This is the generic “parts list”, as compared to the specific serialized items that |
| | are related to a specific piece of Equipment. |
| EQUIP SPEC | Defines the Equipment (Tools, Handling Equipment, etc.) requirements to |
| | perform the specified Maintenance. |
| EQUIP SVC HIST | Captures the time periods when the Equipment was removed from service, |
| | along with the reason. |
| | Note: If the removal from Service is Maintenance related, further information |
| | will be available in the MRO Event area of the model. |
| EQUIP TIME CYCLE | Captures the Time and/or Cycles elapsed as of a specific point in time. |
| | Note: Most of this information should/may be derivable. It is of most use when |
| | Equipment is purchased used - in which case this information should be |
| | provided by the selling party (since it would not be derivable) |
| EQUIP TYPE | Classifies the type of Equipment. Typically a fixed asset. |
| | Example: Transportation Equipment, Operations Equipment, Container |
| | Equipment, etc. |
| EQUIPMENT | A Specific fixed asset (Equipment) used and tracked by the enterprise. |
| | Example: |
| | Travel/Transportation: |
| | Boeing 787 Tail Number X8329 |
| | Mack Truck VIN 43493848389 |
| | Nautilus Cruise Ship ID 3383 |
| | Trailer Asset ID SJ3984 |
| | Refrigerated Railcar Asset ID 9490394 |
| | GE Turbine Engine ID 44343 |
| | Aux Power Unit (APU) ID 2009 |
| | Ford Taurus VIN 3434059 |
| | Casino/Gaming: |
| | Bally 3 wheel $1 slot Asset ID 384372 |
| | etc. |
| EQUIPMENT MODEL | The type of vehicle model as manufactured. |
| | Example: |
| | Aircraft: |
| | Boeing 747 |
| | Lockheed L-1011, |
| | Trucking: |
| | Kenworth Diesel Tractor - Model 2100, |
| | Mac Tipper Trailer, |
| | Volvo WX64 Cab, |
| | etc. |
| EQUIPMENT SUBSTITUTION SUB | A subtype of the LEG INCIDENT entity that represents the equipment that was |
| | used to substitute for the scheduled equipment due to irregular operations. |
| EQUITY ACCOUNT | The entity that indicates a general ledger account is an EQUITY ACCOUNT. |
| | These accounts are related to ownership interest in a company in the form of |
| | common stock or preferred stock. Types of EQUITY ACCOUNTs include |
| | dividend equity and non-dividend equity. |
| EQUITY ACCOUNT TYPE | The entity that identifies the type of EQUITY ACCOUNT. Types of EQUITY |
| | ACCOUNTs include dividend equity and non-dividend equity. |
| EQUITY SURPLUS ACCOUNT | The entity that identifies the net worth that is from stock issued at a premium |
| | over par or stated value. |
| ETHNICITY | The ethnicity of an individual. Example: Latino, Caucasian, African American, |
| | etc. |
| | NOTE: This can be removed as necessary due to legal restrictions prohibiting |
| | the capture of this information. |
| ETOPS RATING | A Rating assigned to certify aircraft flying beyond a certain distance from an |
| | emergency landing facility (typically over water) |
| | Example: |
| | ETOPS-75 |
| | ETOPS-90 |
| | ETOPS-120/138 |
| EVENT COST | Captures all costs not elsewhere represented that were incurred by the |
| | enterprise to host the Group Event. |
| | Used to do profitability calculations. |
| | Example: |
| | labor cost |
| | supplies |
| | Note: Item related costs can be found in the Item Cost entity. This entity is |
| | used to capture costs not directly associated with a (sold) item or product. |
| EXCEPTION | Describes an anomaly. A deviation from what was promised, planned or |
| | expected. |
| | Example: |
| | Late Delivery |
| | Confiscated by Customs |
| | Missing Items |
| | Damaged Items |
| | etc. |
| EXCEPTION REASON | Describes (if known) the reason or cause for an Exception to occur that was |
| | different from what was expected or promised. |
| | Example: |
| | For a Late (delayed) delivery, it could be ‘truck breakdown’ |
| | for Missing Piece it could be ‘Theft’ |
| | for Damage, it could be ‘Dropped’ |
| | etc. |
| EXCHANGE AWARD | A subtype of Award Certificate that associates a specific Account Redemption |
| | to a Reward Program exchange. |
| EXPENSE ACCOUNT | The entity that indicates a general ledger account is an EXPENSE ACCOUNT. |
| | An expense is any cost of doing business resulting from revenue generating |
| | activities. Types of EXPENSE ACCOUNTs include operating expense, interest |
| | expense and other expense. |
| EXPENSE ACCOUNT TYPE | The entity that indicates the type of expense account. Types of expense |
| | accounts include cost of sales, operating expense, interest expense, interest |
| | income and other expense. |
| EXT AIRLINE SALES | The summary information obtained from a third party, e.g., MIDT Information |
| | (Marketing Information Data Tape) from a Global Distribution System (GDS) |
| | concerning number of passengers flown in the specified market and average |
| | fares paid. |
| | Includes external sales (sales made by other Airlines). |
| EXT CASINO BUSINESS | Captures information about competing Casinos. |
| | This information is publicly available in varying degrees due to legal disclosure |
| | rules. |
| EXT LOCATION | A LOCATION that belongs to (or is used by) a third PARTY (external to the |
| | enterprise). |
| | Example: A convenient way of grouping together all Customer locations that |
| | are served by the Enterprise's Sales Territories. |
| | Note: Additional information about this External Location may be captured in |
| | its specialty Location subtype (e.g., Store Location). |
| EXT SERVICES RENDERED ACCT | Leased vehicle expense, security cost, legal fees, audit fees, contracted |
| | personnel services, etc. |
| EXTERNAL COUPON | An external (3rd party) (Manufacturer's or Competitor's) coupon redeemed |
| | during a purchase. |
| | Note: a unique coupon may be received and used by many customers (say a |
| | coupon in a box of cereal). For purposes of the identification, all of these |
| | identical coupons are given the same, unique External Coupon Id and have |
| | the same redemption value. |
| EXTERNAL ORGANIZATION | This is a subtype to ORGANIZATION. It is an organization that is external to |
| | an enterprise. |
| EXTERNAL ORGANIZATION TYPE | The sub-type discriminator for an external organization. This minor entity |
| | identifies the type of organizations such as legal businesses. |
| EXTERNAL PROJECT | EXTERNAL PROJECT Type indicates the PROJECT is for use outside the |
| | company, for example for a 3rd party customer. |
| FACILITY OP EXPENSE ACCOUNT | The entity that indicates the operating expense pertains to facilities. Facility |
| | expenses are related to the maintenance of a physical facility. |
| FARE BASIS | The domain for determining the basis that a fare will be computed on a specific |
| | PRODUCT or PACKAGE. See Note for airline details |
| | Note: For airlines, the travel provider establishes different fare product |
| | categories, both to target specific demand segments and in response to |
| | competitive forces in the market. To do this, multiple fare-basis codes, or |
| | published fares, each with its own set of rules, effective dates, and price |
| | levels, all in the same O&D market are used. Thus, there could well be five or |
| | six different standard excursion fares in a city-pair market, differing in terms of |
| | day of week of travel, flight applicability, routing and price level. |
| | Fare-basis codes, consist of up to eight characters and define a very specific |
| | fare product offering. These are generally comprehensible only to the airline |
| | pricing department that uses them. |
| FEEDBACK | A specific instance of feedback received by the enterprise (typically regarding |
| | the quality of its products and services). |
| | The feedback can be planned: |
| | Contracting a third party to solicit feedback |
| | Periodic inspections and ‘mystery shopper’ activities conducted by the |
| | enterprise |
| | The feedback can be spontaneous: |
| | customers contacting the enterprise |
| | The type of feedback can be free format, or structured (as in surveys). |
| | See the Quality Feedback Subject Area for more information. |
| FEEDBACK CLASS | This entity allows for a more specific classification of unstructured feedback |
| | received, within a specific feedback type. |
| | Example: |
| | Within Feedback Type = Product |
| | Product safety |
| | Product quality |
| | Within Feedback Type = Service |
| | Service speed |
| | Service friendliness |
| FEEDBACK DETAIL | Specifies the particulars provided in an unstructured feedback event, and also |
| | captures the Item or Associate involved (if applicable). |
| FEEDBACK RESPONSE | A brief description of the response type used to resolve a specific individual |
| | PARTY FEEDBACK. |
| | Examples: |
| | Provided a Discount |
| | Make available a Promotional Offer |
| | Provide Loyalty Points |
| | Credited Customer Account |
| | etc. |
| FEEDBACK TYPE | An entity that can be used to organize or group unstructured feedback at a |
| | high level. |
| | Possible Example: |
| | Product related |
| | Service related |
| | Staff related |
| | Store related |
| | etc. |
| FINANCIAL PLAN | The entity that provides details of a company's projected revenue and |
| | expenses for a future period of time. Sometimes referred to as Budget or |
| | Forecast. |
| FINANCIAL PLAN BALANCE | The entity that indicates the planned account balance amounts for defined |
| | groups of CHART OF ACCOUNT SEGMENTs. CHART OF ACCOUNT |
| | SEGMENTs identify areas of the business the company wants to track - |
| | accounts, sub accounts, internal departments, products, etc. - that when |
| | combined or concatenated into segment groups represent valid GL account |
| | numbers. |
| FINANCIAL PLAN STATUS | The entity that provides the status of a FINANCIAL PLAN. Examples may be, |
| | active, in review, on hold, etc. |
| FINANCL PLAN PROJ TASK RESOURC | This entity holds Financial Plan information for Resources assigned to Project |
| | Tasks. Financial Plan information includes cost and billing information. |
| | Resources can be items, such as machine time, or individuals including |
| | associates or 3rd party consultants. |
| FIXED ASSET | This entity identifies all the known FIXED ASSETs of the organization. FIXED |
| | ASSETs are tangible property used in the operation of the business. |
| | Examples of FIXED ASSETs are plant, machinery and equipment, furniture |
| | and fixtures. |
| FIXED ASSET ACCOUNT | The entity that indicates the types of fixed asset accounts. Fixed assets are |
| | long term, tangible property not expected to be converted to cash in the |
| | current fiscal year. Examples are manufacturing equipment, real estate, and |
| | furniture. |
| FIXED ASSET ACCOUNT TYPE | The entity that identifies the type of FIXED ASSET ACCOUNT like |
| | DEPRECIABLE ASSET ACCOUNT or NON DEPRECIABLE ASSET |
| | ACCOUNT. |
| FIXED ASSET AMOUNT | This entity identifies the monetary amounts associated with a FIXED ASSET. |
| | Types of amount that are tracked for a FIXED ASSET include: |
| | Salvage Value |
| | Predicted salvage Value |
| | Original Cost |
| | Adjusted Cost |
| | Depreciation amount |
| | etc. |
| FIXED ASSET AMOUNT TYPE | This entity contains monetary amount types and descriptions that can be |
| | associated with a FIXED ASSET. |
| | Examples are: |
| | Historical cost |
| | Gain on disposal |
| | Loss on disposal |
| | Rental income |
| | Capital appreciation |
| | Impairment loss |
| | Refurbishment cost |
| | Present value minimum lease payments |
| | Salvage Value |
| | Predicted salvage Value |
| | Original Cost |
| | Adjusted Cost |
| | Depreciation amount |
| | Fair value |
| | etc. |
| FIXED ASSET BOOK | This entity is a book or collection of assets, along with a record of the |
| | transactions performed on those assets, including addition, depreciation and |
| | so forth. |
| FIXED ASSET GROUP | This entity defines a category into which assets may be classified for tracking |
| | and reporting. |
| | An example is asset classes that group assets together based on depreciation |
| | method and the asset's estimated useful life. |
| FIXED ASSET GROUP ASSIGN | This entity tracks the group to which a FIXED ASSET is assigned. For |
| | example, FIXED ASSETs may be grouped by Asset Classes for depreciation |
| | tracking and reporting purposes. |
| FIXED ASSET IDENTIFICATION | This entity holds information regarding types of identification that may be |
| | assigned to FIXED ASSETs for tracking and reporting purposes. |
| | Examples of identification are serial numbers and asset tag ID numbers. |
| FIXED ASSET IDENTIFICATN TYPE | This entity holds the list of possible types of identification that can be assigned |
| | to a FIXED ASSET. Examples are Asset Id tags and Serial Numbers. |
| FIXED ASSET OWNERSHIP TYPE | FIXED ASSET OWNERSHIP TYPE describes whether a FIXED ASSET is |
| | leased or purchased. |
| | example: |
| | Purchased, |
| | Leased - Capital Lease, |
| | Reclassed from owner-occupied to investment property |
| | Investment Property under Finance Lease, |
| | Investment Property Owned. |
| FIXED ASSET PO ASSIGN | This entity tracks the Purchase Orders associated with a Fixed Asset. |
| FIXED ASSET STATUS ASSIGN | This entity tracks the status of a FIXED ASSET, such as in use, retired, idle, or |
| | disposed. |
| FIXED ASSET STATUS TYPE | The status or conditions that can be assigned to FIXED ASSET. |
| | Examples are: |
| | in use |
| | retired |
| | idle |
| | in repair |
| | Disposal - Withdrawn from use |
| | Disposal - Sale |
| | Disposal - Finance Lease to 3rd Party |
| | etc. |
| FIXED ASSET TYPE | The entity that identifies the type of internal FIXED ASSET like depreciable |
| | asset or non-depreciable asset. |
| FLIGHT | An aircraft carrying passengers and/or cargo, operated by an airline or carrier |
| | and traveling direct or non-stop from originating city to destination city. |
| FLIGHT CHECK-IN EVENT | The event when a passenger holding a TRAVEL COUPON checks in at the |
| | curb, airline or gate counter to let the airline know they are ready to travel on |
| | the scheduled flight |
| FLIGHT CODESHARE | This entity is an association between one airline's scheduled flight and another |
| | airline's representation of the same flight, using different flight numbers, |
| | codeshare partnerships and agreements; where codeshare means either |
| | airline can sell and issue tickets on its own company ticket stock. |
| FLIGHT PRODUCT (SEGMENT) | An entity that defines a flight product between an origin and a destination that |
| | is available on a regularly scheduled basis. |
| | It will always consist of one or more contiguous LEGs within a given FLIGHT. |
| | Note: a FLIGHT PRODUCT is usually known as and referred to as a |
| | SEGMENT by airlines. |
| | Example: Penguin Airline's Flight 1101 from L.A. to N.Y.C. that departs in the |
| | morning. |
| FLIGHT ROUTE | Indicates the series of T&T FACILITYs visited by a FLIGHT. |
| | This information is technically derivable from the LEG information, but this |
| | entity allows for operations and relationships at a ROUTE level - for example, |
| | we can indicate the Revenue Management Analyst responsible for the |
| | ROUTE. |
| | Example: A flight that takes off in Los Angeles, flies to Chicago, then takes off |
| | again and flies to New York would have a ROUTE of LAX-ORD-JFK |
| FLOOR PLAN | Some enterprises use identical/similar floor plans for many of their locations. |
| | This entity allows all locations with the same plan to be grouped together. |
| FM INVOICE | This entity contains information related to a billing document presented to a |
| | bill-to-party as a request for payment for goods sold or services rendered. The |
| | INVOICE entity captures information about an Invoice such as Invoice Date, |
| | Host Invoice Number, Payment Terms, and Freight Terms. |
| FM PAYMENT | The partial or complete discharge of an obligation typically by its settlement in |
| | the form of a transfer of funds applied against the monetary value of the |
| | debtor's obligation. PAYMENTs may be applied against obligations |
| | represented by one or more INVOICEs. |
| | Other forms of settlement include credit cards, bank transfers, direct debits, |
| | and checks. PAYMENTs can be further classified as an INVOICE PAYMENT, |
| | related to AP INVOICE LINE PAYMENTs or PAYMENTs collected for AR |
| | INVOICE LINE RECEIPTs. |
| | Other PAYMENTs could include Shopping Transactions, or to fulfill the Terms |
| | and Conditions of any Contracts that exist between the company and its |
| | PARTYs & Channels. |
| FM RETURN LINE | This entity identifies a specific ITEM within a RETURN transaction. It is |
| | possible that the same type of ITEM might appear on different lines, for |
| | example, if there were multiple RETURN REASONs. |
| FM VENDOR | Vendor/Supplier information. Shared between Purchasing and Payables. |
| | Note: the concept of Vender may be included in an industry model. Utilize the |
| | existing modeling to fulfill the need for Vender related entities/attributes if they |
| | exist. |
| FM VENDOR PO | This entity defines an order placed by the company for ITEMs to be supplied |
| | by a VENDOR. |
| FM VENDOR PO LINE | This entity defines the lines associated with a VENDOR PO. This is an order |
| | placed by the company with the VENDOR requesting the purchase of specific |
| | ITEMs. It can be for products and/or services and may include specific |
| | delivery dates and associated quantities, expected price per unit, etc. |
| FOLIO ACCOUNT | FOLIO is a collection of LODGING related PURCHASEs that are yet to be |
| | paid for by the PARTY (and consequently are recorded in accounts |
| | receivable). This is typically settled at check out. Examples are the Room |
| | charges, Meals charged to the room, Retail purchase charged to a room, |
| | Telephone charges, etc. |
| FOREIGN CURRENCY ADJ ACCOUNT | The entity that identifies a NONDIVIDEND EQUITY ACCOUNT as a foreign |
| | currency adjustment. Foreign currency adjustments are the gains or losses |
| | resulting from a translation of one currency into another. |
| FRANCHISE | A concept with consumer recognition and value developed by the owning |
| | organization. Often used in marketing and tie-in PROMOTIONs and often |
| | licensed to third parties. |
| | Example: Lucasfilm develops and owns the “Star Wars” concept (or franchise) |
| | and then licenses it to a fast food vendor for promotion purposes, as well as to |
| | a toy company for a series of “Star Wars” related toys (the toy brand may be |
| | “Fisher Price”). |
| FRANCHISE STORE | A STORE that that carries the enterprise branding, but is operated by a |
| | Franchised Third Party. |
| | Note: CORPORATE STORE and FRANCHISE STORE entities are provided |
| | as separate subtype entities to allow for future expansion. Specifically, it |
| | allows for: |
| | the placement of specific franchisee vs. corporate attributes |
| | relating other entities in the model to one of these specific subtypes, if |
| | desired |
| FREE CERTIFICATE | A sub-type of CERTIFICATE that identifies a certificate issued by an airline to |
| | be used to receive a free airline ticket. |
| | Example: Certificate for free round trip to any U.S. City awarded to a |
| | passenger who was bumped from a flight. |
| FREIGHT TERM TYPE | Indicates the payment agreement for Freight. |
| | Example: |
| | The fixed values are: |
| | Prepaid (The Shipper/Consignor pays) |
| | Third Party (A Party other than the Shipper or Receiver pays) |
| | Collect (The Receiver/Consignee pays) |
| | Note: |
| | This attribute is included because even though the Debtor (Paying) Party is |
| | included as an attribute for every SHIPMENT, it may be non-trivial to |
| | determine if the Debtor is actually the same party as the Shipper or Receiver, |
| | due to multiple Organizational Hierarchy Identifiers for a PARTY. |
| | An example could be where the enterprise assigned different Party Ids for the |
| | Customer and the Customer's Headquarters (or Holding Company) - in this |
| | case, even though the Shipper IS the Debtor Party, the actual Shipper Party Id |
| | and Debtor Party Id may differ - but the Payment Term would clearly indicate |
| | this fact. |
| FULFILLMENT TRAN | Inventory adjustment (negative) made due to the allocation/fulfillment/sale of |
| | goods. |
| GAME | Specifies a specific Casino Game. |
| | Examples: |
| | Wheel of Fortune |
| | Draw Poker |
| | Double Cherry |
| | Red White & Blue |
| | Spanish Blackjack |
| GAME CONFIG | Specifies a specific game configuration with specific rules, payouts, hold |
| | percentages, etc. |
| | This configuration can then be applied to multiple game stations, giving those |
| | game stations identical playing and odds characteristics. |
| GAME STATION INSTANCE | Defines a specific Game Station located in a specific Position with specific |
| | Game Configuration(s) for a specific Period of Time. |
| GAME TYPE | High level classification of Casino Games. |
| | Examples: |
| | Slot Games |
| | Reel |
| | Video Poker |
| | etc. |
| | Table Games |
| | Roulette |
| | Baccarat |
| | Craps |
| | Blackjack |
| | Caribbean Stud Poker |
| | etc. |
| GAMING EQUIP SVC | Captures information about the timely on-floor servicing of Gaming Equipment |
| | service calls (typically activated by the player). |
| | Note: This entity is not intended to support the detailed information captured |
| | during comprehensive (off the floor) Maintenance and Repair activities. This |
| | MRO detail may be a future enhancement. |
| GAMING FEEDBACK | Feedback received by the casino (typically regarding the quality of its products |
| | and services). |
| | The feedback can be planned: |
| | Contracting a third party to solicit feedback |
| | Periodic inspections and ‘mystery visitor’ activities conducted by the |
| | enterprise |
| | The feedback can be spontaneous: |
| | customers contacting the enterprise |
| GAMING SESSION TYPE | Classifies the GAMING SESSION into TABLE SESSIONs, SLOT SESSIONs |
| | and any other types of games. |
| | Example: |
| | TABLE SESSION, SLOT SESSION, etc |
| GDS PROVIDER | The Global Distribution System (GDS) is the domain of booking systems used |
| | by the airline industry to make airline flight reservations. |
| | Examples: SABRE, WORLDSPAN, AMADEUS, etc. |
| GE LOCATION | S2000 code that specifies the Geo and/or Electrical Location of the Parts on |
| | an Assembly or Circuit Card. |
| | Also known as a “reference designator” |
| | Typically specifies the horizontal and vertical offsets. |
| GENDER TYPE | This minor entity represents the gender that an individual can have. |
| GENERAL AND ADMIN ACCOUNT | The entity that indicates the operating expense pertains to general and |
| | administrative. These expenses are typically classified as administrative in |
| | nature. For example: advertising, salaries, commissions, office expense, etc. |
| GEOGRAPHY DEMOGRAPHIC | Provides the relationship of GEOGRAPHY to a specific DEMOGRAPHIC |
| | VALUE. |
| | Example: |
| | Postal Code 90210 has a characteristic of Median Income > $100,000 per |
| | year. |
| GIFT CERTIFICATE | An individual serialized Gift Certificate (or Card) that has been purchased, and |
| | is tracked for future redemption. |
| | Example: A gift certificate is presented as tender for items purchased. There |
| | may be an unspent balance remaining after the transaction is complete. |
| | Once a GIFT CERTIFICATE ITEM has been purchased for a specified face |
| | amount, as a SALABLE ITEM, a serialized GIFT CERTIFICATE is then issued |
| | which is then tracked as an account for credit by its serialized number for its |
| | unspent balance. |
| | Note: A Gift Certificate/Card can also be “reloaded”. This is accomplished by |
| | essentially re-selling the same Gift Certificate in future Transactions with |
| | additional amounts that will then be added to the unused balance. |
| GIFT CERTIFICATE ITEM | An item that provides a credit to a customer for a future purchase and |
| | redemption. Typically purchased as a gift to another party. |
| | Note: This represent the “concept” of a Gift Certificate (or Card), NOT the |
| | certificate/card itself. When actually purchased by a customer, it will be |
| | instantiated by a serialized entry in the GIFT CERTIFICATE entity. |
| GL INTERNAL ORG SEGMENT | The entity that indicates the internal organization segment of the accounts |
| | used in financial reporting for a company. |
| GL MAIN ACCOUNT | The entity that indicates accounts used in financial transactions for a company. |
| | This includes both the general ledger and subsidiary ledger transactions. |
| GL MAIN ACCOUNT CATEGORY | This entity categorizes GL MAIN ACCOUNTs according to the type of financial |
| | reporting related components it contains, i.e. Balance Sheet or Income |
| | Statement. |
| GL MAIN ACCOUNT PROJECT XREF | This associative entity links GL MAIN ACCOUNT to PROJECT for this date. |
| GL MAIN ACCOUNT SEGMENT | The entity that indicates the GL MAIN ACCOUNT SEGMENT of the accounts |
| | used in financial reporting for a company. Selling Expense is an example of a |
| | GL MAIN ACCOUNT. |
| GL MAIN ACCT GL SUB ACCT XREF | The entity that provides an association between the main general ledger |
| | accounts and sub general ledger accounts. For example, Selling Expense is |
| | associated with GL SUB ACCOUNT Salaries. |
| GL MAIN ACCT INTERNAL ORG TYPE | The entity that indicates the types of general ledger accounts and how internal |
| | organizations use them. Examples may be, for analysis, generate reports, etc. |
| GL MAIN ACCT INTERNAL ORG XREF | The entity that provides an association between general ledger accounts and |
| | internal departments. |
| GL MAIN ACCT REPORT PROD XREF | This associative entity links GL MAIN ACCOUNT to GL MAIN ACCT REPORT |
| | PROD XREF for this date. |
| GL MAIN ACCT SET OF BOOKS XREF | This associative entity links GL MAIN ACCOUNT to SET OF BOOKS for this |
| | date. |
| GL NON SERVICE PROD TYPE | This entity defines the type of non service product. Examples: Hardware, |
| | Software, Equipment, etc. |
| GL PRODUCT SEGMENT | The entity that indicates the product segment of the accounts used in financial |
| | reporting for a company. |
| GL PROJECT SEGMENT | The entity that indicates the GL PROJECT SEGMENT of the accounts used in |
| | financial reporting for a company. |
| GL REPORTING NON SERVICE PROD | This entity identifies a GL non service product as a physical product (as |
| | opposed to a service). |
| GL REPORTING PRODUCT | The entity that indicates the product segment of the accounts used in financial |
| | reporting for a company. |
| GL REPORTING PRODUCT CATEG | Indicates the category of GL REPORTING PRODUCT (Service or Non |
| | Service). |
| GL REPORTING SERVICE PROD | This entity identifies a GL service product as a service (as opposed to a |
| | physical product). |
| GL SERVICE PROD TYPE | This entity defines the type of service product. Examples: Customer Service, |
| | Professional Service, Data Service, etc. |
| GL SUB ACCOUNT | The entity that indicates sub accounts used in combination with GL Accounts |
| | to further define the nature of the GL Account. This includes both the general |
| | ledger and subsidiary ledger transactions. The GL Sub Account Wages and |
| | Salaries when combined with Selling Expense more clearly define the selling |
| | expense. |
| GL SUB ACCOUNT SEGMENT | The entity that indicates the GL SUB ACCOUNT SEGMENT of the accounts |
| | used in financial reporting for a company. |
| GL SUB ACCOUNT TYPE | The entity that indicates the types of general ledger sub accounts. Examples |
| | may be wages and salaries, employee benefits, etc. |
| GOLF COURSE | A sub-type of LOCATION that tracks information about a distinct area used for |
| | playing GOLF. |
| GOLF RESERVATION | A sub-type of ACTIVITY RESERVATION ITEM that stores information about a |
| | reservation made for playing golf such as reserving “tee times.” |
| GOODWILL ACCOUNT | The entity that provides details for goodwill. These details could include the |
| | cost differential between the acquisition cost of a business and the market |
| | value of the asset acquired. |
| GOVERNMENT ORGANIZATION | An ORGANIZATION that is part of the GOVERNMENT. |
| | Example: Federal Aviation Administration, IRS, Los Angeles City Council, CIA, |
| | USPS, etc. |
| GROUP EVENT | An event hosted by the enterprise for a group of customers with a common |
| | purpose. |
| | Examples: |
| | business conference/workshop |
| | casino junket |
| | wedding |
| | business conference |
| | gala banquet being catered on the final evening of an all week conference |
| | event. |
| | etc. |
| | Note: This is a recursive structure, so sub-events can be created under the |
| | main event. |
| | Some sample Subtypes are shown (Casino Junket, Banquet Event). Additional |
| | subtypes can be created to house specialized event attributes as needed. |
| GROUP EVENT MEMBER | Tracks INDIVIDUALs associated with a GROUP EVENT. This is useful to |
| | track any spending done by the INDIVIDUAL in addition to the |
| | spending/revenues from the GROUP EVENT itself. |
| GROUP EVENT REVENUE SUMMARY | This entity tracks the actual and estimated revenues across various |
| | PRODUCT/ITEM CATEGORIES such as Food, Beverage, Resource, etc. |
| | Note that this is at a lower level than the actual CLASS/CATEGORY/SUB- |
| | CATEGORY. |
| GROUP EVENT STATUS | Identifies the status of the group booking. |
| | Example: |
| | C - confirmed |
| | X - cancelled |
| | T - tentative |
| | checked out |
| | etc. |
| GROUP EVENT STATUS HIST | Captures the history of Status changes affecting the GROUP EVENT including |
| | cancellations, postponements, etc. |
| GROUP EVENT TYPE | Indicates the type of GROUP EVENT. |
| | Example: |
| | Wedding |
| | Junket (Casino, etc.) |
| | Banquet |
| | Golf |
| | Conference |
| | Sales Kickoff |
| | Annual Convention |
| | etc. |
| GUEST CHECK | In a Food Service or Hospitality situation, this represents the final bill |
| | presented to the customer(s). |
| GUEST CHECK TRANSFER | Allows the transfer of one Guest Check to another. |
| | Typically used when a bar counter check gets transferred to a table, one party |
| | that already opened a guest check joins another party, etc. |
| | Note: The transferred balance should be derivable. |
| HANDOVER (PICKUP ORDER) | A request by a customer to pick up goods to be transported at a specific |
| | LOCATION on a specific date and time. |
| HOLIDAY | A declared non-working day. Differs by Country. |
| | Example: Christmas, New Years Day, Bastille Day, Independence Day, etc. |
| HOSP ACTIVITY PRODUCT | A sub-type of HOSPITALITY PRODUCT that has information about activities |
| | that can be reserved by and sold to customers. Typically sporting or |
| | entertainment activities. |
| | Example: Golf Tee times, clubs, golf carts, mountain climbing, theater shows, |
| | sporting event, etc. |
| | Note: Products like golf lessons, etc. are covered under Hospitality Service. |
| HOSPITALITY PRODUCT | A Consumer Hospitality-related offer available for sale to a PARTY(s). |
| | Examples: |
| | Hospitality Product: Ocean view Miami Hotel room, |
| | Hospitality Retail Item: Jacket with Hotel logo, |
| | Menu Item: Turkey sandwich at a Casino cafe, |
| | etc. |
| HOSPITALITY RENTAL PRODUCT | A domain of HOSPITALITY PRODUCTs that customers can rent for temporary |
| | use such as Rental Cars, Golf Carts, etc. |
| HOSPITALITY RETAIL ITEM | All other ITEMs (other than MENU ITEMs) that are available for sale. |
| HOSPITALITY SERVICE | A non-physical type of a HOSPITALITY PRODUCT sold to a CUSTOMER. |
| | For example, Massage, Facial, Hair Perm, Golf Lesson, Caddy service, etc. |
| HOUSEHOLD | This is a subtype entity to PARTY. A household is a grouping of individuals |
| | created by the enterprise for marketing purposes. The individuals may live at |
| | the same address. |
| IATA DELAY CAUSE | Entity that represents the code defined by the International Air Transport |
| | Association (IATA) that defines the cause of the delay affecting this flight. This |
| | provides a consistent set of codes for all airlines to use for describing delays. |
| | Examples: |
| | Passenger and Baggage: |
| | 12 (PL) LATE CHECK-IN, congestions in check-in area, |
| | 18 (PB) BAGGAGE PROCESSING, sorting etc. |
| | Cargo and Mail: |
| | 24 (CI) INADEQUATE PACKING, |
| | 26 (CU) LATE PREPARATION IN WAREHOUSE |
| | Aircraft and Ramp Handling: |
| | 36 (GF) FUELLING/DEFUELLING, fuel supplier, |
| | Technical and Aircraft Equipment: |
| | 46 (TC) AIRCRAFT CHANGE, for technical reasons., |
| | Weather: |
| | 71 (WO) DEPARTURE STATION, |
| | 75 (WI) DE-ICING OF AIRCRAFT |
| | etc. |
| INBOUND TRANSACTION | A Type of Inventory Adjustment Transaction. |
| | Items transferred into a Location. |
| | Example: Transferring goods between distribution centers, supplying stores |
| | with goods from warehouse locations or distribution centers, etc. |
| | Note: |
| | When transferring items from location A to location B, there will be 1 ‘transfer |
| | out’ outbound transaction for location A and 1 (or more) ‘transfer in’ inbound |
| | transactions for location B. Each of the location B transactions will be related |
| | to the originating location A transaction. |
| INCIDENT COST | Groups all costs associated with a specific Incident. |
| | Note: this is useful if an Incident or Equipment Event did NOT trigger |
| | Maintenance Events (since all Maintenance related Event Costs are already |
| | captured elsewhere) |
| INCIDENT REASON | The reason description for an INCIDENT that further describes why the type of |
| | incident occurred. |
| | Example: flight delayed due to weather, flight diverted because of closed |
| | airport, etc. |
| INCIDENT TYPE | The type code assigned to an Incident. |
| | Example: 1 = Equipment substitution, 2 = Delayed, 3 = Cancelled, etc. |
| INCIDENTAL ITEM | Items such as Telephone services, In-room Movies, Mini-Bar items that are |
| | typically not reserved in advance and whose consumption is typically not |
| | budgeted by the PARTY. The consumption of these lead to “incidental |
| | expenses.” |
| INCOME STMT GL MAIN ACCOUNT | The entity that indicates a general ledger account is in the Income statement |
| | reporting category. Types of this category include Expense, and Revenue |
| | Accounts. |
| INCOME STMT GL MAIN ACCT TYPE | The entity that indicates the types of general ledger accounts are on the |
| | Income Statement financial statement. Examples are revenue account and |
| | expense account. |
| INCOME TAX ACCOUNT | The entity that provides the expense details for the income taxes. |
| INCOME TAX PAYABLE ACCOUNT | The entity that provides details for the income taxes. Income taxes are the |
| | amount due to taxing authorities. |
| INDIVIDUAL | This is a subtype entity to PARTY. This entity consists of those people that |
| | are of interest to the enterprise. |
| INDIVIDUAL ALERT | Defines an alert to special conditions that may affect the status of an Individual |
| | (typical a Customer) |
| | Multiple alerts can be in effect at the same point in time for the same |
| | individual. |
| | Examples: |
| | General: |
| | Current Open Bad Check(s) |
| | Lodging: |
| | Hotel Banned (may still play in Casino) |
| | Casino: |
| | Redemptions Frozen (due to bad markers/returned checks) |
| | Casino Excluded (prohibited from Casino play) |
| | State Excluded (prohibited from play in the entire state) |
| | Disassociated (prohibited from Casino play by personal request) |
| INDIVIDUAL ALERT HIST | Captures Alerts that have been assigned to Individuals, as well as the time |
| | period(s) that they apply to. |
| | Multiple alerts can be in effect at the same point in time for the same |
| | individual. |
| | Examples: |
| | Current Open Bad Check(s) |
| | Hotel Banned (may still play in Casino) |
| | Note: If desired, the higher level Party Status entity may be used instead to |
| | capture all status and alert information at the Party level (Individuals and |
| | Organizations). |
| INDIVIDUAL NAME (EMP) | This entity tracks an individual's name. |
| INDIVIDUAL PASSPORT | Captures an Individual's Passport information. Used for Travel and Security |
| | purposes. |
| | An Individual can hold multiple Passports. |
| INGREDIENT | An item that is used (typically along with other ingredients) to create a menu |
| | item. It is not salable to customers by itself. |
| INSPECTION | The event that records the results of an inspection of cargo/freight. Captures |
| | the difference between actual measure versus that specified on the |
| | SHIPMENT LINE ITEM for this PIECE. |
| | Examples: |
| | Weight is more or less than that stated |
| | Wrong NMFC code used to classify the shipment |
| | Wrong Container type used to rate the shipment |
| INTANGIBLE ASSET ACCOUNT | The entity that indicates the other asset is intangible. Types of intangible |
| | assets are patents and goodwill. These assets have no physical existence, |
| | such as a brand, franchise, trademark, or patent; yet have a substantial value |
| | to the company. |
| INTANGIBLE ASSET ACCT TYPE | The entity that indicates the type of an intangible asset account. For example: |
| | patent or goodwill. |
| INTER INTRA COMPANY TXN ACCT | A category of GL SUB ACCOUNT that provides expense details for facility |
| | allocations, data service allocations, other allocations between inter/intra |
| | company parties. |
| INTERACTION TASK | Entity used for capturing information about individual web activity performed. |
| | These could range from adding an item to a basket, deleting an item, etc. The |
| | exact range of tasks that can be captured depends on the capabilities of the |
| | commerce server |
| | Example: add blue sweater to the shopping cart, delete item from the shopping |
| | cart, place an order, download a file, etc |
| INTEREST EXPENSE ACCOUNT | The entity that indicates the expense account is an interest expense. Interest |
| | expense is paid to bondholders for the use of their money. |
| INTEREST INCOME ACCOUNT | The entity that indicates the REVENUE ACCOUNT is for interest income. |
| | Interest income is received by the company from its investment in stocks and |
| | bonds. |
| | Note: Some business might treat Interest Income as a negative expense. In |
| | this case the entity is a subtype of EXPENSE ACCOUNT. |
| INTERNAL ORGANIZATION | This is a subtype to ORGANIZATION. It is an organization that is internal to |
| | an enterprise such as a department. |
| INTERNAL ORGANIZATION TYPE | This minor entity identifies the type of internal organization. Examples of |
| | internal organization types can include departments. |
| INTERNAL PROJECT | INTERNAL PROJECT Type indicates the PROJECT is for use inside the |
| | company only. |
| INVENTORY CONTROL | A cross reference of products or items to locations for the purpose of |
| | managing inventory. It specifies the required, re-ordering, and safety levels of |
| | stock. |
| INVENTORY ITEM | A subset of (physical) items than can be inventoried. This would exclude |
| | service items and virtual items. |
| | There would typically be corresponding information for these Items in the |
| | Inventory Subject Areas to track levels and locations of the Items. |
| | For e.g., Can of soda, 6 pack of Soda cans, Shampoo, Massage oils, Golf |
| | clubs, etc |
| INVENTORY REASON | Indicates the reason for the Inventory Transaction. |
| | Example: |
| | Wastage (why goods became un-salable and un-returnable): |
| | Spoiled, Damaged, Beyond expiration date, etc. |
| | Transfer (Outbound, Inbound): |
| | Normal DC Transfer, Store supply to support promo, Returns from Store |
| | to DC, etc. |
| | Audit: |
| | Normally scheduled stock count, exception count, etc. |
| | Configuration: |
| | Breakdown of bulk in preparation for shipping to Store, etc. |
| | Note: It is assumed all items contained in an Inventory Transaction share the |
| | same reason code. If the requirement is to differentiate reason codes at the |
| | item line level instead, relate the INVENTORY REASON to the INVENTORY |
| | TRANSACTION ITEM level. |
| INVENTORY RELATED ACCT | Lifo/Fifo provisions, material price & usage variances, labor variance, physical |
| | inventory adjustment, etc. |
| INVENTORY REQUEST | A Type of Inventory Transaction. |
| | A Request to get Items transferred into a Location. |
| | Example: |
| | A MRO Shop Manager requests (orders) MRO Items (Parts) from the |
| | local Distribution Center (or another Store). If this request is to support a |
| | specific Maintenance Event, a link to the requesting Maintenance Event is |
| | provided. |
| | Since this is an internal ‘order’, no money will be changing hands. |
| | Note: |
| | The Location doing the requesting is found in the Inventory Transaction entity. |
| | Note: |
| | This Transaction will be linked to all the Inventory Outbound Transactions that |
| | will be generated by the sending Locations to service the request, and in turn, |
| | these linked Outbound Transactions will be linked to the final Inbound |
| | Transactions representing the receipt of these Items by the Requesting Party. |
| INVENTORY TRANSACTION | An event that affects the inventory level of an item. |
| | Inventory Transactions can be: |
| | Internal (the items remain under the control of the enterprise for the |
| | duration of the transaction) or |
| | External (the item is received from, or provided to, an external party) |
| INVENTORY TRANSACTION ITEM | Information about the item involved in the Inventory Transaction. |
| | Covers inventory transactions (adjustment of item counts) in locations |
| | belonging to the enterprise only. |
| | Example: Transferring goods between distribution centers, supplying stores |
| | with goods from warehouse locations or distribution centers, adjusting |
| | Inventory levels due to shrinkage, wastage or damage, etc. |
| | Note: The item quantity will be positive when adding to the inventory count |
| | (transfer in, etc.) and negative when subtracting from the inventory count |
| | (transfer out, wastage, etc.) |
| INVESTMENT ASSET ACCOUNT | The entity that provides details for investments. These investments in debt |
| | securities with a positive intent and the ability to hold these securities until they |
| | mature. |
| INVOICE | A request for payment presented by one Party to another, typically for services |
| | rendered or goods provided. |
| INVOICE ADJUSTMENT | Adjustments to an Invoice or an Invoice Line. |
| | Examples: |
| | credit for damaged item |
| | credit for missing items |
| INVOICE AMOUNT | This associative entity relates the INVOICE with the amounts for the INVOICE, |
| | such as Invoice original amount, Invoice total amount, as defined in the Invoice |
| | Amount Type Cd. The amounts are recorded in transaction, local accounting |
| | and base currencies. |
| INVOICE AMOUNT TYPE | This minor entity contains the INVOICE monetary amount types and |
| | descriptions that can be associated with an AP INVOICE or AR INVOICE. |
| | Examples are: |
| | Invoice original amount |
| | Unit price |
| | Invoice total amount |
| | Freight invoice total amount |
| | Tax amount |
| | Discount amount |
| | Paid amount |
| | Unpaid amount |
| | FOR PA DRAFT INVOICE |
| | raw cost |
| | burden cost |
| | raw revenue |
| | adjusted revenue |
| | bill amount |
| | etc. |
| INVOICE CHARGE | Details the specific charges that are added to a Purchase or Sales Transaction |
| | that are not related to any particular item. |
| | Example: Shipping, Handling, Insurance, Expedited Shipping, etc. |
| INVOICE INVOICE RELATIONSHIP | This associative entity relates INVOICEs to other INVOICEs. There is one |
| | instance for each relationship. The Invoice Relationship Type describes the |
| | relationship type between INVOICEs. |
| | Examples of INVOICE relationships include PA DRAFT INVOICE to AR |
| | INVOICE, and INVOICE ADJUSTMENT to the original INVOICE. |
| INVOICE LINE PARTY | This entity is used to store the relationship between AP INVOICE LINE and the |
| | Party Role Code associated with each Line Item. Possible role codes could be |
| | Shipment Receiver, Payment Approver, Goods Inspector. This entity links to |
| | AP INVOICE LINE as well as INVOICE LINE PARTY ROLE. |
| INVOICE LINE PARTY ROLE | This entity identifies a PARTY's role relationship to an Invoice Line. |
| | Possible role codes could be Shipment Receiver, Payment Approver, Goods |
| | Inspector. |
| INVOICE LINE PAYMENT | Contains information about INVOICE LINE PAYMENT detail related to an |
| | INVOICE PAYMENT. |
| INVOICE LINE PAYMENT STATUS | Assigns a PAYMENT STATUS, such as Remitted or Reversed, to an invoice |
| | line. Tracks INVOICE LINE PAYMENT status by date. Also associates a |
| | reason with the PAYMENT STATUS, such as Wrong Amount or Account |
| | Closed. |
| INVOICE LINE PAYMENT TYPE | Further classifies an INVOICE LINE PAYMENT as a remittance against an AP |
| | INVOICE LINE PAYMENT or collection against an AR INVOICE LINE |
| | RECEIPT. |
| INVOICE PARTY | This entity identifies the PARTYs associated with an INVOICE. For example, |
| | the Customer, Buyer, VENDOR, Requestor, Salesperson, Collector, Payer, |
| | Payee, Ordering Party, Delivered To Party, Bill To Party, Responsible |
| | Department Party, Invoice Created by Party, Responsible Sales Department, |
| | etc. |
| INVOICE PARTY ROLE TYPE | This minor entity identifies the role type of a party to INVOICE such as the |
| | Customer, Buyer, Vendor, Requestor, Salesperson, Collector, Payer, Payee, |
| | Ordering Party, Delivered To Party, Bill To Party, Responsible Department |
| | Party, Invoice Created by Party, Responsible Sales Department, etc. |
| INVOICE PAYMENT | Payments made or collected that relate to an INVOICE. |
| | Other PAYMENTs could include Shopping Transactions, Contract payments or |
| | any PAYMENT that does not relate to an INVOICE. |
| INVOICE PAYMENT APPLY | A way to apply one PAYMENT to one or more INVOICEs. |
| INVOICE PO LINE XREF | Provides a cross reference between Items on a Purchase Invoice and the |
| | related Items on the original Purchase Order Line. |
| INVOICE QUANTITY TYPE | For example, credited, invoiced and ordered. |
| INVOICE RECEIPT LINE XREF | Provides a cross reference between Items on a Purchase Invoice and the |
| | related Items on a Vendor Receipt Line. |
| INVOICE RELATIONSHIP TYPE | This minor entity describes the type of relationship between two INVOICEs |
| | such as replaces, credit memo for, etc. |
| INVOICE SALE LINE XREF | Provides a cross reference between Items on a Sales Invoice and the related |
| | Items on the original Sales Order Line. |
| INVOICE SOURCE TYPE | This entity describes the source of the invoice, i.e. auto invoice, transactions |
| | window, etc. |
| INVOICE STATUS | Describes the status of an Invoice. |
| | Example: |
| | Paid in Full, Written Off, Pending, etc. |
| INVOICE STATUS HIST | This entity tracks the status of an INVOICE, such as cancelled, approved, |
| | pending, send, hold, release, etc. |
| INVOICE STATUS REASON | A reason why a particular Invoice Status Type Cd is assigned to an INVOICE. |
| | For example, if the status code is ‘release’, the reason codes may be: |
| | PO was matched |
| | the quantity ordered has been reconciled. |
| | If the status code is ‘hold’, the reason codes may be: |
| | Funds Hold Reason |
| | Insufficient Information |
| | etc. |
| INVOICE TYPE | Describes the type of Invoice. |
| | Examples: |
| | Submitted by the enterprise for Payment (Accounts Receivable) |
| | Received by the enterprise to be Paid (Accounts Payable) |
| IP ADDRESS | IP (Internet Protocol) addresses are assigned to every computer or device on |
| | a TCP/IP network such as the internet. They may be assigned statically, |
| | where a computer/device is assigned an IP Address and it will always use that |
| | address. They may also be assigned dynamically where at the point a |
| | computer connects to a network, it is assigned an IP Address from the pool of |
| | addresses available from that provider. This entity is differentiated from |
| | ELECTRONIC ADDRESS (found in the ADDRESS Subject Area) which may |
| | not have IP Address detail but will likely have an e-mail User Name. |
| | Customers wishing to do so may make this entity a subtype of ELECTRONIC |
| | ADDRESS. |
| | Example: 192.168.168.173 |
| ITEM | An ITEM is the lowest level for which inventory and sales records are retained |
| | within the enterprise. |
| | An Item is a grouping of one or more products, parts or services and the |
| | optional, corresponding price plan, rate structure or unit charge that may be |
| | marketed by the organization for the purpose of generating revenue. An Item |
| | is what a customer purchases or subscribes to or Items the Enterprise |
| | inventories to do business. |
| | Examples: |
| | Navigational Gyro Assembly |
| | Parker Elite fountain pen in silver |
| | Heineken 8 oz Beer |
| | Round Trip Travel Package (see Multi Item) |
| | Photo Printing Service |
| | Overnight Transportation Service, |
| | Turkey sandwich |
| | 737 Aircraft Coach Passenger Seat Assembly B5R2-4 |
| | Accessorial Service |
| | etc. |
| ITEM (PART) SPEC | Defines the Item (Parts) requirements to perform the specified Maintenance. |
| ITEM CHARGES | Specifies the component amounts that make up the total price charged for a |
| | PRODUCT. |
| | Example: Transfer Fee, Airline Fare, Meal ticket, Gratuity Amt, Tip Amt, Tax, |
| | etc. |
| ITEM CLASS | A sub grouping of like merchandise, usually created along the enterprise's |
| | reporting hierarchy and associated with a certain grouping of ITEMs and |
| | ASSOCIATE(s) managing said ITEMs (e.g. a ‘buyer’). An ITEM CLASS |
| | belongs to exactly one DEPARTMENT and is considered one of the highest |
| | levels at which purchasing and sales/usage are planned. ITEM CLASS may |
| | be a level member of an organization's ITEM hierarchy. The actual naming |
| | convention for an ITEM hierarchy may vary across organizations. |
| ITEM COST | Cost information of an ITEM for a particular effective date range at a given |
| | Location. The key structure may vary as per enterprise requirements. |
| | Mainly to be used for Item profitability calculations or estimates. Sometimes |
| | referred to as “True Cost” of ITEM assuming that all known allocated variable |
| | costs in addition to Purchase (at Cost) of Item have been applied. |
| | Note: Item Cost may vary at a higher level than discrete locations. If costs are |
| | the same across groups of locations, then a Cost Zone entity could be |
| | considered to group Locations together for Costing purpose, and then use this |
| | Cost Zone as a primary key attribute instead of Location Id. |
| ITEM COST DETAIL | Allows Item Costs to be further broken down (or allocated) to actual Cost |
| | Types. |
| | Example: The expenditure items can include: Fuel, Equipment Maintenance, |
| | Rent, Service Charge, Heat and Electricity, Distribution, Repairs, Facility |
| | Maintenance and Grounds, Security, Cleaning, Refuse, Communication - |
| | Telephone, Mail, FedEx, Bank Charges, Stationery and Supplies, Labor, |
| | Purchase (at Cost) of Item (amount paid for goods actually resold), etc. |
| ITEM EQUIVALENCE | Maps the relationships between ITEMs with high degree of similarity. Used to |
| | indicate ITEMs that may be substituted for one another, as well as superseded |
| | ITEMs, obsolete ITEMs, etc. |
| | Note: This structure can also be used to support manufacturer's batch or lot |
| | information if needed. In this case each batch or lot would define a new Item |
| | Id and this structure would be used to group them together. |
| ITEM EQUIVALENCE TYPE | Specifies the relationship between ITEMs with high degree of similarity. Used |
| | to indicate ITEMs that may be substituted for one another, as well as |
| | superseded ITEMs, obsolete ITEMs, etc. |
| | Examples: |
| | item a has been superseded by Item b |
| | item a may be substituted by Item b (without notifying customer - implies |
| | functional and appearance equivalence) |
| | item a may be substituted by Item b (but should notify customer - implies |
| | functional but possibly not appearance equivalence) |
| | item is identical but from a different manufacturer's batch or lot. |
| ITEM GROUP | A cluster of ITEMs, grouped together for analytical or merchandising reasons. |
| | Can be used for permanent, global, or ad-hoc reasons. |
| | Example: |
| | An analyst can define an ITEM GROUP to be all ITEMs that had a return |
| | rate of over 10%. This can then be used to easily track and report on |
| | these ITEMs in future. |
| | A group of Travel Products with destinations located on or near large- |
| | scale recreational venues such as skiing, beaches, theme parks, etc. |
| | Note: An ITEM can be in multiple ITEM GROUPs at the same time. |
| ITEM GROUP TERM | Terms or conditions that are associated with a contract and a group of items. |
| | Example: Special handling or delivery requirements for a group of Items. |
| | Note: This in addition to the information specified in Agreement Pricing area. |
| ITEM GROUP TYPE | Classifies and provides the reason for the creation of an Item Group. |
| | Can be a Custom Typing, or Formal/Standardized for used by the entire |
| | enterprise. |
| ITEM GROUP XREF | Defines which ITEMs are contained in which GROUPs. |
| | Note: An ITEM can be in multiple ITEM GROUPs at the same time. |
| ITEM INVENTORY | Represents the expected On Hand Stock position as of a specific date at a |
| | given location as seen by the system. It is typically based on a known starting |
| | count or base position and adjusted based on known transactions (i.e., sales, |
| | returns, receipts, adjustments) that took place during the intervening period |
| | leading up to the current reporting date. The values of this entity are as |
| | accurate as practical until a periodic physical count is performed to re- |
| | synchronize them to with their actual values, if need be. |
| | ITEM INVENTORY is utilized by store management, category managers, |
| | buyers and merchandisers to analyze inventory on a daily, weekly or specific |
| | period basis, thus allowing for better tactical as well as strategic decisions to |
| | be made regarding current and future item replenishments, planned or |
| | unplanned markdowns, and potential item deletion or reductions, thus resulting |
| | in improved inventory positions to reduce potential out of stock and overstock |
| | situations. |
| | Note: This entity differs from the Perpetual Inventory entity, which instead |
| | reflects all inventory adjustments as they as happen - providing a more real- |
| | time/up to date and time inventory representation. Item Inventory represents |
| | the On Hand Stock position of a given item at the end or beginning of ‘regular’ |
| | or ‘fixed’ period, versus at any point in time during that period. |
| ITEM MSRP HIST | The manufacturer's suggested retail price for an item. |
| ITEM OFFER XREF | A mapping of which Item or Group of Items are involved in a specific promo |
| | offer. An item can participate in a promo offer in 2 ways: |
| | a.) something to be purchased (at full price) to receive an incentive on another |
| | item. (purchase item x and get a discount on item y) |
| | b.) forms part of the actual incentive (get Item x for 50% off) |
| | Travel Example: |
| | Fly LAX-SFO, Monday through Thursday, during January and get 10% |
| | off. |
| | Fly LAX-ATL during December and get a companion ticket for 50% off. |
| | NOTE: Attributes can be added to spell out the exact details of the product/ |
| | promo offer relationship. |
| ITEM PRICE | A Specific Price for a specific Item for a date range, based on a set of pricing |
| | conditions. |
| | Example: |
| | Price for Item A if 100+ are purchased from Location B during 2005. |
| ITEM PRICING | The history of pricing information of an ITEM overtime. The key structure may |
| | vary as per enterprise requirements. |
| | The Pricing Id is used to define a SET OF CONDITIONS for which a single |
| | price applies for a specific date range. |
| | For the specific pricing conditions, see the item type specific Subtypes. |
| | Note: You typically have multiple Pricing Ids (and prices) for the same Item. |
| | This can be due to: |
| | date (price change over time) |
| | condition set (different price by channel, region, etc.) |
| | volume scale (lower price based on volume purchase) |
| | Note: Since the Item entity allows for the capture of 3rd Party Items (like that of |
| | a Competitor), this structure will also allow the capture of 3rd Party pricing |
| | information (such as Competitors, Suppliers, etc.), in addition to the |
| | enterprise's own pricing structure. |
| ITEM SCORE | A relative value, or ‘score’ produced by an ANALYTICAL MODEL after |
| | reviewing business information. This can provide a measure or way to group |
| | and treat ITEMs that the business deals with. |
| | Example: Items can be ‘scored’ for profitability, frequency of purchase, |
| | propensity to be bought, etc. Business partners and customers can similarly |
| | be ‘scored’ |
| ITEM STATUS | Set of possible ‘states’ an Item can possess |
| | Example: |
| | Newly Announced |
| | Available for Order |
| | Discontinued |
| | etc. |
| ITEM STATUS HIST | Captures the history of actual Item ‘states’. |
| | Example: |
| | For Item 2353 (Blue Widget) |
| | Jan 5 1995 - Newly Announced |
| | Mar 3 1995 - Available for Order |
| | May 8 2004 - Discontinued |
| | etc. |
| ITEM SUBCLASS | A level of the ITEM hierarchy description. It is a member of exactly one ITEM |
| | CLASS. The actual naming convention for the product or item hierarchy may |
| | vary across organizations. |
| ITEM TERM | Terms or conditions that are associated with a contract and a specific item. |
| | Example: Special handling or delivery requirements for a given Item. |
| | Note: This in addition to the information specified in Agreement Pricing area. |
| ITEM TRAIT | The actual value describing the specific TRAIT of a specific ITEM. An ITEM |
| | can have an unlimited number of ITEM TRAITs. |
| | Example: |
| | “Hawaiian Destination” DVD has the following ITEM TRAITs: |
| | Aspect Ratio: ‘1:2.35’ |
| | Encoding: ‘Anamorphic’ |
| | Genre: ‘Travel Documentary’ |
| | Age Rating: ‘Family’ |
| | etc. |
| | “Boeing 747 Framostat” Component has the following ITEM TRAITs: |
| | Voltage: 3.3 V |
| | Max Temperature: 120 |
| | Diameter: 15 cm |
| | etc. |
| ITEM TYPE | Indicates the subtype of the ITEM (Travel Product, MRO Item, Transport |
| | Service, etc.) |
| JOB CLASSIFICATION | Describes the general job title or classification of a position. |
| | Examples: |
| | Manager |
| | Stock Clerk |
| | Checkout Clerk |
| | Blackjack Dealer |
| | Forklift Operator |
| | Distribution Center Manager |
| | Driver |
| | etc. |
| JOINT PROJECT | JOINT PROJECT Type indicates the PROJECT is involves PARTYs both |
| | within and outside the company. |
| JOURNAL ENTRY HEADER | The entity that provides summary of an accounting transaction recorded in the |
| | general ledger. |
| JOURNAL ENTRY LINE | The entity that provides details of an accounting transaction usually, credit or |
| | debit recorded for a transaction. One JOURNAL ENTRY HEADER will have |
| | multiple JOURNAL ENTRY LINEs. |
| KENO SESSION | A duration of time spent by the CASINO PLAYER waging bets on a match |
| | between the numbers they have chosen versus what is randomly drawn by the |
| | CASINO from a field/bank of numbers. |
| | For example, the player chooses 15 numbers from the bank of 80 and bets a |
| | dollar against each number (total of $15). The random draw typically includes |
| | 20 numbers. Say, in this case, 7 of them match with player's choice. |
| | Typically, the casino pays the player based on a payoff schedule and the more |
| | the number of matches, the higher the payoff. A jackpot amount is usually |
| | awarded if a player can match all 20 numbers |
| KIDS CLUB RESERVATION | A sub-type of ACTIVITY RESERVATION storing reservation information to |
| | typically entertain or provide care services to the children of guests |
| | (accompanying them on a VISIT). |
| KIOSK | A physical device than can be used by INDIVIDUALs for self-service |
| | applications. |
| | Example: |
| | A Self Service device at the airport where customers can perform their |
| | own check-in and obtain a boarding pass. |
| | A device at the entrance of a store that gives an Individual a list of |
| | targeted Offers when they swipe their Loyalty Card. |
| KIOSK TYPE | This entity describes the nature of the KIOSK. |
| | Example: |
| | providing Information Only, |
| | enabling Web Purchases, |
| | Providing Offers to loyalty card members, |
| | self-check-out/scanning, |
| | etc. |
| LABOR PLAN | Denotes the planned labor cost and hours for a specific job classification for a |
| | specific PERIOD at a specific LOCATION. |
| LABOR POOL | Identifies the associates that can be drawn from to perform labor at a specific |
| | location. |
| LABOR SCHEDULE | Details the associates scheduled to work specific shifts on specific days. |
| LEDGER BATCH | The entity groups INVOICEs into sub ledger or journal entries for processing |
| | into general ledger transactions. |
| LEDGER BATCH TYPE | The entity that indicates the type of general/sub ledger batch. Possible |
| | examples may be: |
| | Batch from journal entries |
| | Batch from accounts payable |
| | batch from accounts receivable |
| | etc. |
| LEDGER POSTING STATUS | The entity that indicates the posting status of a general/sub ledger batch. |
| | Possible examples may be: |
| | Posted (ready to be entered in the general/sub ledger), |
| | Do not post, etc. |
| LEG | This entity represents the basic building block of a single Origin and |
| | Destination pair that represents travel with no intermediate stops. |
| | Example: For Air, it would be one take off and one landing. For Rail, it would |
| | be travel between two consecutive station stops. |
| LEG BOOKING HIST | The history of the actual bookings for a SERVICE CLASS of a SCHEDULED |
| | LEG as they were realized, a set number of days prior to departure. |
| | This would include information on bookings, seats booked, seats ticketed, |
| | deadweight seat count, etc. |
| | Note: The “HIST” suffix indicates that some of the attributes of this entity may |
| | be derivable in some instances by looking at the actual detailed passenger |
| | check-in information, while other attributes may only be sourceable from a |
| | Revenue Management System. |
| LEG CONTAINER | Positional and other information regarding placement of a Container within an |
| | Aircraft during a Scheduled Leg on a specific Flight. |
| LEG EQUIP (ACTUAL) | A cross reference of Equipment utilized during a Scheduled Leg on a specific |
| | Flight. Note that the Equipment listed contains the Aircraft as well as all |
| | Containers, etc. |
| LEG EQUIPMENT PIECE | Specifies all the content (Pieces) of a Shipment that is being transported by a |
| | specific piece of Equipment over a specific Leg. |
| | The Equipment being mapped to can be either a Vehicle (for the mapping of |
| | containers or loose Pieces), OR a Container |
| LEG FLOWN (SUMMARY) | The summary information of the performance of an actual scheduled OnD |
| | LEG as it was realized, i.e. (flown) by the airline. |
| | Example: Penguin Airline's Flight 1101 from L.A. to N.Y.C. that departed on |
| | Tuesday, Jan. 23, 2001 at 10:00 am. Cost per ASM - 17.3 cents, etc. |
| | Note: The “(SUMMARY)” suffix indicates that some of the attributes of this |
| | entity may be derivable in some instances by looking at the actual detailed |
| | passenger reservation and check-in information, while other attributes may |
| | only be sourceable from a Revenue Management System. |
| LEG FLOWN CARGO(SUMMARY) | Captures the overall Cargo Performance for a Flown Leg. Metrics can be |
| | added as needed. |
| | Note: Most of the information shown here should be derivable, and this |
| | structure should only be implemented if the underlying information needed are |
| | not (readily) available. |
| LEG INCIDENT | This entity relates the incidents registered during a specified LEG. |
| | Example: DELAYED, CANCELED, etc. |
| LEG SPACE ALLOCATION | Mapping Allocated/Planned Container Types and Non Container Space |
| | (Loose Freight) requirements to a Scheduled Leg. |
| | At this point the actual containers or ULDs that will be used may not be known |
| | yet (only the type and class), so their unique Serial Numbers are not used. |
| LEG TRAN EQUIP | The Actual Transportation Equipment utilized for a Scheduled Leg on a |
| | specific Flight. |
| | Example: |
| | Air Cargo: |
| | Specific Aircraft |
| | Ground Transportation: |
| | Specific Truck Engine(Tractor) and 2 Trailers |
| LIABILITY ACCOUNT | The entity that indicates a general ledger account is a LIABILITY ACCOUNT. |
| | These accounts are related to a potential loss, or a financial obligation, debt or |
| | claim of money owed to owner party. Types of LIABILITY ACCOUNTs include |
| | current liability and non-current liability. |
| LIABILITY ACCOUNT TYPE | The entity that identifies the type of liability account. Types of liability accounts |
| | are current liability and non-current liability. |
| LIMIT TYPE | This minor entity describes the type of limits that can apply to a party such as |
| | customer credit limit, customer credit limit per order, customer site credit limit, |
| | or vender invoice amount limit, authorization limit, etc. |
| LIMO RESERVATION | A sub-type of ACTIVITY RESERVATION ITEM, it represents a reservation for |
| | a limousine to transport a PARTY from one location to another. |
| LOCAL SALES TERRITORY | A group of customer locations for purposes of marketing and sales. Indicates |
| | the Local Manager responsible for servicing a given Sales Territory. |
| | Example: Eastern Portland territory |
| LOCATION | A physical or virtual site which is owned or leased by a business entity to |
| | support Sales and/or Services. |
| | Example: STORE, DISTRIBUTION CENTER, CALL CENTER, etc |
| | A Location can be contained in another Location (Airline Counter inside an |
| | Airport, Restaurant inside a Hotel, etc.) |
| | Note: Location subtypes are shown as inclusive (meaning a single location can |
| | be a member of multiple location subtypes). This allows a single location to |
| | inherit characteristics from multiple Location subtypes. For example, a Dining |
| | Location can also be a Store Location, thereby inheriting the Store Location |
| | attributes. If the Enterprise does not have this requirement, the subtypes can |
| | be made Exclusive instead. |
| | Note: “Virtual” Locations can refer to: |
| | non-physical locations (Web Store, etc.) |
| | logical Locations inside physical Locations (one use could be a Inventory |
| | Logistics Company dividing a Warehouse into “logical/virtual” Locations to |
| | house Inventory for multiple Clients - this way items on the same shelf |
| | can be in different “virtual” Locations, while all contained in the same |
| | physical Location. |
| LOCATION ADDRESS | Describes how a specific combination of ADDRESS, LOCATION and |
| | ADDRESS USAGE is used in a unique combination |
| | Examples: ‘123 Main Street’ is used by ‘Distribution Center 23’ as ‘Ship To’. |
| | ‘310-555-2342’ is used by ‘Call Center 46’ as ‘Customer Service Fax number’. |
| LOCATION BUSINESS DAY | There is often a requirement for a Business Day to span Calendar Days, such |
| | as when business transacted after midnight (the next calendar day) needs to |
| | be grouped together with business transacted prior to midnight as a cohesive |
| | “Business Day.” |
| | This entity specifies the translation from “Calendar Date” into “Business Date” |
| | for each Location. |
| LOCATION BUSINESS HOURS | Captures the Business Hours for a given Location in Local Time by Day of |
| | Week (Typically the hours that the Location is officially open to transact |
| | business with Customers) |
| | Note: If needs are more complex, this can be extended as follows: |
| | Use Calendar Date in the PK to specify Hours on a daily basis |
| | Add a Type Code for “Hours Type” to capture duration other than |
| | “Business Hours.” |
| LOCATION COST | Denotes the planned and actual cost history of a LOCATION by COST for |
| | specific time period. |
| LOCATION ITEM PRICE | Indicates all Selling Locations to which this pricing applies. |
| | Multiple Selling Locations can share a pricing scheme for a given item. |
| | Note: If there is only a single Item Price regardless of selling location (or a web |
| | enterprise with only a single location), this entity may be omitted. |
| | Example: |
| | allows the enterprise to have differentiated pricing by selling location. |
| LOCATION TRAFFIC | Captures the amount of traffic at a Location. |
| | Typically used to count foot traffic entering and exiting the Location via a |
| | simple counter installed at the Customer portals (as opposed to staff |
| | entrances). |
| | Note: These are anonymous counts, as opposed to VISITs that are transaction |
| | derived or based. |
| | This entity can be enhanced if different types of traffic need to be counted for |
| | the same time period (e.g. foot vs. vehicle traffic) |
| LOCATION TRAIT | A generic construct to describe characteristics of a LOCATION. |
| | Example: Number of Ticket Counter positions, Number of loading docks. |
| LOCATION TRAIT VALUE | A cross-reference between TRAITs and LOCATIONs, describing the specific |
| | TRAITs that belong to a LOCATION. |
| | For example, this can store all possible TRAITs of a PROPERTY UNIT such |
| | as handicap access, smoking preference, etc |
| LOCATION TYPE | Identifies the type of LOCATION. |
| | Example: Airport Ticket Office, City Ticket Office, Kiosk, etc. |
| | A finer level of differentiation can also be used: For example, located at a Mall, |
| | Stand Alone Center, rental office, etc |
| LOCATION XREF | Details information regarding a location pair. Typically used when moving |
| | goods between two locations. |
| | Note: A location can belong to either the enterprise or a third party. |
| LODGING CHANGE EVENT | Captures information about re-assignments such as guest room, conference |
| | rooms, etc that can happen during the guest stay. |
| LODGING CHECK IN EVENT | The event when a guest checks in at the front desk, kiosk or counter of the |
| | hotel/resort signifying their arrival at the LODGING PROPERTY. Typically, |
| | this is when the guest is issued with a room key and indicates that their stay |
| | has started. |
| LODGING CHECK OUT EVENT | The event when a guest checks out from the PROPERTY UNIT (room) at the |
| | front desk, kiosk (or using express checkout) of the hotel/resort signifying their |
| | departure from the LODGING PROPERTY. Typically, this is when the guest |
| | returns the room key indicating that their stay has ended. |
| LODGING CLASS | Groups Lodging Products together for the purpose of marketing and/or |
| | pricing. (Similar to the concept of Service Class used by Airlines) |
| LODGING EVENT | Subtype of TRIP EVENT consisting of lodging related events such as check |
| | out, lodging check-in |
| LODGING EVENT TYPE | Classifies the LODGING EVENT. |
| | Example: |
| | Change of Room |
| | Check-out |
| | Check-in |
| | etc. |
| LODGING ORGANIZATION | This entity reflects the domain of Lodging and Hotel owners as listed with the |
| | American Hotel and Lodging Association and its international counterparts. |
| LODGING PRODUCT | The entity that represents the domain of available lodging options for a |
| | customer for the purpose of obtaining temporary lodging for a specified period |
| | of time at a predetermined rate. |
| LODGING PROPERTY | A sub-type of LOCATION that offers: |
| | temporary accommodations to customers |
| | business facilities (conferences, workshops, etc.) |
| LODGING PURCHASE ITEM | Represents an ITEM or SERVICE that is purchased for primarily providing a |
| | temporary stay at a LOCATION such as a LODGING PRODUCT. |
| | There will be an entry for every single day that the Lodging Product is |
| | purchased (a 3 night stay in a Hotel room will therefore have 3 entries) |
| LODGING RESERVATION | This entity represents the intention (reservation) made by a customer to make |
| | a visit to a HOTEL for the purpose of obtaining temporary lodging for a |
| | specified period of time at a predetermined rate. |
| LONG TERM DEBT ACCOUNT | The entity that provides details for the long-term debt. Long-term debt is the |
| | liability amount due in a year or more. |
| LOOSE FREIGHT ESTIMATE | An estimate of the weight and volume of Loose Freight for a future Shipment. |
| | This is used to do Capacity Planning. |
| | These numbers may be at a global level, or at a Piece level. |
| LOYALTY ACCOUNT | An account issued by an enterprise to a PARTY to encourage purchase |
| | behavior in the form of DISCOUNTs or the collection of frequent purchaser |
| | points |
| LOYALTY ACCOUNT BALANCE HIST | A history of all transactions associated with a rewards account. It tracks |
| | earnings as well as dispersions (Award Redemption) and maintains current as |
| | well as lifetime balances. This is an example of a physicalized/history |
| | construct that would be needed if all information since inception are not kept. |
| LOYALTY ACCOUNT EARNING | A subtype of transaction associated with an Account Balance transaction that |
| | tracks all reward earnings posted to a Rewards Account. |
| | The quantity of loyalty/reward units earned for a business transaction. |
| | While Airlines, Hotels, Casinos and Retailers have traditionally been the |
| | vanguard of Loyalty Programs, some Distributors are now implementing the |
| | concept of Loyalty Accounts and this Entity could be used in conjunction with |
| | that offering. |
| | Note: It is generally a positive quantity, but can be negative to account for |
| | returned merchandise. |
| LOYALTY ACCOUNT EVENT | This entity represents the activity taking place in a PARTY's Loyalty Account. |
| | Example: Account Earning or Account Redemption. |
| LOYALTY ACCOUNT REDEMPTION | A subtype of transaction associated with an Account Balance transaction that |
| | tracks all Award disbursements from a Rewards Account. |
| | Example: frequent flier purchases an airline ticket using accumulated points; |
| | customer redeems 500 points in exchange for merchandise. |
| LOYALTY CONVERSION | Calculation factor used to determine the unit equivalence of units in one |
| | program with that of another program. |
| | Only needed if the Program Unit Value Amt does not provide an accurate |
| | conversion method. |
| LOYALTY LEVEL | This entity is the domain of Levels achievable within a Rewards Program. |
| | Example Levels can be Bronze, Silver, Gold or |
| | Standard, Premier, Executive Premier, etc. |
| LOYALTY PROGRAM | A defined program for tracking and qualifying reward earnings and granting |
| | award packages. |
| | Example: |
| | Point/Distance based Flying program (earn points or “miles”) |
| | Dining program (earn free meals after number of visits) |
| | High volume Corporate purchase program (loyalty discount) |
| | Note: Structure allows for multiple loyalty programs to exist (it's common in the |
| | travel industry to deal with multiple programs - less so in distribution, retail or |
| | wholesale). |
| LRU (A/C) EVENT | Line Maintenance Event. |
| | Captures maintenance work that is done (installing, removing, repairing parts) |
| | without removing the Equipment from its regularly scheduled service. |
| LRU INSTALL (ILS) | Line Install Event. |
| | Captures the installing of parts without removing the Equipment from its |
| | regularly scheduled service. |
| LRU REMOVE (RLS) | Line Removal Event. |
| | Captures the removal of parts without removing the Equipment from its |
| | regularly scheduled service. |
| | Note: some example of derived Unit statistics have been shown. At |
| | implementation time, add any additional attributes that the customer needs. |
| LRU REPAIR | Line Repair Event. |
| | Captures the repair of parts without removing the Equipment from its regularly |
| | scheduled service. |
| MAILING ADDRESS | A physical location to which letters, packages, marketing brochures, etc., may |
| | be posted. Examples: 100 Hill Street, San Francisco, California, USA; PO Box |
| | 45762, Kansas City, Kansas, USA |
| MAINT COST | Groups and specifies all costs associated with a Maintenance Event. |
| | Note: Internal Labor may not be included in here if it is separately specified in |
| | the Maintenance Labor Entity. |
| MAINT EVENT | Captures all Maintenance, Repair, and Overhaul activities. These activities can |
| | be scheduled or unscheduled. |
| | A Maintenance Event can contain (or be made up of) many other Maintenance |
| | Events), without limit. |
| MAINT ITEM | Details the MRO Items used in a specific Maintenance Event. |
| | The Maintenance Task Id in the Maintenance Event entity will specify what |
| | was done to the Item (removed, inspected, repaired, etc.) |
| | The relative position of the Item is also specified (if appropriate) |
| | Note: It may contain multiple Items per Maintenance Event (provided the same |
| | maintenance task was performed on all). The MRO Items may be generic or |
| | Serialized. |
| MAINT LABOR | The information regarding labor performed by an Associate in carrying out the |
| | specifications of a particular MAINT EVENT. |
| | Note that since it specifies the actual individuals involved, it may only be |
| | available for internal activities. |
| | External labor can be captured in the Maintenance Cost entity. |
| MAINT PLAN DOC(MPD) | The Source of the MRO Specification. |
| | Example: |
| | Manufacturers Repair Guide issued by the Manufacturer |
| | Service Bulletin issued by the FAA |
| | Enterprise Engineering Spec created internally |
| | etc. |
| MAINT SCHED | Contains future/planned Maintenance activities. Specifies the Date, Time, |
| | Location, and Equipment involved. |
| MAINT STATUS | Indicates the Status of a Maintenance Event. |
| | Examples: |
| | Repair Completed |
| | On Hold - Waiting for Specialized Tool |
| | On Hold - Waiting for Parts |
| | Certification upgrade completed |
| | etc. |
| MAINT STATUS HIST | Indicates the Status History of a specific Maintenance Event. |
| | Examples: |
| | Repair Completed |
| | On Hold - Waiting for Specialized Tool |
| | On Hold - Waiting for Parts |
| | Certification upgrade completed |
| | etc. |
| MANIFEST | Specifies the Content (Shipment Pieces) of a specific piece of Equipment for a |
| | specific Scheduled Leg. |
| | Example: |
| | A shipment of 250 HP computer printers on Flight 1024 from San Francisco to |
| | New York. |
| | Note: A tractor hauling two trailers on a given Trip will have two Manifests |
| | specifying the Pieces being transported, one for each trailer. |
| MANUFACTURER | Party that manufactures goods, equipment, etc. |
| | Example: Boeing Aircraft Company, Airbus, GRC Ltd, Mack Trucks, Inc, |
| | Scania, Dell Computer, etc., |
| MARKET GROUP | Externally defined grouping of ORGANIZATIONs for which aggregate sales |
| | information data is available. |
| | Example: Supermarkets, Convenience Stores, Drugstores, Mass |
| | Merchandisers, Warehouse Clubs, etc. |
| MARKET GROUP DEMOGRAPHIC | Provides the relationship of a MARKET GROUP to a specific DEMOGRAPHIC |
| | VALUE. |
| | Any purchased statistical information regarding a Market Group (typically |
| | obtained from the Market Group creator. (Nielsen, etc.) |
| | Example: Mass Merchandiser Market Group accounted for 4% of all new retail |
| | facilities opened last year. |
| MARKET GROUP MEMBER | Cross reference of ORGANIZATIONs that are members of a specific MARKET |
| | GROUP. |
| | Example: Acme and Blotto are members of the Mass Merchandisers Market |
| | Group. |
| MARKET SEGMENT | A grouping of PARTYs for marketing or analysis purposes. A MARKET |
| | SEGMENT can be re-used, can receive multiple offers, serve as a control |
| | group, or be used for customer & product analysis purposes. |
| MARKET SEGMENT DEMOGRAPHIC | The characteristics that qualify a PARTY to be a member of a MARKET |
| | SEGMENT. |
| | Example: ‘Income between $20,000 and $29,999’, |
| | ‘Made more than 5 purchases in the last month’, etc. |
| MARKET SEGMENT GROUP | Allows related MARKET SEGMENTs to be grouped together. |
| | Example: To segment top spenders into 10 decile segments - these 10 |
| | segments can now all be grouped together by relating them to the same |
| | MARKET SEGMENT GROUP: e.g.: “Top Spenders by decile” |
| MARKETING EXPENSE ACCOUNT | The entity that indicates the operating expense pertains to marketing. |
| | Marketing expenses are related the actual marketing of a product (i.e. |
| | advertising). |
| MATERIAL SUPPLY AND EQUIP ACCT | A category of GL SUB ACCOUNT that provides the expense details related to |
| | materials and supplies used by the business. Examples: Indirect parts & |
| | supplies, defective parts, office supplies, service parts consumed. |
| MENU | Collects a group of Menu Items into a Menu that can be offered to order from. |
| | Examples: |
| | Dinner Menu |
| | Lunch Menu |
| | Room Service Menu |
| | Limited Menu (for Banquets and other Group Events, etc.) |
| MENU ITEM | ITEM available as part of a DINING FACILITY's menu. For example, various |
| | types of food & beverages such as Cheeseburger, Soda, etc. |
| MENU ITEM INGREDIENT | A Mapping of the ingredients that are contained in a menu item. |
| | Example: Menu Item ‘Hamburger’ contains Ingredients ‘Bun’, ‘Meat Patty’, |
| | ‘Lettuce.’ |
| MENU TYPE | Defines the type of Menu. |
| | Examples: |
| | Dinner |
| | Lunch |
| | Room Service |
| | Limited (typically used for Banquets) |
| | Dedicated (one-off for a special situation/function) |
| | etc. |
| METROPOLITAN STATISTICAL AREA | Metropolitan Statistical Area (MSA). Predefined geographic areas for |
| | marketing use, center around large metropolitan areas. Commonly used in the |
| | USA. |
| | Note: MSA is but one of many Geographical Classification schemes that can |
| | be used, and is shown only as an example. All classifications used by an |
| | actual client should be added to the model during an actual engagement. |
| | Example: Miami MSA, San Francisco MSA, etc. |
| MISCELLANEOUS EXPENSE ACCT | The entity that provides the details for the GL SUB ACCOUNT expenses not |
| | otherwise categorized. Examples: Foreign currency gain/loss, scrap credit, |
| | etc. |
| MM AUDIO OBJECT | Sound that the enterprise may use (mainly) for marketing purposes. |
| | For example: a radio spot; a .WAV file of a trademark sound (such as the |
| | “You've got mail” of AOL); a telephone message, etc. |
| MM COMPONENT | “Higher level” component object that groups multiple, discrete multimedia |
| | objects. Gives the ability to access multiple objects via reference to a single |
| | object. |
| | Example: |
| | Company Header component object that contains: corporate logo, blue |
| | horizontal lines (2), shaded background, company name, address, e-mail link. |
| | “Men's Spring Short-sleeved Shirt Line” containing 4 pictures of men's shirts, |
| | “Spring” graphic, item numbers with pricing text, green outline box with grey |
| | shading, catalog order telephone number. |
| MM IMAGE OBJECT | Describes a specific image that an enterprise can use for (mainly) marketing |
| | purposes. |
| | Example: A photograph of a poodle wearing a red sweater. |
| MM TEXT OBJECT | A text element that the enterprise may use on Ads, WEB PAGEs, catalogs, |
| | etc. |
| | Example: Product description, customer product review, etc. |
| MM VIDEO OBJECT | A video or moving image that the enterprise may use (mainly) for marketing |
| | purposes. |
| | For example: a film; a MPEG digital video stream; an animated graphic, etc. |
| MODEL ALGORITHM TYPE | Describes the algorithm technique used for the analytical model. |
| | Example: Neural Net, Time Series, Cluster, Regression, etc. |
| MODEL PURPOSE | Describes the purpose of the analytical model. |
| | Example: Churn analysis, Growth analysis, Acquisition analysis, or Defection |
| | analysis. |
| MODEL RUN | Describes an actual execution of an ANALYTICAL MODEL. |
| | Example: Seasonal Item forecast for Q1 that was run on Dec. 12. |
| MODEL STATUS | Designates the statuses that an analytical model may have. |
| | Examples: |
| | Active, Inactive, In Test |
| MODEL TYPE | Designates the type of model. |
| | For example: |
| | Scoring, Segmentation, Forecasting. |
| MRO EQUIPMENT SYSTEM | Higher Order logical groupings for MRO Items - typically by the functionality it |
| | provides to the Equipment. |
| | The recursive nature of the entity refers to the sub systems and components |
| | as the digits in the code progress. |
| | In Airlines, this would refer to the ATA Chapter of the Illustrated Parts Catalog. |
| | Example: |
| | Hydraulics |
| | Landing Gear |
| | Avionics |
| | etc. |
| MRO FORECAST | Used for future estimates, projections & forecasts for given MRO Event(s). |
| | Accommodates multiple simultaneous methods and forecast sources. Can |
| | also house the (derived) “actual” quantity to compare against “forecast”. |
| | This example forecasts the number, cost, and out of service days of MRO |
| | events associated with a particular fleet of similar aircraft. |
| MRO HANGAR | A Facility (Location) used in MRO Operations for major maintenance |
| | operations. |
| | Example: Airline hangar used for C & D Checks. |
| MRO INVENTORY IN | An Inventory Transaction, typically triggered by a Maintenance Event, where |
| | an MRO Item is placed into Inventory at a specific Location, Date and time. |
| | Typically used after an Item has been reconditioned and is placed back into |
| | Inventory. |
| MRO INVENTORY OUT | An Inventory Transaction, typically triggered by a Maintenance Event, where |
| | an MRO Item is removed from Inventory at a specific Location, Date and time. |
| | Typically done when an Item is pulled from Inventory to be used to complete a |
| | repair or service action. |
| MRO ITEM | Items that are used or consumed during Maintenance Repair Operations. |
| | Example: Landing Gear, Hydraulic Pump, etc. |
| | Note: If an MRO Item has multiple, different manufacturing batches or lots, |
| | each batch will have its own MRO Item Id. The Item Equivalence structure is |
| | used to tie all batches or lots back to the same Item. |
| | If there is no need to capture batch or lot information, a single MRO Item Id will |
| | be used. |
| MRO LABOR SPEC | Defines the Labor requirements to perform the specified Maintenance. |
| MRO SER ITEM TIME CYCLE | Captures the Time and/or Cycles elapsed since a prior MRO Time/Cycle Event |
| | (see MRO Time Cycle entity for these events) |
| | Note: The relevant link to the Maintenance Event that started the Time/Cycle |
| | count is also provided. |
| | Note: If the Maintenance information is present and complete, most of this |
| | information should/may be derivable. It is of most use when Equipment is |
| | purchased used - in which case this information should be provided by the |
| | selling party (since it would not be derivable) |
| MRO SHOP | A Facility (Location) used in MRO Operations for Shop work and/or Storage. |
| MRO SPEC (MPD = MII) | Defines the Specifics of a Maintenance, Repair, or Overhaul operation and |
| | details all the steps involved. |
| | Types of MRO Specs could be: |
| | Manufacturers Repair Guide |
| | Service Bulletin |
| | Enterprise Engineering Spec |
| | etc. |
| | A Maintenance spec can contain (or consist of) multiple other Maintenance |
| | Specs, and a MRO Spec can be used in multiple higher level MRO Specs. |
| | NOTE: It could be specified at the following levels: |
| | For a MRO Item |
| | For a MRO Item used in a specific Equipment Series |
| | For a Equipment Series |
| MRO SPEC CONTENT | A Maintenance Spec can contain (or consist of) multiple other Maintenance |
| | Specs, and a MRO Spec can be used in multiple higher level MRO Specs. |
| | Example: The same set of Inspections may be performed for both a C Check |
| | and a D Check. |
| MRO STORES | A Facility (Location) used in MRO Operations for storing Spare Parts and for |
| | storage of MRO related tools. |
| MRO TASK | Defines a Task that is performed as part of a MRO Maintenance Event. |
| | Example: |
| | Inspect, Test, Repair, Remove, etc. |
| MRO TIME CYCLE | Indicates the Cycles or Time measured or referenced. |
| | Example: |
| | Time/Cycles accumulated since last check |
| | Time/Cycles accumulated since last installation of the part |
| | Time/Cycles accumulated since installation as a new part |
| | Time/Cycles accumulated since last overhaul |
| | Time/Cycles accumulated since last repair |
| | Time/Cycles accumulated since last in repair shop visit |
| | Note: If the Maintenance information is present and complete, this information |
| | should/may be derivable. It is of most use when Equipment is purchased used - |
| | in which case this information should be provided by the selling party (since it |
| | would not be derivable) |
| MTBF (MANUF) | Manufacturer's specification of durability for the Item, expressed as the Mean |
| | Time Between Failure for an Item. |
| MULTI ITEM | Identifies an Item which is comprised of other Items. See MULTI ITEM |
| | CONTENT for the “bill of materials” Items which are included. |
| | Typical uses: |
| | 1 - when multiple items are combined for sale together, e.g., “Gift Pack.” |
| | Example: a travel “package” consisting of a round-trip airline flight, 5 days and |
| | nights at a Casino hotel, free breakfast at the hotel cafe, and $50 worth of |
| | Casino chips; Indiana Jones Deluxe Pak contains: I.J. Coloring Book, I.J. |
| | movie, and I.J. Action Figure, etc. |
| | 2 - to describe ‘bulk’ or ‘wholesale’ items (the level at which items are typically |
| | ordered from the supplier). |
| | Example: A carton containing 100 Batman DVDs; a pallet containing 10 of the |
| | previously mentioned cartons, etc. |
| | 3. Other component-level groupings. |
| | MRO Example: an Engine Assembly consisting of 2000+ individually |
| | inventoried Items; an aircraft Landing Gear, etc. |
| MULTI ITEM CONTENT | Identifies the “bill of materials” Items which are included in (or make up) a Multi |
| | Item. |
| | Typical uses: |
| | 1 - when multiple items are combined for sale together, e.g., “Gift Pack.” |
| | Example: a 5-pack of Spa soap bars; a travel “package” consisting of a round- |
| | trip airline flight, 5 days and nights at a Casino hotel, free breakfast at the hotel |
| | cafe, and $50 worth of Casino chips; Indiana Jones Deluxe Pak contains: I.J |
| | Coloring Book, I.J. movie, and I.J. Action Figure, etc. |
| | 2 - to describe ‘bulk’ or ‘wholesale’ items (the level at which items are typically |
| | ordered from the supplier). |
| | Example: A carton containing 100 Batman DVDs; a pallet containing 10 of the |
| | previously mentioned cartons, etc. |
| | 3. Other component-level groupings. |
| | Example: an Engine Assembly consisting of 2000+ individually inventoried |
| | Items; an aircraft Landing Gear Assembly, etc. |
| MULTI ITEM TYPE | Describes the Type of Multi Item |
| | Examples: |
| | Component |
| | Gift Pack |
| | Assembly |
| | Kit |
| | Bulk |
| MULTIMEDIA GROUP | Represents a grouping of multimedia objects. |
| | Examples: |
| | A group of text reviews of Harry Potter books |
| | Images of men's shirts |
| | Web links to kitchen appliances |
| | Software application files |
| | Objects with high click rate on the World Wide Web |
| MULTIMEDIA GROUP OBJECT XREF | A cross-reference of multimedia groups and object combinations. This permits |
| | re-using objects in many groups. |
| MULTIMEDIA OBJECT | MULTIMEDIA OBJECT refers to a multimedia element that can be used to |
| | construct a WEB PAGE, AD, catalog, radio spot, etc. |
| | For example, image, audio, text, video. |
| MULTIMEDIA SOURCE | The original source asset. For example, an 8 × 10 negative taken by a specific |
| | photographer; a text slogan created by an ad agency for an enterprise; original |
| | logo artwork. |
| MULTIMEDIA TYPE | Classification scheme use to categorize multimedia. Useful in tracking objects |
| | or sources at a summary level. May be used as a subtype discriminator. |
| | For example - image, text, video, audio, etc |
| NAICS | The North American Industry Classification System. NAICS was developed |
| | jointly by the U.S., Canada, and Mexico to provide new comparability in |
| | statistics about business activity across North America. |
| NAME TYPE | This minor entity identifies the different types of names that an individual or |
| | organization could have such as ‘doing business as’ (dba), legal name, alias, |
| | phonetics, etc. |
| NAVIGATION LEVEL | Used to construct a hierarchical structure of the web site. |
| | Each level points to the next higher level hierarchical navigation levels the user |
| | can access from this WEB PAGE. NOTE: It is only intended to be used by high |
| | level navigational type pages. This allows the Enterprise to set up a Navigation |
| | Structure that makes it simple for users to “drill down” from general to specific |
| | information/ITEMs. |
| | Example: Department Level, Product Category Level, Product Sub Category |
| | Level, etc. |
| NON EMPLOYEE DIRECT EXPNS ACCT | A category of GL SUB ACCOUNT that provides the details for expenses |
| | related to non employees. Examples: Insurance, postage, fines & penalties, |
| | bank charges, telecommunications, phone, etc. |
| NON PAYROLL TAX ACCT | A category of GL SUB ACCOUNT that provides expense details for the taxes |
| | not related to payroll. Examples: VAT (Value Added Tax), property taxes, real |
| | estate taxes, corporate profit tax, etc. |
| NON REVENUE | A subtype of CERTIFICATE that describes the travel vouchers associated with |
| | ASSOCIATE travel for the airline. This may include company and non- |
| | company business. |
| NON STD MAINT | Contains MRO Specifications that are done on an exception basis. These may |
| | sometimes need to be created specifically by Engineering to address a new |
| | problem. |
| | Note: If it is found that these activities are routinely being done for certain |
| | activities, it may be added as a planned activity to those activities, and be |
| | made a Standard Maintenance Specification. |
| NON TRANSIT STATE | The duration of time that a shipment is at a LOCATION (as opposed to being |
| | transported between two locations). |
| | Example: |
| | Being Crossdocked |
| | In Storage |
| | Customs Clearing |
| | Breakbulk |
| | etc. |
| NONCURRENT LIABILITY ACCOUNT | The entity that indicates the liability account is a non-current liability. Non- |
| | current liabilities that are not due in the next twelve months. Types of non- |
| | current liabilities include deferred income taxes, long-term debt and reserves. |
| NONCURRENT LIABILITY ACCT TYPE | The entity that identifies the type of NONCURRENT LIABILITY ACCOUNTs. |
| | Types of non-current liabilities include deferred income taxes, long-term debt |
| | and reserves. |
| NONDEPRECIABLE ASSET ACCOUNT | The entity that identifies the NONDEPRECIABLE ASSET ACCOUNT. |
| | NONDEPRECIABLE FIXED ASSETs include things like raw land. |
| NONDEPRECIABLE ASSET TYPE | This entity identifies the type of non-depreciable asset like raw land. |
| NONDEPRECIABLE FIXED ASSET | The entity that identifies the FIXED ASSET is non-depreciable. |
| | NONDEPRECIABLE FIXED ASSETs include things like raw land. |
| NONDIVIDEND EQUITY ACCOUNT | The entity that identifies the type of NONDIVIDEND EQUITY ACCOUNT. |
| | Types of NONDIVIDEND EQUITY ACCOUNTs include retained earnings, |
| | treasury stock and foreign currency adjustments. |
| NONDIVIDEND EQUITY ACCT TYPE | The entity that Identifies the type of non-dividend equity accounts. Types of |
| | non-dividend equity accounts include retained earnings, treasury stock and |
| | foreign currency adjustments. |
| NONPROFIT ORGANIZATION | A type of ORGANIZATION without a profit motive. |
| | Example: Red Cross, Church groups, etc. |
| NONVOTING STOCK ACCOUNT | The entity that identifies a common stock dividend equity as a non-voting |
| | stock. Non-voting stock equities of a public corporation do not posses voting |
| | rights. |
| NSCM | The NSCM Code (NATO Supply Code for Manufacturers) is code used to |
| | identify non-U.S. Supply companies. (CAGE is the US Equivalent). |
| | Spec2000: Spec 2000 has adopted the CAGE/NSCM codes as a standardized |
| | way to identify Spec 2000 users. |
| | In Spec 2000, CAGE/NSCM Codes are used to identify Manufacturers, |
| | Suppliers and Repair Agencies. Both CAGE and NSCM codes are assigned |
| | by the Defense Logistics Services Center (DLSC) |
| OnD BOOKING CURVE FORECAST | Used for future estimates, projections & forecasts for a given PRODUCT (or |
| | SEGMENT). Accommodates multiple simultaneous methods and forecast |
| | sources. Can also house the (derived) “actual” quantity to compare against |
| | “forecast”. |
| | This example forecasts the Booking Curve (Reservations per Booking Class at |
| | a given checkpoint prior to departure) |
| OnD PAIR | A pair of locations that serve as Origin and Destination for a Travel or |
| | Transportation event. |
| OnD PRODUCT | A distance based travel PRODUCT that is defined by Origination and |
| | Destination (O&D), weekday of departure and time of departure. |
| OnD PRODUCT TYPE | Identifies the type of OnD PRODUCT |
| OnD SALES FORECAST | Used for future estimates, projections & forecasts for a given Item (or |
| | SEGMENT). Accommodates multiple simultaneous methods and forecast |
| | sources. Can also house the (derived) “actual” quantity to compare against |
| | “forecast”. |
| OnD TIMETABLE | The domain of published O&D schedules for a future time period. These |
| | contain O&D, date and time for each OnD PRODUCT scheduled for operation. |
| | Example: a LA to New York flight schedule may be published for 1 year into |
| | the future |
| OPERATING EXPENSE ACCOUNT | The entity that indicates the expense account is an operating expense. |
| | Operating expenses are those that are required to run a company. |
| OPERATING EXPENSE ACCOUNT TYPE | The entity that indicates the type of OPERATING EXPENSE ACCOUNTs. |
| | Operating expenses include selling, marketing, general and administrative, |
| | research and development, facilities and others. |
| OPERATING SYSTEM | The computer operating system being used by a Web Visitor. |
| | Example: Mac OS X, Linux, Windows 2000, etc. |
| OPERATIONS EQUIP | A Specific piece of equipment used in the Operations of the enterprise. |
| | Example: |
| | Handling Equipment - forklift asset id 32324, etc. |
| | MRO Tool - oscilloscope asset id 4453, etc. |
| | etc. |
| | Note: These are high priced Fixed Assets with individual identification. (The |
| | ITEM entity can be used to capture tools like wrenches, hammers, etc. if |
| | needed) |
| OPS EQUIP USAGE | Information regarding usage of all the specific Tools (Operations Equipment) |
| | during a specific Maintenance Event. |
| | Can be used to determine if Tools are creating a bottleneck in Maintenance |
| | Events. |
| ORGANIZATION | This is a subtype entity to PARTY. An organization is any group of individuals |
| | (or one individual) or other organizations formed for a specific purpose. An |
| | organization can be either an internal organization or an external organization. |
| | This definition does not include groups of individuals that form a segment, nor |
| | does it include households (a grouping of individuals created by the enterprise |
| | for marketing purposes.) |
| ORGANIZATION NAME | This entity keeps track of organization names. |
| ORGANIZATION TYPE | The sub-type discriminator for an organization. This minor entity identifies the |
| | type of organizations such as external organizations or internal organizations. |
| OTHER ASSET ACCOUNT | The entity that indicates the ASSET ACCOUNT is an OTHER ASSET |
| | ACCOUNT. Types of OTHER ASSET ACCOUNTs include investments, |
| | deferred charges or intangible assets. |
| OTHER ASSET ACCOUNT TYPE | The entity that indicates the type of other asset. For example: investments, |
| | deferred charges or intangible asset. |
| OTHER CURRENT ASSET ACCOUNT | The entity that indicates the asset account is an OTHER CURRENT ASSET |
| | ACCOUNT. Types of OTHER CURRENT ASSET ACCOUNTs include |
| | Business Leasehold Improvements, Employee Leasehold Improvements, and |
| | Other Refundable Deposits. |
| OTHER EXPENSE ACCOUNT | The entity that indicates the expense account is for other operating expense. |
| | Other expenses are those that are required to run a company and cannot be |
| | classified as one of the other types of expenses. |
| OTHER INVOICE EXPENSE | This entity is a sub-type of AP INVOICE. It is one of four sub-types. The other |
| | three are AP INVOICE EXPENSE, AP REIMBURSABLE EXPENSE, and AP |
| | RECURRING EXPENSE. |
| | OTHER INVOICE EXPENSE pertains to INVOICEs for costs incurred to |
| | operate the company and billed to the company directly by the VENDOR, that |
| | don't fall into one of the other 3 Invoice Types. An example of such as |
| | manufacturing materials and FIXED ASSETs. Periodic business expenses for |
| | which the company may not receive an INVOICE for each period, such as |
| | rent. |
| OTHER OP EXPENSE ACCOUNT | The entity that indicates the operating expense pertains to other operating |
| | expenses. These expenses are general in nature and cannot be classified as |
| | one of the other types of operating expenses. |
| OTHER REVENUE ACCOUNT | The entity that represents income from activities other than normal business |
| | operations, such as investment interest, foreign exchange gains, rent income, |
| | and profit from the sale of non-inventory assets. |
| OUT OF SVC REASON | Captures the reason why Equipment was removed from service. |
| | Examples: |
| | Gaming Equipment |
| | Coin Jam |
| | Vehicles |
| | mothballed due to high fuel prices |
| | lack of demand |
| | grounded for safety reasons |
| | maintenance |
| OUTBOUND TRANSACTION | A Type of Inventory Adjustment Transaction. |
| | Items transferred out of a Location. |
| | Example: Transferring goods between distribution centers, supplying stores |
| | with goods from warehouse locations or distribution centers, etc. |
| | Note: |
| | When transferring items from location A to location B, there will be 1 ‘transfer |
| | out’ outbound transaction for location A and 1 (or more) ‘transfer in’ inbound |
| | transactions for location B. Each of the location B transactions will be related |
| | to the originating location A transaction. |
| PA DRAFT INVOICE | The purpose of the PA Draft Invoice is to feed billable Project information to |
| | the AR Billing system that generates the final Invoice to be sent to a customer. |
| | The Invoice Dttm in the supertype entity, INVOICE, is the date the final |
| | customer INVOICE, related to the PA Draft Invoice, is created. |
| PA DRAFT INVOICE LINE | PA Draft Invoice Line provides line item billing details for project tasks or |
| | resources. This entity identifies detailed information related to the lines on a |
| | specific PA DRAFT INVOICE. |
| PA DRAFT INVOICE LINE AMOUNT | This associative entity relates the draft invoice line with the amounts for the |
| | line item, such as professional services amount, tax line amount, as defined in |
| | the Invoice Amount Type Cd. The amounts are recorded in transaction, local |
| | accounting and global currencies. |
| PACKAGING ITEM | Items that can be used for packaging, such as boxes, pallets or containers |
| | used for storing, moving and/or shipping ITEMs. |
| | Some containers are reusable and are returned to the Supplier after the |
| | enclosed ITEM has been consumed/removed. |
| | Note: This is different from Container Equipment, since Packaging Items are |
| | not individually identified (no serial numbers), nor are they considered assets |
| | or individually trackable. |
| PACKAGING TYPE | The kind of packaging that contains the PIECE. |
| | Example: |
| | box |
| | barrel |
| | carton |
| | pallet |
| | etc |
| PAGE POSITION | An entity that tracks different positions available on a page |
| | Note: The page could be physical, such as in a print ad or catalog, or virtual, |
| | such as on a web page. |
| | Example: Lower right-hand corner, top middle, middle-left, etc. |
| PAGE TYPE | This entity categorizes a PAGEs according to the type of business related |
| | content it contains |
| | Example: Home page, Category page, Products page, Order page, Help page, |
| | Search page |
| | Note: This is used to describe both virtual (web site) as well as physical |
| | (catalog) pages. |
| PART INSTALL(IPT) | Installation of a Part in a Shop (not Line) environment. |
| PART REMOVE(PAR) | Removal of a Part in a Shop (not Line) environment. |
| PART REPAIR(WPS) | Repair of a Part in a Shop (not Line) environment. |
| PARTNER AWARD | A subtype of Award Certificate that associates a specific Account Redemption |
| | to a PARTNER. |
| PARTNER EARNING | A sub-type of the ACCOUNT EARNINGS that represents the earnings |
| | received from PARTNER PARTYs. |
| PARTNER PRODUCT | Identifies the PRODUCTs offered by a PARTNER PARTY. |
| PARTY | A party is any individual, organization or household that is of interest to the |
| | enterprise. |
| PARTY ADDRESS | This entity relates parties to addresses. A party can have many addresses |
| | and an address can be used by many parties. |
| PARTY AGREEMENT ROLE | Defines the Parties involved in the Agreement and their roles. |
| | Example: |
| | The Party who will be providing the goods or services detailed in the |
| | Agreement. |
| | The Party who will be paying for the goods or services detailed in the |
| | Agreement. |
| | Other Parties: Agreement Negotiator, etc. |
| PARTY CHANNEL | This associative entity identifies the way a Channel is used by a Party. |
| | For example: the channel is used as a ‘sales channel’ by a Party. |
| PARTY DEMOGRAPHIC | Provides the relationship of a PARTY to a specific DEMOGRAPHIC VALUE. |
| | Example: INDIVIDUAL: Rachel has an income of $120,000 |
| | HOUSEHOLD: The Smiths have 5 children. |
| | ORGANIZATION: Acme Gifts has annual sales revenue of $4M. |
| PARTY GROUP | This entity identifies artificial groupings of parties such as a vender group or a |
| | customer group. |
| PARTY GROUP REASON TYPE | The reason this grouping of parties was created such as for vendor group or |
| | customer group. |
| PARTY IDENTIFICATION | The numbers that may be assigned to a party by a legal jurisdiction for |
| | identification purposes, as specified by PARTY IDENTIFICATION TYPE. |
| | Example: |
| | Social Security Number |
| | Passport Identification |
| | Driver's License |
| | Federal Tax Identification Number |
| | National Identity Card Number |
| | Etc. |
| PARTY IDENTIFICATION TYPE | The types of legal jurisdiction identification that may be used by a party. |
| | Example: |
| | For Individuals: |
| | U.S. Social Security Number |
| | U.K. Passport Identification |
| | New Jersey Driver's License |
| | Etc. |
| | For Organizations: |
| | U.S. Tax Identification Number |
| | CAGE Code [U.S. Commercial and Government Entity] |
| | NSCM Code [NATO Supply Code for Manufacturers] |
| PARTY INFO SOURCE TYPE | An indication of how/where the first information about the existence of a Party |
| | was obtained. |
| | Examples: |
| | Purchased Prospect List |
| | Web Site |
| | Customer Care Center |
| | Campaign Reply |
| | etc |
| PARTY LIMIT | This entity contains information about credit limits and any other kind of limits |
| | that the party has such as credit limits for a customer or invoice amount limit |
| | for vendor. |
| PARTY PARTY GROUP | This associative entity identifies those Parties that are part of a Party Group. |
| | A Party can be in many Party Groups, and a Party Group describes many |
| | Parties. |
| PARTY PARTY RELATIONSHIP | This entity defines the relationships between parties - individual and individual; |
| | individual and organization; organization and organization; individual and |
| | household and household and household relationships. A party can be part of |
| | many relationships. A party can have many types of relationships with another |
| | party. |
| | Examples of relationships could be employee-employer, Husband-Wife, |
| | household-member, father-son, supplier to the enterprise, or competitor to the |
| | enterprise. |
| PARTY PRIVACY PREFERENCE | A PARTY's privacy preferences for the collection and use of personal data. |
| | For example: Mary Jones permits direct marketing to a specific address but |
| | not to her any of her telephone numbers and does permit release of certain |
| | types of personal information. |
| | It is expected that only explicit choices made by a party would be referenced in |
| | this entity. Tacit presets or overrides may be referenced in the Privacy Preset |
| | entity. |
| PARTY PROJECT ROLE | The entity that indicates the role of a PARTY associated with a project. |
| | Examples of roles could be Project Manager, Project Sponsor, Project |
| | Consultant, etc. |
| PARTY PROJECT TASK ROLE | The entity that indicates the role of an individual on a PROJECT. |
| PARTY REL STATUS REASON | A reason why a particular Party Status Type Cd may be assigned to a party |
| | relationship. |
| PARTY REL STATUS TYPE | The domain of classifications tracked to the relationship role for a Party. |
| | Examples: |
| | Active |
| | Inactive |
| | Prospective |
| | Unmarketable Customer (i.e. deceased). |
| PARTY RELATIONSHIP ROLE | Indicates the relationship of one party to another party. This role code can |
| | represent both sides of the relationship. |
| | Examples: |
| | Manager-Employee |
| | Employer-Employee |
| | Vendor to the enterprise |
| | Customer Service Provider to the enterprise |
| | Account Executive for the enterprise |
| | Father-Son |
| | household-member |
| PARTY ROLE | Code and description used to identify the role of the PARTY in a Transaction. |
| | Example: Agent, Supplier, Inspector, Approver, Reservationist, Traveler, |
| | Travel Requestor, etc. |
| | Note: The appropriate roles will depend on the Transaction linked to. |
| PARTY SCORE | A relative value, or ‘score’ produced by an ANALYTICAL MODEL after |
| | reviewing business information. This can provide a measure or way to group |
| | and treat PARTYs that the business interacts with. |
| | Example: Customers can be ‘scored’ for profitability, frequency of purchases, |
| | propensity to buy, etc. Vendors and suppliers may similarly be ‘scored’ on |
| | accuracy of orders, delivery time etc. |
| PARTY SEGMENT | An associative entity that maps a PARTY into a MARKET SEGMENT. A |
| | PARTY can be a member of multiple MARKET SEGMENTs, and vice versa. |
| PARTY SHIPMENT ROLE | Intersection of a particular shipment and a party and the role that party plays in |
| | that shipment. The PARTY can be an ORGANIZATION or an INDIVIDUAL. |
| | Note: for every SHIPMENT we must have at least three roles: shipper, |
| | receiver, debtor - these roles are shown in the SHIPMENT entity since they |
| | are mandatory and constant. This entity allows for additional/optional PARTY |
| | involvement. |
| | Examples: |
| | Broker |
| | Purchasing agent |
| | Traffic Manager |
| | Sales Agent |
| | Expediter |
| | etc. |
| PARTY STATUS | An overall classification status for a PARTY. |
| | Example: |
| | inactive |
| | do not do business with |
| | etc. |
| PARTY STATUS HIST | Defines the set the specific statuses a Party has had, and the date the Status |
| | became effective. |
| | Example: |
| | For Acme Co. (Party #274832) |
| | Jan. 5, 1995 - Prospect |
| | Mar. 3, 1995 - Trading Partner |
| | May 8, 2004 - Out of Business |
| | etc. |
| PARTY TRAN ROLE | Indicates the PARTY involved in the TRANSACTION, and their ROLE. |
| | Example: for RESERVATIONS: the “taking reservation” PARTY; for |
| | PURCHASES: the “selling” PARTY, the “ticket issuing” PARTY, etc. |
| | This is the entity to store information about: |
| | 1. Travel Agents and Travel Agencies |
| | 2. Referral |
| | 3. Guests involved in a Booking |
| | 4. Concierge bookings |
| PARTY TYPE | The sub-type discriminator for a party. Valid sub-type occurrences are |
| | INDIVIDUAL, ORGANIZATION and HOUSEHOLD. |
| PASSENGER CONFIG | A Pre-defined configuration of Transportation Equipment with a fixed number |
| | of sellable passenger “spots” per SERVICE CLASS. |
| PASSENGER TRAVEL PROVIDER | This entity reflects the domain of PASSENGER TRAVEL PROVIDERs. |
| | Example: AIRLINE, RAILROAD, CRUISE LINE, etc. |
| PASSENGER TRAVEL TYPE | Identifies the type of PASSENGER TRAVEL PROVIDER |
| PATENTS ACCOUNT | The entity that provides details for patents. These details could include the |
| | legal cost a company paid an individual or a company to obtain a patent. |
| PAYMENT | A tender amount received and applied to one or more business transactions. |
| PAYMENT BANK DRAFT ASSIGN | This entity contains information for BANK DRAFTs used for a PAYMENT. It is |
| | related to PAYMENT by PAYMENT ACCOUNT and BANK DRAFT. |
| PAYMENT METHOD TYPE | This entity describes ways in which PAYMENTs are conveyed to payers. |
| | Receipt method tells how the receipt for an INVOICE will be treated; |
| | processing can be manual or automatic. For example: Lockbox, Check, wire |
| | transfer, etc. |
| PAYMENT PARTY | This entity tracks the various PARTYs and their respective roles who are |
| | involved with a PAYMENT. Examples are PARTYs that request, approve, |
| | hold or release PAYMENTs. |
| PAYMENT PARTY ROLE | This entity defines the various roles PARTYs have in processing a PAYMENT. |
| | For example, a PARTY can request, approve, hold or release a PAYMENT. |
| PAYMENT PRIORITY TYPE | A classification of the priority level that one vendor has in relation to another |
| | vendor for a payment. This is the order in which vendors get paid first. |
| | Examples: first, second, third, etc. |
| PAYMENT PROCESS TYPE | This entity contains PAYMENT PROCESS TYPEs. Options include: Batch, |
| | Manual, Quick, and Refund. |
| | Batch Payments originate in Batches. |
| | Manual Payments were made manually and entered into the system. |
| | Quick Payments were made individually by the system |
| | Refund Payments are negative amount payments used to record supplier |
| | refunds and close supplier credit balances. |
| PAYMENT SCHEDULE | This entity contains the scheduled payment detailed information. PAYMENT |
| | SCHEDULEs are created based on Payment Terms, which define the |
| | expected payment and collection due dates for INVOICEs. The payment and |
| | collection activities, activity status, and various amounts are maintained in this |
| | entity. |
| | PAYMENT SCHEDULE supports Cash Flow forecasting and AR Aging |
| | Reports. |
| PAYMENT SCHEDULE AMOUNT | This entity contains the monetary amount information associated with a |
| | PAYMENT SCHEDULE. There is one instance for each collection amount for |
| | each amount type for each amount date. |
| PAYMENT SCHEDULE AMOUNT TYPE | This entity classifies the types of collection amount. |
| | For example: |
| | Adjusted Amt - The amount adjusted against this collection. |
| | Applied Amt - The amount applied against this collection. |
| | Credited Amt - The amount credited against this collection. |
| | In Dispute Amt - The amount of funds in dispute on this collection. |
| | Discount Earned Taxed Amt - The amount of discount earned and taken |
| | on this collection. |
| | Discount Unearned Taxed Amt - The amount of discount taken that was |
| | unearned on this collection. |
| | Last Promise Amt - The amount that the customer last promised to pay on |
| | this collection. |
| | Originally Due Amt - The amount of funds that this collection was created |
| | to record payment of. |
| | Pending Adjustment Amt - The amount of any pending adjustments on |
| | this collection. |
| | Remaining Due Amt - The amount remaining due on this collection. |
| PAYMENT SCHEDULE PAYMENT | This entity identifies the monetary amount of a full or partial settlement of an |
| | obligation to be applied to a PAYMENT SCHEDULE. The PAYMENT is |
| | reported against the PAYMENT SCHEDULE to compare the actual payment |
| | date to the expected payment date, based on the Payment Terms. |
| | PAYMENT SCHEDULE supports Cash Flow forecasting and AR Aging |
| | Reports. |
| PAYMENT STATUS | This entity is used to store the status of each Payment Id. This relates the |
| | PAYMENT entity to the PAYMENT STATUS TYPE entity. |
| | Examples: Approved, confirmed, remitted, cleared, and reversed. |
| PAYMENT STATUS REASON TYPE | Provides descriptions of the reason codes associated with the status of a |
| | PAYMENT. |
| | Possible values: Account Closed, Credit Card Refund Reversed or Amount |
| | Changed, NSF, Payment Reversal, Resubmit Check, Uncollectible, Wrong |
| | Amount, Wrong Customer, and Wrong Invoice. |
| PAYMENT STATUS TYPE | Contains a list of the PAYMENT statuses. Examples: Approved, confirmed, |
| | remitted, cleared, posted, and reversed. |
| PAYMENT TERM TYPE | Contains the list of all the Payment Terms to be associated with scheduled |
| | payment, customer/vendors and INVOICEs. Examples are Net 10 days, Net |
| | 45 days, Prepayment. Payment terms are used in calculating the payment |
| | schedule. |
| | Payment Terms allow the calculation of the due date and the discount date for |
| | PAYMENT of a transaction. For example, the payment term “2% 10, Net 30” |
| | lets a customer take a two percent discount if PAYMENT is received within 10 |
| | days; after 10 days, the entire balance is due within 30 days of the invoice |
| | date with no applicable discount. |
| PAYMENT TYPE | Describes the form of payment tendered. |
| | Note: |
| | If Payment Type is “Account”, the actual Account will contain further |
| | information (Credit Card, Checking Account, etc.) |
| | If Accounts are NOT captured, then the Payment Type may be used to |
| | indicate the type of payment instead. |
| | Example: Cash, Account, etc. |
| PERPETUAL INVENTORY | Represents an up to date calculated inventory level status for a specific item |
| | within a specific location, for a specific date and time. PERPETUAL |
| | INVENTORY reflects all known inventory adjustments as they happen, |
| | providing a more real-time, up to date and time inventory position |
| | representation. |
| | The values represented by this entity are typically calculated by using the most |
| | recent inventory levels in the Item Inventory entity, and then applying all the |
| | transactions per item per location since that date (the transactions that should |
| | be taken into account are: |
| | all the internal inventory transactions, |
| | all transactions moving items from & to 3rd parties (sales, vendor |
| | receipts, etc.) |
| | Note: This entity would be redundant and may be omitted if the enterprise |
| | prefers to dynamically (‘on the fly’) calculate the inventory levels as described |
| | above instead. |
| PERSONA | The ‘role’ an INDIVIDUAL is playing while interacting with the enterprise. |
| | Typically (but not always) in association with an ORGANIZATION. |
| | Example: Two different PERSONAe of Jill may be: |
| | Jill is ordering ITEMs in her capacity as ‘owner’ of ‘Jill's Dog Grooming |
| | Co.’, or |
| | Jill is calling about a problem with an order in her capacity as ‘buyer’ for |
| | AT&T. |
| PIECE | Discrete identifiable object, many of which may make up the shipment. For |
| | transport carriers, the outer package is considered to be a Piece. |
| | Can be thought of as the “handling unit” or the discrete countable objects that |
| | make up a shipment. |
| | Typically, the level at which trace and track scanning is done - in this case, the |
| | PK may be the “Tracking Number”, provided it satisfies all the PK constraints |
| | of uniqueness and non-re-use. |
| | Examples: |
| | a box - may contain multiple items |
| | a shrink wrapped pallet - may contain multiple boxes |
| | a ULD - may contain multiple items or boxes |
| | NOTE: If Pieces within Pieces need to be tracked, a simply recursive |
| | relationship of Piece to itself should be added. |
| PIECE CONTENT | A cross-reference showing which Shipment Line Items are contained in which |
| | pieces. |
| | NOTE: For TL and LTL you will typically not have more than 1 SHIPMENT |
| | LINE per PIECE (because each PIECE is priced by a single CLASS RATING. |
| | However, other Transportation Industries may use this entity. |
| PIT-BANK | Defines a specific area in a Casino, typically called a Bank (for Slots) or Pit (for |
| | Table Games). |
| PLAN | A Specification set for desired or expected future events. |
| PLAN SERVICE CLASS | Specifies the Service Classes covered by the Plan. |
| PLAYER ALERT HIST | Captures Alerts that have been assigned to Players, as well as the time |
| | period(s) that they apply to. |
| | Multiple alerts can be in effect at the same point in time for the same player. |
| | Examples: |
| | Redemptions Frozen (due to bad markers/returned checks) |
| | Current Open Bad Check(s) |
| | Casino Excluded (prohibited from Casino play) |
| | State Excluded (prohibited from play in the entire state) |
| | Disassociated (prohibited from Casino play by personal request) |
| | Hotel Banned (may still play in Casino) |
| | Note: There is also a higher level alert at the Individual level that may be used |
| | for non gaming alerts. |
| PLAYER STATUS | Tracks the CASINO PLAYER development (maturity) status. |
| | Example: |
| | Developing |
| | Maintenance. |
| PNR | Passenger Name Record. An identifier for a reservation. It is unique only for |
| | an unspecified period of time. At some point after the itinerary is either |
| | completed or cancelled (closed). The identifier may be reused for another |
| | reservation. |
| | Also known as PNR Locator or Record Locator.. |
| PNR BOOKING | Portion of PNR that contains the source booking information. |
| PNR FARE | Portion of PNR that contains the source fare information. |
| PNR MISCELLANEOUS | Portion of PNR that contains additional information, such as Purge Dates. |
| PNR PAYMENT | Portion of PNR that contains the source payment information. |
| PNR REMARK | Portion of PNR that contains the source remarks information. |
| PO ACCRUE TYPE | The accrual treatment of a VENDOR PO. Examples: do not accrue, accrue on |
| | receipt. |
| PO DELIVERY RELEASE | This entity identifies the enterprise-supplied request for immediate scheduling |
| | of a delivery against a VENDOR PO LINE. The PO DELIVERY RELEASE |
| | can, for example, allow a blanket purchase order to be delivered in pieces over |
| | time and to specify the delivery schedule just-in-time. |
| PO DELIVERY RELEASE LINE ITEM | This entity defines the authorization by enterprise of a particular delivery of a |
| | release quantity that was requested, based on a particular PO LINE |
| | DELIVERY RELEASE LINE |
| PO DELIVERY RELEASE STATUS | The entity tracks the various status or condition changes of a PO DELIVERY |
| | RELEASE LINE ITEM over time. |
| PO LINE DELIVERY RELEASE LINE | This entity associates the VENDOR PO LINE to the PO DELIVERY RELEASE |
| | LINE ITEM. It identifies the quantity of the VENDOR PO LINE that has been |
| | authorized for release. |
| PO LINE RETURN XREF | Cross References Items returned to the Vendor to the originating Purchase |
| | Order(s). |
| | Note: This can be related to the Vendor Receipt Line entity instead, depending |
| | on the requirement. |
| PO RELEASE STATUS REASON TYPE | Lists the possible reasons for a PO DELIVERY RELEASE STATUS. |
| PO RELEASE STATUS TYPE | Lists the possible Status Types for a PO DELIVERY RELEASE LINE ITEM. |
| | Examples are Incomplete, In Process, Approved, Pre-Approved, Rejected, |
| | Returned, Requires Reapproval, On Hold, Frozen, Open, Closed, Finally |
| | Closed, Cancelled. |
| PO REQUISITION | This entity associates PURCHASE REQUISITIONS to the resulting VENDOR |
| | PO. Requisitions can be consolidated into single VENDOR POs or split into |
| | multiple VENDOR POs. |
| PO TERM | This entity represents a group of term conditions that can be applied together. |
| | For example, an INVOICE could be associated with a PO TERM that states |
| | that the INVOICE can be discounted by 2% if paid within 20 days. |
| PO TERM TYPE | This entity identifies a grouping or classification of PO TERMs such as all |
| | payment terms, penalty terms, discount terms, etc. |
| POKER SESSION | A period of time spent by a CASINO PLAYER at playing a card game |
| | competing with other players |
| POLLED GAMING PERIOD | Gaming activity that is collected for a specific Game Station Instance for a |
| | specific duration of time. This is typically done by machine, as opposed to a |
| | human observer (like a pit boss). |
| POLLED GAMING ROUND | Captures the outcome of individual rounds/hands played. |
| | Note: For Games where information is kept at the detail Round/Hand/Spin |
| | level, many of the attributes at the higher Session/Polled Times Period level |
| | will become derivable and may be omitted. |
| POS REGISTER | A physical device used at a LOCATION to capture or create a business |
| | transaction - typically a Terminal or Point of Sale (POS) device used to enter |
| | the transaction. |
| | This address will allow the enterprise to identify who entered the transaction. |
| | This is important for fraud detection and productivity tracking. |
| POS REGISTER DINING EVENT | A Subtype of POS Register Event that captures Dining specific events. |
| | Allows the Dining establishment to track the POS Entries, as well as the |
| | Associates that entered them. |
| POS REGISTER EVENT | A type of transaction that records changes in the status of a sale terminal, |
| | terminal access by Associates and their supervisors, and other activities and |
| | events related to sales, administration and management of the point of sale |
| | system. POS REGISTER EVENTs do not generate journal entries. They may |
| | generate control totals from terminal maintained accumulators for audit |
| | purposes. |
| | Example: Terminal Sign-on; Sale; No Sale; Price Keyed; Till Settlement, etc. |
| POS REGISTER EVENT TYPE | Classifies POS REGISTER EVENTs (sub types). |
| | Example: |
| | Associate signon |
| | signoff |
| | till settlement |
| | period close |
| | sale |
| | no sale |
| | etc. |
| POSITION | Captures a Specific Position within a Pit or Bank where a Game Station can be |
| | located. |
| POSITION GRADE | Indicates the level of the position. Used to qualify the JOB CLASSIFICATION. |
| | Usually experience or pay level based. |
| | Example: |
| | Trainee |
| | Senior |
| | Grade 4 |
| | etc. |
| POSITION TYPE | Denotes the type of position filled by the ASSOCIATE. |
| | Example: |
| | permanent full-time |
| | permanent part-time |
| | temporary full-time |
| | temporary part-time |
| | etc. |
| POSTAL CODE | A grouping of MAILING ADDRESSes assigned by the Post Office. Frequently |
| | used in marketing analysis and planning. |
| | Example: |
| | USA (ZIP): 90210-3242 |
| | Canada: G1s 1C1 |
| | U.K.: W1P 7HE |
| POWER EQUIP | Power generating Equipment. |
| | Example: |
| | GE Turbine Engine ID 44343 |
| | Aux Power Unit (APU) ID 2009 |
| PREFERENCE | The specific preferences used to identify personal customer preferences. |
| | Example: |
| | seat type preference |
| | smoking preference |
| | bed size preference |
| | language preference |
| PREFERENCE GROUP | High level groups used to collect customer travel preference information. |
| | Example: Flight, Food, Lodging preferences. |
| PREFERENCE VALUE | Details all the possible values for each specific customer preference that make |
| | up the CUSTOMER PREFERENCE entity. |
| | Example: For PREFERENCE “smoking”, then the possible values could be: |
| | yes, no |
| | For PREFERENCE “bed size”, possible values could be king, queen, double, |
| | etc. |
| PREFERRED STOCK ACCOUNT | The entity that identifies dividend equity as preferred stock. Preferred stock |
| | has preference over common stock in the payment of dividends and the |
| | liquidation of assets. |
| PREPAID EXPENSE ACCOUNT | The entity that provides details for the PREPAID EXPENSE ACCOUNTs. |
| | Prepaid expenses are those expenses that have been paid in advance like |
| | insurance. PREPAID EXPENSE ACCOUNTs are types of current assets. |
| PRICE CHANGE REASON | A reason that a price change was made. Examples include markdown or |
| | markup, discount, etc. |
| PRINT AD | An ad in traditional print media, such as newspapers or magazines. |
| | Additional sub-types of ADs can be created as needed - for instance: |
| | BILLBOARD AD, RADIO AD, etc. |
| PRIVACY CATEGORY | The domain of values, at a high level, for the categories of privacy data that |
| | may be related to a PARTY. |
| | Example Categories (from the P3P specification) are: |
| | Physical Contact - telephone number; address |
| | Online Contact - e-mail; web site URL |
| | Unique Identifiers - for consistently identifying or recognizing the |
| | individual |
| | Purchase Information - products; method of payment |
| | Financial Information - account status; activity; balance; payment, etc. |
| | Computer Information - IP number; domain; browser type; operating |
| | system |
| | Navigation and Click-stream data - passively generated by browsing the |
| | web site |
| | Interactive data - actively generated, e.g., search parameters; logs of |
| | account activity |
| | Demographic and Socioeconomic data - gender; age; income, etc. |
| | Content - text of email; chat room communications, etc. |
| | State management mechanisms - maintenance of stateful session; HTTP |
| | cookies, etc |
| | Political information - membership or affiliation with groups |
| | Health information - individual's physical or mental health; |
| | sexual orientation; inquiry into or purchase of health care services or |
| | products |
| | Preference data - individual's likes and dislikes, e.g., favorite color or |
| | musical tastes |
| | Location Data - individual's current physical location; GPS positional data, |
| | etc. |
| | Government-issued identifiers - issued by a government for purposes of |
| | consistently identifying the individual |
| | Other - other types of data |
| PRIVACY DATA | The domain of text describing specific information that the Customer can |
| | implicitly or explicitly protect or not. This does not represent the actual values |
| | (“Home Telephone” not “1-345-678-9876”). Actual data values would be |
| | stored in other subject areas within the model. Gender, for example, would be |
| | referenced in the Individual entity in the Party subject area. A short list of |
| | examples: |
| | Family/given name |
| | Home address |
| | Employer name |
| | Billing address |
| | Contact address |
| | Home phone number |
| | Business phone number |
| | Mobile phone number |
| | Race |
| | Gender |
| | Social Security Number |
| | Medical record |
| | Marital status |
| | Age |
| | Life insurance beneficiary |
| PRIVACY DATA TRANSFER | The recipient and date of transfer of the privacy data. This information may be |
| | required by certain organizations for purposes of tracking who receives |
| | information that is protected by privacy regulations. |
| PRIVACY DATA USAGE | The domain of values for usage of personal information. |
| | Examples: |
| | Direct Marketing, |
| | Third-Party Disclosure, |
| | Affiliate Disclosure, |
| | Government Related |
| | For example: affiliate disclosure may be permitted for certain classes of data; |
| | certain customers may permit direct marketing or third-party disclosure. |
| PRIVACY POLICY SCOPE | The scope reflected in Privacy Preset. This domain permits grouping preset |
| | privacy preferences under the aegis of various organizations or categories as |
| | needed. |
| | Examples: |
| | Individuals under 13 years of age, |
| | Individuals over 21 years of age (adults), |
| | Territorial or country privacy mandates, |
| | Enterprise default policies for release of data, |
| | Health care privacy regulations, |
| | etc. |
| PRIVACY PRESET | Enterprise or organization privacy policy presets. These preset, or default, |
| | values may be used in lieu of explicit consumer preferences. |
| | This entity may, for example, reflect Enterprise default privacy policies; the |
| | mandated privacy requirements of governments or healthcare organizations, |
| | e.g., HIPAA (as identified by the Privacy Preset Party Id), etc. |
| | Note the Privacy Preset Party Id in this entity represents the establishing or |
| | authorizing party or organization and not the party to whom the preset may |
| | apply. |
| PRODUCT CONFORMANCE ACCT | Product conformance software, product guarantee expense. |
| PRODUCT PROVIDER | The ORGANIZATION PARTY that supplies various types of travel, |
| | transportation, hospitality and gaming PRODUCTs. |
| PRODUCT PROVIDER TYPE | A type of PRODUCT PROVIDER that describes the kind of travel, |
| | transportation, hospitality or gaming product being provided. |
| | Example: PASSENGER TRAVEL PROVIDER, CAR RENTAL |
| | ORGANIZATION, LODGING ORGANIZATION, CASINO. |
| PROGRESSIVE GAME | Defines a type of Game where a small percentage of the Buy-in goes towards |
| | a larger payoff. Typically many Game stations are pooled to increase the size |
| | of a common/shared progression jackpot. |
| | Example: |
| | MegaBucks |
| | Wheel of Fortune |
| PROGRESSIVE TYPE | Defines the type of Progressive Game. |
| | This progression may apply to: |
| | a bank of machines within a Casino |
| | multiple banks of machines across multiple Casinos owned by the same |
| | company |
| | multiple banks of machines across multiple casinos owned by multiple |
| | companies |
| | Also known as: |
| | Stand Alone |
| | Local Area Network |
| | Wide Area Network |
| PROJECT | The entity that provides details of a set of activities undertaken to achieve a |
| | desired outcome. |
| | A company may establish a PROJECT for any business activity it wants to |
| | track and report. Examples of typical PROJECTs are new product R&D, |
| | building construction, IT hardware deployments, reorganization and |
| | restructure. |
| PROJECT BILLABLE TYPE | PROJECT BILLABLE TYPE Indicates the billable type for a PROJECT |
| | example: |
| | fully billable |
| | non billable |
| | partially billable |
| | time and material |
| | fixed price |
| | fixed price plus. |
| PROJECT CLASSIFICATION TYPE | PROJECT CLASSIFICATION TYPE Indicates whether the PROJECT involves |
| | parties outside the company. Internal projects are within the company only. |
| | PROJECTs that involve customers or PARTYs outside the company are |
| | designated as External. |
| | Joint PROJECTs involve PARTYs from both inside and outside the company. |
| PROJECT FINANCIAL PLAN | This entity relates a PROJECT budget to a FINANCIAL PLAN. PROJECT |
| | budgets for TASKs, resources, revenue if billable, etc. to track the financial |
| | performance of the PROJECT. |
| PROJECT PARTY | This entity identifies the relationship that a PARTY has to a PROJECT and |
| | identifies the role filled by that PARTY. Example: project manager, team |
| | member, etc. |
| PROJECT RESOURCE FIXED ASSET | This entity lists FIXED ASSETs assigned to a PROJECT TASK. |
| PROJECT STATUS | This entity indicates the status of a PROJECT. |
| | Example: |
| | disputed invoice |
| | in process |
| | completed |
| | hold |
| | accepted. |
| PROJECT STATUS ASSIGN | The entity tracks the various status or condition changes of a project over time. |
| PROJECT TASK | This entity provides information about a TASK or activity that is scheduled as |
| | part of a PROJECT work plan. |
| PROJECT TASK CHART OF ACCOUNT | This entity associates PROJECT TASKs and Resources to a Chart of Account |
| | number to enable revenue and expense reporting for the PROJECT. |
| PROJECT TASK FINANCIAL PLAN | This entity tracks the budget information associated with a PROJECT TASK. |
| PROJECT TASK RELATED | Lists TASKs that are related, the type of relationship, and the start and end |
| | dates for the relationship. An example of a relationship is when the start of |
| | one TASK is dependent on the end of another TASK. |
| PROJECT TASK RELATED TYPE | This entity lists the possible types of relationships between TASKs. For |
| | example, a TASK can be Dependent on another TASK or a TASK can be |
| | Replaced by another TASK. |
| PROJECT TASK RESOURCE ASSIGN | This entity track PROJECT TASK RESOURCEs assigned to a PROJECT. |
| | Resources can be any item or individual assigned to a scheduled TASK in the |
| | project plan. |
| PROJECT TASK RESOURCE INDIVDL | PROJECT TASK RESOURCE INDIVDL are human resources assigned to a |
| | PROJECT. Individuals include employee associates and 3rd party |
| | consultants. The cost and billable rates associated with these Individuals will |
| | be used in the FINANCL PLAN PROJ TASK RESOURC. |
| PROJECT TASK RESOURCE ITEM | PROJECT TASK RESOURCE ITEMs are fixed asset, product, or supply |
| | resources assigned to a PROJECT. The cost and billable rates associated |
| | with these Items will be used in the FINANCL PLAN PROJ TASK RESOURC. |
| PROJECT TASK RESOURCE ITM TYPE | This entity categorizes the Item assigned to a PROJECT TASK RESOURCE |
| | ITEM. Examples are FIXED ASSETs, Product, or Supplies. |
| PROJECT TASK RESOURCE PARTY | This entity identifies the relationship that an individual has to a PROJECT and |
| | identified the role filled by that the individual. Example: project manager, team |
| | member, etc. |
| PROJECT TASK RESOURCE PROD | This entity lists products related to a PROJECT TASK. |
| PROJECT TASK RESOURCE SUPPLS | This entity lists supplies assigned as a resource and to be consumed as part |
| | of a PROJECT TASK. |
| PROJECT TASK RESOURCE TYPE | PROJECT TASK RESOURCE TYPE classifies a Resource assigned to a |
| | PROJECT TASK as either an Item or an Individual. Examples of Items are |
| | computers or machines; Individuals can be Associates or other Party. |
| PROJECT TASK STATUS ASSIGN | This entity tracks the status or condition of a PROJECT TASK. |
| | Examples of PROJECT TASK STATUS ASSIGN: |
| | disputed invoice |
| | in process |
| | completed |
| | hold |
| | accepted. |
| PROJECT TYPE | PROJECT TYPE further identifies the nature of the PROJECT and groups |
| | related PROJECTs together. Examples of PROJECT TYPEs are IT, |
| | Infrastructure, and Product Development. |
| PROMO EXPENSE | Identifies the type of expenses used in a campaign and/or promotion. |
| | Example: Printing, TV spot, consulting, etc |
| PROMO EXPENSE XREF | Tracks the budgeted and actual expenses for a promotion |
| PROMO OFFER | A specific incentive made available to customers. Usually contains 2 parts: a.) |
| | condition(s) to be met, and b.) the reward for a.) |
| | It is usually a narrowly defined marketing effort designed for a specific |
| | purpose. Can be part of a larger campaign. It has a specific start and end date. |
| | A promotion can contain multiple promo offers and ads. |
| | Example: |
| | Buy a DELL Desk top Computer, and get a free Epson 760 printer; |
| | Stay for 3 nights at a casino hotel and receive gaming tokens. |
| | Note: Different Promo Offer instances can be generated based on |
| | Communication Method used. |
| PROMO OFFER TYPE | The type of Promo Offer such as direct mail or email offer. |
| PROMO SEGMENT | A mapping of a group of market segments to a specific promo offer. A promo |
| | offer can be made to more than one market segment. Example: All customers |
| | whose purchase went down over 50% over the last 6 months are offered $20 |
| | off their next order. |
| PROMOTION | A narrowly defined marketing effort designed for a specific purpose and can be |
| | part of a larger campaign. It usually has a specific start and end date. A |
| | promotion can contain multiple offers and ads. Example: A promotion is |
| | created to drive DVD sales. It consists of 2 offers (one for free shipping, and |
| | one for 10% off orders over $100) and 2 ads: a TV ad and a banner ad placed |
| | on selected websites. |
| PROPERTY UNIT | A distinct and finite amount of space that can be rented out to PARTYs such |
| | as Guest Rooms, Conference Rooms, Lawns, etc. |
| PROPERTY UNIT TYPE | Identifies the property unit categories such as ballroom hall, conference room, |
| | king room, king suite, double room, etc. |
| PROPERTY WING | A section within a LODGING PROPERTY that consists of a distinct number of |
| | PROPERTY UNITs |
| PUBLISHED UNIT RATE | Provides the published property unit rates. This is a flexible way of modeling |
| | room rates and can be used to track the rates by season, weekend vs. |
| | weekday, etc. |
| PURCHASE | A sub-type of the TRAVEL TRANSACTION entity that represents a variety of |
| | Item(s) or Service(s) bought and paid for by the PARTY. |
| | Example: Airline tickets, Car rental purchase, Cruise ship tickets, Hotel/Resort |
| | room stay, Souvenir mugs, Beverage, Cheese Sandwich, Golf cart rental, etc. |
| PURCHASE INVOICE | A request for payment presented by (typically) a Supplier or Vendor to the |
| | Enterprise, typically for services rendered or goods provided to the Enterprise. |
| PURCHASE INVOICE LINE | Invoice Lines related to Purchases. |
| | (Invoice issued to the enterprise by a Supplier/Vendor.) |
| PURCHASE REQUISITION | This entity identifies a summary of requirements for item(s) to be purchased. |
| | Typically several PURCHASE REQUISITIONs are grouped together on a |
| | VENDOR PO to ensure cost effective procurement. |
| PURCHASE REQUISITION LINE | This entity identifies the lines of the PURCHASE REQUISITION. It identifies |
| | the ITEM to be purchased, its quantity and status over time. |
| PURCHASE REQUISITION LN ASSIGN | This entity identifies the VENDOR PO LINEs that should be fulfilling one or |
| | more PURCHASE REQUISITION LINEs |
| PURCHASE REQUISITION STATUS | The entity tracks the various status or condition changes of a PURCHASE |
| | REQUISITION over time. |
| PURCHASE REQUISTION LN STATUS | The entity tracks the various status or condition changes of a PURCHASE |
| | REQUISITION LINE over time. |
| PURCHASE TYPE | Classifies the PURCHASE into TRAVEL PURCHASE, RETAIL PURCHASE, |
| | etc. |
| QUALITY GROUP SURVEY | Defines an activity that was conducted to solicit feedback from a group of |
| | customers regarding the products and services of the enterprise. Often done |
| | with a specifically targeted market segment. |
| | Example: |
| | A Market Research Group is hired to obtain feedback from customers. This |
| | can be done via polling (by phone), in-person focus groups, etc. The results |
| | reported could be structured (conforming to a survey format) or free-form |
| | (unstructured). |
| QUALITY OF SERVICE INDEX | A Civil Aeronautics Board-era basis for determining the amount and quality |
| | (presumably from the public's perspective) of airline service in a market. For |
| | each carrier in the market, take the product of the factors for each flight by that |
| | carrier, add across all flights, compare to the sum of all carriers in the market |
| | and the fraction is then the carriers “QSI share” of the market, in terms of |
| | passengers or revenue. |
| | The Basics. |
| | QSI = (frequency, service type, aircraft type, network presence, frequent flyer |
| | program dominance) |
| | Frequency = number of flights per day (for each carrier individually) |
| | Service Type factor = 1.0 nonstop (for each flight), 0.7 one-stop, 0.6 single |
| | connection, 0.55 two-stop, 0.5 double connection. |
| | Aircraft type factor = 1.0, widebody jet (for each flight), 0.85, narrowbody |
| | jet, 0.8 regional jet, 0.7 large turboprop, 0.6 small turboprop. |
| | Network presence factor = typically, a sliding scale of 1.5 to 0.5 depending on |
| | the number of markets served by the carrier compared to the average carrier's |
| | presence at the outbound station (United would be big at SFO, American |
| | would be big at Dallas, etc.) Single value for each carrier/station. |
| | Frequent flyer factor = sliding scale as above, based on the number of “top |
| | tier” frequent flyers for each carrier at the outbound station. Single value for |
| | each carrier/station. |
| QUALITY RESOLUTION | Defines a Global Quality related action taken to resolve or address feedback |
| | received. |
| | Note: This is a global action, as opposed to the Feedback Response entity that |
| | captures the response to an individual Party's feedback instead. |
| | Examples: |
| | Improve Associate Training |
| | Improve Item Quality Inspections |
| | etc. |
| QUALITY SURVEY | A Specific pre-defined formal, controlled, or structured set of questions where |
| | specific responses are solicited, and responses (typically) are constrained to |
| | selecting one of several choices presented. |
| QUALITY SURVEY QUESTION | Details the specific questions contained in the Quality Survey. |
| QUERY STRING FIELD NAME | The domain of parameter names that may appear in the Query String of the |
| | URL for a Web Page. |
| | Examples: |
| | First name |
| | Site |
| | Location. |
| | Source-> Web Log |
| QUERY STRING FIELD VALUE | The domain of parameter values that may appear in the Query String of the |
| | URL for a Web Page. |
| | Example: for Location the names of retail stores - WestSide Grocery, Mountain |
| | Ridge suppliers, etc. |
| QUERY STRING NAME VALUE | Stores the relationship between Page Views, Query String Field Names and |
| | Query String Field Values. It holds the set of name-value pairs from the query |
| | string of the URL that is associated with this Page View. The query string is |
| | the component of the URL that follows the document path. It begins with a |
| | question mark and consists of any number of sets of name-value pairs |
| | (?param1 = value1&param2 = value2...paramn = valuen). The name-value pairs |
| | often include things such as search parameters. This entity can be used to |
| | store both the parameters for the current URL as well as the referring URL, |
| | Query String Current URL Ind is used to distinguish between the two URLs. |
| | Source-> Web Log |
| QUOTED CHARGE | Shows the various PRODUCT or fare component amounts that make up a |
| | quote that was given during a RESERVATION along with the PARTY |
| | responsible for the charge. |
| | Examples: |
| | Golf - Green Fees, Equipment Rental, etc |
| | Spa - Massage, Facials, etc |
| | Airline - Transfer fees, Excess Baggage fees, Airfare, Security Tax, etc |
| | Hotel - Room rate, Adjustments, Discounts, Tax, Rebates, etc |
| R AND D EXPENSE ACCOUNT | The entity that indicates the operating expense pertains to research and |
| | development. Research and development expenses are related to research |
| | and development of products or services for a company. |
| RAIL | This entity defines rail equipment used to transport passengers and/or goods. |
| RAIL PRODUCT | All of the published O&D destinations provided for sale by a particular |
| | RAILROAD. |
| RAIL STATION | The domain of locations where Rail Transportation occurs, i.e., where trains |
| | depart and arrive and passengers board or get off trains. |
| RAILROAD | This entity reflects the domain of Rail Transportation Providers as listed with |
| | the International Rail Association of Public Transport. |
| RAILROAD RESERVATION | This entity represents the intention (reservation) made by a passenger to |
| | purchase a railroad ticket for the purpose of boarding a passenger train |
| | between City Markets. |
| RAILROAD TICKET | This entity represents the Ticket issued to a passenger for the purpose of |
| | boarding a passenger train between City Markets. |
| RATE STRUCTURE | A Rate “Table” that defines a specific price for every product or service offered |
| | IN COMBINATION with a set of pricing conditions. |
| | This presents a unified “price list” that can be available to a Customer |
| | (or group of Customers) via an Agreement. |
| | Pricing conditions could be volume breaks, location dependencies, etc. |
| | One Rate Structure can be designated as a “base” rate structure (default |
| | Pricing). |
| RATED GAMING ROUND | Captures the outcome of individual rounds/hands played. |
| | Note: For Games where information is kept at the detail Round/Hand/Spin |
| | level, many of the attributes at the higher Session level will become derivable |
| | and may be omitted. |
| RATED GAMING SESSION | A Period of time spent at a Casino Game Station by a known CASINO |
| | PLAYER. |
| RAW LAND | The entity that provides details for the raw land accounts. Raw land is a type |
| | of a non-depreciable asset. |
| REASON | This entity indicates the reason why two (or more) TRAVEL TRANSACTIONs |
| | are related. |
| | Examples: a reservation gets cancelled and replaced by a different |
| | reservation, a browsing transaction results in a reservation and or an issued |
| | ticket, etc. |
| RECEIPT | This entity identifies an acknowledgment that a specified article or shipment of |
| | merchandise has been received. The RECEIPT can have 1 or more RECEIPT |
| | LINEs. |
| RECEIPT EXCEPTION | Captures all exceptions noted between the expected/anticipated Vendor |
| | Receipt and the actual delivery. |
| | It can affect the entire receipt, or only specific items in a receipt. |
| | Example (at Receipt level) |
| | Entire order was delivered late |
| | Delivered to wrong site |
| | Delivered contrary to agreement (e.g. Left outside as opposed to upstairs |
| | location specified in agreement) |
| | Example (at Receipt Line level) |
| | Item has cosmetic blemish |
| | Item damaged |
| | Item spoiled |
| RECEIPT LINE | This entity identifies a single line on a RECEIPT which shows the received |
| | ITEM, quantity, unit of measure for the quantity, etc. |
| RECEIPT LINE DOCUMENT | Document that records details of items delivered from VENDORs and |
| | suppliers, for matching to items ordered on a VENDOR PO. |
| RECEIPT LINE INSPECTION | Records the status and results of a quality inspection performed on a |
| | RECEIPT LINE. |
| RECEIPT LINE QUALITY | Defines the possible levels of quality that can be assessed to a RECEIPT |
| | LINE during inspection. For example Good, Pass, Fail. |
| RECEIPT LINE STATUS | This entity contains RECEIPT LINE STATUS values: Complete, Partial, |
| | Awaiting Inspection, etc. |
| RECEIPT LINE STATUS ASSIGN | The entity tracks the various status or condition changes of a RECEIPT LINE |
| | over time. |
| RECEIPT STATUS ASSIGN | The entity tracks the various status or condition changes of a Receipt over |
| | time. |
| RECEIPT STATUS TYPE | Lists the possible Status Types for a Receipt. |
| RECEIPT TERM | This entity identifies the PO TERMs and/or conditions that are associated with |
| | a RECEIPT. |
| RECEIPTS PLAN | A detailed plan of how items will be received into inventory at each |
| | LOCATION. |
| RECEIVE EVENT | The Handover event is the moment in time goods to be transported are |
| | accepted by the CARRIER from the Shipper Party, Agent, or other Carrier. |
| RECEIVED QUANTITY | This entity identifies the actual quantity of ITEMs received from a planned |
| | shipment. Differences in the ITEMs quantity in the planned shipment and the |
| | RECEIVED QUANTITY would identify shrinkage, damage during transit, |
| | pilferage, etc. |
| RECEIVED QUANTITY TYPE | container, primary unit of measure, received unit of measure. |
| RECOMMENDATION | Contains a record for each recommendation that was made by the |
| | recommendation engine. (This table is present to support integration with |
| | recommendation engines and does not imply that internal functions will serve |
| | as a recommendation engine). The information contained in this entity is |
| | derivable and is provided to support various 3rd party E-Commerce |
| | applications. |
| | Example: Recommendation for Men's red flannel shirt; Recommendation for |
| | beach sandals, etc. |
| | Source-> Recommendation DB. |
| REFERRAL | Referral is used to capture information about a customer's previous browsing |
| | history - prior to making a WEB VISIT. As part of customer's previous history, |
| | only the immediate previous Uniform Resource Locator (URL) information is |
| | preserved. |
| | For example if a customer browsed aol->yahoo->clothing>women's clothing..., |
| | then the referral information will carry information about yahoo since that was |
| | the site browsed immediately prior to the web site. A customer could also use |
| | an email or directly access the web site by using a bookmark/favorites list. |
| REFERRAL TYPE | An entity used for classifying referrals into various sub-types. |
| | Example: EMAIL referrals, E LOCATION referrals, etc. |
| REGION | An intermediate organization grouping level within the geographic hierarchy, |
| | which groups LOCATIONs. A specific regional geographic area of the country |
| | or county. |
| RELEASE TYPE | Describes whether release is for a blanket or planned purchase order. |
| | Possible values are therefore “Blanket” or “Planned”. |
| RENTAL EQUIP | Specific piece of Equipment that is rented out by the enterprise to customers |
| | for temporary use. |
| | Example: |
| | Ford Taurus VIN 3434059 |
| RENTAL LEASES EXTERNAL ACCT | A category of GL SUB ACCOUNT that provides expense details related to |
| | external or non-company owned rentals and leases. Examples: Real estate |
| | rent, leases, personal property rent, etc. |
| REPAIRS AND MAINTENANCE ACCT | A category of GL SUB ACCOUNT that provides expense details related to |
| | repairs & maintenance. Examples: Facility repairs, other maintenance. |
| REPORTING MONTH | This entity identifies the dates that are contained in a given reporting month. |
| | This hierarchy typically supports customized, equal-length periods that can |
| | provide more balanced comparisons and analysis, e.g., a “retail” or “454” |
| | calendar. |
| REPORTING QUARTER | This entity identifies the dates that are contained in a given reporting quarter. |
| | This hierarchy typically supports customized, equal-length periods that can |
| | provide more balanced comparisons and analysis, e.g., a “retail” or “454” |
| | calendar. |
| REPORTING WEEK | This entity identifies the dates that are contained in a given reporting week. |
| | This hierarchy typically supports customized, equal-length periods that can |
| | provide more balanced comparisons and analysis, e.g., a “retail”or “454” |
| | calendar. |
| REPORTING YEAR | This entity identifies the dates that are contained in a given reporting year. |
| | This hierarchy typically supports customized, equal-length periods that can |
| | provide more balanced comparisons and analysis, e.g., a “retail” or “454” |
| | calendar. |
| REQUEST TYPE | The domain of special requests for the passenger |
| | Example: Special meal, Wheel chair, or Language help. |
| RESERVATION | The sub-type of the TRAVEL TRANSACTION entity that represents the |
| | domain of requests for a specific itinerary associated with a TRAVEL |
| | TRANSACTION. |
| | Examples: Hotel Reservation, Airline Reservation, Rental Car Reservation. |
| RESERVATION ITEM | The specific items reserved as part of a TRAVEL TRANSACTION. |
| RESERVATION ITEM TYPE | Identifies the type of RESERVATION ITEM - For example, TRAVEL versus |
| | ACTIVITY |
| RESERVATION PREFERENCE | Ties the CUSTOMER PREFERENCEs as stored in their personal profile to a |
| | specific RESERVATION. |
| | This indicates the specific preferences that were requested for this specific |
| | reservation only. |
| RESERVATION STATUS | The domain of status types for a specific itinerary item associated with booked |
| | RESERVATIONs. |
| | Status conditions include: Open, Closed, Cancelled. |
| RESERVES ACCOUNT | The entity that provides details for the reserves. Reserves are the accrual of |
| | anticipated expenses to be paid out in the future, such as product liability, |
| | litigation, etc. |
| RESORT | A subtype of LOCATION where customers visit for relaxation or recreation. A |
| | RESORT typically can include other LOCATIONS such as LODGING |
| | PROPERTY, CASINO, etc. |
| RETAIL PURCHASE | A sub-type of the PURCHASE entity that represents a variety of RETAIL |
| | Item(s) or Service(s) bought and paid for by the PARTY. |
| | For example, Souvenir mugs, T-shirts, Cheese Sandwich, Bottled Water, Golf |
| | clubs, Shampoo, etc. |
| RETAIL PURCHASE CHARGE | Revenue obtained from customers that are not ITEM related. |
| | Example: |
| | Shipping & Handling |
| | Tips (charged & elective) |
| | Insurance, Service charge |
| | Taxes |
| | etc. |
| RETAIL PURCHASE TYPE | Categorizes the various types of RETAIL PURCHASES such as SHOPPING |
| | TRANSACTIONS (Merchandise goods), GUEST CHECKS (Food service |
| | items), etc. |
| RETAINED EARNING ACCOUNT | The entity that identifies a NONDIVIDEND EQUITY ACCOUNT as retained |
| | earnings. Retained earnings are net profits kept to accumulate in a business |
| | after dividends are paid. |
| RETURN | This entity identifies a single transaction where the receiving PARTY sends |
| | back ITEM(s) that previously shipped. |
| RETURN ITEM | A specific PURCHASE ITEM returned by the PARTY. |
| RETURN LINE STATUS ASSIGN | The entity tracks the various status or condition changes of a RETURN LINE |
| | over time. |
| RETURN LINE TYPE | This entity identifies the defined types of RETURN LINE, such as quality |
| | reject, wrong product, received too late, etc. |
| RETURN REASON | Reasons why an ordered/purchased Item is returned. |
| | Example: Damaged, incorrect item, does not meet agreed quality, etc. |
| RETURN STATUS | Lists the possible statuses of a RETURN LINE. For example, Received, In |
| | transit. |
| RETURN TRANSACTION LINE | Details PRODUCTs returned to a LOCATION by a customer for a refund or an |
| | exchange. |
| REV AND RECEIVABLE EXPNS ACCT | A category of GL SUB ACCOUNT that indicates an expense is related to |
| | generating Accounts Receivable. Examples are bad debt reserve, reserve |
| | credits - real estate. |
| REVENUE ACCOUNT | The entity that indicates a general ledger account is a REVENUE ACCOUNT. |
| | Types of REVENUE ACCOUNTs include interest income and other revenue. |
| REVENUE ACCOUNT TYPE | The entity that indicates the type of revenue account. Types of revenue |
| | accounts include sales revenue and other revenue. |
| RFID TAG | This entity captures Serialized Items or any other object tagged with a RFID |
| | Tag containing an Electronic Product Code. The Electronic Product Code |
| | (EPC) is a unique number that identifies a specific item or object in the supply |
| | chain. |
| | The EPC is stored on a radio frequency identification (RFID) tag, which |
| | combines a silicon chip and an antenna. Once the EPC is retrieved from the |
| | tag, it can be associated with dynamic data such as from where an item |
| | originated or the date of its production. |
| | Much like a Global Trade Item Number (GTIN) or Vehicle Identification |
| | Number (VIN), the EPC is the key that unlocks the power of the information |
| | systems that are part of the EPC global Network. |
| | (from http://www.epcglobalinc.org) |
| RFID TRAIT SCAN | The primary use of this entity is to record the values of environmental traits of |
| | an item or object as reported by a scanner/reader at a specific point in time. |
| | Please review the definition for RFID TAG and SER ITEM TRAIT. |
| | This entity is similar to the last above mentioned entity, in that it describes a |
| | trait or characteristic of a RFID Tagged item or object. However, the RFID |
| | TRAIT SCAN records a dynamic trait that may only be true at this one specific |
| | point in time, as opposed to the SER ITEM TRAIT entity that records static/ |
| | permanent traits. |
| | Example: |
| | A sensor reads the ambient temperature and pressure of an Item, and |
| | transmits the results every hour via RFID technology. |
| ROUTE GROUP | A Way to group related ROUTEs together. Note that ROUTE GROUP can also |
| | contain ROUTE GROUPs, thus creating a hierarchy. |
| | Example: all “Trans Atlantic” routes can be collected into a ROUTE GROUP, |
| | than can then again be part of a larger “International” ROUTE GROUP. |
| ROUTE TYPE | This identifies a ROUTE TYPE, i.e. “short haul” or “long haul”. |
| S2000 SER ITEM | Allows the identification of specific instances of an Item. |
| | Spec 2000 compliant Serialized Item. |
| | S2000 requires that this attribute be unique across all Items and Parties. It |
| | consists of two parts: Party specific Serial Number and Party Id (also known as |
| | CAGE Code) |
| SALE INVOICE | A request for payment presented by the Enterprise to a Customer, typically for |
| | services rendered or goods provided. |
| SALE INVOICE LINE | Invoice Lines related to Sales. |
| | (Invoice issued by the enterprise to a customer). |
| SALES PLAN | Detailed plan of how products are marketed at, sold from, and distributed to |
| | each LOCATION for a specific period of time. |
| | NOTE: The plan is shown at the ITEM CLASS level, however, it may be done |
| | at a higher or lower level (DEPARTMENT, ITEM, etc.). Adjust the model |
| | according to enterprise need. Similarly, it is done at LOCATION level - for |
| | Plans at a different level of granularity, the PK should be modified accordingly. |
| | NOTE: If all Sales Planning are done for a fixed or standard date range |
| | enterprise wide, the Sales Plan Dates should be moved from this Entity to the |
| | Plan Entity instead. |
| SALES RETURN TRAN | Inventory adjustment (positive) made due to the return of sold goods from a |
| | customer back to the enterprise. |
| SALES REVENUE ACCOUNT | A type of REVENUE ACCOUNT that provides details on revenue from delivery |
| | of goods and services. Sales revenue is the primary source of revenue |
| | earned by the company from its customers. |
| SCAN CODE | A remotely scanable identifying code that is placed on an item or product. It is |
| | typically a barcode or similar graphic object that is scanned optically, but could |
| | also be an electronic transponder (RF Id Technology device). |
| | Example: UPC code, the scan tickets placed upon ITEMs bought in the meat, |
| | deli, and bakery departments, etc. Other SCAN CODE FORMAT types |
| | associated with a given unique SCAN CODE are GTIN, and EAN. |
| | Note: In the case of RF (Radio Frequency) Id Technology, information in |
| | addition to the item identifying information can be transmitted/received. |
| SCHED EVENT | Captures Maintenance Events that were planned in advance by the Enterprise. |
| | Example: |
| | Regularly Scheduled Maintenance, Planned Upgrades/Certifications, Planned |
| | Service Bulletin compliance, etc. |
| SCHEDULED LEG | Details the date and time that a travel provider has scheduled to provide |
| | transportation. A LEG can be scheduled for multiple dates. |
| SCHEDULED SEGMENT | Details the date and time that a travel provider has scheduled to provide |
| | transportation. A SEGMENT can be scheduled for multiple dates. |
| SCHEDULED SEGMENT LEG | Exists to relate SCHEDULED SEGMENTs to SCHEDULED LEGs. Each |
| | SCHEDULED SEGMENT is made up of one or more SCHEDULED LEGs. |
| | Note: A LEG can be part of multiple SEGMENTs. |
| SEASON | A contiguous period of time of interest to the enterprise. Can be climate and/ |
| | or marketing based. |
| | Example: Summer, ‘Christmas season’, etc. |
| SECURITIES ACCOUNT | The entity that provides details for the SECURITIES ACCOUNTs. Securities |
| | are short term investments with a maturity of three to twelve months. |
| | Securities accounts are types of current assets. |
| SEGMENT BOOKING HIST | The history of the actual bookings for a BOOKING CLASS of a SCHEDULED |
| | SEGMENT as they were realized, a set number of days prior to departure. |
| | This would include information on bookings, seats booked, seats available, |
| | Waitlist, etc. |
| | Note: The “HIST” suffix indicates that some of the attributes of this entity may |
| | be derivable in some instances by looking at the actual detailed passenger |
| | check-in information, while other attributes may only be sourceable from a |
| | Revenue Management System. |
| SEGMENT FLOWN (SUMMARY) | The summary information of the performance of an actual scheduled OnD |
| | SEGMENT as it was realized, i.e. (flown) by the airline. |
| | Example: Penguin Airline's Flight 1101 from L.A. to N.Y.C. that departed on |
| | Tuesday, Jan. 23, 2001 at 10:00 am. |
| | Note: The “(SUMMARY)” suffix indicates that some of the attributes of this |
| | entity may be derivable in some instances by looking at the actual detailed |
| | passenger reservation and check-in information, while other attributes may |
| | only be sourceable from a Revenue Management System. |
| SEGMENT LEG | This entity cross references the LEGs (basic building blocks) that make up an |
| | OnD PRODUCT. An OnD PRODUCT can consist of one or more LEGs. |
| | Example: LA-NY product can consist of a LA-Chicago product plus a Chicago- |
| | NY product. |
| SELLING EXPENSE ACCOUNT | The operating expense category that indicates Selling expenses, related to the |
| | actual selling of a product. For example: Sales salaries and commissions. |
| SER ITEM INVENTORIED DD | Identifies the specific Serialized Items that are Inventoried at a specific |
| | Location. |
| | Note: This tracking may be enabled via RFID Technology - see the RFID |
| | Subject Area for more information. |
| | If detailed Inventory Transactions are captured, this information should be |
| | derivable. |
| SER ITEM INVENTORY ADJUST | Identifies the specific Serialized Items that were added or deleted from |
| | Inventory at a specific internal Location due to the internal movement of goods |
| | (no third party involved). The reason for the addition/deletion is detailed in the |
| | INVENTORY Subject Area. |
| | Note: This tracking may be enabled via RFID Technology - see the RFID |
| | Subject Area for more information. |
| SER ITEM RETURNED | Identifies the specific Serialized Items that were returned by a Customer to the |
| | Enterprise. |
| | Note: This tracking may be enabled via RFID Technology - see the RFID |
| | Subject Area for more information. |
| SER ITEM SHIPPED | Identifies the specific Serialized Items contained in a Shipment. |
| | Note: This tracking may be enabled via RFID Technology - see the RFID |
| | Subject Area for more information. |
| SER ITEM SOLD | Identifies the specific Serialized Items that were sold to a Customer. |
| | Note: This tracking may be enabled via RFID Technology - see the RFID |
| | Subject Area for more information. |
| SER ITEM STATUS | Since Serialized Items can be individually differentiated, it is also possible to |
| | assign a specific status to individual Serialized Items. |
| | Example: |
| | Refurbished |
| | Broken |
| | New |
| SER ITEM STATUS HIST | Captures the history of the Status of a specific individual Serialized Item. |
| | MRO Example: |
| | Framostat Serial No. 121121 was “Broken” on 2/2/2005 |
| | Framostat Serial No. 121121 was “Refurbished” on 8/8/2005 |
| SER ITEM TRAIT | The actual value describing the specific TRAIT of a Serialized Item (a specific |
| | instance of an ITEM). A Serialized Item can have an unlimited number of |
| | Traits. |
| | Similar to the Item Trait entity, except that these Traits only apply to a specific |
| | instance of an Item. See the Item Trait entity in the Item Subject Area for |
| | additional information. |
| | Traits that may be captured for Serialized Items include Expiration Dates, |
| | Manufacturing information, etc. |
| | Example: |
| | Item: Canon 1 Ds Digital Camera with |
| | Item Serial Num: 129384732 |
| | has the following Traits: |
| | Manufacture Date: Jun. 12, 2004 |
| | Plant Num: 2321 |
| | Inspected by: R. Sakamoto |
| SER ITEM VENDOR RECEIPT | Identifies the specific Serialized Items that were received from a Vendor. |
| | Note: This tracking may be enabled via RFID Technology - see the RFID |
| | Subject Area for more information. |
| SER ITEM VENDOR RETURN | Identifies the specific Serialized Items that were returned to the Vendor. |
| | Note: This tracking may be enabled via RFID Technology - see the RFID |
| | Subject Area for more information. |
| SERIALIZED ITEM | Allows the identification of specific instances of an Item. |
| | Item instances can be uniquely identified in several ways: |
| | an imbedded manufacturer serial number on the Item (cameras, DVD |
| | players, firearms, etc.) |
| | a tag fixed to the item for tracking purposes (as in the case of RFID tags - |
| | see EPC Item entity and the RFID Tracking Subject Area for more details) |
| | Note: The model represents the case of unique serial numbers. If there is a |
| | need to represent non-unique serial numbers, a small adjustment would need |
| | to be made by adding a Quantity attribute to all Serialized Item instances - this |
| | quantity attribute is obviously not needed in the case of unique serial numbers - |
| | since the quantity for any serial number will always be 1. |
| SERIALIZED ITEM CONTENT | Describes the ‘bill of material’ of an ITEM than contains other ITEMs. |
| | It is similar to the Multi Item Content entity (see the definition for examples), |
| | except in this case the actual specific instances of Items involved are identified |
| | by their Serial Numbers. |
| SERVICE CLASS | The type of service requested by the passenger. |
| | Example: AIRCRAFT - First Class, Business Class, Economy Class; |
| | LODGING PROPERTY - Deluxe Room, Suite; CRUISE LINE - Steerage; |
| | RENTAL VEHICLE - Full Size, Intermediate, etc. |
| SERVICE CLASS CONFIGURATION | Indicates the sellable capacity per class of service. Expressed in “seats” for |
| | aircraft, “cabins” for Ships, etc. |
| | Example: AIRCRAFT: 20 1st class seats, 120 coach class seats, etc. |
| SERVICE RATE | The amount that is charged to perform a SERVICE. |
| | Note: the Unit of Measure (UOM) at which the Service is priced appears in the |
| | Item entity. |
| SERVICE REQUEST | Details the SERVICEs ordered by a customer pertaining to a SHIPMENT. |
| | Typically contains one TRANSPORT SERVICE and multiple SPECIAL |
| | SERVICE requests. |
| | Example: |
| | Transport Service: Expedited Overnight, |
| | Special Service: inside delivery; sign for delivery. |
| SET OF BOOKS | The entity that indicates a collection of accounting transactions used by a |
| | company. A collection is typically referred to as a ‘set of books’. |
| SET OF BOOKS CALENDAR YEAR | This entity defines the Fiscal Year associated with a SET OF BOOKS. Each |
| | SET OF BOOKS will have a Fiscal Year, or accounting period covering 12 |
| | consecutive months. At the end of the Fiscal Year, the books are closed and |
| | profit or loss is determined. A Fiscal Year does not need to be the same as a |
| | calendar year. The SET OF BOOKS may be change its Fiscal Year. |
| SET OF BOOKS CHART OF ACCOUNT | Each SET OF BOOKS will have its own CHART OF ACCOUNTs, or a list of all |
| | account names and numbers used in a company's General Ledger. A |
| | company's CHART OF ACCOUNTs is generally designed to track and |
| | measure various areas of the business. |
| SET OF BOOKS CURRENCY HIST | This entity relates SET OF BOOKS to CURRENCY and tracks changes over |
| | time. |
| SET OF BOOKS INTERNAL ORG | The entity that provides an association between SET OF BOOKS and Internal |
| | Organization. |
| SET OF BOOKS TYPE | prime |
| | us gaap adj |
| | statutory |
| SHIP | This entity defines Transport Equipment used to transport passengers and/or |
| | goods across bodies of water. |
| SHIP EVENT TYPE | A classification of event types related to the shipment of goods. |
| | Example: |
| | Pickup Arrival |
| | Delivery Acceptance, |
| | Terminal Departure Scan |
| | etc. |
| SHIP PORT | The domain of locations where Ship Transportation occurs, i.e., where Ships |
| | depart and dock and passengers board or get off ships. |
| SHIPMENT COST | The individual items of COST associated with this particular SHIPMENT. Used |
| | to determine the ultimate profitability of the SHIPMENT. |
| SHIPMENT ESTIMATE | An estimate of the weight and volume of a future Shipment. typically provided |
| | by the Shipping Party. These estimates may change as the Shipper gets |
| | closer to the departure date, or when the actual Shipment is finalized. |
| | These estimates are used to do Capacity Planning. |
| | An estimate can consist of Containers and/or Loose Freight. |
| | Note: A history of estimates are captured to help determine the accuracy of |
| | estimates provided by customers. Each subsequent estimate replaces the |
| | prior estimate. (Example: 8 containers are allocated 2 weeks prior to a flight |
| | based on a customer estimate, and the customer changes the estimate to 1 |
| | container 3 days prior to the flight) |
| | Note: At this point of the process, there may be detailed OR very little |
| | information available about the future shipment. The OnD, Scheduled Leg, |
| | weight and volume should be known though. |
| SHIPMENT FEEDBACK | Feedback received in reference to a specific CARGO SHIPMENT. |
| SHIPMENT LINE ITEM | Commodity description that makes up the shipment. |
| SHIPMENT SPACE ALLOCATION | Mapping Shipment(Cargo) Orders to Allocated Container Types or Loose |
| | Freight for a specific Scheduled Leg. |
| | Allows Capacity planning to be done in advance of actual Shipping. |
| | At this point the actual containers or ULDs that will be used may not be known |
| | yet, so their unique Serial Numbers are not used. |
| SHIPMENT STATE | Defines the actual state or ‘status’ of a SHIPMENT PIECE. It has a duration, |
| | and is usually initiated and terminated by an EVENT. |
| | Example: |
| | At customer, waiting to be picked up |
| | Loading at Customer site |
| | In transit from Customer to Terminal |
| | Being Crossdocked |
| | In Storage |
| | etc. |
| SHIPMENT STATE COST | Associates all the generated allocated costs incurred by a specific PIECE |
| | while in a specific STATE. If the COST could (optionally) be associated with a |
| | provided SERVICE. Used to assign costing to calculate SHIPMENT and |
| | customer profitability. |
| | Example: |
| | Associate fuel and labor cost consumed during a given LEG to each of |
| | the PIECEs transported. |
| | Labor and Equipment cost associated with Break down by weight at the |
| | Dock |
| | Facility cost associated with storage of goods when Receiver not ready to |
| | receive. |
| | Costs associated with clearing goods through Customs |
| | etc. |
| SHIPPING EVENT | An event related to the shipment of goods. It does not have a duration, and |
| | occurs in an ‘instant’. Typically changes the STATE or status of the shipments |
| | involved. |
| | Example: |
| | Pickup Arrival |
| | Delivery Acceptance |
| | Terminal Departure Scan |
| | Customs(Border) Event |
| | etc. |
| SHIPPING EXCEPTION | Captures the Exception(s) (if any) that occurred during a Shipping Event. |
| SHOP EVENT | Shop Maintenance Event. |
| | Captures maintenance work that is done (installing, removing, repairing parts) |
| | that is done in a “Shop Environment” (Workshop or Hangar) on an individual |
| | Part, or on Equipment that has been removed from its regularly scheduled |
| | service. |
| SHOP FINDING | Captures the findings of the Maintenance Worker(s). |
| | Example: |
| | No problem found on a Part indicated as faulty by the pilot |
| | Part found to be damaged due to mis-use, and beyond repair |
| | etc. |
| SHOP FINDING TYPE | Higher level Categories for grouping logical classes of Shop Findings together. |
| SHOPPING TRAN DISCOUNT LINE | A cross-reference mapping a SHOPPING TRANSACTION DISCOUNT to the |
| | actual ITEMs that was purchased to qualify for the DISCOUNT and/or the |
| | ITEMs that received the DISCOUNT. |
| | Example: Cross reference the full retail purchase of a ‘6 pack of Coke’ and the |
| | resultant 50% off ‘Dodgers baseball cap’ to the SALES DISCOUNT. |
| SHOPPING TRANSACTION | A sub-type of the RETAIL PURCHASE that represents the potential or actual |
| | sale or return of one or more retail ITEMs. It is very open ended, and can be |
| | used to describe any aggregation of ITEMS made by a (potential) customer. |
| | Other potential examples: This entity can represent Web Shopping Cart, Web |
| | Wish-list, Wedding Registry List, Store P.O.S. Sale, Store Layaway Purchase, |
| | Catalog Order, etc. |
| SHOPPING TRANSACTION LINE | The actual ITEMs purchased by a customer within a Shopping Transaction. |
| SHORT TERM DEBT ACCOUNT | The entity that provides details for the short term debt. Short term debt is all |
| | dept obligations coming due within one year. |
| SIC | A Standard Industry Classification is a statistical classification standard |
| | describing all establishments. It categorizes businesses by the type of |
| | business in which each they are engaged. Businesses engaged in the same |
| | activity, regardless of size or type of ownership are given the same SIC code. |
| | In the United States the SIC is maintained by the Office of Management and |
| | Budget, Executive Office of the President. |
| SLOT CABINET | The physical style of the cabinet in which a gaming machine is housed. |
| | Examples: |
| | Upright cabinet with a 9″ top box (height- 40″, width- 24.5″, depth- 20.75″, |
| | weight 185 pounds) |
| | Upright cabinet with a 16″ top box (46.5″ by 24.5″ by 20.75″, 190 pounds) |
| | Upright cabinet with a Round Top Box (46″ by 24.5″ by 20.75″, 190 |
| | pounds) |
| | Slant Top cabinet with a standard top box (50.75″ by 28″ by 31.25″, 285 |
| | pounds) |
| SLOT EQUIP SERIES | Represents different possible Slot Equipment Versions within a specific Model |
| | (often called a Series) |
| SLOT GAME CONFIG | Specifies the actual Game Configurations currently supported (playable) on |
| | this slot game station. |
| | Note that multiple game configurations can be active at the same time, due to |
| | multi-game game stations. |
| SLOT GAME STATION | A Specific machine device where CASINO PLAYERs gamble by inserting |
| | money, tokens, or tickets in a “slot.”, resulting in “wins” or “losses.” |
| | Example: |
| | Bally 3 wheel $1 Slot Machine Asset ID 384372 |
| SLOT SESSION | A Period of time spent at a Casino Slot Game Station by a known CASINO |
| | PLAYER. |
| SPA | A sub-type of location for sale/consumption of SPA PRODUCTs/SERVICE. |
| SPA RESERVATION | A sub-type of the ACTIVITY RESERVATION indicating the intention of a |
| | PARTY to use SPA PRODUCTs (SERVICE) |
| SPECIAL EVENT RESERVATION | A sub-type of ACTIVITY RESERVATION representing the bookings for |
| | entertainment events/shows, sporting events, etc. |
| SPECIAL EVENTS AGENCY | The agency that is responsible for bringing in the Group Client to the |
| | LODGING ORGANIZATION for a group event. |
| SPECIAL EVENTS AGENCY CONTACT | Identifies the individual within Special Events Agency that brought the Group |
| | Client to the LODGING ORGANIZATION for a group event. |
| SPECIAL RATE | Entity that identifies the rate charged for special services by the transportation |
| | company. |
| | NOTE: Can be Flat Rate OR per Unit of Measure (UOM) ($ per pound, $ per |
| | piece handled) |
| | Example: Some Unit of Measure rates: |
| | time - time in storage |
| | weight - humping charge - sacks of flour - sort and segregate |
| | hourly rate - waiting time because receiver is not ready to receive delivery |
| | % rate (COD example) |
| SPECIAL REQUEST | Any special request made by a Customer. |
| | There may be a charge associated for providing the service. |
| | Example: |
| | special meal or wheel chair assistance. |
| | special items during a catering event |
| | For an Airline, the request may be made at anytime in the Airline booking, |
| | ticketing, check-in or boarding process. |
| SPECIAL SERVICE | Services sold in addition to the physical transportation of goods. Also known |
| | as Assessorial/Accessorial Services. |
| | Example: |
| | Notification prior to delivery |
| | Inside Delivery |
| | Hold for Pickup |
| | etc. |
| SPORTS BET TYPE | Classifies the SPORTS BOOK SESSION by the available types of SPORTS |
| | BETs |
| | Examples: |
| | Straight Bets: Player bets that one team will beat another (with point |
| | spread or money line) |
| | Totals: Player bets the total points scored by both teams |
| | Proposition bets: Player bets against the winning of a toss or a fight |
| | lasting 2 rounds, etc. |
| SPORTS BOOK BETS | Tracks the individual bets placed in a SPORTS BOOK SESSION |
| SPORTS BOOK SESSION | A period of time spent by the CASINO PLAYER gambling on the outcome of |
| | one or many sporting events such as basketball, horse racing, dog racing, etc |
| SPORTS EVENT | Lists all the various sporting events that are available for betting in a SPORTS |
| | BOOK SESSION. |
| | For example, the Atlanta Hawks versus the Detroit Pistons will have two |
| | listings: |
| | 1001 Atlanta Hawks |
| | 1002 Detroit Pistons |
| SPORTS EVENT TYPE | Classifies the various types of SPORTS EVENTS. |
| | For example: |
| | Base - baseball |
| | Bask - basketball |
| | Foot - football |
| STATE TYPE | Classification of the state or ‘status’ of a PIECE being transported. |
| | Example: |
| | At customer, waiting to be picked up |
| | Loading at Customer site |
| | In transit from Customer to Terminal |
| | Being Crossdocked |
| | In Storage |
| | etc. |
| STD MAINT | Contains MRO Specifications that are regularly and routinely planned and |
| | performed. |
| STORE | A type of LOCATION where customers can physically come to and purchase |
| | ITEMs. |
| STORE CLUSTER | A Grouping of STOREs with similar characteristics. This is typically an explicit |
| | grouping by the enterprise, as opposed to the naturalistic groupings provided |
| | by the DEMOGRAPHIC Subject Area. |
| | Typically used to facilitate the merchandising of STOREs with similar sales |
| | patterns - often generated by consumers in a confined geographical area. |
| | Example: Urban, TexMex, etc |
| STORE CONCEPT | A Consumer centric theme or aspect for a Store that is cosmetic in nature (as |
| | opposed to organizational, like CHAIN). Typically does not affect the goods |
| | offered or pricing. |
| | Example: |
| | Adding child friendly displays and entertainment activities to the storefront. |
| STORE FORMAT | STORE FORMAT is used to provide a differentiated shopping experience to |
| | customers across STOREs. This differentiation typical focuses on selection, |
| | size, and quality of goods. |
| | Example: Different terms are used by enterprises, but typical examples would |
| | be Super Store, Outlet Store, Standard Store, etc. |
| SUPPL CERT (STN) | Specifies the MRO Specs to attain additional levels of Certification for an Item |
| | or piece of Equipment. |
| | Example: |
| | Replacing and upgrading navigational Equipment to allow Equipment to be |
| | used where not currently certified. |
| SUPPLY LOCATION | For a given location and item, describes the preferred supply location, as well |
| | as the time typically needed to get the item from the origin location to the |
| | target location. |
| | Note: This structure allows for detail at the lowest atomic item level. If needed |
| | this structure can be defined at a higher level of the item hierarchy instead. |
| SURVEY FEEDBACK | Feedback received in a formal, controlled, or structured format, where specific |
| | responses are solicited, and responses (typically) are constrained to selecting |
| | one of several choices presented. |
| SURVEY QUESTION RESPONSE | Feedback response to a specific item or question on a survey. |
| SVC BULLETIN (SBN) | A MRO Spec issued (typically) by a Safety Governing Body or the |
| | Manufacturer to detail a Parts related issue that needs to be addressed. |
| | Example: |
| | Waterproofing on all Framostats made prior to 1998 need to be inspected due |
| | to short-circuit reports. |
| SWEEPSTAKE ENTRY | Captures a specific entry into a specific Sweepstake. |
| | If the entry was due to a gaming session, the related gaming session is also |
| | shown. |
| T&T FACILITY | Official locations where Travel or Transportation originates or terminates, i.e., |
| | where ships, trains or airplanes depart and arrive and passengers and/or |
| | cargo are taken on (or offloaded). |
| | Example: Atlanta Hartsfield Airport, Long Beach Harbor, Heathrow Airport, etc. |
| | Note: The entity is meant to capture “official” facilities used by many |
| | businesses (usually run by a Government). Privately/Business owned facilities |
| | for exclusive use by a single organization will typically be classified as other |
| | types of Locations instead. |
| T&T FACILITY GROUP | A Grouping of T&T FACILITIES for Marketing or Analytical purposes. |
| | Example: |
| | all the Airports that are part of the “NorthEast Market”, “Chicago Market”, |
| | etc. |
| | all the Ports that are in the “Caribbean Market” for a Cruise Ship |
| | Company. |
| T&T FACILITY GROUP XREF | Maps T&T FACILITYs to T&T FACILITY GROUPs. A T&T FACILITY can be a |
| | member of multiple T&T FACILITY GROUPs. |
| T&T FACILITY TYPE | A type of T&T FACILITY that may be used by a passenger. |
| | Example: AIRPORT, BUS DEPOT, RAIL STATION, SHIP PORT, etc. |
| TABLE GAME CONFIG | Specifies the actual Game Configurations currently supported (playable) on |
| | this table game station. |
| | Note that multiple game configurations can be active at the same time, due to |
| | multi-game game stations. |
| TABLE GAME STATION | A Specific Table where multiple CASINO PLAYERs can gather and gamble, |
| | resulting in “wins” or “losses.” |
| | Example: |
| | Acme DeLuxe Blackjack Table Asset Id 2425 |
| | etc. |
| TABLE SESSION | A Period of time spent at a Casino Table Game Station by a known CASINO |
| | PLAYER. |
| TASK | This entity describes the TASKs or activities that can make up the PROJECT. |
| TELEPHONE ADDRESS | Telephone number. Could be voice, data, fax, pager. |
| TELEPHONE COMM TYPE XREF | A cross reference of telephone numbers with the types of communications that |
| | can be directed to the telephone number (e.g. fax, voice, data). |
| TELEPHONE COMMUNICATION TYPE | The types of communications that can be directed to a telephone number (e.g. |
| | fax, voice, data). |
| TERRITORY | A geographic region within a COUNTRY. Can be a State, Province, etc. |
| | Example: California, Quebec, Gauteng, etc. |
| TICKET | The entity that represents the actual coupon used to claim reserved service. |
| | Can be physical coupon or electronic version of same. |
| TICKET AWARD | This entity is a subtype of AWARD CERTIFICATE and associates a specific |
| | ACCOUNT REDEMPTION to a TICKET or Flight Pass. |
| TICKET AWARD CERTIFICATE | A sub-type of CERTIFICATE that contains information about a certificate |
| | received as a result of redeemed mileage from a frequent traveler account. |
| TICKET FORMAT | This entity is the domain of values used to discriminate different Ticket types. |
| | Examples: ATB2(a magnetic strip ticket that is issued by IATA), E-Ticket and |
| | Manual. |
| TICKET PAYMENT | The methods by which a TICKET is purchased and paid for as well as tracking |
| | changes and reimbursements/refunds. |
| TICKET TYPE | A sub-type of TICKET that contains information about the type of TICKET |
| | purchased. |
| | Example: BUS TICKET, CRUISE LINE TICKET, AIRLINE TICKET, etc. |
| TIME ZONE | The time zone for particular locations around the world. Data may be simple |
| | or complex. Often only an offset from Coordinated Universal Time (UTC) or |
| | Greenwich Mean Time (GMT) is recorded. Los Angeles' time zone would thus |
| | be shown as UCT-0700 (Coordinated Universal Time minus 7 hours). |
| | Honolulu, Hawaii as UCT-1000 (minus 10 hours). |
| | Indicators for usage of Standard or Daylight time (along with other appropriate |
| | attributes such as City and State for the U.S.) and data for Longitude and |
| | Latitude may also be added to this entity if, and as, needed. |
| | NOTE: an example relationship is shown. During implementation, place the |
| | relationship according to customer specifications, e.g., at the CITY or POSTAL |
| | CODE level, etc. |
| | UCT (Atomic Time) replaced the older Greenwich Mean Time (GMT) which |
| | referred to the Mean Solar time at the Royal Observatory |
| TRAIT | Describes a trait of an object, service, experience, etc. |
| | This structure is typically used where objects can have a wide number of |
| | dynamic descriptive attributes, and/or new ones are continuously encountered. |
| | In this case, a generic structure as defined by the Trait structure may be more |
| | appropriate than discrete attributes. |
| | Example: |
| | For Item, it could be: Color, Height, Suitable Age rating, etc. |
| | For Ser Item Trait: Expiration Date, Batch Number, Quality Inspector Id, |
| | etc. |
| | For RFID Trait Scans: Ambient Temperature, Shock, Pressure, etc. |
| | For Quality Feedback Detail: Service Speed, Associate Friendliness, etc. |
| | Note: In environments where objects are homogenous discrete attributes |
| | would be recommended instead (e.g.: in the case of a dedicated Bookseller). |
| TRAIT GROUP | A cluster of related TRAITs. |
| | Example: |
| | For Item: ‘Size’ could be a TRAIT GROUP, with each of the dimensions |
| | (height, width, depth) being a separate TRAIT. |
| | For Service Quality: Associate rating, Accuracy rating, Expense rating, |
| | etc. |
| | For RFID Trait Scan: Handling, Environmental, etc. |
| TRAIT VALUE | The actual value describing the specific TRAIT of a specific object. |
| | Example: |
| | For Item Traits: Color = ‘blue’, Suitable Age rating = ‘12 years and older’ |
| | For Ser Item Trait: Expiration Date = April 2009 |
| | For RFID Trait Scans: Ambient Temperature High = 40 degrees Celsius |
| | For Quality Feedback Detail: Service = Slow; Associate = Very |
| | Professional, etc. |
| | Depending on whether the value is a textual description (Trait Value Desc) |
| | versus a numeric value (Trait Val), populate one or the other attribute but not |
| | both. |
| TRAN EQUIP POWER | History (and current information) of the specific Power generating Equipment |
| | used in specific Transportation Equipment. |
| | Example: |
| | Engine Id 12345 was in service as the number 2 Engine on Aircraft Id 323232 |
| | from 2/2/2000 until 3/3/2002 |
| TRANSACTION DISCOUNT | An amount that reduces the total TENDER amount required from the customer |
| | for a given purchase. This could be due to an OFFER (e.g. COUPON), sale, |
| | markdown, damaged merchandise, etc. It can be related to an entire RETAIL |
| | PURCHASE, or more specifically related to ITEMs in a SHOPPING |
| | TRANSACTION LINE or DINING TRANSACTION LINE. |
| | Example: The amount of $3.25 to be subtracted from total tender required due |
| | to the purchase of 750 ml Kahlua by a loyalty card member. |
| TRANSACTION GROUP | Groups Sales and Inventory TRANSACTION TYPEs into high level transaction |
| | groups. |
| | Example: shopping transaction, inventory transaction, purchase order, return |
| | transaction. |
| TRANSACTION LINE STATUS | Denotes the current phase of a Line Item on a transaction. |
| | Example: Cancelled line item, out of stock line item, backordered line item, etc. |
| | Note: The current status is modeled by a direct relationship to the Transaction |
| | entity. Historical Status (or Status progression) is modeled by an associative |
| | entity between this entity and the transaction entity (and including the effective |
| | date in the associative entity). |
| TRANSACTION STATUS | Denotes the current phase of a Shopping or Inventory Transaction, |
| | Example: |
| | Within Transaction Group SHOPPING TRANSACTION. |
| | Example: Cancelled order, completed order, abandoned shopping cart, |
| | shopping cart that had been converted into an order, etc. |
| | Within Transaction Group INVENTORY: |
| | In Transit, completed, cancelled, etc. |
| | Within Transaction Group PURCHASE ORDER: |
| | Acknowledged, Shipped, In Transit, completed, cancelled, etc. |
| | Note: The current status is modeled by a direct relationship to the Transaction |
| | entity. Historical Status (or Status progression) is modeled by an associative |
| | entity between this entity and the transaction entity (and including the effective |
| | date in the associative entity). |
| TRANSACTION TYPE | Specifies the specific type of Purchase Order, Sales or Inventory transaction, |
| | e.g., within a larger TRANSACTION GROUP. |
| | Example: |
| | Within Transaction Group SHOPPING TRANSACTION: |
| | Web Shopping Cart, Web Wish-list, Wedding Registry List, Store P.O.S. |
| | Sale, Store Layaway Purchase, Catalog Order, etc. |
| | Within Transaction Group INVENTORY: |
| | Wastage, Transfer, Audit(Stock Count), Consolidation, etc. |
| | Within Transaction Group PURCHASE ORDER: |
| | Regular Purchase Order, Blanket Purchase Order, Special Purchase |
| | Order, etc. |
| TRANSFER EVENT | The Transfer Event is the moment that transported goods are handed off to |
| | another CARRIER. |
| TRANSIT STATE | The duration of time that the shipment is being transported between two |
| | locations. A cross-reference of PIECEs being transported in each |
| | SCHEDULED LEG, and the TRANSPORTATION EQUIPMENT it was |
| | contained in. |
| TRANSMITTAL MODE TYPE | This entity identifies how an object was transmitted such as paper sent |
| | through the mail, EDI, or email. |
| TRANSPORT EQUIP | Specific piece of equipment used in the physical transportation of passengers |
| | and/or goods. May be powered or non-powered (towed). |
| | Example: |
| | Boeing 787 Tail Number X8329 |
| | Mack Truck VIN 43493848389 |
| | Nautilus Cruise Ship ID 3383 |
| | Trailer Asset ID SJ3984 |
| | Refrigerated Railcar Asset ID 9490394 |
| | etc. |
| TRANSPORT PURCHASE ITEM | Represents an ITEM or SERVICE purchased for transporting PARTY's, such |
| | as AIR PRODUCT, CRUISE PRODUCT, BUS PRODUCT, RAIL PRODUCT, |
| | etc |
| TRANSPORT RATE | A table that details the charges for performing specific transportation services |
| | (that is, the transporting of a specific type and weight of ITEM between two |
| | specific zones) at a specific service level. |
| | Transport Rates could also be a simple formula involving dimensions and |
| | weight, without regard for the actual content type or commodity to be |
| | transported. |
| TRANSPORT SERVICE CLASS | Generic indicator of speed of Transportation Service. |
| | Example: |
| | 2 day |
| | overnight |
| | same day |
| TRANSPORT SERVICE ITEM | An ITEM used or sold to a customer as part of providing a TRANSPORT |
| | SERVICE. |
| | Specialized entity used if the enterprise sells Transportation (Cargo) Services. |
| | Examples: |
| | Transporting goods from one location to another on behalf of a customer. |
| | Unpacking the item at delivery and taking away the packing material |
| | Providing pick-up and delivery services from the Air Cargo facility. |
| | Packaging Material used |
| TRANSPORT SERVICE RATE | The amount that is charged to perform a Transportation SERVICE. Can |
| | involve the actual movement of goods (movement from an origin to a |
| | destination), or related Services (White Glove Handling, Inside Delivery, etc.) |
| TRANSPORT TRIP EVENT | Subtype of TRIP EVENT consisting of transport related events such as flight |
| | check-in, baggage check, etc |
| TRANSPORT TRIP EVENT TYPE | Classifies the TRANSPORT TRIP EVENT. |
| | Example: |
| | Flight Check-In |
| | Boarding |
| | Denied Boarding |
| | Baggage Check |
| | etc. |
| TRANSPORT TYPE | The type of transportation associated with this event. |
| | Examples: |
| | Bus |
| | Airplane |
| | Boat |
| TRANSPORT ZONE | Grouping of geographic areas (typically POSTAL CODEs) into larger areas for |
| | use in pricing transport between different geographic regions. |
| TRANSPORTATION SERVICE | The different service products that a company offers from a Transportation |
| | perspective that involves the physical transportation of goods. |
| | Example: |
| | Acme Standard |
| | Acme Overnight |
| | Acme Same Day |
| TRANSPORTED PASSENGER | Every entry in this entity represents an actual passenger that was transported |
| | exactly one LEG. |
| | Example: On a LAX/ORD/JFK flight for a passenger flying from LAX to JFK |
| | there will be two entries. |
| TRAVEL AGENCY | Identifies each non-travel provider business used to arrange and make travel |
| | reservations, sell tickets, and distribute tickets to the designated passenger or |
| | designee. |
| TRAVEL COUPON | A single boarding leg of a TICKETed Itinerary for one passenger for one |
| | contiguous period of travel. |
| TRAVEL PARTNER | The domain of companies or enterprises that can participate in Rewards |
| | programs by granting earnings externally to the company that manages the |
| | Reward Account. |
| TRAVEL PASS PAYMENT | A sub-type of Ticket Purchase that records information when a Travel Pass is |
| | used. |
| TRAVEL PAYMENT | Describes the form of payment tendered for the purchase of a Travel Product. |
| | It is separate due to the specialized forms of payment not typically found in |
| | non Travel transactions (Cargo, etc.). |
| | Examples: Corporate Air Travel Pass, Travel Award Certificate, etc. |
| TRAVEL PRODUCT | A Consumer Travel-related offer available for sale to a PARTY(s). |
| | Examples: |
| | OnD Product: Fly LAX-SEQ morning flight |
| | Hospitality Product: Ocean view Miami Hotel room |
| | Hospitality Retail Item: Jacket with Hotel logo |
| | Menu Item: Turkey sandwich at a Casino cafe |
| | etc. |
| | Note: Travel Packages consisting of multiple travel products are assembled at |
| | the Multi Item level. |
| TRAVEL PRODUCT TYPE | Indicates subtypes of TRAVEL PRODUCT. |
| | Example: OnD PRODUCT, HOSPITALITY RENTAL PRODUCT, LODGING |
| | PRODUCT, etc. This could also be used for identifying “Packages.” (See Multi |
| | Item for additional information). |
| TRAVEL PURCHASE | A sub-type of the PURCHASE entity that represents the TRAVEL related |
| | Item(s) or Service(s) bought and paid for by the PARTY. |
| | For example, Airline tickets, Car rental purchase, Cruise ship tickets, |
| | Hotel/Resort room bookings, Golf Tee times, SPA Massage Service, etc. |
| TRAVEL PURCHASE ITEM | The specific items PURCHASEd as part of a TRAVEL TRANSACTION. This |
| | includes all travel related ITEMS except RETAIL (captured in SHOPPING |
| | TRANSACTION and DINING TRANSACTION) |
| TRAVEL PURCHASE ITEM TYPE | Classifies the PURCHASE ITEM into LODGING, ACTIVITY & |
| | TRANSPORTATION PURCHASE ITEMs |
| TRAVEL RESERVATION ITEM | The specific items reserved as part of a TRAVEL TRANSACTION. |
| | This is information that pertains only to the specific reservation, as opposed to |
| | the actual Item that was reserved. |
| TRAVEL RESERVATION TYPE | Identifies the type of RESERVATION ITEM. |
| | Examples: Car Rental, Lodging, Air, etc. |
| TRAVEL RETAIL ITEM | A retail product offered by the travel provider. Typically offered enroute, but |
| | may be available in the Terminal, etc. |
| | Example: Airline-monogrammed jacket; Captain's Wings pin; headphones; an |
| | alcoholic beverage purchased on the plane, etc. |
| | Note: additional retail items related to travel are found in Hospitality Retail |
| | Item. |
| TRAVEL TRAN FEEDBACK | Feedback received from a PARTY related to a TRAVEL TRANSACTION. |
| TRAVEL TRANSACTION | An entity which represents a travel transaction which can contain the |
| | BROWSING, RESERVATION and PURCHASE of PRODUCTs. |
| | Our current convention is to create a new transaction for each TRIP. |
| TRAVEL TRANSACTION TYPE | Identifies the type of TRAVEL TRANSACTION. |
| | Example: Browse, Reservation, Purchase. |
| TRAVEL TRANSACTION XREF | Cross reference entity to allow TRAVEL TRANSACTION to be related to each |
| | other. This can be used to related similar transactions (several |
| | RESERVATION transactions) or different transactions (relating |
| | RESERVATIONs to PURCHASEs, etc.) |
| TRAVEL TRIP | A Group of related TRAVEL TRANSACTIONs. Usually related to a specific |
| | ‘Journey’ made for a specific purpose. |
| | Example: A return flight to Hawaii plus a rental car reservation plus a hotel |
| | reservation. |
| | Note: This is a very high level grouping that will only be used by enterprises |
| | that has visibility into multiple components of a Trip (Lodging plus Rental Car |
| | plus Flight, etc.). Typically not used by enterprises that operate only one of |
| | these components (Lodging establishment, etc.) |
| TRAVEL TRIP FEEDBACK | Feedback from a PARTY regarding a TRAVEL TRIP booked by, arranged by, |
| | or provided by the enterprise. |
| TRAVELERS CHECK | Represents a form of cash in the form of a third party check. Typically used |
| | only once for payment at which time any unspent balance is returned to the |
| | purchaser as cash. |
| | Example: American Express Traveler's Check. |
| TREASURY STOCK ACCOUNT | The entity that identifies a NONDIVIDEND EQUITY ACCOUNT as treasury |
| | stock. Treasury stock is reacquired by a corporation to be retired or resold to |
| | the public. Treasury stock is issued but not outstanding, and is not taken into |
| | consideration when calculating earnings per share or dividends, or for voting |
| | purposes. |
| TRIP EVENT | The actual event(s) which happen during a TRIP. |
| | Example: CHECK-IN EVENT, BAGGAGE CHECK, BOARDING EVENT. |
| TRIP EVENT TYPE | The type of a TRIP EVENT. |
| | Example: Transport Trip Event, Lodging Trip Event. |
| TRUCKING | Transportation Equipment used in the Trucking Industry to move freight. |
| | Note: Pure containers will be captured in the Container entity. |
| | Example: |
| | Truck |
| | Tractor |
| | Trailer |
| | etc. |
| TURN BACK ATB | Indicates a LEG INCIDENT describing a turn back and return to its Originating |
| | TRAVEL FACILITY because of some irregular operation |
| TV AD | An AD designed to be shown on television. Usually 30 seconds in length. |
| ULD | Unit Load Device. A container used to transport baggage, cargo, packages, |
| | etc., via an aircraft. ULDs are typically used in Air Cargo, and their shapes can |
| | be contoured to better fit Aircraft interiors. |
| | Example: a ULD designed to fit into a L-1011 aircraft, etc. |
| UNSCHED EVENT | Captures Maintenance Events that were not planned in advance by the |
| | Enterprise. |
| | Example: |
| | A Warning light comes on when an Aircraft gets ready to depart, prompting an |
| | unscheduled Line Replacement of a Part. |
| UNSTRUCTURED FEEDBACK | The Unstructured Feedback structure captures ‘non-formal’ feedback that is |
| | typically difficult to encode (as opposed to ‘formal’ interactions, such as orders, |
| | payments, etc.). This type of feedback is typically ‘free form’ (phone |
| | conversations, letters, etc.). Attributes are provided to enable summary |
| | representative standard codes to describe the essence of the contact to make |
| | analysis possible. |
| | Feedback is provided in an unstructured format (as opposed to a formal |
| | questionnaire, poll, or survey) |
| | Example: |
| | a telephone call or letter received from a customer |
| UOM | Unit of Measure. The unit in which the quantity or magnitude of an item is |
| | expressed. This business entity specifies the unit measure of an items by its |
| | proper unit measurement. |
| | Examples: |
| | for volume: milliliter, UK dry pint, liter, liquid ounce, cubic centimeter |
| | for weight: kilogram, ton, centigram, ounce, pound |
| | for length: mm; inch; foot; mile; kilometer |
| | for area: square inch, acre, square kilometer |
| | for units: each, carton, byte. Apiece |
| | for connect speed: kilobaud |
| | for loyalty units: points, miles, kilometers |
| | etc. |
| UOM CATEGORY | A commonly named reference to which similar units of measure belong. |
| | Example: “Length” might be described as “the linear extent in space from one |
| | point to another” and categorize the following similar units of measure: inches, |
| | centimeters, feet, kilometers, millimeters, yards, miles, etc. |
| | “Weight” might be described as “the vertical force exerted by a mass as a |
| | result of gravity” and categorize tons, ounces, grams, kilograms, pounds, etc., |
| | units of measure. |
| | Other examples: |
| | volume |
| | area |
| | unit (or piece) |
| | weight |
| | temperature. |
| | etc. |
| UOM CONVERSION | Cross references the translation of one unit of measure to another, similar, unit |
| | of measure (both belonging to the same category). |
| | Example: |
| | Convert Ounces to Kilograms (members of Weight category) |
| | Convert Acres to Square Feet (members of Area category) |
| | Convert Yards to Centimeters (members of Length category) |
| | Convert Inches to Yards (members of Length category), |
| | etc. |
| | This entity also provides the necessary conversion factor for each combination |
| | of measures. |
| | Note: Some conversions are more complex and may need a formula instead of |
| | a factor (such as Fahrenheit to Celsius) |
| | It is recommended to select a single base UOM for each metric and use that |
| | consistently. |
| UPGRADE AWARD | This entity is a subtype of AWARD CERTIFICATE and tracks information |
| | associated with a Transportation Fare Class Upgrade Award |
| USSGL TRANSACTION TYPE | US Only - US Govt Standard GL codes for transactions. |
| VENDOR | A type of ORGANIZATION that supplies ITEMs (Goods or Services) to an |
| | Enterprise for resale or internal use. |
| | Can specify a (high level) VENDOR or a Location-specific VENDOR (if that is |
| | the level at which transactions are done for the Enterprise). |
| | Example: |
| | Ordering goods or services from ACME (or Denver ACME) |
| VENDOR ALLOWANCE | Monetary concessions made by the Vendor (supplier) to the Enterprise. |
| | Example: lump sum amounts, cost allowances, refunds for items that are not |
| | returnable, etc. |
| VENDOR ALLOWANCE TYPE | The type of monetary concession made by a Vendor (supplier) to the |
| | Enterprise. |
| | Example: lump sum amounts, cost allowances, etc. |
| VENDOR DISCOUNT STRUCTURE | The discount structure offered by a VENDOR on an ITEM. A date may be |
| | added to the PK for tracking historical information. |
| | Example: If you buy between 2,000 and 10,000 units you get a 2% discount. |
| | Buy more than 10,000 and get a 4% discount. |
| VENDOR FORECAST | Used for future projections & forecasts for a given ITEM to be supplied by a |
| | given VENDOR. Accommodates multiple simultaneous methods and forecast |
| | sources. Can also house the “actual” amount to compare against “forecast.” |
| | NOTE: This information must be externally supplied by the VENDOR to the |
| | enterprise. It is of great value to compare an enterprise's SALES FORECAST |
| | with it's VENDOR's FORECASTs. Any significant delta indicates potential out |
| | of stock situations. |
| VENDOR ITEM | Identifies which ITEMs can be obtained from which VENDORs. Indicates the |
| | numbering system assigned by the Vendor to the Item, and who is the |
| | Preferred Vendor for the Item. |
| | Note: In some environments this information is created at the Location level - |
| | in that case, Location Id should be added to the PK. |
| VENDOR ITEM COST | Cost information of an ITEM from a given VENDOR. The key structure may |
| | vary as per enterprise requirements. |
| | Typical usage would be to determine the best Vendor to use to supply each |
| | enterprise Location with an Item. |
| | This entity is suitable for high level Supplier “price list” type information. If |
| | more complex Supplier pricing need to be represented (scaled by volume, or |
| | governed by agreement), the richer Item Pricing entity structure should be |
| | used instead. |
| | Note: This Entity is different from the Item Cost entity. Whereas the Item Cost |
| | entity is a running value of all ACTUAL Costs incurred to obtain Items, this |
| | entity exists to provide information on the expected Cost that will be incurred to |
| | obtain Items from different Vendors, often using different destination |
| | Locations. The Item Cost entity is suitable for profitability calculations, while |
| | Vendor Item Cost would not be. |
| VENDOR ITEM SCORE | A relative value, or ‘score’ produced by an ANALYTICAL MODEL after |
| | reviewing business information. This can provide a measure or way to group |
| | and treat ITEMs supplied by VENDORs that the business deals with. |
| | Example: Vendor Items can be ‘scored’ for quality, frequency of purchase, etc. |
| VENDOR LOCATION TERMS | Describes any conditions or terms that may exist between a given VENDOR |
| | and a LOCATION of the enterprise. Used to do auto-replenishment. |
| VENDOR ORDER FEE | Fees and Charges to be paid as part of a Vendor Order other than the per |
| | Item pricing. |
| | Example: Shipping, Handling, Insurance, etc. |
| VENDOR PO COMMENT | This entity relates the VENDOR PO to any associated VENDOR PO |
| | COMMENT. |
| VENDOR PO LINE BACKORDER | This entity identifies the information about VENDOR PURCHASE ORDER |
| | LINEs that have been placed on backorder. Example: on 01/01/2003, a |
| | quantity of 32 of Part Number XYZ123 have been placed on backorder and |
| | were promised to the customer on 02/01/2003. |
| VENDOR PO LINE COMMENT | This entity identifies comments that are associated with a specific VENDOR |
| | PO LINE. |
| VENDOR PO LINE RELATED | This entity relates one VENDOR PO LINE to another. For example, one |
| | VENDOR PO LINE might be broken down into many new lines with smaller |
| | quantities. |
| VENDOR PO LINE RELATED TYPE | This entity indicates the pre-defined reason that two VENDOR PO LINEs are |
| | related. Example: Replaced by, Substituted for, Split into, etc. |
| VENDOR PO LINE STATUS HIST | The entity tracks the various status or condition changes of a Vendor PO Line |
| | over time. |
| VENDOR PO LINE TERM | This entity identifies the terms and/or conditions that are associated with a |
| | VENDOR PO LINE. |
| VENDOR PO PARTY | This entity associates the VENDOR PO to an involved PARTY. For example, |
| | it could identify the ASSOCIATE assigned to manage the order, the planner |
| | assigned to plan the order production, the VENDOR that will be filling the |
| | order, etc. |
| VENDOR PO REASON | Indicates the reason a Status was assigned. |
| VENDOR PO RELATED | This entity allows one VENDOR PO to be related to another. For example, |
| | one VENDOR PO may replace another. |
| VENDOR PO RELATED TYPE | This entity identifies how one VENDOR PO is related to another, such as |
| | Replaced. |
| VENDOR PO STATUS HIST | The entity tracks the various status or condition changes of a VENDOR PO |
| | over time. |
| VENDOR PO TERM | This entity identifies the terms and/or conditions that are associated with a |
| | VENDOR PO. |
| VENDOR PURCHASE ORDER | Represents an order placed by the enterprise for ITEMs to be supplied by the |
| | VENDOR. |
| | Example: Place an order for 50 cases of soda, etc. |
| VENDOR PURCHASE ORDER LINE | The detail line on the VENDOR PURCHASE ORDER that provides information |
| | about the product being ordered. |
| VENDOR RECEIPT | A shipment of ordered goods in transit to, or received by the enterprise from a |
| | VENDOR. |
| VENDOR RECEIPT LINE | Information about a specific ITEM contained in a VENDOR RECEIPT. |
| VENDOR RECEIPT TRAN | Inventory adjustment (positive) made due to the receipt of goods from a |
| | Supplier/Vendor. |
| VENDOR RETURN | ITEMs returned to the VENDOR, due to damage, malfunctioning, etc. of the |
| | ITEM. |
| VENDOR RETURN LINE | Specifies the actual ITEMs returned to the VENDOR, due to damage, |
| | malfunctioning, etc., of the ITEM. |
| VENDOR RETURN TRAN | Inventory adjustment (negative) made due to the return of purchased goods |
| | back to the Supplier/Vendor. |
| VENDOR TYPE | This entity contains one entry for each VENDOR TYPE defined within the |
| | ERP. Predefined VENDOR TYPEs include: Employee, Public Sector |
| | Company, Tax Authority, and Vendor. |
| VISIT | A grouping of transactions generated by the same party at the same location. |
| | Can be thought of as a “Visit” (in person) or a “Session” (by remote channel, |
| | such as web or call center) |
| | The enterprise would have to establish rules for determining the way |
| | transactions are to be grouped together - this is typically done by time, for |
| | example, all transactions with less than 30 minutes elapsed time between |
| | them. |
| | Example: |
| | An unknown visitor browsed our web site today from 12:32 through 13:47. |
| | Jim Y. spends 2 days gambling for at least an hour each day at the |
| | CASINO. |
| | John J. spent 17 minutes today on the phone with our CALL CENTER, |
| | placing catalog orders. |
| | Sharon T. purchased items at the Photo Counter and later bought some |
| | additional items from the Pharmacy totaling 25 minutes visit time. |
| | Larry H. spent 17 minutes today on the phone with our CALL CENTER, |
| | arranging for a pickup order. |
| VISIT FEEDBACK | Feedback received from a PARTY related to a VISIT. |
| VISIT TYPE | Indicates the type of the VISIT. |
| | Example: web visit, store visit, catalog call, etc. |
| VISITOR IDENTIFICATION METHOD | The means by which a Party (visitor) is identified for a Web Visit. There are |
| | three possible values: IP address, cookie, and registered. |
| | Source-> Operational or Transactional DB. |
| VOTING STOCK ACCOUNT | The entity that identifies a common stock dividend equity as a voting stock. |
| | Voting stock equities of a public corporation have voting rights. |
| WAGE AND SALARY ACCT | A category of GL SUB ACCOUNT that indicates Salaries, wages & bonus |
| | compensation expense. |
| WASTAGE TRANSACTION | A Type of Inventory Adjustment Transaction. |
| | A reduction in inventory due to wastage. A known shrinkage to salable item |
| | stock as a result of items being damaged or soiled whereby they cannot be |
| | returned to vendor for credit or sold at heavy markdown, or in the case of |
| | perishables, must be tossed or destroyed as a result of spoilage or falling |
| | outside their approved selling or usage time frame. |
| WAY BILL | The internal record of a SHIPMENT that corresponds to the customer's Bill of |
| | Lading (SHIPMENT). |
| | The default WAY BILL covers exactly 1 SHIPMENT. Structure needs to be |
| | enhanced if multiple SHIPMENTs are to be covered. |
| WAY BILL ADJUSTMENT | Adjustments to the WAY BILL that take place after the original Bill of Lading is |
| | accepted. |
| | Can be for the entire WAY BILL. or a specific WAY BILL LINE. |
| | Examples: |
| | Bad Debt write-off |
| | Incorrect class/pricing code |
| | Incorrect weight. |
| WAY BILL LINE | WAY BILL line item that corresponds to a SHIPMENT LINE ITEM or |
| | SERVICE. Details the amount and type of charge to a customer. |
| WEB AD | A marketing message targeted for specific set of consumers on a web page |
| | Example: ‘Fly AMERICAN banner ad’ on www.yahoo.com |
| WEB AD PLACEMENT | The specifics of where and when a specific WEB AD will be displayed. |
| | Example: Banner Ad #232 (with the animated Poodle) will be displayed on the |
| | AOL ‘Pets’ area during January 2000. |
| WEB AD PLACEMENT STATS | Provides statistics about web ads that are useful in measuring their |
| | effectiveness. These values are usually collected by the ad-agency. |
| | For example, banner ad ‘blue sweater’ on mysite.com has 100 impressions, 20 |
| | clickthroughs over the last month. |
| WEB AD TYPE | A classification scheme used to organize WEB ADs. The classification can be |
| | used to provide summary information about the performance of various WEB |
| | ADs. |
| | For example - premium banner ad, discounted banner ad, keyword related |
| | banner ad. It could also provide information about whether the ad is static or |
| | dynamic (for example - general rotation) OR specify if it is a brand |
| | awareness ad versus an information ad |
| WEB BANNER AD | Marketing messages containing a mix of images and text that is usually hosted |
| | by a third party ORGANIZATION on a WEB PAGE.. |
| | Example: A Fly AeroMexico ad with an AeroMexico logo that links to its web |
| | site. |
| WEB PAGE | A collection of multimedia objects displayed to visitors via use of a web |
| | browsing application during visits to a WEB SITE. A WEB PAGE can contain |
| | product information, marketing information, customer service information. It |
| | can also allow for interaction, in the form of the creation of shopping carts, |
| | orders, etc. These pages are owned by the Enterprise. E SITE models |
| | external web pages. |
| | Example: A DVD Movies category page may consist of a group of images, text |
| | about the image aspect ratio and movie reviews, and information about a |
| | current sale. |
| WEB PAGE GENERATION TYPE | This entity is used to classify the method involved in generating a web page |
| | Example: Static versus dynamic page |
| WEB PAGE MM OBJECT | An associative entity that tracks various objects appearing on a WEB PAGE. |
| | For example: on web page #889243 are found the following objects: Header, |
| | Logo in upper-left hand corner, picture centered, Product Link, and standard |
| | footer bar with links, etc. |
| WEB PAGE VIEW | Web Page View stores the information about the actual WEB PAGEs |
| | displayed to an individual during a given WEB VISIT. |
| | For example: home page-> product page-> casual wear-> sweaters-> |
| | blue sweater. Along with this chain of pages visited information about bytes |
| | transferred, the time stamp when the page was viewed and a host of other |
| | details are stored. |
| WEB SECTION TYPE | This entity represents a classification of the content for a WEB SITE SECTION |
| | similar to sections of a newspaper. A WEB SITE may be divided into several |
| | sections based on the content of the pages. |
| | Example: sports, finance, current news, etc. |
| WEB SERVER | Provides summary information about the physical server devices servicing a |
| | WEB VISIT. |
| | Example: Web Server #3 PRIMERETAIL using port Number 80 with secure |
| | connection, running Apache software located in Time Zone 5 (EST), etc. |
| WEB SERVER ACTIVITY | Provides operational metrics for Web Server. |
| | Example: hits per minute, delay time, number of aborted requests, etc. |
| | Source-> Web Server's Log and Operational Database |
| WEB SERVER SOFTWARE | Captures information about the software being utilized by the Web Server. |
| | Example: Apache, IIS, etc. |
| | Source-> Web Server |
| WEB SERVER STATUS | An entity used to provide information about WEB SERVER status. This |
| | entities contains server codes pertaining to errors and other conditions of the |
| | server. |
| | Example: “401 - Page not Available”, etc. |
| WEB SERVER STATUS CATEGORY | Grouping domain for Web Server Status. |
| | For example: |
| | Unknown |
| | Informational |
| | Successful |
| | Redirection |
| | Client Error |
| WEB SITE | This entity represents a collection of Enterprise-owned WEB PAGES under a |
| | single domain name. External web sites are found under E SITE. |
| | Example: Teradata.com |
| WEB SITE CONTENT TYPE | This entity represents a classification of the content of a WEB SITE |
| | Example: Sports, News, Portal, etc. |
| WEB SITE NAVIGATION | Provides the site map independent of the fact that the pages that instantiate |
| | this structure may change over time. |
| | For example, “Blue suede shoes” page could be part of the “Elvis collection” |
| | class hierarchy or the “Men's Shoes” class hierarchy. And over time, “Blue |
| | suede shoes” could also be part of the “What's hot” class hierarchy. The web |
| | site navigation entity provides a way of showing these changes over time. |
| WEB SITE SECTION | This entity represents divisions of a WEB SITE such as Yahoo Sports or |
| | Yahoo Finance in order to divide large WEB SITES into smaller divisions of |
| | related WEB PAGES that contain similar content. |
| WEB SITE SERVER | Associates the Web Sites that are supported by a Web Server. |
| | Example: Web Site #25 is supported by Web Server #18 with a backup Web |
| | Server #19; Web Site #1 is supported by a server group including Web Server |
| | #8-15, etc. |
| WEB STORE | A sub-type of LOCATION. Allows the enterprise to differentiate between their |
| | web-based activities. This entity is not meant to differentiate between |
| | physical web servers (IP Addresses) - it's more of a logical/business biased |
| | concept. |
| | Example: Frequent flyer Web Store, Travel Specials Web Store, etc. |
| WEB TEXT AD | Marketing messages using text descriptions intended for placement on a WEB |
| | PAGE. |
| | Example: A text message saying ‘Fly Lufthansa’ that is linked to its web site. |
| WEB VISIT | A VISIT during which an internet WEB SITE is accessed by an individual using |
| | the world wide web. |
| WEIGHT BREAK | Entity that represents the break points for one rate charge versus another |
| | based upon weight. |
| | Example: |
| | AMC (absolute minimum charge) |
| | MC (minimum charge) |
| | LSC |
| | SC |
| | 1M |
| | 2M |
| | 5M |
| | 10M |
| | 20M (these last 5 are rates per 100 pounds). |
| WORK SHIFT | Denotes the shift an ASSOCIATE works at a LOCATION, e.g. day, night, |
| | weekdays, weekends nights, etc. |
| WORK SHIFT HOURS | Details the start and duration of a WORK SHIFT by day of week. |
| WORLD REGION | The entity that indicates the WORLD REGION for a country. For example: |
| | APAC (Asia Pacific), EMEA (Europe Middle East Africa), etc. |
| YIELD LEVEL | The level of revenue attained from sale of seats for a flight when compared to |
| | the maximum revenue that could be obtained by selling each seat for its |
| | maximum value. |
| | Example: Low, Medium, High. |

APPENDIX C
Atribute Definitions

| Entity Name | Attribute Name | Attribute Definition | PK | FK |
|---|---|---|---|---|
| ACCOUNT | Account Close Dt | Date on which an ACCOUNT was closed or | No | No |
| | | terminated. | | |
| | Account Expire Dt | The date on which a n ACCOUNT expires. | No | No |
| | | Typically used for accounts that need periodic | | |
| | | renewal, such as CREDIT CARDS. | | |
| | Account Id | Uniquely identifies an ACCOUNT. | Yes | No |
| | Account Name | An optional descriptive Name that can be given to | No | No |
| | | an Account. Typically used for Accounts belonging | | |
| | | to the enterprise. | | |
| | | An example is Disbursement Account. | | |
| | Account Num | The actual account number created by the (3rd | No | No |
| | | party) issuer of the ACCOUNT. Not used as a PK, | | |
| | | since it's beyond the enterprises' control. | | |
| | | Example: Credit card number, checking account | | |
| | | number. | | |
| | Account Open Dt | Date on which an ACCOUNT was opened or | No | No |
| | | established. | | |
| | Account Renew Dt | Date on which an ACCOUNT was renewed (where | No | No |
| | | appropriate). | | |
| | Account Type Cd | The unique identifier for an instance of the | No | Yes |
| | | ACCOUNT TYPE entity. | | |
| | Credit Rating Cd | A code that classifies the credit rating level for this | No | Yes |
| | | PARTY. | | |
| | | Example: 1 = Excellent, 2 = Good, 3 = Slow Pay, | | |
| | | 4 = Poor, etc. | | |
| | Issuing Org Party Id | The unique identifier for an organization. | No | Yes |
| | Primary Liable Party Id | The unique identifier for an individual. | No | Yes |
| | | The principal party responsible for the account. | | |
| ACCOUNT TRANSFER | From Account Id | Uniquely identifies an ACCOUNT. | Yes | Yes |
| | | Source Account. | | |
| | To Account Id | Uniquely identifies an ACCOUNT. | Yes | Yes |
| | | Target Account. | | |
| | Transfer Dttm | The effective date time for the ACCOUNT | Yes | No |
| | | TRANSFER | | |
| | Transfer Qty | The amount of credit/debit units (money or other | No | No |
| | | earnings such as points, mileage) transferred | | |
| | | between ACCOUNTs | | |
| ACCOUNT TYPE | Account Type Cd | The unique identifier for an instance of the | Yes | No |
| | | ACCOUNT TYPE entity. | | |
| | Account Type Desc | Text that describes an instance of the ACCOUNT | No | No |
| | | TYPE entity. | | |
| ACCOUNTING PERIOD MONTH | Accounting Period Month Desc | The description for an ACCOUNTING PERIOD | No | No |
| | | MONTH. | | |
| | Accounting Period Month Id | The unique identifier for an ACCOUNTING | Yes | No |
| | | PERIOD MONTH. | | |
| | Accounting Period Quarter Id | The unique identifier for an ACCOUNTING | No | Yes |
| | | PERIOD QUARTER. | | |
| ACCOUNTING PERIOD MONTH | Accounting Period Mon Wk Desc | The description for an ACCOUNTING PERIOD | No | No |
| WEEK | | MONTH WEEK. | | |
| | Accounting Period Month Id | The unique identifier for an ACCOUNTING | Yes | Yes |
| | | PERIOD MONTH. | | |
| | Accounting Period week Id | The unique identifier for an ACCOUNTING | Yes | Yes |
| | | PERIOD WEEK. | | |
| ACCOUNTING PERIOD | Accounting Period Quarter Desc | The description for an ACCOUNTING PERIOD | No | No |
| QUARTER | | QUARTER. | | |
| | Accounting Period Quarter Id | The unique identifier for an ACCOUNTING | Yes | No |
| | | PERIOD QUARTER. | | |
| | Accounting Period Year Id | The unique identifier for an ACCOUNTING | No | Yes |
| | | PERIOD YEAR. | | |
| ACCOUNTING PERIOD WEEK | Accounting Period Week Desc | The description for an ACCOUNTING PERIOD | No | No |
| | | WEEK. | | |
| | Accounting Period Week Id | The unique identifier for an ACCOUNTING | Yes | No |
| | | PERIOD WEEK. | | |
| ACCOUNTING PERIOD YEAR | Accounting Period Year Desc | The description of the accounting year. | No | No |
| | Accounting Period Year Id | The unique identifier for an ACCOUNTING | Yes | No |
| | | PERIOD YEAR. | | |
| ACCOUNTS PAYABLE | GL Main Account Num | The unique Chart of Account code for the GL | Yes | Yes |
| | | MAIN ACCOUNT. | | |
| ACCOUNTS RECEIVABLE | GL Main Account Num | The unique Chart of Account code for the GL | Yes | Yes |
| | | MAIN ACCOUNT. | | |
| ACCRUED LIABILITY | GL Main Account Num | The unique Chart of Account code for the GL | Yes | Yes |
| ACCOUNT | | MAIN ACCOUNT. | | |
| ACTIVITY PURCHASE ITEM | Purchase Seq Num | An identifier for a specific PURCHASE ITEM | Yes | Yes |
| | | entity. | | |
| | Purchase Tran Id | A unique identifier for this TRAVEL | Yes | Yes |
| | | TRANSACTION. | | |
| ACTIVITY RESERVATION | Activity End Tm | Activity end time | No | No |
| ITEM | | | | |
| | Activity Reservation Dttm | The date for which the activity is reserved | No | No |
| | Activity Start Tm | Activity start time | No | No |
| | Activity Type Cd | Provides codes for various types of activity | No | Yes |
| | | reservations such as spa, dining, golf etc | | |
| | Reservation Seq Num | This attribute identifies a specific RESERVATION | Yes | Yes |
| | | ITEM. | | |
| | Reservation Transaction Id | A unique identifier for this TRAVEL | Yes | Yes |
| | | TRANSACTION. | | |
| ACTIVITY TYPE | Activity Type Cd | Provides codes for various types of activity | Yes | No |
| | | reservations such as spa, dining, golf etc | | |
| | Activity Type Desc | Provides descriptions for various types of activity | No | No |
| | | reservations such as spa, dining, golf, etc | | |
| AD | Ad Agency Party Id | The unique identifier for an organization. | No | Yes |
| | | The Ad agency representing the AD. | | |
| | Ad Cost Amt | The actual cost of an AD. | No | No |
| | Ad Desc | The description of the ad. For instance, NCR logo | No | No |
| | | with a white background and the message | | |
| | | ‘Transforming transactions to relationships’. | | |
| | Ad Id | The unique identifier for an ad. | Yes | No |
| | Ad Type Cd | The code assigned to the type of ad. | No | Yes |
| | Promo Id | The unique identifier for the promotion. | No | Yes |
| AD OBJECT | Ad Id | The unique identifier for an ad. | Yes | Yes |
| | MM Object Id | Unique identifier for a multimedia object. | Yes | Yes |
| AD TYPE | Ad Type Cd | The code assigned to the type of ad. | Yes | No |
| | Ad Type Desc | The description of the type of ad such as Radio, TV | No | No |
| | | or Web. | | |
| ADDRESS | Address Id | A number used to uniquely identify an ADDRESS. | Yes | No |
| | Address Type Cd | A code that uniquely identifies the type of an | No | Yes |
| | | ADDRESS. | | |
| ADDRESS TYPE | Address Type Cd | A code that uniquely identifies the type of an | Yes | No |
| | | ADDRESS. | | |
| | Address Type Desc | A description that describes the type of an | No | No |
| | | ADDRESS. | | |
| ADDRESS USAGE | Address Usage Cd | A code used to uniquely identify the ADDRESS | Yes | No |
| | | USAGE. | | |
| | Address Usage Desc | Text that describes an instance of the ADDRESS | No | No |
| | | USAGE entity. | | |
| | | Example: market to, bill to, ship to, etc | | |
| ADJUSTMENT REASON | Adjust Reason Cd | This attribute describes the reason code for a | Yes | No |
| | | monetary adjustment made to a charge amount. | | |
| | Adjust Reason Desc | This attribute contains the textual description of the | No | No |
| | | reason for a monetary adjustment made to a charge | | |
| | | amount. | | |
| ADJUSTMENT TYPE | Adjust Type Cd | This attribute reflects the type code for a monetary | Yes | No |
| | | adjustment made to a charge amount. | | |
| | Adjust Type Desc | This attribute contains the textual description of the | No | No |
| | | type of monetary adjustment made to a charge | | |
| | | amount. | | |
| ADVERTISING AND | GL Sub Account Num | The unique Chart of Account code for the GL SUB | Yes | Yes |
| PROMOTION ACCT | | ACCOUNT. | | |
| AGREED TERM | Agreement Id | Uniquely identifies an AGREEMENT. | Yes | Yes |
| | Agreement Term Id | Uniquely identifies an Agreement Term. | Yes | Yes |
| | Term End Dt | The final date of the Agreed Term. | No | No |
| | Term Start Dt | The effective date of the Agreed Term. | No | No |
| AGREEMENT | Agreement End Dt | This attribute is the calendar day on which a legal | No | No |
| | | agreement ceases to be effective. | | |
| | Agreement Id | Uniquely identifies an AGREEMENT. | Yes | No |
| | Agreement Name | This attribute is a name or title assigned to the | No | No |
| | | agreement by the enterprise. | | |
| | Agreement Start Dt | This attribute is the calendar day on which a legal | No | No |
| | | agreement becomes effective. | | |
| | Agreement Type Cd | Uniquely identifies the AGREEMENT TYPE. | No | Yes |
| | Replacement Agreement Id | Uniquely identifies an AGREEMENT. | No | Yes |
| | | Identifies the Agreement that replaces or | | |
| | | supersedes this Agreement. | | |
| AGREEMENT FEEDBACK | Agreement Id | Uniquely identifies an AGREEMENT. | Yes | Yes |
| | | The Agreement that prompted the feedback (if | | |
| | | applicable). | | |
| | Feedback Id | Uniquely identifies an instance of Quality | Yes | Yes |
| | | Feedback. Typically system assigned. | | |
| AGREEMENT PRICING | Agreement Id | Uniquely identifies an AGREEMENT. | Yes | Yes |
| | Rate Structure Num | Uniquely identifies a RATE STRUCTURE. | No | Yes |
| AGREEMENT STATUS | Status Cd | Uniquely identifies an Agreement Status. | Yes | No |
| | Status Desc | Textual description of an Agreement Status. | No | No |
| AGREEMENT STATUS HIST | Agreement Id | Uniquely identifies an AGREEMENT. | Yes | Yes |
| | Status Cd | Uniquely identifies an Agreement Status. | Yes | Yes |
| | Status Dt | Effective date of the status change. | Yes | No |
| AGREEMENT TERM | Agreement Term Id | Uniquely identifies an Agreement Term. | Yes | No |
| | Agreement Term Txt | A textual description of an AGREED TERM. | No | No |
| | Agreement Term Type Cd | Uniquely identifies the AGREEMENT TERM | No | Yes |
| | | TYPE. | | |
| | Agreement Term Val | The actual value of the agreement term as defined | No | No |
| | | by the Agreement Term Cd. | | |
| | | Example: for Late Delivery penalty the Agreement | | |
| | | Term Val = 0.5% | | |
| | | Note: This attribute can also be substituted with a | | |
| | | set of attributes representing all the possible | | |
| | | classwords (amt, pct, qty, etc.), of which only one | | |
| | | will be populated per Term. | | |
| AGREEMENT TERM TYPE | Agreement Term Name | A textual name for a Agreement Term Type. | No | No |
| | Agreement Term Type Cd | Uniquely identifies the AGREEMENT TERM | Yes | No |
| | | TYPE. | | |
| | Agreement Term Type Desc | Narrative text describing the Agreement Term | No | No |
| | | Type. | | |
| AGREEMENT TYPE | Agreement Type Cd | Uniquely identifies the AGREEMENT TYPE. | Yes | No |
| | Agreement Type Desc | Narrative text describing the AGREEMENT | No | No |
| | | TYPE. | | |
| AIRCRAFT | Aircraft Registration Num REG | The Aircraft's fully qualified Registration Number | No | No |
| | Aircraft Tail Num DD | The actual Tail Number identification of a specific | No | No |
| | | airplane | | |
| | | Note: It is typically the same value as the Aircraft | | |
| | | Registration Number | | |
| | Equip Id OIN | Uniquely identifies a piece of Equipment that can | Yes | Yes |
| | | be used to transport individuals or cargo. | | |
| AIRLINE | Airline IATA Cd | A code assigned to each AIRLINE by IATA. | No | No |
| | | Currently (2005) 2 characters long | | |
| | | Example: DL, AA, NW, CO, etc. | | |
| | Airline ICAO Cd OPR | A code assigned to each AIRLINE by ICAO | No | No |
| | | (International Civil Aviation Organization) | | |
| | | Currently (2005) 3 characters long | | |
| | | Example: AMX, etc. | | |
| | Airline Num | The numeric identifier assigned to each airline. It | No | No |
| | | is the same number printed on each airlines | | |
| | | respective ticket stock. | | |
| | | Examples: ‘001’, ‘006’ | | |
| | Airline Org Id | The unique identifier for an organization. | Yes | Yes |
| | | Identifies the Organization that provides a Product. | | |
| AIRLINE HUB | Airline Org Id | The unique identifier for an organization. | Yes | Yes |
| | | Identifies the Organization that provides a Product. | | |
| | Enplanement Capacity Qty | The maximum number of passengers possible to | No | No |
| | | fly from this AIRLINE HUB. | | |
| | Flight Capacity Qty | The maximum number of daily departing flights | No | No |
| | | capable from this AIRLINE HUB.. | | |
| | T&T Facility Id | Uniquely identifies a LOCATION. | Yes | Yes |
| | | A Travel and Transportation Facility Location. | | |
| AIRLINE RESERVATION | Flight Product Id | Unique Identifier for an Item. | No | Yes |
| | | A distance based TRAVEL PRODUCT that is | | |
| | | defined by Origination and Destination (O&D), | | |
| | | weekday of departure and time of departure. | | |
| | | An Airline Flight. | | |
| | Reservation Seq Num | This attribute identifies a specific RESERVATION | Yes | Yes |
| | | ITEM. | | |
| | Reservation Transaction Id | A unique identifier for this TRAVEL | Yes | Yes |
| | | TRANSACTION. | | |
| | Sched Seg Depart Dttm | The scheduled departure date and time of a | No | Yes |
| | | SEGMENT. | | |
| | | Note: This departure date and time is usually | | |
| | | identical to the departure date and time of the first | | |
| | | LEG of the SEGMENT. | | |
| AIRLINE TICKET | Initial Conjunction Ind | Indicates if the Ticket is the first ticket in a | No | No |
| | | conjunction ticket series. | | |
| | International Ind | Indicates if the flight will fly domestically (within | No | No |
| | | the country of origin) or Internationally | | |
| | | (destination is another country other than point of | | |
| | | origin). | | |
| | Ticket Id | A unique identifier for a TICKET. | Yes | Yes |
| AIRPORT | Airport Elevation Meas | A physical height measured above sea-level for an | No | No |
| | | airport. In the US this measurement is typically in | | |
| | | feet, such as 5000 feet above sea-level. In the rest | | |
| | | of the world it is measured in meters. | | |
| | Airport IATA Cd REP ARS | The International three letter alphabetic code | No | No |
| | | assigned to each airport by IATA. | | |
| | | Example: ATL, SFO, LHR, LAX, etc. | | |
| | Airport ICAO Cd REP ARS | The International code assigned to each airport by | No | No |
| | | ICAO. | | |
| | | Example: EGLL (London Heathrow), KLAX (Los | | |
| | | Angeles International), etc. | | |
| | Airport Name | The official title or Department of Transportation | No | No |
| | | (DOT) name given to an airport | | |
| | | Note: The enterprise assigned name for the airport | | |
| | | is found in the Location entity (Location Name). | | |
| | | However, if the enterprise always use the official | | |
| | | airport name, this attribute (Airport Name) will be | | |
| | | redundant and can be removed. | | |
| | | Example: | | |
| | | John F. Kennedy International, | | |
| | | Hartsfield International, | | |
| | | Heathrow International, | | |
| | | Charles De Gaulle International, | | |
| | | etc. | | |
| | T&T Facility Id | Uniquely identifies a LOCATION. | Yes | Yes |
| | | A Travel and Transportation Facility Location. | | |
| AIRPORT LOUNGE AWARD | Award Voucher Id | The identifier of a loyalty award or certificate | Yes | Yes |
| | | awarded to a customer account. | | |
| AMORTIZATION METHOD | Amortization Method Cd | A unique code for the AMORTIZATION | Yes | No |
| | | METHOD. Examples may be; cash basis (no | | |
| | | amortization), straight line, declining balance, or | | |
| | | interest method. | | |
| | Amortization Method Desc | A description of the code. | No | No |
| ANALYTICAL MODEL | Model Algorithm Type Cd | A code used to uniquely identify the type of | No | Yes |
| | | technique used for the model algorithm. | | |
| | Model Desc | A description of the model. | No | No |
| | | Example: Propensity of a Customer to buy Item x | | |
| | | if Item y has already been bought; Forecast for | | |
| | | seasonal goods, etc. | | |
| | Model Id | The unique identifier for an instance of the | Yes | No |
| | | ANALYTICAL MODEL entity. | | |
| | Model Name | The name assigned to this model. | No | No |
| | Model Purpose Cd | A code used to uniquely identify the kinds of | No | Yes |
| | | analysis that can be done using the model. | | |
| | Model Source Party Id | The unique identifier for an instance of the PARTY | No | Yes |
| | | entity. | | |
| | Model Status Cd | A code used to uniquely identify the current status | No | Yes |
| | | of the model. | | |
| | Model Type Cd | A code used to uniquely identify the type of model. | No | Yes |
| AP INVOICE | AP Invoice Batch Id | The unique identifier for the general/sub LEDGER | No | Yes |
| | | BATCH processing. | | |
| | AP Invoice COA Id | The unique identifier for a CHART OF | No | Yes |
| | | ACCOUNT, or alias for a complete CHART OF | | |
| | | ACCOUNTs number. | | |
| | AP Invoice Id | A number representing a unique identifier for a | Yes | Yes |
| | | INVOICE. | | |
| | AP Invoice Type Cd | The code assigned to an AP INVOICE TYPE. | No | Yes |
| AP INVOICE EXPENSE | AP Invoice Id | A number representing a unique identifier for a | Yes | Yes |
| | | INVOICE. | | |
| AP INVOICE LINE | AP Invoice Id | A number representing a unique identifier for a | Yes | Yes |
| | | INVOICE. | | |
| | AP Invoice Ln COA Id | The unique identifier for a CHART OF | No | Yes |
| | | ACCOUNT, or alias for a complete CHART OF | | |
| | | ACCOUNTs number. | | |
| | AP Invoice Ln Desc | Provides a description of the AP INVOICE LINE. | No | No |
| | AP Invoice Ln Merchant Doc Num | References a Merchant Document Number, if any, | No | No |
| | | related to the AP INVOICE LINE. Usually a third | | |
| | | party document number used for expense reporting. | | |
| | AP Invoice Ln Num | Uniquely identifies a line item on an Invoice. | Yes | Yes |
| | | The identifier for a specific line on an AP | | |
| | | INVOICE LINE document. | | |
| AP INVOICE LINE AMOUNT | AP Invoice Id | A number representing a unique identifier for a | Yes | Yes |
| | | INVOICE. | | |
| | AP Invoice Ln Amount Dttm | The date and time the AP Invoice Line Amount | Yes | No |
| | | was created. | | |
| | AP Invoice Ln Amount Globl Amt | The monetary value amount associated with an AP | No | No |
| | | Invoice Line in global currency. | | |
| | AP Invoice Ln Amount Local Amt | The monetary value amount associated with an AP | No | No |
| | | Invoice Line in local accounting currency. | | |
| | AP Invoice Ln Amount Trans Amt | The monetary value amount associated with an AP | No | No |
| | | Invoice Line in transaction currency. | | |
| | AP Invoice Ln Num | Uniquely identifies a line item on an Invoice. | Yes | Yes |
| | | The identifier for a specific line on an AP | | |
| | | INVOICE LINE document. | | |
| AP INVOICE LINE PAYMENT | AP Invoice Id | A number representing a unique identifier for a | No | Yes |
| | | INVOICE. | | |
| | AP Invoice line COA Id | The unique identifier for a CHART OF | No | Yes |
| | | ACCOUNT, or alias for a complete CHART OF | | |
| | | ACCOUNTs number. | | |
| | AP Invoice line Payment Amt | Monetary amount associated with an AP INVOICE | No | No |
| | | LINE PAYMENT. | | |
| | AP Invoice Line Payment Num | The identifier for a specific line on an INVOICE | Yes | Yes |
| | | LINE PAYMENT. | | |
| | AP Invoice Ln Num | Uniquely identifies a line item on an Invoice. | No | Yes |
| | | The identifier for a specific line on an AP | | |
| | | INVOICE LINE document. | | |
| | Payment Id | Uniquely identifies a Payment. | Yes | Yes |
| AP INVOICE LINE STATUS | AP Invoice Id | A number representing a unique identifier for a | Yes | Yes |
| ASSIGN | | INVOICE. | | |
| | AP Invoice Line Status Dttm | The date this state of the AP INVOICE LINE | Yes | No |
| | | started. Note that an AP INVOICE LINE Status | | |
| | | can change over time. | | |
| | AP Invoice Line Status Type Cd | Uniquely identifies an Invoice Status. | Yes | Yes |
| | AP Invoice Ln Num | Uniquely identifies a line item on an Invoice. | Yes | Yes |
| | | The identifier for a specific line on an AP | | |
| | | INVOICE LINE document. | | |
| | AP Invoice Ln Status Reason Cd | Uniquely identifies an Invoice Status Reason. | No | Yes |
| | Status Party Id | The unique identifier for any individual or group of | No | Yes |
| | | individuals that is of interest to the enterprise. | | |
| | | In this context, this is the party who is responsible | | |
| | | for this specified AP INVOICE LINE Status. For | | |
| | | example, if the AP INVOICE LINE status is ‘hold’, | | |
| | | this is the ‘held by’ PARTY. If the AP INVOICE | | |
| | | LINE status is ‘release’, this is the ‘released by’ | | |
| | | PARTY. | | |
| AP INVOICE TYPE | AP Invoice Type Cd | The code assigned to an AP INVOICE TYPE. | Yes | No |
| | AP Invoice Type Desc | The description of an AP Invoice Type. | No | No |
| AP RECURRING EXPENSE | AP Invoice Id | A number representing a unique identifier for a | Yes | Yes |
| | | INVOICE. | | |
| AP REIMBURSABLE EXPENSE | AP Invoice Id | A number representing a unique identifier for a | Yes | Yes |
| | | INVOICE. | | |
| APPROVAL STATUS | Approval Status Cd | Unique identifier for an APPROVAL STATUS. | Yes | No |
| | Approval Status Desc | Narrative text describing the APPROVAL | No | No |
| | | STATUS. | | |
| AR COLLECTION ACTIVITY | AR Collect Activity End Dttm | The data and time a AR COLLECTION | No | No |
| | | ACTIVITY ended. | | |
| | AR Collect Activity Party Id | The unique identifier for any individual or group of | No | Yes |
| | | individuals that is of interest to the enterprise. | | |
| | | In this context it is the party who is responsible for | | |
| | | this AR COLLECTION ACTIVITY. | | |
| | | NOTE: If required, will create associative entity to | | |
| | | handle multiple party/roles with the AR | | |
| | | COLLECTION ACTIVITY. | | |
| | AR Collect Activity Ref Num | The reference number that can be uses to identify | No | No |
| | | the specific activity. | | |
| | | For example, a Call Center incident number. | | |
| | AR Collect Activity Start Dttm | The date and time a AR COLLECTION | Yes | No |
| | | ACTIVITY was initiated. | | |
| | AR Collect Activity Txt | Free form text that is captured to further describe | No | No |
| | | the AR COLLECTION ACTIVITY. | | |
| | AR Collect Activity Type Cd | A code for the types of AR collection activities. | Yes | Yes |
| | | For example: collection opened, collection closed, | | |
| | | customer contacted, follow-up call, follow-up | | |
| | | correspondence, refer to supervisor, promised to | | |
| | | pay, payment received, etc. | | |
| | Collection Status Type Cd | A code for the type of COLLECTION STATUS | No | Yes |
| | | TYPE. Examples would be past due 1-30 days, past | | |
| | | due 31-60 days, past due 61-90 days, charged off, | | |
| | | in collections, promised to pay, payment received | | |
| | | or current (not past due). | | |
| | Payment Schedule Id | A number representing a unique identifier for a | Yes | Yes |
| | | PAYMENT SCHEDULE. | | |
| AR COLLECTION ACTIVITY | AR Collect Activity Type Cd | A code for the types of AR COLLECTION | Yes | No |
| TYPE | | ACTIVITYs. | | |
| | | For example: collection opened, collection closed, | | |
| | | customer contacted, follow-up call, follow-up | | |
| | | correspondent, refer to supervisor, promised to pay, | | |
| | | receipt received, etc. | | |
| | AR Collect Activity Type Desc | A description of the code. | No | No |
| AR INVOICE | AR Invoice COA Id | The unique identifier for a CHART OF | No | Yes |
| | | ACCOUNT, or alias for a complete CHART OF | | |
| | | ACCOUNTs number. | | |
| | AR Invoice Customer PO Num | Reference to the customer's purchase order number | No | No |
| | | to link an AR INVOICE to the customer's request | | |
| | | to purchase item(s). If a purchase order number | | |
| | | did not exist in the source system then the value of | | |
| | | this field is ‘No Purchase Order’. | | |
| | AR Invoice GL Batch Id | The unique identifier for the general/sub LEDGER | No | Yes |
| | | BATCH processing associated with an INVOICE. | | |
| | AR Invoice Id | A number representing a unique identifier for an | Yes | Yes |
| | | AR INVOICE. | | |
| | AR Invoice Reason Type Cd | The code indicates why the INVOICE was created | No | Yes |
| | | such as, free product, cancellation, etc. | | |
| | AR Invoice Type Cd | A unique code assigned to an AR INVOICE | No | Yes |
| | | TYPE. | | |
| AR INVOICE LINE | AR Inv Line Actual Ship Dttm | The actual date the item shipped. | No | No |
| | AR Inv Line COA Id | The unique identifier for a CHART OF | No | Yes |
| | | ACCOUNT, or alias for a complete CHART OF | | |
| | | ACCOUNTs number. | | |
| | AR Inv Line Description Txt | Description of item on AR INVOICE LINE. If no | No | No |
| | | description was entered then the value of this field | | |
| | | is ‘No Description’. | | |
| | AR Inv Line Num | A number representing a unique identifier for an | Yes | No |
| | | AR INVOICE LINE. | | |
| | AR Inv Line Type Cd | Defines the type of AR INVOICE LINE. | No | Yes |
| | | Examples: “Chargeback”, “Charges”, “Freight”, | | |
| | | “Line”, “DM-Reversal”, and “Tax”. | | |
| | AR Inv Line Waybill Num | The shipping number. If the INVOICE doesn't | No | No |
| | | have a shipping number then the value is N/A. | | |
| | AR Invoice Id | A number representing a unique identifier for an | Yes | Yes |
| | | AR INVOICE. | | |
| | Host Invoice Line Num | Line number of the INVOICE. | No | No |
| AR INVOICE LINE AMOUNT | AR Inv Line Amount Dttm | The date and time the AR INVOICE LINE | No | No |
| | | AMOUNT was created. | | |
| | AR Inv Line Amount Global Amt | The amount related to the specified AR INVOICE | No | No |
| | | LINE and the invoice amount type code. | | |
| | | In global currency. | | |
| | AR Inv Line Amount Local Amt | The amount related to the specified AR INVOICE | No | No |
| | | LINE and the invoice amount type code. | | |
| | | In the local accounting currency. | | |
| | AR Inv Line Amount Trans Amt | The amount related to the specified AR INVOICE | No | No |
| | | LINE and the invoice amount type code. | | |
| | | In transaction currency. | | |
| | AR Inv Line Amount Type Cd | The code for the type of INVOICE AMOUNT | Yes | Yes |
| | | TYPE. | | |
| | | Examples are: | | |
| | | Invoice original amount | | |
| | | Unit price | | |
| | | Invoice total amount | | |
| | | Freight invoice total amount | | |
| | | Tax amount | | |
| | | Discount amount | | |
| | | Paid amount | | |
| | | Unpaid amount | | |
| | | etc. | | |
| | AR Inv Line Num | A number representing a unique identifier for an | Yes | Yes |
| | | AR INVOICE LINE. | | |
| | AR Invoice Id | A number representing a unique identifier for an | Yes | Yes |
| | | AR INVOICE. | | |
| AR INVOICE LINE QUANTITY | AR Inv Line Num | A number representing a unique identifier for an | Yes | Yes |
| | | AR INVOICE LINE. | | |
| | AR Inv Line Quantity UOM Cd | Uniquely identifies a unit of measure. | No | Yes |
| | | The code assigned to the unit of measure for the | | |
| | | AR INVOICE LINE QUANTITY. | | |
| | AR Invoice Id | A number representing a unique identifier for an | Yes | Yes |
| | | AR INVOICE. | | |
| | AR Invoice Line Quantity Qty | The number of items credited, invoiced or ordered | No | No |
| | | on this AR INVOICE LINE. | | |
| | Invoice Quantity Type Cd | Assigns a code to INVOICE QUANTITY TYPEs. | Yes | Yes |
| | | For example, credited, invoiced and ordered. | | |
| AR INVOICE LINE RECEIPT | AR Inv Line Num | A number representing a unique identifier for an | No | Yes |
| | | AR INVOICE LINE. | | |
| | AR Invoice Id | A number representing a unique identifier for an | No | Yes |
| | | AR INVOICE. | | |
| | AR Invoice Line Payment Num | The identifier for a specific line on an INVOICE | Yes | Yes |
| | | LINE PAYMENT. | | |
| | AR Invoice line Receipt Amt | Monetary amount associated with an AR INVOICE | No | No |
| | | LINE RECEIPT. | | |
| | Chart Of Account Id | The unique identifier for a CHART OF | No | Yes |
| | | ACCOUNT, or alias for a complete CHART OF | | |
| | | ACCOUNTs number. | | |
| | Payment Id | Uniquely identifies a Payment. | Yes | Yes |
| AR INVOICE LINE TYPE | AR Invoice Line Type Cd | Key column that uniquely identifies the row in AR | Yes | No |
| | | INVOICE LINE TYPE. | | |
| | AR Invoice Line Type Desc | Long description of the AR INVOICE LINE | No | No |
| | | TYPE. | | |
| | AR Invoice Line Type Name | The short meaning of the AR INVOICE LINE | No | No |
| | | TYPE. | | |
| AR INVOICE REASON TYPE | AR Invoice Reason Type Cd | The code indicates why the INVOICE was created | Yes | No |
| | | such as, free product, cancellation, etc. See entity | | |
| | | definition for more examples. | | |
| | AR Invoice Reason Type Desc | A description of the code. | No | No |
| AR INVOICE TYPE | AR Invoice Type Cd | A unique code assigned to an AR INVOICE | Yes | No |
| | | TYPE. | | |
| | AR Invoice Type Desc | The description of the AR INVOICE TYPE code. | No | No |
| | AR Invoice Type Name | A short name for AR INVOICE TYPE. Ex. | No | No |
| | | “Invoice”, “Invoice-Local”, “Invoice-State”, | | |
| | | “Projects Credit Memo”. | | |
| ASN | ASN Id | Uniquely identifies an Advance Shipping Notice. | Yes | No |
| | ASN Ship Dttm | The Shipping date and time according to the ASN. | No | No |
| | | Depending on the environment, this may or may | | |
| | | not be identical to the actual Shipping date and | | |
| | | time. | | |
| | Shipment Num | Uniquely identifies a SHIPMENT. | No | Yes |
| | Transmit Dttm | The date and time the ASN was transmitted. | No | No |
| ASSET | Asset Desc | The description of an ASSET. | No | No |
| | Asset Id | A sequence of digits used to identify a VEHICLE | Yes | No |
| | | ASSET. | | |
| | Asset Type Cd | A code that uniquely identifies a VEHICLE | No | Yes |
| | | ASSET. | | |
| ASSET ACCOUNT | Asset Account Type Cd | The unique code assigned to the ASSET | No | Yes |
| | | ACCOUNT TYPE. | | |
| | GL Main Account Num | The unique Chart of Account code for the GL | Yes | Yes |
| | | MAIN ACCOUNT. | | |
| ASSET ACCOUNT TYPE | Asset Account Type Cd | The unique code assigned to the ASSET | Yes | No |
| | | ACCOUNT TYPE. | | |
| | Asset Account Type Desc | The description of ASSET ACCOUNT TYPE. | No | No |
| ASSET TYPE | Asset Type Cd | A code that uniquely identifies a VEHICLE | Yes | No |
| | | ASSET. | | |
| | Asset Type Desc | Textual description of a VEHICLE ASSET. | No | No |
| ASSOCIATE | Assoc Hire Dt | The date on which the associate was hired. | No | No |
| | Assoc HR Num | The number that was assigned to the ASSOCIATE | No | No |
| | | by the enterprise's HR Department. | | |
| | Assoc Termination Dt | The date the associate was terminated from | No | No |
| | | employment. | | |
| | Associate Party Id | An individual who is employed by the enterprise. | Yes | Yes |
| | Location Id | Uniquely identifies a LOCATION. | No | Yes |
| | | The associate's primary location of work. | | |
| | Manager Associate Id | An individual who is employed by the enterprise. | No | Yes |
| | | The associate's manager. | | |
| | Position Id | Unique identifier for an ASSOCIATE POSITION. | No | Yes |
| ASSOCIATE BENEFIT EXPENSE | Associate Expns Type Cd | Uniquely identifies an ASSOCIATE EXPENSE | Yes | Yes |
| | | TYPE. | | |
| | Associate Party Id | An individual who is employed by the enterprise. | Yes | Yes |
| | Benefit Cost Amt | The cost of the benefit given to an ASSOCIATE | No | No |
| | | for a specific ASSOCIATE EXPENSE TYPE, for a | | |
| | | specific time period, within a specific LOCATION | | |
| | | and/or DEPARTMENT of a STORE. | | |
| | Benefit Hours Qty | The total benefit hours for an ASSOCIATE for a | No | No |
| | | specific ASSOCIATE EXPENSE TYPE, for a | | |
| | | specific time period, within a specific LOCATION | | |
| | | and/or DEPARTMENT of a STORE. | | |
| | Period End Dt | The date on which the expense period ends. | Yes | Yes |
| ASSOCIATE EXPENSE HIST | Associate Expns Type Cd | Uniquely identifies an ASSOCIATE EXPENSE | Yes | Yes |
| | | TYPE. | | |
| | Associate Party Id | An individual who is employed by the enterprise. | Yes | Yes |
| | Expense Location Id | Uniquely identifies a LOCATION where associate | No | Yes |
| | | expenses are incurred, or allocated to. Optional. | | |
| | Period End Dt | The date on which the expense period ends. | Yes | No |
| | Period Start Dt | The date on which the expense period begins. | No | No |
| | Position Id | Unique identifier for an ASSOCIATE POSITION. | No | Yes |
| ASSOCIATE EXPENSE TYPE | Assoc Expns Type Desc | Narrative text describing the ASSOCIATE | No | No |
| | | EXPENSE TYPE. | | |
| | Associate Expns Type Cd | Uniquely identifies an ASSOCIATE EXPENSE | Yes | No |
| | | TYPE. | | |
| ASSOCIATE LABOR EXPENSE | Associate Expns Type Cd | Uniquely identifies an ASSOCIATE EXPENSE | Yes | Yes |
| | | TYPE. | | |
| | Associate Party Id | An individual who is employed by the enterprise. | Yes | Yes |
| | Labor Cost Amt | The total cost of the hours worked by an | No | No |
| | | ASSOCIATE for a specific ASSOCIATE | | |
| | | EXPENSE TYPE, for a specific time period, | | |
| | | within a specific LOCATION and/or | | |
| | | DEPARTMENT of a STORE. | | |
| | Labor Hours Qty | The total hours worked by an ASSOCIATE for a | No | No |
| | | specific ASSOCIATE EXPENSE TYPE, for a | | |
| | | specific time period, within a specific LOCATION | | |
| | | and/or DEPARTMENT of a STORE. | | |
| | Period End Dt | The date on which the expense period ends. | Yes | Yes |
| ASSOCIATE POSITION | Job Classification Cd EPT | Uniquely identifies a JOB CLASSIFICATION. | No | Yes |
| | Overtime Rate Pct | A percentage used to calculate the overtime wage | No | No |
| | | rate amount for an ASSOCIATE. | | |
| | | Example: An Associate works overtime at a rate of | | |
| | | 150 percent. | | |
| | Position Desc | Narrative text describing the ASSOCIATE | No | No |
| | | POSITION. | | |
| | Position Grade Cd | Uniquely identifies a POSITION GRADE. | No | Yes |
| | Position Id | Unique identifier for an ASSOCIATE POSITION. | Yes | No |
| | Position Type Cd | Uniquely identifies a POSITION TYPE. | No | Yes |
| | Wage Rate Amt | The rate at which the ASSOCIATE wages are paid. | No | No |
| | Wage UOM Cd | Uniquely identifies a unit of measure. | No | Yes |
| | | The frequency of Wage Rate payments (hour, bi- | | |
| | | weekly, annual, etc.) | | |
| ASSOCIATE QUALIFICATION | Associate Party Id | An individual who is employed by the enterprise. | Yes | Yes |
| | Certification Cd | Uniquely identifies a Certification. | Yes | Yes |
| | Certification Dt | The Date on which the certification was obtained. | Yes | No |
| | Certification Num | Captures the unique certification number associated | No | No |
| | | with this Certification for this Associate (if | | |
| | | applicable). | | |
| | | Example: | | |
| | | State issued badge number for Casino | | |
| | | employee. | | |
| | Certifying Party Id | The unique identifier for any individual or group of | No | Yes |
| | | individuals that is of interest to the enterprise. | | |
| | | The Party the qualification was obtained from, or | | |
| | | who issued the Certification. | | |
| AUDIT TRANSACTION | Inv Tran Id | Uniquely identifies an inventory transaction. | Yes | Yes |
| AVAILABLE CASH ACCOUNT | GL Main Account Num | The unique Chart of Account code for the GL | Yes | Yes |
| | | MAIN ACCOUNT. | | |
| AWARD | Award Cd | A code that uniquely identifies an AWARD | Yes | No |
| | | CERTIFICATE. | | |
| | Award Cost Amt | The equivalent currency amount associated with | No | No |
| | | this Loyalty Award. Typically this is for internal | | |
| | | use only (to aid in profitability calculations) and | | |
| | | will not be revealed to the ACCOUNT holders | | |
| | | earning the Loyalty Awards. | | |
| | | Can also be seen as the Liability amount to the | | |
| | | enterprise (a promise to provide a benefit at a | | |
| | | future date) | | |
| | Award Desc | Textual description of an AWARD | No | No |
| | | CERTIFICATE. | | |
| | Award Max Value Amt | Specifies the maximum “retail” value of the award | No | No |
| | | to the customer. This would also be the perceived | | |
| | | “taxable income” for the customer in some cases. | | |
| | | Example: | | |
| | | 100 Euro Dinner award | | |
| | | Note: Less applicable on Awards like “one class | | |
| | | domestic flight (or hotel room) upgrade)” | | |
| | Award Type Cd | A unique identifier of the type of award earned | No | Yes |
| | | and/or requested by the account owner. | | |
| | Travel Product Id | Unique Identifier for an Item. | No | Yes |
| | | A Travel-related offer available for sale to a | | |
| | | PARTY(s). | | |
| | | This attribute is used if the award has a formal Item | | |
| | | or Product ID. | | |
| AWARD TYPE | Award Type Cd | A unique identifier of the type of award earned | Yes | No |
| | | and/or requested by the account owner. | | |
| | Award Type Desc | A brief explanation of the type of award earned and | No | No |
| | | requested by the account owner. | | |
| AWARD VOUCHER | Award Cd | A code that uniquely identifies an AWARD | No | Yes |
| | | CERTIFICATE. | | |
| | Award Expire Dt | The date when the Award expires if not used. | No | No |
| | Award Valid Dt | The date from which the Award is valid. | No | No |
| | Award Voucher Id | The identifier of a loyalty award or certificate | Yes | No |
| | | awarded to a customer account. | | |
| | Event Dttm | The date and time that a loyalty event occurred | No | Yes |
| | Loyalty Account Id | Uniquely identifies an ACCOUNT. | No | Yes |
| | Promo Offer Id | The unique identifier for an instance of the OFFER | No | Yes |
| | | entity. | | |
| | | Identifies the promotional OFFER that was | | |
| | | responsible for the Loyalty Award (if present). | | |
| | | Example: Customer received a free companion | | |
| | | ticket for flying a newly promoted route a certain | | |
| | | number of times. | | |
| BAGGAGE CHECK | Baggage Damage Ind | Indicates if the checked baggage/luggage incurred | No | No |
| | | damage while being handled by TRAVEL | | |
| | | PROVIDER personal or machinery. | | |
| | Baggage Misplaced Ind | Indicates if the checked item was temporarily lost | No | No |
| | | or misplaced, but later recovered. | | |
| | Checked Baggage Weight Meas | The amount of weight associated with the baggage | No | No |
| | | item(s). | | |
| | Claim Check Id | The claim check number assigned to an item of | No | No |
| | | baggage/luggage at check-in. | | |
| | Incurred Liability Amt | Indicates the monetary amount of loss incurred by | No | No |
| | | the customer related to lost or damaged baggage/ | | |
| | | luggage. | | |
| | Lost Baggage Ind | Indicates if the checked item was permanently lost | No | No |
| | | by the airline. | | |
| | Trip Event Num | A unique number assigned to a TRIP EVENT | Yes | Yes |
| | | entity. | | |
| BAL SHEET GL MAIN | Bal Sheet GL Main Acct Cd | The unique code used as a sub-type discriminator | Yes | No |
| ACCOUNT TYPE | | to classify the BALANCE SHEET GL MAIN | | |
| | | ACCOUNT type. | | |
| | Bal Sheet GL Main Acct Desc | The description of the BALANCE SHEET GL | No | No |
| | | MAIN ACCOUNT Type. | | |
| BALANCE SHEET GL MAIN | Bal Sheet GL Main Acct Cd | The unique code used as a sub-type discriminator | No | Yes |
| ACCOUNT | | to classify the BALANCE SHEET GL MAIN | | |
| | | ACCOUNT type. | | |
| | GL Main Account Num | The unique Chart of Account code for the GL | Yes | Yes |
| | | MAIN ACCOUNT. | | |
| BANK DRAFT | Bank Draft Amt | The monetary amount specified on the BANK | No | No |
| | | DRAFT to be paid to the PARTY specified on the | | |
| | | BANK DRAFT. | | |
| | Bank Draft Cleared Dttm | The date and time a financial institution processed | No | No |
| | | the BANK DRAFT document for a PAYMENT | | |
| | | ACCOUNT. | | |
| | Bank Draft Create Dttm | The date and time a Bank Draft Num document | No | No |
| | | was created. | | |
| | Bank Draft Id | The primary key to the BANK DRAFT entity. | Yes | No |
| | Bank Draft Num | Bank Draft Num is the document number for | No | No |
| | | BANK DRAFT, or draft from a PAYMENT | | |
| | | ACCOUNT to be applied to an INVOICE. | | |
| | Payment Account Id | Uniquely identifies an ACCOUNT. | No | Yes |
| BANQUET EVENT | Group Event Id | A unique identifier for the GROUP EVENT | Yes | Yes |
| | Menu Id | Uniquely identifies an ITEM GROUP. | No | Yes |
| | | The item group to which the object may refer. This | | |
| | | attribute is considered to be mutually exclusive | | |
| | | with Item Id. | | |
| | | Uniquely identifies a Menu. | | |
| | | Defines the special (typically, limited) Menu used | | |
| | | to order from for this event. | | |
| BOARDING DENIED | Compensation Amt | A monetary amount paid to compensate a | No | No |
| | | passenger. | | |
| | Denied Reason Cd | Code associated with a Denied Boarding, i.e. | No | Yes |
| | | 1 = Mechanical, 2 = Overbooked, etc. | | |
| | Trip Event Num | A unique number assigned to a TRIP EVENT | Yes | Yes |
| | | entity. | | |
| | Voluntary Ind | Indicates if a denied boarding was voluntary or | No | No |
| | | non-voluntary | | |
| BOARDING EVENT | Assigned Seat Num | The seat number assigned to every single | No | No |
| | | passenger. | | |
| | Gate Num | The airport terminal gate at which a PARTY is | No | No |
| | | suppose to board the aircraft. This is associated | | |
| | | with the BOARDING EVENT entity and is | | |
| | | determined by the scheduled flight printed on the | | |
| | | purchased TRAVEL COUPON. | | |
| | Trip Event Num | A unique number assigned to a TRIP EVENT | Yes | Yes |
| | | entity. | | |
| BOOKING CLASS | Booking Class Cd | The booking class code associated with this | Yes | No |
| | | particular booking, (i.e. F, Y, M, etc.). | | |
| | Booking Class Desc | The description of the booking class associated | No | No |
| | | with this particular booking | | |
| | Service Class Cd | The unique identifier of a specific CLASS OF | No | Yes |
| | | SERVICE offered by a TRAVEL PROVIDER. | | |
| | Yield Level Cd | A unique code that identifies the yield level | No | Yes |
| BORDER EVENT | Broker Party Id | The unique identifier for any individual or group of | No | Yes |
| | | individuals that is of interest to the enterprise. | | |
| | | The Party retained by the Enterprise to facilitate | | |
| | | Customs Clearance. | | |
| | Ship Event Id | Uniquely identifies a SHIPPING EVENT. | Yes | Yes |
| BRAND | Brand Cd | Uniquely identifies a BRAND. | Yes | No |
| | Brand Name | Short text reference or label for a BRAND. | No | No |
| | Brand Party Id | The unique identifier for a Business. | No | Yes |
| | | Uniquely defines a BRAND OWNER | | |
| | | ORGANIZATION. | | |
| BRAND OWNER ORG | Brand Party Id | The unique identifier for a Business. | Yes | Yes |
| | | Uniquely defines a BRAND OWNER | | |
| | | ORGANIZATION. | | |
| BROWSE | Browse Tran Id | A unique identifier for this TRAVEL | Yes | Yes |
| | | TRANSACTION. | | |
| BROWSE ITEM | Browse Seq Num | This attribute identifies a specific BROWSE | Yes | No |
| | | ITEM. | | |
| | Browse Tran Id | A unique identifier for this TRAVEL | Yes | Yes |
| | | TRANSACTION. | | |
| | Travel Product Id | Unique Identifier for an Item. | No | Yes |
| | | A Travel-related offer available for sale to a | | |
| | | PARTY(s). | | |
| BROWSER APPLICATION | Browser Application Cd | Uniquely identifies the type of web browser | Yes | No |
| | | application being used. | | |
| | Browser Application Name | The Name of the Web Browser application. | No | No |
| BROWSER ID | Browser Application Cd | Uniquely identifies the type of web browser | No | Yes |
| | | application being used. | | |
| | Browser Application Ver Num | The release version of the web browser application | No | Yes |
| | | being used. | | |
| | Browser Id | The unique identifier for a specific web browser | Yes | No |
| | | installed on a specific piece of hardware. Probably | | |
| | | a cookie ID. | | |
| | Connect Method Cd | The technology used to connect to the internet. | No | No |
| | Hardware Type Cd | Code that identifies the type of computer hardware | No | No |
| | | being used | | |
| | Operating System Cd | Code that identifies the computer operating system | No | Yes |
| | | being used | | |
| BOWSER VERSION | Browser Application Cd | Uniquely identifies the type of web browser | Yes | Yes |
| | | application being used. | | |
| | Browser Application Ver Num | The release version of the web browser application | Yes | No |
| | | being used. | | |
| BUS | Equip Id OIN | Uniquely identifies a piece of Equipment that can | Yes | Yes |
| | | be used to transport individuals or cargo. | | |
| BUS DEPOT | T&T Facility Id | Uniquely identifies a LOCATION. | Yes | Yes |
| | | A Travel and Transportation Facility Location. | | |
| BUS ORGANIZATION | Bus Org Id | The unique identifier for an external organization. | Yes | Yes |
| | | Identifies the Organization that provides a Product. | | |
| BUS PRODUCT | Bus Product Id | Unique Identifier for an Item. | Yes | Yes |
| | | A distance based TRAVEL PRODUCT that is | | |
| | | defined by Origination and Destination (O&D), | | |
| | | weekday of departure and time of departure. | | |
| | | A bus trip. | | |
| BUS TICKET | Ticket Id | A unique identifier for a TICKET. | Yes | Yes |
| BUSINESS | Business Legal Class Cd | A code representing the type of business from a | No | Yes |
| | | legal perspective. | | |
| | Business Party Id | The unique identifier for a Business. | Yes | Yes |
| | CAGE Cd MFR ROC SPL | Commercial and Government Entity (CAGE) Code | No | Yes |
| | | is a 5 digit code that identifies companies doing or | | |
| | | wishing to do business with the (United States) | | |
| | | Federal Government. Typically the codes, | | |
| | | administered by Defense Logistics Information | | |
| | | Service, includes U.S., Canadian and NATO | | |
| | | CAGE Codes. | | |
| | | Note: This example is specific to the U.S. The | | |
| | | non-US equivalent is the NATO NSCM Code. | | |
| | Duns Id | Dun & Bradstreet information pertaining to a | No | Yes |
| | | particular business. | | |
| | NSCM Cd MFR ROC SPL | The NSCM Code (NATO Supply Code for | No | Yes |
| | | Manufacturers) is a code used to identify non-U.S. | | |
| | | Supply companies. (CAGE is the US Equivalent). | | |
| BUSINESS CONTACT | Business Contact Id | The unique identifier for an individual. | Yes | Yes |
| | | The person who serves as contact point for the | | |
| | | event. | | |
| | Business Party Id | The unique identifier for a Business. | No | Yes |
| | | The Group Client. | | |
| BUSINESS LEGAL | Business Legal Class Cd | A code representing the type of business from a | Yes | No |
| CLASSIFICATION | | legal perspective. | | |
| | Business Legal Class Desc | A textual description of a legal classification for a | No | No |
| | | business. | | |
| BUSINESS NAICS | Business Party Id | The unique identifier for a Business. | Yes | Yes |
| | NAICS Cd | A six digit code for the North American Industry | Yes | Yes |
| | | Classification System. NAICS was developed | | |
| | | jointly by the U.S., Canada, and Mexico to provide | | |
| | | new comparability in statistics about business | | |
| | | activity across North America. | | |
| | Primary NAICS Ind | The indicator for whether or not the NAICS code | No | No |
| | | for the business is the primary NAICS code. | | |
| BUSINESS SIC | Business Party Id | The unique identifier for a Business. | Yes | Yes |
| | Primary SIC Ind | The indicator for whether or not the SIC code for | No | No |
| | | the business is the primary SIC code. | | |
| | SIC Cd | A code for the Standard Industry Classification | Yes | Yes |
| | | which is a method for classifying businesses by the | | |
| | | type of business they are active in, such as services | | |
| | | or manufacturing. | | |
| BUYER | Buyer Associate Id | An individual who is employed by the enterprise. | Yes | Yes |
| | | An ASSOCIATE whose duty it is to make | | |
| | | purchasing and planning decisions for a group of | | |
| | | ITEMs. | | |
| CAGE | CAGE Cd MFR ROC SPL | Commercial and Government Entity (CAGE) Code | Yes | No |
| | | is a 5 digit code that identifies companies doing or | | |
| | | wishing to do business with the (United States) | | |
| | | Federal Government. Typically the codes, | | |
| | | administered by Defense Logistics Information | | |
| | | Service, includes U.S., Canadian and NATO | | |
| | | CAGE Codes. | | |
| | | Note: This example is specific to the U.S. The | | |
| | | non-US equivalent is the NATO NSCM Code. | | |
| | CAGE Name | The Name assigned to the CAGE Party. | No | No |
| CALENDAR DATE | Accounting Period Month Id | The unique identifier for an ACCOUNTING | No | Yes |
| | | PERIOD MONTH. | | |
| | Accounting Period Week Id | The unique identifier for an ACCOUNTING | No | Yes |
| | | PERIOD WEEK. | | |
| | Calendar Dt | A unique calendar date that is recognized by an | Yes | No |
| | | organization. | | |
| | Date Comment Txt | A textual comment about a particular CALENDAR | No | No |
| | | DATE instance. | | |
| | Day of Month Num DD | A specific day of the month in a calendar. | No | No |
| | Day Of Week Num | Uniquely identifies the day of the week (1-7) | No | Yes |
| | Day of Year Num | Indicates a particular day in the year, from 1 to | No | No |
| | | 365/6. | | |
| | Julian Day Num | The CALENDAR DATE represented in Julian | No | No |
| | | notation. A number representing a date. It is a | | |
| | | count of the days since a fixed point in time long | | |
| | | ago (i.e. January 1, 4713 B.C. of the Gregorian | | |
| | | calendar). By subtracting the Julian dates for two | | |
| | | actual dates, you can get the number of days | | |
| | | between those dates. | | |
| | | Example: | | |
| | | Julian date or day number for Jan. 9, 2001 | | |
| | | would be 2451919. | | |
| | Reporting Week Id | The unique identifier for REPORTING WEEK. | No | Yes |
| CALL CENTER | Call Ctr Loc Id | Uniquely identifies a LOCATION. | Yes | Yes |
| | | A call center used to receive and manage customer | | |
| | | calls regarding customer service, catalog sales, etc. | | |
| CAMPAIGN | Campaign Desc | Text that describes a campaign. | No | No |
| | Campaign End Dt | Date on which a campaign ends. | No | No |
| | Campaign Id | The unique identifier for a campaign. | Yes | No |
| | Campaign Start Dt | The date on which a campaign starts. | No | No |
| | Campaign Strategy Cd | A code used to uniquely identify a business | No | Yes |
| | | objective or strategy of a Campaign. | | |
| | Owner Org Party Id | The unique identifier for an organization. | No | Yes |
| | | Allows for the capture of third party (external) | | |
| | | Campaigns. | | |
| | | Example: Competitor Campaigns. | | |
| CAMPAIGN STRATEGY | Campaign Strategy Cd | A code used to uniquely identify a business | Yes | No |
| | | objective or strategy of a Campaign. | | |
| | Campaign Strategy Desc | Textual description of a Campaign Strategy. | No | No |
| CANCELLED CNX | Destination Facility Id | Uniquely identifies a LOCATION. | Yes | Yes |
| | Flight Num DFN | A unique identifier assigned to a Flight scheduled | Yes | Yes |
| | | for generating revenue and utilized by the general | | |
| | | public. | | |
| | Leg Incident Num | Allows uniqueness of incidents within a | Yes | Yes |
| | | SCHEDULED LEG. | | |
| | | Note: This will allow multiple incidents of the | | |
| | | same type to occur for a given scheduled leg. | | |
| | Origin Facility Id | Uniquely identifies a LOCATION. | Yes | Yes |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| CAPACITY MEASURE | Capacity Measure Cd | Uniquely defines a Capacity Measure | Yes | No |
| | Capacity Measure Desc | Textual description for the Capacity Measure | No | No |
| CAR RENTAL ORGANIZATION | Car Rental Org Id | The unique identifier for an external organization. | Yes | Yes |
| | | Identifies the Organization that provides a Product. | | |
| CAR RENTAL RESERVATION | Reservation Seq Num | This attribute identifies a specific RESERVATION | Yes | Yes |
| | | ITEM. | | |
| | Reservation Transaction Id | A unique identifier for this TRAVEL | Yes | Yes |
| | | TRANSACTION. | | |
| CARGO CAPACITY | Capacity Measure Cd | Uniquely defines a Capacity Measure | Yes | Yes |
| | Cargo Capacity Meas | Specifies the quantity measure for the Capacity | No | No |
| | | metric. | | |
| | Cargo Config Id | Uniquely identifies a Cargo Configuration. | Yes | Yes |
| | UOM Cd | Uniquely identifies a unit of measure. | No | Yes |
| CARGO CONFIG | Cargo Config Id | Uniquely identifies a Cargo Configuration. | Yes | No |
| | Equipment Model Cd AMC AET | A model code for a piece of equipment - typically | No | Yes |
| | | provided by the Manufacturer. | | |
| | Manuf Party Id | The unique identifier for a Business. | No | Yes |
| | | Party that manufactures goods, equipment, etc. | | |
| CARGO CONTAINER CONFIG | Cargo Config Id | Uniquely identifies a Cargo Configuration. | Yes | Yes |
| | Container Class Cd | Uniquely defines a Container Class. | Yes | Yes |
| | Container Qty | The number of containers fitting in this version of | No | No |
| | | the configuration. | | |
| | Version Num | Indicates a specific combination of Containers | Yes | No |
| | | fitting within the same Configuration space. | | |
| CARGO SHIPMENT | BOL Num | Bill of Lading - the primary source document from | No | No |
| | | where all detailed information about a shipment | | |
| | | comes. This is a Shipper (customer) assigned | | |
| | | identifier. | | |
| | Carrier Party Id | The unique identifier for any individual or group of | No | Yes |
| | | individuals that is of interest to the enterprise. | | |
| | | Indicates the overall responsible Carrier. Useful | | |
| | | when multiple Carriers are involved in transporting | | |
| | | a Shipment. (See Trip and Trip Leg information for | | |
| | | Leg specific Carrier information) | | |
| | COD Amt | Cash On Delivery amount to be collected by the | No | No |
| | | CARRIER from the Receiver on behalf of the | | |
| | | Shipper. | | |
| | Commit Delivery Dttm | Date and time the carrier commits to deliver the | No | No |
| | | Shipment. | | |
| | | Note: See the SHIPPING PLAN Subject Area for | | |
| | | detailed date and time planning information down | | |
| | | to the Leg level (if required) | | |
| | Debtor Address Id | A number used to uniquely identify an ADDRESS. | No | Yes |
| | Debtor Party Id | The unique identifier for any individual or group of | No | Yes |
| | | individuals that is of interest to the enterprise. | | |
| | Destination Facility Id | Uniquely identifies a LOCATION. | No | Yes |
| | | For Air Cargo, indicates the Destination T&T | | |
| | | Facility. | | |
| | Freight Term Type Cd | A unique identifier that identifies a FREIGHT | No | Yes |
| | | TERM TYPE. | | |
| | Origin Facility Id | Uniquely identifies a LOCATION. | No | Yes |
| | | For Air Cargo, indicates the Origin T&T Facility. | | |
| | Origination Shipper Ind | Indicates if the Shipper Party is the Origination | No | No |
| | | Shipper. | | |
| | | “Yes” implies the shipment originated with this | | |
| | | Party. | | |
| | | “No” implies the Shipper is a Freight Forwarder, | | |
| | | 3rd Party, another Carrier, etc. providing Freight | | |
| | | services on behalf of the Origination Shipper. | | |
| | Pickup Order Num | Uniquely Identifies a PICKUP ORDER. | No | Yes |
| | Receiver Address Id | A number used to uniquely identify an ADDRESS. | No | Yes |
| | Receiving Party Id | The unique identifier for any individual or group of | No | Yes |
| | | individuals that is of interest to the enterprise. | | |
| | | The Party that will be receiving the SHIPMENT | | |
| | | (consignee) | | |
| | Shipment Num | Uniquely identifies a SHIPMENT. | Yes | No |
| | Shipper Address Id | A number used to uniquely identify an ADDRESS. | No | Yes |
| | Shipper Default Ind | In the case of 3rd Party billing, indicates that the | No | No |
| | | Shipper takes responsibility in the case of non- | | |
| | | payment of the debtor party. | | |
| | Shipper Loaded Ind | Indicates that the SHIPMENT was loaded and | No | No |
| | | counted by the Shipper, not the CARRIER. | | |
| | Shipper Party Id | The unique identifier for any individual or group of | No | Yes |
| | | individuals that is of interest to the enterprise. | | |
| | Shipper Ref Num | The Shipment Reference Number created and used | No | No |
| | | by the Shipper Party to refer to this Shipment. | | |
| | Visit Id | Unique identifier for the VISIT. | No | Yes |
| CARRIER | Carrier Party Id | The unique identifier for a Business. | Yes | Yes |
| | | A carrier organization providing shipping services | | |
| | | such as FedEx, Yellow Freight, etc. | | |
| | SCAC Cd | Uniquely identifies a Standard Carrier Alpha Code | No | No |
| | | (SCAC). | | |
| | | Used to identify Transportation Companies, as | | |
| | | controlled by the NMFTA (see nmfta.org). | | |
| | | The Standard Carrier Alpha Code (SCAC) is a | | |
| | | unique two-to four-letter code assigned to | | |
| | | transportation companies for identification | | |
| | | purposes. The SCAC is required for Electronic | | |
| | | Data Interchange (EDI), intermodal interchange | | |
| | | agreements, U.S. Customs entry, when doing | | |
| | | business with many shippers, on rate tariffs filed | | |
| | | with regulatory agencies, government bills of | | |
| | | lading, and on bids for government traffic. | | |
| CARRIER FORECAST | Carrier Actual Amt DD | The actual amount realized. | No | No |
| | | This is a DERIVED DATA (DD) element. | | |
| | Carrier Forecast Amt | The amount projected by the forecast. | No | No |
| | Carrier Party Id | The unique identifier for a Business. | Yes | Yes |
| | | A carrier organization providing shipping services | | |
| | | such as FedEx, Yellow Freight, etc. | | |
| | Forecast End Dt | The time period for which the forecast was done. | Yes | No |
| | Forecast Method Cd | Can be used to indicate special statistical process | Yes | No |
| | | that was used to generate the forecast. | | |
| | Forecast Source Cd | Indicates the source of the forecast. (3rd party | Yes | No |
| | | application, internal department, etc.) | | |
| | Item Id | Unique Identifier for an Item. | Yes | Yes |
| CASINO | Casino Id | Uniquely identifies a LOCATION. | Yes | Yes |
| | | A sub-type of LOCATION where customers VISIT | | |
| | | for gambling and entertainment. | | |
| CASINO ACCOUNT | Account Settle Dt | The last date on which any debit balance needs to | No | No |
| | | be settled by the player. | | |
| | | Note: This is the date that any collateral provided | | |
| | | by the player may be used to settle the debt. | | |
| | Approved Credit Limit Amt | The maximum amount that can be borrowed by the | No | No |
| | | CASINO PLAYER as approved by the CASINO | | |
| | Casino Account Id | Uniquely identifies an ACCOUNT. | Yes | Yes |
| | Collateral Amt | The value of collateral provided by the player to | No | No |
| | | guarantee repayment of debt. This collateral | | |
| | | becomes the property of the casino on the account | | |
| | | settle date. | | |
| | | Example: Often a check written to and given to the | | |
| | | casino (but not cashed). | | |
| | Credit Approved Dt | Date Player Credit approved | No | No |
| | Credit Expire Dt | Indicates the last date that the player can draw on | No | No |
| | | the credit. | | |
| | | Note: In the case of short term credit- or “This | | |
| | | Trip Only” (TTO), the date will be in the near term. | | |
| | | Players with open ended (“permanent”) credit may | | |
| | | have no expiration date. | | |
| | Current Balance Amt | The current amount of money owed by (or to) the | No | No |
| | | player. | | |
| | | Note: The balance can be negative ((indicating the | | |
| | | amount of money owed to the casino) or positive | | |
| | | (the amount of player money being held by the | | |
| | | casino) | | |
| | Requested Credit Limit Amt | The maximum amount that CASINO PLAYER | No | No |
| | | (requested) would like to borrow against the | | |
| | | ACCOUNT | | |
| CASINO ACCOUNT EVENT | Casino Account Id | Uniquely identifies an ACCOUNT. | Yes | Yes |
| | Event Dttm | The date and time that the CASINO ACCOUNT | Yes | No |
| | | EVENT took place. | | |
| | Event Type Cd | Code for classifying the CASINO ACCOUNT | No | Yes |
| | | EVENT by Type, such as marker issue, debt | | |
| | | repayment, etc. | | |
| CASINO ACCOUNT EVENT | Casino Account Event Type Cd | Code for classifying the CASINO ACCOUNT | Yes | No |
| TYPE | | EVENT by Type, such as marker issue, debt | | |
| | | repayment, etc. | | |
| | Casino Account Event Type Desc | Text description for tracking the CASINO | No | No |
| | | ACCOUNT EVENT | | |
| CASINO ACCOUNT HIST | Balance Effective Dt | The date of the account statement. | Yes | No |
| | Casino Account Id | Uniquely identifies an ACCOUNT. | Yes | Yes |
| | Current Credit Limit Amt | The maximum amount of money that can be | No | No |
| | | borrowed against the CASINO ACCOUNT | | |
| | Debt Payment Amt | The amount of money paid by the player to the | No | No |
| | | casino to reduce (or settle) his or her debt. | | |
| | | Decreases the amount of player debt. | | |
| | Debt Written Off Amt | Amount of money written off by the casino. | No | No |
| | | Reduces the amount of player debt. | | |
| | Front Money In Amt | The amount of money that the CASINO PLAYER | No | No |
| | | deposited as “Front money deposit” and is currently | | |
| | | available to the CASINO PLAYER. | | |
| | Marker Issue Amt | The amount of money lent to the player. | No | No |
| | | Increases the amount of player debt. | | |
| | Previous Balance Amt | Account balance amount at the end of the previous | No | No |
| | | statement. | | |
| | | Note: The balance can be negative ((indicating the | | |
| | | amount of money owed to the casino) or positive | | |
| | | (the amount of player money being held by the | | |
| | | casino) | | |
| CASINO DAY | Casino Id | Uniquely identifies a LOCATION. | Yes | Yes |
| | | A sub-type of LOCATION where customers VISIT | | |
| | | for gambling and entertainment. | | |
| | Gaming Dt | A unique date that is recognized by an | Yes | Yes |
| | | organization. | | |
| | | The Date that revenue is booked against or | | |
| | | recognized. | | |
| | | Example: The business is open until 1am, and all | | |
| | | revenue received between midnight and 1am is | | |
| | | booked under the previous calendar day. | | |
| CASINO DEBT REPAYMENT | Casino Account Id | Uniquely identifies an ACCOUNT. | Yes | Yes |
| | Casino Marker Id | A unique identifier for a CASINO MARKER. | No | Yes |
| | | Indicates the marker that originally extended the | | |
| | | credit. | | |
| | | Note: This is optional and only needed if debt | | |
| | | allocation need to be tracked at the Marker level | | |
| | | (instead of at the Account level). | | |
| | Debt Payment Amt | The amount paid by the player to reduce (or settle) | No | No |
| | | his or her account balance. | | |
| | Event Dttm | The date and time that the CASINO ACCOUNT | Yes | Yes |
| | | EVENT took place. | | |
| CASINO DEBT WRITTEN OFF | Casino Account Id | Uniquely identifies an ACCOUNT. | Yes | Yes |
| | Casino Marker Id | A unique identifier for a CASINO MARKER. | No | Yes |
| | | Indicates the marker that originally extended the | | |
| | | credit. | | |
| | | Note: This is optional and only needed if debt | | |
| | | allocation need to be tracked at the Marker level | | |
| | | (instead of at the Account level). | | |
| | Debt Written Off Amt | Amount of debt that is written off by the CASINO. | No | No |
| | Event Dttm | The date and time that the CASINO ACCOUNT | Yes | Yes |
| | | EVENT took place. | | |
| CASINO FRONT DEPOSIT | Casino Account Id | Uniquely identifies an ACCOUNT. | Yes | Yes |
| | Event Dttm | The date and time that the CASINO ACCOUNT | Yes | Yes |
| | | EVENT took place. | | |
| | Front Money In Amt | The amount of money that the CASINO PLAYER | No | No |
| | | deposited as “Front money deposit” and is currently | | |
| | | available to the CASINO PLAYER. | | |
| CASINO GAME DAY | Casino Id | Uniquely identifies a LOCATION. | Yes | Yes |
| | | A sub-type of LOCATION where customers VISIT | | |
| | | for gambling and entertainment. | | |
| | Game Day End Dttm | Defines the End of a Casino Game Day for a | No | No |
| | | specific Game Type. | | |
| | Game Day Start Dttm | Defines the Start of a Casino Game Day for a | No | No |
| | | specific Game Type. | | |
| | Game Type Cd | Code that identifies the specific type of Casino | Yes | Yes |
| | | Game. | | |
| | | The Game Type that the Casino Day applies to. | | |
| | Gaming Dt | A unique date that is recognized by an | Yes | Yes |
| | | organization. | | |
| | | The Date that revenue is booked against or | | |
| | | recognized. | | |
| | | Example: The business is open until 1am, and all | | |
| | | revenue received between midnight and 1am is | | |
| | | booked under the previous calendar day. | | |
| CASINO GAME EQUIP | Game Equip Id | Uniquely identifies an Equipment Instance. | Yes | Yes |
| CASINO JUNKET | Arrive Dttm | The Arrival date and time of the Junket guests. | No | No |
| | Customer Cnt | This count is used if all the individuals can not be | No | No |
| | | identified/tracked individually. | | |
| | Depart Dttm | The Departure date and time of the Junket guests. | No | No |
| | Group Event Id | A unique identifier for the GROUP EVENT | Yes | Yes |
| | Originating City Cd | The unique code for an instance of the CITY entity. | No | Yes |
| | | The City from which the Casino Junket departed/ | | |
| | | originated. | | |
| | Transport Type Cd | Uniquely identifies a Transport Type. | No | Yes |
| CASINO LOYALTY EARNING | Event Dttm | The date and time that a loyalty event occurred | Yes | Yes |
| | Loyalty Account Id | Uniquely identifies an ACCOUNT. | Yes | Yes |
| | Session Start Dttm | The start of a rated gaming session (that is, a | No | Yes |
| | | gaming session where the identity of the player is | | |
| | | known). | | |
| | Visit Id | The unique identifier for an instance of the VISIT | No | Yes |
| | | entity. | | |
| CASINO MARKER | Approving Assoc Id | The unique identifier for an individual. | No | Yes |
| | | The Associate that approved the marker. | | |
| | Casino Marker Id | A unique identifier for a CASINO MARKER | Yes | No |
| | Marker Amt | The amount for which a MARKER was issued to | No | No |
| | | the PLAYER. | | |
| | | The amount will depend on the available credit | | |
| | | limit in the PLAYERs CASINO CREDIT | | |
| | | ACCOUNT. | | |
| CASINO MARKER ISSUE | Casino Account Id | Uniquely identifies an ACCOUNT. | Yes | Yes |
| | Casino Marker Id | A unique identifier for a CASINO MARKER | No | Yes |
| | Marker Issued Dttm | The date and time that the CASINO ACCOUNT | Yes | Yes |
| | | EVENT took place. | | |
| | Session Start Dttm | The start of a rated gaming session (that is, a | No | Yes |
| | | gaming session where the identity of the player is | | |
| | | known). | | |
| | Visit Id | The unique identifier for an instance of the VISIT | No | Yes |
| | | entity. | | |
| CASINO PLAYER | Casino Player Id | The unique identifier for an individual. | Yes | Yes |
| CASINO PLAYER COMP | Award Voucher Id | The identifier of a loyalty award or certificate | Yes | Yes |
| | | awarded to a customer account. | | |
| CASINO PLAYER HIST | Casino Player Id | The unique identifier for an individual. | Yes | Yes |
| | Casino Rating Cd | Code that describes the rating for a CASINO | No | Yes |
| | | VISIT or a GAMING SESSION assigned to a | | |
| | | CASINO PLAYER | | |
| | Current Win Loss Amt | The amount won or lost by the CASINO PLAYER | No | No |
| | | during the current CASINO VISIT. | | |
| | Earnings Effective Dttm | The date time at which this earnings snapshot was | Yes | No |
| | | captured | | |
| | Lastime Win Loss Amt | The amount won or lost by the CASINO PLAYER | No | No |
| | | during the last CASINO VISIT. | | |
| | Lifetime Comps Amt | The amount of COMPs earned by the CASINO | No | No |
| | | PLAYER from the first CASINO VISIT to the | | |
| | | most current CASINO VISIT. | | |
| | Lifetime Win Loss Amt | The amount of win or loss attributed to the | No | No |
| | | CASINO PLAYER starting from the first CASINO | | |
| | | VISIT to the most current CASINO VISIT. | | |
| | Player Status Cd | Code that identifies the player development status. | No | Yes |
| CASINO PROMO | Actual Guest Cnt | Actual number of patrons attending the event. | No | No |
| | Casino Promo Type Cd | Type of group, event or promotion. E.g. HL = | No | Yes |
| | | Helicopter, SP = Special Event, PR = Promotions. | | |
| | Estmtd Guest Cnt | Estimated number of patrons for the group, event | No | No |
| | | or promotion. | | |
| | Game Type Cd | Code that identifies the specific type of Casino | No | Yes |
| | | Game. | | |
| | Promo Id | The unique identifier for an instance of the | Yes | Yes |
| | | PROMOTION entity. | | |
| CASINO PROMO TYPE | Casino Promo Type Cd | Type of group, event or promotion. E.g. HL = | Yes | No |
| | | Helicopter, SP = Special Event, PR = Promotions. | | |
| | Casino Promo Type Desc | Description of the type of group, event or | No | No |
| | | promotion. | | |
| CASINO RATING | Casino Rating Cd | Code that describes the rating for a CASINO | Yes | No |
| | | VISIT or a GAMING SESSION assigned to a | | |
| | | CASINO PLAYER | | |
| | Casino Rating Desc | Description of the CASINO RATING | No | No |
| | Rating High End Amt | The maximum amount expected to be spent by a | No | No |
| | | CASINO PLAYER on an average during a | | |
| | | CASINO VISIT | | |
| | Rating Low End Amt | The least amount expected to be spent by a | No | No |
| | | CASINO PLAYER on an average during a | | |
| | | CASINO VISIT | | |
| CASINO SWEEPSTAKE | Drawing Dttm | The date and time that the Sweepstake will end and | No | No |
| | | the winner(s) announced. | | |
| | Sweepstake Promo Id | The unique identifier for the promotion. | Yes | Yes |
| | | Specifies a specific Sweepstake. | | |
| CASINO VISIT | Casino Account Id | Uniquely identifies an ACCOUNT. | No | Yes |
| | Casino Player Id | The unique identifier for an individual. | No | Yes |
| | Casino Rating Cd | Code that describes the rating for a CASINO | No | Yes |
| | | VISIT or a GAMING SESSION assigned to a | | |
| | | CASINO PLAYER | | |
| | Casino Visit Type Cd | A code used for classifying the CASINO VISIT. | No | Yes |
| | Host Assoc Id | An individual who is employed by the enterprise. | No | Yes |
| | | An ASSOCIATE (employee of the CASINO | | |
| | | FACILITY) who is typically assigned to help or | | |
| | | assist one or more CASINO PLAYERS during a | | |
| | | CASINO VISIT. | | |
| | Safekeeping Amt | Money belonging to the CASINO PLAYER | No | No |
| | | deposited at the front desk for safekeeping. This | | |
| | | money does not count towards amount available | | |
| | | for gaming. | | |
| | Visit Id | The unique identifier for an instance of the VISIT | Yes | Yes |
| | | entity. | | |
| CASINO VISIT TYPE | Casino Visit Type Cd | A code used for classifying the CASINO VISIT. | Yes | No |
| | Casino Visit Type Desc | Description for classifying CASINO VISIT | No | No |
| CASINO ZONE | Casino Id | Uniquely identifies a LOCATION. | Yes | Yes |
| | | A sub-type of LOCATION where customers VISIT | | |
| | | for gambling and entertainment. | | |
| | Location Zone Cd | Uniquely defines a LOCATION ZONE TYPE. | No | Yes |
| | Zone Area Meas | The square area size of the Zone expressed in | No | No |
| | | square meters or square feet. | | |
| | Zone Num | Uniquely identifies an area of interest within a | Yes | No |
| | | CASINO. | | |
| CASINO ZONE TYPE | Location Zone Cd | Uniquely defines a type of LOCATION ZONE | Yes | No |
| | | TYPE. | | |
| | Location Zone Desc | A description of the LOCATION ZONE TYPE. | No | No |
| CENSUS BLOCK | Census Block Cd | The unique code for an instance of the CENSUS | Yes | No |
| | | BLOCK entity. | | |
| | Country Cd | The unique code for an instance of the COUNTRY | No | Yes |
| | | entity. | | |
| | Postal Cd | A unique code for an instance of the POSTAL | No | Yes |
| | | CODE entity. | | |
| CERTIFICATE PAYMENT | Award Voucher Id | The identifier of a loyalty award or certificate | No | Yes |
| | | awarded to a customer account. | | |
| | Certificate Num | The serial number of the certificate given by an | No | No |
| | | airline to a customer for the purpose of obtaining a | | |
| | | Ticket. | | |
| | Certificate Promotion Cd | A code used to describe the program under which | No | No |
| | | the certificate is being redeemed. | | |
| | Certificate Type Cd | The domain of identifiers for discriminating the | No | Yes |
| | | type of CERTIFICATE used for PAYMENT. | | |
| | Payment Tran Id | Uniquely identifies a Payment. | Yes | Yes |
| CERTIFICATE TYPE | Certificate Type Cd | The domain of identifiers for discriminating the | Yes | No |
| | | type of CERTIFICATE used for PAYMENT. | | |
| | Certificate Type Desc | A brief explanation of the type of CERTIFICATE | No | No |
| | | used for PAYMENT.. | | |
| CERTIFICATION | Certification Cd | Uniquely identifies a Certification. | Yes | No |
| | Certification Desc | Textual description of a Certification | No | No |
| CHAIN | Chain Cd | Uniquely identifies a CHAIN. | Yes | No |
| | Chain Mgr Assoc Id | An individual who is employed by the enterprise. | No | Yes |
| | | The Manager of the CHAIN. | | |
| | Chain Name | Short text reference or label for the chain. | No | No |
| | Org Party Id | The owner/representative of the CHAIN. | No | Yes |
| CHANNEL | Channel Cd | Uniquely identifies a CHANNEL. | Yes | No |
| | Channel Desc | Narrative text describing a CHANNEL. | No | No |
| CHANNEL USAGE TYPE | Channel Usage Type Cd | A code for classifying the usage of channels. For | Yes | No |
| | | example, marketing, sales, electronic, etc. | | |
| | Channel Usage Type Desc | A description of the code. | No | No |
| CHARGE TYPE | Charge Type Cd | Unique identifier for a CHARGE TYPE. | Yes | No |
| | Charge Type Desc | Narrative text describing the CHARGE TYPE. | No | No |
| CHARITY DONATION | Award Voucher Id | The identifier of a loyalty award or certificate | Yes | Yes |
| | | awarded to a customer account. | | |
| CHART OF ACCOUNT | Chart Of Account Desc | The description for a CHART OF ACCOUNT. | No | No |
| | Chart Of Account Expire Dttm | The end date for a CHART OF ACCOUNT. | No | No |
| | Chart Of Account Id | The unique identifier for a CHART OF | Yes | No |
| | | ACCOUNT, or alias for a complete CHART OF | | |
| | | ACCOUNTs number. | | |
| CHART OF ACCOUNT | COA Bal End Amt | The monetary amount of the actual balance for the | No | No |
| BALANCE | | account at the end of the accounting period. | | |
| | | In the local accounting currency. | | |
| | COA Bal End Dttm | The end date for the CHART OF ACCOUNT | No | No |
| | | BALANCE. | | |
| | COA Bal Global Crncy End Amt | The monetary amount of the actual balance for the | No | No |
| | | account at the end of the accounting period. | | |
| | | In the global accounting currency. | | |
| | COA Bal Global Crncy Start Amt | The monetary amount of the actual balance for the | No | No |
| | | account at the start of the accounting period. | | |
| | | In the global accounting currency. | | |
| | COA Bal Id | The unique identifier for a CHART OF | Yes | Yes |
| | | ACCOUNT, or alias for a complete CHART OF | | |
| | | ACCOUNTs number. | | |
| | COA Bal Start Amt | The monetary amount of the actual balance for the | No | No |
| | | account at the start of the accounting period. | | |
| | | In the local accounting currency. | | |
| | COA Bal Start Dttm | The start date for the CHART OF ACCOUNT | Yes | No |
| | | BALANCE. | | |
| CHART OF ACCOUNT | Chart Of Account Segment Desc | The description for a GL Segment. | No | No |
| SEGMENT | | | | |
| | Chart Of Account Segment Id | The unique identifier for any general ledger | Yes | No |
| | | account dimension or segment. | | |
| | COA Segment Category Cd | The unique identifier for a COA SEGMENT | No | Yes |
| | | CATEGORY. | | |
| CHART OF ACCOUNT | Chart Of Account Id | The unique identifier for a CHART OF | Yes | Yes |
| SEGMENT XREF | | ACCOUNT, or alias for a complete CHART OF | | |
| | | ACCOUNTs number. | | |
| | Chart Of Account Segment Id | The unique identifier for any general ledger | Yes | Yes |
| | | account dimension or segment. | | |
| | COA Segment Category Cd | The unique identifier for a COA SEGMENT | Yes | Yes |
| | | CATEGORY. | | |
| | COA Segment Xref End Dttm | The date the association of a CHART OF | No | No |
| | | ACCOUNT SEGMENT Id with a CHART OF | | |
| | | ACCOUNT ended. | | |
| | COA Segment Xref Start Dttm | The date the association of a CHART OF | Yes | No |
| | | ACCOUNT SEGMENT Id with a CHART OF | | |
| | | ACCOUNT started. | | |
| CHECK OUT METHOD | Check Out Method Cd | Classification codes that defines the type of | Yes | No |
| | | LODGING CHECK OUT EVENT | | |
| | Check Out Method Desc | Description of the type of LODGING CHECK | No | No |
| | | OUT EVENT | | |
| CHECKING ACCOUNT | Checking Account Id | Uniquely identifies an ACCOUNT. | Yes | Yes |
| CHECKPOINT | Ship Event Id | Uniquely identifies a SHIPPING EVENT. | Yes | Yes |
| CITY | City Cd | The unique code for an instance of the CITY entity. | Yes | No |
| | City Name | The name of a CITY, village, town, etc. | No | No |
| | County Cd | The unique code for an instance of the COUNTY | No | Yes |
| | | entity. | | |
| | Territory Cd | The unique code for an instance of the | No | Yes |
| | | TERRITORY entity. | | |
| CITY TICKET OFFICE | City Ticket Off Id | Uniquely identifies a LOCATION. | Yes | Yes |
| | | Travel ticket office located in any given city at a | | |
| | | location other than the departure terminal or | | |
| | | station. | | |
| CLAIM | At Fault Ind | Indicates if ‘we’ were at fault, i.e. the transportation | No | No |
| | | company is responsible for the action that caused | | |
| | | the claim. | | |
| | At Fault Location Id | Uniquely identifies a LOCATION. | No | Yes |
| | | The LOCATION that is “at fault” for this claim. | | |
| | Claim Amt | The monetary amount associated with this | No | No |
| | | particular CLAIM. | | |
| | Claim File Dt | The filing date associated with this particular | No | No |
| | | CLAIM. | | |
| | Claim Num | Uniquely identifies a CLAIM. | Yes | No |
| | Claim Reason Cd | Uniquely identifies a CLAIM REASON. | No | Yes |
| | Claim Status Cd | Uniquely identifies a CLAIM STATUS. | No | Yes |
| | Claim Type Cd | Uniquely identifies a CLAIM TYPE. | No | Yes |
| | Payout Amt | The actual monetary pay out associated with this | No | No |
| | | CLAIM entity. | | |
| | Settlement Dt | The date of settlement for this particular CLAIM. | No | No |
| CLAIM REASON | Claim Reason Cd | Uniquely identifies a CLAIM REASON. | Yes | No |
| | Claim Reason Desc | Narrative text describing the CLAIM REASON. | No | No |
| | Claim Type Cd | Uniquely identifies a CLAIM TYPE. | Yes | Yes |
| CLAIM STATUS | Claim Status Cd | Uniquely identifies a CLAIM STATUS. | Yes | No |
| | Claim Status Desc | Narrative text describing a CLAIM STATUS. | No | No |
| CLAIM TYPE | Claim Type Cd | Uniquely identifies a CLAIM TYPE. | Yes | No |
| | Claim Type Desc | Narrative text describing the CLAIM TYPE. | No | No |
| CLASS RATING | Class Rating Cd | Uniquely identifies the CLASS RATING. | Yes | No |
| | Class Rating Desc | Narrative text describing the CLASS RATING. | No | No |
| CLASSIC SER ITEM | Classic Ser Num | The pre-S2000 non-compliant Serial Number (not | No | No |
| | | guaranteed to be unique across Items or Parties) | | |
| | Univ Serial Num USN | The unique serial number for ITEMs that are | Yes | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| COA SEGMENT CATEGORY | COA Segment Category Cd | The unique identifier for a COA SEGMENT | Yes | No |
| | | CATEGORY. | | |
| | COA Segment Category Desc | The description for a COA SEGMENT | No | No |
| | | CATEGORY. | | |
| COA SEGMENT GROUP | Chart Of Account Id | The unique identifier for a CHART OF | Yes | Yes |
| CATEGORY | | ACCOUNT, or alias for a complete CHART OF | | |
| | | ACCOUNTs number. | | |
| | COA Segment Category Cd | The unique identifier for a COA SEGMENT | Yes | Yes |
| | | CATEGORY. | | |
| CODE FORMAT | Code Format Cd | Uniquely identifies the code format. | Yes | No |
| | Code Format Name | Short text reference or label for the code format. | No | No |
| CODE SHARE BASIS | Code Share Basis Cd | A code which represents the fare basis for a Code | Yes | No |
| | | Share flight. | | |
| | Code Share Basis Desc | A textual description of the fare basis for a Code | No | No |
| | | Share flight. | | |
| COLLECTION STATUS TYPE | Collection Status Type Cd | A code for the type of COLLECTION STATUS | Yes | No |
| | | TYPE. Examples would be past due 1-30 days, past | | |
| | | due 31-60 days, past due 61-90 days, charged off, | | |
| | | in collections, promised to pay, payment received | | |
| | | or current (not past due). | | |
| | Collection Status Type Desc | The description of the COLLECTION STATUS | No | No |
| | | TYPE. | | |
| COMMODITY | Class Rating Cd | Uniquely identifies the CLASS RATING. | No | Yes |
| | Commodity Cd | Uniquely identifies a commodity using a | Yes | No |
| | | Classification Standard. | | |
| | Commodity Desc | Narrative text describing a commodity. | No | No |
| | Commodity Group Cd | Uniquely identifies a Commodity Group. | No | Yes |
| | Commodity Name | Short text reference or label for a Commodity. | No | No |
| COMMODITY EQUIP | Commodity Group Cd | Uniquely identifies a Commodity Group. | Yes | Yes |
| | Equip Class Cd | Uniquely identifies the EQUIP CLASS. | Yes | Yes |
| COMMODITY GROUP | Commodity Group Cd | Uniquely identifies a Commodity Group. | Yes | No |
| | Commodity Group Desc | Narrative text describing a Commodity Group. | No | No |
| | Commodity Group Name | Short text reference or label for a Commodity | No | No |
| | | Group. | | |
| | Parent Commodity Group Cd | Uniquely identifies a Commodity Group. | No | Yes |
| | | The parent commodity group of a child commodity | | |
| | | group. | | |
| COMMON STOCK ACCOUNT | Common Shares Outstanding Qty | The number of common stock shares of a | No | No |
| | | corporation. | | |
| | Common Stock Account Type Cd | The unique code assigned to the COMMON | No | Yes |
| | | STOCK ACCOUNT TYPE. Types of common | | |
| | | stock include voting stock and non-voting stock. | | |
| | Common Stock Par Value Amt | The assigned monetary value used to compute the | No | No |
| | | accounting value of common shares on a | | |
| | | company's balance sheet. | | |
| | GL Main Account Num | The unique Chart of Account code for the GL | Yes | Yes |
| | | MAIN ACCOUNT. | | |
| | Total Auth Common Shares Qty | The maximum number of common shares that a | No | No |
| | | corporation may create. | | |
| COMMON STOCK ACCOUNT | Common Stock Account Type Cd | The unique code assigned to the COMMON | Yes | No |
| TYPE | | STOCK ACCOUNT TYPE. Types of common | | |
| | | stock include voting stock and non-voting stock. | | |
| | Common Stock Account Type Desc | The description of the COMMON STOCK | No | No |
| | | ACCOUNT TYPE. | | |
| COMP TYPE | Comp Type Cd | A unique identifier of the type of award earned and | Yes | Yes |
| | | requested by the account owner. | | |
| | | Uniquely identifies a COMP TYPE. | | |
| | Comp Type Desc | Description of the COMP TYPE. | No | No |
| COMP VISIT SUMMARY | Award Voucher Id | The identifier of a loyalty award or certificate | Yes | Yes |
| | | awarded to a customer account. | | |
| | Comp Estmtd Amt | Amount of COMP estimated for the CASINO | No | No |
| | | VISIT. | | |
| | Comp Issue Associate Id | An individual who is employed by the enterprise. | No | Yes |
| | | The Associate who authorizes or issues the Comp. | | |
| | Comp Issued Amt | Amount of COMP actually issued. | No | No |
| | Comp Issued Dttm | Date comp was entered/issued. | No | No |
| | Comp Issued Qty | Number of COMPs issued. For example, if the | No | No |
| | | COMP TYPE is ROOM, this will track the number | | |
| | | of free (complimentary) nights provided to the | | |
| | | PLAYER. | | |
| | Folio Account Id | Uniquely identifies an ACCOUNT. | No | Yes |
| | Visit Id | The unique identifier for an instance of the VISIT | Yes | Yes |
| | | entity. | | |
| COMPENSATORY EARNING | Compensation Seq Num | Uniquely identifies a Compensatory Offer in | No | Yes |
| | | response to a specific Feedback instance. | | |
| | Event Dttm | The date and time that a loyalty event occurred | Yes | Yes |
| | Feedback Id | Uniquely identifies an instance of Quality | No | Yes |
| | | Feedback. Typically system assigned. | | |
| | Loyalty Account Id | Uniquely identifies an ACCOUNT. | Yes | Yes |
| COMPENSATORY OFFER | Compensation Seq Num | Uniquely identifies a Compensatory Offer in | Yes | No |
| | | response to a specific Feedback instance. | | |
| | Feedback Id | Uniquely identifies an instance of Quality | Yes | Yes |
| | | Feedback. Typically system assigned. | | |
| | Promo Offer Id | The unique identifier for a promo offer. | No | Yes |
| | | The Offer provided as compensation. | | |
| CONFIGURATION | Inv Tran Id | Uniquely identifies an inventory transaction. | Yes | Yes |
| TRANSACTION | | | | |
| CONSOL INVOICE SUMMARY | Consol Inv Sumry Begin Bal Amt | The beginning balance for this | No | No |
| | | CONSOLIDATED INVOICE as of this summary | | |
| | | date. | | |
| | Consol Inv Sumry Currency Cd | The code assigned to a CURRENCY. | No | Yes |
| | Consol Inv Sumry Tot Adj Amt | The total adjustment amount made since the prior | No | No |
| | | CONSOLIDATED INVOICE summary date. | | |
| | Consol Inv Sumry Tot Due Amt | The total balance due amount for this | No | No |
| | | CONSOLIDATED INVOICE as of this summary | | |
| | | date. | | |
| | Consol Inv Sumry Tot Paymt Amt | The total amount of any payment received since the | No | No |
| | | prior CONSOLIDATED INVOICE summary date. | | |
| | Consol Invoice Summary Dttm | The ending date that this CONSOLIDATED | Yes | No |
| | | INVOICE was summarized. | | |
| | Consolidated Inv Id | A number representing a unique identifier for a | Yes | Yes |
| | | CONSOLIDATED INVOICE. | | |
| CONSOLIDATED INVOICE | Consolidated Inv Create Dttm | The date this CONSOLIDATED INVOICE was | No | No |
| | | created. | | |
| | Consolidated Inv Id | A number representing a unique identifier for a | Yes | No |
| | | CONSOLIDATED INVOICE. | | |
| | Consolidated Inv Party Id | The unique identifier for any individual or group of | No | Yes |
| | | individuals that is of interest to the enterprise. | | |
| | | In this context it is the PARTY who created the | | |
| | | CONSOLIDATED INVOICE. | | |
| CONSOLIDATED INVOICE | Consolidated Inv Id | A number representing a unique identifier for a | Yes | Yes |
| STATUS | | CONSOLIDATED INVOICE. | | |
| | Consolidated Inv Status Dttm | The date this state of the CONSOLIDATED | Yes | No |
| | | INVOICE started. | | |
| | Invoice Status Type Cd | Uniquely identifies an Invoice Status. | Yes | Yes |
| CONSUMPTION TRANSACTION | Inv Tran Id | Uniquely identifies an inventory transaction. | Yes | Yes |
| CONTAINER CAPACITY | Capacity Measure Cd | Uniquely defines a Capacity Measure | Yes | Yes |
| | Container Capacity Meas | Specifies the quantity measure for the Capacity | No | No |
| | | metric. | | |
| | Container Class Cd | Uniquely defines a Container Class. | Yes | Yes |
| | UOM Cd | Uniquely identifies a unit of measure. | No | Yes |
| CONTAINER CLASS | Container Class Cd | Uniquely defines a Container Class. | Yes | No |
| | Container Class Desc | Textual description of a Container Class. | No | No |
| | Container Type Cd | Uniquely identifies a Container Type. | No | Yes |
| | Fork Lift Capability Ind | Indicates if the Container has special receptacles | No | No |
| | | designed for lifting/moving by a Forklift. | | |
| CONTAINER CONTOUR | Container Contour Cd | Uniquely identifies a Container Contour. | Yes | No |
| | Container Contour Desc | Textual description of a Container Contour. | No | No |
| CONTAINER EQUIP | Container Class Cd | Uniquely defines a Container Class. | No | Yes |
| | Container Contour Cd | Uniquely identifies a Container Contour. | No | Yes |
| | Equip Id OIN | Uniquely identifies an Equipment Instance. | Yes | Yes |
| CONTAINER ESTIMATE | Container Class Cd | Uniquely defines a Container Class. | Yes | Yes |
| | | The type of Container planned to be part of the | | |
| | | Shipment. | | |
| | Container Seq Num | Uniquely defines a Container of a specific type to | Yes | No |
| | | be used for Capacity Planning. | | |
| | Est Volume Meas | Estimate of the Container Volume (cubic) to be | No | No |
| | | utilized by the planned Shipment. | | |
| | | Optional. This will only be used if the enterprise | | |
| | | has visibility inside of the Container. | | |
| | Est Volume Pct | Estimate of the Container Volume percentage to be | No | No |
| | | utilized by the planned Shipment. | | |
| | | Optional. This will only be used if the enterprise | | |
| | | has visibility inside of the Container. | | |
| | Est Weight Meas | Estimate of the Weight to be allocated from a | No | No |
| | | planned Shipment to a specific Container of a | | |
| | | specific Type. | | |
| | Estimate Dttm | The effective date and time of the estimate. | Yes | Yes |
| | Shipment Num | Uniquely identifies a SHIPMENT. | Yes | Yes |
| | | Identifies the Shipment for which space is being | | |
| | | estimated. At this point in time it is a provisional | | |
| | | Shipment Number. | | |
| CONTAINER TYPE | Container Type Cd | Uniquely identifies a Container Type. | Yes | No |
| | Container Type Desc | Textual description of a Container Type. | No | No |
| CONTRACTED FEEDBACK | Feedback Id | Uniquely identifies an instance of Quality | Yes | Yes |
| | | Feedback. Typically system assigned. | | |
| CONVERSION | Conversion Category Cd | Unique identifier for information concerning the | No | Yes |
| | | linkage between recommended Offerings and the | | |
| | | Web Page that the Offering was displayed on. | | |
| | | Source-> Recommendation DB. | | |
| | Conversion Dttm | The date and time on which a Conversion occurred. | No | No |
| | Conversion Id | Unique identifier for successful recommendations | Yes | No |
| | | provided by a recommendation engine such as that | | |
| | | provided by BeFree. A recommendation is | | |
| | | considered successful if a user clicks on the | | |
| | | recommendation. A purchase need not be made in | | |
| | | order for a recommendation to be considered a | | |
| | | Conversion. | | |
| | Conversion Original Click Ind | Designates if the user clicked on the | No | No |
| | | Recommendation when it was originally displayed | | |
| | | or if the user came back at a subsequent time. | | |
| | | 0 - No, | | |
| | | 1 - yes. | | |
| | Web Visit Id | Unique identifier for the VISIT. | No | Yes |
| CONVERSION CATEGORY | Conversion Category Cd | Unique identifier for information concerning the | Yes | No |
| | | linkage between recommended Offerings and the | | |
| | | Web Page that the Offering was displayed on. | | |
| | | Source-> Recommendation DB. | | |
| | Conversion Category Name | The name assigned to a Conversion Category. | No | No |
| | Conversion Category URL Txt | The Internet or Web Address where the Conversion | No | No |
| | | Category appeared. This typically is composed of | | |
| | | four parts: | | |
| | | A protocol name (a protocol is a set of rules and | | |
| | | standards that enable computers to exchange | | |
| | | information). | | |
| | | The location of the site. | | |
| | | The name of the organization that maintains the | | |
| | | site. | | |
| | | A suffix that identifies the kind of organization it is | | |
| | | (such as .com for a commercial organization). | | |
| | | For example, the address | | |
| | | http://www.microsoft.com/provides the following | | |
| | | information: | | |
| | | http: This Web server uses Hypertext Transfer | | |
| | | Protocol (HTTP). | | |
| | | www: This site is on the World Wide Web. | | |
| | | Microsoft The Web server is at Microsoft | | |
| | | Corporation. | | |
| | | com: This is a commercial institution. | | |
| | | When you are viewing a Web page, the page | | |
| | | address appears in the Address bar in Internet | | |
| | | Explorer. | | |
| | Conversion Item Id | Unique Identifier for an Item. | No | Yes |
| | Web Page Id | The unique identifier of a particular WEB PAGE | No | Yes |
| | | instance. | | |
| CORPORATE FEEDBACK | Feedback Id | Uniquely identifies an instance of Quality | Yes | Yes |
| | | Feedback. Typically system assigned. | | |
| | Scheduled Ind | Indicates if the feedback was obtained via a | No | No |
| | | scheduled (like a monthly inspection) event, or | | |
| | | unscheduled (like a mystery shopper or surprise | | |
| | | inspection) event. | | |
| CORPORATE STORE | Location Id | Uniquely identifies a LOCATION. | Yes | Yes |
| | | A physical retail outlet - “brick and mortar”. | | |
| COST | Cost Cd | Uniquely identifies a COST. | Yes | No |
| | Cost Desc | Narrative text describing the COST. | No | No |
| | Cost Type Cd | Uniquely identifies a COST TYPE. | No | Yes |
| COST OF SALES ACCOUNT | GL Main Account Num | The unique Chart of Account code for the GL | Yes | Yes |
| | | MAIN ACCOUNT. | | |
| COST TYPE | Cost Type Cd | Uniquely identifies a COST TYPE. | Yes | No |
| | Cost Type Desc | Narrative text describing the Cost Type. | No | No |
| COUNTRY | Country Cd | The unique code for an instance of the COUNTRY | Yes | No |
| | | entity. | | |
| | Country Group Cd | The unique code assigned to the COUNTRY | No | Yes |
| | | GROUP. | | |
| | Country Name | The name of a COUNTRY | No | No |
| COUNTRY GROUP | Country Group Cd | The unique code assigned to the COUNTRY | Yes | No |
| | | GROUP. | | |
| | Country Group Desc | The description of the COUNTRY GROUP. | No | No |
| | World Region Cd | A number used to uniquely identify a WORLD | No | Yes |
| | | REGION. | | |
| COUNTRY HOLIDAY | Calendar Dt | A unique calendar date that is recognized by an | Yes | Yes |
| | | organization. | | |
| | Country Cd | The unique code for an instance of the COUNTRY | Yes | Yes |
| | | entity. | | |
| | Holiday Cd | Uniquely identifies a HOLIDAY. | Yes | Yes |
| COUNTRY SEASON | Calendar Dt | A unique calendar date that is recognized by an | Yes | Yes |
| | | organization. | | |
| | Country Cd | The unique code for an instance of the COUNTRY | Yes | Yes |
| | | entity. | | |
| | Season Cd | Uniquely identifies a SEASON. | Yes | Yes |
| COUNTY | County Cd | The unique code for an instance of the COUNTY | Yes | No |
| | | entity. | | |
| | County Name | The name of a COUNTY. | No | No |
| | Msa Cd | The unique code for an instance of the | No | Yes |
| | | METROPOLITAN STATISTICAL AREA entity. | | |
| | Territory Cd | The unique code for an instance of the | No | Yes |
| | | TERRITORY entity. | | |
| COUPON CERTIFICATE | Coupon Serial Num | The actual serial number appearing on an issued | Yes | No |
| | | COUPON. | | |
| | Individual Party Id UPI | The unique identifier for any individual or group of | No | Yes |
| | | individuals that is of interest to the enterprise. | | |
| | | The Individual targeted by the Coupon Certificate. | | |
| | | Note: The Coupon Certificate may in some cases | | |
| | | be redeemed by an individual other than the | | |
| | | original recipient. | | |
| | Promo Offer Id | The unique identifier for a promo offer. | Yes | Yes |
| COUPON OFFER | Coupon Txt | Textual content of the “Coupon” or token to be | No | No |
| | | referenced by the customer to receive the offer. | | |
| | | Example: “20Off”, “SummerSave”, “FreeShip”, | | |
| | | etc. | | |
| | Promo Offer Id | The unique identifier for a promo offer. | Yes | Yes |
| CREDIT CARD | Credit Card Account Id | Uniquely identifies an ACCOUNT. | Yes | Yes |
| | Credit Card Type Cd | Uniquely identifies a Credit Card Type. | No | Yes |
| CREDIT CARD TYPE | Credit Card Type Cd | Uniquely identifies a Credit Card Type. | Yes | No |
| | Credit Card Type Desc | Narrative text describing the Credit Card Type. | No | No |
| CREDIT RATING | Credit Rating Cd | Uniquely identifies a CREDIT RATING. | Yes | No |
| | Credit Rating Desc | Narrative text describing the CREDIT RATING. | No | No |
| CREW MEMBER | Associate Party Id | An individual who is employed by the enterprise. | Yes | Yes |
| | | The individual(s) that are operating (driving, | | |
| | | flying, etc.) the transportation equipment. | | |
| | Destination Facility Id | Uniquely identifies a LOCATION. | Yes | Yes |
| | Flight Num DFN | A unique identifier assigned to a Flight scheduled | Yes | Yes |
| | | for generating revenue and utilized by the general | | |
| | | public. | | |
| | Origin Facility Id | Uniquely identifies a LOCATION. | Yes | Yes |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| CRUISE LINE | Cruise Org Id | The unique identifier for an external organization. | Yes | Yes |
| | | Identifies the Organization that provides a Product. | | |
| CRUISE LINE RESERVATION | Reservation Seq Num | This attribute identifies a specific RESERVATION | Yes | Yes |
| | | ITEM. | | |
| | Reservation Transaction Id | A unique identifier for this TRAVEL | Yes | Yes |
| | | TRANSACTION. | | |
| CRUISE LINE TICKET | Ticket Id | A unique identifier for a TICKET. | Yes | Yes |
| CRUISE PRODUCT | Cruise Product Id | Unique Identifier for an Item. | Yes | Yes |
| | | A distance based TRAVEL PRODUCT that is | | |
| | | defined by Origination and Destination (O&D), | | |
| | | weekday of departure and time of departure. | | |
| | | A ship sailing, cruise. | | |
| CURRENCY | Currency Cd | The code assigned to a CURRENCY. | Yes | No |
| | Currency Name | The name of the CURRENCY. | No | No |
| CURRENCY TRANSLATION | Currency Trans Rate End Dttm | The end date for the CURRENCY translation rate. | No | No |
| RATE | | | | |
| | Currency Trans Rate Start Dttm | The begin date for the CURRENCY translation | Yes | No |
| | | rate. | | |
| | Currency Trans Rate Type Cd | The unique code assigned to the CURRENCY | Yes | Yes |
| | | TRANSLATION RATE TYPE. Possible examples | | |
| | | may be: | | |
| | | Monthly Average Rate, | | |
| | | End of Period Rate, | | |
| | | Daily Rate, | | |
| | | etc. | | |
| | Source Currency Cd | The code assigned to the Source Currency. | Yes | Yes |
| | Source To Target Currency Rate | The percent used to convert a Source Currency to | No | No |
| | | the company's Global Currency (e.g. exchange | | |
| | | rate). | | |
| | Target Currency Cd | The code assigned to a Company's Global | Yes | Yes |
| | | Currency. | | |
| | Target To Source Currency Rate | The percent used to convert a company's Global | No | No |
| | | Currency to the Source Currency (e.g. exchange | | |
| | | rate). | | |
| CURRENCY TRANSLATION | Currency Trans Rate Type Cd | The unique code assigned to the CURRENCY | Yes | No |
| RATE TYPE | | TRANSLATION RATE TYPE. Possible examples | | |
| | | may be: | | |
| | | Monthly Average Rate, | | |
| | | End of Period Rate, | | |
| | | Daily Rate, | | |
| | | etc. | | |
| | Currency Trans Rate Type Desc | The description of the CURRENCY | No | No |
| | | TRANSLATION RATE TYPE. | | |
| CURRENT ASSET ACCOUNT | Current Asset Account Type Cd | The unique code assigned to the CURRENT | No | Yes |
| | | ASSET ACCOUNT TYPE. Examples may be | | |
| | | available cash, prepaid expenses, inventory, | | |
| | | accounts receivable, or securities. | | |
| | GL Main Account Num | The unique Chart of Account code for the GL | Yes | Yes |
| | | MAIN ACCOUNT. | | |
| CURRENT ASSET ACCOUNT | Current Asset Account Type Cd | The unique code assigned to the CURRENT | Yes | No |
| TYPE | | ASSET ACCOUNT TYPE. Examples may be | | |
| | | available cash, prepaid expenses, inventory, | | |
| | | accounts receivable, or securities. | | |
| | Current Asset Acct Type Desc | A description of the CURRENT ASSET | No | No |
| | | ACCOUNT TYPE. | | |
| CURRENT LIABILITY | Current Liab Account Type Cd | The unique code assigned to the CURRENT | No | Yes |
| ACCOUNT | | LIABILITY ACCOUNT TYPE. Examples may be | | |
| | | accrued liability, deferred revenue, short-term debt, | | |
| | | current long-term debt, income taxes and accounts | | |
| | | payable. | | |
| | GL Main Account Num | The unique Chart of Account code for the GL | Yes | Yes |
| | | MAIN ACCOUNT. | | |
| CURRENT LIABILITY | Current Liab Account Type Cd | The unique code assigned to the CURRENT | Yes | No |
| ACCOUNT TYPE | | LIABILITY ACCOUNT TYPE. Examples may be | | |
| | | accrued liability, deferred revenue, short-term debt, | | |
| | | current long-term debt, income taxes and accounts | | |
| | | payable. | | |
| | Current Liab Account Type Desc | The description of the CURRENT LIABILITY | No | No |
| | | ACCOUNT TYPE. | | |
| CURRENT LONG TERM DEBT | GL Main Account Num | The unique Chart of Account code for the GL | Yes | Yes |
| ACCOUNT | | MAIN ACCOUNT. | | |
| CUSTOMER FEEDBACK | Feedback Id | Uniquely identifies an instance of Quality | Yes | Yes |
| | | Feedback. Typically system assigned. | | |
| | Feedback Response Cd | Uniquely identifies a FEEDBACK RESPONSE. | No | Yes |
| | Shopping Transaction Id | A unique identifier for this TRAVEL | No | Yes |
| | | TRANSACTION. | | |
| CUSTOMER PREFERENCE | Party Id | The unique identifier for an instance of the PARTY | Yes | Yes |
| | | entity. | | |
| | Preference Cd | The identifier for a personal customer preference. | Yes | Yes |
| | Preference Value Cd | A code that indicates the preference for this | Yes | Yes |
| | | PARTY. | | |
| CUSTOMS FORM | Form Country Cd | The unique code for an instance of the COUNTRY | Yes | Yes |
| | | entity. | | |
| | Form Id | Uniquely identifies a Customs Form (within a | Yes | No |
| | | Country). | | |
| | Form Name | Textual Name of a Customs Form. | No | No |
| | Form Type Cd | Uniquely identifies a Customs Form Type. | No | Yes |
| CUSTOMS FORM PRESENTED | Form Country Cd | The unique code for an instance of the COUNTRY | Yes | Yes |
| | | entity. | | |
| | Form Id | Uniquely identifies a Customs Form (within a | Yes | Yes |
| | | Country). | | |
| | Ship Event Id | Uniquely identifies a SHIPPING EVENT. | Yes | Yes |
| CUSTOMS FORM TYPE | Form Type Cd | Uniquely identifies a Customs Form Type. | Yes | No |
| | Form Type Desc | Textual description of a Customs Form Type. | No | No |
| CUSTOMS REQUIREMENT | Commodity Cd | Uniquely identifies a commodity using a | Yes | Yes |
| | | Classification Standard. | | |
| | Form Country Cd | The unique code for an instance of the COUNTRY | No | Yes |
| | | entity. | | |
| | Form Id | Uniquely identifies a Customs Form (within a | No | Yes |
| | | Country). | | |
| | From Country Cd | The unique code for an instance of the COUNTRY | No | Yes |
| | | entity. | | |
| | Lead Tm | The amount of time prior to actual arrival of goods | No | No |
| | | that the information must be provided to the | | |
| | | Controlling Authority. | | |
| | Requirement Seq Num | Sequential Number used to capture all the Customs | Yes | No |
| | | Forms pertaining to a specific NMFC Code. | | |
| | To Country Cd | The unique code for an instance of the COUNTRY | No | Yes |
| | | entity. | | |
| DAY OF WEEK | Day Of Week Name | The name of the day of the week associated with a | No | No |
| | | CALENDAR DATE. | | |
| | | Example: Monday, Tuesday, etc. | | |
| | Day Of Week Num | Uniquely identifies the day of the week (1-7) | Yes | No |
| DAYPART | Daypart Cd | Uniquely identifies a DAYPART | Yes | No |
| | Daypart Desc | Narrative text describing the daypart. | No | No |
| DAYPART HOURS | Day Of Week Num | Uniquely identifies the day of the week (1-7) | Yes | Yes |
| | Daypart Cd | Uniquely identifies a DAYPART | Yes | Yes |
| | Daypart End Tm | Time of the end of the DAYPART. | No | No |
| | Daypart Start Tm | Start time of the DAYPART. | No | No |
| DEFERRED CHARGE | GL Main Account Num | The unique Chart of Account code for the GL | Yes | Yes |
| ACCOUNT | | MAIN ACCOUNT. | | |
| DEFERRED INCOME TAX | GL Main Account Num | The unique Chart of Account code for the GL | Yes | Yes |
| ACCOUNT | | MAIN ACCOUNT. | | |
| DEFERRED REVENUE | GL Main Account Num | The unique Chart of Account code for the GL | Yes | Yes |
| ACCOUNT | | MAIN ACCOUNT. | | |
| DELAYED DLY | Actual Arrival Dttm ADE TMR | The date and wall clock time of the actual arrival | No | No |
| | | time at the destination location | | |
| | Actual Departure Dttm TMA | The date and wall clock time of the actual | No | No |
| | | departure of the travel vehicle at its originating | | |
| | | location.. | | |
| | Destination Facility Id | Uniquely identifies a LOCATION. | Yes | Yes |
| | Flight Num DFN | A unique identifier assigned to a Flight scheduled | Yes | Yes |
| | | for generating revenue and utilized by the general | | |
| | | public. | | |
| | Leg Incident Num | Allows uniqueness of incidents within a | Yes | Yes |
| | | SCHEDULED LEG. | | |
| | | Note: This will allow multiple incidents of the | | |
| | | same type to occur for a given scheduled leg. | | |
| | Origin Facility Id | Uniquely identifies a LOCATION. | Yes | Yes |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| DELIVERY | Accepting Party Id | The unique identifier for any individual or group of | No | Yes |
| | | individuals that is of interest to the enterprise. | | |
| | Ship Event Id | Uniquely identifies a SHIPPING EVENT. | Yes | Yes |
| DEMOGRAPHIC | Demog Cd | The unique code for an instance of the | Yes | No |
| | | DEMOGRAPHIC entity. | | |
| | Demog Desc | Text that describes an instance of the | No | No |
| | | DEMOGRAPHIC entity. | | |
| | Demog Group Cd | The unique code for an instance of the | No | Yes |
| | | DEMOGRAPHIC GROUP entity. | | |
| | Source Org Party Id | The unique identifier for an organization that is the | No | Yes |
| | | source or supplier of the demographic data. | | |
| DEMOGRAPHIC GROUP | Demog Group Cd | The unique code for an instance of the | Yes | No |
| | | DEMOGRAPHIC GROUP entity. | | |
| | Demog Group Desc | Text that describes an instance of the | No | No |
| | | DEMOGRAPHIC GROUP entity. | | |
| DEMOGRAPHIC VALUE | Demog Cd | The unique code for an instance of the | Yes | Yes |
| | | DEMOGRAPHIC entity. | | |
| | Demog Range End Val | The ending value for a DEMOGRAPHIC VALUE | No | No |
| | | that consists of a range. | | |
| | Demog Range Start Val | The start value for a DEMOGRAPHIC VALUE | No | No |
| | | that consists of a range. | | |
| | Demog Val | The actual value of a DEMOGRAPHIC VALUE. | No | No |
| | Demog Value Cd | A code referencing a specific DEMOGRAPHIC | Yes | No |
| | | VALUE for a given demographic code. | | |
| DENIED REASON | Denied Reason Cd | Code associated with a Denied Boarding, i.e. | Yes | No |
| | | 1 = Mechanical, 2 = Overbooked, etc. | | |
| | Denied Reason Desc | Boarding Denied description associated with each | No | No |
| | | Denied Reason Cd such as Mechanical or Weather | | |
| DEPARTMENT | Department Cd | Uniquely identifies a DEPARTMENT. | Yes | No |
| | Department Name | The name of the DEPARTMENT. | No | No |
| | Division Cd | Uniquely identifies a DIVISION. | No | Yes |
| DEPRECIABLE ASSET | GL Main Account Num | The unique Chart of Account code for the GL | Yes | Yes |
| ACCOUNT | | MAIN ACCOUNT. | | |
| DEPRECIABLE ASSET ACCT | GL Main Account Num | The unique Chart of Account code for the GL | Yes | Yes |
| PAYABLE | | MAIN ACCOUNT. | | |
| DEPRECIABLE ASSET | Deprec Asset Deprec End Dttm | The calendar date and time on which a | No | No |
| DEPRECIATION | | DEPRECIABLE ASSET DEPRECIATION ended. | | |
| | Deprec Asset Deprec Start Dttm | The calendar date and time on which a | Yes | No |
| | | DEPRECIABLE ASSET DEPRECIATION | | |
| | | started. | | |
| | Depreciable Fixed Asset Id | A unique identifier for an asset held by the | Yes | Yes |
| | | organization. | | |
| | Depreciation Method Cd | The code assigned to a DEPRECIATION | Yes | Yes |
| | | METHOD. | | |
| DEPRECIABLE ASSET TYPE | Depreciable Asset Type Cd | The code assigned to a DEPRECIABLE ASSET | Yes | No |
| | | TYPE. | | |
| | Depreciable Asset Type Desc | The description for a DEPRECIABLE ASSET | No | No |
| | | TYPE. | | |
| DEPRECIABLE EQUIPMENT | Deprec Equipmnt Fixed Asset Id | The unique identifier for a DEPRECIABLE | Yes | Yes |
| | | ASSET. In this case, a piece of equipment. | | |
| DEPRECIABLE FIXED ASSET | Depreciable Asset Type Cd | The code assigned to a DEPRECIABLE ASSET | No | Yes |
| | | TYPE. | | |
| | Depreciable Fixed Asset Id | A unique identifier for an asset held by the | Yes | Yes |
| | | organization. | | |
| DEPRECIABLE PROPERTY | Deprec Property Fixed Asset Id | A unique identifier for an asset held by the | Yes | Yes |
| | | organization. | | |
| DEPRECIATION AMOUNT | Depreciation Method Cd | The code assigned to a DEPRECIATION | No | Yes |
| | | METHOD. | | |
| | Fixed Asset Amount Stan Dttm | The calendar date and time on which a FIXED | Yes | Yes |
| | | ASSET AMOUNT started. | | |
| | Fixed Asset Amount Type Cd | The code that describes the Fixed Asset Amount | Yes | Yes |
| | | Type. | | |
| | | Examples are: | | |
| | | Salvage Value | | |
| | | Predicted salvage Value | | |
| | | Original Cost | | |
| | | Adjusted Cost | | |
| | | Depreciation amount | | |
| | | etc. | | |
| | Fixed Asset Id | The unique identifier for a FIXED ASSET. | Yes | Yes |
| DEPRECIATION AND AMORT | GL Sub Account Num | The unique Chart of Account code for the GL SUB | Yes | Yes |
| ACCT | | ACCOUNT. | | |
| DEPRECIATION METHOD | Depreciation Method Cd | The code assigned to a DEPRECIATION | Yes | No |
| | | METHOD. | | |
| | Depreciation Method Desc | The description for a DEPRECIATION METHOD. | No | No |
| DINING LOCATION | Dining Location Id | Uniquely identifies a LOCATION. | Yes | Yes |
| | | A sub-type of LOCATION used for the | | |
| | | sale/consumption of food & drinks. For example, | | |
| | | Bars, Bakeries, Cafes, Restaurants, etc. | | |
| DINING RESERVATION | Dining Location Id | Uniquely identifies a LOCATION. | No | Yes |
| | | A sub-type of LOCATION used for the | | |
| | | sale/consumption of food & drinks. For example, | | |
| | | Bars, Bakeries, Cafes, Restaurants, etc. | | |
| | | For Lodging enterprises, this is also used to | | |
| | | differentiate between in-room and restaurant | | |
| | | location. | | |
| | Property Id | Uniquely identifies a LOCATION. | No | Yes |
| | | A sub-type of LOCATION used to provide | | |
| | | temporary accommodations to customers, business | | |
| | | facilities (conferences, workshops), etc. | | |
| | Property Unit Id | Uniquely defining a distinct and finite amount of | No | Yes |
| | | space that can be rented out to PARTYs such as | | |
| | | Guest Rooms, Conference Rooms, Lawns, etc. | | |
| | | within a lodging property. | | |
| | | Used for in-room dining, or dining not in the | | |
| | | Restaurant location (conference room, etc.). | | |
| | Reservation Seq Num | This attribute identifies a specific RESERVATION | Yes | Yes |
| | | ITEM. | | |
| | Reservation Transaction Id | A unique identifier for this TRAVEL | Yes | Yes |
| | | TRANSACTION. | | |
| | Zone Num | Uniquely identifies an area of interest within a | No | Yes |
| | | Dining Location. | | |
| | | Used to indicate where the dining event will take | | |
| | | place (to be served pool-side, etc.) | | |
| DINING TABLE | Dining Location Id | Uniquely identifies a LOCATION. | Yes | Yes |
| | | A sub-type of LOCATION used for the | | |
| | | sale/consumption of food & drinks. For example, | | |
| | | Bars, Bakeries, Cafes, Restaurants, etc. | | |
| | Seat Cnt | The default number of individuals that can be | No | No |
| | | served at this TABLE. | | |
| | | Note: The actual number of guests served are | | |
| | | indicated in the actual dining transaction area. | | |
| | Table Num | Uniquely identifies a TABLE (serving area) within | Yes | No |
| | | a Dining Location and Zone. | | |
| | Zone Num | Uniquely identifies an area of interest within a | Yes | Yes |
| | | Dining Location. | | |
| DINING TRANSACTION | Dining Location Id | Uniquely identifies a LOCATION. | No | Yes |
| | | A sub-type of LOCATION used for the | | |
| | | sale/consumption of food & drinks. For example, | | |
| | | Bars, Bakeries, Cafes, Restaurants, etc. | | |
| | Dining Tran End Dttm | The date when the guest check was closed | No | No |
| | Dining Tran Start Dttm | The date when the guest check was opened | No | No |
| | Dining Transaction Id | A unique identifier for this TRAVEL | Yes | Yes |
| | | TRANSACTION. | | |
| | Guest Check Total Guest Cnt DD | The total number of guests on a single guest check. | No | No |
| | On-Site Delivery Ind | Was the order provided to the customer on the | No | No |
| | | premises? | | |
| | | “No” indicates an order that was delivered off- | | |
| | | premises. | | |
| | | “Yes” indicates an order that was either picked up | | |
| | | in person, or delivered to a table. | | |
| | On-Site Dining Ind | Was the order consumed on the premises? | No | No |
| | | “No” indicates an order that was delivered, or | | |
| | | provided as “takeout” or “to go” | | |
| | On-Site Order Ind | Was the order placed on the premises? (“No” | No | No |
| | | indicates web or telephone order) | | |
| | Reservation Seq Num | This attribute identifies a specific RESERVATION | No | Yes |
| | | ITEM. | | |
| | Reservation Transaction Id | A unique identifier for this TRAVEL | No | Yes |
| | | TRANSACTION. | | |
| | Room Service Ind | Was this a Room Service Order? | No | No |
| | Table Num | Uniquely identifies a TABLE (serving area) within | No | Yes |
| | | a Dining Location and Zone. | | |
| | | Note: Not used in the case of Room Service. | | |
| | Zone Num | Uniquely identifies an area of interest within a | No | Yes |
| | | Dining Location. | | |
| | | Note: Not used in the case of Room Service. | | |
| DINING TRANSACTION LINE | Dining Transaction Id | A unique identifier for this TRAVEL | Yes | Yes |
| | | TRANSACTION. | | |
| | Dining Transaction Line Num | Identifies a specific line within the DINING | Yes | No |
| | | TRANSACTION | | |
| | Guest Check Id | Uniquely identifies a Guest Check. | No | Yes |
| | Menu Item Id | Unique Identifier for an Item. | No | Yes |
| | | A Hospitality-related offer available for sale to a | | |
| | | PARTY(s). | | |
| | Menu Item Qty | The number of menu items purchased as part of the | No | No |
| | | DINING TRANSACTION | | |
| | Menu Item Selling Price Amt | The cost to the customer for the purchase of the | No | No |
| | | MENU ITEM. | | |
| DINING ZONE | Dining Location Id | Uniquely identifies a LOCATION. | Yes | Yes |
| | | A sub-type of LOCATION used for the | | |
| | | sale/consumption of food & drinks. For example, | | |
| | | Bars, Bakeries, Cafes, Restaurants, etc. | | |
| | Location Zone Cd | Uniquely identifies a Location Zone Type. | No | Yes |
| | Zone Area Meas | The square area size of the Zone expressed in | No | No |
| | | square meters or square feet. | | |
| | Zone Num | Uniquely identifies an area of interest within a | Yes | No |
| | | Dining Location. | | |
| DINING ZONE STAFF | Associate Party Id | An individual who is employed by the enterprise. | Yes | Yes |
| | Dining Location Id | Uniquely identifies a LOCATION. | Yes | Yes |
| | | A sub-type of LOCATION used for the | | |
| | | sale/consumption of food & drinks. For example, | | |
| | | Bars, Bakeries, Cafes, Restaurants, etc. | | |
| | Job Classification Cd EPT | Unique identifier for a JOB CLASSIFICATION. | Yes | Yes |
| | | Note: This attribute is included because an | | |
| | | associate may be scheduled to perform a job | | |
| | | classification other than his/her assigned one. | | |
| | | Example: A Sr. Cashier may be scheduled to act as | | |
| | | Supervisor for a shift (and be paid accordingly). | | |
| | Labor Dt | The date on which labor is to be scheduled. | Yes | Yes |
| | Work Shift Cd | Uniquely identifies a WORK SHIFT. | Yes | Yes |
| | Zone Num | Uniquely identifies an area of interest within a | Yes | Yes |
| | | Dining Location. | | |
| DINING ZONE TYPE | Location Zone Cd | Uniquely identifies a Location Zone Type. | Yes | No |
| | Location Zone Desc | Narrative text describing a Location Zone Type. | No | No |
| DIRECT EARNING | Event Dttm | The date and time that a loyalty event occurred | Yes | Yes |
| | Loyalty Account Id | Uniquely identifies an ACCOUNT. | Yes | Yes |
| | Trip Event Num | A unique number assigned to a TRIP EVENT | No | Yes |
| | | entity. | | |
| DIRECT MAIL AD | Direct Mail Ad Id | The unique identifier for an ad. | Yes | Yes |
| DISASTER | Destination Facility Id | Uniquely identifies a LOCATION. | Yes | Yes |
| | Flight Num DFN | A unique identifier assigned to a Flight scheduled | Yes | Yes |
| | | for generating revenue and utilized by the general | | |
| | | public. | | |
| | Leg Incident Num | Allows uniqueness of incidents within a | Yes | Yes |
| | | SCHEDULED LEG. | | |
| | | Note: This will allow multiple incidents of the | | |
| | | same type to occur for a given scheduled leg. | | |
| | Origin Facility Id | Uniquely identifies a LOCATION. | Yes | Yes |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| DISCOUNT | Discount Cd | Uniquely identifies the DISCOUNT. | Yes | No |
| | Discount Desc | Narrative text describing a DISCOUNT. | No | No |
| | Discount Type Cd | Uniquely identifies a DISCOUNT TYPE. | No | Yes |
| DISCOUNT TYPE | Discount Type Cd | Uniquely identifies a DISCOUNT TYPE. | Yes | No |
| | Discount Type Desc | Narrative text describing a DISCOUNT TYPE. | No | No |
| | Discount Type Name | Short text reference or label for a DISCOUNT | No | No |
| | | TYPE. | | |
| DISTANCE MAP | Distance Meas | The distance measured in miles/kilometers between | No | No |
| | | the ‘From Postal Cd’ to the ‘To Postal Cd’ contained | | |
| | | in this instance of the DISTANCE MAP entity. | | |
| | From Country Cd | The unique code for an instance of the COUNTRY | Yes | Yes |
| | | entity. | | |
| | From Postal Cd | A unique code for an instance of the POSTAL | Yes | Yes |
| | | CODE entity. | | |
| | Source Party Id | The unique identifier for any individual or group of | Yes | Yes |
| | | individuals that is of interest to the enterprise. | | |
| | | The PARTY that published, provided, or created | | |
| | | this information. | | |
| | To Country Cd | The unique code for an instance of the COUNTRY | Yes | Yes |
| | | entity. | | |
| | To Postal Cd | A unique code for an instance of the POSTAL | Yes | Yes |
| | | CODE entity. | | |
| DISTRIBUTION CENTER | Distribution Center Id | Uniquely identifies a LOCATION. | Yes | Yes |
| | | A distribution center or warehouse. | | |
| DISTRICT | District Cd | Uniquely identifies a DISTRICT. | Yes | No |
| | District Mgr Assoc Id | An individual who is employed by the enterprise. | No | Yes |
| | | The manager of the DISTRICT. | | |
| | District Name | Short text reference or label for the DISTRICT. | No | No |
| | Region Cd | Uniquely identifies a REGION. | No | Yes |
| DIVERTED DIV | Destination Facility Id | Uniquely identifies a LOCATION. | Yes | Yes |
| | Flight Num DFN | A unique identifier assigned to a Flight scheduled | Yes | Yes |
| | | for generating revenue and utilized by the general | | |
| | | public. | | |
| | Leg Incident Num | Allows uniqueness of incidents within a | Yes | Yes |
| | | SCHEDULED LEG. | | |
| | | Note: This will allow multiple incidents of the | | |
| | | same type to occur for a given scheduled leg. | | |
| | Origin Facility Id | Uniquely identifies a LOCATION. | Yes | Yes |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| | T&T Facility Id | Uniquely identifies a LOCATION. | No | Yes |
| | | Specifies the Diversion T&T Facility that was used | | |
| | | instead of the Originally Planned Destination. | | |
| DIVIDEND EQUITY ACCOUNT | Dividend Equity Acct Type Cd | The unique code assigned to the DIVIDEND | No | Yes |
| | | EQUITY ACCOUNT TYPE. Types of dividend | | |
| | | equities are common stock and preferred stock. | | |
| | GL Main Account Num | The unique Chart of Account code for the GL | Yes | Yes |
| | | MAIN ACCOUNT. | | |
| DIVIDEND EQUITY ACCOUNT | Dividend Equity Acct Type Cd | The unique code assigned to the DIVIDEND | Yes | No |
| TYPE | | EQUITY ACCOUNT TYPE. Types of dividend | | |
| | | equities are common stock and preferred stock. | | |
| | Dividend Equity Acct Type Desc | The description of the DIVIDEND EQUITY | No | No |
| | | ACCOUNT TYPE. | | |
| DIVISION | Division Cd | Uniquely identifies a DIVISION. | Yes | No |
| | Division Mgr Assoc Id | An individual who is employed by the enterprise. | No | Yes |
| | | The manager of the DIVISION. | | |
| | Division Name | Short text reference or label for a DIVISION. | No | No |
| | Org Party Id | The unique identifier for an organization. | No | Yes |
| | | The ORGANIZATION represented by the | | |
| | | DIVISION. | | |
| DOCUMENT TYPE | Document Type Cd | The unique identifier for the DOCUMENT TYPE. | Yes | No |
| | Document Type Desc | The description for a DOCUMENT TYPE. | No | No |
| DOMAIN IP REASON | Domain IP Reason Cd | A unique code that specifies the type of | Yes | No |
| | | relationship that may exist between an IP Address | | |
| | | and a Domain. | | |
| | Domain IP Reason Desc | A textual description of the Domain IP Reason. | No | No |
| DOMAIN ROOT | Domain Root Cd | A unique identifier for the root of the domain | Yes | No |
| | | server. | | |
| | Domain Root Desc | A textual description of a Domain Root. | No | No |
| DUNNING LETTER | AR Collect Activity Start Dttm | The date and time a AR COLLECTION | Yes | Yes |
| | | ACTIVITY was initiated. | | |
| | AR Collect Activity Type Cd | A code for the types of AR collection activities. | Yes | Yes |
| | | For example: collection opened, collection closed, | | |
| | | customer contacted, follow-up call, follow-up | | |
| | | correspondence, refer to supervisor, promised to | | |
| | | pay, payment received, etc. | | |
| | Dunning Level Cd | The DUNNING LEVEL TYPE placed on this item | No | Yes |
| | | on the printed correspondence (Dunning Letter). If | | |
| | | this scheduled payment did not require this type of | | |
| | | collection action then this field is NULL. | | |
| | | Examples: first, second, final, etc. | | |
| | Payment Schedule Id | A number representing a unique identifier for a | Yes | Yes |
| | | PAYMENT SCHEDULE. | | |
| DUNNING LEVEL TYPE | Dunning Level Cd | The DUNNING LEVEL TYPE placed on this item | Yes | No |
| | | on the printed correspondence (Dunning Letter). If | | |
| | | this scheduled payment did not require this type of | | |
| | | collection action then this field is NULL. | | |
| | | Examples: first, second, final, etc. | | |
| | Dunning Level Desc | A description of the code. | No | No |
| DUNS | Duns Id | Dun & Bradstreet information pertaining to a | Yes | No |
| | | particular business. | | |
| | Duns Num | A number assigned by Dun & Bradstreet and | No | No |
| | | known as the Data Universal Numbering System | | |
| | | (DUNS). It uses a unique 9-digit number to | | |
| | | identify a specific business location, access it in the | | |
| | | D&B information base and link it to parent | | |
| | | companies, subsidiaries and branches throughout | | |
| | | the life of the business. The United Nations and the | | |
| | | U.S. government have endorsed D&B's Number as | | |
| | | a global business identifier for electronic | | |
| | | commerce including Electronic Data Interchange | | |
| | | (EDI) transactions. | | |
| DWELLING TYPE | Dwelling Type Cd | A code that uniquely identifies the DWELLING | Yes | No |
| | | TYPE. | | |
| | Dwelling Type Desc | A description of the Dwelling Type Code. | No | No |
| E LOC REF DIRECTORY | Directory Referral Desc | Textual description of the directory referral. If this | No | No |
| | | attribute is identical to the referral URL, then it | | |
| | | could be removed from the model. | | |
| | Referral Id | A coding method for classifying a REFERRAL. | Yes | Yes |
| E LOC REF SEARCH | Referral Id | A coding method for classifying a REFERRAL. | Yes | Yes |
| | Search Result Desc | Textual description of a search result. | No | No |
| | Search Terms Txt | The terms used in performing search | No | No |
| E LOC REF WEB AD | Referral Id | A coding method for classifying a REFERRAL. | Yes | Yes |
| | Web Ad Placement Id | The unique identifier that identifies a particular | No | Yes |
| | | instance of WEB AD PLACEMENT. | | |
| E LOC REFERRAL TYPE | E Loc Ref Type Cd | A coding method for classifying an E LOC | Yes | No |
| | | REFERRAL TYPE. | | |
| | E Loc Ref Type Desc | Classifies E LOCATION referrals into various sub- | No | No |
| | | types such as Searches, Web Ads, Directories, etc. | | |
| E LOCATION | E Loc Desc | The description of this particular E LOCATION. | No | No |
| | E Loc Name | The name given to this particular E LOCATION. | No | No |
| | E Loc Type Cd | A coding method for classifying an E LOCATION. | No | Yes |
| | E Location Id | Unique value that identifies this particular E | Yes | No |
| | | LOCATION. | | |
| | E Site Id | Unique value that identifies a particular E SITE. | No | Yes |
| E LOCATION REFERRAL | E Loc Ref Type Cd | A coding method for classifying an E LOC | No | Yes |
| | | REFERRAL TYPE. | | |
| | E Location Id | Unique value that identifies this particular E | No | Yes |
| | | LOCATION. | | |
| | Referral Id | A coding method for classifying a REFERRAL. | Yes | Yes |
| | Referring Page URL Txt | The uniform resource locator associated with an E | No | No |
| | | LOCATION. | | |
| E LOCATION TYPE | E Loc Type Cd | A coding method for classifying an E LOCATION. | Yes | No |
| | E Loc Type Desc | Textual description of an E LOCATION TYPE. | No | No |
| E SITE | E Site Id | Unique value that identifies a particular E SITE. | Yes | No |
| | E Site Owner Organization Id | The unique identifier for an organization. | No | Yes |
| | E Site Type Cd | A code used for classifying E SITEs. | No | Yes |
| E SITE TYPE | E Site Type Cd | A code used for classifying E SITEs. | Yes | No |
| | E Site Type Desc | Textual description of the classification of an E | No | No |
| | | SITE. | | |
| EARNING STATEMENT TYPE | Earning Statement Type Cd | A code used to uniquely identify a VENDOR as a | Yes | No |
| | | 1099 type. | | |
| | | A 1099 classification scheme is used in the United | | |
| | | States for types of payments. | | |
| | | Note: U.S.A. centric - replace with appropriate | | |
| | | localized content as needed. | | |
| | Earning Statement Type Desc | The description of the code. | No | No |
| EDUCATIONAL | Educational Party Id | The unique identifier for a Business. | Yes | Yes |
| ORGANIZATION | | An educational institution. | | |
| | | Example: Yale University, Universite Paris, etc. | | |
| ELECTRONIC ADDRESS | Domain Root Cd | A unique identifier for the root of the domain | No | Yes |
| | | server. | | |
| | Electronic Address Domain Name | The name of the InterNic domain registered. | No | No |
| | | Examples: aol, microsoft, earthlink, etc. | | |
| | Electronic Address Id | A number used to uniquely identify an | Yes | Yes |
| | | ELECTRONIC ADDRESS. | | |
| | Electronic Address Txt | The textual part of the email address before the @ | No | No |
| | | symbol | | |
| | Electronic Address Type Cd | A code that uniquely identifies the ELECTRONIC | No | Yes |
| | | ADDRESS TYPE. | | |
| | Email Text Format Ind | Indicates that emails send to this email address | No | No |
| | | should be in text format (not HTML format). | | |
| ELECTRONIC ADDRESS TYPE | Electronic Address Type Cd | A code that uniquely identifies the ELECTRONIC | Yes | No |
| | | ADDRESS TYPE. | | |
| | Electronic Address Type Desc | A description of the ELECTRONIC ADDRESS | No | No |
| | | TYPE. | | |
| EMAIL AD | Email Ad Id | The unique identifier for an ad. | Yes | Yes |
| | | An ad sent via e-mail. | | |
| EMAIL CLIENT APPLICATION | Email Client Appl Ver Num | The version of the Email Client Application. | No | No |
| | Email Client Application Cd | A unique identifier for the email application used | Yes | No |
| | | by a client to read and send email. | | |
| | | Source-> Email application log file. | | |
| | Email Client Application Name | The name of the Email Client Application. | No | No |
| EMAIL REFERRAL | Electronic Address Id | A number used to uniquely identify an | No | Yes |
| | | ELECTRONIC ADDRESS. | | |
| | Email Ad Id | The unique identifier for an ad. | No | Yes |
| | | An ad sent via e-mail. | | |
| | Email Client Application Cd | A unique identifier for the email application used | No | Yes |
| | | by a client to read and send email. | | |
| | | Source-> Email application log file. | | |
| | Referral Id | A coding method for classifying a REFERRAL. | Yes | Yes |
| EMPLOYEE BENEFIT ACCT | GL Sub Account Num | The unique Chart of Account code for the GL SUB | Yes | Yes |
| | | ACCOUNT. | | |
| EMPLOYEE RELATED | GL Sub Account Num | The unique Chart of Account code for the GL SUB | Yes | Yes |
| EXPENSE ACCT | | ACCOUNT. | | |
| ENTER METHOD | Enter Method Cd | Uniquely identifies the ENTER METHOD. | Yes | No |
| | Enter Method Desc | Narrative text describing the ENTER METHOD. | No | No |
| EQUIP (SPARES) LOCATION | Equip Id OIN | Uniquely identifies an Equipment Instance. | No | Yes |
| | Location Id | Uniquely identifies a LOCATION. | Yes | Yes |
| EQUIP CERTIFICATION | Certification Cd | Uniquely identifies an Equipment Certification | Yes | Yes |
| | Equip Class Cd | Uniquely identifies the EQUIP CLASS. | No | Yes |
| EQUIP CLASS | Equip Class Cd | Uniquely identifies the EQUIP CLASS. | Yes | No |
| | Equip Class Desc | Narrative text describing the EQUIP CLASS. | No | No |
| EQUIP ERROR MSG | Equip Error Cd FLT | Uniquely identifies an Equipment Error Message. | Yes | No |
| | Equip Error Txt AMT | The Text displayed (or looked up) for an error | No | No |
| | | message. | | |
| EQUIP EVENT | Equip Event Id ERI | Uniquely identifies a Equipment Event. | Yes | No |
| | Equip Id OIN | Uniquely identifies a piece of Equipment that can | No | Yes |
| | | be used to transport individuals or cargo. | | |
| | Equip Log Entry Id OEI | Uniquely identifies an Equipment Log Entry. | No | Yes |
| | Equip System Cd ATA DTA ACS | Uniquely identifies a MRO Equipment System. | No | Yes |
| | ETOPS Phase Ind | Indicates if the event happened during the ETOPS | No | No |
| | | part of a Leg (if applicable). | | |
| | | Example: “Yes” the event occurred during the | | |
| | | ETOPS part of a Leg. | | |
| | IATA Delay Cause Cd ICE ICN | Uniquely identifies the IATA Delay Cause. | No | Yes |
| | Incident Dttm IOD | The date and time the incident occurred. | No | No |
| | Incident Log Dttm | The date and time the incident was logged.. | No | No |
| | Parent Equip Event Id ICD | Uniquely identifies a Equipment Event. | No | Yes |
| | | Indicates the Parent (or Primary or Initial) Event | | |
| | | that caused the current Event. | | |
| | Reporting Party Id | The unique identifier for any individual or group of | No | Yes |
| | | individuals that is of interest to the enterprise. | | |
| | | The Party that reported the Event. | | |
| EQUIP EVENT MSG | Equip Error Cd FLT | Uniquely identifies an Equipment Error Message. | Yes | Yes |
| | Equip Event Id ERI | Uniquely identifies a Equipment Event. | Yes | Yes |
| EQUIP GAME CONFIG | Game Config Id | Uniquely identifies a specific Game Configuration. | Yes | Yes |
| | Game Equip Id | Uniquely identifies an Equipment Instance. | Yes | Yes |
| EQUIP GAME XREF | Equip Series Id | Uniquely identifies a particular series of | Yes | Yes |
| | | equipment. | | |
| | Game Id | Uniquely identifies a specific Game. | Yes | Yes |
| EQUIP LOG ENTRY (OEI) | Equip Id OIN | Uniquely identifies a piece of Equipment that can | No | Yes |
| | | be used to transport individuals or cargo. | | |
| | Equip Log Entry Id OEI | Uniquely identifies an Equipment Log Entry. | Yes | No |
| EQUIP RELIABILITY SPEC | Claim Qty | The Claimed quantity of reliability measure. | No | No |
| | | Example: 10,000 cycles, 1400 hours, etc. | | |
| | Equip Series Id ASE AEM | Uniquely identifies a particular series of | Yes | Yes |
| | | equipment. | | |
| | Line Num | Uniquely identifies a Reliability Specification | Yes | No |
| | | within a Equipment Series. | | |
| | Reliability Spec Desc | A textual description of the Reliability | No | No |
| | | Specification. | | |
| | UOM Cd | Uniquely identifies a unit of measure. | No | Yes |
| | | The claimed reliability measure UOM. | | |
| EQUIP SERIALIZED CONTENT | Component Position Cd CPI APT | Position or location of the Part relative to the | No | No |
| | | Equipment it is installed in. | | |
| | | Note: This code look-up table must be supplied by | | |
| | | the airline in conjunction with Spec 2000 | | |
| | | definitions. | | |
| | End Dttm | Marks the end of the association between a | No | No |
| | | Serialized Part and the Equipment it is installed in. | | |
| | Equip Id OIN | Uniquely identifies an Equipment Instance. | Yes | Yes |
| | Start Dttm | Marks the beginning of the association between a | Yes | No |
| | | Serialized Part and the Equipment it is installed in. | | |
| | Univ Serial Num USN | The unique serial number for ITEMs that are | Yes | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| EQUIP SERIES | Equip Series Id ASE AEM | Uniquely identifies a particular series of | Yes | No |
| | | equipment. | | |
| | Equipment Model Cd AMC AET | A model code for a piece of equipment - typically | No | Yes |
| | | provided by the Manufacturer. | | |
| | ETOPS Cd EFI | Applies to Aircraft. | No | Yes |
| | | ETOPS (Extended-range Twin-engine Operation | | |
| | | Performance Standards). | | |
| | | If the Aircraft is approved for extended flight away | | |
| | | from an emergency of diversion airport, this will | | |
| | | indicate the certified ETOPS Rating. | | |
| | | Example: | | |
| | | ETOPS-90 | | |
| | | ETOPS-120/138 | | |
| | | ETOPS-180/207 | | |
| | Manuf Party Id | The unique identifier for a Business. | No | Yes |
| | | Party that manufactures goods, equipment, etc. | | |
| EQUIP SERIES CONTENT | Equip Series Id ASE AEM | Uniquely identifies a particular series of | Yes | Yes |
| | | equipment. | | |
| | Install Item Qty | The number of Items installed in the configuration. | No | No |
| | MMEL Item Qty | The Manufacturer's Minimum Equipment Fly List | No | No |
| | | (MMEL) quantity for dispatch. | | |
| | | The minimum quantity installed for the Equipment | | |
| | | to still qualify to be dispatched. | | |
| | MMEL Max Days Cnt | When Equipment is dispatched with less than the | No | No |
| | | Installed MMEL Item quantity (but equal or greater | | |
| | | than the MMEL quantity), a maximum number of | | |
| | | days for repair/replacement can be specified to | | |
| | | bring the quantity back up to the specified original | | |
| | | install quantity. | | |
| | MMEL Remarks Txt | All exceptions and further remarks, conditions, etc. | No | No |
| | | governing MMEL. | | |
| | | Example: 2 Air Conditioners installed in the hold | | |
| | | BUT can dispatch with 0 working UNLESS live | | |
| | | animals are transported in the hold. | | |
| | MRO Item Id ASN | Unique Identifier for an Item. | Yes | Yes |
| | | Items that are used or consumed during | | |
| | | Maintenance Repair Operations. | | |
| EQUIP SPEC | Equip Class Cd | Uniquely identifies the EQUIP CLASS. | Yes | Yes |
| | Estimated Cost Amt | The estimated equipment (tool) cost of this type to | No | No |
| | | perform this MRO Specification. | | |
| | MRO Spec Id OII | Uniquely identifies a MRO Specification. | Yes | Yes |
| | Plan Hours Tm | The Amount of Time Equipment (Tools) of this | No | No |
| | | type is required to complete this MRO | | |
| | | Specification. | | |
| | Plan Qty | The Number of pieces of Equipment (Tools) of this | No | No |
| | | type required to perform this MRO Specification. | | |
| EQUIP SVC HIST | Equip Id OIN | Uniquely identifies an Equipment Instance. | Yes | Yes |
| | Out Of Service Dttm ODD | The date on which Equipment is removed from | Yes | No |
| | | Service (typically for Maintenance purposes) | | |
| | | Example: | | |
| | | Equipment was removed from service on | | |
| | | 1/3/2005 to enable C Check Maintenance to be | | |
| | | done. | | |
| | | Equipment was removed from service on | | |
| | | 5/5/2005 due to rising fuel prices. | | |
| | | All maintenance related service interruptions can | | |
| | | also be seen in the Maintenance Event area. | | |
| | Out Of Svc Rsn Cd | Uniquely identifies a Reason for Removing | No | Yes |
| | | Equipment from Service. | | |
| | Return To Service Dttm ASD | The date and time on which Equipment is placed | No | No |
| | | back in Service (typically after a temporary | | |
| | | removal from Service for Maintenance purposes) | | |
| | | Example: | | |
| | | Equipment return to service on 3/3/2005 after D | | |
| | | Check completion. | | |
| | | All maintenance related service interruptions can | | |
| | | also be seen in the Maintenance Event area. | | |
| EQUIP TIME CYCLE | Cycle Cnt CTY ETC ATC | Total Operating Cycles for the Period. | No | No |
| | Equip Id OIN | Uniquely identifies an Equipment instance. | Yes | Yes |
| | ETOPS Cycle Cnt ETL | Total ETOPS Operating Cycles for the Period. | No | No |
| | ETOPS Operating Tm ETF | Total ETOPS Operating Time for the Period. | No | No |
| | ETOPS Rev Depart Cnt ETR | Total ETOPS Revenue Departures for the Period. | No | No |
| | Operating Tm CTH ETH ATH | Total Operating Time for the Period. | No | No |
| | Period End Dttm | Date and Time of CycleTime Totals. | No | No |
| | Period Start Dttm | The Start of the measuring Period. | No | No |
| EQUIP TYPE | Equip Type Cd | Uniquely identifies an Equipment Type. | Yes | No |
| | Equip Type Desc | Textual description of an Equipment Type. | No | No |
| EQUIPMENT | Equip Class Cd | Uniquely identifies the EQUIP CLASS. | No | Yes |
| | Equip Id OIN | Uniquely identifies an Equipment Instance. | Yes | Yes |
| | Equip Series Id ASE AEM | Uniquely identifies a particular series of | No | Yes |
| | | equipment. | | |
| | Equip Type Cd | Uniquely identifies an Equipment Type. | No | Yes |
| | In Service Dt OSD | Date the EQUIPMENT was first placed into | No | No |
| | | service by the Enterprise. | | |
| | Initial In Service Dt | The first time (EVER) the Equipment was placed | No | No |
| | | in service. | | |
| | | Typically used when the Equipment was purchased | | |
| | | used - since even though the In Service Date may | | |
| | | be only 2 months in the past, the Equipment may | | |
| | | have been In Service for the past 10 years.. | | |
| | Manuf Serial Num AIN EMS | The Serial Number as assigned by the | No | No |
| | | Manufacturer. | | |
| | Manufacture Dt ARD | The date the Equipment was manufactured. | No | No |
| | Owner Party Id | The unique identifier for any individual or group of | No | Yes |
| | | individuals that is of interest to the enterprise. | | |
| | | Indicates the actual owner of the EQUIPMENT | | |
| | | (for rented EQUIPMENT). | | |
| | Retire Dt | The date the Enterprise permanently retired the | No | No |
| | | Equipment from service, such as when it is sold or | | |
| | | scrapped. | | |
| EQUIPMENT MODEL | Equipment Model Cd AMC AET | A model code for a piece of equipment - typically | Yes | No |
| | | provided by the Manufacturer. | | |
| | Equipment Model Desc | Narrative text describing the EQUIPMENT | No | No |
| | | MODEL. | | |
| | Manuf Party Id | The unique identifier for a Business. | Yes | Yes |
| | | Party that manufactures goods, equipment, etc. | | |
| EQUIPMENT SUBSTITUTION | Destination Facility Id | Uniquely identifies a LOCATION. | Yes | Yes |
| SUB | | | | |
| | Equip Id OIN | Uniquely identifies a piece of Equipment that can | No | Yes |
| | | be used to transport individuals or cargo. | | |
| | Flight Num DFN | A unique identifier assigned to a Flight scheduled | Yes | Yes |
| | | for generating revenue and utilized by the general | | |
| | | public. | | |
| | Leg Incident Num | Allows uniqueness of incidents within a | Yes | Yes |
| | | SCHEDULED LEG. | | |
| | | Note: This will allow multiple incidents of the | | |
| | | same type to occur for a given scheduled leg. | | |
| | Origin Facility Id | Uniquely identifies a LOCATION. | Yes | Yes |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| EQUITY ACCOUNT | Equity Account Type Cd | The unique code assigned to the EQUITY | No | Yes |
| | | ACCOUNT TYPE. Types of EQUITY | | |
| | | ACCOUNTs include dividend equity and non- | | |
| | | dividend equity. | | |
| | GL Main Account Num | The unique Chart of Account code for the GL | Yes | Yes |
| | | MAIN ACCOUNT. | | |
| EQUITY ACCOUNT TYPE | Equity Account Type Cd | The unique code assigned to the EQUITY | Yes | No |
| | | ACCOUNT TYPE. Types of EQUITY | | |
| | | ACCOUNTs include dividend equity and non- | | |
| | | dividend equity. | | |
| | Equity Account Type Desc | The description of the EQUITY ACCOUNT | No | No |
| | | TYPE. | | |
| EQUITY SURPLUS ACCOUNT | GL Main Account Num | The unique Chart of Account code for the GL | Yes | Yes |
| | | MAIN ACCOUNT. | | |
| ETHNICITY | Ethnicity Cd | A unique identifier for an individual's ethnicity. | Yes | No |
| | Ethnicity Desc | A description of the individual's ethnicity. | No | No |
| ETOPS RATING | ETOPS Cd EFI | Applies to Aircraft. | Yes | No |
| | | ETOPS (Extended-range Twin-engine Operation | | |
| | | Performance Standards). | | |
| | | If the Aircraft is approved for extended flight away | | |
| | | from an emergency of diversion airport, this will | | |
| | | indicate the certified ETOPS Rating. | | |
| | | Example: | | |
| | | ETOPS-90 | | |
| | | ETOPS-120/138 | | |
| | | ETOPS-180/207 | | |
| EVENT COST | Cost Cd | Uniquely identifies a COST. | Yes | Yes |
| | Event Cost Amt | The cost incurred for the Cost classification for the | No | No |
| | | Group Event. | | |
| | Group Event Id | A unique identifier for the GROUP EVENT | Yes | Yes |
| EXCEPTION | Exception Cd | Uniquely identifies an EXCEPTION. | Yes | No |
| | Exception Desc | Narrative text describing the EXCEPTION. | No | No |
| EXCEPTION REASON | Exception Reason Cd | Uniquely identifies an Exception Reason | Yes | No |
| | Exception Reason Desc | Narrative text describing the reason for exception. | No | No |
| EXCHANGE AWARD | Award Voucher Id | The identifier of a loyalty award or certificate | Yes | Yes |
| | | awarded to a customer account. | | |
| EXPENSE ACCOUNT | Expense Account Type Cd | The unique code assigned to the EXPENSE | No | Yes |
| | | ACCOUNT TYPE. Types of expense accounts | | |
| | | include operating expense, interest expense and | | |
| | | other expense. | | |
| | GL Main Account Num | The unique Chart of Account code for the GL | Yes | Yes |
| | | MAIN ACCOUNT. | | |
| EXPENSE ACCOUNT TYPE | Expense Account Type Cd | The unique code assigned to the EXPENSE | Yes | No |
| | | ACCOUNT TYPE. Types of expense accounts | | |
| | | include operating expense, interest expense and | | |
| | | other expense. | | |
| | Expense Account Type Desc | The description of the EXPENSE ACCOUNT | No | No |
| | | TYPE. | | |
| EXT AIRLINE SALES | Adjusted Passenger Cnt | The total number of passengers flown for the | No | No |
| | | specified period adjusted to exclude frequent flyer | | |
| | | and free passengers | | |
| | Adjusted Revenue Amt | The sum of all revenue collected from flown | No | No |
| | | passengers for the specified period adjusted to | | |
| | | exclude frequent flyer and free passengers. | | |
| | Airline Org Id | The unique identifier for an organization. | Yes | Yes |
| | | Identifies the Organization that provides a Product. | | |
| | ASM/K Cnt | Available Seat Mile/Kilometers = Total | No | No |
| | | Miles(Kilometers) flown * Total Seats (empty and | | |
| | | filled) on Flights | | |
| | Average Fare Amt | The average Fare paid by all flown passengers for | No | No |
| | | the specified period adjusted to exclude frequent | | |
| | | flyer and free passengers. | | |
| | Flight Product Id | Unique Identifier for an Item. | Yes | Yes |
| | | A distance based TRAVEL PRODUCT that is | | |
| | | defined by Origination and Destination (O&D), | | |
| | | weekday of departure and time of departure. | | |
| | | An Airline Flight. | | |
| | Market Statistic Effective Dt | The calendar day that the statistics has been | Yes | No |
| | | accumulated and effective. | | |
| | | Note: The Effective date and End Date indicate a | | |
| | | span of time and, together, specify a time period | | |
| | | over which the statistics were collected. | | |
| | Market Statistic End Dt | The calendar day that the statistics are no longer | No | No |
| | | relevant. | | |
| | | Note: The Effective date and End Date indicate a | | |
| | | span of time and, together, specify a time period | | |
| | | over which the statistics were collected | | |
| | RASM/K Amt | Revenue per Available Seat Mile/Kilometer | No | No |
| | | Total Revenue for flown flights divided by | | |
| | | ASM/K, expressed as an amount. | | |
| EXT CASINO BUSINESS | Casino Hold Pct DD | The aggregate percentage of the Turnover Amount | No | No |
| | | that was retained by the Casino for this Game | | |
| | | Type. | | |
| | Casino Id | Uniquely identifies a LOCATION. | Yes | Yes |
| | | A sub-type of LOCATION where customers VISIT | | |
| | | for gambling and entertainment. | | |
| | Game Type Cd | Code that identifies the specific type of Casino | Yes | Yes |
| | | Game. | | |
| | Gamestation Cnt | The number of gaming stations for the game type. | No | No |
| | Net Player Win Amt DD | The total net amount won by the player. | No | No |
| | | This can be calculated by subtracting the total buy- | | |
| | | in amount from the total payout amount. | | |
| | | This amount can be negative or positive. | | |
| | Period Buy-in Amt | The total amount the player presents to wager with. | No | No |
| | | Note: This is not the same as the wagered amount, | | |
| | | since the entire buy-in amount can usually be | | |
| | | retracted by the player prior to, or instead of | | |
| | | placing it at risk. | | |
| | | Also known as coin-in, drop, etc., depending on | | |
| | | game type. | | |
| | Period End Dttm | End of the reponing period. | No | No |
| | Period Jackpot Amt | The total amount of jackpots won by the player. | No | No |
| | Period Payout Amt | The total amount paid out to the player. | No | No |
| | | Note: To get the net player win/loss, this amount | | |
| | | needs to be subtracted from the buy-in amount. | | |
| | Period Start Dttm | Start of the reporting period. | Yes | No |
| | Period Turnover Amt | This is the total amount actually wagered (or | No | No |
| | | placed at risk) by the player. | | |
| | | Note that this amount can greatly exceed the buy-in | | |
| | | amount. | | |
| | | Also known as Handle, Gross (or Total) Wager | | |
| | | Amount, etc., depending on game type. | | |
| EXT LOCATION | Ext Location Id | Uniquely identifies a LOCATION. | Yes | Yes |
| | | A LOCATION that belongs to (or is used by) a | | |
| | | third PARTY (external to the enterprise). | | |
| | Local Sales Territory Id | Unique identifier for a LOCAL SALES | No | Yes |
| | | TERRITORY. | | |
| | | The Sales Territory of the enterprise responsible for | | |
| | | servicing this external (Customer) location. | | |
| | Servicing Location Id | Uniquely identifies a LOCATION. | No | Yes |
| | | Identifies the enterprise location that has the | | |
| | | responsibility for servicing this external location. | | |
| EXT SERVICES RENDERED | GL Sub Account Num | The unique Chart of Account code for the GL SUB | Yes | Yes |
| ACCT | | ACCOUNT. | | |
| EXTERNAL COUPON | Coupon Issuing Org Party Id | The unique identifier for an organization. | No | Yes |
| | | This may be the product manufacturer or another | | |
| | | organization that issues the coupon to the customer. | | |
| | External Coupon Desc | Narrative text describing the EXTERNAL | No | No |
| | | COUPON. | | |
| | External Coupon Id | Uniquely identifies an EXTERNAL COUPON. | Yes | No |
| | External Coupon Value Amt | The discount (redemption) value of the coupon. | No | No |
| EXTERNAL ORGANIZATION | External Org Party Id | The unique identifier for an external organization. | Yes | Yes |
| | External Org Type Cd | A unique identifier for the type of external | No | Yes |
| | | organization. | | |
| EXTERNAL ORGANIZATION | External Org Type Cd | A unique identifier for the type of external | Yes | No |
| TYPE | | organization. | | |
| | External Org Type Desc | A textual description of the code. | No | No |
| EXTERNAL PROJECT | Project Id | The unique identifier for the PROJECT. | Yes | Yes |
| FACILITY OP EXPENSE | GL Main Account Num | The unique Chart of Account code for the GL | Yes | Yes |
| ACCOUNT | | MAIN ACCOUNT. | | |
| FARE BASIS | Booking Class Cd | The booking class code associated with this | No | Yes |
| | | particular booking, (i.e. F, Y, M, etc.). | | |
| | Fare Basis Cd | The unique codes used to determine the basis of the | Yes | No |
| | | Fare charged to PARTYs for the purchase of a | | |
| | | PRODUCT or PACKAGE. | | |
| | Fare Basis Desc | A brief explanation of the basis of the Fare charged | No | No |
| | | to the PARTY for the purchase of a PRODUCT or | | |
| | | PACKAGE. | | |
| FEEDBACK | Event Dttm | The date and time of the event that is being | No | No |
| | | reported on (if applicable). | | |
| | | Example: | | |
| | | “I visited your store on this date and time, and the | | |
| | | restrooms were dirty” | | |
| | Event Resolution Dt | The date that an action was taken to resolve the | No | No |
| | | feedback. | | |
| | Feedback Id | Uniquely identifies an instance of Quality | Yes | No |
| | | Feedback. Typically system assigned. | | |
| | Group Survey Id | Uniquely identifies a Quality Group Event. | No | Yes |
| | | Used of the feedback was solicited during a Quality | | |
| | | Group Event. | | |
| | Location Id | Uniquely identifies a LOCATION. | No | Yes |
| | | The location that is the subject of the feedback (or | | |
| | | where the feedback occurred), if applicable | | |
| | Quality Resolution Cd | Uniquely identifies a Quality Resolution. | No | Yes |
| | Reporting Dttm | The date and time the feedback was reported. | No | No |
| | Reporting Party Id | The unique identifier for any individual or group of | No | Yes |
| | | individuals that is of interest to the enterprise. | | |
| | | The Party that is providing the feedback (if | | |
| | | known). | | |
| FEEDBACK CLASS | Feedback Class Cd | Uniquely identifies a Feedback Class. | Yes | No |
| | Feedback Class Desc | Narrative text describing the Feedback Class. | No | No |
| | Feedback Type Cd | Uniquely identifies a Feedback Type. | Yes | Yes |
| FEEDBACK DETAIL | Associate Party Id | An individual who is employed by the enterprise. | No | Yes |
| | | The associate that prompted the feedback provided | | |
| | | (if applicable). | | |
| | Feedback Id | Uniquely identifies an instance of Quality | Yes | Yes |
| | | Feedback. Typically system assigned. | | |
| | Feedback Verbose Txt | The actual feedback comments received. | No | No |
| | | This could be the actual contents of a customer | | |
| | | letter, or a synopsis of a telephone call received. | | |
| | | Note: Not very useful for data mining, but helpful | | |
| | | in resolving individual customer issues. | | |
| | Item Id | Unique Identifier for an Item. | No | Yes |
| | | The Item, Service, or Product that prompted, or is | | |
| | | related to the feedback. | | |
| | Quality Event Seq Num | Uniquely identifies a specific detail item of | Yes | No |
| | | feedback. | | |
| | Quality Rating Num | The response to a feedback item expressed as a | No | No |
| | | number. | | |
| | | Example: | | |
| | | rated ‘friendliness of staff’ as a 3 out of 5 | | |
| | Quality Rating Txt | The response to a feedback item expressed in text | No | No |
| | | format. | | |
| | | Example: | | |
| | | qualified service as “slow” or “bad” | | |
| | Trait Cd | Uniquely identifies a TRAIT. | No | Yes |
| | Trait Value Cd | Uniquely identifies a TRAIT. | No | Yes |
| | | The trait or characteristic that feedback was | | |
| | | provided about. | | |
| | | The Trait attributes are needed if the survey | | |
| | | questions are more specific than can be provided | | |
| | | for by the broad feedback class attributes. | | |
| FEEDBACK RESPONSE | Feedback Response Cd | Uniquely identifies a FEEDBACK RESPONSE. | Yes | No |
| | Feedback Response Desc | Narrative text describing the FEEDBACK | No | No |
| | | RESPONSE. | | |
| FEEDBACK TYPE | Feedback Type Cd | Uniquely identifies a Feedback Type. | Yes | No |
| | Feedback Type Desc | Narrative text describing the Feedback Type. | No | No |
| FINANCIAL PLAN | Financial Plan Desc | The description of the FINANCIAL PLAN. | No | No |
| | Financial Plan End Dttm | The FINANCIAL PLAN's end date. | No | No |
| | Financial Plan Id | The unique identifier assigned to the FINANCIAL | Yes | No |
| | | PLAN. | | |
| | Financial Plan Name | The name assigned to the FINANCIAL PLAN. | No | No |
| | Financial Plan Revision Dttm | The FINANCIAL PLAN revision date. | No | No |
| | Financial Plan Revision Num | The revision number of the FINANCIAL PLAN. | No | No |
| | Financial Plan Start Dttm | The FINANCIAL PLAN's start date. | No | No |
| | Financial Plan Status Cd | The unique code assigned to the FINANCIAL | No | Yes |
| | | PLAN STATUS. | | |
| FINANCIAL PLAN BALANCE | Financial Plan Id | The unique identifier assigned to the FINANCIAL | Yes | Yes |
| | | PLAN. | | |
| | Financl Pln Bal COA Id | The unique identifier for a CHART OF | Yes | Yes |
| | | ACCOUNT, or alias for a complete CHART OF | | |
| | | ACCOUNTs number. | | |
| | Financl Pln Bal End Amt | The monetary amount of the FINANCIAL PLAN | No | No |
| | | BALANCE for the account at the end of the | | |
| | | accounting period. | | |
| | | In the local accounting currency. | | |
| | Financl Pln Bal End Dttm | The end date for the FINANCIAL PLAN | No | No |
| | | BALANCE. | | |
| | Financl Pln Bal Glbl End Amt | The monetary amount of the FINANCIAL PLAN | No | No |
| | | BALANCE for the account at the end of the | | |
| | | accounting period. | | |
| | | In the global accounting currency. | | |
| | Financl Pln Bal Glbl Start Amt | The monetary amount of the FINANCIAL PLAN | No | No |
| | | BALANCE for the account at the start of the | | |
| | | accounting period. | | |
| | | In the global accounting currency. | | |
| | Financl Pln Bal Start Amt | The monetary amount of the FINANCIAL PLAN | No | No |
| | | BALANCE for the account at the start of the | | |
| | | accounting period. | | |
| | | In the local accounting currency. | | |
| | Financl Pln Bal Start Dttm | The start date for the FINANCIAL PLAN | Yes | No |
| | | BALANCE. | | |
| FINANCIAL PLAN STATUS | Financial Plan Status Cd | The unique code assigned to the FINANCIAL | Yes | No |
| | | PLAN STATUS. | | |
| | Financial Plan Status Desc | The description of the FINANCIAL PLAN | No | No |
| | | STATUS. | | |
| FINANCL PLAN PROJ TASK | Financial Plan Id | The unique identifier assigned to the FINANCIAL | Yes | Yes |
| RESOURC | | PLAN. | | |
| | Financl Pln Proj Brd Cost Rate | The burden rate assigned to the Project Task | No | No |
| | | Resource for Financial Plan Purposes. | | |
| | Financl Pln Proj Res Cost Rate | The cost rate associated with the Project Task | No | No |
| | | Resource for Financial Plan Purposes. | | |
| | Financl Pln Proj Res Crncy Cd | The code assigned to a transaction CURRENCY. | No | Yes |
| | Financl Pln Proj Task UOM Cd | Uniquely identifies a unit of measure. | No | Yes |
| | | The unit of measure associated with the Project | | |
| | | Task Resource Item quantity. | | |
| | Financl Pln Proj Tsk Bill Rate | The billing rate assigned to the Project Task | No | No |
| | | Resource for Financial Plan purposes. | | |
| | Financl Pln Proj Tsk Itm Qty | The quantity of a Resource Item assigned to a | No | No |
| | | Project Task for the Financial Plan. | | |
| | Proj Task Resource Id | The unique identifier assigned to a Project Task | Yes | Yes |
| | | Resource. | | |
| | Proj Task Resource Start Dttm | The calendar date and time a PROJECT TASK | Yes | Yes |
| | | RESOURCE ASSIGN started. | | |
| | Project Id | The unique identifier for the PROJECT. | Yes | Yes |
| | Project Task Start Dttm | The calendar date and time a PROJECT TASK | Yes | Yes |
| | | started. | | |
| | Task Id | The unique identifier assigned to a TASK. | Yes | Yes |
| FIXED ASSET | Fixed Asset Acquire Dttm | The date the FIXED ASSET was acquired. | No | No |
| | Fixed Asset Address Id | A number used to uniquely identify an ADDRESS. | No | Yes |
| | | In this case, the ADDRESS associated with the | | |
| | | FIXED ASSET. | | |
| | Fixed Asset Currency Cd | The code assigned to a transaction CURRENCY. | No | Yes |
| | Fixed Asset Desc | The description for a FIXED ASSET. | No | No |
| | Fixed Asset Id | The unique identifier for a FIXED ASSET. | Yes | Yes |
| | Fixed Asset Location Id | Uniquely identifies a LOCATION. | No | Yes |
| | Fixed Asset Managing Party Id | The unique identifier for any individual or group of | No | Yes |
| | | individuals that is of interest to the enterprise. | | |
| | Fixed Asset Mfg Party Id | The unique identifier for any individual or group of | No | Yes |
| | | individuals that is of interest to the enterprise. | | |
| | | In this case, the PARTY that originally | | |
| | | manufactured the FIXED ASSET. | | |
| | Fixed Asset Name | The name of a FIXED ASSET. | No | No |
| | Fixed Asset New Used Ind | Indicates whether the FIXED ASSET was new or | No | No |
| | | used when acquired. | | |
| | Fixed Asset Ownershp Type Cd | The code assigned to the FIXED ASSET | No | Yes |
| | | OWNERSHIP TYPE. | | |
| | Fixed Asset Type Cd | The code assigned to a FIXED ASSET TYPE. | No | Yes |
| | Fixed Asset Useful Life End Dt | The end date for the period of time over which a | No | No |
| | | depreciable asset is expected to provide a | | |
| | | productive return. | | |
| FIXED ASSET ACCOUNT | Fixed Asset Account Type Cd | The unique code assigned to the fixed ASSET GL | No | Yes |
| | | Account type. Examples may be depreciable asset | | |
| | | account or non-depreciable asset account. | | |
| | GL Main Account Num | The unique Chart of Account code for the GL | Yes | Yes |
| | | MAIN ACCOUNT. | | |
| FIXED ASSET ACCOUNT TYPE | Fixed Asset Account Type Cd | The unique code assigned to the fixed ASSET GL | Yes | No |
| | | Account type. Examples may be depreciable asset | | |
| | | account or non-depreciable asset account. | | |
| | Fixed Asset Account Type Desc | The description of the fixed ASSET type. | No | No |
| FIXED ASSET AMOUNT | Fixed Asset Amount Amt | The numeric value indicating the monetary value of | No | No |
| | | a FIXED ASSET. | | |
| | Fixed Asset Amount Currency Cd | The code assigned to a transaction CURRENCY. | No | Yes |
| | Fixed Asset Amount Deprec Ind | The indicator that a DEPRECIATION AMOUNT | No | No |
| | | exist. | | |
| | Fixed Asset Amount End Dttm | The calendar date and time on which a FIXED | No | No |
| | | ASSET AMOUNT ended. | | |
| | Fixed Asset Amount Start Dttm | The calendar date and time on which a FIXED | Yes | No |
| | | ASSET AMOUNT started. | | |
| | Fixed Asset Amount Type Cd | The code that describes the Fixed Asset Amount | Yes | Yes |
| | | Type. | | |
| | | Examples are: | | |
| | | Salvage Value | | |
| | | Predicted salvage Value | | |
| | | Original Cost | | |
| | | Adjusted Cost | | |
| | | Depreciation amount | | |
| | | etc. | | |
| | Fixed Asset COA Id | The unique identifier for a CHART OF | No | Yes |
| | | ACCOUNT, or alias for a complete CHART OF | | |
| | | ACCOUNTs number. | | |
| | Fixed Asset Id | The unique identifier for a FIXED ASSET. | Yes | Yes |
| | Ledger Batch Id | The unique identifier for the general/sub LEDGER | No | Yes |
| | | BATCH processing. | | |
| FIXED ASSET AMOUNT TYPE | Fixed Asset Amount Type Cd | The code for the FIXED ASSET AMOUNT TYPE. | Yes | No |
| | Fixed Asset Amount Type Desc | The description for the FIXED ASSET AMOUNT | No | No |
| | | TYPE. | | |
| FIXED ASSET BOOK | Fixed Asset Id | The unique identifier for a FIXED ASSET. | Yes | Yes |
| | Set Of Books Cd | The unique identifier for the SET OF BOOKS. | Yes | Yes |
| | Set Of Books Start Dttm | The date marking the beginning for a SET OF | Yes | Yes |
| | | BOOKS. | | |
| FIXED ASSET GROUP | Fixed Asset Group Desc | The description for the FIXED ASSET GROUP. | No | No |
| | Fixed Asset Group Id | Fixed Asset Group Id is assigned to identify a | Yes | No |
| | | unique asset collection. | | |
| | Fixed Asset Group Name | The name for the FIXED ASSET GROUP. | No | No |
| FIXED ASSET GROUP ASSIGN | Fixed Asset Group End Dttm | The date and time the FIXED ASSET GROUP | No | No |
| | | assignment ended. | | |
| | Fixed Asset Group Id | Fixed Asset Group Id is assigned to identify a | Yes | Yes |
| | | unique asset collection. | | |
| | Fixed Asset Group Start Dttm | The date and time the FIXED ASSET GROUP | Yes | No |
| | | assignment started. | | |
| | Fixed Asset Id | The unique identifier for a FIXED ASSET. | Yes | Yes |
| FIXED ASSET IDENTIFICATION | Fixed Asset Id | The unique identifier for a FIXED ASSET. | Yes | Yes |
| | Fixed Asset Ident End Dttm | The date and time a FIXED ASSET | No | No |
| | | IDENTIFICATION ended. | | |
| | Fixed Asset Ident Num | Holds the number assigned to the FIXED ASSET | No | No |
| | | IDENTIFICATION. | | |
| | | Examples are serial number or asset tag ID number. | | |
| | Fixed Asset Ident Start Dttm | The date and time a FIXED ASSET | Yes | No |
| | | IDENTIFICATION started. | | |
| | Fixed Asset Ident Type Cd | The code assigned to a FIXED ASSET | Yes | Yes |
| | | IDENTIFICATN TYPE. | | |
| FIXED ASSET IDENTIFICATN | Fixed Asset Ident Type Cd | The code assigned to a FIXED ASSET | Yes | No |
| TYPE | | IDENTIFICATN TYPE. | | |
| | Fixed Asset Ident Type Desc | Describes a FIXED ASSET IDENTIFICATN | No | No |
| | | TYPE. | | |
| FIXED ASSET OWNERSHIP | Fixed Asset Ownershp Type Cd | The code assigned to the FIXED ASSET | Yes | No |
| TYPE | | OWNERSHIP TYPE. | | |
| | Fixed Asset Ownershp Type Desc | The description of the FIXED ASSET | No | No |
| | | OWNERSHIP TYPE. | | |
| FIXED ASSET PO ASSIGN | Fixed Asset Id | The unique identifier for a FIXED ASSET. | Yes | Yes |
| | Vend PO Ln Num | A number representing a unique line on a | Yes | Yes |
| | | VENDOR PO LINE. | | |
| | Vendor PO Id | The unique identifier of a specific VENDOR PO. | Yes | Yes |
| FIXED ASSET STATUS ASSIGN | Fixed Asset Id | The unique identifier for a FIXED ASSET. | Yes | Yes |
| | Fixed Asset Status End Dttm | The date and time a FIXED ASSET STATUS | No | No |
| | | ASSIGN assigned to a Fixed Asset Id ended. | | |
| | Fixed Asset Status Party Id | The unique identifier for any individual or group of | No | Yes |
| | | individuals that is of interest to the enterprise. | | |
| | | The party id for the party who assigned the status | | |
| | | to the FIXED ASSET. | | |
| | Fixed Asset Status Start Dttm | The date and time a FIXED ASSET STATUS | Yes | No |
| | | ASSIGN was assigned to a Fixed Asset Id. | | |
| | Fixed Asset Status Type Cd | The code assigned to a FIXED ASSET STATUS | Yes | Yes |
| | | TYPE. | | |
| FIXED ASSET STATUS TYPE | Fixed Asset Status Type Cd | The code assigned to a FIXED ASSET STATUS | Yes | No |
| | | TYPE. | | |
| | Fixed Asset Status Type Desc | The description of the FIXED ASSET STATUS | No | No |
| | | TYPE. | | |
| FIXED ASSET TYPE | Fixed Asset Type Cd | The code assigned to a FIXED ASSET TYPE. | Yes | No |
| | Fixed Asset Type Desc | The description for the FIXED ASSET TYPE. | No | No |
| FLIGHT | Airline Org Id | The unique identifier for an organization. | No | Yes |
| | | Identifies the Organization that provides a Product. | | |
| | Flight Num DFN | A unique identifier assigned to a Flight scheduled | Yes | No |
| | | for generating revenue and utilized by the general | | |
| | | public. | | |
| | Non Stop Ind | An indicator which signifies that a FLIGHT makes | No | No |
| | | no intermediary stops between Origin and | | |
| | | Destination points. | | |
| | Route Cd | The unique code assigned to a route managed by a | No | Yes |
| | | RM Analyst. | | |
| FLIGHT CHECK-IN EVENT | Actual Service Class Cd | The unique identifier of a specific SERVICE | No | Yes |
| | | CLASS offered by a TRAVEL PROVIDER. | | |
| | | Example: A (First Class), B (Business Class) or C | | |
| | | (Economy Class). | | |
| | | This is the actual Service Class that was given to | | |
| | | the passenger (may be different than what was | | |
| | | booked/ticketed) | | |
| | Change Issued Ind | An indication that a passenger/guest was able to | No | No |
| | | change a seat/room assignment at check-in. | | |
| | Change Request Ind | An indication that a passenger/guest at check-in | No | No |
| | | requested a seat/room assignment change. | | |
| | Class Upgrade Charge Amt | The monetary amount charged to a ticketed | No | No |
| | | PARTY when requesting and giving a class | | |
| | | upgrade. | | |
| | Class Upgrade Request Ind | A PARTY has requested a service class upgrade | No | No |
| | | at check-in. | | |
| | Downgrade Issued Ind | A checked PARTY was downgraded from an | No | No |
| | | otherwise confirmed class/cabin level. | | |
| | Go Show Ind | Indicates a passenger who showed up just before | No | No |
| | | flight departure with no previous booking and | | |
| | | purchased tickets. | | |
| | | Example: “Yes” the passenger is a Go Show. | | |
| | No Show Ind | Indicates a passenger who has a reservation for this | No | No |
| | | flight but does not board the flight or cancel the | | |
| | | reservation.. | | |
| | | Example: “Yes” the passenger is a No Show. | | |
| | Overweight Baggage Charge Amt | The monetary amount charged to a ticketed | No | No |
| | | PARTY for the overweight limit portion of their | | |
| | | checked baggage/luggage. | | |
| | Overweight Baggage Weight Meas | Indicates by how much, if any, of the total luggage | No | No |
| | | weight is over the allowable limit. | | |
| | Standby Ind | Indicates if the passenger had to standby for this | No | No |
| | | segment. | | |
| | Trip Event Num | A unique number assigned to a TRIP EVENT | Yes | Yes |
| | | entity. | | |
| | Unaccompanied Minor Ind | An indicator that an unaccompanied minor has | No | No |
| | | checked-in. | | |
| | Upgrade Issued Ind | An indication that a checked passenger/guest was | No | No |
| | | given a cabin/class/room upgrade. | | |
| | With Infant Ind | An indication that the PARTY checked in with a | No | No |
| | | child or infant that will be occupying the same seat. | | |
| FLIGHT CODESHARE | Code Share Basis Cd | A code which represents the fare basis for a Code | No | Yes |
| | | Share flight. | | |
| | Hard Block Seat Qty | The number of seats blocked out by a specific | No | No |
| | | airline participating in a codeshare flight. | | |
| | Primary Flight Num | A unique identifier assigned to a Flight scheduled | Yes | Yes |
| | | for generating revenue and utilized by the general | | |
| | | public. | | |
| | | This is the Flight Num assigned by the operating | | |
| | | carrier. | | |
| | Shared Flight Num | A unique identifier assigned to a Flight scheduled | Yes | Yes |
| | | for generating revenue and utilized by the general | | |
| | | public. | | |
| | | This is the Flight Num assigned by the code share | | |
| | | carrier but not operating the flight. | | |
| FLIGHT PRODUCT (SEGMENT) | Flight Num DFN | A unique identifier assigned to a Flight scheduled | No | Yes |
| | | for generating revenue and utilized by the general | | |
| | | public. | | |
| | Flight Product Id | Unique Identifier for an Item. | Yes | Yes |
| | | A distance based TRAVEL PRODUCT that is | | |
| | | defined by Origination and Destination (O&D), | | |
| | | weekday of departure and time of departure. | | |
| | | An Airline Flight. | | |
| FLIGHT ROUTE | RM Analyst Associate Id | An individual who is employed by the enterprise. | No | Yes |
| | Route Cd | The unique code assigned to a route managed by a | Yes | No |
| | | RM Analyst. | | |
| | Route Group Cd | The unique code assigned to a group of routes | No | Yes |
| | | managed by a RM Analyst. | | |
| | Route Name | A unique name assigned to a route managed by a | No | No |
| | | RM Analysts. | | |
| | Route Type Cd | A unique code assigned to a route type managed by | No | Yes |
| | | a RM Analysts (i.e. 0- short haul, 1- long haul). | | |
| FLOOR PLAN | Floor Plan Area Meas | The square area size of the Floor Plan expressed in | No | No |
| | | square meters or square feet. | | |
| | Floor Plan Desc | Narrative text describing a Floor Plan Id | No | No |
| | Floor Plan Id | Uniquely identifies a Floor Plan Id | Yes | No |
| FM INVOICE | Consolidated Inv Id | A number representing a unique identifier for a | No | Yes |
| | | CONSOLIDATED INVOICE. | | |
| | Inv Transmittal Mode Type Cd | The code for a TRANSMITTAL MODE. | No | Yes |
| | Invoice Currency Cd | The code assigned to a CURRENCY. | No | Yes |
| | Invoice Description Txt | Free form text that may be used to further describe | No | No |
| | | the invoice. | | |
| | Invoice Dttm | The date and time an INVOICE was created. | No | No |
| | Invoice Freight Term Cd | A unique identifier that identifies a FREIGHT | No | Yes |
| | | TERM TYPE. | | |
| | Invoice Id | Uniquely identifies an INVOICE. | Yes | Yes |
| | Invoice Source Type Cd | The code associated with the source of the | No | Yes |
| | | INVOICE, i.e. auto invoice, transactions window, | | |
| | | etc. | | |
| | Payment Term Type Cd | Uniquely identifies the AGREEMENT TERM | No | Yes |
| | | TYPE. | | |
| | | Identifies the Payment Term Type. | | |
| FM PAYMENT | Payment Address Id | A number used to uniquely identify an ADDRESS. | No | Yes |
| | | In this context it is the payment originating address | | |
| | | of the PARTY making the PAYMENT. | | |
| | Payment COA Id | The unique identifier for a CHART OF | No | Yes |
| | | ACCOUNT, or alias for a complete CHART OF | | |
| | | ACCOUNTs number. | | |
| | Payment Comments Txt | Text representing any comments about the | No | No |
| | | PAYMENT. | | |
| | Payment Currency Cd | The code assigned to a transaction amount | No | Yes |
| | | CURRENCY. | | |
| | | The Local and Global currency is defined by the | | |
| | | SET OF BOOKs. | | |
| | Payment GL Batch Id | The unique identifier for the general/sub LEDGER | No | Yes |
| | | BATCH processing. | | |
| | Payment Global Amt | The monetary amount of the PAYMENT in the | No | No |
| | | global currency. | | |
| | Payment Id | Uniquely identifies a Payment. | Yes | Yes |
| | Payment Local Amt | The monetary amount of the PAYMENT in the | No | No |
| | | local accounting book currency. | | |
| | Payment Method Type Cd | Contains list or account PAYMENT METHOD | No | Yes |
| | | TYPEs. | | |
| | Payment Process Type Cd | The code used to uniquely identify the PAYMENT | No | Yes |
| | | PROCESS TYPE. | | |
| | Payment Reference Num | For AR INVOICE LINE RECEIPT payments, the | No | No |
| | | customer's reference number to this PAYMENT. | | |
| | | For example, the customer's Purchase Order | | |
| | | number. | | |
| | | For AP INVOICE LINE PAYMENTs, the vendor's | | |
| | | reference number to this PAYMENT. For | | |
| | | example, the vendor's Sales Order number. | | |
| FM RETURN LINE | Return Id | Uniquely identifies a Return. | Yes | Yes |
| | Return Line Freight Term Cd | A unique identifier that identifies a FREIGHT | No | Yes |
| | | TERM TYPE. | | |
| | Return Line Type Cd | The code assigned to a RETURN LINE TYPE. | No | Yes |
| | Return Ln Carrier Party Id | The unique identifier for any individual or group of | No | Yes |
| | | individuals that is of interest to the enterprise. | | |
| | Return Ln Create Dttm | The date a RETURN LINE was created. | No | No |
| | Return Ln Currency Cd | The code assigned to a CURRENCY. | No | Yes |
| | Return Ln Expected Return Dttm | The date that a RETURN LINE is expected to be | No | No |
| | | received. | | |
| | Return Ln Num | Identifies a specific Line Item within a Vendor | Yes | Yes |
| | | Return | | |
| | Return Ln Transaction Dttm | The date and time that an item was returned. | No | No |
| | Return Ln Unit List Price Amt | The currency amount of ITEMs returned, usually | No | No |
| | | based on MSRP. | | |
| FM VENDOR | Earning Statement Type Cd | A code used to uniquely identify a 1099 type | No | Yes |
| | | Vendor. A 1099 classification scheme is used in | | |
| | | the United States for types of payments. | | |
| | | Note: U.S.A. centric - replace with appropriate | | |
| | | localized content as needed. | | |
| | Vendor Default Freight Term Cd | A unique identifier that identifies a FREIGHT | No | Yes |
| | | TERM TYPE. | | |
| | Vendor Party Id | The unique identifier for a Business. | Yes | Yes |
| | | A Supplier of Goods or Services. | | |
| | Vendor Payment Priority Cd | A classification of the priority level that one vendor | No | Yes |
| | | has in relation to another vendor for a payment. | | |
| | | This is the order in which vendors get paid first. | | |
| | | Examples: first, second, third. etc. | | |
| | Vendor Type Cd | A code used to uniquely identify vendor type. For | No | Yes |
| | | example, Employee, Public Sector Company, Tax | | |
| | | Authority, and Vendor. | | |
| FM VENDOR PO | Vendor PO Accrue Type Cd | A unique identifier for the accrual treatment of a | No | Yes |
| | | VENDOR PO. Examples: do not accrue, accrue on | | |
| | | receipt. | | |
| | Vendor PO Bill To Addr Id | A number used to uniquely identify an ADDRESS. | No | Yes |
| | Vendor PO Bill To Party Id | The unique identifier for any individual or group of | No | Yes |
| | | individuals that is of interest to the enterprise. | | |
| | Vendor PO Created By Party Id | The unique identifier for any individual or group of | No | Yes |
| | | individuals that is of interest to the enterprise. | | |
| | Vendor PO Id | Unique identifier for a VENDOR PURCHASE | Yes | Yes |
| | | ORDER. | | |
| | Vendor PO Revision Num | A number representing a revision for a VENDOR | No | No |
| | | PO. | | |
| | Vendor PO Sent To Addr Id | A number used to uniquely identify an ADDRESS. | No | Yes |
| | Vendor PO Sold To Addr Id | A number used to uniquely identify an ADDRESS. | No | Yes |
| | Vendor PO Sold To Party Id | The unique identifier for any individual or group of | No | Yes |
| | | individuals that is of interest to the enterprise. | | |
| | Vendor PO Transmittal Mode Cd | The code for a TRANSMITTAL MODE. | No | Yes |
| FM VENDOR PO LINE | PO Ln Requestd Delivry Dttm | The delivery date requested for a specific | No | No |
| | | VENDOR PO LINE item. | | |
| | Req Ship To Address Id | A number used to uniquely identify an ADDRESS. | No | Yes |
| | | In this case, the Address of the Requested Ship To | | |
| | | PARTY for a VENDOR PO LINE. | | |
| | Req Ship To Party Id | The unique identifier for any individual or group of | No | Yes |
| | | individuals that is of interest to the enterprise. | | |
| | | In this context it is the requested Ship To | | |
| | | individual or group for the VENDOR PO LINE. | | |
| | Ship To Address Id | A number used to uniquely identify an ADDRESS. | No | Yes |
| | | In this case, the Address of the Ship To Party for a | | |
| | | VENDOR PO LINE. | | |
| | Vend PO Ln Accrued Ind | Designates the accrual handling for a VENDOR | No | No |
| | | PO LINE. | | |
| | | Examples: do not accrue, accrue on receipt. | | |
| | Vend PO Ln COA Id | The unique identifier for a CHART OF | No | Yes |
| | | ACCOUNT, or alias for a complete CHART OF | | |
| | | ACCOUNTs number. | | |
| | Vend PO Ln Create Dttm | The date and time that a VENDOR PO LINE was | No | No |
| | | created. | | |
| | Vend PO Ln Desc | The description for a VENDOR PO LINE. | No | No |
| | Vend PO Ln Num | A number representing a unique line on a | Yes | Yes |
| | | VENDOR PO LINE. | | |
| | Vend PO Ln Price Currency Cd | The code assigned to a CURRENCY. In this case, | No | Yes |
| | | the CURRENCY associated with a VENDOR PO | | |
| | | LINE. | | |
| | Vend PO Ln Taxable Ind | Designates whether a VENDOR PO LINE is | No | No |
| | | taxable. | | |
| | Vendor PO Id | The unique identifier of a specific VENDOR PO. | Yes | Yes |
| | Vendor PO Ln Buyer Party Id | The unique identifier for any individual or group of | No | Yes |
| | | individuals that is of interest to the enterprise. | | |
| | | In this context, it is the individual or group | | |
| | | associated with the Buyer function for the | | |
| | | VENDOR PO LINE. | | |
| FOLIO ACCOUNT | Folio Account Id | Uniquely identifies an ACCOUNT. | Yes | Yes |
| | Folio Charge Amt DD | Folio charges derived from various PURCHASE | No | No |
| | | transactions. | | |
| | Folio Credit Amt DD | The amount credited against the FOLIO (as a result | No | No |
| | | of PAYMENT) | | |
| FOREIGN CURRENCY ADJ | GL Main Account Num | The unique Chart of Account code for the GL | Yes | Yes |
| ACCOUNT | | MAIN ACCOUNT. | | |
| FRANCHISE | Franchise Cd | Uniquely identifies a FRANCHISE. | Yes | No |
| | Franchise Name | Short text reference or label for a FRANCHISE. | No | No |
| | Licensor Party Id | The unique identifier for an organization. | No | Yes |
| | | The organization that licenses the franchise. | | |
| FRANCHISE STORE | Franchisee Org Party Id | The unique identifier for an organization. | No | Yes |
| | | The Party that operates the Store under a Franchise | | |
| | | agreement. | | |
| | Location Id | Uniquely identifies a LOCATION. | Yes | Yes |
| | | A physical retail outlet - “brick and mortar”. | | |
| FREE CERTIFICATE | Payment Tran Id | Uniquely identifies a Payment. | Yes | Yes |
| FREIGHT TERM TYPE | Freight Term Type Cd | A unique identifier that identifies a FREIGHT | Yes | Yes |
| | | TERM TYPE. | | |
| | Freight Term Type Desc | A textual description that describes a FREIGHT | No | No |
| | | TERM TYPE. | | |
| FULFILLMENT TRAN | Inv Tran Id | Uniquely identifies an inventory transaction. | Yes | Yes |
| | Shopping Transaction Id | A unique identifier for this TRAVEL | No | Yes |
| | | TRANSACTION. | | |
| | Shopping Transaction Line Num | Identifies a specific line within a SHOPPING | No | Yes |
| | | TRANSACTION. | | |
| GAME | Game Id | Uniquely identifies a specific Game. | Yes | No |
| | Game Name | Textual Name for a Game. | No | No |
| | Game Type Cd | Code that identifies the specific type of Casino | No | Yes |
| | | Game. | | |
| GAME CONFIG | Denomination Amt | Used for game configurations with a fixed | No | No |
| | | denomination. | | |
| | | The monetary value of a waging unit. | | |
| | Game Config Id | Uniquely identifies a specific Game Configuration. | Yes | No |
| | Game Id | Uniquely identifies a specific Game. | No | Yes |
| | Max Bet Amt | The largest wager possible in this game | No | No |
| | | configuration. | | |
| | Min Bet Amt | The smallest wager possible in this game | No | No |
| | | configuration. | | |
| | Progressive Game Id | Uniquely identifies a Progressive Game. | No | Yes |
| | | Used if this game configuration supports a | | |
| | | progressive game. | | |
| | Theo Avg Return Pct | The aggregate average return percentage expected | No | No |
| | | from this game configuration. | | |
| | Theo High Return Pct | The average return percentage expected from this | No | No |
| | | game configuration when played by experienced | | |
| | | players. | | |
| | | Note: This applies to games like blackjack, video | | |
| | | poker, etc. where the skill level of the player has an | | |
| | | effect on the outcome. | | |
| | Theo Low Return Pct | The average return percentage expected from this | No | No |
| | | game configuration when played by inexperienced | | |
| | | players and those unfamiliar with the game. | | |
| | | Note: This applies to games like blackjack, video | | |
| | | poker, etc. where the skill level of the player has an | | |
| | | effect on the outcome. | | |
| | Theo Optimum Return Pct | The return percentage expected from this game | No | No |
| | | configuration when played using 100% perfect play | | |
| | | strategy. | | |
| | | Note: This applies to games like blackjack, video | | |
| | | poker, etc. where the skill level of the player has an | | |
| | | effect on the outcome. | | |
| GAME STATION INSTANCE | Casino Id | Uniquely identifies a LOCATION. | No | Yes |
| | | A sub-type of LOCATION where customers VISIT | | |
| | | for gambling and entertainment. | | |
| | Game Equip Id | Uniquely identifies an Equipment Instance. | No | Yes |
| | Game Station Instance Id | Uniquely identifies a Game Station Instance. | Yes | No |
| | Instance End Dttm | Timestamp when this Game Station Instance | No | No |
| | | ended. | | |
| | Instance Start Dttm | Timestamp when this Game Station Instance | No | No |
| | | became effective. | | |
| | PitBank Num | Identifies an unique Pit or Bank. | No | Yes |
| | Position Num | Uniquely identifies a specific Position within a Pit | No | Yes |
| | | or Bank. | | |
| | Zone Num | Uniquely identifies an area of interest within a | No | Yes |
| | | CASINO. | | |
| GAME TYPE | Game Type Cd | Code that identifies the specific type of Casino | Yes | No |
| | | Game. | | |
| | Game Type Desc | Description that identifies the specific type of | No | No |
| | | Casino Game. | | |
| GAMING EQUIP SVC | Equip Id OIN | Uniquely identifies an Equipment Instance. | Yes | Yes |
| | Out Of Service Dttm ODD | The date on which Equipment is removed from | Yes | Yes |
| | | Service (typically for Maintenance purposes) | | |
| | | Example: | | |
| | | Equipment was removed from service on | | |
| | | 1/3/2005 to enable C Check Maintenance to be | | |
| | | done. | | |
| | | Equipment was removed from service on | | |
| | | 5/5/2005 due to rising fuel prices. | | |
| | | All maintenance related service interruptions can | | |
| | | also be seen in the Maintenance Event area. | | |
| | Service End Dttm | Date and Time the Service ended. | No | No |
| | | Note: May be omitted if always the same as the | | |
| | | Return to Service Dttm. | | |
| | Service Start Dttm | Date and Time the Service was started. | No | No |
| | | This can be used to determine the Response Time | | |
| | | to the Service Call. | | |
| | Servicing Associate Id | An individual who is employed by the enterprise. | No | Yes |
| | | The Associate that responded to the Service Call. | | |
| GAMING FEEDBACK | Feedback Id | Uniquely identifies an instance of Quality | Yes | Yes |
| | | Feedback. Typically system assigned. | | |
| | Session Start Dttm | The start of a rated gaming session (that is, a | Yes | Yes |
| | | gaming session where the identity of the player is | | |
| | | known). | | |
| | Visit Id | The unique identifier for an instance of the VISIT | Yes | Yes |
| | | entity. | | |
| GAMING SESSION TYPE | Gaming Session Type Cd | A code for identifying the type of GAMING | Yes | No |
| | | SESSION. | | |
| | Gaming Session Type Desc | Description for identifying the type of GAMING | No | No |
| | | SESSION. | | |
| GDS PROVIDER | GDS Provider Desc | This attribute is a brief description of each Global | No | No |
| | | Distribution System (GDS). | | |
| | GDS Provider Id | The unique identifier for a Business. | Yes | Yes |
| | | The Global Distribution System (GDS) identifier. | | |
| GE LOCATION | GE Location Cd GEL | S2000 code that specifies the Geo and/or Electrical | Yes | No |
| | | Location of the Parts on a Assembly or Circuit | | |
| | | Card. | | |
| | GE Location Desc | Textual description of the GE Location | No | No |
| GENDER TYPE | Gender Type Cd | This is the unique code for the gender types. | Yes | No |
| | Gender Type Desc | A description of the code. | No | No |
| GENERAL AND ADMIN | GL Main Account Num | The unique Chart of Account code for the GL | Yes | Yes |
| ACCOUNT | | MAIN ACCOUNT. | | |
| GEOGRAPHY DEMOGRAPHIC | Country Cd | The unique code for an instance of the COUNTRY | Yes | Yes |
| | | entity. | | |
| | Demog Cd | The unique code for an instance of the | Yes | Yes |
| | | DEMOGRAPHIC entity. | | |
| | Demog Value Cd | A code referencing a specific DEMOGRAPHIC | No | Yes |
| | | VALUE for a given demographic code. | | |
| | Postal Cd | A unique code for an instance of the POSTAL | Yes | Yes |
| | | CODE entity. | | |
| GIFT CERTIFICATE | Certificate Account Id | Uniquely identifies an ACCOUNT. | Yes | Yes |
| | Gift Certificate Item Id | Unique Identifier for an Item. | No | Yes |
| | | A Hospitality-related offer available for sale to a | | |
| | | PARTY(s). | | |
| | Shopping Transaction Id | A unique identifier for this TRAVEL | No | Yes |
| | | TRANSACTION. | | |
| | Shopping Transaction Line Num | Identifies a specific line within a SHOPPING | No | Yes |
| | | TRANSACTION. | | |
| | Unspent Balance Amt | The total unspent balance for the gift certificate or | No | No |
| | | card. | | |
| GIFT CERTIFICATE ITEM | Face Value Amt | The purchase or face value of the gift certificate or | No | No |
| | | card. | | |
| | | Example: A $25 gift certificate. | | |
| | Gift Certificate Item Id | Unique Identifier for an Item. | Yes | Yes |
| | | A Hospitality-related offer available for sale to a | | |
| | | PARTY(s). | | |
| GL INTERNAL ORG SEGMENT | Chart Of Account Segment Id | The unique identifier for any general ledger | Yes | Yes |
| | | account dimension or segment. | | |
| | GL Main Account Num | The unique Chart of Account code for the GL | No | Yes |
| | | MAIN ACCOUNT. | | |
| | GL Main Intrnl Org Start Dttm | The start date that associates the GL MAIN | No | Yes |
| | | ACCOUNT and the Internal Organization. | | |
| | Internal Org Party Id | The unique identifier for an internal organization. | No | Yes |
| GL MAIN ACCOUNT | GL Main Account Category Cd | The unique code used as a sub-type discriminator | No | Yes |
| | | to classify the GL MAIN ACCOUNT | | |
| | | CATEGORY type. | | |
| | GL Main Account Desc | The description for the GL MAIN ACCOUNT. | No | No |
| | GL Main Account End Dttm | The date this GL MAIN ACCOUNT is no longer | No | No |
| | | active. | | |
| | GL Main Account Name | The name assigned to the GL MAIN ACCOUNT. | No | No |
| | GL Main Account Num | The unique Chart of Account code for the GL | Yes | No |
| | | MAIN ACCOUNT. | | |
| | GL Main Account Start Dttm | The start date this GL MAIN ACCOUNT became | No | No |
| | | active. | | |
| | Parent GL Main Account Num | The unique Chart of Account code for the GL | No | Yes |
| | | MAIN ACCOUNT. | | |
| GL MAIN ACCOUNT | GL Main Account Category Cd | The unique code used as a sub-type discriminator | Yes | No |
| CATEGORY | | to classify the GL MAIN ACCOUNT | | |
| | | CATEGORY type. | | |
| | GL Main Account Category Desc | The description of the GL MAIN ACCOUNT | No | No |
| | | CATEGORY code. | | |
| GL MAIN ACCOUNT PROJECT | GL Main Account Num | The unique Chart of Account code for the GL | Yes | Yes |
| XREF | | MAIN ACCOUNT. | | |
| | GL Main Acct Proj End Dttm | The date the PROJECT and GL Main Account | No | No |
| | | Num association ended. | | |
| | GL Main Acct Proj Start Dttm | The date the PROJECT and GL Main Account | Yes | No |
| | | Num association started. | | |
| | Project Id | The unique identifier for the PROJECT. | Yes | Yes |
| GL MAIN ACCOUNT SEGMENT | Chart Of Account Segment Id | The unique identifier for any general ledger | Yes | Yes |
| | | account dimension or segment. | | |
| | GL Main Account Num | The unique Chart of Account code for the GL | No | Yes |
| | | MAIN ACCOUNT. | | |
| GL MAIN ACCT GL SUB ACCT | GL Main Account Num | The unique Chart of Account code for the GL | Yes | Yes |
| XREF | | MAIN ACCOUNT. | | |
| | GL Main GL Sub Acct End Dttm | The date the GL SUB ACCOUNT is no longer | No | No |
| | | assigned to the GL Main Account Num. | | |
| | GL Main GL Sub Acct Start Dttm | The start date this GL SUB ACCOUNT was | Yes | No |
| | | assigned to the GL Main Account Num. | | |
| | GL Sub Account Num | The unique Chart of Account code for the GL SUB | Yes | Yes |
| | | ACCOUNT. | | |
| GL MAIN ACCT INTERNAL | GL Main Internl Org Type Cd | The code assigned to the GL MAIN ACCT | Yes | No |
| ORG TYPE | | INTERNAL ORG TYPE. | | |
| | GL Main Internl Org Type Desc | The description of the GL MAIN ACCT | No | No |
| | | INTERNAL ORG TYPE. | | |
| GL MAIN ACCT INTERNAL | GL Main Account Num | The unique Chart of Account code for the GL | Yes | Yes |
| ORG XREF | | MAIN ACCOUNT. | | |
| | GL Main Internl Org Type Cd | The code assigned to the GL MAIN ACCT | No | Yes |
| | | INTERNAL ORG TYPE. | | |
| | GL Main Intrnl Org End Dttm | The date that the GL MAIN ACCOUNT and the | No | No |
| | | Internal Organization no longer associated. | | |
| | GL Main Intrnl Org Start Dttm | The start date that associates the GL MAIN | Yes | No |
| | | ACCOUNT and the Internal Organization. | | |
| | Internal Org Party Id | The unique identifier for an internal organization. | Yes | Yes |
| GL MAIN ACCT REPORT PROD | GL Main Account Num | The unique Chart of Account code for the GL | Yes | Yes |
| XREF | | MAIN ACCOUNT. | | |
| | GL Main Report Prod End Dttm | The date the GL Product and GL Main Account | No | No |
| | | Num association ended. | | |
| | GL Main Report Prod Start Dttm | The date the GL Product and GL Main Account | Yes | No |
| | | Num association started. | | |
| | GL Reporting Product Id | The unique identifier for a GL REPORTING | Yes | Yes |
| | | PRODUCT. | | |
| GL MAIN ACCT SET OF BOOKS | GL Main Account Num | The unique Chart of Account code for the GL | Yes | Yes |
| XREF | | MAIN ACCOUNT. | | |
| | GL Main Set Of Book End Dttm | The accounting period end date this GL | No | No |
| | | ACCOUNT and SET OF BOOKS association | | |
| | | represents. | | |
| | GL Main Set Of Book Start Dttm | The accounting period start date this GL | Yes | No |
| | | ACCOUNT and SET OF BOOKS association | | |
| | | represents. | | |
| | Set Of Books Cd | The unique identifier for the SET OF BOOKS. | Yes | Yes |
| | Set Of Books Start Dttm | The date marking the beginning for a SET OF | Yes | Yes |
| | | BOOKS. | | |
| GL NON SERVICE PROD TYPE | GL Non Service Prod Type Cd | The unique code assigned to a GL NON SERVICE | Yes | No |
| | | PROD TYPE. | | |
| | GL Non Service Prod Type Desc | The description of GL NON SERVICE PROD | No | No |
| | | TYPE. | | |
| GL PRODUCT SEGMENT | Chart Of Account Segment Id | The unique identifier for any general ledger | Yes | Yes |
| | | account dimension or segment. | | |
| | GL Main Account Num | The unique Chart of Account code for the GL | No | Yes |
| | | MAIN ACCOUNT. | | |
| | GL Main Report Prod Start Dttm | The date the GL Product and GL Main Account | No | Yes |
| | | Num association started. | | |
| | GL Reporting Product Id | The unique identifier for a GL REPORTING | No | Yes |
| | | PRODUCT. | | |
| GL PROJECT SEGMENT | Chart Of Account Segment Id | The unique identifier for any general ledger | Yes | Yes |
| | | account dimension or segment. | | |
| | GL Main Account Num | The unique Chart of Account code for the GL | No | Yes |
| | | MAIN ACCOUNT. | | |
| | GL Main Acct Proj Start Dttm | The date the PROJECT and GL Main Account | No | Yes |
| | | Num association started. | | |
| | Project Id | The unique identifier for the PROJECT. | No | Yes |
| GL REPORTING NON SERVICE | GL Non Service Prod Type Cd | The unique code assigned to a GL NON SERVICE | No | Yes |
| PROD | | PROD TYPE. | | |
| | GL Reporting Product Id | The unique identifier for a GL REPORTING | Yes | Yes |
| | | PRODUCT. | | |
| GL REPORTING PRODUCT | GL Reporting Prod Categ Cd | The unique code assigned to a GL REPORTING | No | Yes |
| | | PRODUCT CATEG. | | |
| | GL Reporting Product Desc | The description for a GL REPORTING | No | No |
| | | PRODUCT. | | |
| | GL Reporting Product Id | The unique identifier for a GL REPORTING | Yes | No |
| | | PRODUCT. | | |
| | GL Reporting Product Name | The name for a GL REPORTING PRODUCT. | No | No |
| | Item Id | Uniquely identifies an item. Typically system | No | Yes |
| | | assigned. | | |
| | Parent GL Reporting Product Id | The parent GL REPORTING PRODUCT assigned | No | Yes |
| | | to a GL REPORTING PRODUCT. | | |
| GL REPORTING PRODUCT | GL Reporting Prod Categ Cd | The unique code assigned to a GL REPORTING | Yes | No |
| CATEG | | PRODUCT CATEG. | | |
| | GL Reporting Prod Categ Desc | The description for a GL REPORTING PRODUCT | No | No |
| | | CATEG. | | |
| GL REPORTING SERVICE PROD | GL Reporting Product Id | The unique identifier for a GL REPORTING | Yes | Yes |
| | | PRODUCT. | | |
| | GL Service Prod Type Cd | The unique code assigned to a GL SERVICE | No | Yes |
| | | PROD TYPE. | | |
| GL SERVICE PROD TYPE | GL Service Prod Type Cd | The unique code assigned to a GL SERVICE | Yes | No |
| | | PROD TYPE. | | |
| | GL Service Prod Type Desc | The description of GL SERVICE PROD TYPE. | No | No |
| GL SUB ACCOUNT | GL Sub Account Desc | The description for the GL SUB ACCOUNT. | No | No |
| | GL Sub Account Name | The name assigned to the GL SUB ACCOUNT. | No | No |
| | GL Sub Account Num | The unique Chart of Account code for the GL SUB | Yes | No |
| | | ACCOUNT. | | |
| | GL Sub Account Type Cd | The unique code used as a sub-type discriminator | No | Yes |
| | | to classify the GL SUB ACCOUNT TYPE. | | |
| | Parent GL Sub Account Num | The unique Chart of Account code for the GL SUB | No | Yes |
| | | ACCOUNT. | | |
| GL SUB ACCOUNT SEGMENT | Chart Of Account Segment Id | The unique identifier for any general ledger | Yes | Yes |
| | | account dimension or segment. | | |
| | GL Main Account Num | The unique Chart of Account code for the GL | No | Yes |
| | | MAIN ACCOUNT. | | |
| | GL Main GL Sub Acct Start Dttm | The start date this GL SUB ACCOUNT was | No | Yes |
| | | assigned to the GL Main Account Num. | | |
| | GL Sub Account Num | The unique Chart of Account code for the GL SUB | No | Yes |
| | | ACCOUNT. | | |
| GL SUB ACCOUNT TYPE | GL Sub Account Type Cd | The unique code used as a sub-type discriminator | Yes | No |
| | | to classify the GL SUB ACCOUNT TYPE. | | |
| | GL Sub Account Type Desc | The description of the GL SUB ACCOUNT TYPE. | No | No |
| GOLF COURSE | Golf Course Id | Uniquely identifies a LOCATION. | Yes | Yes |
| | | A sub-type of LOCATION that tracks information | | |
| | | about a distinct area used for playing GOLF. | | |
| GOLF RESERVATION | Golf Course Id | Uniquely identifies a LOCATION. | No | Yes |
| | | A sub-type of LOCATION that tracks information | | |
| | | about a distinct area used for playing GOLF. | | |
| | Holes Booked Cnt | The number of holes booked in the GOLF | No | No |
| | | RESERVATION | | |
| | Reservation Seq Num | This attribute identifies a specific RESERVATION | Yes | Yes |
| | | ITEM. | | |
| | Reservation Transaction Id | A unique identifier for this TRAVEL | Yes | Yes |
| | | TRANSACTION. | | |
| | Slots Booked Cnt | Total number of slots booked as part of the | No | No |
| | | reservation, typically representing the number of | | |
| | | people teeing off at any given time. | | |
| GOODWILL ACCOUNT | GL Main Account Num | The unique Chart of Account code for the GL | Yes | Yes |
| | | MAIN ACCOUNT. | | |
| GOVERNMENT | Government Party Id | The unique identifier for a Business. | Yes | Yes |
| ORGANIZATION | | A government organization. | | |
| | | Example: DOD, MI5, Social Security | | |
| | | Administration, etc. | | |
| GROUP EVENT | Agent Flat Fee Amt | A flat fee or commission paid to the Party that | No | No |
| | | brought the customers to the enterprise. Can be a | | |
| | | fixed amount or a multiplier per headcount. | | |
| | | May be in addition to or instead of a revenue | | |
| | | sharing commission. | | |
| | Agent Revshare Pct | A commission paid to the Party that brought the | No | No |
| | | customers to the enterprise. Based on revenue | | |
| | | sharing - a percentage of revenue or profit | | |
| | | generated by the customers that were provided by | | |
| | | the Agent. | | |
| | | May be in addition to or instead of a flat fee | | |
| | | commission. | | |
| | Business Contact Id | The unique identifier for an individual. | No | Yes |
| | | The person who serves as contact point for the | | |
| | | event. | | |
| | Events Agency Contact Id | The unique identifier for an individual. | No | Yes |
| | Group Catering Manager Id | An individual who is employed by the enterprise. | No | Yes |
| | | The manager assigned to manage the catering for | | |
| | | the event. | | |
| | Group Event Coordinator Id | An individual who is employed by the enterprise. | No | Yes |
| | | The manager assigned to coordinate the event. | | |
| | Group Event End Dt | The end date for a group event | No | No |
| | Group Event Id | A unique identifier for the GROUP EVENT | Yes | No |
| | Group Event Name | Name assigned to a group event | No | No |
| | Group Event Start Dt | The start date for a group event | No | No |
| | Group Event Total Price Amt DD | The total amount charged to the GROUP CLIENT | No | No |
| | | as a result of hosting the GROUP EVENT. | | |
| | Group Event Type Cd | Code that describes the type of Group Event. | No | Yes |
| | Group Sales Manager Id | An individual who is employed by the enterprise. | No | Yes |
| | | The sales manager assigned to the event. | | |
| | Parent Group Event Id | A unique identifier for the GROUP EVENT. | No | Yes |
| | | Defines a higher level Group Event that this Group | | |
| | | Event is a part of. | | |
| | | Example: Gala Banquet being catered on the final | | |
| | | evening of a all week Conference Event. | | |
| | Promo Offer Id | The unique identifier for a promo offer. | No | Yes |
| | | If this Group Event was as response to a | | |
| | | Promotional Offer, this will provide a linkage to | | |
| | | the Promotional Offer. | | |
| | Referral Party Id | The unique identifier for any individual or group of | No | Yes |
| | | individuals that is of interest to the enterprise. | | |
| GROUP EVENT MEMBER | Group Event Id | A unique identifier for the GROUP EVENT | Yes | Yes |
| | Individual Party Id UPI | The unique identifier for an individual. | Yes | Yes |
| GROUP EVENT REVENUE | Agent Commission Amt | Used to capture the Revenue Share commission to | No | No |
| SUMMARY | | be paid to the Agent that brought the Group Event | | |
| | | to the Enterprise. | | |
| | Group Event Actual Revenue Amt DD | The actual revenue generated from a GROUP | No | No |
| | | EVENT | | |
| | Group Event Est Revenue Amt | The estimated revenue from a GROUP EVENT | No | No |
| | Group Event Id | A unique identifier for the GROUP EVENT | Yes | Yes |
| | Travel Product Id | Unique Identifier for an Item. | Yes | Yes |
| | | A Travel-related offer available for sale to a | | |
| | | PARTY(s). | | |
| GROUP EVENT STATUS | Group Event Status Cd | Code for the status of the GROUP EVENT. | Yes | No |
| | Group Event Status Desc | Description for the status of GROUP EVENT. | No | No |
| GROUP EVENT STATUS HIST | Event Change Dt | The date when the change to GROUP EVENT | No | No |
| | | occurred | | |
| | Event Change Reason Desc | Description for the GROUP EVENT change | No | No |
| | Group Event Id | A unique identifier for the GROUP EVENT | Yes | Yes |
| | Group Event Loss Ind | An indicator to show that GROUP EVENT was not | No | No |
| | | acquired(lost or turned down) | | |
| | Group Event Status Cd | Code for the status of the GROUP EVENT. | Yes | Yes |
| | Lost to Party Id | The unique identifier for any individual or group of | No | Yes |
| | | individuals that is of interest to the enterprise. | | |
| GROUP EVENT TYPE | Group Event Type Cd | Code that describes the type of Group Event. | Yes | No |
| | Group Event Type Desc | Description for this type of Group Event. | No | No |
| GUEST CHECK | Dining Transaction Id | A unique identifier for this TRAVEL | No | Yes |
| | | TRANSACTION. | | |
| | Guest Check Discount Amt DD | The total discount amount on a guest check. | No | No |
| | | This amount can typically be derived from the | | |
| | | information in the Transaction Discount entity. | | |
| | Guest Check Id | Uniquely identifies a Guest Check. | Yes | No |
| | Guest Check Tip Amt | Tip amount on a guest check | No | No |
| | Guest Check Total Amt DD | Total amount owed by the customer as a result of a | No | No |
| | | DINING TRANSACTION, typically captured on | | |
| | | the guest check | | |
| | Guest Cnt | The number of guests that placed orders on this | No | No |
| | | Guest Check. | | |
| GUEST CHECK TRANSFER | From Guest Check Id | Uniquely identifies a Guest Check. | Yes | Yes |
| | To Guest Check Id | Uniquely identifies a Guest Check. | Yes | Yes |
| | Transfer Dttm | The date and time that the transfer occurred. | No | No |
| | Transferred Amt DD | The amount transferred from the (typically closed | No | No |
| | | out) guest check to the new guest check. | | |
| | | Typically derivable. | | |
| HANDOVER (PICKUP ORDER) | Actual Dttm DD | The actual date and time the carrier showed up at | No | No |
| | | the pickup site. (Derivable from the SHIPPING | | |
| | | EVENT) | | |
| | Commit Dttm | Date and time the carrier committed to pick up the | No | No |
| | | goods. | | |
| | Order Dttm | Date and time when the PICKUP request was | No | No |
| | | received. | | |
| | Pickup Order Num | Uniquely Identifies a PICKUP ORDER. | Yes | No |
| | Req Dttm | Date and time service requestor requests that | No | No |
| | | pickup be made. | | |
| | Visit Id | Unique identifier for the VISIT. | No | Yes |
| HOLIDAY | Holiday Cd | Uniquely identifies a HOLIDAY. | Yes | No |
| | Holiday Name | Short text reference or label for a HOLIDAY. | No | No |
| HOSP ACTIVITY PRODUCT | Hosp Activity Prod Id | Unique Identifier for an Item. | Yes | Yes |
| | | A Hospitality-related offer available for sale to a | | |
| | | PARTY(s). | | |
| HOSPITALITY PRODUCT | Hosp Product Id | Unique Identifier for an Item. | Yes | Yes |
| | | A Hospitality-related offer available for sale to a | | |
| | | PARTY(s). | | |
| HOSPITALITY RENTAL | Hosp Rental Prod Id | Unique Identifier for an Item. | Yes | Yes |
| PRODUCT | | A Hospitality-related offer available for sale to a | | |
| | | PARTY(s). | | |
| HOSPITALITY RETAIL ITEM | Hosp Retail Item Id | Unique Identifier for an Item. | Yes | Yes |
| | | A Hospitality-related offer available for sale to a | | |
| | | PARTY(s). | | |
| HOSPITALITY SERVICE | Hosp Service Id | Unique Identifier for an Item. | Yes | Yes |
| | | A Hospitality-related offer available for sale to a | | |
| | | PARTY(s). | | |
| | Service Desc | Provides the description of the SERVICE. | No | No |
| HOUSEHOLD | Child Cnt | The number of children in the household | No | No |
| | Household Id | The unique identifier for a household. | Yes | Yes |
| IATA DELAY CAUSE | IATA Delay Cause Cd ICE ICN | Uniquely identifies the IATA Delay Cause. | Yes | No |
| | IATA Delay Cause Desc | Textual description of the IATA Delay Cause. | No | No |
| INBOUND TRANSACTION | Inv Tran Id | Uniquely identifies an inventory transaction. | Yes | Yes |
| | Shipment Num | Uniquely identifies a SHIPMENT. | No | Yes |
| | | Optional. Mainly to be used if an external party is | | |
| | | transporting the inventory. | | |
| INCIDENT COST | Actual Cost Amt | The Actual Cost of a specific type of Cost for a | No | No |
| | | given Incident. | | |
| | Cost Cd | Uniquely identifies a COST. | Yes | Yes |
| | Equip Log Entry Id OEI | Uniquely identifies an Equipment Log Entry. | Yes | Yes |
| | Estimated Cost Amt | The Cost estimate of a specific type of Cost for a | No | No |
| | | given Incident. | | |
| INCIDENT REASON | Incident Reason Cd | The code assigned to every single reason that | Yes | No |
| | | corresponds to every incident that may occur | | |
| | | during a flight. | | |
| | | Example: flight delayed due to weather, flight | | |
| | | diverted because of closed airport, flight cancelled | | |
| | | due to mechanical problem, etc. | | |
| | Incident Reason Desc | A textual description of each Incident reason. | No | No |
| | | Example: Mechanical Problem, Closed airport, | | |
| | | Weather conditions, etc. | | |
| INCIDENT TYPE | Incident Type Cd | Defines code assigned to every type of incident that | Yes | No |
| | | may occur. | | |
| | | Examples: 1 = Flight delayed, 2 = Flight cancelled, | | |
| | | 3 = Flight diverted, etc. | | |
| | Incident Type Desc | A textual description of each Incident Type. | No | No |
| | | Examples are: Cancelled, Delayed, Diverted, | | |
| | | Equipment Substitution, etc. | | |
| INCIDENTAL ITEM | Incidental Item Id | Unique Identifier for an Item. | Yes | Yes |
| | | A Hospitality-related offer available for sale to a | | |
| | | PARTY(s). | | |
| INCOME STMT GL MAIN | GL Main Account Num | The unique Chart of Account code for the GL | Yes | Yes |
| ACCOUNT | | MAIN ACCOUNT. | | |
| | Income Stmt GL Main Acct Cd | The code assigned to the INCOME STMT GL | No | Yes |
| | | MAIN ACCT TYPE. | | |
| INCOME STMT GL MAIN ACCT | Income Stmt GL Main Acct Cd | The code assigned to the INCOME STMT GL | Yes | No |
| TYPE | | MAIN ACCT TYPE. | | |
| | Income Stmt GL Main Acct Desc | The description assigned to the INCOME STMT | No | No |
| | | GL MAIN ACCT TYPE. | | |
| INCOME TAX ACCOUNT | GL Main Account Num | The unique Chart of Account code for the GL | Yes | Yes |
| | | MAIN ACCOUNT. | | |
| INCOME TAX PAYABLE | GL Main Account Num | The unique Chart of Account code for the GL | Yes | Yes |
| ACCOUNT | | MAIN ACCOUNT. | | |
| INDIVIDUAL | Birth Dt | The date of birth of this individual. | No | No |
| | Ethnicity Cd | A unique identifier for an individual's ethnicity. | No | Yes |
| | Gender Type Cd | This is the unique code for the gender types. | No | Yes |
| | Household Id | The unique identifier for a household. | No | Yes |
| | Individual Party Id UPI | The unique identifier for an individual. | Yes | Yes |
| | Marital Dt | Date of marriage. Includes year, month and date. | No | No |
| | | Typically used for promotional/marketing | | |
| | | purposes: Anniversary parties, special invitations, | | |
| | | etc.. | | |
| INDIVIDUAL ALERT | Player Alert Cd | Uniquely identifies a Player Alert. | Yes | No |
| | Player Alert Desc | Textual description of a Player Alert. | No | No |
| INDIVIDUAL ALERT HIST | Alert End Dt | End of Alert period. | No | No |
| | Alert Start Dt | Alert effective date. | No | No |
| | Individual Party Id UPI | The unique identifier for an individual. | Yes | Yes |
| | Player Alert Cd | Uniquely identifies a Player Alert. | Yes | Yes |
| | Reporting Party Id | The unique identifier for any individual or group of | No | Yes |
| | | individuals that is of interest to the enterprise. | | |
| INDIVIDUAL NAME (EMP) | Family Name | The family name of the individual. | No | No |
| | Given Name | The given name of the individual. | No | No |
| | Individual Party Id UPI | The unique identifier for an individual. | Yes | Yes |
| | Middle Name | The middle name of the individual. | No | No |
| | Name Prefix Txt | The name prefix such as Dr., Rev. | No | No |
| | Name Suffix Txt | The name suffix such as Senior, Junior, III. | No | No |
| | Name Type Cd | A unique code for the type of name that this | Yes | Yes |
| | | individual or organization could have such as | | |
| | | ‘doing business as’ (dba), legal name, alias, | | |
| | | phonetics, etc. | | |
| INDIVIDUAL PASSPORT | Country Cd | The unique code for an instance of the COUNTRY | Yes | Yes |
| | | entity. | | |
| | Expire Dt | Passport Expiration Date. | No | No |
| | Individual Party Id UPI | The unique identifier for an individual. | Yes | Yes |
| | Passport Id | An identifier that uniquely describes an | No | No |
| | | INDIVIDUAL PARTY's Passport Identification | | |
| | | (specific to a Country). | | |
| INGREDIENT | Ingredient Item Id | Unique Identifier for an Item. | Yes | Yes |
| | | An Item used as an Ingredient in a Menu Item and, | | |
| | | typically, not sold separately to consumers. | | |
| INSPECTION | Actual Class Rating Cd | Uniquely identifies the CLASS RATING. | No | Yes |
| | | The actual (as opposed to claimed) value. | | |
| | Actual Commodity Cd | Uniquely identifies a commodity using a | No | Yes |
| | | Classification Standard. | | |
| | Actual Cube Meas | The actual cube measure taken during the | No | No |
| | | inspection of this PIECE. Could differ from the | | |
| | | cube measure stated on the customer's Bill of | | |
| | | Lading. | | |
| | | The actual (as opposed to claimed) value. | | |
| | Actual Weight Meas | The actual weight measure taken during the | No | No |
| | | inspection of this PIECE. Could differ from the | | |
| | | weight measure stated on the customer's Bill of | | |
| | | Lading. | | |
| | | The actual (as opposed to claimed) value. | | |
| | Ship Event Id | Uniquely identifies a SHIPPING EVENT. | Yes | Yes |
| INTANGIBLE ASSET ACCOUNT | Amortization Method Cd | A unique code for the AMORTIZATION | No | Yes |
| | | METHOD. Examples may be; cash basis (no | | |
| | | amortization), straight line, declining balance, or | | |
| | | interest method. | | |
| | GL Main Account Num | The unique Chart of Account code for the GL | Yes | Yes |
| | | MAIN ACCOUNT. | | |
| | Intangble Asset Amortizatn Amt | The monetary amount reducing the value of an | No | No |
| | | asset. | | |
| | Intangible Asset Account Cd | The unique code assigned to the INTANGIBLE | No | Yes |
| | | ASSET ACCT TYPE. For example: patent or | | |
| | | goodwill. | | |
| INTANGIBLE ASSET ACCT | Intangible Asset Account Cd | The unique code assigned to the INTANGIBLE | Yes | No |
| TYPE | | ASSET ACCT TYPE. For example: patent or | | |
| | | goodwill. | | |
| | Intangible Asset Account Desc | The description of the INTANGIBLE ASSET | No | No |
| | | ACCT TYPE. | | |
| INTER INTRA COMPANY TXN | GL Sub Account Num | The unique Chart of Account code for the GL SUB | Yes | Yes |
| ACCT | | ACCOUNT. | | |
| INTERACTION TASK | Interaction Task Cd | Coding scheme for identifying an interaction task. | Yes | No |
| | Interaction Task Desc | Textual description of interaction task code - For | No | No |
| | | instance, Add item to basket, Delete item from | | |
| | | basket, Purchase, etc | | |
| INTEREST EXPENSE ACCOUNT | GL Main Account Num | The unique Chart of Account code for the GL | Yes | Yes |
| | | MAIN ACCOUNT. | | |
| INTEREST INCOME ACCOUNT | GL Main Account Num | The unique Chart of Account code for the GL | Yes | Yes |
| | | MAIN ACCOUNT. | | |
| INTERNAL ORGANIZATION | Internal Org Party Id | The unique identifier for an internal organization. | Yes | Yes |
| | Internal Org Type Cd | A unique code used to identify the type of internal | No | Yes |
| | | organization. | | |
| INTERNAL ORGANIZATION | Internal Org Type Cd | A unique code used to identify the type of internal | Yes | No |
| TYPE | | organization. | | |
| | Internal Org Type Desc | A textual description of the internal organization | No | No |
| | | type. | | |
| INTERNAL PROJECT | Project Id | The unique identifier for the PROJECT. | Yes | Yes |
| INVENTORY CONTROL | Item Id ASN | Unique Identifier for an Item. | Yes | Yes |
| | | A subset of (physical) items than can be | | |
| | | inventoried, and shelved. This would exclude | | |
| | | service items and virtual items (downloadable | | |
| | | products). | | |
| | Location Id | Uniquely identifies a LOCATION. | Yes | Yes |
| | Max Stock Level Qty | The maximum number of units to have in stock. | No | No |
| | Min Order Units Qty | Minimal units that must be specified on an order. | No | No |
| | Min Stock Units Qty | The minimal number of units to have in stock. | No | No |
| | Safety Stock Units Qty | Units used in case there is an unexpected shortage. | No | No |
| INVENTORY ITEM | Item Id ASN | Unique Identifier for an Item. | Yes | Yes |
| | | A subset of (physical) items than can be | | |
| | | inventoried, and shelved. This would exclude | | |
| | | service items and virtual items (downloadable | | |
| | | products). | | |
| | Item SKU Num | An identification number (Stock Keeping Unit) | No | No |
| | | often used to identify ITEMs. Since it is frequently | | |
| | | not unique, or ambiguous it is not used as PK, but | | |
| | | is kept as a convenience. | | |
| | | Note: if SKU is unique in your environment, it can | | |
| | | be used as the PK, instead of Item Id. | | |
| INVENTORY REASON | Inv Reason Cd | Uniquely identifies an inventory reason. | Yes | No |
| | Inv Reason Desc | Narrative text describing an inventory reason. | No | No |
| | Tran Type Cd | Uniquely identifies the transaction type. | Yes | Yes |
| INVENTORY RELATED ACCT | GL Sub Account Num | The unique Chart of Account code for the GL SUB | Yes | Yes |
| | | ACCOUNT. | | |
| INVENTORY REQUEST | Expedite Ind | Indicates if the request is standard or urgent. | No | No |
| | Internal Order Num | Internal “Order” Reference Number for tracking | No | No |
| | | purposes. | | |
| | | Note: Since the Inventory Transaction Id uniquely | | |
| | | identifies this transaction, this attribute is typically | | |
| | | only needed to capture a legacy internal Order | | |
| | | identifier. | | |
| | Inv Tran Id | Uniquely identifies an inventory transaction. | Yes | Yes |
| | Maint Event Id MTN | Uniquely identifies a Maintenance Event. | No | Yes |
| | | MRO Industry Specific. | | |
| | | If the Inventory Request was in support of a | | |
| | | specific Maintenance Event, this will provide a link | | |
| | | to that Maintenance Event. | | |
| | | Optional. | | |
| | Requesting Assoc Party Id | An individual who is employed by the enterprise. | No | No |
| | | The Associate that requested the Inventory. | | |
| | Supplying Location Id | Uniquely identifies a LOCATION. | No | Yes |
| INVENTORY TRANSACTION | Inv Reason Cd | Uniquely identifies the reason for this Inventory | No | Yes |
| | | Transaction. | | |
| | | Note: It is assumed all items contained in this | | |
| | | transaction share this reason code. If the | | |
| | | requirement is to differentiate reason codes at the | | |
| | | item line level instead, relate the INVENTORY | | |
| | | REASON to the INVENTORY TRANSACTION | | |
| | | ITEM level. | | |
| | Inv Tran Id | Uniquely identifies an inventory transaction. | Yes | No |
| | Location Id | Uniquely identifies a LOCATION. | No | Yes |
| | | The location where the inventory count will be | | |
| | | adjusted. | | |
| | Related Inv Tran Id | Uniquely identifies an inventory transaction. | No | Yes |
| | | Used to link related Inventory Transactions. | | |
| | | TRANSFER Example: | | |
| | | Transferring goods between distribution centers, | | |
| | | supplying stores with goods from warehouse | | |
| | | locations or distribution centers, etc. | | |
| | | When transferring items from location A to | | |
| | | location B, there will be 1 ‘transfer out’ outbound | | |
| | | transaction for location A and 1 (or more) ‘transfer | | |
| | | in’ inbound transactions for location B. Each of the | | |
| | | location B transactions will be related to the | | |
| | | originating location A transaction. | | |
| | | CONFIGURATION Example: | | |
| | | When a bulk item is broken into its component | | |
| | | items, there will be several related transactions: 1 | | |
| | | to decrease the bulk item count and a transaction to | | |
| | | increase the component item count for each | | |
| | | component item created. | | |
| | | Likewise in the case where component items are | | |
| | | ‘bulked up’ or consolidated, where the opposite | | |
| | | process will take place. | | |
| | Tran Dttm | The date and time the transaction was created. | No | No |
| | Tran Status Cd | Unique identifier for a TRANSACTION STATUS. | No | Yes |
| | Tran Type Cd | Uniquely identifies the transaction type. | No | Yes |
| INVENTORY TRANSACTION | Completion Dttm | Indicates the date and time the transaction has been | No | No |
| ITEM | | completely applied to the item. | | |
| | | Example: | | |
| | | 500 Bulk Item A (Pallet) is to be reconfigured into | | |
| | | 20 Item B (Carton) to prepare for shipment to | | |
| | | stores. The inventory transaction is issued on | | |
| | | Monday 8 am, but the work is not completed until | | |
| | | Tuesday 3pm. | | |
| | | Note: This is the date and time that the inventory | | |
| | | can officially be adjusted to recognize the effect of | | |
| | | the transaction. | | |
| | | Note: This allows for the atomic level capture of | | |
| | | information. Some enterprises may elect to just use | | |
| | | the high level Inventory Transaction Date and time | | |
| | | instead. | | |
| | Inv Tran Id | Uniquely identifies an inventory transaction. | Yes | Yes |
| | Inv Value Amt DD | The restated unit book value of an inventoried item | No | No |
| | | as result of the Inventory Transaction (if relevant). | | |
| | | Note: If the enterprise use simple pricing this | | |
| | | attribute may be derivable. | | |
| | | For more complex pricing models, this may be a | | |
| | | non-derivable and populated by an application. | | |
| | Item Adjust Qty | The number by which the inventory count for the | No | No |
| | | item should be adjusted. | | |
| | | Note: Will indicate either a positive or negative | | |
| | | adjustment. The item quantity will be positive | | |
| | | when adding to the inventory count (transfer in, | | |
| | | etc.) and negative when subtracting from the | | |
| | | inventory count (transfer out, wastage, etc.) | | |
| | | Note: In the special case of configuration | | |
| | | transactions we will have both a positive and a | | |
| | | negative adjustment quantity (in the case of a bulk | | |
| | | break-down, for instance, we will have a negative | | |
| | | adjustment for the Bulk Item, and Positive | | |
| | | adjustment(s) for the Component Item(s)) | | |
| | Item Id ASN | Unique Identifier for an Item. | Yes | Yes |
| | | A subset of (physical) items than can be | | |
| | | inventoried, and shelved. This would exclude | | |
| | | service items and virtual items (downloadable | | |
| | | products). | | |
| | Unit Cost Adjust Amt | The adjustment to the unit cost of the item due to | No | No |
| | | the Transaction (if relevant). | | |
| | | Example: | | |
| | | Wastage Transaction may drive up the Unit Cost of | | |
| | | the Inventory Item. | | |
| INVESTMENT ASSET | GL Main Account Num | The unique Chart of Account code for the GL | Yes | Yes |
| ACCOUNT | | MAIN ACCOUNT. | | |
| INVOICE | Invoice Dt | Date that an invoice is issued. | No | No |
| | Invoice Id | Uniquely identifies an INVOICE. | Yes | No |
| | Invoice Type Cd | Uniquely identifies an Invoice Type. | No | Yes |
| | Invoiced Party Id | The unique identifier for any individual or group of | No | Yes |
| | | individuals that is of interest to the enterprise. | | |
| | | The Party that the Invoice was submitted to for | | |
| | | Payment. | | |
| | Invoicing Party Id | The unique identifier for any individual or group of | No | Yes |
| | | individuals that is of interest to the enterprise. | | |
| | | The Party that Issued the Invoice. | | |
| | Orig Invoice Num | The Invoice Number as referenced by the Invoice | No | No |
| | | Issuer. | | |
| | Payment Due Dt | The date by which payment for this Invoice must | No | No |
| | | be received. | | |
| INVOICE ADJUSTMENT | Adjust Amt | The amount of the adjustment (can be positive or | No | No |
| | | negative). | | |
| | Adjust Dt | The date of the adjustment. | No | No |
| | Adjust Item Qty | An adjustment to be applied to the quantity of | No | No |
| | | Items on the invoice (if applicable). | | |
| | Adjust Reason Cd | This attribute describes the reason code for a | No | Yes |
| | | monetary adjustment made to a charge amount. | | |
| | Adjust Seq Num | Uniquely identifies an Invoice Adjustment for a | Yes | No |
| | | given Invoice. | | |
| | Adjust Type Cd | This attribute reflects the type code for a monetary | No | Yes |
| | | adjustment made to a charge amount. | | |
| | Invoice Id | Uniquely identifies an INVOICE. | Yes | Yes |
| | Invoice Line Num | Uniquely identifies a line item on an Invoice. | No | Yes |
| | | Used to link the a specific Invoice Line being | | |
| | | adjusted. | | |
| | | Left null if the adjustment applies globally to the | | |
| | | Invoice, instead of a specific Invoice Line. | | |
| INVOICE AMOUNT | Invoice Amount Dttm | The date and time this amount was recorded. | Yes | No |
| | Invoice Amount Global Amt | The amount related to the specified INVOICE and | No | No |
| | | the invoice amount type code. | | |
| | | Global currency is assigned to the Set of Books. | | |
| | Invoice Amount Local Amt | The amount related to the specified INVOICE and | No | No |
| | | the invoice amount type code. | | |
| | | Each Set of Books is assigned a Local currency | | |
| | | code, which applies to the Invoice Amount in | | |
| | | Local Currency. | | |
| | Invoice Amount Transaction Amt | The amount related to the specified INVOICE and | No | No |
| | | the invoice amount type code. | | |
| | | Transaction currency must be defined for each | | |
| | | transaction, for example assigned by INVOICE. | | |
| | | Global and Local currency codes are assigned to | | |
| | | each Set of Books, but transaction currency codes | | |
| | | can vary by transaction. | | |
| | Invoice Amount Type Cd | The code for the type of INVOICE AMOUNT | Yes | Yes |
| | | TYPE. | | |
| | | Examples are: | | |
| | | Invoice original amount, | | |
| | | Unit price, | | |
| | | Invoice total amount | | |
| | | Freight invoice total amount, | | |
| | | Tax amount, | | |
| | | Discount amount, | | |
| | | Paid amount, | | |
| | | Unpaid amount, etc. | | |
| | Invoice Id | A number representing a unique identifier for a | Yes | Yes |
| | | INVOICE. | | |
| INVOICE AMOUNT TYPE | Invoice Amount Type Cd | The code for the type of INVOICE AMOUNT | Yes | No |
| | | TYPE. | | |
| | | Examples are: | | |
| | | Invoice original amount, | | |
| | | Unit price, | | |
| | | Invoice total amount | | |
| | | Freight invoice total amount, | | |
| | | Tax amount, | | |
| | | Discount amount, | | |
| | | Paid amount, | | |
| | | Unpaid amount, etc. | | |
| | Invoice Amount Type Desc | The description for the INVOICE AMOUNT | No | No |
| | | TYPE code. | | |
| INVOICE CHARGE | Charge Type Cd | Unique identifier for a CHARGE TYPE. | Yes | Yes |
| | Invoice Amt | The amount charged on the Invoice for this Charge | No | No |
| | | Type. | | |
| | Invoice Id | Uniquely identifies an INVOICE. | Yes | Yes |
| INVOICE INVOICE | Inv Inv Relationshp End Dttm | The date and time this INVOICE to INVOICE | No | No |
| RELATIONSHIP | | relationship ended. | | |
| | Inv Inv Relationshp Start Dttm | The date and time this INVOICE to INVOICE | Yes | No |
| | | relationship started. | | |
| | Invoice Id | A number representing a unique identifier for a | Yes | Yes |
| | | INVOICE. | | |
| | Invoice Relationship Type Cd | The unique code for the relationship that one | Yes | Yes |
| | | INVOICE has with another INVOICE. Examples | | |
| | | include replaces, credit memo for, etc. | | |
| | Related Invoice Id | A number representing a unique identifier for a | Yes | Yes |
| | | INVOICE. | | |
| INVOICE LINE PARTY | AP Invoice Id | A number representing a unique identifier for a | Yes | Yes |
| | | INVOICE. | | |
| | AP Invoice Ln Num | Uniquely identifies a line item on an Invoice. | Yes | Yes |
| | | The identifier for a specific line on an AP | | |
| | | INVOICE LINE document. | | |
| | Inv Line Party Role Type Cd | A unique code assigned to identify a PARTY's role | Yes | Yes |
| | | relationship to an Invoice Line. | | |
| | | Possible role codes could be Shipment Receiver, | | |
| | | Payment Approver and Goods Inspector. | | |
| | Invoice Line Party End Dttm | The calendar date on which an INVOICE LINE | No | No |
| | | PARTY relationship ended. | | |
| | Invoice Line Party Id | The unique identifier for any individual or group of | Yes | Yes |
| | | individuals that is of interest to the enterprise. | | |
| | | In this context it is the party that has a role with | | |
| | | this invoice line. | | |
| | Invoice Line Party Start Dttm | The calendar date on which an INVOICE LINE | Yes | No |
| | | PARTY relationship started. | | |
| INVOICE LINE PARTY ROLE | Inv Line Party Role Type Cd | A unique code assigned to identify a PARTY's role | Yes | No |
| | | relationship to an Invoice Line. | | |
| | | Possible role codes could be Shipment Receiver, | | |
| | | Payment Approver and Goods Inspector. | | |
| | Inv Line Party Role Type Desc | Describes a PARTY's role relationship to an | No | No |
| | | Invoice Line. | | |
| INVOICE LINE PAYMENT | Invoice Line Payment Num | The identifier for a specific line on an INVOICE | Yes | No |
| | | LINE PAYMENT. | | |
| | Invoice Payment Type Cd | The code used to uniquely identify the INVOICE | No | Yes |
| | | PAYMENT TYPE. | | |
| | Payment Id | Uniquely identifies a Payment. | Yes | Yes |
| INVOICE LINE PAYMENT | Inv Ln Paymnt Stat Comment Txt | Free form text that may be used to further describe | No | No |
| STATUS | | the status. For example, if the invoice line payment | | |
| | | was reversed, comments may be entered to further | | |
| | | describe the reversal reason. | | |
| | Inv Ln Paymnt Stat Dttm | The date and time a payment status was created. | Yes | No |
| | | Payment status can change over time, for example | | |
| | | be Approved but later Reversed. | | |
| | Invoice Line Payment Num | The identifier for a specific line on an INVOICE | Yes | Yes |
| | | LINE PAYMENT. | | |
| | Payment Id | Uniquely identifies a Payment. | Yes | Yes |
| | Payment Status Reason Type Cd | The unique code why the receipt was reversed. | No | Yes |
| | Payment Status Type Cd | The code used to uniquely identify the PAYMENT | Yes | Yes |
| | | STATUS TYPE. | | |
| INVOICE LINE PAYMENT TYPE | Invoice Payment Type Cd | The code used to uniquely identify the INVOICE | Yes | No |
| | | PAYMENT TYPE. | | |
| | Invoice Payment Type Desc | A description of the INVOICE PAYMENT TYPE | No | No |
| | | code. | | |
| INVOICE PARTY | Invoice Id | A number representing a unique identifier for a | Yes | Yes |
| | | INVOICE. | | |
| | Invoice Party End Dttm | The calendar date on which an INVOICE PARTY | No | No |
| | | relationship ended. | | |
| | Invoice Party Id | The unique identifier for any individual or group of | Yes | Yes |
| | | individuals that is of interest to the enterprise. | | |
| | | In this context it is the party that has a role with | | |
| | | this INVOICE. | | |
| | Invoice Party Role Type Cd | A unique identifier for the role that one party can | Yes | Yes |
| | | have with the INVOICE. | | |
| | Invoice Party Start Dttm | The calendar date on which an INVOICE PARTY | Yes | No |
| | | relationship started. | | |
| INVOICE PARTY ROLE TYPE | Invoice Party Role Type Cd | A unique identifier for the role that one party can | Yes | No |
| | | have with the invoice. | | |
| | Invoice Party Role Type Desc | A textual description for a Party Relationship Role. | No | No |
| INVOICE PAYMENT | Payment Tran Id | Uniquely identifies a Payment. | Yes | Yes |
| INVOICE PAYMENT APPLY | Applied Amt | For PAYMENTs that span multiple INVOICEs | No | No |
| | | indicate the amount applied to a specific INVOICE | | |
| | Closing Pmt Ind | Indicates that this PAYMENT satisfied the | No | No |
| | | INVOICE, thus closing it. Note that the | | |
| | | PAYMENT amount may not match the INVOICE | | |
| | | amount. | | |
| | Invoice Id | Uniquely identifies an INVOICE. | Yes | Yes |
| | Payment Apply Dttm | The date and time that the payment was applied. | No | No |
| | Payment Tran Id | Uniquely identifies a Payment. | Yes | Yes |
| INVOICE PO LINE XREF | Invoice Id | Uniquely identifies an INVOICE. | Yes | Yes |
| | Invoice Item Qty | The cross referenced Invoice Item quantity. | No | No |
| | Invoice Line Num | Uniquely identifies a line item on an Invoice. | Yes | Yes |
| | Vendor PO Id | Unique identifier for a VENDOR PURCHASE | Yes | Yes |
| | | ORDER. | | |
| | Vendor PO Line Num | The VENDOR PURCHASE ORDER LINE | Yes | Yes |
| | | number. | | |
| INVOICE QUANTITY TYPE | Invoice Quantity Type Cd | Assigns a code to INVOICE QUANTITY TYPEs. | Yes | No |
| | | For example, credited, invoiced and ordered. | | |
| | Invoice Quantity Type Desc | Provides a description of an INVOICE | No | No |
| | | QUANTITY TYPE code. | | |
| INVOICE RECEIPT LINE XREF | Invoice Id | Uniquely identifies an INVOICE. | Yes | Yes |
| | Invoice Item Qty | The cross referenced Invoice Item quantity. | No | No |
| | Invoice Line Num | Uniquely identifies a line item on an Invoice. | Yes | Yes |
| | Vendor Receipt Id | Unique identifier for the VENDOR RECEIPT | Yes | Yes |
| | | entity. | | |
| | Vendor Receipt Line Num | Identifies a specific line within a VENDOR | Yes | Yes |
| | | RECEIPT. | | |
| INVOICE RELATIONSHIP TYPE | Invoice Relationship Type Cd | The unique code for the relationship that one | Yes | No |
| | | INVOICE has with another INVOICE. Examples | | |
| | | include replaces, credit memo for, etc. | | |
| | Invoice Relationship Type Desc | The description of INVOICE relationship type. | No | No |
| INVOICE SALE LINE XREF | Invoice Id | Uniquely identifies an INVOICE. | Yes | Yes |
| | Invoice Item Qty | The cross referenced Invoice Item quantity. | No | No |
| | Invoice Line Num | Uniquely identifies a line item on an Invoice. | Yes | Yes |
| | Shopping Transaction Id | A unique identifier for this TRAVEL | Yes | Yes |
| | | TRANSACTION. | | |
| | Shopping Transaction Line Num | Identifies a specific line within a SHOPPING | Yes | Yes |
| | | TRANSACTION. | | |
| INVOICE SOURCE TYPE | Invoice Source Type Cd | The code associated with the source of the | Yes | No |
| | | INVOICE, i.e. auto invoice, transactions window, | | |
| | | etc. | | |
| | Invoice Source Type Desc | Description for the Invoice Source Type Cd. | No | No |
| INVOICE STATUS | Invoice Status Cd | Uniquely identifies an Invoice Status. | Yes | No |
| | Invoice Status Desc | Narrative text describing the Invoice Status. | No | No |
| INVOICE STATUS HIST | Invoice Id | A number representing a unique identifier for a | Yes | Yes |
| | | INVOICE. | | |
| | Invoice Status Cd | Uniquely identifies an Invoice Status. | Yes | Yes |
| | Invoice Status Dttm | The date and time this state of the INVOICE | Yes | No |
| | | started. | | |
| | | Note that an INVOICE STATUS can change over | | |
| | | time. | | |
| | Invoice Status Reason Cd | Uniquely identifies an Invoice Status Reason. | No | Yes |
| INVOICE STATUS REASON | Invoice Status Reason Cd | Uniquely identifies an Invoice Status Reason. | Yes | No |
| | Invoice Status Reason Desc | The description for the Invoice Status Reason code. | No | No |
| INVOICE TYPE | Invoice Type Cd | Uniquely identifies an Invoice Type. | Yes | No |
| | Invoice Type Desc | Narrative text describing the Invoice Type. | No | No |
| IP ADDRESS | Country Cd | The unique code for an instance of the COUNTRY | No | Yes |
| | | entity. | | |
| | Domain IP Reason Cd | A unique code that specifies the type of | No | Yes |
| | | relationship that may exist between an IP Address | | |
| | | and a Domain. | | |
| | Domain Name | The domain name minus the domain root. | No | No |
| | | Examples: aol; daytonoh.ncr; swsrv04.attbi | | |
| | Domain Root Cd | A unique identifier for the root of the domain | No | Yes |
| | | server. | | |
| | IP Address Num | The unique IP Address Number. | Yes | No |
| ITEM | Brand Cd | Uniquely identifies a BRAND. | No | Yes |
| | Commodity Cd | Uniquely identifies a commodity using a | No | Yes |
| | | Classification Standard. | | |
| | | Example: | | |
| | | NMFC Code | | |
| | Franchise Cd | Uniquely identifies a FRANCHISE. | No | Yes |
| | Inventory Item Ind | Indicates if the item is physically inventoried. | No | No |
| | | Example: | | |
| | | Some items that are NOT inventoried would be: | | |
| | | electronic download items, menu items (food | | |
| | | industry), service items, etc. | | |
| | | Note: If there is an requirement to capture several | | |
| | | attributes that pertain ONLY to these kinds of | | |
| | | Items, a separate Item Subtype should be created to | | |
| | | house them. | | |
| | Item Class Cd | Uniquely identifies an ITEM CLASS. | No | Yes |
| | Item Desc | Narrative text describing the ITEM. | No | No |
| | Item Id | Unique Identifier for an Item. | Yes | No |
| | Item Name | Short text reference or label for an ITEM. | No | No |
| | Item Subclass Cd | Uniquely identifies an ITEM SUBCLASS. | No | Yes |
| | Item Type Cd | Uniquely identifies the Item subtype. | No | Yes |
| | Multi Item Ind | Indicates that an Item is a Multi Item or not. | No | No |
| | | Example: “Yes” - item is a Multi Item, “No” - item | | |
| | | is not a Multi Item. | | |
| | Owner Party Id | The unique identifier for any individual or group of | No | Yes |
| | | individuals that is of interest to the enterprise. | | |
| | | The “Owner” of the Item Id. Used when an | | |
| | | External Organization's ITEMs need to be | | |
| | | represented. It can also be implemented with this | | |
| | | attribute as part of the PK to allow for the reuse of | | |
| | | an Item Id. | | |
| | | Note: There are essentially two different types of | | |
| | | Items: | | |
| | | Items that are resold (and often identified in a | | |
| | | standard way (UPC, GTIN)), and sold by | | |
| | | many 3rd Parties (Consumer Electronics, | | |
| | | Pharmaceuticals, etc.) - in this case the Owner | | |
| | | is the Party identified in the UPC (or | | |
| | | equivalent scan) Code. | | |
| | | Items that are unique to a specific Party and | | |
| | | not widely/typically resold by 3rd Parties | | |
| | | (OnD Product, FedEx Ground Transportation | | |
| | | Service, etc.) | | |
| | Pricing UOM Cd | The pricing unit of measure that applies to this | No | Yes |
| | | item. | | |
| | | Example: | | |
| | | A bottle of Coke has a pricing unit of measure of | | |
| | | “Each” or “Apiece.” | | |
| | | Ground Coffee is sold by the “Pound” or | | |
| | | “Kilogram.” | | |
| | | Bolts of cloth are sold by the “Yard”, etc. | | |
| | | Note: This measure is different from an ITEM | | |
| | | TRAIT. For the bottle of coke example above, a | | |
| | | trait might show a “Size” of 1 liter, etc., while the | | |
| | | price is set per bottle. | | |
| | | If the enterprise only sells items by the piece (for | | |
| | | example a book store) then this entity may be | | |
| | | omitted from the model. | | |
| | Salable Item Ind | An item that can be sold to a customer. | No | No |
| | | Could be physical, virtual, or a service. This is | | |
| | | typically the “Products” offered for sale by the | | |
| | | Enterprise. | | |
| | | Examples of items that are NOT salable to | | |
| | | customers would be: | | |
| | | For a Retailer: bulk items (pallet/carton level - | | |
| | | this is the level at which it is usually acquired | | |
| | | form suppliers). | | |
| | | for a Distributor: Consumer level retail items | | |
| | | (the bulk packaging of the same would be | | |
| | | Salable). | | |
| | | parts, components, or ingredients used to make | | |
| | | Salable Items | | |
| | | items acquired for internal use only. | | |
| | | Note: If there is an requirement to capture several | | |
| | | attributes that pertain ONLY to these kinds of | | |
| | | Items, a separate Item Subtype should be created to | | |
| | | house them. | | |
| | Service Item Ind | Work performed by the enterprise (or on behalf of | No | No |
| | | the enterprise) for a fee for the benefit of a | | |
| | | customer - typically referred to as “providing a | | |
| | | service” to a customer. | | |
| | | Example: Installation of a new PC, Transportation | | |
| | | Service, Carpet cleaning, Repair Service, etc. | | |
| | | Note: If there is an requirement to capture several | | |
| | | attributes that pertain ONLY to these kinds of | | |
| | | Items, a separate Item Subtype should be created to | | |
| | | house them. | | |
| | Vendor Party Id | The unique identifier for an organization. | No | Yes |
| | | Indicates the Organization that is the primary | | |
| | | marketer and seller of the item. Often the same | | |
| | | Organization as the manufacturer. | | |
| | | Example: | | |
| | | The brand “7 Up” is primary marketed and sold | | |
| | | (and also manufactured) by the Coca Cola | | |
| | | Company. | | |
| | | Note: The enterprise must decide what level of | | |
| | | meaningful information to source this attribute | | |
| | | with. In the soft drink example above it is useful, as | | |
| | | well as in the case of pharmacy items where the | | |
| | | Vendor and the manufacturer are typically the same | | |
| | | company. | | |
| | | It would typically not be used to list ‘actual’ | | |
| | | manufacturer for items such as toys (where well | | |
| | | known brands like Fisher Price products are | | |
| | | typically manufactured by Chinese companies that | | |
| | | the Enterprise would never have to deal with | | |
| | | directly or use for analytical decision making | | |
| | | processes.) | | |
| | | Another way to look at this attribute is to consider | | |
| | | it to be the Vendor of the item (which may or may | | |
| | | not be the same as the Supplier of the item, since | | |
| | | the item may be supplied by a distributor instead of | | |
| | | the Vendor) | | |
| ITEM (PART) SPEC | Estimated Cost Amt | The estimated MRO Item (parts) cost of this type | No | No |
| | | to perform this MRO Specification. | | |
| | MRO Item Id ASN | Unique Identifier for an Item. | Yes | Yes |
| | | Items that are used or consumed during | | |
| | | Maintenance Repair Operations. | | |
| | MRO Spec Id OII | Uniquely identifies a MRO Specification. | Yes | Yes |
| | Plan Qty | The Number of MRO Items (Parts) of this type | No | No |
| | | required to perform this MRO Specification. | | |
| ITEM CHARGES | Charge Amt | Amount charged for a specific component of a | No | No |
| | | PRODUCT. | | |
| | Charge Type Cd | Identifies a unique occurrence of CHARGE TYPE | Yes | Yes |
| | Liable Party Id | The unique identifier for any individual or group of | Yes | Yes |
| | | individuals that is of interest to the enterprise. | | |
| | | The Party liable for payment of item charges. | | |
| | Purchase Seq Num | An identifier for a specific PURCHASE ITEM | Yes | Yes |
| | | entity. | | |
| | Purchase Tran Id | A unique identifier for this TRAVEL | Yes | Yes |
| | | TRANSACTION. | | |
| ITEM CLASS | Associate Party Id | An individual who is employed by the enterprise. | No | Yes |
| | Department Cd | Uniquely identifies a DEPARTMENT. | No | Yes |
| | Item Class Cd | Uniquely identifies an ITEM CLASS. | Yes | No |
| | Item Class Name | Short text reference or label for the ITEM CLASS. | No | No |
| ITEM COST | Item Cost Amt DD | The cost of an ITEM. | No | No |
| | | This is derivable by adding up all the different Cost | | |
| | | Types present in the Item Cost Detail entity. | | |
| | | Note: If all the Cost components are not present | | |
| | | OR the Costs are not further exploded, this | | |
| | | attribute will NOT be derivable. | | |
| | Item Cost Start Dt | The date the item cost took effect. | Yes | No |
| | | Note: An end date may be added if gaps in the date | | |
| | | range need to be presented (at the risk of | | |
| | | introducing date overlaps) | | |
| | Item Id | Unique Identifier for an Item. | Yes | Yes |
| | Location Id | Uniquely identifies a LOCATION. | Yes | Yes |
| | | The Location the Cost applies to. Optional. | | |
| ITEM COST DETAIL | Allocated Cost Amt | The allocated Cost component for a specific Cost | No | No |
| | | Type. | | |
| | Cost Cd | Uniquely identifies a COST. | Yes | Yes |
| | | The Cost component specified. | | |
| | Item Cost Start Dt | The date the item cost took effect. | Yes | Yes |
| | | Note: An end date may be added if gaps in the date | | |
| | | range need to be presented (at the risk of | | |
| | | introducing date overlaps) | | |
| | Item Id | Unique Identifier for an Item. | Yes | Yes |
| | Location Id | Uniquely identifies a LOCATION. | Yes | Yes |
| | | The Location the Cost applies to. Optional. | | |
| ITEM EQUIVALENCE | Equivalence Type Cd | Uniquely identifies an Item Equivalence Type. | Yes | Yes |
| | Item Id | Unique Identifier for an Item. | Yes | Yes |
| | Related Item Id | Unique Identifier for an Item. | Yes | Yes |
| ITEM EQUIVALENCE TYPE | Equivalence Type Cd | Uniquely identifies an Item Equivalence Type. | Yes | No |
| | Equivalence Type Desc | Textual description of an Item Equivalence Type. | No | No |
| ITEM GROUP | Item Group Desc | Narrative text describing an ITEM GROUP. | No | No |
| | Item Group Id | Uniquely identifies an ITEM GROUP. | Yes | No |
| | | The item group to which the object may refer. This | | |
| | | attribute is considered to be mutually exclusive | | |
| | | with Item Id. | | |
| | Item Group Type Cd | Uniquely identifies an Item Group Type. | No | Yes |
| ITEM GROUP TERM | Agreement Id | Uniquely identifies an AGREEMENT. | Yes | Yes |
| | Agreement Term Id | Uniquely identifies an Agreement Term. | Yes | Yes |
| | Item Group Id | Uniquely identifies an ITEM GROUP. | Yes | Yes |
| | | The item group to which the object may refer. This | | |
| | | attribute is considered to be mutually exclusive | | |
| | | with Item Id. | | |
| ITEM GROUP TYPE | Item Group Type Cd | Uniquely identifies an Item Group Type. | Yes | No |
| | Item Group Type Desc | Textual description of an Item Group Type. | No | No |
| ITEM GROUP XREF | Item Group Id | Uniquely identifies an ITEM GROUP. | Yes | Yes |
| | | The item group to which the object may refer. | | |
| | | Note: This attribute is considered to be mutually | | |
| | | exclusive with Item Id. | | |
| | Item Id | Unique Identifier for an Item. | Yes | Yes |
| ITEM INVENTORY | Item Id ASN | Unique Identifier for an Item. | Yes | Yes |
| | | A subset of (physical) items than can be | | |
| | | inventoried, and shelved. This would exclude | | |
| | | service items and virtual items (downloadable | | |
| | | products). | | |
| | Item Inv Dt | A unique calendar date that is recognized by an | Yes | No |
| | | organization. | | |
| | | The date representing the inventory position. | | |
| | Location Id | Uniquely identifies a LOCATION. | Yes | Yes |
| | On Hand Cost Amt DD | The cost per unit to the enterprise for the remaining | No | No |
| | | items in stock. | | |
| | | Note: Item Pricing and Costing is shown in the | | |
| | | ITEM PRICING Subject Area. The Item Cost in | | |
| | | the ITEM PRICING Subject Area is used for | | |
| | | profitability calculations. | | |
| | | If Cost for Inventory purposes is calculated in the | | |
| | | same fashion, this will be a derived attribute. | | |
| | | This attribute will be needed if a different costing | | |
| | | process or value is used for Inventory purposes. | | |
| | On Hand Unit Qty | The counted ending quantity in stock available for | No | No |
| | | sale. | | |
| | On Hand Value Amt DD | The unit book value of an inventoried item after | No | No |
| | | temporary or permanent markdowns, if any, have | | |
| | | been applied but prior to any discounts being taken. | | |
| | | Note: If the enterprise use simple pricing this | | |
| | | attribute may be derivable. | | |
| | | For more complex pricing models, this may be a | | |
| | | non-derivable and populated by an application. | | |
| ITEM MSRP HIST | Item Id | Unique Identifier for an Item. | Yes | Yes |
| | MSRP Amt | The manufacturer's suggested retail price for an | No | No |
| | | item. | | |
| | MSRP End Dt | The last day the MSRP applies to. | No | No |
| | MSRP Start Dt | The effective date of the MSRP. | Yes | No |
| ITEM OFFER XREF | Item Group Id | Uniquely identifies an ITEM GROUP. | No | Yes |
| | | The item group to which the object may refer. This | | |
| | | attribute is considered to be mutually exclusive | | |
| | | with Item Id. | | |
| | Item Id | Unique Identifier for an Item. | No | Yes |
| | Item Offer Line Num | Differentiates different lines appearing on an item | Yes | No |
| | | offer xref. | | |
| | Location Id | Unique identifier for a LOCATION. | No | Yes |
| | | The location where the ITEM OFFER is valid. | | |
| | Org Party Id | The unique identifier for an organization. | No | Yes |
| | | The organization making the ITEM OFFER. | | |
| | Promo Offer Id | The unique identifier for a promo offer. | Yes | Yes |
| ITEM PRICE | Break Point End Qty | The high point of the range. The maximum item | No | No |
| | | quantity to qualify for the price. | | |
| | Break Point Start Qty | The low point of the range. The minimum item | No | No |
| | | quantity to qualify for the price. | | |
| | Item Id | Unique Identifier for an Item. | Yes | Yes |
| | Item Price Amt | Price of an ITEM. | No | No |
| | Pricing Id | Identifies a specific price for an Item. | Yes | Yes |
| | | Note: You typically have multiple Pricing Ids (and | | |
| | | prices) for the same Item. This can be due to: | | |
| | | date (price change over time) | | |
| | | condition set (different price by channel, | | |
| | | region, etc.) | | |
| | | volume scale (lower price based on volume | | |
| | | purchase) | | |
| | | etc. | | |
| ITEM PRICING | Item Id | Unique Identifier for an Item. | Yes | Yes |
| | Item Price Start Dt | The effective date of a specific Item Price. | No | No |
| | | Note: An end date may be added if gaps in the date | | |
| | | range need to be presented (at the risk of | | |
| | | introducing date overlaps) | | |
| | Price Change Reason Cd | Uniquely identifies a Price Change Reason. | No | Yes |
| | Pricing Id | Identifies a specific price for an Item. | Yes | No |
| | | Note: You typically have multiple Pricing Ids (and | | |
| | | prices) for the same Item. This can be due to: | | |
| | | date (price change over time) | | |
| | | condition set (different price by channel, | | |
| | | region, etc.) | | |
| | | volume scale (lower price based on volume | | |
| | | purchase) | | |
| | | etc. | | |
| | Rate Structure Num | Uniquely identifies a RATE STRUCTURE. | No | Yes |
| | | Groups a set of prices together to form a pricing | | |
| | | collection that can be offered to customers. | | |
| | | Can be used in Agreement Pricing. | | |
| | | A Special Rate Structure can be created to be used | | |
| | | in the A = absence of Agreements (“base rate”) | | |
| | Selling Party Id | The unique identifier for any individual or group of | No | Yes |
| | | individuals that is of interest to the enterprise. | | |
| ITEM SCORE | Item Id | Unique Identifier for an Item. | Yes | Yes |
| | Item Score Num | The actual score produced for the ITEM by the | No | No |
| | | ANALYTICAL MODEL. | | |
| | | Example: Item 10278 has a ‘customer profitability’ | | |
| | | score of 7 out of 10; Item 405 has a “propensity to | | |
| | | be purchased’ score of 4 out of 10. | | |
| | Model Id | The unique identifier for an instance of the | Yes | Yes |
| | | ANALYTICAL MODEL entity. | | |
| | Model Run Id | An identifier (or sequential number) that uniquely | Yes | Yes |
| | | describes this particular run of the ANALYTICAL | | |
| | | MODEL. | | |
| ITEM STATUS | Item Status Cd | Uniquely identifies an Item Status Code. | Yes | No |
| | Item Status Desc | Textual description of an Item Status Code. | No | No |
| ITEM STATUS HIST | Item Id | Unique Identifier for an Item. | Yes | Yes |
| | Item Status Cd | Uniquely identifies an Item Status Code. | Yes | Yes |
| | Item Status Dt | The Date the Status took effect. | Yes | No |
| ITEM SUBCLASS | Item Class Cd | Uniquely identifies an ITEM CLASS. | Yes | Yes |
| | Item Subclass Cd | Uniquely identifies an ITEM SUBCLASS. | Yes | No |
| | Item Subclass Name | Short text reference or label for the ITEM | No | No |
| | | SUBCLASS. | | |
| ITEM TERM | Agreement Id | Uniquely identifies an AGREEMENT. | Yes | Yes |
| | Agreement Term Id | Uniquely identifies an Agreement Term. | Yes | Yes |
| | Item Id | Unique Identifier for an Item. | Yes | Yes |
| ITEM TRAIT | Item Id | Unique Identifier for an Item. | Yes | Yes |
| | Trait Cd | Uniquely identifies a TRAIT. | Yes | Yes |
| | Trait Value Cd | Uniquely identifies a TRAIT VALUE. | No | Yes |
| ITEM TYPE | Item Type Cd | Uniquely identifies the Item subtype. | Yes | No |
| | Item Type Desc | Narrative text describing the Item subtype. | No | No |
| JOB CLASSIFICATION | Job Classification Cd EPT | Uniquely identifies a JOB CLASSIFICATION. | Yes | No |
| | Job Classification Desc | Narrative text describing a JOB | No | No |
| | | CLASSIFICATION. | | |
| JOINT PROJECT | Project Id | The unique identifier for the PROJECT. | Yes | Yes |
| JOURNAL ENTRY HEADER | JE Header Batch Id | The unique identifier for the general/sub LEDGER | No | Yes |
| | | BATCH processing. | | |
| | JE Header Conv Dttm | The JOURNAL ENTRY HEADER conversion | No | No |
| | | date. | | |
| | JE Header Create Dttm | The JOURNAL ENTRY HEADER creation date. | No | No |
| | JE Header Desc | The description of the JOURNAL ENTRY | No | No |
| | | HEADER. | | |
| | JE Header Host Header Id | The identifier for the JOURNAL ENTRY | No | No |
| | | HEADER in the host system. | | |
| | JE Header Id | The unique identifier for the JOURNAL ENTRY | Yes | No |
| | | HEADER. | | |
| | JE Header Month Id | The unique identifier for an ACCOUNTING | No | Yes |
| | | PERIOD MONTH. | | |
| | JE Header Name | The name assigned to the JOURNAL ENTRY | No | No |
| | | HEADER. | | |
| | JE Header Posted Dttm | The JOURNAL ENTRY HEADER posted date. | No | No |
| | JE Header Reversing Ind | The flag assigned to indicate if the JOURNAL | No | No |
| | | ENTRY HEADER was reversed. | | |
| | JE Header Reversing Month Id | The unique identifier for an ACCOUNTING | No | Yes |
| | | PERIOD MONTH. | | |
| | Set Of Books Cd | The unique identifier for the SET OF BOOKS. | No | Yes |
| | Set Of Books Start Dttm | The date marking the beginning for a SET OF | No | Yes |
| | | BOOKS. | | |
| JOURNAL ENTRY LINE | Charge To Employee Party Id | The unique identifier for any individual or group of | No | Yes |
| | | individuals that is of interest to the enterprise. | | |
| | Created By Employee Party Id | The unique identifier for any individual or group of | No | Yes |
| | | individuals that is of interest to the enterprise. | | |
| | Internal Org Party Id | The unique identifier for an internal organization. | No | Yes |
| | JE Header Id | The unique identifier for the JOURNAL ENTRY | Yes | Yes |
| | | HEADER. | | |
| | Journal Entry Line COA Id | The unique identifier for a CHART OF | No | Yes |
| | | ACCOUNT, or alias for a complete CHART OF | | |
| | | ACCOUNTs number. | | |
| | Journal Entry Line Credit Ind | The flag assigned to indicate if the JOURNAL | No | No |
| | | ENTRY LINE is a credit account transaction. | | |
| | Journal Entry Line Desc | The description of the JOURNAL ENTRY LINE. | No | No |
| | Journal Entry Line Global Amt | The monetary amount of the JOURNAL ENTRY | No | No |
| | | LINE. | | |
| | | In the global accounting currency. | | |
| | Journal Entry Line Local Amt | The monetary amount of the JOURNAL ENTRY | No | No |
| | | LINE. | | |
| | | In the local accounting currency. | | |
| | Journal Entry Line Num | The JOURNAL ENTRY LINE number. | Yes | No |
| | Journal Entry Line Trans Amt | The monetary amount of the JOURNAL ENTRY | No | No |
| | | LINE. | | |
| | | In the transaction currency. | | |
| | Journl Entry Ln Trans Crncy Cd | The code assigned to a CURRENCY. | No | Yes |
| KENO SESSION | Keno Casino Adv Pct | The advantage that the CASINO holds in any | No | No |
| | | KENO SESSION. Typically this can range from | | |
| | | 25% to 40% | | |
| | Keno Number House Draw Cnt | The maximum count of numbers drawn out by the | No | No |
| | | CASINO as the “lucky” numbers. For example, 20 | | |
| | | numbers chosen from a field of 80. | | |
| | Keno Number Match Cnt | The count of numbers chosen by the CASINO | No | No |
| | | PLAYER that match with the house draw. | | |
| | Keno Number Total Cnt | The numbers included in the complete field from | No | No |
| | | which the CASINO PLAYER chooses anywhere | | |
| | | between 1 to HOUSE DRAW CNT. | | |
| | Keno Payoff Amt | The amount of money that the CASINO pays the | No | No |
| | | CASINO PLAYER according to a payoff schedule | | |
| | Keno Player Chosen Number Cnt | The count of numbers chosen by the CASINO | No | No |
| | | PLAYER. For example, the player chooses 5 out | | |
| | | of 80. | | |
| | Keno Session Total Bet Amt | The amount spent by the CASINO PLAYER as the | No | No |
| | | KENO SESSION wager. (Keno Player Chosen | | |
| | | Number Cnt × bet amt) | | |
| | Session Start Dttm | The start of a rated gaming session (that is, a | Yes | Yes |
| | | gaming session where the identity of the player is | | |
| | | known). | | |
| | Visit Id | The unique identifier for an instance of the VISIT | Yes | Yes |
| | | entity. | | |
| KIDS CLUB RESERVATION | Reservation Seq Num | This attribute identifies a specific RESERVATION | Yes | Yes |
| | | ITEM. | | |
| | Reservation Transaction Id | A unique identifier for this TRAVEL | Yes | Yes |
| | | TRANSACTION. | | |
| KIOSK | Kiosk Loc Id | Uniquely identifies a LOCATION. | Yes | Yes |
| | | A kiosk or self-service terminal. | | |
| | Kiosk Type Cd | Uniquely identifies a KIOSK TYPE. | No | Yes |
| KIOSK TYPE | Kiosk Type Cd | Uniquely identifies a KIOSK TYPE. | Yes | No |
| | Kiosk Type Desc | Narrative text describing the type of KIOSK. | No | No |
| LABOR PLAN | Job Classification Cd EPT | Uniquely identifies a JOB CLASSIFICATION. | Yes | Yes |
| | Location Id | Uniquely identifies a LOCATION. | Yes | Yes |
| | Plan Cost Amt | Denotes the planned labor costs for a particular job | No | No |
| | | classification, a specific time period, at a specific | | |
| | | LOCATION. | | |
| | Plan Hours Qty | The planned labor hours for a particular JOB | No | No |
| | | CLASSIFICATION, a specific time period, at a | | |
| | | specific LOCATION. | | |
| | Plan Overtime Cost Amt | Denotes the planned overtime labor costs for a | No | No |
| | | particular job classification, a specific time period, | | |
| | | at a specific LOCATION. | | |
| | Plan Overtime Hours Qty | The planned labor overtime hours for a particular | No | No |
| | | JOB CLASSIFICATION, a specific time period, at | | |
| | | a specific LOCATION. | | |
| | Plan Period End Dt | The date on which the labor plan ends. | No | No |
| | Plan Period Start Dt | The date on which the LABOR PLAN begins. | Yes | No |
| | Work Shift Cd | Uniquely identifies a WORK SHIFT. | Yes | Yes |
| LABOR POOL | Associate Party Id | An individual who is employed by the enterprise. | Yes | Yes |
| | Location Id | Uniquely identifies a LOCATION. | Yes | Yes |
| LABOR SCHEDULE | Associate Party Id | An individual who is employed by the enterprise. | Yes | Yes |
| | Job Classification Cd EPT | Unique identifier for a JOB CLASSIFICATION. | Yes | Yes |
| | | Note: This attribute is included because an | | |
| | | associate may be scheduled to perform a job | | |
| | | classification other than his/her assigned one. | | |
| | | Example: A Sr. Cashier may be scheduled to act as | | |
| | | Supervisor for a shift (and be paid accordingly). | | |
| | Labor Dt | The date on which labor is to be scheduled. | Yes | No |
| | Location Id | Uniquely identifies a LOCATION. | Yes | Yes |
| | Schedule Hours Qty | The number of non overtime hours the associate is | No | No |
| | | scheduled to work. | | |
| | Schedule Overtime Hours Qty | The number of overtime hours the associate is | No | No |
| | | scheduled to work. | | |
| | Work Shift Cd | Uniquely identifies a WORK SHIFT. | Yes | Yes |
| LEDGER BATCH | Ledger Batch Accounting Dttm | The LEDGER BATCH date that applies for | No | No |
| | | accounting purposes. | | |
| | Ledger Batch Creation Dttm | The creation date for the LEDGER BATCH. | No | No |
| | Ledger Batch Desc | The description of the general/sub LEDGER | No | No |
| | | BATCH. | | |
| | Ledger Batch Host Num | The LEDGER BATCH number in the host system. | No | No |
| | Ledger Batch Id | The unique identifier for the general/sub LEDGER | Yes | No |
| | | BATCH processing. | | |
| | Ledger Batch Name | The name assigned to the general/sub LEDGER | No | No |
| | | BATCH. | | |
| | Ledger Batch Posted Dttm | The date the LEDGER BATCH was posted or | No | No |
| | | recorded to the General or Sub Ledger. | | |
| | Ledger Batch Type Cd | The unique code assigned to the batch processing | No | Yes |
| | | type. Possible examples may be: | | |
| | | Batch from accounts payable, batch from accounts | | |
| | | receivable, batch from AP invoices, batch from AR | | |
| | | invoices, etc. | | |
| | Ledger Posting Status Cd | The unique code assigned to the LEDGER | No | Yes |
| | | POSTING STATUS. Possible examples may be: | | |
| | | Posted (ready to be entered in the general/sub | | |
| | | ledger), | | |
| | | Do not post, etc. | | |
| LEDGER BATCH TYPE | Ledger Batch Type Cd | The unique code assigned to the general/sub | Yes | No |
| | | LEDGER BATCH TYPE. Possible examples may | | |
| | | be: | | |
| | | Batch from journal entries, | | |
| | | Batch from accounts payable, | | |
| | | batch from accounts receivable, etc. | | |
| | Ledger Batch Type Desc | The description of the LEDGER BATCH TYPE. | No | No |
| | Ledger Batch Type Name | The name assigned to the general/sub LEDGER | No | No |
| | | BATCH TYPE. | | |
| LEDGER POSTING STATUS | Ledger Posting Status Cd | The unique code assigned to the LEDGER | Yes | No |
| | | POSTING STATUS. Possible examples may be: | | |
| | | Posted (ready to be entered in the general/sub | | |
| | | ledger), | | |
| | | Do not post, etc. | | |
| | Ledger Posting Status Desc | The description of the LEDGER POSTING | No | No |
| | | STATUS. | | |
| LEG | Destination Facility Id | Uniquely identifies a LOCATION. | Yes | Yes |
| | ETOPS Cd EFI | Applies to Aircraft. | No | Yes |
| | | ETOPS (Extended-range Twin-engine Operation | | |
| | | Performance Standards). | | |
| | | If the Aircraft is approved for extended flight away | | |
| | | from an emergency of diversion airport, this will | | |
| | | indicate the certified ETOPS Rating. | | |
| | | Example: | | |
| | | ETOPS-90 | | |
| | | ETOPS-120/138 | | |
| | | ETOPS-180/207 | | |
| | Flight Num DFN | A unique identifier assigned to a Flight scheduled | Yes | Yes |
| | | for generating revenue and utilized by the general | | |
| | | public. | | |
| | Leg Seq Num | A numeric sequence assigned to each leg in the | No | No |
| | | order in which they appear in a Scheduled Flight. | | |
| | | Example: For a round trip flight from LAX to NYC | | |
| | | that stops in Chicago both ways, the | | |
| | | FlightSegmentSeqNBRs would be as follows: | | |
| | | 1 = LAX to ORD, 2 = ORD to LGA, | | |
| | | 3 = LGA to ORD, 4 = ORD to LAX. | | |
| | Origin Facility Id | Uniquely identifies a LOCATION. | Yes | Yes |
| LEG BOOKING HIST | Adjustment Cnt | An adjustment, also referred to as an ADJ, is a | No | No |
| | | facility that allows us to plan on upgrading people. | | |
| | | The sum of adjustments for all compartments for a | | |
| | | flight on a given date and days to departure is | | |
| | | always 0. | | |
| | | i.e. if you upgrade 2 people to business class from | | |
| | | economy, Adjustment Cnt for business class is +2 | | |
| | | and Adjustment Cnt for economy is −2 | | |
| | Allowed Overbook Pct | The percentage to which a travel provider is | No | No |
| | | prepared to overbook capacity to take into account | | |
| | | canceling and noshowing passengers. | | |
| | Blocked Seat Cnt | Seats being held back (not for sale) at the | No | No |
| | | leg/service class level | | |
| | Capacity Cnt | Number of physical seats present in a | No | No |
| | | configuration. It does not include the deadweight | | |
| | | seat count. | | |
| | Days To Dept Cnt | A designated point in time across the booking | Yes | No |
| | | history of a flight (i.e. x days before departure) at | | |
| | | which key metrics for a flight are recorded. | | |
| | | Usually a flight is made available for booking by | | |
| | | the inventory system 365 days in advance. | | |
| | | As the flight departure date nears, the metrics are | | |
| | | recorded more frequently and they are recorded | | |
| | | further apart during the early part of a flight's | | |
| | | booking life. | | |
| | | This is called a Checkpoint by some airlines | | |
| | Deadweight Seat Cnt | Number of seats that have to be sacrificed because | No | No |
| | | of the associated weight of equipment and/or | | |
| | | cargo on an airplane | | |
| | | Only at LEG level, since it is an flight operations | | |
| | | element. | | |
| | Destination Facility Id | Uniquely identifies a LOCATION. | Yes | Yes |
| | Flight Num DFN | A unique identifier assigned to a Flight scheduled | Yes | Yes |
| | | for generating revenue and utilized by the general | | |
| | | public. | | |
| | Gross Availability Cnt DD | Capacity Cnt * (1 + Allowed Overbook Pct) − Leg | No | No |
| | | Seats Booked Cnt − Blocked Seat Cnt + Adjustment | | |
| | | Cnt | | |
| | Origin Facility Id | Uniquely identifies a LOCATION. | Yes | Yes |
| | Sched Leg Depart Dttm TME | The scheduled departure date and time of a LEG. | Yes | Yes |
| | | Note. If this LEG is the initial LEG of one (or | | |
| | | more) SEGMENT, this departure date and time | | |
| | | would typically be identical to the corresponding | | |
| | | SEGMENT departure date and time. | | |
| | Seats Booked Cnt | Number of seats booked at this time. | No | No |
| | Seats Ticketed Cnt | Number of seats that have been ticketed at this | No | No |
| | | time. | | |
| | Service Class Cd | The unique identifier of a specific CLASS OF | Yes | Yes |
| | | SERVICE offered by a TRAVEL PROVIDER. | | |
| LEG CONTAINER | Destination Facility Id | Uniquely identifies a LOCATION. | Yes | Yes |
| | Equip Id OIN | Uniquely identifies an Equipment Instance. | Yes | Yes |
| | | Identifies a specific piece of Container Equipment | | |
| | | in this case. | | |
| | Flight Num DFN | A unique identifier assigned to a Flight scheduled | Yes | Yes |
| | | for generating revenue and utilized by the general | | |
| | | public. | | |
| | Origin Facility Id | Uniquely identifies a LOCATION. | Yes | Yes |
| | Position Num | Identifies the location of the container within a | No | No |
| | | piece of Equipment. | | |
| | | Example: Identifies the bay location of a specific | | |
| | | ULD within the cargo hold of a 747. | | |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| LEG EQUIP (ACTUAL) | Cube Capacity Pct | The actual percentage of total maximum cubic- | No | No |
| | | foot/meter capacity currently in use for this piece | | |
| | | of LEG EQUIPMENT. | | |
| | Destination Facility Id | Uniquely identifies a LOCATION. | Yes | Yes |
| | Equip Id OIN | Uniquely identifies an Equipment Instance. | Yes | Yes |
| | Exclusive Use Ind | Indicates that a Shipper requested and obtained | No | No |
| | | exclusive use of the Aircraft/Trailer/Container. In | | |
| | | this case, no other goods will be added, even if | | |
| | | capacity is available. | | |
| | | Example: “No” - not exclusive use. | | |
| | Flight Num DFN | A unique identifier assigned to a Flight scheduled | Yes | Yes |
| | | for generating revenue and utilized by the general | | |
| | | public. | | |
| | Origin Facility Id | Uniquely identifies a LOCATION. | Yes | Yes |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| | Weight Capacity Pct | The percentage measure of the current load versus | No | No |
| | | the approved weight capacity for an instance of this | | |
| | | LEG EQUIPMENT. | | |
| LEG EQUIPMENT PIECE | Depth Position Cd | Location in the Equipment (vehicle or container) | No | No |
| | | where a Piece is positioned from rear to front. | | |
| | | Example: | | |
| | | tail | | |
| | | middle | | |
| | | nose | | |
| | Destination Facility Id | Uniquely identifies a LOCATION. | Yes | Yes |
| | Equip Id OIN | Uniquely identifies an Equipment Instance. | Yes | Yes |
| | Flight Num DFN | A unique identifier assigned to a Flight scheduled | Yes | Yes |
| | | for generating revenue and utilized by the general | | |
| | | public. | | |
| | Height Position Cd | Location in the Equipment (vehicle or container) | No | No |
| | | where a Piece is positioned from top to bottom. | | |
| | | Examples: | | |
| | | floor | | |
| | | middle | | |
| | | top | | |
| | Manifest Id | Uniquely identifies a Manifest. | No | Yes |
| | Origin Facility Id | Uniquely identifies a LOCATION. | Yes | Yes |
| | Piece Num | Uniquely identifies a PIECE contained in a | Yes | Yes |
| | | SHIPMENT. | | |
| | | This can often be thought of as a “Tracking | | |
| | | Number” | | |
| | | Identifies a Piece (of a Shipment) being transported | | |
| | | by this Equipment over the specified Leg. | | |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| LEG FLOWN (SUMMARY) | Capacity Cnt | Number of physical seats present in a configuration | No | No |
| | Cost Per Seat Mile Amt DD | A derived(DD) amount based on operating cost | No | No |
| | | that varies depending on the VEHICLE MODEL. | | |
| | | This is a measure that TRAVEL PROVIDERs | | |
| | | calculate to make seating arrangement plans. Once | | |
| | | the seating arrangement is determined for a | | |
| | | PRODUCT segment, the cost per seat | | |
| | | mile/kilometer will remain the same until the seat | | |
| | | arrangement is changed again. | | |
| | Destination Facility Id | Uniquely identifies a LOCATION. | Yes | Yes |
| | Flight Num DFN | A unique identifier assigned to a Flight scheduled | Yes | Yes |
| | | for generating revenue and utilized by the general | | |
| | | public. | | |
| | Origin Facility Id | Uniquely identifies a LOCATION. | Yes | Yes |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| | Seats Booked Cnt | Number of seats booked. | No | No |
| | Seats Flown Cnt | Number of seats that actually contained a flown | No | No |
| | | passenger | | |
| | Seats Ticketed Cnt | Number of seats that have been ticketed. | No | No |
| | Service Class Cd | The unique identifier of a specific CLASS OF | Yes | Yes |
| | | SERVICE offered by a TRAVEL PROVIDER. | | |
| | Weight Factor Pct | A ratio weighted for the Service Class seats and | No | No |
| | | calculated based on the size of seats and the | | |
| | | number of “upper” class seats that can be provided | | |
| | | compared to economy seats. This weight uses | | |
| | | economy seats as a base, therefore, the weight for | | |
| | | economy class seats is 1.0. Similar to Cost per seat | | |
| | | mile/kilometer, this measure will remain the same | | |
| | | until the seat arrangement is changed again. | | |
| | | FIRST CLASS EXAMPLE: | | |
| | | Weight for First Class Seat = The Number of | | |
| | | Economy Class Seats that could be provided in the | | |
| | | space assigned for First Class seats divided by the | | |
| | | Number of First Class Seats Provided | | |
| | | Example: For a wide body “twin aisle” type | | |
| | | aircraft (767, 777, 747, DC10, A300/340) with the | | |
| | | following seat arrangement: | | |
| | | First Class: 3 Rows of 4 seats (72″ length) per row | | |
| | | occupying 216″ of length of aircraft | | |
| | | Economy Class: 20 Rows of 8 seats (30″ length) | | |
| | | per row | | |
| | | The 216″ length space in First Class can | | |
| | | accommodate 7 Rows of 8 seats per row of | | |
| | | Economy Class seats, therefore, | | |
| | | Weight for First Class Seat = 56/12 = 4.7 | | |
| | | Weight for Economy Class Seat = 1.0 | | |
| | | BUSINESS CLASS EXAMPLE: | | |
| | | Weight for Business Class Seat = The Number of | | |
| | | Economy Class Seats that could be provided in the | | |
| | | space assigned for Business Class seats | | |
| | | divided by the Number of Business Class Seats | | |
| | | Provided. | | |
| | | Example: for a wide body “twin aisle” type aircraft | | |
| | | (767, 777, 747, DC10, A300/340) with the | | |
| | | following seat arrangement: | | |
| | | Business Class: 8 Rows of 6 seats (50″ length) per | | |
| | | row occupying 400″ of length of aircraft | | |
| | | Economy Class: 20 Rows of 8 seats (30″ length) | | |
| | | per row | | |
| | | The 400″ length space in Business Class can | | |
| | | accommodate 13 Rows of 8 seats per row of | | |
| | | Economy Class seats, therefore, | | |
| | | Weight for Business Class Seat = 104/48 = 2.2 | | |
| | | Weight for Economy Class Seat = 1.0 | | |
| LEG FLOWN | Destination Facility Id | Uniquely identifies a LOCATION. | Yes | Yes |
| CARGO(SUMMARY) | | | | |
| | Flight Num DFN | A unique identifier assigned to a Flight scheduled | Yes | Yes |
| | | for generating revenue and utilized by the general | | |
| | | public. | | |
| | Origin Facility Id | Uniquely identifies a LOCATION. | Yes | Yes |
| | Revenue per Kilogram Meas | The total Cargo Revenue for the Leg, divided by | No | No |
| | | the total Cargo Weight for the Leg. | | |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| | Weight Booked Meas | The total Cargo Weight booked for the Leg. | No | No |
| | Weight Flown Meas | The actual Cargo Weight flown for the Leg. | No | No |
| LEG INCIDENT | Destination Facility Id | Uniquely identifies a LOCATION. | Yes | Yes |
| | Equip Event Id ERI | Uniquely identifies a Equipment Event. | No | Yes |
| | Flight Num DFN | A unique identifier assigned to a Flight scheduled | Yes | Yes |
| | | for generating revenue and utilized by the general | | |
| | | public. | | |
| | Incident Reason Cd | The code assigned to every single reason that | No | Yes |
| | | corresponds to every incident that may occur | | |
| | | during a flight. | | |
| | | Example: flight delayed due to weather, flight | | |
| | | diverted because of closed airport, etc. | | |
| | Incident Type Cd | Defines code assigned to every type of incident that | No | Yes |
| | | may occur. | | |
| | | Examples: 1 = Flight delayed, 2 = Flight cancelled, | | |
| | | 3 = Flight diverted, etc. | | |
| | Leg Incident Num | Allows uniqueness of incidents within a | Yes | No |
| | | SCHEDULED LEG. | | |
| | | Note: This will allow multiple incidents of the | | |
| | | same type to occur for a given scheduled leg. | | |
| | Origin Facility Id | Uniquely identifies a LOCATION. | Yes | Yes |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| LEG SPACE ALLOCATION | Allocated Volume Meas DD | The volume available for allocation for a type of | No | No |
| | | Container or loose freight for a specific Scheduled | | |
| | | Leg (may be derivable) | | |
| | Allocated Weight Meas DD | The total weight allocated to the type of Container | No | No |
| | | or loose freight for a specific Scheduled Leg (may | | |
| | | be derivable) | | |
| | Available Volume Meas DD | The volume available for allocation for a type of | No | No |
| | | Container or loose freight for a specific Scheduled | | |
| | | Leg (may be derivable) | | |
| | Available Weight Meas DD | The weight available for allocation for a type of | No | No |
| | | Container or loose freight for a specific Scheduled | | |
| | | Leg (may be derivable) | | |
| | Cargo Position Num | Identifies a specific cargo position being allocated. | Yes | No |
| | | In the case of a Container, it can be the Container | | |
| | | slot position in the Transport Vehicle that can fit a | | |
| | | Container of this type of Class, and in the case of | | |
| | | loose freight, indicate a loose freight area in the | | |
| | | Transport Vehicle. | | |
| | Container Class Cd | Uniquely defines a Container Class. | No | Yes |
| | | Used to pre-allocate a container class. Leave blank | | |
| | | to allocate loose freight. | | |
| | Destination Facility Id | Uniquely identifies a LOCATION. | Yes | Yes |
| | Flight Num DFN | A unique identifier assigned to a Flight scheduled | Yes | Yes |
| | | for generating revenue and utilized by the general | | |
| | | public. | | |
| | Origin Facility Id | Uniquely identifies a LOCATION. | Yes | Yes |
| | Sched Leg Depart Dttm TME | The scheduled departure date and time of a LEG. | Yes | Yes |
| | | Note. If this LEG is the initial LEG of one (or | | |
| | | more) SEGMENT, this departure date and time | | |
| | | would typically be identical to the corresponding | | |
| | | SEGMENT departure date and time. | | |
| LEG TRAN EQUIP | Destination Facility Id | Uniquely identifies a LOCATION. | Yes | Yes |
| | Equip Id OIN | Uniquely identifies an Equipment Instance. | Yes | Yes |
| | | Identifies a specific piece of Transportation | | |
| | | Equipment in this case. | | |
| | Flight Num DFN | A unique identifier assigned to a Flight scheduled | Yes | Yes |
| | | for generating revenue and utilized by the general | | |
| | | public. | | |
| | Origin Facility Id | Uniquely identifies a LOCATION. | Yes | Yes |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| LIABILITY ACCOUNT | GL Main Account Num | The unique Chart of Account code for the GL | Yes | Yes |
| | | MAIN ACCOUNT. | | |
| | Liability Account Party Id | The unique identifier for any individual or group of | No | Yes |
| | | individuals that is of interest to the enterprise. | | |
| | | The PARTY to whom money is owed. | | |
| | Liability Account Type Cd | The unique code assigned to the LIABILITY | No | Yes |
| | | ACCOUNT TYPE. Types of liability accounts are | | |
| | | current liability and non-current liability. | | |
| LIABILITY ACCOUNT TYPE | Liability Account Type Cd | The unique code assigned to the LIABILITY | Yes | No |
| | | ACCOUNT TYPE. Types of liability accounts are | | |
| | | current liability and non-current liability. | | |
| | Liability Account Type Desc | The description of the LIABILITY ACCOUNT | No | No |
| | | TYPE. | | |
| LIMIT TYPE | Limit Type Cd | A code for the type of credit limit such as credit | Yes | No |
| | | limit, credit limit per order, credit limit per site. | | |
| | Limit Type Desc | The description of the code. | No | No |
| LIMO RESERVATION | Reservation Seq Num | This attribute identifies a specific RESERVATION | Yes | Yes |
| | | ITEM. | | |
| | Reservation Transaction Id | A unique identifier for this TRAVEL | Yes | Yes |
| | | TRANSACTION. | | |
| LOCAL SALES TERRITORY | District Cd | Uniquely identifies a DISTRICT. | No | Yes |
| | Local Mgr Assoc Id | An individual who is employed by the enterprise. | No | Yes |
| | | The Manager in charge of the local sales territory. | | |
| | Local Sales Territory Id | Uniquely identifies a LOCAL SALES | Yes | No |
| | | TERRITORY. | | |
| LOCATION | Chain Cd | Uniquely identifies a CHAIN. | No | Yes |
| | Channel Cd | Uniquely identifies a CHANNEL. | No | Yes |
| | Corporate Adjust Tm | Defines the time offset to a standard “Corporate” or | No | No |
| | | “Headquarters” time, if required. | | |
| | | Note: Derivable if the Headquarters Location and | | |
| | | associated Time Zone/Local time are known. | | |
| | District Cd | Uniquely identifies a DISTRICT. | No | Yes |
| | Floor Plan Id | Uniquely identifies a Floor Plan Id | No | Yes |
| | Housed On Equip Id | Uniquely identifies a piece of Equipment that can | No | Yes |
| | | be used to transport individuals or cargo. | | |
| | | Used only if the Location is physically located on | | |
| | | Transportation Equipment. | | |
| | | Example: | | |
| | | a Casino on a Cruise Ship or Boat | | |
| | | Fine Dining Restaurant on a Train | | |
| | Location Close Dt | The date on which this location ceased being used | No | No |
| | | for business. | | |
| | Location Effective Dt | The date on which the Location attained its current | No | No |
| | | configuration.. | | |
| | | This date may simply be the date the business was | | |
| | | first opened. Alternately, if the configuration of a | | |
| | | business changes considerably (enlarges, for | | |
| | | example), this date will then reflect the date when | | |
| | | the configuration change went into effect. | | |
| | | This date is typically used to alert the user when | | |
| | | attempting to do sales comparison of pre- | | |
| | | configuration numbers with post-configuration | | |
| | | numbers. | | |
| | Location Id | Uniquely identifies a LOCATION. | Yes | No |
| | Location Mgr Assoc Id | An individual who is employed by the enterprise. | No | Yes |
| | | The manager of the LOCATION. | | |
| | Location Name RLN | Name, Short text reference or Label for the | No | No |
| | | LOCATION. | | |
| | Location Open Dt | The date on which the location was first used for | No | No |
| | | business. | | |
| | Location Total Area Meas | The square area size of the Location expressed in | No | No |
| | | square meters or square feet. | | |
| | Location Type Cd | Uniquely identifies a LOCATION TYPE. | No | Yes |
| | Owner Org Party Id | The unique identifier for an organization. | No | Yes |
| | | Identifies the Owner of the business conducted at | | |
| | | the LOCATION (not necessarily the actual owner | | |
| | | of the real estate or building facility - which may or | | |
| | | may not be the same Party). | | |
| | Parent Location Id | Uniquely identifies a LOCATION. | No | Yes |
| | | The parent or owning location for this location. | | |
| | SPLC Cd | Standard Point Location Code (SPLC) for the | No | No |
| | | LOCATION, as controlled by the NMFTA | | |
| | | National Motor Freight Traffic Association - see | | |
| | | nmfta.org) | | |
| | | Used by the Transportation Industry during the | | |
| | | movement of Goods. | | |
| | | Specific to North America (Canada, USA, Mexico) | | |
| | | The Standard Point Location Code (SPLC) is | | |
| | | designed to provide each point originating freight | | |
| | | and each point receiving freight in North America | | |
| | | with a unique code number so constructed as to | | |
| | | identify the point with its geographic location, | | |
| | | using two digits to identify State, County and City | | |
| | | and three digits to identify Sub-Code. | | |
| | | Code Structure SPLC is based a system of nesting | | |
| | | recognized political entitles and numbering them in | | |
| | | a standard geographic pattern. The nesting system | | |
| | | is State-County-City-Sub-Code. Different | | |
| | | nomenclatures for areas equivalent to these four | | |
| | | groups are substituted as they occur. | | |
| | | Commonwealth, Province and Territory are | | |
| | | synonymous with State while Parish, Municipio | | |
| | | and Census District or Census Divisions are | | |
| | | synonymous with County. Cities, Boroughs, | | |
| | | Municipalities, Towns, Villages, named | | |
| | | communities and rural areas, constitute the Cities | | |
| | | and Sub-Codes. A point means a particular city, | | |
| | | town, village, community, railroad station or other | | |
| | | named area, which is treated as a unit for | | |
| | | transportation purposes. Each point is identified by | | |
| | | a nine-digit number. | | |
| | | Note: Since this is an “Intelligent Code” with built- | | |
| | | in meaning, care should be taken that it doesn't | | |
| | | conflict with or contradict the Location Address | | |
| | | information. | | |
| | Time Zone Cd | The unique code for a time zone. | No | Yes |
| LOCATION ADDRESS | Address Id | A number used to uniquely identify an ADDRESS. | Yes | Yes |
| | Address Usage Cd | A code used to uniquely identify the ADDRESS | Yes | Yes |
| | | USAGE. | | |
| | Default Ind | In the case of multiple ADDRESSes for the same | No | No |
| | | usage, indicates the default one to use. | | |
| | | Example: “Yes” this is the default address; “No” | | |
| | | this is not the default address. | | |
| | Location Id | Uniquely identifies a LOCATION. | Yes | Yes |
| LOCATION BUSINESS DAY | Business Day End Dttm | Defines the End of a Business Day. | No | No |
| | Business Day Start Dttm | Defines the Start of a Business Day. | No | No |
| | Business Dt | A unique date that is recognized by an | Yes | Yes |
| | | organization. | | |
| | | The Date that revenue is booked against or | | |
| | | recognized. | | |
| | | Example: The business is open until lam, and all | | |
| | | revenue received between midnight and lam is | | |
| | | booked under the previous calendar day. | | |
| | Location Id | Uniquely identifies a LOCATION. | Yes | Yes |
| LOCATION BUSINESS HOURS | Day Of Week Num | Uniquely identifies the day of the week (1-7) | Yes | Yes |
| | Location Close Tm | Closed for Business time. | No | No |
| | | Note: This may be the following calendar date, | | |
| | | example: Open at 6am, close at 1 am (next day). | | |
| | Location Id | Uniquely identifies a LOCATION. | Yes | Yes |
| | Location Open Tm | Open for Business time. | No | No |
| LOCATION COST | Actual Cost Amt | The actual amount for a specific COST, for a | No | No |
| | | specific time period, at a specific LOCATION. | | |
| | Cost Cd | Uniquely identifies a COST. | Yes | Yes |
| | Location Id | Uniquely identifies a LOCATION. | Yes | Yes |
| | Period End Dt | The date on which the LOCATION COSTS end. | No | No |
| | Period Start Dt | The date on which the LOCATION COSTs begin. | Yes | No |
| | Plan Cost Amt | The planned amount for a specific COST, for a | No | No |
| | | specific time period, at a specific LOCATION. | | |
| LOCATION ITEM PRICE | Item Id | Unique Identifier for an Item. | Yes | Yes |
| | Pricing Id | Identifies a specific price for an Item. | Yes | Yes |
| | | Note: You typically have multiple Pricing Ids (and | | |
| | | prices) for the same Item. This can be due to: | | |
| | | date (price change over time) | | |
| | | condition set (different price by channel, | | |
| | | region, etc.) | | |
| | | volume scale (lower price based on volume | | |
| | | purchase) | | |
| | | etc. | | |
| | Selling Location Id | Uniquely identifies a LOCATION. | Yes | Yes |
| | | The selling location to which the pricing applies. | | |
| LOCATION TRAFFIC | Entry Cnt | The number of entries counted in a time period. | No | No |
| | Exit Cnt | The number of exits counted in a time period. | No | No |
| | Location Id | Uniquely identifies a LOCATION. | Yes | Yes |
| | Period End Dt | The end of the Traffic Counting Period. | No | No |
| | Period Start Dt | The start of the Traffic Counting Period. | Yes | No |
| LOCATION TRAIT | Location Trait Cd | Uniquely identifies a TRAIT. | Yes | No |
| | Location Trait Desc | Narrative text describing a TRAIT. | No | No |
| LOCATION TRAIT VALUE | Location Id | Uniquely identifies a LOCATION. | Yes | Yes |
| | Location Trait Cd | Uniquely identifies a TRAIT. | Yes | Yes |
| | Location Trait Val | The actual value enumerating a LOCATION | No | No |
| | | TRAIT. | | |
| LOCATION TYPE | Location Type Cd | Uniquely identifies a LOCATION TYPE. | Yes | No |
| | Location Type Desc | Narrative text describing a LOCATION. | No | No |
| LOCATION XREF | Destination Loc Id | Unique identifier for a LOCATION. | Yes | Yes |
| | | The target location (to). | | |
| | Distance Meas | The distance between the two locations. | No | No |
| | | Note: This should be expressed in the measure that | | |
| | | makes most sense to the enterprise. (actual vs. | | |
| | | ground vs. air distances) | | |
| | Nominal Lead Tm | The nominal time it takes to move goods between | No | No |
| | | the two locations. | | |
| | | If need be this can be extended to differentiate by | | |
| | | Transpon Mode (air, rail, ground) | | |
| | | Note: For a more extensive treatment of this topic, | | |
| | | see the Shipping Plan Subject Area. | | |
| | Origin Loc Id | Unique identifier for a LOCATION. | Yes | Yes |
| | | The source location (from). | | |
| LODGING CHANGE EVENT | Lodging Change Issued Ind | An indicator specifying whether the change request | No | No |
| | | was honored. If this is set to “Y”, then the Property | | |
| | | information in this entity refers to newly assigned | | |
| | | property unit. | | |
| | Lodging Event Num | A unique number assigned to a LODGING | Yes | Yes |
| | | EVENT entity. | | |
| | Property Id | Uniquely identifies a LOCATION. | No | Yes |
| | | A sub-type of LOCATION used to provide | | |
| | | temporary accommodations to customers, business | | |
| | | facilities (conferences, workshops), etc. | | |
| | Property Unit Id | Uniquely defining a distinct and finite amount of | No | Yes |
| | | space that can be rented out to PARTYs such as | | |
| | | Guest Rooms, Conference Rooms, Lawns, etc. | | |
| | | within a lodging property. | | |
| LODGING CHECK IN EVENT | Adult Cnt | The number of Adults checking into the Property. | No | No |
| | Child Cnt | The number of Children checking into the | No | No |
| | | Property. | | |
| | | Note: The age limit defining “child” may vary by | | |
| | | enterprise and or travel product. | | |
| | Complimentary Upgrade Ind | Indicates that the PARTY received a no-cost | No | No |
| | | upgrade at check-in | | |
| | Lodging Event Num | A unique number assigned to a LODGING | Yes | Yes |
| | | EVENT entity. | | |
| | Property Id | Uniquely identifies a LOCATION. | No | Yes |
| | | A sub-type of LOCATION used to provide | | |
| | | temporary accommodations to customers, business | | |
| | | facilities (conferences, workshops), etc. | | |
| | Property Unit Id | Uniquely defining a distinct and finite amount of | No | Yes |
| | | space that can be rented out to PARTYs such as | | |
| | | Guest Rooms, Conference Rooms, Lawns, etc. | | |
| | | within a lodging property. | | |
| | Upsell Charge Amt | The extra amount of money charged to the PARTY | No | No |
| | | for the upsell. | | |
| | Upsell Ind | Indicates that the PARTY was sold a higher class | No | No |
| | | PRODUCT at check-in | | |
| LODGING CHECK OUT EVENT | Check Out Method Cd | Classification codes that defines the type of | No | Yes |
| | | LODGING CHECK OUT EVENT | | |
| | Early Check Out Ind | Indicates if the PARTY checked out earlier than | No | No |
| | | planned | | |
| | Early Check Out Penalty Amt | The amount, if any, charged to the PARTY for | No | No |
| | | checking out earlier than planned. | | |
| | Lodging Event Num | A unique number assigned to a LODGING | Yes | Yes |
| | | EVENT entity. | | |
| LODGING CLASS | Owner Org Id | The unique identifier for an organization. | Yes | Yes |
| | Property Id | Uniquely identifies a LOCATION. | Yes | Yes |
| | | A sub-type of LOCATION used to provide | | |
| | | temporary accommodations to customers, business | | |
| | | facilities (conferences, workshops), etc. | | |
| | Property Unit Type Cd | Provides codes for property units such as | Yes | Yes |
| | | KD—king double room | | |
| | | JE—junior executive room | | |
| | | BR—ballroom | | |
| | Property Wing Cd | A code used to identify various sections or parts of | Yes | Yes |
| | | a property. For example, East Wing, Emerald | | |
| | | Tower, etc | | |
| | Unit Cnt | The number of Units available in this Lodging | No | No |
| | | Class. | | |
| LODGING EVENT | Folio Account Id | Uniquely identifies an ACCOUNT. | No | Yes |
| | | Assigns the Folio Account that will be used to | | |
| | | accumulate all hospitality charges. | | |
| | Lodging Event Num | A unique number assigned to a LODGING | Yes | Yes |
| | | EVENT entity. | | |
| | Lodging Event Type Cd | A code specifying the type of LODGING EVENT | No | Yes |
| | Reservation Seq Num | This attribute identifies a specific RESERVATION | No | Yes |
| | | ITEM. | | |
| | Reservation Transaction Id | A unique identifier for this TRAVEL | No | Yes |
| | | TRANSACTION. | | |
| | Visit Id | Unique identifier for the VISIT. | No | Yes |
| | | Link to the related Visit. | | |
| LODGING EVENT TYPE | Lodging Event Type Cd | A code specifying the type of LODGING EVENT | Yes | No |
| | Lodging Event Type Desc | Description of the type of LODGING EVENT | No | No |
| LODGING ORGANIZATION | Lodging Org Id | The unique identifier for an external organization. | Yes | Yes |
| | | Identifies the Organization that provides a Product. | | |
| LODGING PRODUCT | Lodging Prod Id | Unique Identifier for an Item. | Yes | Yes |
| | | A Hospitality-related offer available for sale to a | | |
| | | PARTY(s). | | |
| | Owner Org Id | The unique identifier for an organization. | No | Yes |
| | Property Id | Uniquely identifies a LOCATION. | No | Yes |
| | | A sub-type of LOCATION used to provide | | |
| | | temporary accommodations to customers, business | | |
| | | facilities (conferences, workshops), etc. | | |
| | Property Unit Type Cd | Provides codes for property units such as | No | Yes |
| | | KD—king double room | | |
| | | JE—junior executive room | | |
| | | BR—ballroom | | |
| | Property Wing Cd | A code used to identify various sections or parts of | No | Yes |
| | | a property. For example, East Wing, Emerald | | |
| | | Tower, etc | | |
| LODGING PROPERTY | Property Id | Uniquely identifies a LOCATION. | Yes | Yes |
| | | A sub-type of LOCATION used to provide | | |
| | | temporary accommodations to customers, business | | |
| | | facilities (conferences, workshops), etc. | | |
| LODGING PURCHASE ITEM | Lodging Dt | The Lodging Date. | No | No |
| | | For a room that is occupied overnight (thus | | |
| | | spanning two calendar days), this will typically be | | |
| | | the first of the two dates. | | |
| | Occupancy Cnt | The number of people occupying the room. | No | No |
| | Published Rate Ind DD | Indicates if the actual published room rate is being | No | No |
| | | charged. This is typically derivable by looking at | | |
| | | the actual Room Rate (in the Charges entity), and | | |
| | | comparing it to the Published Room Rate. | | |
| | Purchase Seq Num | An identifier for a specific PURCHASE ITEM | Yes | Yes |
| | | entity. | | |
| | Purchase Tran Id | A unique identifier for this TRAVEL | Yes | Yes |
| | | TRANSACTION. | | |
| LODGING RESERVATION | Confirmation Num | A number provided to the PARTY as a means for | No | No |
| | | confirming/verifying the LODGING | | |
| | | RESERVATION | | |
| | Number of Nights Cnt | The number of nights a PARTY is planning to stay | No | No |
| | | at the LODGING PROPERTY | | |
| | Owner Org Id | The unique identifier for an organization. | No | Yes |
| | Planned Arrival Dt | Reservation planned arrival date | No | No |
| | Property Id | Uniquely identifies a LOCATION. | No | Yes |
| | | A sub-type of LOCATION used to provide | | |
| | | temporary accommodations to customers, business | | |
| | | facilities (conferences, workshops), etc. | | |
| | Property Unit Type Cd | Provides codes for property units such as: | No | Yes |
| | | KD—king double room | | |
| | | JE—junior executive room | | |
| | | BR—ballroom | | |
| | Property Wing Cd | A code used to identify various sections or parts of | No | Yes |
| | | a property. For example, East Wing, Emerald | | |
| | | Tower, etc | | |
| | Reservation Seq Num | This attribute identifies a specific RESERVATION | Yes | Yes |
| | | ITEM. | | |
| | Reservation Transaction Id | A unique identifier for this TRAVEL | Yes | Yes |
| | | TRANSACTION. | | |
| LONG TERM DEBT ACCOUNT | GL Main Account Num | The unique Chart of Account code for the GL | Yes | Yes |
| | | MAIN ACCOUNT. | | |
| LOOSE FREIGHT ESTIMATE | Est Volume Meas | Estimate of the Volume (cubic) of loose freight for | No | No |
| | | a planned Shipment. | | |
| | | This may be a global number, or allocated at a | | |
| | | Piece level (if known). | | |
| | Est Weight Meas | Estimate of the Weight of loose freight for a | No | No |
| | | planned Shipment. | | |
| | | This may be a global number, or allocated at a | | |
| | | Piece level (if known). | | |
| | Estimate Dttm | The effective date and time of the estimate. | Yes | Yes |
| | Piece Num | Uniquely identifies a PIECE contained in a | No | Yes |
| | | SHIPMENT. | | |
| | | This can often be thought of as a “Tracking | | |
| | | Number” | | |
| | | This is optional for estimates, but if provided will | | |
| | | enable linking to the actual Piece when eventually | | |
| | | presented for shipment. | | |
| | Shipment Num | Uniquely identifies a SHIPMENT. | Yes | Yes |
| | | Identifies the Shipment for which space is being | | |
| | | estimated. At this point in time it is a provisional | | |
| | | Shipment Number. | | |
| LOYALTY ACCOUNT | Loyalty Account Id | Uniquely identifies an ACCOUNT. | Yes | Yes |
| | Loyalty Level Cd | A unique number assigned to a specific award level | No | Yes |
| | | used to promote and encourage product usage | | |
| | | (utilization). | | |
| | Loyalty Program Id | Uniquely identifies a Loyalty Program. | No | Yes |
| LOYALTY ACCOUNT | Balance Effective Dt | The calendar day that the change in an Account | Yes | No |
| BALANCE HIST | | Balance (a transaction) occurs. | | |
| | Lifetime Expired Qty | The number of units expired from a LOYALTY | No | No |
| | | ACCOUNT | | |
| | Lifetime Purged Qty | The number of units purged from a LOYALTY | No | No |
| | | ACCOUNT | | |
| | Lifetime Redeem Qty DD | The number of units redeemed from a LOYALTY | No | No |
| | | ACCOUNT. | | |
| | | Note: this value may be derived from ACCOUNT | | |
| | | REDEMPTION provided all historic redemption | | |
| | | events are maintained. | | |
| | Lifetime Voided Qty | The number of units voided from a LOYALTY | No | No |
| | | ACCOUNT | | |
| | Loyalty Account Id | Uniquely identifies an ACCOUNT. | Yes | Yes |
| | Maint Cur Status Qty DD | The total number of miles or kilometers or points | No | No |
| | | needed to maintain the current account level status. | | |
| | Non Qualifying Current Bal Qty | The non-qualifying new current balance of points | No | No |
| | | the customer has available after this update of their | | |
| | | award program is applied. | | |
| | Non Qualifying Life Accrue Qty | Keeps track of the balance of the lifetime non- | No | No |
| | | qualifying points earned by a customer. | | |
| | Non Qualifying YTD Balance Qty | The balance of non-qualifying base points or | No | No |
| | | rewards at the point in time that the transaction is | | |
| | | posted. | | |
| | Previous Balance Qty | The balance of points the PARTY had available | No | No |
| | | prior to this update of their award program. | | |
| | Qualifying Current Balance Qty | The qualifying new current balance of points the | No | No |
| | | customer has available after this update of their | | |
| | | award program is applied. | | |
| | Qualifying Life Accrue Qty | Keeps track of the balance of the lifetime | No | No |
| | | qualifying points earned by a customer. | | |
| | Qualifying YTD Balance Qty | The balance of qualifying base points or rewards at | No | No |
| | | the point in time that the transaction is posted. | | |
| | | These points are taken in consideration by the | | |
| | | AIRLINE, HOTEL, etc to attain the next upper | | |
| | | account level. | | |
| LOYALTY ACCOUNT EARNING | Base Earn Qty | Number of base account units that count towards | No | No |
| | | award earnings. | | |
| | Bonus Earn Qty | Number of bonus account units that count towards | No | No |
| | | award earnings, and awarded in addition to Base | | |
| | | units. Usually awarded as a multiplier for advanced | | |
| | | loyalty level customers. | | |
| | Event Dttm | The date and time that a loyalty event occurred | Yes | Yes |
| | Loyalty Account Id | Uniquely identifies an ACCOUNT. | Yes | Yes |
| | Promo Offer Id | The unique identifier for an instance of the OFFER | No | Yes |
| | | entity. | | |
| | | Identifies the promotional OFFER that was | | |
| | | responsible for the ACCOUNT EARNINGs. | | |
| | | Example: Customer received 1,000 promotional | | |
| | | bonus points for flying a newly promoted route. | | |
| | Qualifying Qty | Based upon the rules of the loyalty program the | No | No |
| | | account earnings are either qualifying or non | | |
| | | qualifying for a specific event or program. | | |
| | | Number of account units that count towards | | |
| | | qualifying events such as reaching the next loyalty | | |
| | | level or special promotional events. | | |
| LOYALTY ACCOUNT EVENT | Event Dttm | The date and time that a loyalty event occurred | Yes | No |
| | Loyalty Account Id | Uniquely identifies an ACCOUNT. | Yes | Yes |
| LOYALTY ACCOUNT | Account Redeem Qty DD | The total amount of points redeemed since the last | No | No |
| REDEMPTION | | update of the customers award program. This is a | | |
| | | DERIVED DATA (DD) element. | | |
| | Event Dttm | The date and time that a loyalty event occurred | Yes | Yes |
| | Loyalty Account Id | Uniquely identifies an ACCOUNT. | Yes | Yes |
| | Payment Tran Id | This attribute is optional. | No | Yes |
| | | This attribute is used if loyalty points are redeemed | | |
| | | directly as part of a payment. | | |
| | | This will not be used if the points are redeemed for | | |
| | | a Loyalty Award - the relationship to Payment will | | |
| | | then be made via the Loyalty Award and | | |
| | | Certificate entities to the actual Payment where the | | |
| | | award is applied. | | |
| | Redeem Qty | The actual number of points required for this | No | No |
| | | specific instance of an ACCOUNT REDEMPTION | | |
| | | activity. | | |
| LOYALTY CONVERSION | Conversion Rate | The multiplication factor to apply to produce the | No | No |
| | | conversion. | | |
| | From Loyalty Program Id | Uniquely identifies a Loyalty Program. | Yes | Yes |
| | To Loyalty Program Id | Uniquely identifies a Loyalty Program. | Yes | Yes |
| LOYALTY LEVEL | Level Qualifying Desc | A brief explanation qualification required to join | No | No |
| | | the reward level. Example: “25,000 paid flight | | |
| | | miles” | | |
| | Level Qualifying Qty | The earned quantity of units to qualify for this | No | No |
| | | level. | | |
| | | Note: Sometimes qualifying is more complex than | | |
| | | a simple ‘qty’ of reward units, in which case the | | |
| | | Loyalty Qualifying Desc attribute can be used. | | |
| | Loyalty Level Cd | Uniquely identifies a LOYALTY LEVEL. | Yes | No |
| | Loyalty Level Name | Short text reference or label for a loyalty level. | No | No |
| | Loyalty Program Id | Uniquely identifies a Loyalty Program. | Yes | Yes |
| LOYALTY PROGRAM | Loyalty Program Desc | A textual description of the Award Program, how it | No | No |
| | | works, what are the award potentials, limits and | | |
| | | limitations, etc. | | |
| | Loyalty Program End Dt | The last calendar day that an Award Program ends | No | No |
| | | and is no longer effective for customer | | |
| | | participation. | | |
| | Loyalty Program Id | Uniquely identifies a Loyalty Program. | Yes | No |
| | Loyalty Program Name | Short text reference or label for a loyalty program. | No | No |
| | Loyalty Program Start Dt | The first calendar day that an Award Program starts | No | No |
| | | and becomes effective for customer participation. | | |
| | Loyalty Program UOM Cd | Uniquely identifies a unit of measure. | No | Yes |
| | | The units that earnings in the program are | | |
| | | expressed in. | | |
| | | Example: Points, currency, points, visits, etc. | | |
| | Program Owner Party Id | The unique identifier for an organization. | No | Yes |
| | | The organization that owns and operates the | | |
| | | LOYALTY PROGRAM. | | |
| | Program Unit Value Amt | The monetary worth of a single loyalty unit. | No | No |
| | | This value is used to convert external (partner) | | |
| | | program award units to a monetary value to | | |
| | | determine the expense or revenue when award units | | |
| | | are exchanged or transferred between different | | |
| | | programs. | | |
| | | It can also be used to determine the book value of | | |
| | | the enterprise's outstanding loyalty program | | |
| | | liability. | | |
| LRU (A/C) EVENT | LRU Maint Event Id | Uniquely identifies a Maintenance Event. | Yes | Yes |
| LRU INSTALL (ILS) | LRU Install Event Id | Uniquely identifies a Maintenance Event. | Yes | Yes |
| | LRU Remove Event Id RTI | Uniquely identifies a Maintenance Event. | No | Yes |
| LRU REMOVE (RLS) | Hours In Service Tm DD | Upon removal, the elapsed number of hours the | No | No |
| | | Unit had been in service. | | |
| | LRU Remove Event Id RTI | Uniquely identifies a Maintenance Event. | Yes | Yes |
| | Number of Cycles Qty DD | Upon removal, the total number of Cycles | No | No |
| | | (landings, etc.) the Unit had experienced while in | | |
| | | service. | | |
| | Remove Reason Cd RFR | S2000 code that specifies reason for removal. | No | No |
| | | Example: | | |
| | | Leakage | | |
| | | Refurbish | | |
| | | Pilot Complaint | | |
| | | etc. | | |
| | | Note: This code look-up table must be supplied by | | |
| | | the airline in conjunction with Spec 2000 | | |
| | | definitions. | | |
| | Remove Type Cd TTY | S2000 code that describes the LRU Removal Type | No | No |
| | | Examples: | | |
| | | Scheduled | | |
| | | Unscheduled | | |
| | | Robbery/Cannibalization | | |
| | | etc. | | |
| | | Note: This code look-up table must be supplied by | | |
| | | the airline in conjunction with Spec 2000 | | |
| | | definitions. | | |
| LRU REPAIR | LRU Repair Event Id | Uniquely identifies a Maintenance Event. | Yes | Yes |
| MAILING ADDRESS | Address Line 1 Txt | The first line of text containing all or part of a | No | No |
| | | physical site address excluding city name, state, | | |
| | | and postal (zip) code or country. | | |
| | | This line typically contains additional recipient | | |
| | | information such as “in care of” (c/o), department | | |
| | | names or “Attention:” names. | | |
| | Address Line 2 Txt | The second line of text containing all or part of a | No | No |
| | | physical site address excluding city name, state, | | |
| | | and postal (zip) code or country. | | |
| | | This line typically contains street numbers and | | |
| | | street names. (Street, Avenue, Road, Boulevard, | | |
| | | Parkway, Highway, etc) | | |
| | Address Line 3 Txt | The third line of text containing all or part of a | No | No |
| | | physical site address excluding city name, state, | | |
| | | and postal (zip) code or country. | | |
| | | This line typically contains additional location | | |
| | | numbers such as apartment numbers or business | | |
| | | suite numbers. | | |
| | Carrier Route Txt | A text string representing Mail Carrier Route | No | No |
| | | Numbers or identifiers for aiding in the distribution | | |
| | | of mail. Used primarily in rural regions. | | |
| | Census Block Cd | The unique code for an instance of the CENSUS | No | Yes |
| | | BLOCK entity. | | |
| | City Cd | The unique code for an instance of the CITY entity. | No | Yes |
| | Country Cd | The unique code for an instance of the COUNTRY | No | Yes |
| | | entity. | | |
| | Dwelling Type Cd | A code that uniquely identifies the DWELLING | No | Yes |
| | | TYPE. | | |
| | Latitude Meas | The navigational coordinate represented by the | No | No |
| | | address and recorded as an angular distance | | |
| | | (degrees) north or south of the earth's equator. | | |
| | | Typically generated by GPS (Global Positioning | | |
| | | System) applications, and enables the usage of | | |
| | | Geography Information System applications. | | |
| | Longitude Meas | The navigational coordinate measured as a | No | No |
| | | meridian that passes through each of the earth's | | |
| | | poles (N/S) and the physical site represented by the | | |
| | | address. It is recorded as an angular distance | | |
| | | (degrees), as measured from the zero or prime | | |
| | | meridian that passes from the north and south poles | | |
| | | through Greenwich, England. | | |
| | | Typically generated by GPS (Global Positioning | | |
| | | System) applications, and enables the usage of | | |
| | | Geography Information System applications. | | |
| | Mailing Address Id | A number used to uniquely identify a MAILING | Yes | Yes |
| | | ADDRESS. | | |
| | Postal Cd | A unique code for an instance of the POSTAL | No | Yes |
| | | CODE entity. | | |
| MAINT COST | Actual Cost Amt MMT | The Actual cost for a specific cost type for a | No | No |
| | | specific Maintenance Event. | | |
| | Cost Cd | Uniquely identifies a COST. | Yes | Yes |
| | Estimated Cost Amt | The Estimated cost for a specific cost type for a | No | No |
| | | specific Maintenance Event. | | |
| | Maint Event Id MTN | Uniquely identifies a Maintenance Event. | Yes | Yes |
| MAINT EVENT | Complete Dttm RED DOI TED PRV | The date and time a Maintenance Event is | No | No |
| | | completed | | |
| | Equip Out Of Service Dttm | The Date and Time the Equipment was removed | No | No |
| | | from active Service to perform the Maintenance. | | |
| | Equip Return To Svc Dttm | The Date and Time the Equipment was returned to | No | No |
| | | active Service after completion of the Maintenance. | | |
| | Inspect Party Id UPI | The unique identifier for an individual. | No | Yes |
| | | The Individual who inspects and signs off on | | |
| | | completed maintenance work. | | |
| | Job Card Id | Unique identifier for a job card. | No | No |
| | | A job card represents one maintenance task to be | | |
| | | done by maintenance personnel. | | |
| | | Allows for the Maint Event Id to be related to the | | |
| | | manual (or existing legacy) job card system used | | |
| | | by the airline. | | |
| | Maint Event Id MTN | Uniquely identifies a Maintenance Event. | Yes | No |
| | Maint Loc Id | Uniquely identifies a LOCATION. | No | Yes |
| | | The location where the maintenance is performed. | | |
| | Maint Party Id | The unique identifier for any individual or group of | No | Yes |
| | | individuals that is of interest to the enterprise. | | |
| | | The Party that performs the maintenance. | | |
| | Maint Task Id | Uniquely identifies a MRO Task. | No | Yes |
| | MRO Spec Id OII | Uniquely identifies a MRO Specification. | No | Yes |
| | Parent Maint Event Id | Uniquely identifies a Maintenance Event. | No | Yes |
| | | A specific Maint Event that groups other Maint | | |
| | | Events. Typically used when a single, higher-level | | |
| | | Maint Event consists of a series of (smaller) Maint | | |
| | | Events. | | |
| | Start Dttm TSD | The start date and time for a Maintenance Event. | No | No |
| | Work Order Num WON | Used to specify Work Order if work is done | No | No |
| | | externally. | | |
| | | This Work Order Number can then be used to link | | |
| | | the legacy System to this Maintenance Event. | | |
| MAINT ITEM | GE Location Cd GEL | S2000 code that specifies the Geo and/or Electrical | No | Yes |
| | | Location of the Parts on a Assembly or Circuit | | |
| | | Card. | | |
| | Item Qty | The number of Items involved in the Maintenance | No | No |
| | | Event. | | |
| | | Note: This attribute will always be one if a | | |
| | | serialized Item is referenced. | | |
| | Line Num | Uniquely identifies an Item (or Items, if non- | Yes | No |
| | | serialized) involved in a Maintenance Event. | | |
| | Maint Event Id MTN | Uniquely identifies a Maintenance Event. | Yes | Yes |
| | MRO Item Id ASN | Unique Identifier for an Item. | No | Yes |
| | | Items that are used or consumed during | | |
| | | Maintenance Repair Operations. | | |
| | Univ Serial Num USN | The unique serial number for ITEMs that are | No | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| | | Note: This attribute will be null if a non serialized | | |
| | | Item is referenced. | | |
| MAINT LABOR | Associate Party Id | An individual who is employed by the enterprise. | Yes | Yes |
| | | The person performing the labor. | | |
| | Certification Cd | Uniquely identifies an Equipment Certification | No | Yes |
| | Maint Event Id MTN | Uniquely identifies a Maintenance Event. | Yes | Yes |
| | Overtime Ind | Indicates if the labor is considered overtime. | No | No |
| | Productive Hours Tm | Actual hours worked by the Associate on this | No | No |
| | | maintenance task. | | |
| | | Example: Mechanic scheduled to work four hours | | |
| | | on a maintenance task but had to wait 30 minutes | | |
| | | for a required tool and took one hour for lunch.. | | |
| | | Mechanic actually worked 2.5 hours on the | | |
| | | assigned task. | | |
| | Start Dttm | The date and time Labor started. | Yes | No |
| | Stop Dttm | The date and time Labor ended. | No | No |
| MAINT PLAN DOC(MPD) | Maint Plan Doc Id | Uniquely identifies a Maintenance Plan Document. | Yes | No |
| | Source Party Id | The unique identifier for any individual or group of | No | Yes |
| | | individuals that is of interest to the enterprise. | | |
| | | The Creator/Issuer of the Maintenance Plan. | | |
| MAINT SCHED | Equip Event Id ERI | Uniquely identifies a Equipment Event. | No | Yes |
| | | This provides a link back to an Equipment Event. | | |
| | | This is used in cases where an Equipment Event | | |
| | | prompts deferred maintenance to be scheduled. | | |
| | | A Common instance is where the “master | | |
| | | minimum equipment fly list” (MMEL) specifies | | |
| | | that Equipment can be dispatched provided | | |
| | | maintenance is performed within a set period of | | |
| | | time. | | |
| | Equip Id OIN | Uniquely identifies an Equipment Instance. | No | Yes |
| | Maint Sched Id HRI | Uniquely identifies an Instance of Scheduled | Yes | No |
| | | Maintenance. | | |
| | MRO Spec Id OII | Uniquely identifies a MRO Specification. | No | Yes |
| | | The MRO Spec to be performed. | | |
| | Sched Complete Dttm | The Date and time the Maintenance is scheduled to | No | No |
| | | be completed. | | |
| | Sched Loc Id | Uniquely identifies a LOCATION. | No | Yes |
| | | The Location where the Maintenance work is to be | | |
| | | performed. | | |
| | Sched Start Dttm | The Date and time the Maintenance is scheduled to | No | No |
| | | commence. | | |
| | Sched Univ Serial Num | The unique serial number for ITEMs that are | No | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| MAINT STATUS | Maint Stat Cd | Uniquely identifies the Maint Status. | Yes | No |
| | Maint Status Desc | Narrative text describing the Maint Status Type. | No | No |
| MAINT STATUS HIST | Maint Event Id MTN | Uniquely identifies a Maintenance Event. | Yes | Yes |
| | Maint Stat Cd | Uniquely identifies the Maint Status. | Yes | Yes |
| | Maint Status Dttm | Date and Time the Maintenance Status is effective. | Yes | No |
| MANIFEST | Manifest Create Dttm | Date and time the Manifest was generated. | No | No |
| | Manifest Id | Uniquely identifies a Manifest. | Yes | No |
| MANUFACTURER | Manuf Party Id | The unique identifier for a Business. | Yes | Yes |
| | | Party that manufactures goods, equipment, etc. | | |
| MARKET GROUP | Market Group Cd | Uniquely identifies a MARKET GROUP. | Yes | No |
| | Market Group Desc | Narrative text describing a market group. | No | No |
| | Source Org Party Id | The unique identifier for an organization. | No | Yes |
| | | The Party providing the information. | | |
| | | Example: Nielsen, IRI, etc. | | |
| MARKET GROUP | Demog Cd | The unique code for an instance of the | Yes | Yes |
| DEMOGRAPHIC | | DEMOGRAPHIC entity. | | |
| | Demog Value Cd | A code referencing a specific DEMOGRAPHIC | No | Yes |
| | | VALUE for a given demographic code. | | |
| | Market Group Cd | Uniquely identifies a MARKET GROUP. | Yes | Yes |
| MARKET GROUP MEMBER | Market Group Cd | Uniquely identifies a MARKET GROUP. | Yes | Yes |
| | Member Org Party Id | The unique identifier for an organization. | Yes | Yes |
| MARKET SEGMENT | Model Id | The unique identifier for an instance of the | No | Yes |
| | | ANALYTICAL MODEL entity. | | |
| | Model Run Id | An identifier (or sequential number) that uniquely | No | Yes |
| | | describes this particular run of the ANALYTICAL | | |
| | | MODEL. | | |
| | Segment Desc | Text that describes an instance of the MARKET | No | No |
| | | SEGMENT entity. | | |
| | Segment Dttm | The date and time on which a SEGMENT was | No | No |
| | | generated. | | |
| | Segment Group Id | The unique identifier for an instance of the | No | Yes |
| | | MARKET SEGMENT GROUP entity. | | |
| | Segment Id | The unique identifier for an instance of the | Yes | No |
| | | MARKET SEGMENT entity. | | |
| MARKET SEGMENT | Demog Cd | The unique code for an instance of the | Yes | Yes |
| DEMOGRAPHIC | | DEMOGRAPHIC entity. | | |
| | Demog Value Cd | A code referencing a specific DEMOGRAPHIC | Yes | Yes |
| | | VALUE for a given demographic code. | | |
| | Segment Id | The unique identifier for an instance of the | Yes | Yes |
| | | MARKET SEGMENT entity. | | |
| MARKET SEGMENT GROUP | Segment Group Desc | Textual description for the SEGMENT GROUP. | No | No |
| | | Example: “Top Spenders by decile” | | |
| | Segment Group Id | The unique identifier for an instance of the | Yes | No |
| | | MARKET SEGMENT GROUP entity. | | |
| MARKETING EXPENSE | GL Main Account Num | The unique Chart of Account code for the GL | Yes | Yes |
| ACCOUNT | | MAIN ACCOUNT. | | |
| MATERIAL SUPPLY AND | GL Sub Account Num | The unique Chart of Account code for the GL SUB | Yes | Yes |
| EQUIP ACCT | | ACCOUNT. | | |
| MENU | Menu Cd | Uniquely identifies the Menu Type. | No | Yes |
| | Menu Id | Uniquely identifies an ITEM GROUP. | Yes | Yes |
| | | The item group to which the object may refer. This | | |
| | | attribute is considered to be mutually exclusive | | |
| | | with Item Id. | | |
| | | Uniquely identifies a Menu. | | |
| MENU ITEM | Menu Item Id | Unique Identifier for an Item. | Yes | Yes |
| | | A Hospitality-related offer available for sale to a | | |
| | | PARTY(s). | | |
| MENU ITEM INGREDIENT | Ingredient Item Id | Unique Identifier for an Item. | Yes | Yes |
| | | One or more ingredients can be combined to create | | |
| | | a Hospitality-related offer (i.e. Menu item) | | |
| | | available for sale to a PARTY(s). | | |
| | Ingredient Qty | Indicate how much of the ingredient is used in the | No | No |
| | | menu item. | | |
| | | Note: the quantity will be expressed as a | | |
| | | fraction/factor of the base unit quantity and UOM | | |
| | | (unit of measure) as defined in the Ingredient Item's | | |
| | | related Item Trait definition. | | |
| | Menu Item Id | Unique Identifier for an Item. | Yes | Yes |
| | | A Hospitality-related offer available for sale to a | | |
| | | PARTY(s). | | |
| MENU TYPE | Menu Cd | Uniquely identifies the Menu Type. | Yes | No |
| | Menu Desc | Textual Description for a Menu Type. | No | No |
| METROPOLITAN STATISTICAL | Msa Cd | The unique code for an instance of the | Yes | No |
| AREA | | METROPOLITAN STATISTICAL AREA entity. | | |
| | Msa Desc | Text that describes an instance of the | No | No |
| | | METROPOLITAN STATISTICAL AREA entity. | | |
| MISCELLANEOUS EXPENSE | GL Sub Account Num | The unique Chart of Account code for the GL SUB | Yes | Yes |
| ACCT | | ACCOUNT. | | |
| MM AUDIO OBJECT | MM Audio Object Duration Tm | The length of time for the audio object to run. | No | No |
| | | For example: 15 seconds. | | |
| | MM Audio Object Id | Unique identifier for a MM Audio Object | Yes | Yes |
| MM COMPONENT | MM Component Object Id | Unique identifier for a multimedia object. | Yes | Yes |
| | | A parent object that groups multiple child objects. | | |
| | MM Object Id | Unique identifier for a multimedia object. | Yes | Yes |
| MM IMAGE OBJECT | MM Image Object Id | Unique identifier for a MM Image Object. | Yes | Yes |
| | MM Image Resolution Meas | A measurement of the resolution of the MM Image | No | No |
| | | Object. | | |
| | | Examples: 600 dpi; 150 dpi | | |
| | MM Image Size Height Meas | A description of the MM Image Object height. | No | No |
| | | Examples: 235 pixels; 2 inches, etc. | | |
| | MM Image Size UOM Cd | Uniquely identifies a unit of measure. | No | Yes |
| | | The Unit of Measure of the image size. | | |
| | | Examples: pixels; cm, etc. | | |
| | MM Image Size Width Meas | A description of the MM Image Object width. | No | No |
| | | Examples: 540 pixels; 3.5 cm, etc. | | |
| MM TEXT OBJECT | MM Text Object Id | Unique identifier for a MM Text Object | Yes | Yes |
| | MM Text Object Message Txt | The actual text message of the text object. | No | No |
| MM VIDEO OBJECT | MM Video Object Duration Tm | The length of time the video object runs. For | No | No |
| | | example: 1 minute 34 seconds. | | |
| | MM Video Object Id | Unique identifier for a MM Video Object | Yes | Yes |
| MODEL ALGORITHM TYPE | Model Algorithm Type Cd | A code used to uniquely identify the type of | Yes | No |
| | | technique used for the model algorithm. | | |
| | Model Algorithm Type Desc | A textual description of the model algorithm type. | No | No |
| MODEL PURPOSE | Model Purpose Cd | A code used to uniquely identify the kinds of | Yes | No |
| | | analysis that can be done using the model. | | |
| | Model Purpose Desc | A textual description of the model purpose. | No | No |
| MODEL RUN | Model Id | The unique identifier for an instance of the | Yes | Yes |
| | | ANALYTICAL MODEL entity. | | |
| | Model Run Dttm | The date and time that this particular analytical | No | No |
| | | model was executed. | | |
| | Model Run Id | An identifier that uniquely describes the particular | Yes | No |
| | | run of the ANALYTICAL MODEL. | | |
| MODEL STATUS | Model Status Cd | A code used to uniquely identify the current status | Yes | No |
| | | of the model. | | |
| | Model Status Desc | A textual description of the model status. | No | No |
| MODEL TYPE | Model Type Cd | A code used to uniquely identify the type of model. | Yes | No |
| | Model Type Desc | A textual description of the model type. | No | No |
| | Model Type Name | The name assigned to a model type. | No | No |
| MRO EQUIPMENT SYSTEM | Equip System Cd ATA DTA ACS | Uniquely identifies a MRO Equipment System. | Yes | No |
| | Equip System Desc | Textual Description of a MRO Equipment System. | No | No |
| | Parent Equip System Cd ATA DTA | Uniquely identifies a MRO Equipment System. | No | Yes |
| | ACS | Identifies the next higher level system that the | | |
| | | current system is part of/contained in. | | |
| MRO FORECAST | Cost Per Event Forecast Amt | The Forecasted cost of Maintenance Events | No | No |
| | | involving the Equipment Series during the Time | | |
| | | Period. | | |
| | Equip Series Id ASE AEM | Uniquely identifies a particular series of | Yes | Yes |
| | | equipment. | | |
| | Lost Days Forecast Cnt | The Forecasted number of Out Of Service Days | No | No |
| | | caused by Maintenance Events involving the | | |
| | | Equipment Series during the Time Period. | | |
| | Maint Event Forecast Cnt | The Forecasted number of Maintenance Events | No | No |
| | | involving the Equipment Series during the Time | | |
| | | Period. | | |
| | Model Id | The unique identifier for an instance of the | Yes | Yes |
| | | ANALYTICAL MODEL entity. | | |
| | Model Run Id | An identifier that uniquely describes the particular | Yes | Yes |
| | | run of the ANALYTICAL MODEL. | | |
| | Period End Dt | The End Date of a specific time period. | Yes | No |
| | Period Start Dt | The Start Date of a specific time period. | No | No |
| MRO HANGAR | Location Id | Uniquely identifies a LOCATION. | Yes | Yes |
| MRO INVENTORY IN | Inv Tran Id | Uniquely identifies an inventory transaction. | Yes | Yes |
| | Maint Event Id MTN | Uniquely identifies a Maintenance Event. | No | Yes |
| MRO INVENTORY OUT | Inv Tran Id | Uniquely identifies an inventory transaction. | Yes | Yes |
| | Maint Event Id MTN | Uniquely identifies a Maintenance Event. | No | Yes |
| MRO ITEM | Consumable Ind | Indicates Items that are “used up” or consumed | No | No |
| | | during use. | | |
| | Expendable Ind | Indicates Items that are discarded when their useful | No | No |
| | | life is over, or when not performing to spec | | |
| | | anymore. | | |
| | Life Limited Cycles Cnt | The number of repaired/reconditioned cycles | No | No |
| | | allowed for this MRO Item before it must be | | |
| | | discarded. | | |
| | Life Limited Tm | The total time allowed for this MRO Item to | No | No |
| | | operate before it must be replaced. | | |
| | LRU Ind | Indicates if this Item can be replaced ‘on the Line’ | No | No |
| | | (in other words, without taking the Equipment out | | |
| | | of Service) | | |
| | Manuf Part Id MPN or PNR | The Item or Part Number assigned to this Item by | No | No |
| | | the Manufacturer. | | |
| | Manuf Party Id | The unique identifier for a Business. | No | Yes |
| | | Party that manufactures goods, equipment, etc. | | |
| | | The Company that manufactures this Item | | |
| | MRO Item Id ASN | Unique Identifier for an Item. | Yes | Yes |
| | | Items that are used or consumed during | | |
| | | Maintenance Repair Operations. | | |
| | Repairable Ind | Indicates if this Item can be repaired if it is not | No | No |
| | | performing to spec. (Some Items need to be | | |
| | | disposed of instead). | | |
| | Rotable Ind | Indicates if this Item can be repaired/reconditioned | No | No |
| | | and made available for re-use. | | |
| MRO LABOR SPEC | Certification Cd | Uniquely identifies an Equipment Certification | Yes | Yes |
| | Estimated Cost Amt | The estimated labor cost of this type to perform | No | No |
| | | this MRO Specification. | | |
| | Job Classification Cd EPT | Uniquely identifies a JOB CLASSIFICATION. | Yes | Yes |
| | MRO Spec Id OII | Uniquely identifies a MRO Specification. | Yes | Yes |
| | Plan Hours Tm | The Amount of Time Individuals with this | No | No |
| | | Qualification/Skill required to labor to perform | | |
| | | this MRO Specification. | | |
| | Plan Qty | The Number of Individuals with this Qualification/ | No | No |
| | | Skill required to perform this MRO Specification. | | |
| MRO SER ITEM TIME CYCLE | Effective Dttm | The date and time this MRO SER ITEM TIME | Yes | No |
| | | CYCLE was last updated. | | |
| | Line Num | Uniquely identifies an Item (or Items, if non- | No | Yes |
| | | serialized) involved in a Maintenance Event. | | |
| | | References the Maintenance Event that started the | | |
| | | Time/Cycle count (if applicable). | | |
| | Maint Event Id MTN | Uniquely identifies a Maintenance Event. | No | Yes |
| | | References the Maintenance Event that started the | | |
| | | Time/Cycle count (if applicable). | | |
| | Operating Cycle Cnt OPC | The total number of cycles this MRO SER ITEM | No | No |
| | | has been in service since this MRO SER ITEM | | |
| | | TIME CYCLE was last updated. | | |
| | Operating Day Cnt ODT | The total number of days this MRO SER ITEM has | No | No |
| | | been in service since this MRO SER ITEM TIME | | |
| | | CYCLE was last updated. | | |
| | Operating Tm OTT | The total elapsed time this MRO SER ITEM has | No | No |
| | | been in service since this MRO SER ITEM TIME | | |
| | | CYCLE was last updated. | | |
| | Time Cycle Cd TRF | Uniquely identifies an MRO TIME CYCLE. | Yes | Yes |
| | Univ Serial Num USN | The unique serial number for ITEMs that are | Yes | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| MRO SHOP | Location Id | Uniquely identifies a LOCATION. | Yes | Yes |
| | | An MRO shop and storage location. | | |
| MRO SPEC (MPD = MII) | Do By Dt | Specifies the Date by which a Maintenance Spec is | No | No |
| | | to be completed. | | |
| | | Typically used for urgent Safety/Airworthiness | | |
| | | directives. | | |
| | Elapsed Time Estimate Tm | Projected total elapsed time estimated to perform | No | No |
| | | the maintenance associated with this MRO SPEC | | |
| | | Maintenance Task. | | |
| | Equip Series Id ASE AEM | Uniquely identifies a particular series of | No | Yes |
| | | equipment. | | |
| | | The Equipment Series to be maintained. May be | | |
| | | specified in conjunction with a MRO Item. | | |
| | | May be null - see Entity Definition | | |
| | Frequency Cd STE MCV | Specifies the maintenance frequency associated | No | No |
| | | with this MRO SPEC Maintenance Task. | | |
| | | Example: 1 = daily, 2 = weekly, 3 = monthly, etc. | | |
| | Maint Plan Doc Id | Uniquely identifies a Maintenance Plan Document. | No | Yes |
| | Maint Task Id | Uniquely identifies a MRO Task. | No | Yes |
| | MRO Item Id ASN | Unique Identifier for an Item. | No | Yes |
| | | The MRO Item to be maintained. May be specified | | |
| | | in conjunction with an Equipment Series. | | |
| | | May be null - see Entity Definition | | |
| | MRO Spec Desc STL OCD | Textual description of a MRO Specification. | No | No |
| | MRO Spec Id OII | Uniquely identifies a MRO Specification. | Yes | No |
| | Sched Maint Spec Id | If this is an equivalent BUT NON SCHEDULED | No | Yes |
| | | maint spec, pointer to actual used MAINT SPEC | | |
| | | Example: | | |
| | | If the Airbus MRO Spec for Framostat replacement | | |
| | | has been replaced by an internal Airline | | |
| | | Engineering Spec, the Airbus Spec will point to the | | |
| | | Engineering Spec. | | |
| | Srce Party Id | The unique identifier for any individual or group of | No | Yes |
| | | individuals that is of interest to the enterprise. | | |
| | | The Creator/Issuer of the Maintenance Plan. | | |
| | | Note: This attribute will be null if the MRO Spec is | | |
| | | contained (as one of many) in a Maintenance Plan | | |
| | | Document. | | |
| | Srce Party Spec Desc TCD MTD OCD | The Textual Description used by the Source Party | No | No |
| | | to refer to this MRO Spec. | | |
| | Srce Party Spec Id SBN STN MRB | The Identifier used by the Source Party to refer to | No | No |
| | MII MTI | this MRO Spec. | | |
| MRO SPEC CONTENT | Child MRO Spec Id | Uniquely identified an MRO Specification. | Yes | Yes |
| | | The MRO Specification that is contained within the | | |
| | | Parent MRO Specification. | | |
| | Parent MRO Spec Id | Uniquely identified an MRO Specification. | Yes | Yes |
| | | The Parent MRO Specification that contains 1 or | | |
| | | more MRO Specifications. | | |
| | | Note: A Parent MRO Specification may contain | | |
| | | other Parent MRO Specifications. | | |
| MRO STORES | Location Id | Uniquely identifies a LOCATION. | Yes | Yes |
| MRO TASK | Maint Task Id | Uniquely identifies a MRO Task. | Yes | No |
| | Task Desc | The Textual Description of the MRO Task. | No | No |
| | Task Name | The name given to the MRO Task. | No | No |
| MRO TIME CYCLE | Time Cycle Cd TRF | Uniquely identifies an MRO TIME CYCLE. | Yes | No |
| | Time Cycle Desc | Textual Description of an MRO TIME CYCLE | No | No |
| MTBF (MANUF) | Line Num | Identifies a specific MTBF Claim for the Item. | Yes | No |
| | MRO Item Id ASN | Unique Identifier for an Item. | Yes | Yes |
| | | Items that are used or consumed during | | |
| | | Maintenance Repair Operations. | | |
| | MTBF Desc | A textual description of the MTBF Specification. | No | No |
| | MTBF Qty | Mean Time Between Failures (MTBF) | No | No |
| | | specification for an MRO Item specified by the | | |
| | | manufacturer. This can be defined in terms of | | |
| | | hours of operation, use cycles, etc. | | |
| | | The Claimed MTBF measure. | | |
| | | Example: 10,000 cycles, 1400 hours, etc. | | |
| | UOM Cd | Uniquely identifies a unit of measure. | No | Yes |
| MULTI ITEM | Equip System Cd ATA DTA ACS | Uniquely identifies a MRO Equipment System. | No | Yes |
| | Multi Item Id | Unique Identifier for an Item. | Yes | Yes |
| | | Identifies an Item which is comprised of other | | |
| | | Items. See MULTI ITEM CONTENT for the “bill | | |
| | | of materials” Items which are included. | | |
| | Multi Item Type Cd | Uniquely identifies a Multi Item Type. | No | Yes |
| MULTI ITEM CONTENT | Item Content Qty | The quantity of this Item contained in the Multi | No | No |
| | | Item. | | |
| | Item Id | Unique Identifier for an Item. | Yes | Yes |
| | | A component (child) Item of a Multi Item. | | |
| | Multi Item Id | Unique Identifier for an Item. | Yes | Yes |
| | | Identifies an Item which is comprised of other | | |
| | | Items. See MULTI ITEM CONTENT for the “bill | | |
| | | of materials” Items which are included. | | |
| MULTI ITEM TYPE | Multi Item Type Cd | Uniquely identifies a Multi Item Type. | Yes | No |
| | Multi Item Type Desc | Textual Description of a Multi Item Type. | No | No |
| MULTIMEDIA GROUP | MM Group Desc | A description of a multimedia group. | No | No |
| | MM Group Id | A unique value for a multimedia group. | Yes | No |
| MULTIMEDIA GROUP OBJECT | MM Group Id | A unique value for a multimedia group. | Yes | Yes |
| XREF | | | | |
| | MM Object Id | Unique identifier for a multimedia object. | Yes | Yes |
| MULTIMEDIA OBJECT | Item Group Id | Uniquely identifies an ITEM GROUP. | No | Yes |
| | | The item group to which the object may refer. This | | |
| | | attribute is considered to be mutually exclusive | | |
| | | with Item Id. | | |
| | Item Id | Unique Identifier for an Item. | No | Yes |
| | MM Object Create Dt | The date the object was created. | No | No |
| | MM Object Desc | A textual description providing information about | No | No |
| | | the object. For instance, Left side-bar frame in the | | |
| | | home page or Men's white full sleeves t-shirt logo. | | |
| | MM Object Id | Unique identifier for a multimedia object. | Yes | No |
| | MM Object Name | The name given to an object such as “picture of | No | No |
| | | Earth” or “left side bar”. | | |
| | MM Object Type Cd | A unique code identifying the class or kind of | No | Yes |
| | | object. A subtype discriminator. | | |
| | MM Source Id | A unique identifier for the multimedia source. | No | Yes |
| MULTIMEDIA SOURCE | MM Source Creator Party Id | The unique identifier for any individual or group of | No | Yes |
| | | individuals that is of interest to the enterprise. | | |
| | | The creator of the multimedia source. | | |
| | MM Source Desc | A description of the multimedia source. | No | No |
| | MM Source Id | A unique identifier for the multimedia source. | Yes | No |
| | MM Source Name | A name given to this multimedia source. | No | No |
| | MM Source Storage Location Txt | A text description of the storage location of this | No | No |
| | | multimedia source. | | |
| | MM Source Type Cd | A unique code to identify the class or kind of | No | Yes |
| | | multimedia. May be used as a subtype | | |
| | | discriminator. | | |
| MULTIMEDIA TYPE | MM Type Cd | A unique code to identify the class or kind of | Yes | No |
| | | multimedia. May be used as a subtype | | |
| | | discriminator. | | |
| | MM Type Desc | A description of the multimedia type. | No | No |
| NAICS | NAICS Cd | A six digit code for the North American Industry | Yes | No |
| | | Classification System. NAICS was developed | | |
| | | jointly by the U.S., Canada, and Mexico to provide | | |
| | | new comparability in statistics about business | | |
| | | activity across North America. | | |
| | NAICS Desc | A textual description of the code. | No | No |
| NAME TYPE | Name Type Cd | A unique code for the type of name that this | Yes | No |
| | | individual or organization could have such as | | |
| | | ‘doing business as’ (dba), legal name, alias, | | |
| | | phonetics, etc. | | |
| | Name Type Desc | The description of the code such as ‘doing business | No | No |
| | | as’, legal name, alias, phonetic name. | | |
| NAVIGATION LEVEL | Nav Level Desc | Description of the NAVIGATION LEVEL or the | No | No |
| | | name of the levels in the hierarchical structure(s) of | | |
| | | the web site that the shopper will browse down | | |
| | | through to get to product-specific web pages. | | |
| | | Example: Department Level, Product Category | | |
| | | Level, Product Sub Category Level, etc. | | |
| | Nav Level Id | The unique identifier for an instance of the | Yes | No |
| | | NAVIGATION LEVEL entity. | | |
| | Parent Nav Level Id | Allows for a multi-level hierarchical structure. | No | Yes |
| NON EMPLOYEE DIRECT | GL Sub Account Num | The unique Chart of Account code for the GL SUB | Yes | Yes |
| EXPNS ACCT | | ACCOUNT. | | |
| NON PAYROLL TAX ACCT | GL Sub Account Num | The unique Chart of Account code for the GL SUB | Yes | Yes |
| | | ACCOUNT. | | |
| NON REVENUE | Payment Tran Id | Uniquely identifies a Payment. | Yes | Yes |
| NON STD MAINT | MRO Spec Id OII | Uniquely identifies a MRO Specification. | Yes | Yes |
| NON TRANSIT STATE | Piece Num | Uniquely identifies a PIECE contained in a | Yes | Yes |
| | | SHIPMENT. | | |
| | | This can often be thought of as a “Tracking | | |
| | | Number” | | |
| | Start Event Id | A unique identifier for a SHIPPING EVENT. | Yes | Yes |
| | | The event that triggers the start of the current state. | | |
| NONCURRENT LIABILITY | GL Main Account Num | The unique Chart of Account code for the GL | Yes | Yes |
| ACCOUNT | | MAIN ACCOUNT. | | |
| | Noncurrent Liab Acct Type Cd | The unique code assigned to the NONCURRENT | No | Yes |
| | | LIABILITY ACCT TYPE. Types of non-current | | |
| | | liabilities include deferred income taxes, long-term | | |
| | | debt and reserves. | | |
| NONCURRENT LIABILITY | Noncurrent Liab Acct Type Cd | The unique code assigned to the NONCURRENT | Yes | No |
| ACCT TYPE | | LIABILITY ACCT TYPE. Types of non-current | | |
| | | liabilities include deferred income taxes, long-term | | |
| | | debt and reserves. | | |
| | Noncurrent Liab Acct Type Desc | The description of the NONCURRENT | No | No |
| | | LIABILITY ACCT TYPE. | | |
| NONDEPRECIABLE ASSET | GL Main Account Num | The unique Chart of Account code for the GL | Yes | Yes |
| ACCOUNT | | MAIN ACCOUNT. | | |
| NONDEPRECIABLE ASSET | NonDepreciable Asset Type Cd | The code assigned to a NONDEPRECIABLE | Yes | No |
| TYPE | | ASSET TYPE. | | |
| | NonDepreciable Asset Type Desc | The description of the NONDEPRECIABLE | No | No |
| | | ASSET TYPE. | | |
| NONDEPRECIABLE FIXED | NonDepreciable Asset Type Cd | The code assigned to a NONDEPRECIABLE | No | Yes |
| ASSET | | ASSET TYPE. | | |
| | NonDepreciable Fixed Asset Id | A unique identifier for an asset held by the | Yes | Yes |
| | | organization. | | |
| NONDIVIDEND EQUITY | GL Main Account Num | The unique Chart of Account code for the GL | Yes | Yes |
| ACCOUNT | | MAIN ACCOUNT. | | |
| | Nondividnd Eqty Acct Type Cd | The unique code assigned to the NONDIVIDEND | No | Yes |
| | | EQUITY ACCOUNT type. Types of non-dividend | | |
| | | equity accounts include retained earnings, treasury | | |
| | | stock and foreign currency adjustments. | | |
| NONDIVIDEND EQUITY ACCT | Nondividnd Eqty Acct Type Cd | The unique code assigned to the NONDIVIDEND | Yes | No |
| TYPE | | EQUITY ACCOUNT type. Types of non-dividend | | |
| | | equity accounts include retained earnings, treasury | | |
| | | stock and foreign currency adjustments. | | |
| | Nondividnd Eqty Acct Type Desc | The description of the NONDIVIDEND EQUITY | No | No |
| | | ACCOUNT type. | | |
| NONPROFIT ORGANIZATION | Nonprofit Party Id | The unique identifier for a Business. | Yes | Yes |
| | | Any organization that operates as a not-for-profit | | |
| | | business. | | |
| NONVOTING STOCK | GL Main Account Num | The unique Chart of Account code for the GL | Yes | Yes |
| ACCOUNT | | MAIN ACCOUNT. | | |
| NSCM | NSCM Cd MFR ROC SPL | The NSCM Code (NATO Supply Code for | Yes | No |
| | | Manufacturers) is code used to identify non-U.S. | | |
| | | Supply companies. (CAGE is the US Equivalent). | | |
| | NSCM Name | The Name assigned to the NSCM Party. | No | No |
| OnD BOOKING CURVE | Booking Class Cd | The booking class code associated with this | Yes | Yes |
| FORECAST | | particular booking, (i.e. F, Y, M, etc.). | | |
| | Days To Dept Cnt | A designated point in time across the booking | Yes | Yes |
| | | history of a flight at which key metrics for a flight | | |
| | | are recorded. Usually a flight is made available for | | |
| | | booking by the inventory system 365 days in | | |
| | | advance. As the flight departure date nears, the | | |
| | | metrics are recorded more frequently and they are | | |
| | | spaced further apart during the early part of a | | |
| | | flight's booking life. | | |
| | Flight Product Id | Unique Identifier for an Item. | Yes | Yes |
| | | A distance based TRAVEL PRODUCT that is | | |
| | | defined by Origination and Destination (O&D), | | |
| | | weekday of departure and time of departure. | | |
| | | An Airline Flight. | | |
| | Forecast Revenue Amt | The amount of PRODUCT revenue forecasted. | No | No |
| | Forecast Seats Available Cnt | The number of available seats forecasted.. | No | No |
| | Forecast Seats Booked Cnt | The number of booked seats forecasted. | No | No |
| | Location Id | Uniquely identifies a LOCATION. | Yes | Yes |
| | Model Id | The unique identifier for an instance of the | Yes | Yes |
| | | ANALYTICAL MODEL entity. | | |
| | Model Run Id | An identifier (or sequential number) that uniquely | Yes | Yes |
| | | describes this particular run of the ANALYTICAL | | |
| | | MODEL. | | |
| | Sched Seg Depart Dttm | The scheduled departure date and time of a | Yes | Yes |
| | | SEGMENT. | | |
| | | Note: This departure date and time is usually | | |
| | | identical to the departure date and time of the first | | |
| | | LEG of the SEGMENT. | | |
| OnD PAIR | Destination Facility Id | Uniquely identifies a LOCATION. | Yes | Yes |
| | Origin Facility Id | Uniquely identifies a LOCATION. | Yes | Yes |
| OnD PRODUCT | Actual Distance Meas | The actual travel distance between the two | No | No |
| | | TRAVEL FACILITYs. | | |
| | Award Distance Meas | The number of base LOYALTY ACCOUNT units | No | No |
| | | awarded for this OnD PRODUCT. | | |
| | Destination Facility Id | Uniquely identifies a LOCATION. | No | Yes |
| | OnD Product Id | Unique Identifier for an Item. | Yes | Yes |
| | | A distance based TRAVEL PRODUCT that is | | |
| | | defined by Origination and Destination (O&D), | | |
| | | weekday of departure and time of departure. | | |
| | OnD Product Type Cd | A code the identifies the type of OnD PRODUCT | No | Yes |
| | One Way Ind | Indicates if this is a one way product. | No | No |
| | Origin Facility Id | Uniquely identifies a LOCATION. | No | Yes |
| | Return Ind | Indicates if this is a return trip product, where the | No | No |
| | | passenger travels from an origin to a destination, | | |
| | | and then back again to their original origin. | | |
| OnD PRODUCT TYPE | OnD Product Type Cd | A code the identifies the type of OnD PRODUCT | Yes | No |
| | OnD Product Type Desc | A textual description of the type of OnD | No | No |
| | | PRODUCT | | |
| OnD SALES FORECAST | Actual Qty DD | The actual quantity of PRODUCTs. | No | No |
| | | This is a DERIVED DATA (DD) element. | | |
| | | The actual atomic level information is in the | | |
| | | PURCHASE Subject Area. | | |
| | Actual Revenue Amt DD | The actual amount of revenue received for | No | No |
| | | PRODUCTs. This is a DERIVED DATA (DD) | | |
| | | element. The actual atomic level information is in | | |
| | | the PURCHASE subject area. | | |
| | Actual Sales Amt DD | The amount of ITEM sales that actually occurred. | No | No |
| | | This is a DERIVED DATA (DD) element. | | |
| | Booking Class Cd | The booking class code associated with this | Yes | Yes |
| | | particular booking, (i.e. F, Y, M, etc.). | | |
| | Forecast Qty | The quantity of PRODUCTs forecasted.. | No | No |
| | Forecast Revenue Amt | The amount of PRODUCT revenue forecasted. | No | No |
| | Forecast Sales Amt | The amount of ITEM sales forecasted. | No | No |
| | Forecast Sales End Dt | The end date of the sales forecast. | Yes | No |
| | Item Id | Unique Identifier for an Item. | Yes | Yes |
| | Model Id | The unique identifier for an instance of the | Yes | Yes |
| | | ANALYTICAL MODEL entity. | | |
| | Model Run Id | An identifier (or sequential number) that uniquely | Yes | Yes |
| | | describes this particular run of the ANALYTICAL | | |
| | | MODEL. | | |
| | Period End Dt | The End Date of a specific time period. | Yes | No |
| | Period Start Dt | The Start Date of a specific time period. | No | No |
| OnD TIMETABLE | Arrival Tm | The arrival time published in the schedule for a | No | No |
| | | specific OnD. | | |
| | Arrival Week Day Id | Uniquely identifies the day of the week (1-7) | No | Yes |
| | Departure Tm | The scheduled time of departure for a flight as | No | No |
| | | found in the OnD SCHEDULE entity. | | |
| | Departure Week Day Id | Uniquely identifies the day of the week (1-7) | Yes | Yes |
| | Destination Facility Id | Uniquely identifies a LOCATION. | Yes | Yes |
| | Equip Series Id ASE AEM | Uniquely identifies a particular series of | No | Yes |
| | | equipment. | | |
| | Flight Num DFN | A unique identifier assigned to a Flight scheduled | Yes | Yes |
| | | for generating revenue and utilized by the general | | |
| | | public. | | |
| | Origin Facility Id | Uniquely identifies a LOCATION. | Yes | Yes |
| OPERATING EXPENSE | GL Main Account Num | The unique Chart of Account code for the GL | Yes | Yes |
| ACCOUNT | | MAIN ACCOUNT. | | |
| | Operating Expns Acct Type Cd | The unique code assigned to the OPERATING | No | Yes |
| | | EXPENSE ACCOUNT TYPE. Operating expenses | | |
| | | include marketing, general and administrative, | | |
| | | research and development, facilities and others. | | |
| OPERATING EXPENSE | Operating Expns Acct Type Cd | The unique code assigned to the OPERATING | Yes | No |
| ACCOUNT TYPE | | EXPENSE ACCOUNT TYPE. Operating expenses | | |
| | | include marketing, general and administrative, | | |
| | | research and development, facilities and others. | | |
| | Operating Expns Acct Type Desc | The description of the OPERATING EXPENSE | No | No |
| | | ACCOUNT TYPE. | | |
| OPERATING SYSTEM | Operating System Cd | Code that identifies the computer operating system | Yes | No |
| | | being used | | |
| | Operating System Name | The name of the computer operating system being | No | No |
| | | used | | |
| | Operating System Version Num | The release version of the computer operating | No | No |
| | | system being used. | | |
| OPERATIONS EQUIP | Equip Id OIN | Uniquely identifies an Equipment Instance. | Yes | Yes |
| OPS EQUIP USAGE | End Dttm | Date and Time that marks the end of the allocation | No | No |
| | | of the Tool to the Maintenance Event. | | |
| | Equip Id OIN | Uniquely identifies an Equipment Instance. | Yes | Yes |
| | Maint Event Id MTN | Uniquely identifies a Maintenance Event. | Yes | Yes |
| | Start Dttm | Date and Time that marks the beginning of the | No | No |
| | | allocation of the Tool to the Maintenance Event. | | |
| | Usage Tm | The amount of time that the tool was actually in | No | No |
| | | use for a specific Maint Event. | | |
| | | Note: this may not be the same as the difference | | |
| | | between the Start and End dates and times. | | |
| ORGANIZATION | Org Party Id | The unique identifier for an organization. | Yes | Yes |
| | Org Type Cd | A unique code used to identify the types of an | No | Yes |
| | | organization. | | |
| | Parent Org Party Id | The unique identifier for an organization. Permits | No | Yes |
| | | setting up a hierarchy for organizations. | | |
| | | Example: | | |
| | | A subsidiary owned by the parent enterprise. | | |
| ORGANIZATION NAME | Name Type Cd | A unique code for the type of name that this | Yes | Yes |
| | | individual or organization could have such as | | |
| | | ‘doing business as’ (dba), legal name, alias, | | |
| | | phonetics, etc. | | |
| | Org Name Desc | A text description of the organization name. | No | No |
| | Org Name MFN RON WHO | The name for the organization such as Los Angeles | No | No |
| | | Coin Club, Oakwood Country Club, Coca Cola, | | |
| | | Prime Rate Bank. | | |
| | Org Party Id | The unique identifier for an organization. | Yes | Yes |
| ORGANIZATION TYPE | Org Type Cd | A unique code used to identify the types of an | Yes | No |
| | | organization. | | |
| | Org Type Desc | A description of the ORGANIZATION TYPE. | No | No |
| OTHER ASSET ACCOUNT | GL Main Account Num | The unique Chart of Account code for the GL | Yes | Yes |
| | | MAIN ACCOUNT. | | |
| | Other Asset Account Party Id | The unique identifier for any individual or group of | No | Yes |
| | | individuals that is of interest to the enterprise. | | |
| | | The PARTY that owes your enterprise money. | | |
| | Other Asset Account Type Cd | The unique code assigned to the OTHER ASSET | No | Yes |
| | | ACCOUNT TYPE. For example: investments, | | |
| | | deferred charges or intangible asset. | | |
| OTHER ASSET ACCOUNT TYPE | Other Asset Account Type Cd | The unique code assigned to the OTHER ASSET | Yes | No |
| | | ACCOUNT TYPE. For example: investments, | | |
| | | deferred charges or intangible asset. | | |
| | Other Asset Account Type Desc | The description of the OTHER ASSET | No | No |
| | | ACCOUNT TYPE. | | |
| OTHER CURRENT ASSET | GL Main Account Num | The unique Chart of Account code for the GL | Yes | Yes |
| ACCOUNT | | MAIN ACCOUNT. | | |
| OTHER EXPENSE ACCOUNT | GL Main Account Num | The unique Chart of Account code for the GL | Yes | Yes |
| | | MAIN ACCOUNT. | | |
| OTHER INVOICE EXPENSE | AP Invoice Id | A number representing a unique identifier for a | Yes | Yes |
| | | INVOICE. | | |
| OTHER OP EXPENSE | GL Main Account Num | The unique Chart of Account code for the GL | Yes | Yes |
| ACCOUNT | | MAIN ACCOUNT. | | |
| OTHER REVENUE ACCOUNT | GL Main Account Num | The unique Chart of Account code for the GL | Yes | Yes |
| | | MAIN ACCOUNT. | | |
| OUT OF SVC REASON | Out Of Svc Rsn Cd | Uniquely identifies a Reason for Removing | Yes | No |
| | | Equipment from Service. | | |
| | Out Of Svc Rsn Desc | Textual description of a Reason for Removing | No | No |
| | | Equipment from Service. | | |
| OUTBOUND TRANSACTION | Inv Tran Id | Uniquely identifies an inventory transaction. | Yes | Yes |
| | Shipment Num | Uniquely identifies a SHIPMENT. | No | Yes |
| | | Optional. Mainly to be used if an external party is | | |
| | | transporting the inventory. | | |
| PA DRAFT INVOICE | PA Draft Invoice Dttm | The date and time this PA DRAFT INVOICE was | No | No |
| | | created. | | |
| | PA Draft Invoice Id | A number representing a unique identifier for a | Yes | Yes |
| | | INVOICE. | | |
| | Project Id | The unique identifier for the PROJECT. | No | Yes |
| PA DRAFT INVOICE LINE | PA Draft Inv Ln Approve Dttm | The calendar date and time the PA Draft Invoice | No | No |
| | | Line was approved. | | |
| | PA Draft Inv Ln Bill Thru Dttm | The calendar date and time indicating the billing | No | No |
| | | cut off date for the PA Draft Invoice Line. | | |
| | PA Draft Inv Ln Dttm | The calendar date and time a PA Draft Invoice Line | Yes | No |
| | | was created. | | |
| | PA Draft Inv Ln Num | A number representing a unique identifier for a PA | Yes | No |
| | | Draft Invoice Line. | | |
| | PA Draft Invoice Id | A number representing a unique identifier for a | Yes | Yes |
| | | INVOICE. | | |
| | Proj Task Resource Id | The unique identifier assigned to a Project Task | No | Yes |
| | | Resource. | | |
| | Proj Task Resource Start Dttm | The calendar date and time a PROJECT TASK | No | Yes |
| | | RESOURCE ASSIGN started. | | |
| | Project Id | The unique identifier for the PROJECT. | No | Yes |
| | Project Task Start Dttm | The calendar date and time a PROJECT TASK | No | Yes |
| | | started. | | |
| | Task Id | The unique identifier assigned to a TASK. | No | Yes |
| PA DRAFT INVOICE LINE | PA Draft Inv Line Amount Dttm | The calendar date and time a PA DRAFT | No | No |
| AMOUNT | | INVOICE LINE AMOUNT was created. | | |
| | PA Draft Inv Line Global Amt | The amount related to the specified INVOICE and | No | No |
| | | the invoice amount type code, in global currency. | | |
| | PA Draft Inv Line Local Amt | The amount related to the specified INVOICE and | No | No |
| | | the invoice amount type code, in local accounting | | |
| | | currency. | | |
| | PA Draft Inv Line Trans Amt | The amount related to the specified INVOICE and | No | No |
| | | the invoice amount type code, in transaction | | |
| | | currency. | | |
| | PA Draft Inv Ln Dttm | The calendar date and time a PA DRAFT | Yes | Yes |
| | | INVOICE LINE was created. | | |
| | PA Draft Inv Ln Num | A number representing a unique identifier for a PA | Yes | Yes |
| | | DRAFT INVOICE LINE. | | |
| | PA Draft Invoice Id | A number representing a unique identifier for a | Yes | Yes |
| | | INVOICE. | | |
| | PA Invoice Amount Type Cd | The code for the type of INVOICE AMOUNT | Yes | Yes |
| | | TYPE. | | |
| | | Examples are: | | |
| | | Invoice original amount | | |
| | | Unit price | | |
| | | Invoice total amount | | |
| | | Freight invoice total amount | | |
| | | Tax amount | | |
| | | Discount amount | | |
| | | Paid amount | | |
| | | Unpaid amount | | |
| | | etc. | | |
| PACKAGING ITEM | Packaging Item Id | Unique Identifier for an Item. | Yes | Yes |
| | | This attribute identifies Items that can be used for | | |
| | | packaging, such as boxes, pallets or containers | | |
| | | used for storing, moving and/or shipping ITEMs. | | |
| | Packaging Type Cd | Uniquely identifies the Packaging Type. | No | Yes |
| | Returnable Ind | An indicator that identifies that a package or | No | No |
| | | container is returnable. | | |
| PACKAGING TYPE | Packaging Type Cd | Uniquely identifies the Packaging Type. | Yes | No |
| | Packaging Type Desc | Narrative text describing the Packaging Type. | No | No |
| PAGE POSITION | Page Position Cd | A code used for identifying the positions on a page. | Yes | No |
| | Page Position Desc | Description of the page position. | No | No |
| PAGE TYPE | Page Type Cd | Code that identifies a particular type of PAGE. | Yes | No |
| | Page Type Desc | Textual description of this particular type of | No | No |
| | | PAGE. | | |
| PART INSTALL(IPT) | Part Install Event Id HRI or MTN | Uniquely identifies a Maintenance Event. | Yes | Yes |
| | Part Remove Event Id HRI or MTN | Uniquely identifies a Maintenance Event. | No | Yes |
| PART REMOVE(PAR) | Part Remove Event Id HRI or MTN | Uniquely identifies a Maintenance Event. | Yes | Yes |
| PART REPAIR(WPS) | Maint Event Id MTN | Uniquely identifies a Maintenance Event. | Yes | Yes |
| PARTNER AWARD | Award Voucher Id | The identifier of a loyalty award or certificate | Yes | Yes |
| | | awarded to a customer account. | | |
| PARTNER EARNING | Event Dttm | The date and time that a loyalty event occurred | Yes | Yes |
| | Loyalty Account Id | Uniquely identifies an ACCOUNT. | Yes | Yes |
| | Partner Party Id | The unique identifier for an external organization. | No | Yes |
| | Travel Product Id | Unique Identifier for an Item. | No | Yes |
| | | A Travel-related offer available for sale to a | | |
| | | PARTY(s). | | |
| PARTNER PRODUCT | Partner Party Id | The unique identifier for an external organization. | Yes | Yes |
| | Travel Product Id | Unique Identifier for an Item. | Yes | Yes |
| | | A Travel-related offer available for sale to a | | |
| | | PARTY(s). | | |
| PARTY | Credit Rating Cd | Uniquely identifies a CREDIT RATING. | No | Yes |
| | Party First Purchase Dt | The date the PARTY first purchased a product or | No | No |
| | | service. | | |
| | | This attribute is only needed if all purchase history | | |
| | | is not retained. | | |
| | Party Id | The unique identifier for any individual or group of | Yes | No |
| | | individuals that is of interest to the enterprise. | | |
| | Party Info Source Type Cd | A code used to uniquely identify how/where the | No | Yes |
| | | first information about the existence of a Party was | | |
| | | obtained. | | |
| | Party Start Dt | The date this party first became of interest to the | No | No |
| | | enterprise. | | |
| | Party Type Cd | A code used to uniquely identify the sub-type | No | Yes |
| | | discriminator for a party. Valid sub-type | | |
| | | occurrences are INDIVIDUAL, ORGANIZATION | | |
| | | and HOUSEHOLD. | | |
| PARTY ADDRESS | Address Id | A number used to uniquely identify an ADDRESS. | Yes | Yes |
| | Address Usage Cd | A code used to uniquely identify the ADDRESS | Yes | Yes |
| | | USAGE. | | |
| | Default Ind | In the case of multiple ADDRESSes for the same | No | No |
| | | usage, indicates the default one to use. | | |
| | Party Id | The unique identifier for any individual or group of | Yes | Yes |
| | | individuals that is of interest to the enterprise. | | |
| PARTY AGREEMENT ROLE | Agreement Id | Uniquely identifies an AGREEMENT. | Yes | Yes |
| | Party Id | The unique identifier for any individual or group of | Yes | Yes |
| | | individuals that is of interest to the enterprise. | | |
| | Party Role Cd | Uniquely identifies the PARTY ROLE. | Yes | Yes |
| PARTY CHANNEL | Channel Party Id | The unique identifier for any individual or group of | Yes | Yes |
| | | individuals that is of interest to the enterprise. | | |
| | | In this context this is the Party who uses the | | |
| | | Channel.. | | |
| | Channel Type Cd | The code assigned to the CHANNEL. Example: | Yes | Yes |
| | | Point of Sale - POS, Internet, call center, mail | | |
| | | order, etc. | | |
| | Channel Usage Type Cd | A code for classifying the usage of channels. For | Yes | Yes |
| | | example, marketing, sales, electronic, etc. | | |
| | Party Channel End Dttm | The date this association ended. | No | No |
| | Party Channel Start Dttm | The date this Party is associated with this Channel | Yes | No |
| | | for this specific usage. | | |
| PARTY DEMOGRAPHIC | Demog Cd | The unique code for an instance of the | Yes | Yes |
| | | DEMOGRAPHIC entity. | | |
| | Demog Value Cd | A code referencing a specific DEMOGRAPHIC | No | Yes |
| | | VALUE for a given demographic code. | | |
| | Party Id | The unique identifier for any individual or group of | Yes | Yes |
| | | individuals that is of interest to the enterprise. | | |
| PARTY GROUP | Parent Party Group Id | The unique identifier for the party group that is the | No | Yes |
| | | hierarchical parent to this party group. This | | |
| | | provides for roll ups from one group to another. | | |
| | Party Group Desc | The description of the group of parties. | No | No |
| | Party Group Id | The unique identifier for the grouping of parties. | Yes | No |
| | Party Group Name | A short name of the group of parties. | No | No |
| | Party Group Reason Type Cd | The reason this grouping of parties was created | No | Yes |
| | | such as for vendor group or customer group. | | |
| | Party Group Start Dttm | The date this group was created. | No | No |
| PARTY GROUP REASON TYPE | Party Group Reason Type Cd | The reason this grouping of parties was created | Yes | No |
| | | such as for vendor group or customer group. | | |
| | Party Group Reason Type Desc | The description of the code. | No | No |
| PARTY IDENTIFICATION | Party Id | The unique identifier for any individual or group of | Yes | Yes |
| | | individuals that is of interest to the enterprise. | | |
| | Party Identification Num | The numbers assigned to a party for identification | No | No |
| | | purposes, as specified by the Party Identification | | |
| | | Type Cd. This will be the Social Security Number, | | |
| | | Passport Identification, | | |
| | | Driver's License, Federal Tax Identification | | |
| | | Number, National Identity Card Number, | | |
| | | Etc. | | |
| | Party Identification Type Cd | A code used to uniquely identify the types of legal | Yes | Yes |
| | | jurisdiction identification that may be used by a | | |
| | | party. | | |
| | | Example: | | |
| | | SSN = Social Security Number, | | |
| | | PASSP = Passport Identification, | | |
| | | DRIV = Driver's License, | | |
| | | FTIN = Federal Tax Identification Number, | | |
| | | NICN = National Identity Card Number. | | |
| PARTY IDENTIFICATION TYPE | Party Identification Type Cd | A code used to uniquely identify the types of legal | Yes | No |
| | | jurisdiction identification that may be used by a | | |
| | | party. | | |
| | | Example: | | |
| | | SSN = Social Security Number, | | |
| | | PASSP = Passport Identification, | | |
| | | DRIV = Driver's License, | | |
| | | FTIN = Federal Tax Identification Number, | | |
| | | NICN = National Identity Card Number. | | |
| | Party Identification Type Desc | A textual description of a Party Identification Type | No | No |
| | | Cd. | | |
| | Party Identification Type Name | The name assigned to a Party Identification Type. | No | No |
| | | Examples: | | |
| | | Social Security Number | | |
| | | Passport Identification | | |
| | | Driver's License | | |
| | | Federal Tax Identification Number | | |
| | | National Identity Card Number. | | |
| PARTY INFO SOURCE TYPE | Party Info Source Desc | A textual description of the party info source. | No | No |
| | Party Info Source Name | The name assigned to a party info source. | No | No |
| | Party Info Source Type Cd | A code used to uniquely identify how/where the | Yes | No |
| | | first information about the existence of a Party was | | |
| | | obtained. | | |
| PARTY LIMIT | Party Limit Amt | The amount of the credit limit for this party. | No | No |
| | Party Limit Currency Cd | The code assigned to a CURRENCY. | No | Yes |
| | Party Limit End Dttm | The date when this limit is no longer effective. | No | No |
| | | May be null. | | |
| | Party Limit Party Id | The unique identifier for any individual or group of | Yes | Yes |
| | | individuals that is of interest to the enterprise. | | |
| | | In this context this is the Party who has the | | |
| | | described limit. | | |
| | Party Limit Start Dttm | The date when this limit was effective for this | Yes | No |
| | | party. | | |
| | Party Limit Type Cd | A code for the type of credit limit such as credit | Yes | Yes |
| | | limit, credit limit per order, credit limit per site. | | |
| PARTY PARTY GROUP | Party Group Id | The unique identifier for the grouping of parties. | Yes | Yes |
| | Party Group Party Id | The unique identifier for any individual or group of | Yes | Yes |
| | | individuals that is of interest to the enterprise. | | |
| | | In this context this is the Party that belongs to this | | |
| | | Party Group. | | |
| | Party Party Group End Dttm | The date this Party- Group association ended. | No | No |
| | Party Party Group Start Dttm | The date this Party- Group association started. | Yes | No |
| PARTY PARTY RELATIONSHIP | Party Rel Status Reason Cd | A code used to uniquely identify a reason for a | No | Yes |
| | | party relationship status type. | | |
| | Party Rel Status Type Cd | A code used to uniquely identify a party | No | Yes |
| | | relationship classification. | | |
| | Party Relationship Role Cd | A Unique identifier for the role that one party can | Yes | Yes |
| | | have with another party. | | |
| | Related Party Id | The identifier for a party, individual, organization | Yes | Yes |
| | | or household that is related to another party. | | |
| | Relates Party Id | The identifier for a party, individual, organization | Yes | Yes |
| | | or household, that relates to another party. | | |
| PARTY PRIVACY PREFERENCE | Party Privacy Preference Num | Uniquely identifies a party's preference. This is | Yes | No |
| | | handled like a line number as in purchase orders - | | |
| | | one line number for each preference. | | |
| | Privacy Authorizing Party Id | The party authorizing the privacy option, for | No | Yes |
| | | example, a parent consenting for a child; an adult | | |
| | | consenting for him or herself. | | |
| | Privacy Data Cd | Uniquely identifies the privacy data. | No | Yes |
| | Privacy Data Usage Cd | Uniquely identifies the usage of privacy data. | No | Yes |
| | Privacy Preference Ind | The privacy preference. Examples: Y - the | No | No |
| | | information is protected and private; N - the | | |
| | | information is not protected. | | |
| | Privacy Preference Party Id | The party to whom the privacy preference applies. | Yes | Yes |
| PARTY PROJECT ROLE | Party Project Role Cd | The code assigned to the role of a party who is | Yes | No |
| | | associated with a project. | | |
| | Party Project Role Desc | The text describing the role of a PARTY who is | No | No |
| | | associated with a project. | | |
| PARTY PROJECT TASK ROLE | Party Project Task Role Cd | The code assigned to the role of an associate that is | Yes | No |
| | | on a PROJECT. | | |
| | Party Project Task Role Desc | The text describing the role of an associate that is | No | No |
| | | on a PROJECT. | | |
| PARTY REL STATUS REASON | Party Rel Status Reason Cd | A code used to uniquely identify a reason for a | Yes | No |
| | | party relationship status type. | | |
| | Party Rel Status Reason Desc | A textual description of a reason for a party | No | No |
| | | relationship status type. | | |
| PARTY REL STATUS TYPE | Party Rel Status Type Cd | A code used to uniquely identify a party | Yes | No |
| | | relationship classification. | | |
| | Party Rel Status Type Desc | A textual description for the Party Rel Status Type | No | No |
| | | Cd. | | |
| PARTY RELATIONSHIP ROLE | Party Relationship Role Cd | A Unique identifier for the role that one party can | Yes | No |
| | | have with another party. | | |
| | Party Relationship Role Desc | A textual description for a Party Relationship Role. | No | No |
| PARTY ROLE | Party Role Cd | Uniquely identifies the PARTY ROLE. | Yes | No |
| | Party Role Desc | Narrative text describing the PARTY ROLE. | No | No |
| PARTY SCORE | Model Id | The unique identifier for an instance of the | Yes | Yes |
| | | ANALYTICAL MODEL entity. | | |
| | Model Run Id | An identifier that uniquely describes the particular | Yes | Yes |
| | | run of the ANALYTICAL MODEL. | | |
| | Party Id | The unique identifier for any individual or group of | Yes | Yes |
| | | individuals that is of interest to the enterprise. | | |
| | Party Score Val | The actual score produced for the PARTY by the | No | No |
| | | ANALYTICAL MODEL. | | |
| | | Example: Jim Smith has a ‘customer profitability’ | | |
| | | score of 7; Acme Supplies has an ‘on-time | | |
| | | delivery’ score of 3. | | |
| PARTY SEGMENT | Party Id | The unique identifier for any individual or group of | Yes | Yes |
| | | individuals that is of interest to the enterprise. | | |
| | Segment Id | The unique identifier for an instance of the | Yes | Yes |
| | | MARKET SEGMENT entity. | | |
| PARTY SHIPMENT ROLE | Party Id | The unique identifier for any individual or group of | Yes | Yes |
| | | individuals that is of interest to the enterprise. | | |
| | Party Role Cd | Uniquely identifies the PARTY ROLE. | Yes | Yes |
| | Shipment Num | Uniquely identifies a SHIPMENT. | Yes | Yes |
| PARTY STATUS | Party Status Cd | Uniquely defines a Party Status. | Yes | No |
| | Party Status Desc | Textual description for a Party Status. | No | No |
| PARTY STATUS HIST | Party Id | The unique identifier for any individual or group of | Yes | Yes |
| | | individuals that is of interest to the enterprise. | | |
| | | The Party the Status applies to. | | |
| | Party Status Cd | Uniquely defines a Party Status. | Yes | Yes |
| | Status Dt | The effective date of the status. | Yes | No |
| PARTY TRAN ROLE | Party Id | The unique identifier for an instance of the PARTY | Yes | Yes |
| | | entity. | | |
| | Party Role Cd | A unique identifier for an instance of the PARTY | Yes | Yes |
| | | ROLE entity. | | |
| | | Example: 1- Person Making the reservation, 2- | | |
| | | Person for whom the reservation is being made, 3- | | |
| | | Person paying for the reservation, etc. | | |
| | Travel Transaction Id | A unique identifier for this TRAVEL | Yes | Yes |
| | | TRANSACTION. | | |
| PARTY TYPE | Party Type Cd | A code used to uniquely identify the sub-type | Yes | No |
| | | discriminator for a party. Valid sub-type | | |
| | | occurrences are INDIVIDUAL, ORGANIZATION | | |
| | | and HOUSEHOLD. | | |
| | Party Type Desc | A textual description for a party type. | No | No |
| PASSENGER CONFIG | Equipment Model Cd AMC AET | A model code for a piece of equipment - typically | No | Yes |
| | | provided by the Manufacturer. | | |
| | Manuf Party Id | The unique identifier for a Business. | No | Yes |
| | | Party that manufactures goods, equipment, etc. | | |
| | Passenger Config Id | Uniquely identifies a specific passenger | Yes | No |
| | | configuration. | | |
| PASSENGER TRAVEL | Passenger Travel Type Cd | A code the identifies the type of PASSENGER | No | Yes |
| PROVIDER | | TRAVEL PROVIDER | | |
| | Product Provider Id | The unique identifier for an external organization. | Yes | Yes |
| | | Identifies the Organization that provides a Product. | | |
| PASSENGER TRAVEL TYPE | Passenger Travel Type Cd | A code the identifies the type of PASSENGER | Yes | No |
| | | TRAVEL PROVIDER | | |
| | Passenger Travel Type Desc | A textual description of the type of PASSENGER | No | No |
| | | TRAVEL PROVIDER | | |
| PATENTS ACCOUNT | GL Main Account Num | The unique Chart of Account code for the GL | Yes | Yes |
| | | MAIN ACCOUNT. | | |
| PAYMENT | Approval Status Cd | Unique identifier for an APPROVAL STATUS. | No | Yes |
| | Credit Account Id | Uniquely identifies an ACCOUNT. | No | Yes |
| | | An account used to grouped unpaid (credit) | | |
| | | purchases, and credited when payment is applied. | | |
| | | Note: This attribute is not used in cases where the | | |
| | | customer does not have a pre-established account. | | |
| | Debit Account Id | Uniquely identifies an ACCOUNT. | No | Yes |
| | | Used to indicate the account used to make the | | |
| | | payment (could be a credit card, checking account, | | |
| | | etc.). Not used if payment was in cash. | | |
| | Deposit Ind | Indicates if the PAYMENT was a deposit (or pre- | No | No |
| | | payment) towards a PURCHASE ITEM | | |
| | Paying Party Id | The unique identifier for any individual or group of | No | Yes |
| | | individuals that is of interest to the enterprise. | | |
| | | The Party making the actual Payment. | | |
| | Payment Amt | The amount paid in conjunction with this | No | No |
| | | PAYMENT entity. | | |
| | | NOTE: Since the payment may be allocated to | | |
| | | multiple transactions, this amount MAY be | | |
| | | redundant in some environments - however, it may | | |
| | | still be of use to determine if under or over | | |
| | | allocation of the payment were made. | | |
| | Payment Dttm | The date (and time) the payment was received for | No | No |
| | | this PAYMENT entity. | | |
| | Payment Tran Id | Uniquely identifies a Payment. | Yes | No |
| | Payment Type Cd | Uniquely identifies a payment type. | No | Yes |
| | Payment Waive Amt | The amount of money waived by the enterprise at | No | No |
| | | the time of payment | | |
| | Payment Waive Ind | Indicates if the part or the whole of the PAYMENT | No | No |
| | | was waived as a complimentary gesture by the | | |
| | | enterprise | | |
| | Purchase Tran Id | A unique identifier for this TRAVEL | No | Yes |
| | | TRANSACTION. | | |
| | Settlement Dttm | This attribute is the date and time when a | No | No |
| | | PAYMENT is finally received (settled) by the | | |
| | | travel provider. | | |
| PAYMENT BANK DRAFT | Bank Draft Id | The primary key to the BANK DRAFT entity. | Yes | Yes |
| ASSIGN | | | | |
| | Payment Id | Uniquely identifies a Payment. | Yes | Yes |
| PAYMENT METHOD TYPE | Payment Method Type Cd | Contains list or account PAYMENT METHOD | Yes | No |
| | | TYPEs. | | |
| | Payment Method Type Desc | A description of the PAYMENT METHOD TYPE | No | No |
| | | code. | | |
| | Payment Method Type Name | Payment Method Name. | No | No |
| PAYMENT PARTY | Payment Id | Uniquely identifies a Payment. | Yes | Yes |
| | Payment Party Dttm | The calendar date and time a Payment PARTY | No | No |
| | | authorized a PAYMENT. | | |
| | Payment Party Id | The unique identifier for any individual or group of | Yes | Yes |
| | | individuals that is of interest to the enterprise. | | |
| | Payment Party Role Cd | The code assigned to a Payment Party Role. | Yes | Yes |
| PAYMENT PARTY ROLE | Payment Party Role Cd | A unique identifier for the role that one PARTY | Yes | No |
| | | can have with the PAYMENT. | | |
| | Payment Party Role Desc | A textual description for a PAYMENT PARTY | No | No |
| | | ROLE. | | |
| PAYMENT PRIORITY TYPE | Payment Priority Type Cd | A classification of the priority level that one vendor | Yes | No |
| | | has in relation to another vendor for a PAYMENT. | | |
| | | This is the order in which vendors get paid first. | | |
| | | Examples: first, second, third, etc. | | |
| | Payment Priority Type Desc | A description of the code. | No | No |
| PAYMENT PROCESS TYPE | Payment Process Type Cd | The code used to uniquely identify the PAYMENT | Yes | No |
| | | PROCESS TYPE. | | |
| | Payment Process Type Desc | A description of the PAYMENT PROCESS TYPE | No | No |
| | | code. | | |
| PAYMENT SCHEDULE | Consolidated Inv Id | A number representing a unique identifier for a | No | Yes |
| | | CONSOLIDATED INVOICE. | | |
| | Invoice Id | A number representing a unique identifier for a | No | Yes |
| | | INVOICE. | | |
| | Payment Schedule Id | A number representing a unique identifier for a | Yes | No |
| | | PAYMENT SCHEDULE. | | |
| | Payment Term Type Cd | Uniquely identifies the AGREEMENT TERM | No | Yes |
| | | TYPE. | | |
| | | Identifies the Payment Term Type. | | |
| PAYMENT SCHEDULE | Payment Sched Amount Dttm | The date and time the PAYMENT SCHEDULE | Yes | No |
| AMOUNT | | amount was created. | | |
| | Payment Sched Amount Due Dttm | The date the scheduled payment amount is due. | No | No |
| | Payment Sched Amount Globl Amt | The monetary amount of the scheduled payment in | No | No |
| | | the global currency. | | |
| | Payment Sched Amount Local Amt | The monetary amount of the scheduled payment in | No | No |
| | | the currency of the local accounting books. | | |
| | Payment Sched Amount Trans Amt | The monetary amount of the scheduled payment in | No | No |
| | | the transaction currency. | | |
| | | The Currency Cd associated with the transaction is | | |
| | | specified in the PAYMENT entity. | | |
| | Payment Sched Amount Type Cd | A code for the type of collection amount. | Yes | Yes |
| | | For example: | | |
| | | Adjusted Amt | | |
| | | Applied Amt | | |
| | | Credited Amt | | |
| | | In Dispute Amt | | |
| | | Discount Earned Taxed Amt | | |
| | | Discount Unearned Taxed Amt | | |
| | | Last Promise Amt | | |
| | | Originally Due Amt | | |
| | | Pending Adjustment Amt | | |
| | | Remaining Due Amt. | | |
| | Payment Schedule Id | A number representing a unique identifier for a | Yes | Yes |
| | | PAYMENT SCHEDULE. | | |
| PAYMENT SCHEDULE | Payment Sched Amount Type Cd | A code for the type of collection amount. | Yes | No |
| AMOUNT TYPE | | For example: | | |
| | | Adjusted Amt | | |
| | | Applied Amt | | |
| | | Credited Amt | | |
| | | In Dispute Amt | | |
| | | Discount Earned Taxed Amt | | |
| | | Discount Unearned Taxed Amt | | |
| | | Last Promise Amt | | |
| | | Originally Due Amt | | |
| | | Pending Adjustment Amt | | |
| | | Remaining Due Amt. | | |
| | Payment Sched Amount Type Desc | A description of the PAYMENT SCHEDULE | No | No |
| | | AMOUNT TYPE code. | | |
| PAYMENT SCHEDULE | Payment Id | Uniquely identifies a Payment. | Yes | Yes |
| PAYMENT | | | | |
| | Payment Schedule Id | A number representing a unique identifier for a | Yes | Yes |
| | | PAYMENT SCHEDULE. | | |
| PAYMENT STATUS | Payment Id | Uniquely identifies a Payment. | Yes | Yes |
| | Payment Status Comment Txt | Free form text that may be used to further describe | No | No |
| | | the status. For example, if the PAYMENT was | | |
| | | reversed, comments may be entered to further | | |
| | | describe the reversal reason. | | |
| | Payment Status Dttm | The date and time the status was created for the | Yes | No |
| | | PAYMENT. | | |
| | | PAYMENT STATUS can change over time, for | | |
| | | example be Approved but later Reversed. | | |
| | Payment Status Reason Type Cd | The unique code why the receipt was reversed. | No | Yes |
| | Payment Status Type Cd | The code used to uniquely identify the PAYMENT | Yes | Yes |
| | | STATUS TYPE. | | |
| PAYMENT STATUS REASON | Payment Status Reason Type Cd | The unique code associated with the reason for a | Yes | No |
| TYPE | | PAYMENT STATUS TYPE. | | |
| | Paymnt Status Reason Type Desc | Text describing the reason associated with a | No | No |
| | | PAYMENT STATUS TYPE. | | |
| PAYMENT STATUS TYPE | Payment Status Type Cd | The code used to uniquely identify the PAYMENT | Yes | No |
| | | STATUS TYPE. | | |
| | Payment Status Type Desc | A description of the PAYMENT STATUS TYPE. | No | No |
| | | Examples: Approved, confirmed, remitted, | | |
| | | cleared, and reversed. | | |
| PAYMENT TERM TYPE | Payment Term Type Cd | Uniquely identifies the AGREEMENT TERM | Yes | Yes |
| | | TYPE. | | |
| | | Identifies the Payment Term Type. | | |
| | Payment Term Type Desc | A description of the Payment Term Type Code. | No | No |
| | | Examples are Net 10 days, Net 45 days, | | |
| | | Prepayment. Payment terms are used in calculating | | |
| | | the payment schedule. | | |
| PAYMENT TYPE | Payment Type Cd | Uniquely identifies a payment type. | Yes | No |
| | Payment Type Desc | Narrative text describing a payment type. | No | No |
| PERPETUAL INVENTORY | Item Id ASN | Unique Identifier for an Item. | Yes | Yes |
| | | A subset of (physical) items than can be | | |
| | | inventoried, and shelved. This would exclude | | |
| | | service items and virtual items (downloadable | | |
| | | products). | | |
| | Location Id | Uniquely identifies a LOCATION. | Yes | Yes |
| | Perpetual Inv Dttm | The date and time reflected by the inventory level. | Yes | No |
| | Perpetual Inv Unit Qty DD | The most recent calculated level of units of an item | No | No |
| | | in inventory. | | |
| | Perpetual Inv Value Amt DD | The unit book value of an inventoried item after | No | No |
| | | temporary or permanent markdowns, if any, have | | |
| | | been applied but prior to any discounts have been | | |
| | | taken. | | |
| | | Note: If the enterprise use simple pricing this | | |
| | | attribute may be derivable. | | |
| | | For more complex pricing models, this may be a | | |
| | | non-derivable and populated by an application. | | |
| PERSONA | Individual Party Id UPI | The unique identifier for an individual. | No | Yes |
| | Individual Rel Role Cd | A Unique identifier for the role that one party can | No | Yes |
| | | have with another party. | | |
| | Organization Party Id | The unique identifier for an organization. | No | Yes |
| | Persona Id | Unique identifier for a PERSONA. | Yes | No |
| PIECE | Claim Num | Uniquely identifies a CLAIM. | No | Yes |
| | Cube Meas | The cubic-foot/meter (cube) requirements needed | No | No |
| | | to transport this PIECE, stated on the Bill of | | |
| | | Lading. | | |
| | Deficit Weight Charge Ind | Indicate SHIPMENT LINE was charged at the next | No | No |
| | | higher weight level (because it's cheaper). | | |
| | | A check is made when a PIECE gets close to a | | |
| | | class weight break to determine if the price is | | |
| | | cheaper at the next higher class. If the next higher | | |
| | | class is used, this indicator will be set. | | |
| | EPC Cd | Uniquely identifies a RFID Tagged object. | No | Yes |
| | | Radio Frequency tag id associated with this PIECE. | | |
| | | Note: There are two possible usages of RFID Tag | | |
| | | at this level: | | |
| | | 1. To purely identify or tag the Piece to track its | | |
| | | movement while transported. In this case the RFID | | |
| | | tag is nothing more than a shipment ‘tracking | | |
| | | number’ that can be read remotely. | | |
| | | 2. To identify a re-usable container. In this case, | | |
| | | the RFID tag should be related back to a Serialized | | |
| | | Package Item (an uniquely identified Package | | |
| | | Item) that provides more information about the | | |
| | | container. | | |
| | FAK Ind | Freight All Kind Indicator. Indicates that | No | No |
| | | miscellaneous goods were shipped and assigned a | | |
| | | ‘combined’ NMFC code for rating purposes - in | | |
| | | other words the NMFC is not an accurate | | |
| | | description of the actual goods shipped. | | |
| | Motorized Ind | Indicates if this PIECE requires motorized (vs. | No | No |
| | | manual) handling. | | |
| | | For example: This PIECE must be moved by a | | |
| | | motorized fork lift due to its size or weight. | | |
| | Origination Party Id | The unique identifier for any individual or group of | No | Yes |
| | | individuals that is of interest to the enterprise. | | |
| | | If the Shipper is not the Origination Shipper, this | | |
| | | will identify the Origination Shipper. | | |
| | | This information is at the Piece level, since Pieces | | |
| | | from multiple different Origination Shippers may | | |
| | | be consolidated into one Shipment. | | |
| | | Not used if Shipper is the Origination Shipper. | | |
| | | Note: This information is often a requirement for | | |
| | | security and control purposes. | | |
| | Origination Reference Num | If the Shipper is not the Origination Shipper, this is | No | No |
| | | a link back to the Origination Shipper's Reference | | |
| | | Number for the Shipment. | | |
| | | Not used if Shipper is the Origination Shipper, | | |
| | | since we will then have a 3rd party reference | | |
| | | number at the shipment level instead (BOL Num). | | |
| | Packaging Item Id | Unique Identifier for an Item. | No | Yes |
| | | This attribute identifies Items that can be used for | | |
| | | packaging, such as boxes, pallets or containers | | |
| | | used for storing, moving and/or shipping ITEMs. | | |
| | Piece Class Rating Cd | The unique code for an instance of the CLASS | No | Yes |
| | | RATING entity. | | |
| | | A Rating for the entire PIECE. If the PIECE | | |
| | | contain multiple items (with multiple ratings), this | | |
| | | rating is usually the most expensive rating of those | | |
| | | available. | | |
| | Piece Num | Uniquely identifies a PIECE contained in a | Yes | No |
| | | SHIPMENT. | | |
| | | This can often be thought of as a “Tracking | | |
| | | Number” | | |
| | Shipment Num | Uniquely identifies a SHIPMENT. | No | Yes |
| | | The Shipment that the Piece is part of. | | |
| | Weight Meas | The weight requirements needed to transport this | No | No |
| | | PIECE, stated on the Bill of Lading. | | |
| PIECE CONTENT | Item Qty | The number of items associated with this PIECE. | No | No |
| | Item Qty UOM Cd | Uniquely identifies a unit of measure. | No | Yes |
| | | A Unit of Measure (UOM) code assigned to an | | |
| | | instance of the PIECE CONTENT entity. | | |
| | | The Item Qty Unit of Measure. | | |
| | Piece Num | Uniquely identifies a PIECE contained in a | Yes | Yes |
| | | SHIPMENT. | | |
| | | This can often be thought of as a “Tracking | | |
| | | Number” | | |
| | Shipment Line Num | The line number for this SHIPMENT. Each | Yes | Yes |
| | | SHIPMENT LINE ITEM has a sequential number | | |
| | | starting at one and going to ‘n’ where ‘n’ represents | | |
| | | the last SHIPMENT LINE ITEM associated with | | |
| | | this SHIPMENT. | | |
| | Shipment Num | Uniquely identifies a SHIPMENT. | Yes | Yes |
| PIT-BANK | Casino Id | Uniquely identifies a LOCATION. | Yes | Yes |
| | | A sub-type of LOCATION where customers VISIT | | |
| | | for gambling and entertainment. | | |
| | PitBank Num | Identifies an unique Pit or Bank. | Yes | No |
| | Zone Num | Uniquely identifies an area of interest within a | Yes | Yes |
| | | CASINO. | | |
| PLAN | Create Dt | The date the Plan was created. | No | No |
| | Creator Party Id | The unique identifier for any individual or group of | No | Yes |
| | | individuals that is of interest to the enterprise. | | |
| | | The Person or Organization that created the Plan. | | |
| | External Party Id | The unique identifier for any individual or group of | No | Yes |
| | | individuals that is of interest to the enterprise. | | |
| | | A Plan can be created based on the relationship | | |
| | | with a 3rd Party (Optional). | | |
| | | Example: | | |
| | | Sales Plan: How much are we planning to sell to an | | |
| | | important Customer | | |
| | | Transportation Plan: How do we plan to ship to a | | |
| | | specific Customer with specific Requirements. | | |
| | Plan Desc | Textual description of a PLAN. | No | No |
| | Plan Id | Uniquely identifies a PLAN. | Yes | No |
| PLAN SERVICE CLASS | Transport Svc Class Cd | Uniquely identifies a Transport Service Class. | Yes | Yes |
| PLAYER ALERT HIST | Alert End Dt | End of Alert date. | No | No |
| | Alert Start Dt | Alert effective date. | Yes | No |
| | Casino Player Id | The unique identifier for an individual. | Yes | Yes |
| | Player Alert Cd | Uniquely identifies a Player Alert. | Yes | Yes |
| | Reporting Party Id | The unique identifier for any individual or group of | No | Yes |
| | | individuals that is of interest to the enterprise. | | |
| | | The Party that reported/generated the alert. Could | | |
| | | be another Company, State Organization, etc. | | |
| PLAYER STATUS | Player Status Cd | Code that identifies the player development status. | Yes | No |
| | Player Status Desc | Description of the player's development status. | No | No |
| PNR | Actual Purge Dt | The date the PNR was purged. | No | No |
| | Agent Persona Id | Uniquely identifies an instance of a PERSONA. | No | Yes |
| | GDS Provider Id | The unique identifier for an external organization. | No | Yes |
| | Parent PNR Create Dt | The date on which the PNR that this one was split | No | Yes |
| | | from, was created | | |
| | Parent PNR Num | The original PNR from which this PNR was split | No | Yes |
| | | off. May be null. | | |
| | PNR Create Dt | The creation date of a PNR. This is needed to | Yes | No |
| | | uniquely identify a PNR, since PNR numbers are | | |
| | | re-used over time. | | |
| | PNR Num | Uniquely identifies a specific occurrence of a PNR. | Yes | No |
| | PNR Termination Dt | The date on which the PNR expires if no booking | No | No |
| | | takes place. | | |
| PNR BOOKING | Agent Persona Id | Uniquely identifies an instance of a PERSONA. | No | Yes |
| | | The person (Agent) working for a specific Travel | | |
| | | Agency or Travel Provider who created the PNR | | |
| | PNR Booking Effective Dt | The date when this PNR becomes valid. | Yes | No |
| | PNR Booking Source Txt | The source for this PNR text. | No | No |
| | PNR Booking Txt | The booking text associated with a PNR. | No | No |
| | PNR Create Dt | The creation date of a PNR. This is needed to | Yes | Yes |
| | | uniquely identify a PNR, since PNR numbers are | | |
| | | re-used over time. | | |
| | PNR Num | Uniquely identifies a specific occurrence of a PNR. | Yes | Yes |
| | POS Register Id | The unique identifier for an instance of the POS | No | Yes |
| | | REGISTER entity. | | |
| | | Identifies the physical device used at a | | |
| | | LOCATION to capture or create a business | | |
| | | transaction - typically a Terminal or Point of Sale | | |
| | | (POS) device used to enter the transaction. | | |
| | | This address will allow the enterprise to identify | | |
| | | who entered the transaction. This is important for | | |
| | | fraud detection and productivity tracking. | | |
| PNR FARE | Agent Persona Id | Uniquely identifies an instance of a PERSONA. | No | Yes |
| | | The person (Agent) working for a specific Travel | | |
| | | Agency or Travel Provider who created the PNR | | |
| | PNR Create Dt | The creation date of a PNR. This is needed to | Yes | Yes |
| | | uniquely identify a PNR, since PNR numbers are | | |
| | | re-used over time. | | |
| | PNR Fare Effective Dt | Date by when this PNR must be ticketed of the fare | Yes | No |
| | | expires. | | |
| | PNR Fare Num | The fare number associated with this PNR. | Yes | No |
| | PNR Fare Source Txt | The source for this PNR fare. | No | No |
| | PNR Fare Txt | The fare text associated with this PNR. | No | No |
| | PNR Fare Type Cd | The fare type code associated with this PNR (i.e. | Yes | No |
| | | Y, F, M, etc.) | | |
| | PNR Num | Uniquely identifies a specific occurrence of a PNR. | Yes | Yes |
| | POS Register Id | The unique identifier for an instance of the POS | No | Yes |
| | | REGISTER entity. | | |
| | | Identifies the physical device used at a | | |
| | | LOCATION to capture or create a business | | |
| | | transaction - typically a Terminal or Point of Sale | | |
| | | (POS) device used to enter the transaction. | | |
| | | This address will allow the enterprise to identify | | |
| | | who entered the transaction. This is important for | | |
| | | fraud detection and productivity tracking. | | |
| PNR MISCELLANEOUS | Header Effective Dt | Effective date of Header as recorded in PNR. | Yes | No |
| | Planned PNR Purge Dt | The date on which the PNR will be purged from | No | No |
| | | the operational system. | | |
| | PNR Create Dt | The creation date of a PNR. This is needed to | Yes | Yes |
| | | uniquely identify a PNR, since PNR numbers are | | |
| | | re-used over time. | | |
| | PNR Num | Uniquely identifies a specific occurrence of a PNR. | Yes | Yes |
| PNR PAYMENT | Agent Persona Id | Uniquely identifies an instance of a PERSONA. | No | Yes |
| | | The person (Agent) working for a specific Travel | | |
| | | Agency or Travel Provider who created the PNR | | |
| | Payment Num | Uniquely identifies a specific occurrence of a | Yes | No |
| | | payment. | | |
| | PNR Create Dt | The creation date of a PNR. This is needed to | Yes | Yes |
| | | uniquely identify a PNR, since PNR numbers are | | |
| | | re-used over time. | | |
| | PNR Num | Uniquely identifies a specific occurrence of a PNR. | Yes | Yes |
| | PNR Payment Effective Dt | Date the payment was received. | Yes | No |
| | PNR Payment Source Txt | The source for this PNR payment. | No | No |
| | PNR Payment Txt | The payment text associated with this PNR. | No | No |
| | POS Register Id | The unique identifier for an instance of the POS | No | Yes |
| | | REGISTER entity. | | |
| | | Identifies the physical device used at a | | |
| | | LOCATION to capture or create a business | | |
| | | transaction - typically a Terminal or Point of Sale | | |
| | | (POS) device used to enter the transaction. | | |
| | | This address will allow the enterprise to identify | | |
| | | who entered the transaction. This is important for | | |
| | | fraud detection and productivity tracking. | | |
| PNR REMARK | PNR Create Dt | The creation date of a PNR. This is needed to | Yes | Yes |
| | | uniquely identify a PNR, since PNR numbers are | | |
| | | re-used over time. | | |
| | PNR Num | Uniquely identifies a specific occurrence of a PNR. | Yes | Yes |
| | PNR Remark Effective Dt | Date the Remark was entered into the PNR. | Yes | No |
| | PNR Remark Num | Uniquely identifies a specific occurrence of a PNR | Yes | No |
| | | remark | | |
| | PNR Remark Source Txt | The source for this PNR remark. | No | No |
| | PNR Remark Txt | The remark text associated with this PNR. | No | No |
| | PNR Remark Type Cd | The code that identifies the meaning of the text in | Yes | No |
| | | this field of the PNR. | | |
| PO ACCRUE TYPE | PO Accrue Type Cd | A unique identifier for the accrual treatment of a | Yes | No |
| | | VENDOR PO. Examples: do not accrue, accrue on | | |
| | | receipt. | | |
| | PO Accrue Type Desc | A textual description for a PO ACCRUE TYPE. | No | No |
| PO DELIVERY RELEASE | PO Delivery Release Auth Dttm | The date on which the entemrise gave release | No | No |
| | | authorization for the Delivery Release Line | | |
| | | Authorization Qty. | | |
| | PO Delivery Release Id | The unique identifier for a PO DELIVERY | Yes | No |
| | | RELEASE. | | |
| | PO Delivery Release Type Cd | Describes whether release is for a blanket or | No | Yes |
| | | planned purchase order. Possible values are | | |
| | | therefore “Blanket” or “Planned”. | | |
| | PO Delivery Relse Auth Doc Num | A number identifying a document that represents | No | No |
| | | the authorization for a PO DELIVERY RELEASE. | | |
| | PO Delivry Promised Ship Dttm | The date and time that this delivery is scheduled to | No | No |
| | | be shipped. | | |
| | PO Delivry Rel USSGL Trans Cd | The code assigned to a USSGL TRANSACTION | No | Yes |
| | | TYPE. | | |
| | PO Delivry Transmital Mode Cd | The code for a TRANSMITTAL MODE. | No | Yes |
| PO DELIVERY RELEASE LINE | PO Delivery Release Id | The unique identifier for a PO DELIVERY | Yes | Yes |
| ITEM | | RELEASE. | | |
| | PO Delivry Rel Ln Itm Auth Qty | The quantity of PRODUCT that has been | No | No |
| | | authorized for release. | | |
| | PO Delivry Rel Ln Itm Num | A number representing a single line item on a PO | Yes | No |
| | | DELIVERY RELEASE LINE ITEM. | | |
| | PO Delivry Rel Ln Itm Req Dttm | The date on which the PRODUCT delivery has | No | No |
| | | been requested on a PO DELIVERY RELEASE | | |
| | | LINE ITEM. | | |
| PO DELIVERY RELEASE | PO Delivery Release Id | The unique identifier for a PO DELIVERY | Yes | Yes |
| STATUS | | RELEASE. | | |
| | PO Delivry Rel Ln Itm Num | A number representing a single line item on a PO | Yes | Yes |
| | | DELIVERY RELEASE LINE ITEM. | | |
| | PO Delivry Rel Status Reasn Cd | The code assigned to a PO RELEASE STATUS | No | Yes |
| | | REASON TYPE. | | |
| | PO Delivry Release Status Dttm | The date and time a PARTY created the PO | Yes | No |
| | | DELIVERY RELEASE STATUS. | | |
| | PO Delivry Status Party Id | The unique identifier for any individual or group of | No | Yes |
| | | individuals that is of interest to the enterprise. | | |
| | | The Id of the PO DELIVERY RELEASE STATUS | | |
| | | Party. | | |
| | PO Release Status Type Cd | The code assigned to a PO Release Party Status | Yes | Yes |
| | | Type. | | |
| PO LINE DELIVERY RELEASE | PO Delivery Release Id | The unique identifier for a PO DELIVERY | Yes | Yes |
| LINE | | RELEASE. | | |
| | PO Delivry Rel Ln Itm Num | A number representing a single line item on a PO | Yes | Yes |
| | | DELIVERY RELEASE LINE ITEM. | | |
| | PO Line Delivery Rel Line Qty | The quantity of VENDOR PO LINE released for | No | No |
| | | delivery by a PO DELIVERY RELEASE LINE | | |
| | | ITEM. | | |
| | Vend PO Ln Num | A number representing a unique line on a | Yes | Yes |
| | | VENDOR PO LINE. | | |
| | Vendor PO Id | The unique identifier of a specific VENDOR PO. | Yes | Yes |
| PO LINE RETURN XREF | Return Qty | The actual Item PO quantity being returned. | No | No |
| | Vendor PO Id | Unique identifier for a VENDOR PURCHASE | Yes | Yes |
| | | ORDER. | | |
| | Vendor PO Line Num | The VENDOR PURCHASE ORDER LINE | Yes | Yes |
| | | number. | | |
| | Vendor Return Id | Uniquely identifies a Return. | Yes | Yes |
| | Vendor Return Line Num | Identifies a specific Line Item within a Vendor | Yes | Yes |
| | | Return | | |
| PO RELEASE STATUS REASON | PO Rel Status Reason Type Cd | The code assigned to a PO RELEASE STATUS | Yes | No |
| TYPE | | REASON TYPE. | | |
| | PO Rel Status Reason Type Desc | The description of the PO RELEASE STATUS | No | No |
| | | REASON TYPE. | | |
| PO RELEASE STATUS TYPE | PO Release Status Type Cd | The code assigned to a PO RELEASE STATUS | Yes | No |
| | | TYPE. | | |
| | PO Release Status Type Desc | The description of a PO RELEASE STATUS | No | No |
| | | TYPE. | | |
| PO REQUISITION | PO Requisition End Dttm | The calendar date and time on which a PO | No | No |
| | | REQUISITION relationship ended. | | |
| | PO Requisition Start Dttm | The calendar date and time on which a PO | Yes | No |
| | | REQUISITION relationship started. | | |
| | Purchase Requisition Id | The unique identifier for a PURCHASE | Yes | Yes |
| | | REQUISITION. | | |
| | Vendor PO Id | The unique identifier of a specific VENDOR PO. | Yes | Yes |
| PO TERM | PO term Currency Cd | The code assigned to a CURRENCY. | No | Yes |
| | PO Term End Dttm | The date and time a specific PO TERM became | No | No |
| | | invalid for current use. | | |
| | PO Term Id | The unique identifier for a PO TERM. | Yes | No |
| | PO Term Monetary Amt | The monetary amount associated with Terms such | No | No |
| | | as all payment terms, penalty terms, discount | | |
| | | terms, etc. | | |
| | PO Term Pct | The Percent associated with Terms such as all | No | No |
| | | payment terms, penalty terms, discount terms, etc. | | |
| | PO Term Qty | The Quantity associated with Terms such as all | No | No |
| | | payment terms, penalty terms, discount terms, etc. | | |
| | PO Term Start Dttm | The date and time a specific PO TERM became | Yes | No |
| | | valid for current use. | | |
| | PO Term Type Cd | The code for a PO TERM TYPE. | No | Yes |
| | PO Term UOM Cd | Uniquely identifies a unit of measure. | No | Yes |
| | | The code assigned to the unit of measure for the | | |
| | | PO TERM Qty. | | |
| PO TERM TYPE | PO Term Type Cd | The code for a PO TERM TYPE. | Yes | No |
| | PO Term Type Desc | The description for a PO TERM TYPE. | No | No |
| POKER SESSION | House Cut Amt | The amount of money that the CASINO keeps to | No | No |
| | | itself. | | |
| | Poker Avg Bet Amt | The average amount of bet for the complete | No | No |
| | | POKER SESSION, across all individual bets | | |
| | Poker Total Bet Amt | The total amount of bets in a POKER SESSION | No | No |
| | Session Start Dttm | The start of a rated gaming session (that is, a | Yes | Yes |
| | | gaming session where the identity of the player is | | |
| | | known). | | |
| | Visit Id | The unique identifier for an instance of the VISIT | Yes | Yes |
| | | entity. | | |
| POLLED GAMING PERIOD | Actual Player Win Amt DD | The total net amount won by the player. | No | No |
| | | This can be calculated by subtracting the total buy- | | |
| | | in amount from the total payout amount. | | |
| | | This amount can be negative or positive. | | |
| | Avg Bet Amt DD | The average size of bet made by the player during | No | No |
| | | the session. | | |
| | | Can be calculated by dividing the Turnover amount | | |
| | | by the number of rounds played. | | |
| | Buy-In Amt | The total amount the player presents to wager with. | No | No |
| | | Note: This is not the same as the wagered amount, | | |
| | | since the entire buy-in amount can usually be | | |
| | | retracted by the player prior to, or instead of | | |
| | | placing it at risk. | | |
| | | Also known as coin-in, drop, etc., depending on | | |
| | | game type. | | |
| | Game Config Id | Uniquely identifies a specific Game Configuration. | No | Yes |
| | Game Station Instance Id | Uniquely identifies a Game Station Instance. | Yes | Yes |
| | Jackpot Amt | The total amount of jackpots won by the player. | No | No |
| | Jackpot Cnt | The number of jackpots won by the player. | No | No |
| | Max Bet Amt | The largest bet made by the player during the | No | No |
| | | session. | | |
| | Min Bet Amt | The smallest bet made by the player during the | No | No |
| | | session. | | |
| | Payout Amt | The total amount paid out to the player. | No | No |
| | | Note: To get the net player win/loss, this amount | | |
| | | need to be subtracted from the buy-in amount. | | |
| | Polling End Dttm | Date and time that the polling ended. | No | No |
| | Polling Start Dttm | Date and time that the polling started. | Yes | No |
| | Rounds Played Cnt | The number of hands, rounds, or games played. | No | No |
| | | Could also be called spins, throws, etc. depending | | |
| | | on the game type. | | |
| | Slot Hand Pay Amt | The total Payout amount that had to manually | No | No |
| | | dispensed (not paid by the machine). | | |
| | | This happens typically due to jackpots (legal | | |
| | | purposes), or where the machine had insufficient | | |
| | | money to dispense. | | |
| | | Used mainly for Slot games. | | |
| | Slot Hopper Fill Amt | The total amount of money placed into the machine | No | No |
| | | by the Casino. | | |
| | | Used mainly for Slot games. | | |
| | Table Avg Player Cnt | The number of players (on average) per round | No | No |
| | | during the session. | | |
| | | Used mainly for Table games. | | |
| | Theo Player Win Amt DD | Using the theoretical win percentages and the | No | No |
| | | turnover amount, we can calculate the amount the | | |
| | | player “should” have won in theory. | | |
| | | This amount can be negative or positive. | | |
| | Turnover Amt | This is the total amount actually wagered (or | No | No |
| | | placed at risk) by the player. | | |
| | | Note that this amount can greatly exceed the buy-in | | |
| | | amount. | | |
| | | Also known as Handle, Gross (or Total) Wager | | |
| | | Amount, etc., depending on game type. | | |
| POLLED GAMING ROUND | Game Station Instance Id | Uniquely identifies a Game Station Instance. | Yes | Yes |
| | Jackpot Amt | Used if pan (or all) of the Player win amount was | No | No |
| | | as result of a Jackpot). | | |
| | Player Win Amt | Money won by the Player for this round (can be | No | No |
| | | negative). | | |
| | Polling Start Dttm | Date and time that the polling started. | Yes | Yes |
| | Round End Dttm | Timestamp for the end of the round. | No | No |
| | Round Num | Uniquely identifies a Round played within a | Yes | No |
| | | Session. Also called hand, game, spin, throw, etc. | | |
| | | depending on the game type. | | |
| | Round Start Dttm | Timestamp for the start of the round. | No | No |
| | Wager Add Amt | Some games allow the Player to add to their initial | No | No |
| | | wager during the round/game/hand. This attribute | | |
| | | captures that. | | |
| | | Example: | | |
| | | Doubling down in blackjack | | |
| | | etc. | | |
| | Wager Amt | Money wagered this round. | No | No |
| | Wager Cnt | The number of Wagers made in a Round. | No | No |
| | | Example: | | |
| | | a player plays 3 hands during a blackjack game | | |
| | | a player plays 5 lines on a slot machine | | |
| POS REGISTER | Location Id | Uniquely identifies a LOCATION. | No | Yes |
| | POS Register Desc | Narrative text describing the POS REGISTER. | No | No |
| | POS Register Id | Unique identifier for the POS REGISTER. | Yes | No |
| POS REGISTER DINING EVENT | Dining Transaction Id | A unique identifier for this TRAVEL | No | Yes |
| | | TRANSACTION. | | |
| | Dining Transaction Line Num | Identifies a specific line within the DINING | No | Yes |
| | | TRANSACTION | | |
| | POS Register Event Id | Unique identifier for the POS REGISTER EVENT. | Yes | Yes |
| | POS Register Id | Unique identifier for the POS REGISTER. | Yes | Yes |
| POS REGISTER EVENT | POS Operator Associate Id | An individual who is employed by the enterprise. | No | Yes |
| | | This is the ASSOCIATE who signs onto the Point- | | |
| | | of-Sale Terminal and acts as operator until sign-off. | | |
| | POS Register Event Id | Unique identifier for the POS REGISTER EVENT. | Yes | No |
| | POS Register Event Type Cd | Uniquely identifies the POS REGISTER EVENT | No | Yes |
| | | TYPE. | | |
| | POS Register Id | Unique identifier for the POS REGISTER. | Yes | Yes |
| | Register Event Dttm | The date and time on which a POS REGISTER | No | No |
| | | EVENT occurred. | | |
| POS REGISTER EVENT TYPE | POS Register Event Type Cd | Uniquely identifies the POS REGISTER EVENT | Yes | No |
| | | TYPE. | | |
| | POS Register Event Type Desc | Narrative text describing the POS REGISTER | No | No |
| | | EVENT TYPE. | | |
| POSITION | Casino Id | Uniquely identifies a LOCATION. | Yes | Yes |
| | | A sub-type of LOCATION where customers VISIT | | |
| | | for gambling and entertainment. | | |
| | PitBank Num | Identifies an unique Pit or Bank. | Yes | Yes |
| | Position Num | Uniquely identifies a specific Position within a Pit | Yes | No |
| | | or Bank. | | |
| | Zone Num | Uniquely identifies an area of interest within a | Yes | Yes |
| | | CASINO. | | |
| POSITION GRADE | Position Grade Cd | Uniquely identifies a POSITION GRADE. | Yes | No |
| | Position Grade Desc | Narrative text describing the POSITION GRADE. | No | No |
| POSITION TYPE | Position Type Cd | Uniquely identifies a POSITION TYPE. | Yes | No |
| | Position Type Desc | Narrative text describing the POSITION TYPE. | No | No |
| POSTAL CODE | Country Cd | The unique code for an instance of the COUNTRY | Yes | Yes |
| | | entity. | | |
| | County Cd | The unique code for an instance of the COUNTY | No | Yes |
| | | entity. | | |
| | Postal Cd | A unique code for an instance of the POSTAL | Yes | No |
| | | CODE entity. | | |
| | Transport Zone Cd | The unique identifier for an instance of the ZONE | No | Yes |
| | | entity. | | |
| | | The Postal Code Zone | | |
| POWER EQUIP | Equip Id OIN | Uniquely identifies an Equipment Instance. | Yes | Yes |
| PREFERENCE | Preference Cd | The identifier for a personal customer preference. | Yes | No |
| | Preference Desc | A textual description of each personal | No | No |
| | | PREFERENCE. | | |
| | Preference Group Cd | The high level grouping for categorizing customer | No | Yes |
| | | preferences data. | | |
| PREFERENCE GROUP | Preference Group Cd | The high level qualifier for categorizing customer | Yes | No |
| | | preferences data. | | |
| | Preference Group Desc | A textual description of each Customer Preference | No | No |
| | | group used to categorize collected data about | | |
| | | customer preferences. | | |
| PREFERENCE VALUE | Preference Cd | The identifier for a personal customer preference. | Yes | Yes |
| | Preference Value Cd | A code that indicates the preference for this | Yes | No |
| | | PARTY. | | |
| | Preference Value Desc | Indicates the description for this code | No | No |
| PREFERRED STOCK ACCOUNT | GL Main Account Num | The unique Chart of Account code for the GL | Yes | Yes |
| | | MAIN ACCOUNT. | | |
| | Preferred Shares Outstndng Qty | The number of PREFERRED STOCK shares of a | No | No |
| | | corporation. | | |
| PREPAID EXPENSE ACCOUNT | GL Main Account Num | The unique Chart of Account code for the GL | Yes | Yes |
| | | MAIN ACCOUNT. | | |
| | Prepaid Expense Party Id | The unique identifier for any individual or group of | No | Yes |
| | | individuals that is of interest to the enterprise. | | |
| | | The PARTY to whom this prepaid expense was | | |
| | | made. | | |
| PRICE CHANGE REASON | Price Change Reason Cd | Uniquely identifies a Price Change Reason. | Yes | No |
| | Price Change Reason Desc | Narrative text describing the reason for the price | No | No |
| | | change. | | |
| PRINT AD | Print Ad Id | The unique identifier for an ad. | Yes | Yes |
| | | Typically in printed media such as magazine or | | |
| | | newspaper, etc. | | |
| PRIVACY CATEGORY | Privacy Category Cd | Uniquely identifies the category of privacy data. | Yes | No |
| | Privacy Category Desc | A textual description of the category code. | No | No |
| PRIVACY DATA | Privacy Category Cd | Uniquely identifies the category of privacy data. | No | Yes |
| | Privacy Data Cd | Uniquely identifies the privacy data. | Yes | No |
| | Privacy Data Desc | A textual description of the data. | No | No |
| PRIVACY DATA TRANSFER | Privacy Data Cd | Uniquely identifies the privacy data. | No | Yes |
| | Privacy Data Receipt Party Id | The party who receives the privacy data. | Yes | Yes |
| | Privacy Data Subject Party Id | The party to whom the transferred privacy data | Yes | Yes |
| | | applies. | | |
| | Privacy Data Transfer Dttm | The date on which the privacy data was transferred | No | No |
| | | to a party. | | |
| | Privacy Data Transfer Num | Uniquely identifies a party's personal data. This is | Yes | No |
| | | handled like a line number as in purchase orders - | | |
| | | one line number for each preference. | | |
| | Privacy Data Usage Cd | Uniquely identifies the usage of privacy data. | No | Yes |
| PRIVACY DATA USAGE | Privacy Data Usage Cd | Uniquely identifies the usage of privacy data. | Yes | No |
| | Privacy Data Usage Desc | A textual description of the data usage. | No | No |
| PRIVACY POLICY SCOPE | Privacy Policy Scope Cd | Uniquely identifies the privacy policy scope. | Yes | No |
| | Privacy Policy Scope Desc | A textual description for a privacy policy scope. | No | No |
| PRIVACY PRESET | Privacy Data Cd | Uniquely identifies the privacy data. | No | Yes |
| | Privacy Data Usage Cd | Uniquely identifies the usage of privacy data. | No | Yes |
| | Privacy Policy Scope Cd | Uniquely identifies the privacy policy scope. | Yes | Yes |
| | Privacy Preset Mandated Ind | If a preference chosen by a party must be | No | No |
| | | overridden by the preset value then this attribute is | | |
| | | set to “Y”. Otherwise it is set to “N”. | | |
| | | In this latter case it is presumed that the party's | | |
| | | preference indicator could or would override the | | |
| | | preset preference indicator. | | |
| | | This permits overriding a party's preference for | | |
| | | reasons of, for example, government mandates or | | |
| | | company policy. | | |
| | Privacy Preset Num | Uniquely identifies a privacy preset. This is | Yes | No |
| | | handled like a line number as in purchase orders - | | |
| | | one line number for each preset. | | |
| | Privacy Preset Party Id | The party (person, organization, etc.) that | Yes | Yes |
| | | establishes or authorizes the privacy default preset. | | |
| | | This is not the party to whom the preset will apply. | | |
| | Privacy Preset Preference Ind | The preset privacy preference. Examples: Y - the | No | No |
| | | information is protected and private; N - the | | |
| | | information is not protected. | | |
| PRODUCT CONFORMANCE | GL Sub Account Num | The unique Chart of Account code for the GL SUB | Yes | Yes |
| ACCT | | ACCOUNT. | | |
| PRODUCT PROVIDER | Product Provider Id | The unique identifier for an external organization. | Yes | Yes |
| | | Identifies the Organization that provides a Product. | | |
| | Product Provider Type Cd | A code that identifies a sub type of the PRODUCT | No | Yes |
| | | PROVIDER entity. | | |
| | | Example: 1- Passenger Travel Provider, 2- Car | | |
| | | Rental Provider, 3- Lodging Provider, etc. | | |
| PRODUCT PROVIDER TYPE | Product Provider Type Cd | A code that identifies a sub type of the PRODUCT | Yes | No |
| | | PROVIDER entity. | | |
| | | Example: 1- Passenger Travel Provider, 2- Car | | |
| | | Rental Provider, 3- Lodging Provider, etc. | | |
| | Product Provider Type Desc | A textual description of a sub type of the | No | No |
| | | PRODUCT PROVIDER entity. | | |
| | | Example: Passenger Travel Provider, Car Rental | | |
| | | Provider, Lodging Provider, etc. | | |
| PROGRESSIVE GAME | Progressive Game Id | Uniquely identifies a Progressive Game. | Yes | No |
| | Progressive Game Name | Textual Name of a Progressive Game. | No | No |
| | Progressive Type Cd | Uniquely identifies a type of Progressive Game. | No | Yes |
| PROGRESSIVE TYPE | Progressive Type Cd | Uniquely identifies a type of Progressive Game. | Yes | No |
| | Progressive Type Desc | Textual description of a Progressive Game Type. | No | No |
| PROJECT | Project Billable Type Cd | The unique code assigned to a PROJECT | No | Yes |
| | | BILLABLE TYPE. | | |
| | Project Classification Type Cd | The unique code assigned to a PROJECT | No | Yes |
| | | CLASSIFICATION TYPE. | | |
| | Project Desc | The description for the PROJECT. | No | No |
| | Project Id | The unique identifier for the PROJECT. | Yes | No |
| | Project Name | The name for a PROJECT. | No | No |
| | Project Num | Designator assigned to PROJECT in project | No | No |
| | | accounting system. | | |
| | Project Plan End Dttm | The calendar date and time the PROJECT ended. | No | No |
| | Project Plan Start Dttm | The calendar date and time a PROJECT started. | No | No |
| | Project Type Cd | The unique code assigned to a PROJECT TYPE. | No | Yes |
| PROJECT BILLABLE TYPE | Project Billable Type Cd | The unique code assigned to a PROJECT | Yes | No |
| | | BILLABLE TYPE. | | |
| | Project Billable Type Desc | The description for a PROJECT BILLABLE TYPE | No | No |
| | | code. | | |
| PROJECT CLASSIFICATION | Project Classification Type Cd | The unique code assigned to a PROJECT | Yes | No |
| TYPE | | CLASSIFICATION TYPE. | | |
| | Project Classificatn Type Desc | The description for a PROJECT | No | No |
| | | CLASSIFICATION TYPE. | | |
| PROJECT FINANCIAL PLAN | Financial Plan Id | The unique identifier assigned to the FINANCIAL | Yes | Yes |
| | | PLAN. | | |
| | Project Id | The unique identifier for the PROJECT. | Yes | Yes |
| PROJECT PARTY | Party Project Role Cd | The code assigned to a PARTY PROJECT ROLE. | Yes | Yes |
| | Project Id | The unique identifier for the PROJECT. | Yes | Yes |
| | Project Party End Dttm | The calendar date and time on which a PARTY | No | No |
| | | ended an association with a PROJECT. | | |
| | Project Party Id | The unique identifier for any individual or group of | Yes | Yes |
| | | individuals that is of interest to the enterprise. | | |
| | | The unique identifier for a PARTY related to a | | |
| | | project role. | | |
| | Project Party Start Dttm | The calendar date and time on which a PARTY | Yes | No |
| | | began an association with a PROJECT. | | |
| PROJECT RESOURCE FIXED | Fixed Asset Id | The unique identifier for a FIXED ASSET. | No | Yes |
| ASSET | | | | |
| | Proj Task Resource Id | The unique identifier assigned to a Project Task | Yes | Yes |
| | | Resource. | | |
| | Proj Task Resource Start Dttm | The calendar date and time a PROJECT TASK | Yes | Yes |
| | | RESOURCE ASSIGN started. | | |
| | Project Id | The unique identifier for the PROJECT. | Yes | Yes |
| | Project Task Start Dttm | The calendar date and time a PROJECT TASK | Yes | Yes |
| | | started. | | |
| | Task Id | The unique identifier assigned to a TASK. | Yes | Yes |
| PROJECT STATUS | Project Status Cd | The code assigned to the PROJECT STATUS. | Yes | No |
| | | Example: | | |
| | | disputed invoice | | |
| | | in process | | |
| | | completed | | |
| | | hold | | |
| | | accepted. | | |
| | Project Status Desc | The description for a PROJECT STATUS. | No | No |
| PROJECT STATUS ASSIGN | Proj Status Assign End Dttm | The calendar date and time a Project Status ended. | No | No |
| | Proj Status Assign Party Id | The unique identifier for any individual or group of | No | Yes |
| | | individuals that is of interest to the enterprise. | | |
| | | The id of the party who assigned the Project Status. | | |
| | Proj Status Assign Start Dttm | The calendar date and time a Project Status started. | Yes | No |
| | Project Id | The unique identifier for the PROJECT. | Yes | Yes |
| | Project Status Cd | The code assigned to the PROJECT STATUS. | Yes | Yes |
| | | Example: | | |
| | | disputed invoice | | |
| | | in process | | |
| | | completed | | |
| | | hold | | |
| | | accepted. | | |
| PROJECT TASK | Project Id | The unique identifier for the PROJECT. | Yes | Yes |
| | Project Task Billable Type Cd | Project Task Billable Type Cd is the code that | No | Yes |
| | | indicates whether a PROJECT is billable or non- | | |
| | | billable. | | |
| | Project Task Duration Qty | Project Task Duration Qty refers to the amount of | No | No |
| | | time that a TASK has been in progress. | | |
| | Project Task Duration UOM Cd | Uniquely identifies a unit of measure. | No | Yes |
| | | Project Task Duration UOM Cd is the code that | | |
| | | represents the UOM associated with a task | | |
| | | duration. For example, the task duration quantity | | |
| | | may be in hours, days, or weeks. | | |
| | Project Task End Dttm | The calendar date and time a PROJECT TASK | No | No |
| | | ended. | | |
| | Project Task Location Id | Uniquely identifies a LOCATION. | No | Yes |
| | | The Id of the location associated with a PROJECT | | |
| | | TASK | | |
| | Project Task Start Dttm | The calendar date and time a PROJECT TASK | Yes | No |
| | | started. | | |
| | Task Id | The unique identifier assigned to a TASK. | Yes | Yes |
| | Task Work Breakdown Level Num | The Project Task Work Breakdown Structure | No | No |
| | | (WBS) Level Num identifies the TASK's unique | | |
| | | place in the structure of a PROJECT. WBS is the | | |
| | | hierarchy of tasks in a PROJECT. | | |
| PROJECT TASK CHART OF | Proj Task Resource Id | The unique identifier assigned to a Project Task | Yes | Yes |
| ACCOUNT | | Resource. | | |
| | Proj Task Resource Start Dttm | The calendar date and time a PROJECT TASK | Yes | Yes |
| | | RESOURCE ASSIGN started. | | |
| | Project Id | The unique identifier for the PROJECT. | Yes | Yes |
| | Project Task COA End Dttm | The date and time the assignment of a CHART OF | No | No |
| | | ACCOUNT number to a PROJECT TASK ended. | | |
| | Project Task COA Id | The unique identifier for a CHART OF | Yes | Yes |
| | | ACCOUNT, or alias for a complete CHART OF | | |
| | | ACCOUNTs number. | | |
| | Project Task COA Start Dttm | The date and time the assignment of a CHART OF | Yes | No |
| | | ACCOUNT number to a PROJECT TASK started. | | |
| | Project Task Start Dttm | The calendar date and time a PROJECT TASK | Yes | Yes |
| | | started. | | |
| | Task Id | The unique identifier assigned to a TASK. | Yes | Yes |
| PROJECT TASK FINANCIAL | Financial Plan Id | The unique identifier assigned to the FINANCIAL | Yes | Yes |
| PLAN | | PLAN. | | |
| | Project Id | The unique identifier for the PROJECT. | Yes | Yes |
| | Project Task Start Dttm | The calendar date and time the Project Task started. | Yes | Yes |
| | Task Id | The unique identifier assigned to a TASK. | Yes | Yes |
| PROJECT TASK RELATED | Proj Task Related End Dttm | The date and time the PROJECT TASK | No | No |
| | | Relationship ended. | | |
| | Proj Task Related Start Dttm | The date and time the PROJECT TASK | Yes | No |
| | | relationship started. | | |
| | Project Id | The unique identifier for the PROJECT. | Yes | Yes |
| | Project Task Related Type Cd | The code assigned to a PROJECT TASK | Yes | Yes |
| | | RELATED TYPE. | | |
| | Project Task Start Dttm | The calendar date and time a PROJECT TASK | Yes | Yes |
| | | started. | | |
| | Related Project Id | The unique identifier for the PROJECT. | Yes | Yes |
| | Related Project Tsk Start Dttm | The calendar date and time a PROJECT TASK | Yes | Yes |
| | | started. | | |
| | Related Task Id | The unique identifier assigned to a TASK. | Yes | Yes |
| | Task Id | The unique identifier assigned to a TASK. | Yes | Yes |
| PROJECT TASK RELATED | Project Task Related Type Cd | The code assigned to a PROJECT TASK | Yes | No |
| TYPE | | RELATED TYPE. | | |
| | Project Task Related Type Desc | The description for a PROJECT TASK RELATED | No | No |
| | | TYPE. | | |
| PROJECT TASK RESOURCE | Proj Task Resource Desc | The description for a Resource assigned to a | No | No |
| ASSIGN | | PROJECT TASK. | | |
| | Proj Task Resource End Dttm | The calendar date and time a PROJECT TASK | No | No |
| | | RESOURCE ASSIGN ended. | | |
| | Proj Task Resource Id | The unique identifier representing a Resource | Yes | No |
| | | assigned to a PROJECT TASK. | | |
| | Proj Task Resource Name | The name of a Resource assigned to a PROJECT | No | No |
| | | TASK. | | |
| | Proj Task Resource Start Dttm | The calendar date and time a PROJECT TASK | Yes | No |
| | | RESOURCE ASSIGN started. | | |
| | Proj Task Resource Type Cd | The code assigned to a PROJECT TASK | No | Yes |
| | | RESOURCE TYPE. | | |
| | Project Id | The unique identifier for the PROJECT. | Yes | Yes |
| | Project Task Start Dttm | The calendar date and time a PROJECT TASK | Yes | Yes |
| | | started. | | |
| | Task Id | The unique identifier assigned to a TASK. | Yes | Yes |
| PROJECT TASK RESOURCE | Proj Task Resource Id | The unique identifier assigned to a Project Task | Yes | Yes |
| INDIVDL | | Resource. | | |
| | Proj Task Resource Start Dttm | The calendar date and time a PROJECT TASK | Yes | Yes |
| | | RESOURCE ASSIGN started. | | |
| | Project Id | The unique identifier for the PROJECT. | Yes | Yes |
| | Project Task Start Dttm | The calendar date and time a PROJECT TASK | Yes | Yes |
| | | started. | | |
| | Task Id | The unique identifier assigned to a TASK. | Yes | Yes |
| PROJECT TASK RESOURCE | Proj Task Resource Id | The unique identifier assigned to a Project Task | Yes | Yes |
| ITEM | | Resource. | | |
| | Proj Task Resource Start Dttm | The calendar date and time a PROJECT TASK | Yes | Yes |
| | | RESOURCE ASSIGN started. | | |
| | Project Id | The unique identifier for the PROJECT. | Yes | Yes |
| | Project Item Burden Cost Rate | The burden rate per unit of measure assigned to the | No | No |
| | | PROJECT TASK RESOURCE ITEM. | | |
| | Project Task Item Bill Rate | The billing rate assigned to the PROJECT TASK | No | No |
| | | RESOURCE ITEM. | | |
| | Project Task Item Cost Rate | The cost rate assigned to the PROJECT TASK | No | No |
| | | RESOURCE ITEM. | | |
| | Project Task Item Curncy Cd | The code assigned to a transaction CURRENCY. | No | Yes |
| | Project Task Item Qty | The quantity associated with the PROJECT TASK | No | No |
| | | RESOURCE ITEM, such as hours of machine | | |
| | | time. | | |
| | Project Task Item Type Cd | The code associated with a PROJECT TASK | No | Yes |
| | | RESOURCE ITEM. | | |
| | Project Task Item UOM Cd | Uniquely identifies a unit of measure. | No | Yes |
| | | The unit of measure associated with the quantity | | |
| | | for a PROJECT TASK RESOURCE ITEM. | | |
| | Project Task Start Dttm | The calendar date and time a PROJECT TASK | Yes | Yes |
| | | started. | | |
| | Task Id | The unique identifier assigned to a TASK. | Yes | Yes |
| PROJECT TASK RESOURCE | Project Task Item Type Cd | The code for an Item assigned as a PROJECT | Yes | No |
| ITM TYPE | | TASK RESOURCE ITEM. | | |
| | Project Task Item Type Desc | Describes the code for an Item assigned as a | No | No |
| | | PROJECT TASK RESOURCE ITEM. | | |
| PROJECT TASK RESOURCE | Party Project Task Role Cd | The code assigned to the role of an associate that is | Yes | Yes |
| PARTY | | on a PROJECT. | | |
| | Proj Task Resource Id | The unique identifier assigned to a Project Task | Yes | Yes |
| | | Resource. | | |
| | Proj Task Resource Start Dttm | The calendar date and time a PROJECT TASK | Yes | Yes |
| | | RESOURCE ASSIGN started. | | |
| | Proj Tsk Resrce Bill Rate | The monetary amount representing the billable rate | No | No |
| | | related to a PROJECT TASK RESOURCE | | |
| | | PARTY. | | |
| | Proj Tsk Resrce Brdn Cost Rate | The monetary amount representing the burden or | No | No |
| | | overhead cost rate related to a PROJECT TASK | | |
| | | RESOURCE PARTY. | | |
| | Proj Tsk Resrce Cost Rate | The monetary amount representing the direct cost | No | No |
| | | rate related to a PROJECT TASK RESOURCE | | |
| | | PARTY. | | |
| | Proj Tsk Resrce Crncy Cd | The code assigned to a CURRENCY. | No | Yes |
| | Proj Tsk Resrce Party End Dttm | The date on which an ASSOCIATE ended an | No | No |
| | | association with a PROJECT. | | |
| | Proj Tsk Resrce Party Qty | The Quantity associated with a PARTY assigned as | No | No |
| | | a resource to a PROJECT TASK. | | |
| | Proj Tsk Resrce Party UOM Cd | Uniquely identifies a unit of measure. | No | Yes |
| | | The code assigned to the unit of measure for the | | |
| | | Project Task Resource Qty. For example, UOM | | |
| | | could be Hours, Days or Weeks. | | |
| | Proj Tsk Resrce Start Dttm | The date on which an ASSOCIATE began an | Yes | No |
| | | association with a PROJECT. | | |
| | Project Id | The unique identifier for the PROJECT. | Yes | Yes |
| | Project Task Resource Party Id | The unique identifier for any individual or group of | Yes | Yes |
| | | individuals that is of interest to the enterprise. | | |
| | | In this case, the PARTY related to a project role. | | |
| | Project Task Start Dttm | The calendar date and time a PROJECT TASK | Yes | Yes |
| | | started. | | |
| | Task Id | The unique identifier assigned to a TASK. | Yes | Yes |
| PROJECT TASK RESOURCE | Item Id | Uniquely identifies an item. Typically system | No | Yes |
| PROD | | assigned. | | |
| | | The unique Id associated with an Item or Product | | |
| | | assigned to a PROJECT TASK. | | |
| | Proj Task Resource Id | The unique identifier assigned to a Project Task | Yes | Yes |
| | | Resource. | | |
| | Proj Task Resource Start Dttm | The calendar date and time a PROJECT TASK | Yes | Yes |
| | | RESOURCE ASSIGN started. | | |
| | Project Id | The unique identifier for the PROJECT. | Yes | Yes |
| | Project Task Start Dttm | The calendar date and time a PROJECT TASK | Yes | Yes |
| | | started. | | |
| | Task Id | The unique identifier assigned to a TASK. | Yes | Yes |
| PROJECT TASK RESOURCE | Inventory Item Id | Uniquely identifies an item. Typically system | No | Yes |
| SUPPLS | | assigned. | | |
| | | The unique Id for supplies in inventory and | | |
| | | assigned as a resource to a PROJECT TASK. | | |
| | Proj Task Resource Id | The unique identifier assigned to a Project Task | Yes | Yes |
| | | Resource. | | |
| | Proj Task Resource Start Dttm | The calendar date and time a PROJECT TASK | Yes | Yes |
| | | RESOURCE ASSIGN started. | | |
| | Project Id | The unique identifier for the PROJECT. | Yes | Yes |
| | Project Task Start Dttm | The calendar date and time a PROJECT TASK | Yes | Yes |
| | | started. | | |
| | Task Id | The unique identifier assigned to a TASK. | Yes | Yes |
| PROJECT TASK RESOURCE | Proj Task Resource Type Desc | The description of a PROJECT TASK | No | No |
| TYPE | | RESOURCE TYPE. | | |
| | Project Task Resource Type Cd | The code assigned to a PROJECT TASK | Yes | No |
| | | RESOURCE TYPE. | | |
| PROJECT TASK STATUS | Proj Task Est Completion Pct | Estimated Completion Pct holds a percentage value | No | No |
| ASSIGN | | that reflects the current status of a TASK, based on | | |
| | | the work completed. | | |
| | Proj Task Status End Dttm | The calendar date and time a PROJECT TASK | No | No |
| | | STATUS ASSIGN ended. | | |
| | Proj Task Status Party Id | The unique identifier for any individual or group of | No | Yes |
| | | individuals that is of interest to the enterprise. | | |
| | | The Id of the PARTY who assigned the status to | | |
| | | the PROJECT TASK. | | |
| | Proj Task Status Start Dttm | The calendar date and time a PROJECT TASK | Yes | No |
| | | STATUS ASSIGN started. | | |
| | Project Id | The unique identifier for the PROJECT. | Yes | Yes |
| | Project Task Start Dttm | The calendar date and time a PROJECT TASK | Yes | Yes |
| | | started. | | |
| | Project Task Status Cd | The code assigned to the PROJECT STATUS. | Yes | Yes |
| | | Example: | | |
| | | disputed invoice | | |
| | | in process | | |
| | | completed | | |
| | | hold | | |
| | | accepted. | | |
| | Task Id | The unique identifier assigned to a TASK. | Yes | Yes |
| PROJECT TYPE | Project Type Cd | The unique code assigned to a PROJECT TYPE. | Yes | No |
| | Project Type Desc | The description of a PROJECT TYPE. | No | No |
| PROMO EXPENSE | Promo Expense Cd | The code used to identify promo expenses. | Yes | No |
| | Promo Expense Desc | The description of a code used in identifying | No | No |
| | | promo expenses. | | |
| PROMO EXPENSE XREF | Ad Id | The unique identifier for an ad. | No | Yes |
| | Promo Actual Amt | The actual amount spent on a promotion. | No | No |
| | Promo Budget Amt | The budgeted amount for a promotion. | No | No |
| | Promo Expense Cd | The code used to identify promo expenses | Yes | Yes |
| | Promo Expense Seq Num | The line number of a promo expense. | Yes | No |
| | Promo Id | The unique identifier for the promotion. | Yes | Yes |
| PROMO OFFER | Ad Id | The unique identifier for an ad. | No | Yes |
| | Item Offer Ind | Indicates if the Offer references specific Items. | No | No |
| | | Example: | | |
| | | NON ITEM OFFER: | | |
| | | Provides an incentive to a customer, without | | |
| | | specifying any items or products. | | |
| | | Example: | | |
| | | Temporary reduced rates provided a certain level of | | |
| | | business is transacted. | | |
| | | ITEM OFFER: | | |
| | | Involves a specific item (product or service) or | | |
| | | group of items (or any higher level grouping of | | |
| | | items) | | |
| | | Example: | | |
| | | Order item x during the next week and get 10% | | |
| | | discount. | | |
| | Promo Id | The unique identifier for the promotion. | No | Yes |
| | Promo Offer Desc | The description for a promo offer. | No | No |
| | Promo Offer Id | The unique identifier for a promo offer. | Yes | No |
| | Promo Offer Type Cd | The code assigned to the offer type. | No | Yes |
| PROMO OFFER TYPE | Promo Offer Type Cd | The code assigned to the offer type. | Yes | No |
| | Promo Offer Type Desc | The description of the offer type. For example; | No | No |
| | | item offer, email offer, etc. | | |
| PROMO SEGMENT | Promo Offer Id | The unique identifier for a promo offer. | Yes | Yes |
| | Segment Id | The unique identifier for an instance of the | Yes | Yes |
| | | MARKET SEGMENT entity. | | |
| PROMOTION | Campaign Id | The unique identifier for a Campaign. | No | Yes |
| | Promo Desc | The description of the promotion. | No | No |
| | Promo End Dt | The date on which a promotion ends. | No | No |
| | Promo Goal Amt | The amount of revenue a promotion is expected to | No | No |
| | | generate. | | |
| | Promo Id | The unique identifier for the promotion. | Yes | No |
| | Promo Start Dt | The date on which a promotion starts. | No | No |
| PROPERTY UNIT | Owner Org Id | The unique identifier for an organization. | No | Yes |
| | Property Id | Uniquely identifies a LOCATION. | Yes | Yes |
| | | A sub-type of LOCATION used to provide | | |
| | | temporary accommodations to customers, business | | |
| | | facilities (conferences, workshops), etc. | | |
| | Property Unit Id | Uniquely defining a distinct and finite amount of | Yes | No |
| | | space that can be rented out to PARTYs such as | | |
| | | Guest Rooms, Conference Rooms, Lawns, etc. | | |
| | | within a lodging property. | | |
| | Property Unit Type Cd | Provides codes for property units such as: | No | Yes |
| | | KD—king double room | | |
| | | JE—junior executive room | | |
| | | BR—ballroom | | |
| | Property Wing Cd | A code used to identify various sections or parts of | No | Yes |
| | | a property. | | |
| | | Example: | | |
| | | East Wing | | |
| | | Emerald Tower | | |
| | | etc. | | |
| | Room Num | The “room number” used when communicating to | No | No |
| | | Guests. May differ from Internal Property Unit Id. | | |
| | | May refer to Conference Rooms, Hotel rooms, etc. | | |
| | | In some cases (pool area, lawn), there may be no | | |
| | | ‘physical’ room. | | |
| | Unit Name | Used to capture the name of certain Property Units. | No | No |
| | | Example: | | |
| | | Seagull Ballroom | | |
| | | Emerald Swimming Pool Patio | | |
| PROPERTY UNIT TYPE | Property Unit Type Cd | Provides codes for property units such as: | Yes | No |
| | | KD—king double room | | |
| | | JE—junior executive room | | |
| | | BR—ballroom | | |
| | Property Unit Type Desc | Description of the property unit such as | No | No |
| | | KD—king double room | | |
| | | JE—junior executive room | | |
| | | BR—ballroom | | |
| PROPERTY WING | Property Wing Cd | A code used to identify various sections or parts of | Yes | No |
| | | a property. For example, East Wing, Emerald | | |
| | | Tower, etc | | |
| | Property Wing Desc | Description of the property wing | No | No |
| PUBLISHED UNIT RATE | Owner Org Id | The unique identifier for an organization. | Yes | Yes |
| | Property Id | Uniquely identifies a LOCATION. | Yes | Yes |
| | | A sub-type of LOCATION used to provide | | |
| | | temporary accommodations to customers, business | | |
| | | facilities (conferences, workshops), etc. | | |
| | Property Unit Type Cd | Provides codes for property units such as: | Yes | Yes |
| | | KD—king double room | | |
| | | JE—junior executive room | | |
| | | BR—ballroom | | |
| | Property Wing Cd | A code used to identify various sections or parts of | Yes | Yes |
| | | a property. For example, East Wing, Emerald | | |
| | | Tower, etc | | |
| | Published Rate Amt | The published rate for staying in the PROPERTY | No | No |
| | | UNIT. | | |
| | | Note: A different rate may actually be charged to | | |
| | | the customer. | | |
| | Rate End Dt | The last date on which the PUBLISHED UNIT | No | No |
| | | RATE is in effect. | | |
| | Rate Start Dt | The date on which the PUBLISHED UNIT RATE | Yes | No |
| | | becomes effective. | | |
| PURCHASE | Folio Account Id | Uniquely identifies an ACCOUNT. | No | Yes |
| | | If payment is not rendered at purchase time, this | | |
| | | account is debited to group credit purchases | | |
| | | together for later payment. | | |
| | | Note: Alternatively, the Credit Account Id attribute | | |
| | | in the PAYMENT entity can be used for this | | |
| | | purpose. | | |
| | Purchase Tran Id | A unique identifier for this TRAVEL | Yes | Yes |
| | | TRANSACTION. | | |
| | Purchase Type Cd | A code for classifying various types of | No | Yes |
| | | PURCHASEs | | |
| PURCHASE INVOICE | Invoice Id | Uniquely identifies an INVOICE. | Yes | Yes |
| PURCHASE INVOICE LINE | Invoice Amt | The unit amount charged on the Invoice for this | No | No |
| | | Item. | | |
| | | “Should” be identical to the original price specified | | |
| | | on the original order, but may be different. | | |
| | Invoice Id | Uniquely identifies an INVOICE. | Yes | Yes |
| | Invoice Item Qty | The quantity of Items being Invoiced. | No | No |
| | Invoice Line Num | Uniquely identifies a line item on an Invoice. | Yes | No |
| | Item Id | Unique Identifier for an Item. | No | Yes |
| | | The Item being invoiced. | | |
| PURCHASE REQUISITION | Creator Party Id | The unique identifier for any individual or group of | No | Yes |
| | | individuals that is of interest to the enterprise. | | |
| | | In this case, the PARTY who created a | | |
| | | PURCHASE REQUISITION. | | |
| | Purchase Requisition Dttm | The date on which a PURCHASE REQUISITION | No | No |
| | | was created. | | |
| | Purchase Requisition Id | The unique identifier for a PURCHASE | Yes | No |
| | | REQUISITION. | | |
| | Purchase Requisition Num | An identifier assigned to a PURCHASE | No | No |
| | | REQUISITION. This identifier may not be unique | | |
| | | across all information providing systems. | | |
| | Requesting Party Id | The unique identifier for any individual or group of | No | Yes |
| | | individuals that is of interest to the enterprise. | | |
| | | In this case, the PARTY requesting a PURCHASE | | |
| | | REQUISITION. | | |
| PURCHASE REQUISITION LINE | Purchase Req Line Item Id | Unique Identifier for an Item. | No | Yes |
| | Purchase Req Ln Currency Cd | The code assigned to a CURRENCY. | No | Yes |
| | Purchase Req Ln Desc | The text describing a PURCHASE REQUISITION | No | No |
| | | LINE item. | | |
| | Purchase Req Ln Num | The unique identifier for a single line on a | Yes | No |
| | | PURCHASE REQUISITION LINE. | | |
| | Purchase Req Ln Qty | The amount of an ITEM requested on this | No | No |
| | | PURCHASE REQUISITION LINE | | |
| | Purchase Req Ln Reference Num | For PURCHASE REQUISITIONs, the customer's | No | No |
| | | reference number to this line item. | | |
| | Purchase Req Ln Unit Price Amt | The monetary amount representing the per unit | No | No |
| | | price of a PURCHASE REQUISITION LINE item. | | |
| | Purchase Requestd Delivry Dttm | The Requested Delivery date and time for a | No | No |
| | | PURCHASE REQUISITION LINE. | | |
| | Purchase Requisition Id | The unique identifier for a PURCHASE | Yes | Yes |
| | | REQUISITION. | | |
| | Purchse Req Ln Buyr Party Id | The unique identifier for any individual or group of | No | Yes |
| | | individuals that is of interest to the enterprise. | | |
| | | In this case, the PARTY related to the Buyer | | |
| | | associated with the PURCHASE REQUISITION | | |
| | | LINE item. | | |
| | Purchse Req Ln Vend Party Id | The unique identifier for any individual or group of | No | Yes |
| | | individuals that is of interest to the enterprise. | | |
| | | In this case, the PARTY related to the preferred | | |
| | | Vendor for the PURCHASE REQUISITION LINE | | |
| | | item. | | |
| PURCHASE REQUISITION LN | Purchase Req Line End Dttm | The calendar date and time on which a | No | No |
| ASSIGN | | PURCHASE REQUISITION LINE ASSIGN | | |
| | | relationship ended. | | |
| | Purchase Req Line Start Dttm | The calendar date and time on which a | Yes | No |
| | | PURCHASE REQUISITION LINE ASSIGN | | |
| | | relationship started. | | |
| | Purchase Req Ln Num | A unique identifier for a PURCHASE | Yes | Yes |
| | | REQUISITION LINE. | | |
| | Purchase Requisition Id | The unique identifier for a PURCHASE | Yes | Yes |
| | | REQUISITION. | | |
| | Vend PO Ln Num | A number representing a unique line on a | Yes | Yes |
| | | VENDOR PO LINE. | | |
| | Vendor PO Id | The unique identifier of a specific VENDOR PO. | Yes | Yes |
| PURCHASE REQUISITION | Purchase Req Status Dttm | The date and time a Status was assigned to a | Yes | No |
| STATUS | | PURCHASE REQUISITION. | | |
| | Purchase Req Status Reason Cd | The code for the reason a status was assigned to a | No | Yes |
| | | PURCHASE REQUISITION. | | |
| | Purchase Requisition Id | The unique identifier for a PURCHASE | Yes | Yes |
| | | REQUISITION. | | |
| | Purchase Requisition Status Cd | Unique identifier for a TRANSACTION STATUS. | Yes | Yes |
| | Purchs Req Status Party Id | The unique identifier for any individual or group of | No | Yes |
| | | individuals that is of interest to the enterprise. | | |
| | | The Id belonging to the PARTY who assigned a | | |
| | | slams to a PURCHASE REQUISITION. | | |
| PURCHASE REQUISTION LN | Purchase Req Line Party Id | The unique identifier for any individual or group of | No | Yes |
| STATUS | | individuals that is of interest to the enterprise. | | |
| | Purchase Req Line Status Cd | Unique identifier for a TRANSACTION LINE | Yes | Yes |
| | | STATUS. | | |
| | Purchase Req Line Status Dttm | The date and time a Status was assigned to a | Yes | No |
| | | PURCHASE REQUISITION LINE. | | |
| | Purchase Req Ln Num | The unique identifier for a single line on a | Yes | Yes |
| | | PURCHASE REQUISITION LINE. | | |
| | Purchase Req Ln Stat Reason Cd | The code for the reason a status was assigned to a | No | Yes |
| | | PURCHASE REQUISITION LINE. | | |
| | Purchase Requisition Id | The unique identifier for a PURCHASE | Yes | Yes |
| | | REQUISITION. | | |
| PURCHASE TYPE | Purchase Type Cd | A code for classifying various types of | Yes | No |
| | | PURCHASEs | | |
| | Purchase Type Desc | The description that elucidates various types of | No | No |
| | | PURCHASEs | | |
| QUALITY GROUP SURVEY | Group Survey Id | Uniquely identifies a Quality Group Survey | Yes | No |
| | Quality Resolution Cd | Uniquely identifies a Quality Resolution. | No | Yes |
| | | The Quality Resolution adopted as a result of the | | |
| | | Group Survey. | | |
| | | Note: If multiple Resolutions are to be supported, | | |
| | | create an associative entity instead. | | |
| | Segment Id | The unique identifier for an instance of the | No | Yes |
| | | MARKET SEGMENT entity. | | |
| | | The Market Segmented targeted or selected for | | |
| | | feedback. | | |
| | Survey Conducted End Dt | The date the feedback collection event ended. | No | No |
| | Survey Conducted Start Dt | The date the feedback collection event started. | No | No |
| | Survey Desc | Narrative text describing the Quality Group | No | No |
| | | Survey. | | |
| | Survey Id | Uniquely identifies a Quality Survey. | No | Yes |
| | | The Survey questionnaire used. Optional. | | |
| QUALITY OF SERVICE INDEX | Flight Product Id | Unique Identifier for an Item. | Yes | Yes |
| | | A distance based TRAVEL PRODUCT that is | | |
| | | defined by Origination and Destination (O&D), | | |
| | | weekday of departure and time of departure. | | |
| | | An Airline Flight. | | |
| | QSI Effective Dt | The calendar day that the QSI was collected and | Yes | No |
| | | are relevant. | | |
| | QSI End Dt | The calendar day that the QSI statistics are no | No | No |
| | | longer relevant.. | | |
| | QSI Share Pct | The individual share or percentage of the market as | No | No |
| | | shared by all flights as reported by the Department | | |
| | | of Transportation (DOT) for the specified operating | | |
| | | airline and market. | | |
| | QSI Value Qty | The actual value as reported by the Department of | No | No |
| | | Transportation (DOT) for the specified operating | | |
| | | airline and market. | | |
| QUALITY RESOLUTION | Quality Resolution Cd | Uniquely identifies a Quality Resolution. | Yes | No |
| | Quality Resolution Desc | Narrative text describing the Quality Resolution. | No | No |
| QUALITY SURVEY | Survey Desc | Narrative text describing the Quality Survey. | No | No |
| | Survey Id | Uniquely identifies a Quality Survey. | Yes | No |
| QUALITY SURVEY QUESTION | Feedback Class Cd | Uniquely identifies a Feedback Class. | No | Yes |
| | Feedback Type Cd | Uniquely identifies a Feedback Type. | No | Yes |
| | Survey Id | Uniquely identifies a Quality Survey. | Yes | Yes |
| | Survey Line Num | Uniquely identifies a specific survey item or | Yes | No |
| | | question on a survey. | | |
| | Survey Question Txt | The actual text of the Survey Question asked. | No | No |
| | Trait Cd | Uniquely identifies a TRAIT. | No | Yes |
| | | The trait or characteristic being surveyed. | | |
| | | The Trait attributes are needed if the survey | | |
| | | questions are more specific than can be provided | | |
| | | for by the broad feedback class attributes. | | |
| | Trait Value Cd | Unique identifier for a TRAIT VALUE. | No | Yes |
| | | The value of the trait or characteristic being | | |
| | | surveyed. | | |
| QUERY STRING FIELD NAME | Query String Field Name Desc | Text description of Query Field String Names. | No | No |
| | | Examples: | | |
| | | First name, | | |
| | | Site, | | |
| | | Location. | | |
| | Query String Field Name Id | A unique identifier for the domain of parameter | Yes | No |
| | | names that may appear in the Query String of the | | |
| | | URL for a Web Page. | | |
| QUERY STRING FIELD VALUE | Query String Field Value Desc | Text description for Query String Field Values. | No | No |
| | | Examples: | | |
| | | Sylvie | | |
| | | Lebanon | | |
| | | Columbia. | | |
| | Query String Field Value Id | Unique identifier for the domain of parameter | Yes | No |
| | | values that may appear in the query string of the | | |
| | | URL for a Web Page. | | |
| | | Source-> Web Log. | | |
| QUERY STRING NAME VALUE | Page View Sequence Num | The ordinal number that sequences WEB PAGE | Yes | Yes |
| | | VIEW instances within the context of a particular | | |
| | | WEB VISIT (Visit Id) | | |
| | Query String Current URL Ind | This entity can be used to store both the parameters | No | No |
| | | for the current URL as well as the referring URL. | | |
| | | The Query String Current URL Ind attribute is used | | |
| | | to distinguish between the two URLs. “Yes” | | |
| | | indicates current, “No” indicates referring. | | |
| | | Examples: Yes; No | | |
| | | Source-> Web Log | | |
| | Query String Field Name Id | A unique identifier for the domain of parameter | Yes | Yes |
| | | names that may appear in the Query String of the | | |
| | | URL for a Web Page. | | |
| | Query String Field Value Id | Unique identifier for the domain of parameter | Yes | Yes |
| | | values that may appear in the query string of the | | |
| | | URL for a Web Page. | | |
| | | Source-> Web Log. | | |
| | Web Visit Id | Unique identifier for the VISIT. | Yes | Yes |
| QUOTED CHARGE | Charge Type Cd | Identifies a unique occurrence of CHARGE TYPE | Yes | Yes |
| | Quoted Amt | The amount quoted to a PARTY for a specific | No | No |
| | | charge component. | | |
| | Quoted Party Id | The unique identifier for any individual or group of | Yes | Yes |
| | | individuals that is of interest to the enterprise | | |
| | | The Party requesting/receiving the Quote.. | | |
| | Reservation Seq Num | This attribute identifies a specific RESERVATION | Yes | Yes |
| | | ITEM. | | |
| | Reservation Transaction Id | A unique identifier for this TRAVEL | Yes | Yes |
| | | TRANSACTION. | | |
| R AND D EXPENSE ACCOUNT | GL Main Account Num | The unique Chart of Account code for the GL | Yes | Yes |
| | | MAIN ACCOUNT. | | |
| RAIL | Equip Id OIN | Uniquely identifies a piece of Equipment that can | Yes | Yes |
| | | be used to transport individuals or cargo. | | |
| RAIL PRODUCT | Rail Product Id | Unique Identifier for an Item. | Yes | Yes |
| | | A distance based TRAVEL PRODUCT that is | | |
| | | defined by Origination and Destination (O&D), | | |
| | | weekday of departure and time of departure. | | |
| | | A Rail trip. | | |
| RAIL STATION | T&T Facility Id | Uniquely identifies a LOCATION. | Yes | Yes |
| | | A Travel and Transportation Facility Location. | | |
| RAILROAD | Railroad Org Id | The unique identifier for an external organization. | Yes | Yes |
| | | Identifies the Organization that provides a Product. | | |
| RAILROAD RESERVATION | Reservation Seq Num | This attribute identifies a specific RESERVATION | Yes | Yes |
| | | ITEM. | | |
| | Reservation Transaction Id | A unique identifier for this TRAVEL | Yes | Yes |
| | | TRANSACTION. | | |
| RAILROAD TICKET | Ticket Id | A unique identifier for a TICKET. | Yes | Yes |
| RATE STRUCTURE | Base Rate Ind | Indicates if this structure is the Base (or Default) | No | No |
| | | rate structure. This is the rate structure that is | | |
| | | typically given to customers who do not have an | | |
| | | AGREEMENT with the enterprise. | | |
| | | Example: “Yes” this rate is the Base rate. | | |
| | Rate Structure Name | A textual name for a RATE STRUCTURE. | No | No |
| | Rate Structure Num | Uniquely identifies a RATE STRUCTURE. | Yes | No |
| RATED GAMING ROUND | Jackpot Amt | Used if part (or all) of the Player win amount was | No | No |
| | | as result of a Jackpot). | | |
| | Player Win Amt | Money won by the Player for this round (can be | No | No |
| | | negative). | | |
| | Round Num | Uniquely identifies a Round played within a | Yes | No |
| | | Session. Also called hand, game, spin, throw, etc. | | |
| | | depending on the game type. | | |
| | Session Start Dttm | The start of a rated gaming session (that is, a | Yes | Yes |
| | | gaming session where the identity of the player is | | |
| | | known). | | |
| | Visit Id | The unique identifier for an instance of the VISIT | Yes | Yes |
| | | entity. | | |
| | Wager Add Amt | Some games allow the Player to add to their initial | No | No |
| | | wager during the round/game/hand. This attribute | | |
| | | captures that. | | |
| | | Example: | | |
| | | Doubling down in blackjack | | |
| | | etc. | | |
| | Wager Amt | Money wagered this round. | No | No |
| | Wager Cnt | The number of Wagers made in a Round. | No | No |
| | | Example: | | |
| | | a player plays 3 hands during a blackjack game | | |
| | | a player plays 5 lines on a slot machine | | |
| RATED GAMING SESSION | Casino Rating Cd | Code that describes the rating for a CASINO | No | Yes |
| | | VISIT or a GAMING SESSION assigned to a | | |
| | | CASINO PLAYER | | |
| | Game Config Id | Uniquely identifies a specific Game Configuration. | No | Yes |
| | Game Station Instance Id | Uniquely identifies a Game Station Instance. | No | Yes |
| | Gaming Session Type Cd | A code for identifying the type of GAMING | No | Yes |
| | | SESSION. | | |
| | Rating Assoc Id | The unique identifier for an individual. | No | Yes |
| | | Represent the rating authority (typically the pit | | |
| | | boss) | | |
| | Session End Dttm | The end of a rated gaming session (that is, a | No | No |
| | | gaming session where the identity of the player is | | |
| | | known). | | |
| | Session Start Dttm | The start of a rated gaming session (that is, a | Yes | No |
| | | gaming session where the identity of the player is | | |
| | | known). | | |
| | Session Win Amt DD | The total amount won by the Player for the | No | No |
| | | Session. May be negative. | | |
| | | Note: This information is typically derivable form | | |
| | | the detail level attributes. | | |
| | Visit Id | The unique identifier for an instance of the VISIT | Yes | Yes |
| | | entity. | | |
| RAW LAND | Raw Land Fixed Asset Id | A unique identifier for an asset held by the | Yes | Yes |
| | | organization. | | |
| REASON | Reason Cd | This code uniquely identifies the reason why two | Yes | No |
| | | (or more) TRAVEL TRANSACTIONs are related. | | |
| | Reason Desc | This code describes the reason why two (or more) | No | No |
| | | TRAVEL TRANSACTIONs are related. | | |
| RECEIPT | Receipt Create Dttm | The date on which a RECEIPT was created. | No | No |
| | Receipt Id | Unique identifier for the VENDOR RECEIPT | Yes | Yes |
| | | entity. | | |
| | Receipt Num | An identifier assigned to a RECEIPT. This | No | No |
| | | identifier may not be unique across all information | | |
| | | providing systems. | | |
| | Receipt Party Id | The unique identifier for any individual or group of | No | Yes |
| | | individuals that is of interest to the enterprise. | | |
| | | In this context it is the PARTY who created the | | |
| | | RECEIPT. | | |
| | Receipt Proof of Delivery Num | A number identifying that delivery has been made. | No | No |
| RECEIPT EXCEPTION | Affected Item Qty | If an Item is involved in an exception, specifies the | No | No |
| | | quantity of affected items. | | |
| | Exception Cd | Uniquely identifies an EXCEPTION. | No | Yes |
| | Exception Reason Cd | Uniquely identifies an Exception Reason | No | Yes |
| | Exception Seq Num | Uniquely identifies an Exception for a given | Yes | No |
| | | Receipt. (a receipt may have multiple exceptions) | | |
| | Vendor Receipt Id | Unique identifier for the VENDOR RECEIPT | Yes | Yes |
| | | entity. | | |
| | | The Receipt that had an exception. | | |
| | Vendor Receipt Line Num | Identifies a specific line within a VENDOR | No | Yes |
| | | RECEIPT. | | |
| | | Identifies a specific line number (item) in a receipt | | |
| | | that had an exception. | | |
| RECEIPT LINE | Receipt Id | Unique identifier for the VENDOR RECEIPT | Yes | Yes |
| | | entity. | | |
| | Receipt Ln Address Id | A number used to uniquely identify an ADDRESS. | No | Yes |
| | | In this case, the Address associated with a | | |
| | | RECEIPT LINE. | | |
| | Receipt Ln Carrier Party Id | The unique identifier for any individual or group of | No | Yes |
| | | individuals that is of interest to the enterprise. | | |
| | | In this context it is the Carrier related to the | | |
| | | RECEIPT LINE. | | |
| | Receipt Ln Create Dttm | The date and time on which a RECEIPT LINE was | No | No |
| | | created. | | |
| | Receipt Ln Expected Recpt Dttm | The date and time on which a RECEIPT is | No | No |
| | | expected to be delivered. | | |
| | Receipt Ln Location Id | Uniquely identifies a LOCATION. | No | Yes |
| | Receipt Ln Num | Identifies a specific line within a VENDOR | Yes | Yes |
| | | RECEIPT. | | |
| | Receipt Ln Signature Ind | An indicator that identifies if a customer signature | No | No |
| | | was received for the shipment receipt. | | |
| RECEIPT LINE DOCUMENT | Receipt Id | Unique identifier for the VENDOR RECEIPT | Yes | Yes |
| | | entity. | | |
| | Receipt Line Document Num | A number representing an official RECEIPT LINE | No | No |
| | | DOCUMENT. It may be generated by a legacy | | |
| | | system. | | |
| | Receipt Line Document Type Cd | The unique identifier for the DOCUMENT TYPE. | Yes | Yes |
| | Receipt Ln Num | Identifies a specific line within a VENDOR | Yes | Yes |
| | | RECEIPT. | | |
| | Recpt Ln Doc Creatr Party Id | The unique identifier for any individual or group of | No | Yes |
| | | individuals that is of interest to the enterprise. | | |
| | | In this context it is the Party who created the | | |
| | | RECEIPT LINE DOCUMENT. | | |
| RECEIPT LINE INSPECTION | Receipt Id | Unique identifier for the VENDOR RECEIPT | Yes | Yes |
| | | entity. | | |
| | Receipt Line Inspection Dttm | The date and time of inspection of the RECEIPT | Yes | No |
| | | LINE. | | |
| | Receipt Ln Inspection Party Id | The unique identifier for any individual or group of | No | Yes |
| | | individuals that is of interest to the enterprise. | | |
| | | The Id of the Party performing the RECEIPT LINE | | |
| | | INSPECTION. | | |
| | Receipt Ln Inspectn Status Cd | The code for the status of the RECEIPT LINE | No | Yes |
| | | INSPECTION. | | |
| | Receipt Ln Num | Identifies a specific line within a VENDOR | Yes | Yes |
| | | RECEIPT. | | |
| | Receipt Ln Qual Inspectn Cd | The code assigned to the RECEIPT LINE | No | Yes |
| | | QUALITY Inspection. | | |
| RECEIPT LINE QUALITY | Receipt Ln Qual Inspectn Cd | The code assigned to the RECEIPT LINE | Yes | No |
| | | QUALITY Inspection. | | |
| | Receipt Ln Qual Inspectn Desc | The description of the Receipt Line Inspection Cd. | No | No |
| RECEIPT LINE STATUS | Receipt Line Status Cd | The code for a RECEIPT LINE STATUS. | Yes | No |
| | Receipt Line Status Desc | The description for the RECEIPT LINE STATUS | No | No |
| | | code. | | |
| RECEIPT LINE STATUS ASSIGN | Receipt Id | Unique identifier for the VENDOR RECEIPT | Yes | Yes |
| | | entity. | | |
| | Receipt Line Status Assign Cd | The code for the status assigned to a RECEIPT | Yes | Yes |
| | | LINE. | | |
| | Receipt Ln Num | Identifies a specific line within a VENDOR | Yes | Yes |
| | | RECEIPT. | | |
| | Receipt Ln Status Assign Dttm | The date and time a status was assigned to a | Yes | No |
| | | RECEIPT LINE. | | |
| | Receipt Ln Status Party Id | The unique identifier for any individual or group of | No | Yes |
| | | individuals that is of interest to the enterprise. | | |
| | | In this context, the Id of the Party who assigned a | | |
| | | status to a RECEIPT LINE. | | |
| RECEIPT STATUS ASSIGN | Receipt Id | Unique identifier for the VENDOR RECEIPT | Yes | Yes |
| | | entity. | | |
| | Receipt Status Assign Cd | The code assigned to a RECEIPT STATUS TYPE. | Yes | Yes |
| | Receipt Status Assign Dttm | The date and time on which a RECEIPT STATUS | Yes | No |
| | | ASSIGN was created. | | |
| | Receipt Status Party Id | The unique identifier for any individual or group of | No | Yes |
| | | individuals that is of interest to the enterprise. | | |
| RECEIPT STATUS TYPE | Receipt Status Type Cd | The code assigned to a RECEIPT STATUS TYPE. | Yes | No |
| | Receipt Status Type Desc | The description of a RECEIPT STATUS TYPE | No | No |
| | | Cd. | | |
| RECEIPT TERM | Receipt Id | Unique identifier for the VENDOR RECEIPT | Yes | Yes |
| | | entity. | | |
| | Receipt Term End Dttm | The calendar date and time on which a RECEIPT | No | No |
| | | TERM ended. | | |
| | Receipt Term Id | The unique identifier for a PO TERM. | Yes | Yes |
| | Receipt Term Start Dttm | The date and time a specific PO TERM became | Yes | Yes |
| | | valid for current use. | | |
| RECEIPTS PLAN | Item Id ASN | Unique Identifier for an Item. | Yes | Yes |
| | | A subset of (physical) items than can be | | |
| | | inventoried, and shelved. This would exclude | | |
| | | service items and virtual items (downloadable | | |
| | | products). | | |
| | Location Id | Uniquely identifies a LOCATION. | Yes | Yes |
| | Receipts Plan Start Dt | The starting date of the Receipts Plan. | Yes | No |
| | Receipts Plan Unit Qty | The item quantity that is planned for receipt. | No | No |
| | Receipts Plan Value Amt DD | The unit book value of an inventoried item after | No | No |
| | | temporary or permanent markdowns, if any, have | | |
| | | been applied but prior to any discounts being taken. | | |
| | | Note: If the enterprise use simple pricing this | | |
| | | attribute may be derivable. | | |
| | | For more complex pricing models, this may be a | | |
| | | non-derivable and populated by an application. | | |
| RECEIVE EVENT | Ship Event Id | Uniquely identifies a SHIPPING EVENT. | Yes | Yes |
| RECEIVED QUANTITY | Receipt Id | Unique identifier for the VENDOR RECEIPT | Yes | Yes |
| | | entity. | | |
| | Receipt Ln Num | Identifies a specific line within a VENDOR | Yes | Yes |
| | | RECEIPT. | | |
| | Received Quantity Line UOM Cd | Uniquely identifies a unit of measure. | No | Yes |
| | | The code assigned to the unit of measure for the | | |
| | | Received Item Qty on a RETURN LINE. | | |
| | Received Quantity Recpt Ln Qty | The quantity of items received that were associated | No | No |
| | | with a RECEIPT LINE. | | |
| | Received Quantity Type Cd | The code assigned to a type of quantity received. | Yes | Yes |
| | | Examples: container, primary unit of measure, | | |
| | | received unit of measure. | | |
| RECEIVED QUANTITY TYPE | Received quantity Type Cd | The code assigned to a type of quantity received. | Yes | No |
| | | Examples: container, primary unit of measure, | | |
| | | received unit of measure. | | |
| | Received quantity Type Desc | The description of a type of quantity received. | No | No |
| RECOMMENDATION | Page Conversion Category Cd | Unique identifier for information concerning the | No | Yes |
| | | linkage between recommended Offerings and the | | |
| | | Web Page that the Offering was displayed on. | | |
| | | Source-> Recommendation DB. | | |
| | Recommend Conversion Cat Cd | Unique identifier for information concerning the | No | Yes |
| | | linkage between recommended Offerings and the | | |
| | | Web Page that the Offering was displayed on. | | |
| | | Source-> Recommendation DB. | | |
| | Recommendation Clicked Ind | Designates if the user clicked on the | No | No |
| | | Recommendation. | | |
| | | 0 - No, | | |
| | | 1 - yes. | | |
| | Recommendation Dttm | The date and time on which a Recommendation | No | No |
| | | was made. | | |
| | Recommendation Id | Unique identifier for each Recommendation that | Yes | No |
| | | was made by the Recommendation engine. | | |
| | Web Visit Id | Unique identifier for the VISIT. | No | Yes |
| REFERRAL | Referral Id | A coding method for classifying a REFERRAL. | Yes | No |
| | Referral Name | Name given to the referring link. Could be used to | No | No |
| | | store the referring URL. | | |
| | Referral Type Cd | Classifies referrals into various sub-types such as | No | Yes |
| | | EMAIL referrals, E LOCATION referrals, etc. | | |
| REFERRAL TYPE | Referral Type Cd | Classifies referrals into various sub-types such as | Yes | No |
| | | EMAIL referrals, E LOCATION referrals, etc. | | |
| | Referral Type Desc | Textual description of a referral | No | No |
| REGION | Division Cd | Uniquely identifies a DIVISION. | No | Yes |
| | Region Cd | Uniquely identifies a REGION. | Yes | No |
| | Region Mgr Assoc Id | An individual who is employed by the enterprise. | No | Yes |
| | | The manager of the REGION. | | |
| | Region Name | Short text reference or label for the REGION. | No | No |
| RELEASE TYPE | Release Type Cd | Describes whether release is for a blanket or | Yes | No |
| | | planned purchase order. Possible values are | | |
| | | therefore “Blanket” or “Planned”. | | |
| | Release Type Desc | The description for the code. | No | No |
| RENTAL EQUIP | Equip Id OIN | Uniquely identifies an Equipment Instance. | Yes | Yes |
| RENTAL LEASES EXTERNAL | GL Sub Account Num | The unique Chart of Account code for the GL SUB | Yes | Yes |
| ACCT | | ACCOUNT. | | |
| REPAIRS AND MAINTENANCE | GL Sub Account Num | The unique Chart of Account code for the GL SUB | Yes | Yes |
| ACCT | | ACCOUNT. | | |
| REPORTING MONTH | Reporting Month Desc | The description for a REPORTING MONTH. | No | No |
| | Reporting Month Id | The unique identifier for a REPORTING MONTH. | Yes | No |
| | Reporting Quarter Id | The unique identifier for a REPORTING | No | Yes |
| | | QUARTER. | | |
| REPORTING QUARTER | Reporting Quarter Desc | The description for a REPORTING QUARTER. | No | No |
| | Reporting Quarter Id | The unique identifier for a REPORTING | Yes | No |
| | | QUARTER. | | |
| | Reporting Year Id | The unique identifier for a REPORTING YEAR. | No | Yes |
| REPORTING WEEK | Reporting Month Id | The unique identifier for a REPORTING MONTH. | No | Yes |
| | Reporting Week Desc | The description for a REPORTING WEEK. | No | No |
| | Reporting Week Id | The unique identifier for REPORTING WEEK. | Yes | No |
| REPORTING YEAR | Reporting Year Desc | The description for a REPORTING YEAR. | No | No |
| | Reporting Year Id | The unique identifier for a REPORTING YEAR. | Yes | No |
| REQUEST TYPE | Request Type Cd | This attribute is the identifier of a type of | Yes | No |
| | | SPECIAL REQUEST. | | |
| | | Example: | | |
| | | KM = Kosher Meal | | |
| | | VM = Vegetarian Meal | | |
| | | WC = Wheel Chair | | |
| | | SL = Spanish Language Interpreter | | |
| | | etc. | | |
| | Requested Type Desc | This attribute is a brief description of a type of | No | No |
| | | request. | | |
| | | Example: Kosher Meal, Vegetarian Meal, Wheel | | |
| | | Chair, Interpreter, etc. | | |
| RESERVATION | Award Voucher Id | The identifier of a loyalty award or certificate | No | Yes |
| | | awarded to a customer account. | | |
| | Reservation Cancel Dt | The calendar day that a reservation is cancelled and | No | No |
| | | no longer valid. | | |
| | Reservation Cancel Ind | A canceled reservation due to customer | No | No |
| | | authorization. | | |
| | Reservation Close Dt | The calendar day that a reservation is closed and | No | No |
| | | no longer valid. | | |
| | Reservation Group Ind | An identifier for a reservation that is made for a | No | No |
| | | GROUP of customers. | | |
| | Reservation Status Cd | The domain of status codes used to indicate the | No | Yes |
| | | state of an itinerary. | | |
| | | Example: O for Open, C for Closed. etc | | |
| | Reservation Transaction Id | A unique identifier for this TRAVEL | Yes | Yes |
| | | TRANSACTION. | | |
| RESERVATION ITEM | Adult Cnt | Indicates the number of Adults planning to make | No | No |
| | | use of the reservation. | | |
| | | Used where multiple individuals can make use of | | |
| | | the same reservation (hotel rooms, etc.) | | |
| | Booked Party Id | The unique identifier for any individual or group of | No | Yes |
| | | individuals that is of interest to the enterprise. | | |
| | | The person who will be making use of the | | |
| | | Reservation. | | |
| | Child Cnt | Indicates the number of Children planning to make | No | No |
| | | use of the reservation. | | |
| | | Used where multiple individuals can make use of | | |
| | | the same reservation (hotel rooms, etc.) | | |
| | | Note: The age limit defining “child” may vary by | | |
| | | enterprise and/or travel product. | | |
| | Page View Sequence Num | The ordinal number that sequences WEB PAGE | No | Yes |
| | | VIEW instances within the context of a particular | | |
| | | WEB VISIT (Visit Id) | | |
| | | If this transaction was made via a website, this | | |
| | | indicates the specific Web Page from which the | | |
| | | item was selected. | | |
| | Reservation Item Type Cd | A code to identify the type of RESERVATION | No | Yes |
| | | ITEM | | |
| | Reservation Seq Num | This attribute identifies a specific RESERVATION | Yes | No |
| | | ITEM. | | |
| | Reservation Status Cd | The domain of status codes used to indicate the | No | Yes |
| | | state of a reservation. | | |
| | | Example: Open, Closed, Cancelled. etc | | |
| | Reservation Transaction Id | A unique identifier for this TRAVEL | Yes | Yes |
| | | TRANSACTION. | | |
| | Travel Product Id | Unique Identifier for an Item. | No | Yes |
| | | A Travel-related offer available for sale to a | | |
| | | PARTY(s). | | |
| | Web Visit Id | Unique identifier for the VISIT. | No | Yes |
| | | Uniquely identifies a visit to a web site. | | |
| | | If this transaction was made via a website, this | | |
| | | indicates the specific Web Visit. | | |
| RESERVATION ITEM TYPE | Reservation Item Type Cd | A code to identify the type of RESERVATION | Yes | No |
| | | ITEM | | |
| | Reservation Item Type Desc | The description that identifies the type of | No | No |
| | | RESERVATION ITEM | | |
| RESERVATION PREFERENCE | Booked Ind | Indicator that shows if a customer preference was | No | No |
| | | booked as part of a RESERVATION (yes, no) | | |
| | Party Id | The unique identifier for an instance of the PARTY | Yes | Yes |
| | | entity. | | |
| | Preference Cd | The identifier for a personal customer preference. | Yes | Yes |
| | Preference Value Cd | A code that indicates the preference for this | Yes | Yes |
| | | PARTY. | | |
| | Requested Ind | An indicator that shows that a customer preference | No | No |
| | | was requested as part of the RESERVATION | | |
| | | process (yes, no) | | |
| | Reservation Transaction Id | A unique identifier for this TRAVEL | Yes | Yes |
| | | TRANSACTION. | | |
| RESERVATION STATUS | Reservation Status Cd | The domain of status codes used to indicate the | Yes | No |
| | | state of a reservation. | | |
| | | Example: Open, Closed, Cancelled. etc | | |
| | Reservation Status Desc | This attribute is an explanation of the status codes | No | No |
| | | used to indicate the state of a reservation. | | |
| | | Example: Open, Closed, Cancelled | | |
| RESERVES ACCOUNT | GL Main Account Num | The unique Chart of Account code for the GL | Yes | Yes |
| | | MAIN ACCOUNT. | | |
| RESORT | Resort Id | Uniquely identifies a LOCATION. | Yes | Yes |
| | | A subtype of LOCATION where customers visit | | |
| | | for relaxation or recreation. A RESORT typically | | |
| | | can include other LOCATIONS such as | | |
| | | LODGING PROPERTY, CASINO, etc. | | |
| RETAIL PURCHASE | Associate Party Id | An individual who is employed by the enterprise. | No | Yes |
| | Purchase Tran Id | A unique identifier for this TRAVEL | Yes | Yes |
| | | TRANSACTION. | | |
| | Retail Purchase Type Cd | The code for classifying RETAIL PURCHASEs | No | Yes |
| RETAIL PURCHASE CHARGE | Charge Amt | The amount of a non-ITEM related charge | No | No |
| | Charge Line Num | Identifies a specific charge within a Sale or | Yes | No |
| | | Purchase. | | |
| | | Note: If a Charge Type can appear only once per | | |
| | | Transaction, this attribute can be substituted with | | |
| | | Charge Type Cd instead. | | |
| | Charge Type Cd | Unique identifier for a CHARGE TYPE. | No | Yes |
| | Purchase Tran Id | A unique identifier for this TRAVEL | Yes | Yes |
| | | TRANSACTION. | | |
| RETAIL PURCHASE TYPE | Retail Purchase Type Cd | The code for classifying RETAIL PURCHASEs | Yes | No |
| | Retail Purchase Type Desc | A description of the classification of the RETAIL | No | No |
| | | PURCHASE | | |
| RETAINED EARNING | GL Main Account Num | The unique Chart of Account code for the GL | Yes | Yes |
| ACCOUNT | | MAIN ACCOUNT. | | |
| RETURN | Return From Address Id | A number used to uniquely identify an ADDRESS. | No | Yes |
| | Return From Party Id | The unique identifier for any individual or group of | No | Yes |
| | | individuals that is of interest to the enterprise. | | |
| | Return Id | Uniquely identifies a RETURN. | Yes | Yes |
| RETURN ITEM | Orig Purchase Seq Num | An identifier for a specific PURCHASE ITEM | No | Yes |
| | | entity. | | |
| | Orig Purchase Tran Id | A unique identifier for this TRAVEL | No | Yes |
| | | TRANSACTION. | | |
| | Purchase Tran Id | A unique identifier for this TRAVEL | Yes | Yes |
| | | TRANSACTION. | | |
| | Return Credit Amt | This attribute contains the amount credited for a | No | No |
| | | specific RETURN ITEM. | | |
| | Return Reason Cd | Unique identifier for the RETURN REASON. | No | Yes |
| | Return Seq Num | This attribute identifies a specific RETURN ITEM. | Yes | No |
| RETURN LINE STATUS ASSIGN | Return Id | Uniquely identifies a Return. | Yes | Yes |
| | Return Line Status Assign Cd | The code of the Status assigned to the RETURN | Yes | Yes |
| | | LINE. | | |
| | Return Line Status Assign Dttm | The date and time a status was assigned to a | Yes | No |
| | | RETURN LINE. | | |
| | Return Line Status Party Id | The unique identifier for any individual or group of | No | Yes |
| | | individuals that is of interest to the enterprise. | | |
| | | The id of the PARTY who assigned the status to | | |
| | | the RETURN LINE. | | |
| | Return Ln Num | Identifies a specific Line Item within a Vendor | Yes | Yes |
| | | Return | | |
| RETURN LINE TYPE | Return Line Type Cd | The code assigned to a RETURN LINE TYPE. | Yes | No |
| | Return Line Type Desc | A description of a RETURN LINE TYPE. | No | No |
| RETURN REASON | Return Reason Cd | Unique identifier for the RETURN REASON. | Yes | No |
| | Return Reason Desc | Narrative text describing the reason for the return | No | No |
| | | of the ITEM. | | |
| RETURN STATUS | Return Status Cd | The code assigned to a status of a RETURN. | Yes | No |
| | Return Status Desc | The description of a Return Status Cd. | No | No |
| RETURN TRANSACTION LINE | Enter Method Cd | Uniquely identifies the ENTER METHOD. | No | Yes |
| | Item Id | Unique Identifier for an Item. | No | Yes |
| | Orig Shopping Tran Id | A unique identifier for this TRAVEL | No | Yes |
| | | TRANSACTION. | | |
| | | Links to the original Sales Transaction. | | |
| | Orig Shopping Tran Line Num | Identifies a specific line within a SHOPPING | No | Yes |
| | | TRANSACTION. | | |
| | | Links to the original Sales Transaction. | | |
| | Return Item Qty | The total quantity number of items returned. | No | No |
| | Return Reason Cd | Unique identifier for the RETURN REASON. | No | Yes |
| | Return Transaction Dttm | The date an item was returned by a customer | No | No |
| | Return Transaction Line Num | Identifies a specific line within a RETURN | Yes | No |
| | | TRANSACTION LINE. | | |
| | Shopping Transaction Id | A unique identifier for this TRAVEL | Yes | Yes |
| | | TRANSACTION. | | |
| | Tran Line Status Cd | Unique identifier for a TRANSACTION LINE | No | Yes |
| | | STATUS. | | |
| | Unit Refund Amt | The amount refunded to a customer for a single | No | No |
| | | ITEM. | | |
| REV AND RECEIVABLE EXPNS | GL Sub Account Num | The unique Chart of Account code for the GL SUB | Yes | Yes |
| ACCT | | ACCOUNT. | | |
| REVENUE ACCOUNT | GL Main Account Num | The unique Chart of Account code for the GL | Yes | Yes |
| | | MAIN ACCOUNT. | | |
| | Revenue Account Type Cd | The unique code assigned to the REVENUE | No | Yes |
| | | ACCOUNT TYPE. Types of revenue accounts | | |
| | | include Interest Income and other revenue. | | |
| REVENUE ACCOUNT TYPE | Revenue Account Type Cd | The unique code assigned to the REVENUE | Yes | No |
| | | ACCOUNT TYPE. Types of revenue accounts | | |
| | | include Interest Income and other revenue. | | |
| | Revenue Account Type Desc | The description of the REVENUE ACCOUNT | No | No |
| | | TYPE. | | |
| RFID TAG | Code Format Cd | Uniquely identifies the code format. | No | Yes |
| | | Specifies the encoding standard used for the RFID | | |
| | | Tag. | | |
| | EPC Cd | Uniquely identifies a RFID Tag. | Yes | No |
| | | Note: Due to the Classword Suffix Rule, the | | |
| | | attribute name may appear redundant, since EPC = | | |
| | | “Electronic Product Code”. | | |
| RFID TRAIT SCAN | EPC Cd | Uniquely identifies a RFID Tag. | Yes | Yes |
| | | Note: Due to the Classword Suffix Rule, the | | |
| | | attribute name may appear redundant, since EPC = | | |
| | | “Electronic Product Code”. | | |
| | Scan Dttm | The date and time the scan or reading was made. | Yes | No |
| | Scan Location Id | Uniquely identifies a LOCATION. | No | Yes |
| | | The location of the Item at the time of the scan. | | |
| | Trait Cd | Uniquely identifies a TRAIT. | Yes | Yes |
| | Trait Value Cd | Unique identifier for a TRAIT VALUE. | Yes | Yes |
| ROUTE GROUP | Parent Group Cd | A unique code assigned to a Parent Group of routes | No | Yes |
| | | assigned to a RM Analyst. | | |
| | Route Group Cd | The unique code assigned to a group of routes | Yes | No |
| | | managed by a RM Analyst. | | |
| | Route Group Desc | A unique description assigned to a route group | No | No |
| | | managed by a RM Analysts. | | |
| ROUTE TYPE | Route Type Cd | A unique code assigned to a route type managed by | Yes | No |
| | | a RM Analysts (i.e. 0- short haul, 1- long haul). | | |
| | Route Type Desc | A unique description assigned to a route type | No | No |
| | | managed by a RM Analysts. | | |
| S2000 SER ITEM | CAGE Cd MFR ROC SPL | Commercial and Government Entity (CAGE) Code | No | Yes |
| | | is a 5 digit code that identifies companies doing or | | |
| | | wishing to do business with the (United States) | | |
| | | Federal Government. Typically the codes, | | |
| | | administered by Defense Logistics Information | | |
| | | Service, includes U.S., Canadian and NATO | | |
| | | CAGE Codes. | | |
| | | Note: This example is specific to the U.S. The | | |
| | | non-US equivalent is the NATO NSCM Code. | | |
| | | Spec2000: Spec 2000 has adopted the | | |
| | | CAGE/NSCM codes as a standardized way to | | |
| | | identify Spec 2000 users. | | |
| | | In Spec 2000, CAGE/NSCM Codes are used to | | |
| | | identify Manufacturers, Suppliers and Repair | | |
| | | Agencies. Both CAGE and NSCM codes are | | |
| | | assigned by the Defense Logistics Services Center | | |
| | | (DLSC) | | |
| | | Note: This attribute is specified at the Business | | |
| | | Party level, and can be derived via the Item Owner/ | | |
| | | Manufacturer foreign keys higher in the Item | | |
| | | hierarchy. | | |
| | NSCM Cd MFR ROC SPL | The NSCM Code (NATO Supply Code for | No | Yes |
| | | Manufacturers) is code used to identify non-U.S. | | |
| | | Supply companies. (CAGE is the US Equivalent). | | |
| | | Note: This attribute is specified at the Business | | |
| | | Party level, and can be derived via the Item Owner/ | | |
| | | Manufacturer foreign keys higher in the Item | | |
| | | hierarchy. | | |
| | S2000 Ser Num SER | The Party specific Serial Number (not unique | No | No |
| | | across Parties) | | |
| | Univ Serial Num USN | The unique serial number for ITEMs that are | Yes | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| SALE INVOICE | Invoice Id | Uniquely identifies an INVOICE. | Yes | Yes |
| SALE INVOICE LINE | Invoice Amt | The unit amount charged on the Invoice for this | No | No |
| | | Item. | | |
| | | “Should” be identical to the original price specified | | |
| | | on the original order, but may be different. | | |
| | Invoice Id | Uniquely identifies an INVOICE. | Yes | Yes |
| | Invoice Item Qty | The quantity of Items being Invoiced. | No | No |
| | Invoice Line Num | Uniquely identifies a line item on an Invoice. | Yes | Yes |
| | Item Id | Unique Identifier for an Item. | No | Yes |
| | | The Item being invoiced. | | |
| SALES PLAN | Item Class Cd | Uniquely identifies an ITEM CLASS. | Yes | Yes |
| | Location Id | Uniquely identifies a LOCATION. | Yes | Yes |
| | Plan Id | Uniquely identifies a PLAN. | Yes | Yes |
| | Sales Plan Amt | The projected gross margin for the item sales for a | No | No |
| | | given time period. | | |
| | Sales Plan End Dt | The date on which the sales plan ends. | No | No |
| | Sales Plan Margin Pct | Represents the planning of the projected gross | No | No |
| | | margin %. | | |
| | Sales Plan Start Dt | The date on which the sales plan begins. | Yes | No |
| | Shrinkage Plan Amt | The monetary amount expected to be written off | No | No |
| | | due to shrinkage (item loss, item theft, etc) during a | | |
| | | given period. | | |
| SALES RETURN TRAN | Inv Tran Id | Uniquely identifies an inventory transaction. | Yes | Yes |
| | Return Transaction Line Num | Identifies a specific line within a RETURN | No | Yes |
| | | TRANSACTION LINE. | | |
| | Shopping Transaction Id | A unique identifier for this TRAVEL | No | Yes |
| | | TRANSACTION. | | |
| SALES REVENUE ACCOUNT | GL Main Account Num | The unique Chart of Account code for the GL | Yes | Yes |
| | | MAIN ACCOUNT. | | |
| SCAN CODE | Code Format Cd | Uniquely identifies the code format. | Yes | Yes |
| | Item Id ASN | Unique Identifier for an Item. | No | Yes |
| | | A subset of (physical) items than can be | | |
| | | inventoried, and shelved. This would exclude | | |
| | | service items and virtual items (downloadable | | |
| | | products). | | |
| | Scan Cd | Uniquely identifies a SCAN CODE. | Yes | No |
| SCHED EVENT | Maint Sched Id HRI | Uniquely identifies an Instance of Scheduled | No | Yes |
| | | Maintenance. | | |
| | Sched Maint Event Id | Uniquely identifies a Maintenance Event. | Yes | Yes |
| | Unsched Maint Event Id | Indicates the scheduled event was done | No | Yes |
| | | unscheduled (error condition prompted a fix/task | | |
| | | that was scheduled in the near future & now need | | |
| | | not be done) | | |
| SCHEDULED LEG | Book End Dt | The last calendar day that the published schedule is | No | No |
| | | effective for the public to book flights according to | | |
| | | the listings. | | |
| | Book Start Dt | The first calendar day that the published schedule | No | No |
| | | is effective for the public to book flights according | | |
| | | to the listings. | | |
| | Destination Facility Id | Uniquely identifies a LOCATION. | Yes | Yes |
| | Equip Id OIN | Uniquely identifies a piece of Equipment that can | No | Yes |
| | | be used to transport individuals or cargo. | | |
| | Flight Num DFN | A unique identifier assigned to a Flight scheduled | Yes | Yes |
| | | for generating revenue and utilized by the general | | |
| | | public. | | |
| | Origin Facility Id | Uniquely identifies a LOCATION. | Yes | Yes |
| | Sched Leg Arrive Dttm TMS | Specific Date and Time used to help identify a | No | No |
| | | SCHEDULED OnD PRODUCT projected arrival. | | |
| | Sched Leg Depart Dttm TME | The scheduled departure date and time of a LEG. | Yes | No |
| | | Note: If this LEG is the initial LEG of one (or | | |
| | | more) SEGMENT, this departure date and time | | |
| | | would typically be identical to the corresponding | | |
| | | SEGMENT departure date and time. | | |
| SCHEDULED SEGMENT | Flight Product Id | Unique Identifier for an Item. | Yes | Yes |
| | | A distance based TRAVEL PRODUCT that is | | |
| | | defined by Origination and Destination (O&D), | | |
| | | weekday of departure and time of departure. | | |
| | | An Airline Flight. | | |
| | Sched Seg Depart Dttm | The scheduled departure date and time of a | Yes | No |
| | | SEGMENT. | | |
| | | Note: This departure date and time is usually | | |
| | | identical to the departure date and time of the first | | |
| | | LEG of the SEGMENT. | | |
| SCHEDULED SEGMENT LEG | Destination Facility Id | Uniquely identifies a LOCATION. | Yes | Yes |
| | Flight Num DFN | A unique identifier assigned to a Flight scheduled | Yes | Yes |
| | | for generating revenue and utilized by the general | | |
| | | public. | | |
| | Flight Product Id | Unique Identifier for an Item. | Yes | Yes |
| | | A distance based TRAVEL PRODUCT that is | | |
| | | defined by Origination and Destination (O&D), | | |
| | | weekday of departure and time of departure. | | |
| | | An Airline Flight. | | |
| | Origin Facility Id | Uniquely identifies a LOCATION. | Yes | Yes |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| | Sched Seg Depart Dttm | The scheduled departure date and time of a | Yes | Yes |
| | | SEGMENT. | | |
| | | Note: This departure date and time is usually | | |
| | | identical to the departure date and time of the first | | |
| | | LEG of the SEGMENT. | | |
| SEASON | Season Cd | Uniquely identifies a SEASON. | Yes | No |
| | Season Name | Short text reference or label for a SEASON. | No | No |
| SECURITIES ACCOUNT | GL Main Account Num | The unique Chart of Account code for the GL | Yes | Yes |
| | | MAIN ACCOUNT. | | |
| | Securities Account Party Id | The unique identifier for any individual or group of | No | Yes |
| | | individuals that is of interest to the enterprise. | | |
| | | The party who issued the short term security such | | |
| | | as 6-month municipal bond. | | |
| SEGMENT BOOKING HIST | Allowed Overbook Pct | The percentage to which a travel provider is | No | No |
| | | prepared to overbook capacity to take into account | | |
| | | canceling and noshowing passengers. | | |
| | Blocked Seat Cnt | Seats being held back (not for sale) in certain | No | No |
| | | booking classes | | |
| | Booking Class Cd | The booking class code associated with this | Yes | Yes |
| | | particular booking, (i.e. F, Y, M, etc.). | | |
| | Days To Dept Cnt | A designated point in time across the booking | Yes | No |
| | | history of a flight (i.e. x days before departure) at | | |
| | | which key metrics for a flight are recorded. | | |
| | | Usually a flight is made available for booking by | | |
| | | the inventory system 365 days in advance. | | |
| | | As the flight departure date nears, the metrics are | | |
| | | recorded more frequently and they are recorded | | |
| | | further apart during the early part of a flight's | | |
| | | booking life. | | |
| | | This is called a Checkpoint by some airlines | | |
| | Flight Product Id | Unique Identifier for an Item. | Yes | Yes |
| | | A distance based TRAVEL PRODUCT that is | | |
| | | defined by Origination and Destination (O&D), | | |
| | | weekday of departure and time of departure. | | |
| | | An Airline Flight. | | |
| | Noshow Estimate Pct | An estimate of the number of booked passengers | No | No |
| | | not checking in (expressed as a percentage of the | | |
| | | total number of bookings) | | |
| | Sched Seg Depart Dttm | The scheduled departure date and time of a | Yes | Yes |
| | | SEGMENT. | | |
| | | Note: This departure date and time is usually | | |
| | | identical to the departure date and time of the first | | |
| | | LEG of the SEGMENT. | | |
| | Seats Allocated Cnt | The total number of actual physical seats that have | No | No |
| | | been allocated to the booking class. The sum of all | | |
| | | seat allocations equal the total number of physical | | |
| | | seats of the aircraft. | | |
| | | Note: When this number is increased from one | | |
| | | checkpoint to another, an equivalent decreased | | |
| | | allocation must be made in another booking class. | | |
| | | The deadweight count has been factored into this | | |
| | | allocation. | | |
| | Seats Available Cnt DD | The number of seats available to be booked at this | No | No |
| | | time. | | |
| | | Metric = Seats Allocated * (1 + Allowed | | |
| | | Overbooking Pct) − Seats Booked − Blocked Seat | | |
| | | Cnt | | |
| | | The Leg Deadweight count (at leg level) has been | | |
| | | taken into account for this calculation. | | |
| | Seats Booked Cnt | Number of seats booked at this time. | No | No |
| | Seats Ticketed Cnt | Number of seats that have been ticketed at this time | No | No |
| | Waitlist Cnt | Number of booked passengers on waiting list for | No | No |
| | | potential upgrade to this booking class. | | |
| SEGMENT FLOWN | Booking Class Cd | The booking class code associated with this | Yes | Yes |
| (SUMMARY) | | particular booking, (i.e. F, Y, M, etc.). | | |
| | Denied Cnt DD | The total number of passengers who were denied | No | No |
| | | boarding either due to operational (broken chair, | | |
| | | etc) or commercial (overbooking, etc) or personal | | |
| | | (drunk, etc.) reasons | | |
| | Denied Commercial Cnt DD | The total number of passengers who were denied | No | No |
| | | boarding due to commercial (overbooking, etc) | | |
| | | reasons | | |
| | Denied Compensation Amt DD | The compensation amount provided to passengers | No | No |
| | | whose boarding was denied | | |
| | Denied Operations Cnt DD | The total number of passengers who were denied | No | No |
| | | boarding due to operational (aircraft substituted by | | |
| | | a smaller aircraft, broken chair, etc) | | |
| | Denied Standby Cnt | The number of standby passengers who were | No | No |
| | | denied boarding | | |
| | | These individuals did not hold a valid ticket for this | | |
| | | flight but were standing by to see if space would | | |
| | | become available. | | |
| | Denied Voluntary Cnt | The number of passengers who volunteered for | No | No |
| | | denied boarding | | |
| | Denied Voluntary Comp Cnt | The number of passengers who volunteered for | No | No |
| | | denied boarding and received compensation. | | |
| | Denied With Comp Cnt | The number of passengers who were denied | No | No |
| | | boarding and received compensation | | |
| | Flight Product Id | Unique Identifier for an Item. | Yes | Yes |
| | | A distance based TRAVEL PRODUCT that is | | |
| | | defined by Origination and Destination (O&D), | | |
| | | weekday of departure and time of departure. | | |
| | | An Airline Flight. | | |
| | Go Show Cnt | The number of passengers who showed up just | No | No |
| | | before flight departure with no previous booking | | |
| | | and purchased tickets for this specific SEGMENT | | |
| | No Show Cnt | The number of passengers with confirmed booking | No | No |
| | | who did not show up for a given flight | | |
| | Offload Cnt | The number of passengers who were off loaded to a | No | No |
| | | different flight | | |
| | Sched Seg Depart Dttm | The scheduled departure date and time of a | Yes | Yes |
| | | SEGMENT. | | |
| | | Note: This departure date and time is usually | | |
| | | identical to the departure date and time of the first | | |
| | | LEG of the SEGMENT. | | |
| | Seats Booked Cnt | Number of seats booked. | No | No |
| | Seats Flown Cnt | Number of seats that actually contained a flown | No | No |
| | | passenger | | |
| | Seats Ticketed Cnt | Number of seats that have been ticketed. | No | No |
| SEGMENT LEG | Critical Leg Ind | Indicates the LEG(s) most likely to be sold out, | No | No |
| | | thus closing out an entire (potentially high profit) | | |
| | | SEGMENT, making it unavailable for additional | | |
| | | passengers. Sometimes called a “leg index”. | | |
| | Destination Facility Id | Uniquely identifies a LOCATION. | Yes | Yes |
| | Flight Num DFN | A unique identifier assigned to a Flight scheduled | Yes | Yes |
| | | for generating revenue and utilized by the general | | |
| | | public. | | |
| | Flight Product Id | Unique Identifier for an Item. | Yes | Yes |
| | | A distance based TRAVEL PRODUCT that is | | |
| | | defined by Origination and Destination (O&D), | | |
| | | weekday of departure and time of departure. | | |
| | | An Airline Flight. | | |
| | Origin Facility Id | Uniquely identifies a LOCATION. | Yes | Yes |
| SELLING EXPENSE ACCOUNT | GL Main Account Num | The unique Chart of Account code for the GL | Yes | Yes |
| | | MAIN ACCOUNT. | | |
| SER ITEM INVENTORIED DD | Item Id ASN | Unique Identifier for an Item. | Yes | Yes |
| | | A subset of (physical) items than can be | | |
| | | inventoried, and shelved. This would exclude | | |
| | | service items and virtual items (downloadable | | |
| | | products). | | |
| | Location Id | Uniquely identifies a LOCATION. | Yes | Yes |
| | Perpetual Inv Dttm | The date and time reflected by the inventory level. | Yes | Yes |
| | Univ Serial Num USN | The unique serial number for ITEMs that are | Yes | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| SER ITEM INVENTORY | Adj Ser Item Status Cd | Uniquely identifies a Serialized Item Status. | No | Yes |
| ADJUST | | Captures a change or adjustment in Serialized Item | | |
| | | status, if applicable, for this Inventory Transaction. | | |
| | | Example: | | |
| | | Status changed from “Broken” to | | |
| | | “Refurbished” | | |
| | Inv Tran Id | Uniquely identifies an inventory transaction. | Yes | Yes |
| | Item Id ASN | Unique Identifier for an Item. | Yes | Yes |
| | | A subset of (physical) items than can be | | |
| | | inventoried, and shelved. This would exclude | | |
| | | service items and virtual items (downloadable | | |
| | | products). | | |
| | Univ Serial Num USN | The unique serial number for ITEMs that are | Yes | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| SER ITEM RETURNED | Return Transaction Line Num | Identifies a specific line within a RETURN | Yes | Yes |
| | | TRANSACTION LINE. | | |
| | Shopping Transaction Id | A unique identifier for this TRAVEL | Yes | Yes |
| | | TRANSACTION. | | |
| | Univ Serial Num USN | The unique serial number for ITEMs that are | Yes | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| SER ITEM SHIPPED | Shipment Line Num | The line number for this SHIPMENT. Each | Yes | Yes |
| | | SHIPMENT LINE ITEM has a sequential number | | |
| | | starting at one and going to ‘n’ where ‘n’ represents | | |
| | | the last SHIPMENT LINE ITEM associated with | | |
| | | this SHIPMENT. | | |
| | Shipment Num | Uniquely identifies a SHIPMENT. | Yes | Yes |
| | Univ Serial Num USN | The unique serial number for ITEMs that are | Yes | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| SER ITEM SOLD | Shopping Transaction Id | A unique identifier for this TRAVEL | Yes | Yes |
| | | TRANSACTION. | | |
| | Shopping Transaction Line Num | Identifies a specific line within a SHOPPING | Yes | Yes |
| | | TRANSACTION. | | |
| | Univ Serial Num USN | The unique serial number for ITEMs that are | Yes | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| SER ITEM STATUS | Ser Item Status Cd | Uniquely identifies a Serialized Item Status. | Yes | No |
| | Ser Item Status Desc | Textual Description of a Serialized Item Status. | No | No |
| SER ITEM STATUS HIST | Ser Item Status Cd | Uniquely identifies a Serialized Item Status. | Yes | Yes |
| | Ser Item Status Dttm | The effective date and time of the status change or | Yes | No |
| | | status assignment. | | |
| | Univ Serial Num USN | The unique serial number for ITEMs that are | Yes | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| SER ITEM TRAIT | Trait Cd | Uniquely identifies a TRAIT. | Yes | Yes |
| | Trait Value Cd | Unique identifier for a TRAIT VALUE. | Yes | Yes |
| | Univ Serial Num USN | The unique serial number for ITEMs that are | Yes | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| SER ITEM VENDOR RECEIPT | Univ Serial Num USN | The unique serial number for ITEMs that are | Yes | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| | Vendor Receipt Id | Unique identifier for the VENDOR RECEIPT | Yes | Yes |
| | | entity. | | |
| | Vendor Receipt Line Num | Identifies a specific line within a VENDOR | Yes | Yes |
| | | RECEIPT. | | |
| SER ITEM VENDOR RETURN | Univ Serial Num USN | The unique serial number for ITEMs that are | Yes | Yes |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| | Vendor Return Id | Uniquely identifies a Return. | Yes | Yes |
| | Vendor Return Line Num | Identifies a specific Line Item within a Vendor | Yes | Yes |
| | | Return | | |
| SERIALIZED ITEM | EPC Cd | Uniquely identifies an EPC Item. | No | Yes |
| | | This attribute is used only for Serialized Items that | | |
| | | are tracked via RFID technology. | | |
| | Item Id ASN | Unique Identifier for an Item. | No | Yes |
| | | A subset of (physical) items than can be | | |
| | | inventoried, and shelved. This would exclude | | |
| | | service items and virtual items (downloadable | | |
| | | products). | | |
| | Manuf Serial Num SER | The Item or Part Serial Number assigned to this | No | No |
| | | specific instance of this Item by the Manufacturer. | | |
| | Source Party Id DD | The unique identifier for any individual or group of | No | Yes |
| | | individuals that is of interest to the enterprise. | | |
| | | The company that sourced or provided this item. | | |
| | | Note: If all purchase and supply records are kept, | | |
| | | this will be derivable. | | |
| | Univ Serial Num USN | The unique serial number for ITEMs that are | Yes | No |
| | | individually tracked. | | |
| | | Spec 2000 Note: S2000 requires that this attribute | | |
| | | be unique across all Items and Parties. It consists of | | |
| | | two parts: Party specific Serial Number and Party | | |
| | | Id (also known as CAGE Code) | | |
| | Warranty Expire Dt | The last day that the Item is covered by a Warranty. | No | No |
| SERIALIZED ITEM CONTENT | Content Univ Serial Num | The unique Serial Number for ITEMs that are | Yes | Yes |
| | | individually tracked. | | |
| | | The Serial Number of the child ITEMs that are | | |
| | | contained within the Parent ITEM with a specific | | |
| | | Serial Number. | | |
| | End Dt | Marks the end of the association between a | No | No |
| | | Serialized Item and the Serialized Item it is | | |
| | | contained in/part of/installed in. | | |
| | GE Location Cd GEL | S2000 code that specifies the Geo and/or Electrical | No | Yes |
| | | Location of the Parts on a Assembly or Circuit | | |
| | | Card. | | |
| | Item Qty | This value will always be 1 (one) and can thus be | No | No |
| | | omitted, unless Serialized Items are not completely | | |
| | | unique (such as the case if they are assigned as | | |
| | | batch numbers instead of individually) | | |
| | Parent Univ Serial Num | The unique serial number for ITEMs that are | Yes | Yes |
| | | individually tracked. | | |
| | | The Serial Number of the Parent Item Id that | | |
| | | contains the Content Item Id(s). | | |
| | Start Dt | Marks the beginning of the association between a | Yes | No |
| | | Serialized Item and the Serialized Item it is | | |
| | | contained in/part of/installed in. | | |
| SERVICE CLASS | Service Class Cd | The unique identifier of a specific CLASS OF | Yes | No |
| | | SERVICE offered by a TRAVEL PROVIDER. | | |
| | Service Class Desc | A brief explanation of a specific CLASS OF | No | No |
| | | SERVICE offered by a TRAVEL PROVIDER. | | |
| SERVICE CLASS | Cabin Qty | The number of cabins within the specified CLASS | No | No |
| CONFIGURATION | | OF SERVICE. Used for cruise ships. | | |
| | Passenger Config Id | Uniquely identifies a specific passenger | Yes | Yes |
| | | configuration. | | |
| | Seat Qty | The number of seats within the specified CLASS | No | No |
| | | OF SERVICE. Used for aircrafts, busses, etc. | | |
| | Service Class Cd | The unique identifier of a specific SERVICE | No | Yes |
| | | CLASS offered by a TRAVEL PROVIDER. | | |
| | | Example: A (First Class), B (Business Class) or C | | |
| | | (Economy Class). | | |
| SERVICE RATE | Pricing Id | Identifies a specific price for an Item. | Yes | Yes |
| | | Note: You typically have multiple Pricing Ids (and | | |
| | | prices) for the same Item. This can be due to: | | |
| | | date (price change over time) | | |
| | | condition set (different price by channel, | | |
| | | region, etc.) | | |
| | | volume scale (lower price based on volume | | |
| | | purchase) | | |
| | | etc. | | |
| | Rate Amt | The Rate charged for the Service. | No | No |
| | | Note: See the Item entity for the Pricing Unit Of | | |
| | | Measure (UOM) | | |
| | Service Item Id | Unique Identifier for an Item. | Yes | Yes |
| SERVICE REQUEST | Request Seq Num | A numerical sequence number that identifies this | Yes | No |
| | | SERVICE REQUEST as part of a SHIPMENT. | | |
| | | This number will be sequential and will start with | | |
| | | one and end with ‘n’ where ‘n’ is the last SERVICE | | |
| | | REQUEST associated with the SHIPMENT. | | |
| | Service Item Id | Unique Identifier for an Item. | No | Yes |
| | | An ITEM used or sold to a customer as part of | | |
| | | providing a TRANSPORT SERVICE. | | |
| | Shipment Line Num | The line number for this SHIPMENT. Each | No | Yes |
| | | SHIPMENT LINE ITEM has a sequential number | | |
| | | starting at one and going to ‘n’ where ‘n’ represents | | |
| | | the last SHIPMENT LINE ITEM associated with | | |
| | | this SHIPMENT. | | |
| | Shipment Num | Uniquely identifies a SHIPMENT. | Yes | Yes |
| SET OF BOOKS | Parent Set Of Books Cd | The unique identifier for the SET OF BOOKS. | No | Yes |
| | Set Of Books Cd | The unique identifier for the SET OF BOOKS. | Yes | No |
| | Set Of Books Desc | The description of the SET OF BOOKS. | No | No |
| | Set Of Books End Dttm | The date marking the end for a SET OF BOOKS. | No | No |
| | Set Of Books Name | The name assigned to the SET OF BOOKS. | No | No |
| | Set Of Books Start Dttm | The date marking the beginning for a SET OF | Yes | No |
| | | BOOKS. | | |
| | Set Of Books Type Cd | The code assigned to the SET OF BOOKS. | No | Yes |
| SET OF BOOKS CALENDAR | Custom Calendar Type Cd | Defines the type of Custom Calendar, for instance | Yes | No |
| YEAR | | Fiscal Year. | | |
| | | At companies where one and only one version of a | | |
| | | Fiscal Calendar is used, this attribute may simply | | |
| | | be removed. | | |
| | Custom Calendar Year Id | The unique identifier for an ACCOUNTING | Yes | Yes |
| | | PERIOD YEAR. | | |
| | Set Of Books Calndr Start Dttm | The date and time a Set of Books association with a | Yes | No |
| | | Calendar started. | | |
| | Set Of Books Cd | The unique identifier for the SET OF BOOKS. | Yes | Yes |
| | Set Of Books Start Dttm | The date marking the beginning for a SET OF | Yes | Yes |
| | | BOOKS. | | |
| SET OF BOOKS CHART OF | Set Of Books Cd | The unique identifier for the SET OF BOOKS. | Yes | Yes |
| ACCOUNT | | | | |
| | Set Of Books COA Id | The unique identifier for a CHART OF | Yes | Yes |
| | | ACCOUNT, or alias for a complete CHART OF | | |
| | | ACCOUNTs number. | | |
| | Set Of Books COA Start Dttm | The date and time a Chart of Account numbers | Yes | No |
| | | association with a Set of Books started. | | |
| | Set Of Books Start Dttm | The date marking the beginning for a SET OF | Yes | Yes |
| | | BOOKS. | | |
| SET OF BOOKS CURRENCY | Global Currency Cd | The code assigned to a CURRENCY. | No | Yes |
| HIST | | | | |
| | Local Currency Cd | The code assigned to a CURRENCY. | Yes | Yes |
| | Set Of Books Cd | The unique identifier for the SET OF BOOKS. | Yes | Yes |
| | Set Of Books Hist End Dttm | The date on which the currency type is no longer | No | No |
| | | associated with a SET OF BOOKS. | | |
| | Set Of Books Hist Start Dttm | The date on which the currency type is associated | Yes | No |
| | | with a SET OF BOOKS. | | |
| | Set Of Books Start Dttm | The date marking the beginning for a SET OF | Yes | Yes |
| | | BOOKS. | | |
| SET OF BOOKS INTERNAL ORG | Internal Org Party Id | The unique identifier for an internal organization. | Yes | Yes |
| | Set Of Books Cd | The unique identifier for the SET OF BOOKS. | Yes | Yes |
| | Set Of Books Org End Dttm | The date the SET OF BOOKS and Internal | No | No |
| | | Organization association ended. | | |
| | Set Of Books Org Start Dttm | The date the SET OF BOOKS and Internal | Yes | No |
| | | Organization association started. | | |
| | Set Of Books Start Dttm | The date marking the beginning for a SET OF | Yes | Yes |
| | | BOOKS. | | |
| SET OF BOOKS TYPE | Set Of Books Type Cd | The code assigned to the SET OF BOOKS. | Yes | No |
| | Set Of Books Type Desc | The description of the SET OF BOOKS. Examples: | No | No |
| | | Prime, US GAAP Adj, Statutory. | | |
| SHIP | Equip Id OIN | Uniquely identifies a piece of Equipment that can | Yes | Yes |
| | | be used to transport individuals or cargo. | | |
| SHIP EVENT TYPE | Ship Event Type Cd | Uniquely identifies a SHIP EVENT TYPE. | Yes | No |
| | Ship Event Type Desc | Narrative text describing a SHIP EVENT TYPE. | No | No |
| SHIP PORT | T&T Facility Id | Uniquely identifies a LOCATION. | Yes | Yes |
| | | A Travel and Transportation Facility Location. | | |
| SHIPMENT COST | Allocated Cost Amt | The monetary amount allocated for the various | No | No |
| | | COSTs associated with this SHIPMENT. | | |
| | Cost Cd | Uniquely identifies a COST. | Yes | Yes |
| | Shipment Num | Uniquely identifies a SHIPMENT. | Yes | Yes |
| SHIPMENT ESTIMATE | Active Status Ind | Indicates if the estimate is active. | No | No |
| | | It will be marked as inactive when a more up to | | |
| | | date estimate is submitted, or if the planned | | |
| | | shipment is cancelled. | | |
| | Estimate Dttm | The effective date and time of the estimate. | Yes | No |
| | Shipment Num | Uniquely identifies a SHIPMENT. | Yes | Yes |
| | | Identifies the Shipment for which space is being | | |
| | | estimated. At this point in time it is a provisional | | |
| | | Shipment Number. | | |
| SHIPMENT FEEDBACK | Feedback Id | Uniquely identifies an instance of Quality | Yes | Yes |
| | | Feedback. Typically system assigned. | | |
| | Shipment Num | Uniquely identifies a SHIPMENT. | Yes | Yes |
| SHIPMENT LINE ITEM | Agreement Id | Uniquely identifies an AGREEMENT. | No | Yes |
| | | The Agreement governing the shipping of this Item | | |
| | | (if applicable and not derivable) | | |
| | Commodity Cd | Uniquely identifies a commodity using a | No | Yes |
| | | Classification Standard. | | |
| | Full Value Liability Ind | Indicates that the Carrier assumes full liability for | No | No |
| | | the shipped item. | | |
| | Item Class Rating Cd | The unique code for an instance of the CLASS | No | Yes |
| | | RATING entity. | | |
| | | If the item is packed in a PIECE with differently | | |
| | | rated items, the most expensive rating is usually | | |
| | | used to classify the entire PIECE. | | |
| | Item Id | Unique Identifier for an Item. | No | Yes |
| | Item Qty | The number of items associated with this | No | No |
| | | SHIPMENT LINE ITEM. | | |
| | Item Qty UOM Cd | Uniquely identifies a unit of measure. | No | Yes |
| | | The Item Qty Unit of Measure. | | |
| | Release Value Amt | Indicates the maximum assumed liability by the | No | No |
| | | CARRIER in the case of loss or damage. | | |
| | Shipment Line Num | The line number for this SHIPMENT. Each | Yes | No |
| | | SHIPMENT LINE ITEM has a sequential number | | |
| | | starting at one and going to ‘n’ where ‘n’ represents | | |
| | | the last SHIPMENT LINE ITEM associated with | | |
| | | this SHIPMENT. | | |
| | Shipment Num | Uniquely identifies a SHIPMENT. | Yes | Yes |
| SHIPMENT SPACE | Allocated Volume Meas | The total volume allocated to the type of Container | No | No |
| ALLOCATION | | or Loose Freight for a specific Scheduled Leg (may | | |
| | | be derivable) | | |
| | | Note: This may be the same as the Estimated | | |
| | | Volume OR it may be different. The reason for | | |
| | | allocating a different amount compared to what the | | |
| | | Shipper estimated could be: | | |
| | | Shipper typically under/over estimates | | |
| | | Irregular objects that need more space | | |
| | | allocated than the actual Volume. | | |
| | Allocated Volume Pct | Estimate of the percentage of available volume in | No | No |
| | | the Container (or Loose Freight Space) that is to be | | |
| | | allocated to a planned Shipment. | | |
| | | This information can be useful to consolidate | | |
| | | multiple Shipments in a single Container (in cases | | |
| | | where the enterprise is dealing directly with the | | |
| | | Originating Shipper) | | |
| | Allocated Weight Meas | The total weight allocated to the type of Container | No | No |
| | | or Loose Freight for a specific Scheduled Leg. | | |
| | | Note: This may be the same as the Estimated | | |
| | | Weight OR it may be different. A reason for | | |
| | | allocating a different amount compared to what the | | |
| | | Shipper estimated could be: | | |
| | | Shipper typically under/over estimates | | |
| | Cargo Position Num | Identifies a specific cargo position being allocated. | Yes | Yes |
| | | In the case of a Container, it can be the Container | | |
| | | slot position in the Transport Vehicle that can fit a | | |
| | | Container of this type of Class, and in the case of | | |
| | | loose freight, indicate a loose freight area in the | | |
| | | Transport Vehicle. | | |
| | Destination Facility Id | Uniquely identifies a LOCATION. | Yes | Yes |
| | Estimate Dttm | The effective date and time of the estimate. | No | Yes |
| | Flight Num DFN | A unique identifier assigned to a Flight scheduled | Yes | Yes |
| | | for generating revenue and utilized by the general | | |
| | | public. | | |
| | Origin Facility Id | Uniquely identifies a LOCATION. | Yes | Yes |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| | Shipment Num | Uniquely identifies a SHIPMENT. | No | Yes |
| | | Identifies the Shipment for which space is being | | |
| | | estimated. At this point in time it is a provisional | | |
| | | Shipment Number. | | |
| SHIPMENT STATE | End Event Id | A unique identifier for a SHIPPING EVENT. | No | Yes |
| | | The event that triggers the end of the current state. | | |
| | Piece Num | Uniquely identifies a PIECE contained in a | Yes | Yes |
| | | SHIPMENT. | | |
| | | This can often be thought of as a “Tracking | | |
| | | Number” | | |
| | Shipment State Type Cd | Indicates the type of shipment state (transit, non | No | No |
| | | transit). | | |
| | Start Event Id | A unique identifier for a SHIPPING EVENT. | Yes | Yes |
| | | The event that triggers the start of the current state. | | |
| | State Type Cd | Uniquely identifies a STATE TYPE. | No | Yes |
| SHIPMENT STATE COST | Allocated Cost Amt | The monetary amount allocated for the various | No | No |
| | | COSTs associated with this SHIPMENT STATE. | | |
| | Cost Cd | Uniquely identifies a COST. | Yes | Yes |
| | Piece Num | Uniquely identifies a PIECE contained in a | Yes | Yes |
| | | SHIPMENT. | | |
| | | This can often be thought of as a “Tracking | | |
| | | Number” | | |
| | Service Item Id | Unique Identifier for an Item. | No | Yes |
| | | An ITEM used or sold to a customer as part of | | |
| | | providing a TRANSPORT SERVICE. | | |
| | Start Event Id | A unique identifier for a SHIPPING EVENT. | Yes | Yes |
| | | The event that triggers the start of the current state. | | |
| SHIPPING EVENT | Ship Event Dttm | Timestamp that indicates when the event occurred. | No | No |
| | Ship Event Id | Uniquely identifies a SHIPPING EVENT. | Yes | No |
| | Ship Event Type Cd | Uniquely identifies a SHIP EVENT TYPE. | No | Yes |
| SHIPPING EXCEPTION | Exception Cd | Uniquely identifies an EXCEPTION. | Yes | Yes |
| | Exception Reason Cd | Uniquely identifies an Exception Reason | No | Yes |
| | Ship Event Id | Uniquely identifies a SHIPPING EVENT. | Yes | Yes |
| SHOP EVENT | LRU Maint Event Id | Uniquely identifies a Maintenance Event. | No | Yes |
| | Maint Event Id MTN | Uniquely identifies a Maintenance Event. | Yes | Yes |
| | Modify Ind | Indicates if a Modified part/component was | No | No |
| | | provided in the place of the original received one. | | |
| | Receive Dttm MRD | The date and time the component/part/LRU was | No | No |
| | | received by the Shop. | | |
| | Remove Type Cd RRC | S2000 Supplier Removal type as seen from the | No | No |
| | | Shop's point of view. | | |
| | | Example: | | |
| | | Production Return | | |
| | | Modification | | |
| | | Scheduled Maint | | |
| | | etc. | | |
| | | Note: This code look-up table must be supplied by | | |
| | | the airline in conjunction with Spec 2000 | | |
| | | definitions. | | |
| | Shop Action Cd SAC | S2000 code that specifies the type of action | No | No |
| | | performed | | |
| | | Example: | | |
| | | Calibrated | | |
| | | Overhauled | | |
| | | Beyond Economic Repair | | |
| | Shop Finding Id SFI | Uniquely identifies a Shop Finding. | No | Yes |
| SHOP FINDING | Confirm Ind | Indicates that the problem found confirms the | No | No |
| | | problem reported. | | |
| | | Example: “Yes”, the finding is confirmed. | | |
| | Equip Msg Confirm Ind FAC | Did the needed maintenance confirm the | No | No |
| | | Equipment Message that was originally displayed/ | | |
| | | generated? | | |
| | Fault Found Cd FFC | Unique code that reflects nature of fault found | No | No |
| | | during shop action. | | |
| | Fault Induced Cd FFC | Unique code that reflects the fault was induced by | No | No |
| | | the operator of the Equipment. | | |
| | Justified Ind | Indicates if the maintenance work was justified (did | No | No |
| | | a problem really exist?) | | |
| | | Example: “No”, “Yes” | | |
| | Notes Txt | Miscellaneous textual information reflected in the | No | No |
| | | shop findings. These notes may reflect Associate | | |
| | | (technician) findings, problems discovered, status, | | |
| | | etc. | | |
| | Shop Finding Id SFI | Uniquely identifies a Shop Finding. | Yes | No |
| | Shop Finding Txt REM | Textual write-up of Shop Findings. | No | No |
| | Shop Finding Type Cd | Uniquely identifies a Shop Finding Type. | No | Yes |
| SHOP FINDING TYPE | Shop Finding Type Cd | Uniquely identifies a Shop Finding Type. | Yes | No |
| | Shop Finding Type Desc | Textual description of a Shop Finding Type. | No | No |
| SHOPPING TRAN DISCOUNT | Discounted Item Ind | Multiple ITEMs can be involved in a DISCOUNT. | No | No |
| LINE | | The ITEM(s) purchased to fulfill the DISCOUNT | | |
| | | condition, and the ITEM that was discounted. This | | |
| | | indicator can be used to tag the ITEM that was | | |
| | | actually discounted. | | |
| | Purchase Tran Id | A unique identifier for this TRAVEL | Yes | Yes |
| | | TRANSACTION. | | |
| | Shopping Transaction Id | A unique identifier for this TRAVEL | Yes | Yes |
| | | TRANSACTION. | | |
| | Shopping Transaction Line Num | Identifies a specific line within a SHOPPING | Yes | Yes |
| | | TRANSACTION. | | |
| | Tran Discnt Line Num | Identifies a specific line within a SHOPPING | Yes | Yes |
| | | TRANSACTION DISCOUNT. | | |
| SHOPPING TRANSACTION | Bill To Address Id | A number used to uniquely identify an ADDRESS. | No | Yes |
| | | The address of the “Bill To” Party. | | |
| | Bill To Party Id | The unique identifier for any individual or group of | No | Yes |
| | | individuals that is of interest to the enterprise. | | |
| | | The Party to be billed for this transaction. | | |
| | Order Num | The order number assigned to this shopping | No | No |
| | | transaction. | | |
| | | Used for external communication and Order | | |
| | | Tracking for shopping transactions where there is a | | |
| | | delay between the sale and the fulfillment. | | |
| | | It is typically used to provide linkage to legacy | | |
| | | Order Systems. In some environments may be | | |
| | | identical to Shopping Transaction Id (in which case | | |
| | | it can be omitted). | | |
| | Related Shopping Tran Id | A unique identifier for this TRAVEL | No | Yes |
| | | TRANSACTION. | | |
| | | The unique identifier of the instance of the | | |
| | | SHOPPING TRANSACTION entity that is related | | |
| | | to this instance. | | |
| | | It can be used to relate two SHOPPING | | |
| | | TRANSACTIONS, e.g.: when an order was | | |
| | | cancelled, and replaced by a new order, or when a | | |
| | | web shopping cart was replaced by an actual order, | | |
| | | or where one Transaction represents a Gift Registry | | |
| | | (or Wishlist), and is related to multiple purchase | | |
| | | SHOPPING TRANSACTIONs of guests buying | | |
| | | from the registry. | | |
| | Reported As Dttm | The accounting date for this SHOPPING | No | No |
| | | TRANSACTION | | |
| | Ship To Address Id | A number used to uniquely identify an ADDRESS. | No | Yes |
| | | The address of the “Ship To” Party. | | |
| | Ship To Party Id | The unique identifier for any individual or group of | No | Yes |
| | | individuals that is of interest to the enterprise. | | |
| | | The Party who will be receiving the Purchased | | |
| | | Items. | | |
| | Shopping Transaction Id | A unique identifier for this TRAVEL | Yes | Yes |
| | | TRANSACTION. | | |
| | Tran Status Cd | Unique identifier for a TRANSACTION STATUS. | No | Yes |
| | Tran Type Cd | Uniquely identifies the transaction type. | No | Yes |
| SHOPPING TRANSACTION | Enter Method Cd | Uniquely identifies the ENTER METHOD. | No | Yes |
| LINE | | | | |
| | Item Id | Unique Identifier for an Item. | No | Yes |
| | Item Qty | The total quantity number of items purchased in a | No | No |
| | | single transaction at the time of check-out. | | |
| | Orig Shopping Tran Id | A unique identifier for this TRAVEL | No | Yes |
| | | TRANSACTION. | | |
| | | The unique identifier for an instance of the | | |
| | | SHOPPING TRANSACTION LINE entity. This | | |
| | | refers to a previous, related sales transaction and | | |
| | | may be used as an audit aid, e.g. | | |
| | | Example: during the transaction one item is | | |
| | | cancelled and a new one created that references the | | |
| | | cancelled item. | | |
| | Orig Shopping Tran Line Num | Identifies a specific line within a SHOPPING | No | Yes |
| | | TRANSACTION. | | |
| | | The unique identifier for an instance of the | | |
| | | SHOPPING TRANSACTION LINE entity. This | | |
| | | refers to a previous, related sales transaction and | | |
| | | may be used as an audit aid, e.g. | | |
| | | Example: during the transaction one item is | | |
| | | cancelled and a new one created that references the | | |
| | | cancelled item. | | |
| | Page View Sequence Num | The ordinal number that sequences WEB PAGE | No | Yes |
| | | VIEW instances within the context of a particular | | |
| | | WEB VISIT (Visit Id) | | |
| | | If this transaction was made via a website, this | | |
| | | indicates the specific Web Page from which the | | |
| | | item was selected. | | |
| | Promised Fulfillment Dt | The fulfillment origination date indicated to the | No | No |
| | | customer. | | |
| | Shopping Transaction Id | A unique identifier for this TRAVEL | Yes | Yes |
| | | TRANSACTION. | | |
| | Shopping Transaction Line Num | Identifies a specific line within a SHOPPING | Yes | No |
| | | TRANSACTION. | | |
| | Tran Line Status Cd | Unique identifier for a TRANSACTION LINE | No | Yes |
| | | STATUS. | | |
| | Transaction Line Dttm | The date and time a SHOPPING TRANSACTION | No | No |
| | | LINE is created. | | |
| | Unit Cost Amt DD | The cost to the enterprise of a single ITEM. | No | No |
| | | This information may be derivable (see the ITEM | | |
| | | PRICING Subject Area) | | |
| | Unit List Price Amt | The ‘regular’ price offered to the CUSTOMER by | No | No |
| | | the Enterprise for each unit of an item. | | |
| | | It may or may not be the same as the actual price | | |
| | | sold for. | | |
| | Unit Selling Price Amt | Indicates the cost to the CUSTOMER for the total | No | No |
| | | transaction at the time of check-out. | | |
| | Web Visit Id | Unique identifier for the VISIT. | No | Yes |
| | | Uniquely identifies a visit to a web site. | | |
| | | If this transaction was made via a website, this | | |
| | | indicates the specific Web Visit. | | |
| SHORT TERM DEBT ACCOUNT | GL Main Account Num | The unique Chart of Account code for the GL | Yes | Yes |
| | | MAIN ACCOUNT. | | |
| SIC | SIC Cd | A code for the Standard Industry Classification | Yes | No |
| | | which is a method for classifying businesses by the | | |
| | | type of business they are active in, such as services | | |
| | | or manufacturing. | | |
| | SIC Desc | A textual description of the SIC code. | No | No |
| SLOT CABINET | Cabinet Cd | Uniquely identifies a Slot Cabinet. | Yes | No |
| | Cabinet Desc | Description of the cabinet style. | No | No |
| SLOT EQUIP SERIES | Bill Validator Ind | Indicates if the machine is capable of accepting | No | No |
| | | paper money. | | |
| | Cabinet Cd | Uniquely identifies a Slot Cabinet. | No | Yes |
| | Denomination Amt | Used for equipment with a fixed denomination. | No | No |
| | | The monetary value of a waging unit. | | |
| | Equip Series Id | Uniquely identifies a particular series of | Yes | Yes |
| | | equipment. | | |
| | Ticket Ind | Indicates if the machine is capable of using printed | No | No |
| | | tickets as buy-ins and pay-outs. | | |
| SLOT GAME CONFIG | EPROM Config Id | Uniquely identifies all EPROMs that contains a | No | No |
| | | specific Slot Game Configuration program. | | |
| | | All Slot Machines containing this type of EPROM | | |
| | | will offer identical play and odds. | | |
| | Game Config Id | Uniquely identifies a specific Game Configuration. | Yes | Yes |
| SLOT GAME STATION | EPROM Seal Dt | The date the EPROM seal was placed on an | No | No |
| | | EPROM chip. | | |
| | EPROM Seal Num | The unique number assigned to an EPROM seal, | No | No |
| | | required by some states to guard against tampering. | | |
| | Game Equip Id | Uniquely identifies an Equipment Instance. | Yes | Yes |
| SLOT SESSION | Actual Player Win Amt DD | The total net amount won by the player. | No | No |
| | | This can be calculated by subtracting the total buy- | | |
| | | in amount from the total payout amount. | | |
| | | This amount can be negative or positive. | | |
| | Avg Bet Amt DD | The average size of bet made by the player during | No | No |
| | | the session. | | |
| | | Can be calculated by dividing the Turnover amount | | |
| | | by the number of rounds played. | | |
| | Avg Wager Cnt | The average number of Wagers made in a Round. | No | No |
| | | Example: | | |
| | | a player plays 3 hands during a blackjack game | | |
| | | a player plays 5 lines on a slot machine | | |
| | Buy-In Amt | The total amount the player presents to wager with. | No | No |
| | | Note: This is not the same as the wagered amount, | | |
| | | since the entire buy-in amount can usually be | | |
| | | retracted by the player prior to, or instead of | | |
| | | placing it at risk. | | |
| | | Also known as coin-in, drop, etc., depending on | | |
| | | game type. | | |
| | Jackpot Amt | The total amount of jackpots won by the player. | No | No |
| | Jackpot Cnt | The number of jackpots won by the player. | No | No |
| | Max Bet Amt | The largest bet made by the player during the | No | No |
| | | session. | | |
| | Min Bet Amt | The smallest bet made by the player during the | No | No |
| | | session. | | |
| | Payout Amt | The total amount paid out to the player. | No | No |
| | | Note: To get the net player win/loss, this amount | | |
| | | need to be subtracted from the buy-in amount. | | |
| | Rounds Played Cnt | The number of hands, rounds, or games played. | No | No |
| | | Could also be called spins, throws, etc. depending | | |
| | | on the game type. | | |
| | Session End Dttm | The end of a rated gaming session (that is, a | No | No |
| | | gaming session where the identity of the player is | | |
| | | known). | | |
| | Session Start Dttm | The start of a rated gaming session (that is, a | Yes | Yes |
| | | gaming session where the identity of the player is | | |
| | | known). | | |
| | Slot Hand Pay Amt | The total Payout amount that had to manually | No | No |
| | | dispensed (not paid by the machine). | | |
| | | This happens typically due to jackpots (legal | | |
| | | purposes), or where the machine had insufficient | | |
| | | money to dispense. | | |
| | | Used mainly for Slot games. | | |
| | Slot Hopper Fill Amt | The total amount of money placed into the machine | No | No |
| | | by the Casino. | | |
| | | Used mainly for Slot games. | | |
| | Theo Player Win Amt DD | Using the theoretical win percentages and the | No | No |
| | | turnover amount, we can calculate the amount the | | |
| | | player “should” have won in theory. | | |
| | | This amount can be negative or positive. | | |
| | Turnover Amt | This is the total amount actually wagered (or | No | No |
| | | placed at risk) by the player. | | |
| | | Note that this amount can greatly exceed the buy-in | | |
| | | amount. | | |
| | | Also known as Handle, Gross (or Total) Wager | | |
| | | Amount, etc., depending on game type. | | |
| | Visit Id | The unique identifier for an instance of the VISIT | Yes | Yes |
| | | entity. | | |
| SPA | Spa Location Id | Uniquely identifies a LOCATION. | Yes | Yes |
| | | A sub-type of location for sale/consumption of | | |
| | | SPA PRODUCTs/SERVICE. | | |
| SPA RESERVATION | Reservation Seq Num | This attribute identifies a specific RESERVATION | Yes | Yes |
| | | ITEM. | | |
| | Reservation Transaction Id | A unique identifier for this TRAVEL | Yes | Yes |
| | | TRANSACTION. | | |
| SPECIAL EVENT | Reservation Seq Num | This attribute identifies a specific RESERVATION | Yes | Yes |
| RESERVATION | | ITEM. | | |
| | Reservation Transaction Id | A unique identifier for this TRAVEL | Yes | Yes |
| | | TRANSACTION. | | |
| SPECIAL EVENTS AGENCY | Agency Party Id | The unique identifier for an external organization. | Yes | Yes |
| SPECIAL EVENTS AGENCY | Agency Party Id | The unique identifier for an external organization. | No | Yes |
| CONTACT | | | | |
| | Events Agency Contact Id | The unique identifier for an individual. | Yes | Yes |
| SPECIAL RATE | Pricing Id | Identifies a specific price for an Item. | Yes | Yes |
| | | Note: You typically have multiple Pricing Ids (and | | |
| | | prices) for the same Item. This can be due to: | | |
| | | date (price change over time) | | |
| | | condition set (different price by channel, | | |
| | | region, etc.) | | |
| | | volume scale (lower price based on volume | | |
| | | purchase) | | |
| | | etc. | | |
| | Rate Amt | The specific monetary rate amount associated with | No | No |
| | | this SPECIAL RATE service. | | |
| | Service Item Id | Unique Identifier for an Item. | Yes | Yes |
| | | A non-physical type of ITEM sold to a customer | | |
| | | a.k.a. providing a TRANSPORT SERVICE to a | | |
| | | customer. | | |
| SPECIAL REQUEST | Request Id | A unique identifier associated with a SPECIAL | Yes | No |
| | | REQUEST entity. | | |
| | Request Type Cd | This attribute is the identifier of a type of | Yes | Yes |
| | | SPECIAL REQUEST. | | |
| | | Example: | | |
| | | KM = Kosher Meal | | |
| | | VM = Vegetarian Meal | | |
| | | WC = Wheel Chair | | |
| | | SL = Spanish Language Interpreter | | |
| | | etc. | | |
| | Reservation Seq Num | This attribute identifies a specific RESERVATION | No | Yes |
| | | ITEM. | | |
| | Reservation Transaction Id | A unique identifier for this TRAVEL | No | Yes |
| | | TRANSACTION. | | |
| | Satisfied Ind | The request was met to the customer's satisfaction. | No | No |
| | Special Request Charge Amt | Any charge associated with a special request. | No | No |
| | | Examples: Taking a pet along with the passenger | | |
| | Trip Event Num | A unique number assigned to a TRIP EVENT | No | Yes |
| | | entity. | | |
| | | Used if the request is related to a Trip. | | |
| SPECIAL SERVICE | Special Service Item Id | Unique Identifier for an Item. | Yes | Yes |
| | | Services sold in addition to the physical | | |
| | | transportation of goods. Also known as | | |
| | | Assessorial/Accessorial Services. | | |
| SPORTS BET TYPE | Sports Bet Type Cd | A code for classifying the type of SPORTS BET | Yes | No |
| | Sports Bet Type Desc | Classification description of the type of SPORTS | No | No |
| | | BET | | |
| SPORTS BOOK BETS | Session Start Dttm | The start of a rated gaming session (that is, a | Yes | Yes |
| | | gaming session where the identity of the player is | | |
| | | known). | | |
| | Sports Bet Type Cd | A code for classifying the type of SPORTS BET | No | Yes |
| | Sports Book Bet Amt | The amount of money wagered against an outcome | No | No |
| | | of a SPORTS EVENT. | | |
| | Sports Book Casino Adv Pct | The advantage in percentage that the CASINO | No | No |
| | | holds against the players in a SPORTS BOOK | | |
| | | SESSION | | |
| | Sports Book Seq Num | A sequence number to track the individual bets in a | Yes | No |
| | | SPORTS BOOK SESSION | | |
| | Sports Book Win Amt | The total amount won as a result of winning the | No | No |
| | | SPORTS BOOK bet. | | |
| | Sports Book Win Ind | An indicator showing that the bet resulted in a win | No | No |
| | | for the CASINO PLAYER | | |
| | Sports Event Id | Unique identifier for a SPORTS EVENT. The | No | Yes |
| | | identifier lists each team in a SPORTS EVENT as | | |
| | | opposed to the event itself | | |
| | Visit Id | The unique identifier for an instance of the VISIT | Yes | Yes |
| | | entity. | | |
| SPORTS BOOK SESSION | Session Start Dttm | The start a rated gaming session (that is, a | Yes | Yes |
| | | gaming session where the identity of the player is | | |
| | | known). | | |
| | Visit Id | The unique identifier for an instance of the VISIT | Yes | Yes |
| | | entity. | | |
| SPORTS EVENT | Sports Event Desc | Description information for the SPORTS EVENT | No | No |
| | Sports Event Id | Unique identifier for a SPORTS EVENT. The | Yes | No |
| | | identifier lists each team in a SPORTS EVENT as | | |
| | | opposed to the event itself | | |
| | Sports Event Type Cd | Code for classifying SPORTS EVENTS. | No | Yes |
| SPORTS EVENT TYPE | Sports Event Type Cd | Code for classifying SPORTS EVENTS. | Yes | No |
| | Sports Event Type Desc | Description information for classifying SPORTS | No | No |
| | | EVENTS. | | |
| STATE TYPE | State Type Cd | Uniquely identifies a STATE TYPE. | Yes | No |
| | State Type Desc | Narrative text describing a STATE TYPE. | No | No |
| STD MAINT | Maint A B C D level Cd | The Maintenance Level specified. | No | No |
| | | Example “A” Check, “C” Check, etc. | | |
| | Maint Spec Id | Uniquely identifies a MRO Specification. | Yes | Yes |
| STORE | Location Id | Uniquely identifies a LOCATION. | Yes | Yes |
| | | A physical retail outlet - “brick and mortar”. | | |
| | Store Cluster Cd | Uniquely identifies a store cluster. | No | Yes |
| | Store Concept Cd | Uniquely identifies a Store Concept Cd. | No | Yes |
| | Store Format Cd | Uniquely identifies a store format. | No | Yes |
| STORE CLUSTER | Store Cluster Cd | Uniquely identifies a store cluster. | Yes | No |
| | Store Cluster Desc | Narrative text describing a store cluster. | No | No |
| | Store Cluster Name | Short text reference or label for a store cluster. | No | No |
| STORE CONCEPT | Store Concept Cd | Uniquely identifies a Store Concept Cd. | Yes | No |
| | Store Concept Desc | Narrative text describing a Store Concept Desc. | No | No |
| STORE FORMAT | Store Format Cd | Uniquely identifies a store format. | Yes | No |
| | Store Format Desc | Narrative text describing a store format. | No | No |
| SUPPL CERT (STN) | Issue Dt IDE | The Date the Specification was issued. | No | No |
| | MRO Spec Id OII | Uniquely identifies a MRO Specification. | Yes | Yes |
| SUPPLY LOCATION | Destination Loc Id | Unique identifier for a LOCATION. | Yes | Yes |
| | | The target location (to). | | |
| | Item Id ASN | Unique Identifier for an Item. | Yes | Yes |
| | | A subset of (physical) items than can be | | |
| | | inventoried, and shelved. This would exclude | | |
| | | service items and virtual items (downloadable | | |
| | | products). | | |
| | Item Lead Tm | The amount of time typically needed to get the item | No | No |
| | | ready to be shipped or transported. | | |
| | Origin Loc Id | Unique identifier for a LOCATION. | Yes | Yes |
| | | The source location (from). | | |
| | Preferred Supply Loc Ind | Indicates that this is the preferred source location to | No | No |
| | | be used to supply the destination location with the | | |
| | | item. | | |
| | Ship Lead Tm | The amount of time it typically takes to ship or | No | No |
| | | transport the item between the two locations using | | |
| | | the default mode of transport. | | |
| SURVEY FEEDBACK | Feedback Id | Uniquely identifies an instance of Quality | Yes | Yes |
| | | Feedback. Typically system assigned. | | |
| | Survey Id | Uniquely identifies a Quality Survey. | No | Yes |
| SURVEY QUESTION RESPONSE | Feedback Id | Uniquely identifies an instance of Quality | Yes | Yes |
| | | Feedback. Typically system assigned. | | |
| | Quality Rating Num | The response to a survey item expressed as a | No | No |
| | | number. | | |
| | | Example: | | |
| | | rated ‘friendliness of staff’ as a 3 out of 5 | | |
| | | used to select desired response to a ‘multiple | | |
| | | choice’ prompt | | |
| | Quality Rating Txt | The response to a survey item expressed in text | No | No |
| | | format. | | |
| | | Example: | | |
| | | response to “how can we best improve our | | |
| | | service?” | | |
| | Survey Id | Uniquely identifies a Quality Survey. | Yes | Yes |
| | Survey Line Num | Uniquely identifies a specific survey item or | Yes | Yes |
| | | question on a survey. | | |
| SVC BULLETIN (SBN) | AW Directive Num ARW | Airworthiness Directive Number (Spec 2000) | No | No |
| | Compliance Cd SCC | S2000 code that indicates the compliance nature of | No | No |
| | | the Service Bulletin. | | |
| | | Example: | | |
| | | Mandatory | | |
| | | Optional | | |
| | | Recommended | | |
| | | Note: This code look-up table must be supplied by | | |
| | | the airline in conjunction with Spec 2000 | | |
| | | definitions. | | |
| | Issue Dt IDE | The Date the Specification was issued. | No | No |
| | MRO Spec Id EON | Uniquely identifies a MRO Specification. | Yes | Yes |
| SWEEPSTAKE ENTRY | Entry Dttm | The date and time of a valid Sweepstake Entry by a | Yes | No |
| | | Customer. | | |
| | Loyalty Account Id | Uniquely identifies an ACCOUNT. | Yes | Yes |
| | Session Start Dttm | The start of a rated gaming session (that is, a | No | Yes |
| | | gaming session where the identity of the player is | | |
| | | known). | | |
| | Sweepstake Promo Id | The unique identifier for the promotion. | Yes | Yes |
| | | Specifies a specific Sweepstake. | | |
| | Visit Id | The unique identifier for an instance of the VISIT | No | Yes |
| | | entity. | | |
| T&T FACILITY | T&T Facility Id | Uniquely identifies a LOCATION. | Yes | Yes |
| | | A Travel and Transportation Facility Location. | | |
| | T&T Facility Type Cd | A code used to identify the type of T&T | No | Yes |
| | | FACILITY. | | |
| T&T FACILITY GROUP | T&T Facility Group Cd | Uniquely identifies a T&T FACILITY GROUP. | Yes | No |
| | T&T Facility Group Desc | A textual description for a grouping of T&T | No | No |
| | | FACILITIES used for Marketing or Analytical | | |
| | | purposes. | | |
| T&T FACILITY GROUP XREF | T&T Facility Group Cd | Uniquely identifies a T&T FACILITY GROUP. | Yes | Yes |
| | T&T Facility Id | Uniquely identifies a LOCATION. | Yes | Yes |
| | | A Travel and Transportation Facility Location. | | |
| T&T FACILITY TYPE | T&T Facility Type Cd | A code used to identify the type of T&T | Yes | No |
| | | FACILITY. | | |
| | T&T Facility Type Desc | A textual description of a T&T FACILITY type. | No | No |
| TABLE GAME CONFIG | Game Config Id | Uniquely identifies a specific Game Configuration. | Yes | Yes |
| | Max Hourly Games Cnt | The number of games that this table configuration | No | No |
| | | can support per hour. | | |
| | Max Player Cnt | The maximum number of Players that can wager at | No | No |
| | | this Gaming Station at the same time. | | |
| TABLE GAME STATION | Game Equip Id | Uniquely identifies an Equipment Instance. | Yes | Yes |
| TABLE SESSION | Actual Player Win Amt DD | The total net amount won by the player. | No | No |
| | | This can be calculated by subtracting the total buy- | | |
| | | in amount from the total payout amount. | | |
| | | This amount can be negative or positive. | | |
| | Avg Bet Amt DD | The average size of bet made by the player during | No | No |
| | | the session. | | |
| | | Can be calculated by dividing the Turnover amount | | |
| | | by the number of rounds played. | | |
| | Avg Wager Cnt | The average number of Wagers made in a Round. | No | No |
| | | Example: | | |
| | | a player plays 3 hands during a blackjack game | | |
| | | a player plays 5 lines on a slot machine | | |
| | Buy-In Amt | The total amount the player presents to wager with. | No | No |
| | | Note: This is not the same as the wagered amount, | | |
| | | since the entire buy-in amount can usually be | | |
| | | retracted by the player prior to, or instead of | | |
| | | placing it at risk. | | |
| | | Also known as coin-in, drop, etc., depending on | | |
| | | game type. | | |
| | Jackpot Amt | The total amount of jackpots won by the player. | No | No |
| | Jackpot Cnt | The number of jackpots won by the player. | No | No |
| | Max Bet Amt | The largest bet made by the player during the | No | No |
| | | session. | | |
| | Min Bet Amt | The smallest bet made by the player during the | No | No |
| | | session. | | |
| | Payout Amt | The total amount paid out to the player. | No | No |
| | | Note: To get the net player win/loss, this amount | | |
| | | need to be subtracted from the buy-in amount. | | |
| | Rounds Played Cnt | The number of hands, rounds, or games played. | No | No |
| | | Could also be called spins, throws, etc. depending | | |
| | | on the game type. | | |
| | Seat Num | Identifies the position or seat the player occupied at | No | No |
| | | the table. | | |
| | Session End Dttm | The end of a rated gaming session (that is, a | No | No |
| | | gaming session where the identity of the player is | | |
| | | known). | | |
| | Session Start Dttm | The start of a rated gaming session (that is, a | Yes | Yes |
| | | gaming session where the identity of the player is | | |
| | | known). | | |
| | Table Avg Player Cnt | The number of players (on average) per round | No | No |
| | | during the session. | | |
| | | Used mainly for Table games. | | |
| | Theo Player Win Amt DD | Using the theoretical win percentages and the | No | No |
| | | turnover amount, we can calculate the amount the | | |
| | | player “should” have won in theory. | | |
| | | This amount can be negative or positive. | | |
| | Turnover Amt | This is the total amount actually wagered (or | No | No |
| | | placed at risk) by the player. | | |
| | | Note that this amount can greatly exceed the buy-in | | |
| | | amount. | | |
| | | Also known as Handle, Gross (or Total) Wager | | |
| | | Amount, etc., depending on game type. | | |
| | Visit Id | The unique identifier for an instance of the VISIT | Yes | Yes |
| | | entity. | | |
| TASK | Parent Task Id | Parent Task Id identifies the Summary TASK | No | Yes |
| | | group to which the Task Id belongs. | | |
| | Task Desc | The description for the TASK. | No | No |
| | Task Id | The unique identifier assigned to a TASK. | Yes | No |
| | Task Name | The name assigned to a TASK. | No | No |
| TELEPHONE ADDRESS | Telephone Address Id | A number used to uniquely identify a | Yes | Yes |
| | | TELEPHONE. | | |
| | Telephone Area Cd | A set of digits in a telephone number that represent | No | No |
| | | the area code. The number of digits may vary by | | |
| | | country. | | |
| | Telephone Country Cd | A set of digits in a telephone number that represent | No | No |
| | | the country. The number of digits vary by country. | | |
| | Telephone Exchange Num | A set of digits in a telephone number that represent | No | No |
| | | a central office exchange. The number of digits | | |
| | | may vary by country. | | |
| | Telephone Extension Num | The extension for the phone. This may be null if no | No | No |
| | | extension applies to this number. | | |
| | Telephone Home Ind | Indicator for whether the Telephone is a Home | No | No |
| | | number. | | |
| | Telephone Line Num | A set of digits in a telephone number that represent | No | No |
| | | the line number from the central office. The | | |
| | | number of digits may vary by country. | | |
| | Telephone Wireline Ind | Indicator for whether the Telephone is a Wireline | No | No |
| | | number. | | |
| TELEPHONE COMM TYPE | Telephone Address Id | A number used to uniquely identify a | Yes | Yes |
| XREF | | TELEPHONE. | | |
| | Telephone Comm Type Cd | A code used to uniquely identify the TELEPHONE | Yes | Yes |
| | | COMMUNICATION TYPE. | | |
| TELEPHONE | Telephone Comm Type Cd | A code used to uniquely identify the TELEPHONE | Yes | No |
| COMMUNICATION TYPE | | COMMUNICATION TYPE. | | |
| | Telephone Comm Type Desc | A textual description for a TELEPHONE | No | No |
| | | COMMUNICATION TYPE. | | |
| | Telephone Comm Type Name | The name assigned to a TELEPHONE | No | No |
| | | COMMUNICATION TYPE. | | |
| TERRITORY | Country Cd | The unique code for an instance of the COUNTRY | No | Yes |
| | | entity. | | |
| | Territory Cd | The unique code for an instance of the | Yes | No |
| | | TERRITORY entity. | | |
| | Territory Name | The name for an instance of the TERRITORY | No | No |
| | | entity. | | |
| | Time Zone Cd | The unique code for a time zone. | No | Yes |
| TICKET | Delivery Cd | The domain of delivery types for a ticket. | No | No |
| | | Example: Mailed, E-Ticketed, Customer Pick-Up, | | |
| | | etc | | |
| | Purchase Tran Id | A unique identifier for this TRAVEL | No | Yes |
| | | TRANSACTION. | | |
| | Ticket Desc | A textual description of a specific instance of a | No | No |
| | | TICKET. | | |
| | Ticket Format Cd | Uniquely identifies the kind or type of ticket. | No | Yes |
| | Ticket Id | A unique identifier for a TICKET. | Yes | No |
| | Ticket Issue Dt | The calendar day that a ticket was issued, either as | No | No |
| | | an E-Ticket, or printed on airline paper stock. | | |
| | Ticket Type Cd | An identifier for a TICKET subtype. | No | Yes |
| | | Example: 1- BUS TICKET, 2- AIRLINE TICKET, | | |
| | | 3- RAILROAD TICKET, etc. | | |
| TICKET AWARD | Award Voucher Id | The identifier of a loyalty award or certificate | Yes | Yes |
| | | awarded to a customer account. | | |
| | Ticket Id | A unique identifier for a TICKET. | No | Yes |
| TICKET AWARD CERTIFICATE | Payment Tran Id | Uniquely identifies a Payment. | Yes | Yes |
| TICKET FORMAT | Ticket Format Cd | Uniquely identifies the kind or type of ticket. | Yes | No |
| | Ticket Format Desc | A textual description of the kind or type of Ticket. | No | No |
| | | It is used distinguish between ATB2, E-Ticket, and | | |
| | | Manual types. | | |
| | | Example: A = ATB2, E = E-Ticket, | | |
| | | M = Manual, etc | | |
| TICKET PAYMENT | Applied Purchase Amt | This attribute is the monetary amount presented by | No | No |
| | | the purchaser to compensate or partially | | |
| | | compensate for a PURCHASE. | | |
| | Payment Tran Id | Uniquely identifies a Payment. | Yes | Yes |
| | Ticket Id | A unique identifier for a TICKET. | Yes | Yes |
| TICKET TYPE | Ticket Type Cd | An identifier for a TICKET subtype. | Yes | No |
| | | Example: 1- BUS TICKET, 2- AIRLINE TICKET, | | |
| | | 3-RAILROAD TICKET, etc. | | |
| | Ticket Type Desc | A textual description of a TICKET subtype. | No | No |
| | | Example: BUS TICKET, CRUISE LINE TICKET, | | |
| | | AIRLINE TICKET, etc. | | |
| TIME ZONE | Time Zone Cd | The unique code for a time zone. | Yes | No |
| | Time Zone Name | The name of the time zone. | No | No |
| | UCT Offset Tm | The delta between UCT (Coordinated Universal | No | No |
| | | Time) and the time in the time zone. | | |
| | | Note: The structure need to be enhanced if daylight | | |
| | | savings or complex requirements need to be | | |
| | | handled. | | |
| TRAIT | Trait Cd | Uniquely identifies a TRAIT. | Yes | No |
| | Trait Desc | Narrative text describing the TRAIT. | No | No |
| | Trait Group Cd | Uniquely identifies a TRAIT GROUP. | No | Yes |
| TRAIT GROUP | Trait Group Cd | Uniquely identifies a TRAIT GROUP. | Yes | No |
| | Trait Group Desc | Narrative text describing the TRAIT GROUP. | No | No |
| TRAIT VALUE | Trait Cd | Uniquely identifies a TRAIT. | Yes | Yes |
| | Trait Val | The amount or quantity describing a TRAIT | No | No |
| | | VALUE. | | |
| | Trait Value Cd | Unique identifier for a TRAIT VALUE. | Yes | No |
| | Trait Value Desc | Narrative text describing the TRAIT VALUE. | No | No |
| | Trait Value UOM Cd | Uniquely identifies a unit of measure. | No | Yes |
| | | Applies only to the Trait Val if that attribute is | | |
| | | populated and if it is appropriate. | | |
| | | Example: waist size of 34 measured in inches. | | |
| TRAN EQUIP POWER | End Dttm | Marks the end of the association between the | No | No |
| | | Power Equipment and the Transportation | | |
| | | Equipment it is installed in. | | |
| | Position Num EPC | Indicates the position of the Power Equipment in | No | No |
| | | the Transport Equipment. | | |
| | | Aircraft Example: | | |
| | | Engine Number 3 | | |
| | Power Equip Id OIN | Uniquely identifies an Equipment Instance. | Yes | Yes |
| | Start Dttm | Marks the beginning of the association between the | Yes | No |
| | | Power Equipment and the Transportation | | |
| | | Equipment it is installed in. | | |
| | Tran Equip Id OIN | Uniquely identifies a piece of Equipment that can | Yes | Yes |
| | | be used to transport individuals or cargo. | | |
| TRANSACTION DISCOUNT | Coupon Serial Num | The actual serial number appearing on an issued | No | Yes |
| | | COUPON. | | |
| | Discount Amt | The total amount of the discount given | No | No |
| | Discount Cd | The unique identifier for an instance of the | No | Yes |
| | | DISCOUNT entity. | | |
| | External Coupon Id | The unique identifier for an instance of the | No | Yes |
| | | EXTERNAL COUPON entity. | | |
| | Promo Offer Id | The unique identifier for a promo offer. | No | Yes |
| | Purchase Tran Id | A unique identifier for this TRAVEL | Yes | Yes |
| | | TRANSACTION. | | |
| | Tran Discnt Line Num | Identifies a specific line within a SHOPPING | Yes | No |
| | | TRANSACTION DISCOUNT. | | |
| TRANSACTION GROUP | Tran Group Cd | Uniquely identifies the transaction group. | Yes | No |
| | Tran Group Desc | Narrative text describing the transaction group. | No | No |
| TRANSACTION LINE STATUS | Tran Group Cd | Uniquely identifies the transaction group. | No | Yes |
| | Tran Line Status Cd | Unique identifier for a TRANSACTION LINE | Yes | No |
| | | STATUS. | | |
| | Tran Line Status Desc | Narrative text describing the TRANSACTION | No | No |
| | | LINE STATUS. | | |
| TRANSACTION STATUS | Tran Group Cd | Uniquely identifies the transaction group. | No | Yes |
| | Tran Status Cd | Unique identifier for a TRANSACTION STATUS. | Yes | No |
| | Tran Status Desc | Narrative text describing the TRANSACTION | No | No |
| | | STATUS. | | |
| TRANSACTION TYPE | Tran Group Cd | Uniquely identifies the transaction group. | No | Yes |
| | Tran Type Cd | Uniquely identifies the transaction type. | Yes | No |
| | Tran Type Desc | Narrative text describing the transaction type. | No | No |
| TRANSFER EVENT | Ship Event Id | Uniquely identifies a SHIPPING EVENT. | Yes | Yes |
| TRANSIT STATE | Destination Facility Id | Uniquely identifies a LOCATION. | No | Yes |
| | Equip Id OIN | Uniquely identifies an Equipment Instance. | No | Yes |
| | Flight Num DFN | A unique identifier assigned to a Flight scheduled | No | Yes |
| | | for generating revenue and utilized by the general | | |
| | | public. | | |
| | Origin Facility Id | Uniquely identifies a LOCATION. | No | Yes |
| | Piece Num | Uniquely identifies a PIECE contained in a | Yes | Yes |
| | | SHIPMENT. | | |
| | | This can often be thought of as a “Tracking | | |
| | | Number” | | |
| | Sched Leg Depart Dttm TME | The scheduled departure date and time of a LEG. | No | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| | Start Event Id | A unique identifier for a SHIPPING EVENT. | Yes | Yes |
| | | The event that triggers the start of the current state. | | |
| TRANSMITTAL MODE TYPE | Transmittal Mode Type Cd | The code for a TRANSMITTAL MODE. | Yes | No |
| | Transmittal Mode Type Desc | The description for a TRANSMITTAL MODE. | No | No |
| TRANSPORT EQUIP | Cargo Config Id | Uniquely identifies a Cargo Configuration. | No | Yes |
| | Equip Id OIN | Uniquely identifies a piece of Equipment that can | Yes | Yes |
| | | be used to transport individuals or cargo. | | |
| | Passenger Config Id | Uniquely identifies a specific passenger | No | Yes |
| | | configuration. | | |
| | Transport Type Cd | Uniquely identifies a Transport Type. | No | Yes |
| TRANSPORT PURCHASE ITEM | PNR Create Dt | The creation date of a PNR. This is needed to | No | Yes |
| | | uniquely identify a PNR, since PNR numbers are | | |
| | | re-used over time. | | |
| | PNR Num | Uniquely identifies a specific occurrence of a PNR. | No | Yes |
| | Purchase Seq Num | An identifier for a specific PURCHASE ITEM | Yes | Yes |
| | | entity. | | |
| | Purchase Tran Id | A unique identifier for this TRAVEL | Yes | Yes |
| | | TRANSACTION. | | |
| | Ticket Id | A unique identifier for a TICKET. | No | Yes |
| | Travel Coupon Id | The ordering of a series of one or more TRAVEL | No | Yes |
| | | COUPONs associated with a single Ticket or | | |
| | | Conjunctive Ticket series. | | |
| TRANSPORT RATE | Class Rating Cd | Uniquely identifies the CLASS RATING. | No | Yes |
| | From Zone Cd | The unique identifier for an instance of the ZONE | No | Yes |
| | | entity. | | |
| | | The departure Zone. | | |
| | Pricing Id | Identifies a specific price for an Item. | Yes | Yes |
| | | Note: You typically have multiple Pricing Ids (and | | |
| | | prices) for the same Item. This can be due to: | | |
| | | date (price change over time) | | |
| | | condition set (different price by channel, | | |
| | | region, etc.) | | |
| | | volume scale (lower price based on volume | | |
| | | purchase) | | |
| | | etc. | | |
| | Rate Amt | The specific monetary rate amount associated with | No | No |
| | | this TRANSPORT service. Typically x$/ton or | | |
| | | y$/piece. | | |
| | Service Item Id | Unique Identifier for an Item. | Yes | Yes |
| | | A non-physical type of ITEM sold to a customer | | |
| | | a.k.a. providing a TRANSPORT SERVICE to a | | |
| | | customer. | | |
| | To Zone Cd | The unique identifier for an instance of the ZONE | No | Yes |
| | | entity. | | |
| | | The destination Zone. | | |
| | Weight Break Cd | Uniquely identifies a WEIGHT BREAK. | No | Yes |
| TRANSPORT SERVICE CLASS | Transport Svc Class Cd | Uniquely identifies a Transport Service Class. | Yes | No |
| | Transport Svc Class Desc | Textual description of a Transport Service Class. | No | No |
| TRANSPORT SERVICE ITEM | Service Item Id | Unique Identifier for an Item. | Yes | Yes |
| | | An ITEM used or sold to a customer as part of | | |
| | | providing a TRANSPORT SERVICE. | | |
| TRANSPORT SERVICE RATE | Pricing Id | Identifies a specific price for an Item. | Yes | Yes |
| | | Note: You typically have multiple Pricing Ids (and | | |
| | | prices) for the same Item. This can be due to: | | |
| | | date (price change over time) | | |
| | | condition set (different price by channel, | | |
| | | region, etc.) | | |
| | | volume scale (lower price based on volume | | |
| | | purchase) | | |
| | | etc. | | |
| | Rate Type Cd | Indicates the type of service rate (transport rate, | No | No |
| | | special rate) | | |
| | Service Item Id | Unique Identifier for an Item. | Yes | Yes |
| | | An ITEM used or sold to a customer as part of | | |
| | | providing a TRANSPORT SERVICE. | | |
| TRANSPORT TRIP EVENT | Ticket Id | A unique identifier for a TICKET. | No | Yes |
| | Transport Trip Event Type Cd | Code specifying the type of TRANSPORT TRIP | No | Yes |
| | | EVENT | | |
| | Travel Coupon Id | The ordering of a series of one or more TRAVEL | No | Yes |
| | | COUPONs associated with a single Ticket or | | |
| | | Conjunctive Ticket series. | | |
| | Trip Event Num | A unique number assigned to a TRIP EVENT | Yes | Yes |
| | | entity. | | |
| TRANSPORT TRIP EVENT TYPE | Transport Trip Event Type Cd | Code specifying the type of TRANSPORT TRIP | Yes | No |
| | | EVENT | | |
| | Transport Trip Event Type Desc | Description of the TRANSPORT TRIP EVENT | No | No |
| | | classification | | |
| TRANSPORT TYPE | Transport Type Cd | Uniquely identifies a Transport Type. | Yes | No |
| | Transport Type Desc | Textual description for a Transport Type. | No | No |
| TRANSPORT ZONE | Transport Zone Cd | Uniquely identifies a Transport Zone. | Yes | No |
| | Transport Zone Desc | Narrative text describing a Transport Zone. | No | No |
| TRANSPORTATION SERVICE | Service Item Id | Unique Identifier for an Item. | Yes | Yes |
| | | The different service products that a company | | |
| | | offers from a Transportation perspective that | | |
| | | involves the physical transportation of goods. | | |
| | Transport Svc Class Cd | Uniquely identifies a Transport Service Class. | No | Yes |
| TRANSPORTED PASSENGER | Booking Class Cd | The booking class code associated with this | No | Yes |
| | | particular booking, (i.e. F, Y, M, etc.). | | |
| | Flight Product Id | Unique Identifier for an Item. | No | Yes |
| | | A distance based TRAVEL PRODUCT that is | | |
| | | defined by Origination and Destination (O&D), | | |
| | | weekday of departure and time of departure. | | |
| | | An Airline Flight. | | |
| | Sched Seg Depart Dttm | The scheduled departure date and time of a | No | Yes |
| | | SEGMENT. | | |
| | | Note: This departure date and time is usually | | |
| | | identical to the departure date and time of the first | | |
| | | LEG of the SEGMENT. | | |
| | Ticket Id | A unique identifier for a TICKET. | Yes | Yes |
| | Travel Coupon Id | The ordering of a series of one or more TRAVEL | Yes | Yes |
| | | COUPONs associated with a single Ticket or | | |
| | | Conjunctive Ticket series. | | |
| TRAVEL AGENCY | IATA Cd | The International Air Transportation Association | No | No |
| | | number assigned to a specified travel agency. | | |
| | Travel Agency Id | The unique identifier for an external organization. | Yes | Yes |
| | Travel Agency Type Cd | A code that identifies the type of TRAVEL | No | No |
| | | AGENCY. | | |
| | | Example: 1-Consolidators/Reseller, 2- | | |
| | | Wholesalers, 3-Tour Brokers, etc. | | |
| TRAVEL COUPON | Flight Product Id | Unique Identifier for an Item. | No | Yes |
| | | A distance based TRAVEL PRODUCT that is | | |
| | | defined by Origination and Destination (O&D), | | |
| | | weekday of departure and time of departure. | | |
| | | An Airline Flight. | | |
| | Sched Seg Depart Dttm | The scheduled departure date and time of a | No | Yes |
| | | SEGMENT. | | |
| | | Note: This departure date and time is usually | | |
| | | identical to the departure date and time of the first | | |
| | | LEG of the SEGMENT. | | |
| | Ticket Id | A unique identifier for a TICKET. | Yes | Yes |
| | Travel Coupon Fare Amt | The amount paid by a certain PARTY in the | No | No |
| | | referenced TRAVEL COUPON. | | |
| | Travel Coupon Id | The ordering of a series of one or more TRAVEL | Yes | No |
| | | COUPONs associated with a single Ticket or | | |
| | | Conjunctive Ticket series. | | |
| TRAVEL PARTNER | Alliance Ind | Indicates if the partner is a member of the | No | No |
| | | Enterprise Alliance. | | |
| | Partner Party Id | The unique identifier for an external organization. | Yes | Yes |
| TRAVEL PASS PAYMENT | Payment Tran Id | Uniquely identifies a Payment. | Yes | Yes |
| | Travel Pass Id | The identifier of a special travel account such as a | No | No |
| | | Universal Airline Travel Pass (UATP) card where | | |
| | | pre-purchased miles are deducted for receiving a | | |
| | | Ticket | | |
| TRAVEL PAYMENT | Payment Tran Id | Uniquely identifies a Payment. | Yes | Yes |
| TRAVEL PRODUCT | Product Desc | A brief textual description of an instance of the | No | No |
| | | PRODUCT entity. | | |
| | Product Provider Id | The unique identifier for an external organization. | No | Yes |
| | | Identifies the Organization that provides a Product. | | |
| | Travel Product Id | Unique Identifier for an Item. | Yes | Yes |
| | | A Travel-related offer available for sale to a | | |
| | | PARTY(s). | | |
| | Travel Product Type Cd | A code that identifies a sub type of the PRODUCT | No | Yes |
| | | entity. | | |
| TRAVEL PRODUCT TYPE | Travel Product Type Cd | A code that identifies a sub type of the PRODUCT | Yes | No |
| | | entity. | | |
| | Travel Product Type Desc | A textual description of a sub type of the TRAVEL | No | No |
| | | PRODUCT. | | |
| TRAVEL PURCHASE | Purchase Tran Id | A unique identifier for this TRAVEL | Yes | Yes |
| | | TRANSACTION. | | |
| TRAVEL PURCHASE ITEM | Fare Basis Cd | The unique codes used to determine the basis of the | No | Yes |
| | | Fare charged to PARTYs for the purchase of a | | |
| | | PRODUCT or PACKAGE. | | |
| | Issued Party Id | The unique identifier for an instance of the PARTY | No | Yes |
| | | entity. | | |
| | Page View Sequence Num | The ordinal number that sequences WEB PAGE | No | Yes |
| | | VIEW instances within the context of a particular | | |
| | | WEB VISIT (Visit Id) | | |
| | | If this transaction was made via a website, this | | |
| | | indicates the specific Web Page from which the | | |
| | | item was selected. | | |
| | Purchase Item Type Cd | A code for classifying PURCHASE ITEM | No | Yes |
| | Purchase Seq Num | An identifier for a specific PURCHASE ITEM | Yes | No |
| | | entity. | | |
| | Purchase Tran Id | A unique identifier for this TRAVEL | Yes | Yes |
| | | TRANSACTION. | | |
| | Service Class Cd | The unique identifier of a specific SERVICE | No | Yes |
| | | CLASS offered by a TRAVEL PROVIDER. | | |
| | | Note: in the case of air travel, this attribute is | | |
| | | derivable from the Fare Basis Cd. | | |
| | Travel Product Id | Unique Identifier for an Item. | No | Yes |
| | | A Travel-related offer available for sale to a | | |
| | | PARTY(s). | | |
| | Web Visit Id | Unique identifier for the VISIT. | No | Yes |
| | | Uniquely identifies a visit to a web site. | | |
| | | If this transaction was made via a website, this | | |
| | | indicates the specific Web Visit. | | |
| TRAVEL PURCHASE ITEM | Purchase Item Type Cd | A code for classifying PURCHASE ITEM | Yes | No |
| TYPE | | | | |
| | Purchase Item Type Desc | Description that classifies PURCHASE ITEM | No | No |
| TRAVEL RESERVATION ITEM | Fare Basis Cd | The unique codes used to determine the basis of the | No | Yes |
| | | Fare charged to PARTYs for the purchase of a | | |
| | | PRODUCT or PACKAGE. | | |
| | PNR Create Dt | The creation date of a PNR. This is needed to | No | Yes |
| | | uniquely identify a PNR, since PNR numbers are | | |
| | | re-used over time. | | |
| | PNR Num | Uniquely identifies a specific occurrence of a PNR. | No | Yes |
| | Reservation Item Qty | The total number of items/products that are part of | No | No |
| | | this transaction. For example, 3 flight products, 2 | | |
| | | King Size Garden View Rooms, etc. | | |
| | Reservation Seq Num | This attribute identifies a specific RESERVATION | Yes | Yes |
| | | ITEM. | | |
| | Reservation Transaction Id | A unique identifier for this TRAVEL | Yes | Yes |
| | | TRANSACTION. | | |
| | Service Class Cd | The unique identifier of a specific SERVICE | No | Yes |
| | | CLASS offered by a TRAVEL PROVIDER. | | |
| | | Example: A (First Class), B (Business Class) or C | | |
| | | (Economy Class). | | |
| | Travel Reservation Type Cd | A code the identifies the type of RESERVATION | No | Yes |
| | | ITEM | | |
| TRAVEL RESERVATION TYPE | Travel Reservation Type Cd | A code the identifies the type of RESERVATION | Yes | No |
| | | ITEM | | |
| | Travel Reservation Type Desc | A textual description of the type of | No | No |
| | | RESERVATION ITEM | | |
| TRAVEL RETAIL ITEM | Travel Retail Item Id | Unique Identifier for an Item. | Yes | Yes |
| | | A Travel-related offer available for sale to a | | |
| | | PARTY(s). | | |
| TRAVEL TRAN FEEDBACK | Feedback Id | Uniquely identifies an instance of Quality | Yes | Yes |
| | | Feedback. Typically system assigned. | | |
| | Travel Transaction Id | A unique identifier for this TRAVEL | Yes | Yes |
| | | TRANSACTION. | | |
| TRAVEL TRANSACTION | Agreement Id | Uniquely identifies an AGREEMENT. | No | Yes |
| | | The agreement spells out the terms covering the | | |
| | | Transaction. | | |
| | | Note: This captures the actual agreement used for | | |
| | | the transaction which may be used for later analysis | | |
| | | to validate that the proper agreement was used. | | |
| | Group Event Id | A unique identifier for the GROUP EVENT. | No | Yes |
| | | If this Transaction is part of a Group Event, this | | |
| | | will provide a reference link to it. | | |
| | | Example: | | |
| | | Group Tour | | |
| | | Casino Junket | | |
| | | Banquet | | |
| | | Conference | | |
| | PNR Create Dt | The creation date of a PNR. This is needed to | No | Yes |
| | | uniquely identify a PNR, since PNR numbers are | | |
| | | re-used over time. | | |
| | PNR Num | Uniquely identifies a specific occurrence of a PNR. | No | Yes |
| | POS Register Id | The unique identifier for an instance of the POS | No | Yes |
| | | REGISTER entity. | | |
| | | Identifies the physical device used at a | | |
| | | LOCATION to capture or create a business | | |
| | | transaction - typically a Terminal or Point of Sale | | |
| | | (POS) device used to enter the transaction. | | |
| | | This address will allow the enterprise to identify | | |
| | | who entered the transaction. This is important for | | |
| | | fraud detection and productivity tracking. | | |
| | Promo Offer Id | The unique identifier for an instance of the OFFER | No | Yes |
| | | entity. | | |
| | | The PROMOTIONAL OFFER that generated or | | |
| | | prompted this TRANSACTION | | |
| | Transaction Dttm | The date and time of a specific TRAVEL | No | No |
| | | TRANSACTION. | | |
| | Travel Transaction Id | A unique identifier for this TRAVEL | Yes | No |
| | | TRANSACTION. | | |
| | Travel Transaction Type Cd | A code the identifies the type of TRAVEL | No | Yes |
| | | TRANSACTION | | |
| | Trip Id | Uniquely identifies a TRIP. | No | Yes |
| | Visit Id | The unique identifier for an instance of the VISIT | No | Yes |
| | | entity. | | |
| TRAVEL TRANSACTION TYPE | Travel Transaction Type Cd | A code the identifies the type of TRAVEL | Yes | No |
| | | TRANSACTION | | |
| | Travel Transaction Type Desc | A textual description of the type of TRAVEL | No | No |
| | | TRANSACTION | | |
| | | Example: Browse, Reservation, Purchase. | | |
| TRAVEL TRANSACTION XREF | Original Transaction Id | A unique identifier for this TRAVEL | Yes | Yes |
| | | TRANSACTION. | | |
| | Reason Cd | This code uniquely identifies the reason why two | No | Yes |
| | | (or more) TRAVEL TRANSACTIONs are related. | | |
| | Related Transaction Id | A unique identifier for this TRAVEL | Yes | Yes |
| | | TRANSACTION. | | |
| TRAVEL TRIP | Business Ind | Indicates if the TRIP is for business (or leisure) | No | No |
| | | purpose. | | |
| | Trip Desc | Textual description of trip for Marketing Purposes | No | No |
| | Trip Id | Uniquely identifies a TRIP. | Yes | No |
| TRAVEL TRIP FEEDBACK | Feedback Id | Uniquely identifies an instance of Quality | Yes | Yes |
| | | Feedback. Typically system assigned. | | |
| | Trip Id | Uniquely identifies a TRIP. | Yes | Yes |
| TRAVELERS CHECK | Travelers Check Account Id | Uniquely identifies an ACCOUNT. | Yes | Yes |
| | Travelers Check Amt | The monetary face value of the traveler's check. | No | No |
| TREASURY STOCK ACCOUNT | GL Main Account Num | The unique Chart of Account code for the GL | Yes | Yes |
| | | MAIN ACCOUNT. | | |
| | Treasury Stock Account Qty | The number of treasury stock shares of a | No | No |
| | | corporation. | | |
| TRIP EVENT | Associate Party Id | An individual who is employed by the enterprise. | No | Yes |
| | Trip Event Dttm | A specific date and time associated with an event | No | No |
| | | represented by a TRIP EVENT entity. | | |
| | Trip Event Num | A unique number assigned to a TRIP EVENT | Yes | No |
| | | entity. | | |
| | Trip Event Type Cd | An identifier for a TRIP EVENT subtype. | No | Yes |
| | Trip Id | Uniquely identifies a TRIP. | No | Yes |
| TRIP EVENT TYPE | Trip Event Type Cd | An identifier for a TRIP EVENT subtype. | Yes | No |
| | Trip Event Type Desc | A textual description of a TRIP EVENT subtype. | No | No |
| TRUCKING | Equip Id OIN | Uniquely identifies a piece of Equipment that can | Yes | Yes |
| | | be used to transport individuals or cargo. | | |
| TURN BACK ATB | Destination Facility Id | Uniquely identifies a LOCATION. | Yes | Yes |
| | Flight Num DFN | A unique identifier assigned to a Flight scheduled | Yes | Yes |
| | | for generating revenue and utilized by the general | | |
| | | public. | | |
| | Leg Incident Num | Allows uniqueness of incidents within a | Yes | Yes |
| | | SCHEDULED LEG. | | |
| | | Note: This will allow multiple incidents of the | | |
| | | same type to occur for a given scheduled leg. | | |
| | Origin Facility Id | Uniquely identifies a LOCATION. | Yes | Yes |
| | Sched Leg Depart Dttm TME | The scheduled departure date and time of a LEG. | Yes | Yes |
| | | Note: If this LEG is the initial LEG of one (or | | |
| | | more) SEGMENT, this departure date and time | | |
| | | would typically be identical to the corresponding | | |
| | | SEGMENT departure date and time. | | |
| TV AD | TV Ad Id | The unique identifier for an ad. | Yes | Yes |
| | | A ad made for viewing on television. | | |
| ULD | Equip Id OIN | Uniquely identifies an Equipment Instance. | Yes | Yes |
| | ULD Marked Serial Num | The Serial Number as marked on the ULD. This | No | No |
| | | number may differ from the unique Equipment Id | | |
| UNSCHED EVENT | Equip Event Id ERI | Uniquely identifies a Equipment Event. | No | Yes |
| | | Identifies the Equipment Event that occurred that | | |
| | | prompted this unscheduled event. | | |
| | Unsched Maint Event Id | Uniquely identifies a Maintenance Event that was | Yes | Yes |
| | | unscheduled. | | |
| UNSTRUCTURED FEEDBACK | Feedback Class Cd | Uniquely identifies a Feedback Class. | No | Yes |
| | Feedback Id | Uniquely identifies an instance of Quality | Yes | Yes |
| | | Feedback. Typically system assigned. | | |
| | Feedback Type Cd | Uniquely identifies a Feedback Type. | No | Yes |
| UOM | UOM Category Cd | Uniquely identifies a UOM category. | No | Yes |
| | UOM Cd | Uniquely identifies a unit of measure. | Yes | No |
| | UOM Name | Short text reference or label for a unit of measure. | No | No |
| | | Example: Liter, Ounce, Byte, Gram, Mile, etc. | | |
| UOM CATEGORY | UOM Category Cd | Uniquely identifies a UOM category. | Yes | No |
| | UOM Category Desc | Narrative text describing the UOM category. | No | No |
| | UOM Category Name | Short text reference or label for a UOM category. | No | No |
| UOM CONVERSION | From UOM Cd | Uniquely identifies a unit of measure. | Yes | Yes |
| | | This is the starting unit of measure for a | | |
| | | conversion. | | |
| | To UOM Cd | Uniquely identifies a unit of measure. | Yes | Yes |
| | | This is the ending unit of measure for a conversion. | | |
| | UOM Conversion Factor Qty | Factor by which the From UOM is multiplied to | No | No |
| | | calculate the To UOM. Conversions can only be | | |
| | | performed on UOMs belonging to the same | | |
| | | category, e.g., millimeter (length) to inch (length). | | |
| | | Example: | | |
| | | Use a conversion factor qty of 30.48 to convert | | |
| | | feet to an equivalent length in centimeters | | |
| | | (e.g., 3 feet multiplied by 30.48 equals 91.44 | | |
| | | centimeters). Conversely use a conversion | | |
| | | factor qty of 0.032808399 to convert | | |
| | | centimeters to feet. | | |
| | | Use a conversion factor qty of 16 to convert | | |
| | | pounds to an equivalent weight in ounces (e.g., | | |
| | | 2.2 pounds multiplied by 16 equals 35.2 | | |
| | | ounces). Conversely use a conversion factor | | |
| | | qty of 0.0625 to convert ounces to pounds. | | |
| UPGRADE AWARD | Award Voucher Id | The identifier of a loyalty award or certificate | Yes | Yes |
| | | awarded to a customer account. | | |
| | Ticket Id | A unique identifier for a TICKET. | No | Yes |
| | Travel Coupon Id | The ordering of a series of one or more TRAVEL | No | Yes |
| | | COUPONs associated with a single Ticket or | | |
| | | Conjunctive Ticket series. | | |
| USSGL TRANSACTION TYPE | USSGL Transaction Type Cd | The code assigned to a USSGL TRANSACTION | Yes | No |
| | | TYPE. | | |
| | USSGL Transaction Type Desc | The description for the USSGL TRANSACTION | No | No |
| | | TYPE. | | |
| VENDOR | Buyer Associate Id | An individual who is employed by the enterprise. | No | Yes |
| | | An ASSOCIATE whose duty it is to make | | |
| | | purchasing and planning decisions for a group of | | |
| | | ITEMs. | | |
| | | Indicates the Associate managing purchase | | |
| | | decisions from this Vendor. (If multiple Buyers | | |
| | | buy from this Vendor, indicates the managing | | |
| | | Associate for this Vendor) | | |
| | Vendor Party Id | The unique identifier for a Business. | Yes | Yes |
| | | A Supplier of Goods or Services. | | |
| VENDOR ALLOWANCE | Exception Seq Num | Uniquely identifies an Exception for a given | No | Yes |
| | | Receipt. (a receipt may have multiple exceptions) | | |
| | | This attribute is used IF the allowance can be | | |
| | | traced back to a specific receipt. (sometimes | | |
| | | exceptions are not noticed until much later, and the | | |
| | | exact receipt may be unclear) | | |
| | Item Id | Unique Identifier for an Item. | No | Yes |
| | Item Qty | Indicates the number of Items responsible for the | No | No |
| | | Allowance if the allowance is Item specific.. | | |
| | | Example: The number of Items that spoiled and can | | |
| | | not be returned. | | |
| | Vendor Allowance Amt | The reduction amount allowed by the vendor. | No | No |
| | Vendor Allowance Dt | The date the allowance occurred. | No | No |
| | Vendor Allowance Num | Uniquely identifies an allowance received from a | Yes | No |
| | | specific Organization. | | |
| | Vendor Allowance Type Cd | Unique identifier for the Vendor Allowance Type. | No | Yes |
| | Vendor Party Id | The unique identifier for a Business. | Yes | Yes |
| | | A Supplier of Goods or Services. | | |
| | Vendor Receipt Id | Unique identifier for the VENDOR RECEIPT | No | Yes |
| | | entity. | | |
| | | The Receipt that had an exception. | | |
| | | Note: This attribute is used IF the allowance can be | | |
| | | traced back to a specific receipt. (sometimes | | |
| | | exceptions are not noticed until much later, and the | | |
| | | exact receipt may be unclear) | | |
| VENDOR ALLOWANCE TYPE | Vendor Allowance Type Cd | Unique identifier for the Vendor Allowance Type. | Yes | No |
| | Vendor Allowance Type Desc | Narrative text describing the Vendor Allowance | No | No |
| | | Type. | | |
| VENDOR DISCOUNT | Break Point End Qty | The high point of the range. The maximum item | No | No |
| STRUCTURE | | quantity to qualify for the price. | | |
| | Break Point Start Qty | The low point of the range. | No | No |
| | Discount Pct | The discount percentage offered. | No | No |
| | Item Id | Unique Identifier for an Item. | Yes | Yes |
| | Vendor Discount Id | Identifies this specific discount. | Yes | No |
| | Vendor Party Id | The unique identifier for a Business. | Yes | Yes |
| | | A Supplier of Goods or Services. | | |
| VENDOR FORECAST | Item Id | Uniquely identifies an item. Typically system | Yes | Yes |
| | | assigned. | | |
| | Vendor Actual Amt DD | The actual amount realized. | No | No |
| | | This is a DERIVED DATA (DD) element. | | |
| | Vendor Forecast Amt | The amount projected by the forecast. | No | No |
| | Vendor Forecast End Dt | The time period for which the forecast was done. | Yes | No |
| | Vendor Forecast Method Cd | Can be used to indicate a special statistical process | Yes | No |
| | | that was used to generate the forecast. | | |
| | Vendor Forecast Qty | The quantity or unit count projected by the | No | No |
| | | forecast. | | |
| | Vendor Forecast Source Cd | Indicates the source of the forecast. (3rd party | Yes | No |
| | | application, internal department, etc.) | | |
| | Vendor Party Id | The unique identifier for a Business. | Yes | Yes |
| | | A Supplier of Goods or Services. | | |
| VENDOR ITEM | Item Id | Unique Identifier for an Item. | Yes | Yes |
| | Preferred Vendor Ind | Indicates that this is the preferred, primary, or | No | No |
| | | default Vendor (Supplier) to be used when | | |
| | | purchasing this Item. | | |
| | Vendor Item Num | The VENDOR assigned number of an ITEM. | No | No |
| | Vendor Lead Tm | Indicates the expected amount of time between | No | No |
| | | order placement and order shipment. | | |
| | Vendor Party Id | The unique identifier for a Business. | Yes | Yes |
| | | A Supplier of Goods or Services. | | |
| VENDOR ITEM COST | Delivery Location Id | Uniquely identifies a LOCATION. | Yes | Yes |
| | | Indicates the intended enterprise delivery Location. | | |
| | | Optional, and should be omitted if Vendor Cost is | | |
| | | not differentiated by delivery location. | | |
| | Item Cost End Dt | The final date the item cost is valid. | No | No |
| | Item Cost Start Dt | The date the item cost took effect. | Yes | No |
| | Item Id | Unique Identifier for an Item. | Yes | Yes |
| | Vendor Item Cost Amt | The cost of an ITEM from this VENDOR. | No | No |
| | Vendor Party Id | The unique identifier for a Business. | Yes | Yes |
| | | A Supplier of Items. | | |
| VENDOR ITEM SCORE | Item Id | Unique Identifier for an Item. | Yes | Yes |
| | Model Id | The unique identifier for an instance of the | Yes | Yes |
| | | ANALYTICAL MODEL entity. | | |
| | Model Run Id | An identifier that uniquely describes the particular | Yes | Yes |
| | | run of the ANALYTICAL MODEL. | | |
| | Vendor Item Score Num | The actual score produced for the VENDOR's | No | No |
| | | ITEM by the ANALYTICAL MODEL. | | |
| | | Example: Vendor 204's Item 10056 has a ‘quality | | |
| | | rating’ score of 85 out of 100; Vendor 15's Item | | |
| | | 432 has a ‘propensity to be bought’ score of 8 out of | | |
| | | 10. | | |
| | Vendor Party Id | The unique identifier for a Business. | Yes | Yes |
| VENDOR LOCATION TERMS | Location Id | Uniquely identifies a LOCATION. | Yes | Yes |
| | Shipping Lead Days Cnt | Used to do auto replenishment. | No | No |
| | Vendor Lead Days Cnt | Used to do auto replenishment. | No | No |
| | Vendor Party Id | The unique identifier for a Business. | Yes | Yes |
| | | A Supplier of Goods or Services. | | |
| VENDOR ORDER FEE | Charge Amt | The amount of a non-ITEM related charge. | No | No |
| | Charge Seq Num | Identifies a specific charge within a Vendor Order. | Yes | No |
| | | Note: If a Charge Type can appear only once per | | |
| | | Vendor Order, this attribute can be substituted with | | |
| | | Charge Type Cd instead. | | |
| | Charge Type Cd | Unique identifier for a CHARGE TYPE. | No | Yes |
| | Vendor PO Id | Unique identifier for a VENDOR PURCHASE | Yes | Yes |
| | | ORDER. | | |
| VENDOR PO COMMENT | Vendor PO Comment Dttm | The date and time a VENDOR PO COMMENT | No | No |
| | | was assigned to a VENDOR PO. | | |
| | Vendor PO Comment Line Id | The unique identifier of a VENDOR PO | Yes | No |
| | | COMMENT. | | |
| | Vendor PO Comment Txt | The text comment associated with a VENDOR PO. | No | No |
| | Vendor PO Id | The unique identifier of a specific VENDOR PO. | Yes | Yes |
| VENDOR PO LINE | Vend PO Ln Backordr End Dttm | The date and time ending the backorder of the | No | No |
| BACKORDER | | VENDOR PURCHASE ORDER LINE. | | |
| | Vend PO Ln Backordr Prom Dttm | The date ITEMs on backorder are expected to be | No | No |
| | | available. | | |
| | Vend PO Ln Backordr Qty | The quantity of ITEMs on backorder. | No | No |
| | Vend PO Ln Backordr Start Dttm | The date and time marking the VENDOR | Yes | No |
| | | PURCHASE ORDER LINE being placed on | | |
| | | backorder. | | |
| | Vend PO Ln Num | A number representing a unique line on a | Yes | Yes |
| | | VENDOR PO LINE. | | |
| | Vendor PO Id | The unique identifier of a specific VENDOR PO. | Yes | Yes |
| VENDOR PO LINE COMMENT | Vend PO Ln Num | A number representing a unique line on a | Yes | Yes |
| | | VENDOR PO LINE. | | |
| | Vendor PO Id | The unique identifier of a specific VENDOR PO. | Yes | Yes |
| | Vendor PO Line Comment Dttm | The date and time a textual VENDOR PO LINE | No | No |
| | | COMMENT is associated with a specific | | |
| | | VENDOR PO LINE. | | |
| | Vendor PO Line Comment Id | The unique identifier of a VENDOR PO LINE | Yes | No |
| | | COMMENT. | | |
| | Vendor PO Line Comment Txt | The text comment associated with a VENDOR PO | No | No |
| | | LINE. | | |
| VENDOR PO LINE RELATED | Related Vendor PO Id | The unique identifier of a specific VENDOR PO. | Yes | Yes |
| | | In this case, the VENDOR PO for the VENDOR | | |
| | | PO LINE that is related to another specific | | |
| | | VENDOR PO LINE. | | |
| | Related Vendor PO Line Num | A number representing a unique line on a | Yes | Yes |
| | | VENDOR PO LINE. | | |
| | Relates To Vendor PO Id | The unique identifier of a specific VENDOR PO. | Yes | Yes |
| | | In this case, the VENDOR PO for the VENDOR | | |
| | | PO LINE that is relates to another specific | | |
| | | VENDOR PO LINE. | | |
| | Relates To Vendor PO Line Num | A number identifying a line within a VENDOR PO | Yes | Yes |
| | | LINE number. In this case, the VENDOR PO | | |
| | | LINE number related to another VENDOR PO | | |
| | | LINE number | | |
| | Vendor PO Line Related Type Cd | The code assigned to a VENDOR PO LINE | No | Yes |
| | | RELATED TYPE | | |
| | Vendor PO Ln Relatd Start Dttm | The calendar date and time on which a VENDOR | Yes | No |
| | | PO LINE RELATED relationship started. | | |
| | Vendor PO Ln Related End Dttm | The calendar date and time on which a VENDOR | No | No |
| | | PO LINE RELATED relationship ended. | | |
| VENDOR PO LINE RELATED | Vendor PO Line Related Type Cd | The code assigned to a VENDOR PO LINE | Yes | No |
| TYPE | | RELATED TYPE | | |
| | Vendor PO Ln Related Type Desc | The description for a VENDOR PO LINE | No | No |
| | | RELATED TYPE | | |
| VENDOR PO LINE STATUS | Vendor PO Id | Unique identifier for a VENDOR PURCHASE | Yes | Yes |
| HIST | | ORDER. | | |
| | Vendor PO Line Num | The VENDOR PURCHASE ORDER LINE | Yes | Yes |
| | | number. | | |
| | Vendor PO Line Status Dttm | The date and time a status was assigned to a | Yes | No |
| | | Vendor PO Line. | | |
| | Vendor PO Ln Status Reason Cd | The code for the reason a status was assigned to a | No | Yes |
| | | Vendor PO Line. | | |
| | Vendor PO Status Cd | Unique identifier for a TRANSACTION LINE | Yes | Yes |
| | | STATUS. | | |
| VENDOR PO LINE TERM | Vend PO Ln Num | A number representing a unique line on a | Yes | Yes |
| | | VENDOR PO LINE. | | |
| | Vendor PO Id | The unique identifier of a specific VENDOR PO. | Yes | Yes |
| | Vendor PO Line Term End Dttm | The calendar date and time on which a VENDOR | No | No |
| | | PO LINE TERM ended. | | |
| | Vendor PO Line Term Id | The unique identifier for a PO TERM. | Yes | Yes |
| | Vendor PO Line Term Start Dttm | The date and time a specific VENDOR PO LINE | Yes | Yes |
| | | TERM became valid for current use. | | |
| VENDOR PO PARTY | Party Id | The unique identifier for any individual or group of | Yes | Yes |
| | | individuals that is of interest to the enterprise. | | |
| | | The unique identifier for a PARTY. In this context | | |
| | | it is the individual or group associated with the | | |
| | | Vendor PO. | | |
| | Party Role Cd | Uniquely identifies the PARTY ROLE. | Yes | Yes |
| | Vendor PO Id | Unique identifier for a VENDOR PURCHASE | Yes | Yes |
| | | ORDER. | | |
| VENDOR PO REASON | Vendor PO Reason Cd | The code assigned to a reason a status is assigned | Yes | No |
| | | to a VENDOR PO. | | |
| | Vendor PO Reason Desc | The description of the reason a status is assigned to | No | No |
| | | a VENDOR PO. | | |
| VENDOR PO RELATED | Related Vendor PO Id | The unique identifier of a specific VENDOR | Yes | Yes |
| | | PURCHASE ORDER. In this case, the VENDOR | | |
| | | PURCHASE ORDER that is related to another | | |
| | | specific VENDOR PURCHASE ORDER. | | |
| | Relates To Vendor PO Id | The unique identifier of a specific VENDOR | Yes | Yes |
| | | PURCHASE ORDER. In this case, the VENDOR | | |
| | | PURCHASE ORDER that is relates to another | | |
| | | specific VENDOR PURCHASE ORDER. | | |
| | Vendor PO Related End Dttm | The calendar date and time on which a VENDOR | No | No |
| | | PO LINE RELATED relationship ended. | | |
| | Vendor PO Related Start Dttm | The calendar date and time on which a VENDOR | Yes | No |
| | | PO LINE RELATED relationship started. | | |
| | Vendor PO Related Type Cd | A code assigned to VENDOR PO RELATED | No | Yes |
| | | TYPE. | | |
| VENDOR PO RELATED TYPE | Vendor PO Related Type Cd | A code assigned to VENDOR PO RELATED | Yes | No |
| | | TYPE. | | |
| | Vendor PO Related Type Desc | Describes a code assigned to VENDOR PO | No | No |
| | | RELATED TYPE. | | |
| VENDOR PO STATUS HIST | Vendor PO Id | The unique identifier of a specific VENDOR PO. | Yes | Yes |
| | Vendor PO Status Cd | The code for a VENDOR PO STATUS. | No | Yes |
| | Vendor PO Status Dttm | The date and time a status was assigned to a | Yes | No |
| | | VENDOR PO. | | |
| | Vendor PO Status Reason Cd | The code for the reason a status was assigned to a | No | Yes |
| | | VENDOR PO. | | |
| VENDOR PO TERM | PO Term Id | The unique identifier for a PO TERM. | Yes | Yes |
| | PO Term Start Dttm | The date and time a specific VENDOR PO TERM | Yes | Yes |
| | | became valid for current use. | | |
| | Vendor PO Id | The unique identifier of a specific VENDOR PO. | Yes | Yes |
| | Vendor PO Term End Dttm | The calendar date and time on which a VENDOR | No | No |
| | | PO TERM ended. | | |
| VENDOR PURCHASE ORDER | Purchasing Loc Id | Unique identifier for a LOCATION. | No | Yes |
| | | The location placing the purchase order. | | |
| | Receiving Loc Id | Uniquely identifies a LOCATION. | No | Yes |
| | | The location where the goods will be shipped to. | | |
| | Tran Type Cd | Uniquely identifies the transaction type. | No | Yes |
| | Vendor Party Id | The unique identifier for a Business. | No | Yes |
| | | A Supplier of Goods or Services. | | |
| | | The vendor that receives the purchase order. | | |
| | Vendor PO Closed Ind | Shows the status of the purchase order. Values | No | No |
| | | may be “Yes” (PO is closed) or “No” (PO is open). | | |
| | Vendor PO Dttm | The date and time of the vendor purchase order. | No | No |
| | Vendor PO Id | Unique identifier for a VENDOR PURCHASE | Yes | No |
| | | ORDER. | | |
| | Vendor PO Num | An identifier assigned to a VENDOR PO. This | No | No |
| | | identified may not be unique across all information | | |
| | | providing systems. | | |
| | | This is the PO Number assigned by the Vendor. | | |
| VENDOR PURCHASE ORDER | Agreement Id | Uniquely identifies an AGREEMENT. | No | Yes |
| LINE | | The Agreement governing the purchase of this Item | | |
| | | (if applicable and not derivable) | | |
| | | Note: This captures the actual Agreement used for | | |
| | | the transaction. This may be useful for later | | |
| | | analysis to validate that the proper Agreement was | | |
| | | used. | | |
| | Item Id | Unique Identifier for an Item. | No | Yes |
| | Purchase Unit Qty | The purchased number of units. | No | No |
| | Unit List Price Amt | Represents the List or Suggested Retail price per | No | No |
| | | unit. May differ from actual price paid. | | |
| | Unit Purchase Price Amt | Represents the purchase price per unit. | No | No |
| | Vendor PO Id | Unique identifier for a VENDOR PURCHASE | Yes | Yes |
| | | ORDER. | | |
| | Vendor PO Line Num | The VENDOR PURCHASE ORDER LINE | Yes | No |
| | | number. | | |
| VENDOR RECEIPT | ASN Id | Uniquely identifies an Advance Shipping Notice. | No | Yes |
| | | Links to a Shipment entity for detailed tracking | | |
| | | information. | | |
| | Receiving Loc Id | Unique identifier for a LOCATION. | No | Yes |
| | | LOCATION that receives the ordered items. | | |
| | | Note: This information is also located in the | | |
| | | Vendor Purchase Order Entity. It's presence here | | |
| | | supports the Receipt of Goods not intended for this | | |
| | | Location (exceptions). May be omitted if this is not | | |
| | | an requirement. | | |
| | Shipment Dttm | The date (and time) on which the items were | No | No |
| | | shipped. | | |
| | | Note: If the Shipment Entity (and or ASN Entity) | | |
| | | are used, this attribute will be redundant and can be | | |
| | | omitted. | | |
| | Shipment Num | Uniquely identifies a SHIPMENT. | No | Yes |
| | | Links to the Shipment that transported the Order. | | |
| | | May be derivable if an ASN is always provided. | | |
| | Vendor Party Id | The unique identifier for a Business. | No | Yes |
| | | A Supplier of Goods or Services. | | |
| | Vendor PO Id | Unique identifier for a VENDOR PURCHASE | No | Yes |
| | | ORDER. | | |
| | | Links to the original Order placed. | | |
| | Vendor Receipt Dttm | The date and time the shipment was received. | No | No |
| | Vendor Receipt Id | Unique identifier for the VENDOR RECEIPT | Yes | No |
| | | entity. | | |
| VENDOR RECEIPT LINE | Received Item Id | Unique identifier for an ITEM. Typically system | No | Yes |
| | | assigned. | | |
| | | The product or service to which the object may | | |
| | | refer. This attribute is considered to be mutually | | |
| | | exclusive with Item Group Id. | | |
| | | The actual Item being received from the Vendor. | | |
| | | Note: This attribute is especially useful in the case | | |
| | | where the Supplier substituted a different item for | | |
| | | the originally ordered item. | | |
| | Received Unit Qty | The actual quantity of units received from the | No | No |
| | | VENDOR. | | |
| | Vendor PO Id | Unique identifier for a VENDOR PURCHASE | No | Yes |
| | | ORDER. | | |
| | Vendor PO Line Num | The VENDOR PURCHASE ORDER LINE | No | Yes |
| | | number. | | |
| | Vendor Receipt Id | Unique identifier for the VENDOR RECEIPT | Yes | Yes |
| | | entity. | | |
| | Vendor Receipt Line Num | Identifies a specific line within a VENDOR | Yes | No |
| | | RECEIPT. | | |
| VENDOR RECEIPT TRAN | Inv Tran Id | Uniquely identifies an inventory transaction. | Yes | Yes |
| | Vendor Receipt Id | Unique identifier for the VENDOR RECEIPT | No | Yes |
| | | entity. | | |
| | Vendor Receipt Line Num | Identifies a specific line within a VENDOR | No | Yes |
| | | RECEIPT. | | |
| VENDOR RETURN | Returning Location Id | Uniquely identifies a LOCATION. | No | Yes |
| | Shipment Num | Uniquely identifies a SHIPMENT. | No | Yes |
| | | The identifier of the actual Shipment used to return | | |
| | | the goods to the Vendor or Supplier. | | |
| | Vendor Party Id | The unique identifier for a Business. | No | Yes |
| | | A Supplier of Goods or Services. | | |
| | | The Party to whom the Goods are being returned. | | |
| | Vendor Return Dt | The date items were returned to a vendor. | No | No |
| | Vendor Return Id | Uniquely identifies a Return. | Yes | No |
| VENDOR RETURN LINE | Item Id | Unique Identifier for an Item. | No | Yes |
| | Return Reason Cd | Unique identifier for the RETURN REASON. | No | Yes |
| | | Why the Item is being returned. | | |
| | Return Unit Cost Amt | The cost assigned per Item being returned. | No | No |
| | Return Unit Qty | The quantity that was returned to the VENDOR. | No | No |
| | Return Unit Refund Amt | The per unit amount refunded by the Vendor. | No | No |
| | Vendor Return Id | Uniquely identifies a Return. | Yes | Yes |
| | Vendor Return Line Num | Identifies a specific Line Item within a Vendor | Yes | No |
| | | Return | | |
| | Vendor RMA Cd | RMA (Return Merchandise/Material | No | No |
| | | Authorization) Code provided by the Vendor. | | |
| VENDOR RETURN TRAN | Inv Tran Id | Uniquely identifies an inventory transaction. | Yes | Yes |
| | Vendor Return Id | Uniquely identifies a Return. | No | Yes |
| | Vendor Return Line Num | Identifies a specific Line Item within a Vendor | No | Yes |
| | | Return | | |
| VENDOR TYPE | Vendor Type Cd | A code used to uniquely identify vendor type. For | Yes | No |
| | | example, Employee, Public Sector Company, Tax | | |
| | | Authority, and Vendor. | | |
| | Vendor Type Desc | The description of the code. | No | No |
| VISIT | Group Event Id | A unique identifier for the GROUP EVENT. | No | Yes |
| | | Identifies the Group Event if the visit was in | | |
| | | conjunction with a Group Event. | | |
| | Location Id | Unique identifier used to identify a LOCATION. | No | Yes |
| | | LOCATION where the Customer transacted | | |
| | | business with the enterprise. Typically a call center, | | |
| | | walk in outlet, web site, etc. The LOCATION will | | |
| | | also determine the CHANNEL. | | |
| | Parent Visit Id | The unique identifier for an instance of the VISIT | No | Yes |
| | | entity. | | |
| | | Indicates a ‘larger’ VISIT that contains this VISIT. | | |
| | | Example: a visit to a dining establishment during a | | |
| | | stay at a lodging location. | | |
| | Visit End Dttm | The date and time that a VISIT ended. For WEB | No | No |
| | | VISITs this can be whenever x minutes without | | |
| | | any activity have elapsed. | | |
| | Visit Id | Unique identifier for the VISIT. | Yes | No |
| | Visit Start Dttm | The date and time on which a VISIT started. | No | No |
| | Visit Type Cd | Unique identifier for a VISIT TYPE. | No | Yes |
| | Visiting Persona Id | Unique identifier for a PERSONA. | No | Yes |
| VISIT FEEDBACK | Feedback Id | Uniquely identifies an instance of Quality | Yes | Yes |
| | | Feedback. Typically system assigned. | | |
| | Visit Id | Unique identifier for the VISIT. | Yes | Yes |
| VISIT TYPE | Visit Type Cd | Unique identifier for a VISIT TYPE. | Yes | No |
| | Visit Type Desc | Narrative text describing the VISIT TYPE. | No | No |
| VISITOR IDENTIFICATION | Visitor Id Method Cd | A unique identifier for the means by which a Party | Yes | No |
| METHOD | | (visitor) is identified for a Web Visit. There are | | |
| | | three possible values: IP address, cookie, and | | |
| | | registered. | | |
| | Visitor Id Method Desc | A textual description for a Visitor Identification | No | No |
| | | Method. | | |
| | | Examples: IP Address, Cookie, Registered. | | |
| VOTING STOCK ACCOUNT | GL Main Account Num | The unique Chart of Account code for the GL | Yes | Yes |
| | | MAIN ACCOUNT. | | |
| WAGE AND SALARY ACCT | GL Sub Account Num | The unique Chart of Account code for the GL SUB | Yes | Yes |
| | | ACCOUNT. | | |
| WASTAGE TRANSACTION | Inv Tran Id | Uniquely identifies an inventory transaction. | Yes | Yes |
| WAY BILL | Invoice Id | Uniquely identifies an INVOICE. | No | Yes |
| | Shipment Num | Uniquely identifies a SHIPMENT. | No | Yes |
| | Way Bill Num | Uniquely identifies a Way Bill. | Yes | No |
| WAY BILL ADJUSTMENT | Adjust Amt | This attribute reflects the monetary amount of | No | No |
| | | adjustment made to a FREIGHT BILL LINE | | |
| | | charge amount. This adjustment can be either up | | |
| | | or down based on the reason for the adjustment. | | |
| | Adjust Dt | This attribute reflects the date a monetary | No | No |
| | | adjustment was made to a FREIGHT BILL LINE | | |
| | | charge amount. | | |
| | Adjust Reason Cd | This attribute describes the reason code for a | No | Yes |
| | | monetary adjustment made to a FREIGHT BILL | | |
| | | LINE. | | |
| | Adjust Seq Num | Uniquely identifies an Freight Bill Adjustment for | Yes | No |
| | | a given Freight Bill. | | |
| | Adjust Type Cd | This attribute reflects the type code for a monetary | No | Yes |
| | | adjustment made to a FREIGHT BILL LINE. | | |
| | Way Bill Line Num | A unique number that identifies the WAY BILL | No | Yes |
| | | LINE. These numbers are sequential starting at | | |
| | | one and ending at ‘n’ where ‘n’ is the last line in the | | |
| | | sequence. | | |
| | | Used to link the a specific Way Bill Line being | | |
| | | adjusted. | | |
| | | Left null if the adjustment applies globally to the | | |
| | | entire Way Bill, instead of a specific Way Bill | | |
| | | Line. | | |
| | Way Bill Num | Uniquely identifies a Way Bill. | Yes | Yes |
| WAY BILL LINE | Charge Amt | The monetary amount charged for service | No | No |
| | | associated with this particular FREIGHT BILL | | |
| | | LINE. | | |
| | | Note: This amount “should” match the Amount | | |
| | | specified by the Pricing Id, but may not always do | | |
| | | so in practice. | | |
| | | To “force” agreement, this attribute can be deleted, | | |
| | | making it impossible to charge any amount other | | |
| | | than what is specified by the Pricing Id. | | |
| | Piece Num | Uniquely identifies a PIECE contained in a | No | Yes |
| | | SHIPMENT. | | |
| | | This can often be thought of as a “Tracking | | |
| | | Number” | | |
| | Pricing Id | Identifies a specific price for an Item. | No | Yes |
| | | Note: You typically have multiple Pricing Ids (and | | |
| | | prices) for the same Item. This can be due to: | | |
| | | date (price change over time) | | |
| | | condition set (different price by channel, | | |
| | | region, etc.) | | |
| | | volume scale (lower price based on volume | | |
| | | purchase) | | |
| | | etc. | | |
| | Service Item Id | Unique Identifier for an Item. | No | Yes |
| | | A non-physical type of ITEM sold to a customer | | |
| | | a.k.a. providing a TRANSPORT SERVICE to a | | |
| | | customer. | | |
| | Shipment Line Num | The line number for this SHIPMENT. Each | No | Yes |
| | | SHIPMENT LINE ITEM has a sequential number | | |
| | | starting at one and going to ‘n’ where ‘n’ represents | | |
| | | the last SHIPMENT LINE ITEM associated with | | |
| | | this SHIPMENT. | | |
| | Shipment Num | Uniquely identifies a SHIPMENT. | No | Yes |
| | Way Bill Line Num | A unique number that identifies the WAY BILL | Yes | No |
| | | LINE. These numbers are sequential starting at | | |
| | | one and ending at ‘n’ where ‘n’ is the last line in the | | |
| | | sequence. | | |
| | Way Bill Num | Uniquely identifies a Way Bill. | Yes | Yes |
| WEB AD | Web Ad Id | The unique identifier for an ad. | Yes | Yes |
| | | An ad made for viewing on a web site. | | |
| | Web Ad Type Cd | Unique identifier for a WEB AD TYPE. | No | Yes |
| WEB AD PLACEMENT | Agreement Id | Uniquely identifies an AGREEMENT. | No | Yes |
| | | The agreement spells out the terms governing the | | |
| | | placement of the Ad. | | |
| | | Note: This captures the actual agreement used for | | |
| | | the placement which may be used for later analysis | | |
| | | to validate that the proper agreement was used. | | |
| | E Location Id | Unique value that identifies this particular E | No | Yes |
| | | LOCATION. | | |
| | Electronic Address Id | A number used to uniquely identify an | No | Yes |
| | | ELECTRONIC ADDRESS. | | |
| | Page Position Cd | A code used for identifying the positions on a page. | No | Yes |
| | Web Ad Id | The unique identifier for an ad. | No | Yes |
| | | An ad made for viewing on a web site. | | |
| | Web Ad Placement Id | The unique identifier that identifies a particular | Yes | No |
| | | instance of WEB AD PLACEMENT. | | |
| | Web Ad Plcmnt Desc | This is a text description of where the | No | No |
| | | Advertisement is placed. | | |
| | Web Ad Plcmnt End Dttm | The date and time the web ad was removed from | No | No |
| | | service. This attribute may be placed in a | | |
| | | supertype (AD PLACEMENT) if same exists. | | |
| | Web Ad Plcmnt Referral Fee Amt | The cost to the Enterprise of having a WEB AD | No | No |
| | | displayed on a referral Web site. This could be a | | |
| | | combination of the number of impressions and the | | |
| | | number of clickthroughs. | | |
| | Web Ad Plcmnt Start Dttm | The date and time the web ad was placed in | No | No |
| | | service. This attribute may be placed in a | | |
| | | supertype (AD PLACEMENT) if same exists. | | |
| | Web Ad Plcmnt URI Stem Txt | The URI Stem of the Advertisement, this does not | No | No |
| | | include the query string. | | |
| | Web Ad Plcmnt URI Txt | The URI of the Advertisement, whether that | No | No |
| | | Advertisement be a banner displayed on a | | |
| | | publisher's page or a web page interposed between | | |
| | | a link of interest to a visitor and the target of that | | |
| | | link. | | |
| | Web Ad Provider Cost Amt | The cost to the Ad Service Provider for placing this | No | No |
| | | advertisement. | | |
| | Web Ad Tracking Cd | An unique code that can be imbedded in a web | No | No |
| | | link, to aid in tracking links that are clicked on. | | |
| | Web Page Id | The unique identifier of a particular WEB PAGE | No | Yes |
| | | instance. | | |
| WEB AD PLACEMENT STATS | Web Ad Placement Id | The unique identifier that identifies a particular | Yes | Yes |
| | | instance of WEB AD PLACEMENT. | | |
| | Web Ad Stats Clickthrus Qty | The number of times a WEB AD was clicked on to | No | No |
| | | take a customer to the Enterprise's web site. | | |
| | Web Ad Stats Dttm | The date and time that the instance of WEB AD | Yes | No |
| | | PLACEMENT STATS was created | | |
| | Web Ad Stats Impressions Qty | The number of times a WEB AD is displayed by a | No | No |
| | | referral web site between the start and end dates | | |
| | Web Stats Provider Party Id | The unique identifier for an organization. | No | Yes |
| WEB AD TYPE | Web Ad Type Cd | Unique identifier for a WEB AD TYPE. | Yes | No |
| | Web Ad Type Desc | Narrative text describing a WEB AD TYPE. | No | No |
| WEB BANNER AD | Web Ad Id | The unique identifier for an ad. | Yes | Yes |
| | | An ad made for viewing on a web site. | | |
| WEB PAGE | Communication Protocol Txt | Specifies a communication protocol such as | No | No |
| | | “http://”, “ftp://”, etc. | | |
| | Page Type Cd | Code that identifies a particular type of PAGE. | No | Yes |
| | Web Page Desc | Textual description of this particular WEB PAGE. | No | No |
| | | It can describe the design principles or other | | |
| | | characteristics of the web page. | | |
| | | Example: “This is a web page consisting of 3 | | |
| | | frames with a horizontal menu bar at the top and a | | |
| | | navigation menu bar at the left and a main are in | | |
| | | the middle . . . ” | | |
| | Web Page Document Path Desc | The document path is an absolute or relative | No | No |
| | | pathname to the requested document. | | |
| | | For example: /solutions/fs-ldm.html | | |
| | Web Page Domain Name | The name of the Web Page Internet domain as | No | No |
| | | registered as resolved from the IP address. | | |
| | | Example for web: acme.com | | |
| | Web Page Generation Type Cd | A coding scheme for identifying the method | No | Yes |
| | | involved in generating a page instance | | |
| | Web Page Id | The unique identifier of a particular WEB PAGE | Yes | No |
| | | instance. | | |
| | Web Page Name | The name given to this particular WEB PAGE. For | No | No |
| | | dynamically generated web pages, the web page | | |
| | | name may be an intelligent concatenation of | | |
| | | information about the script being executed with | | |
| | | look up values for (some of) the parameters | | |
| | | involved. | | |
| | | Example: | | |
| | | “macys.com home page” | | |
| | | “Men's - accessories - DKNY Leather | | |
| | | Backpack - product display” | | |
| | | “Check out page” | | |
| | | etc. | | |
| | Web Page URL Txt | The uniform resource locator associated with a | No | No |
| | | WEB PAGE. | | |
| | Web Site Id | A unique identifier for the web site. | No | Yes |
| | Web Site Nav Id | The unique identifier for an instance of the WEB | No | Yes |
| | | SITE NAVIGATION entity. | | |
| | Web Site Section Id | A unique identifier for a WEB SITE SECTION | No | Yes |
| WEB PAGE GENERATION TYPE | Web Page Generation Type Cd | A coding scheme for identifying the method | Yes | No |
| | | involved in generating a page instance | | |
| | Web Page Generation Type Desc | A textual description of the page instance type code | No | No |
| WEB PAGE MM OBJECT | Link To Web Page Id | The unique identifier of a particular WEB PAGE | No | Yes |
| | | instance. | | |
| | | This object may have an embedded Uniform | | |
| | | Resource Locator (URL) to a WEB PAGE. | | |
| | MM Object Id | Unique identifier for a multimedia object. | Yes | Yes |
| | Page Position Cd | A code used for identifying the positions on a page. | No | Yes |
| | Web Page Id | The unique identifier of a particular WEB PAGE | Yes | Yes |
| | | instance. | | |
| | Web Page MM Obj File Size Meas | The size of the object file. | No | No |
| | | Example: 128 kb | | |
| | Web Page MM Obj URL Txt | The uniform resource locator for the object. | No | No |
| | | For example: | | |
| | | http://website.com/products/sourcefiles/tshirt102.jpg | | |
| | Web Page Object End Dttm | The date and time when this object ended being | No | No |
| | | used on this web page. | | |
| | Web Page Object Start Dttm | The date and time when this object started being | Yes | No |
| | | used on this web page. | | |
| WEB PAGE VIEW | Current Web Page Id | The unique identifier of a particular WEB PAGE | No | Yes |
| | | instance the visitor is currently viewing. | | |
| | Data Transferred Meas | The amount of data transferred from the server to | No | No |
| | | the client as a result of an interaction (this data | | |
| | | could be useful for bandwidth calculations) | | |
| | Data Transferred UOM Cd | Uniquely identifies a unit of measure. See Data | No | Yes |
| | | Transferred Meas. | | |
| | | Commonly expressed as Kilobytes, Megabytes, etc. | | |
| | HTTP Secure Ind | Identifies if the request is using a secure connection | No | No |
| | | Examples - Y = Secure, N = Not Secure | | |
| | Interaction Task Cd | Coding scheme for identifying an interaction task. | No | Yes |
| | Interaction Task Params Txt | Parameters, if used in an interaction task. For | No | No |
| | | example, search terms | | |
| | Interaction Task Status Cd | The status of an interaction task - For example, | No | No |
| | | Success or Failure | | |
| | Page Processing Duration Tm | Web Servers can be configured to log the time it | No | No |
| | | takes them to display a page on a Visitor's browser. | | |
| | | This is where that information would be stored. It | | |
| | | can also be calculated from Network Sniffer Logs. | | |
| | | weblog->time_taken | | |
| | Page View End Dttm | The date and time on which Web Page ceases to be | No | No |
| | | viewed. | | |
| | Page View Sequence Num | The ordinal number that sequences WEB PAGE | Yes | No |
| | | VIEW instances within the context of a particular | | |
| | | WEB VISIT (Visit Id) | | |
| | Page View Start Dttm | The date and time that this WEB PAGE VIEW | No | No |
| | | instance occurred. | | |
| | Referring MM Object Id | Unique identifier for a multimedia object. The | No | Yes |
| | | referring object that precipitated this Web Page | | |
| | | View, such as a clicked link. | | |
| | Web Server Id | A classification number for identifying web server | No | Yes |
| | Web Server Status Cd | Uniquely identifies a web server status. | No | Yes |
| | Web Visit Id | Unique identifier for the VISIT. | Yes | Yes |
| WEB SECTION TYPE | Web Section Type Cd | A unique code for a SECTION TYPE | Yes | No |
| | Web Section Type Desc | A description of the SECTION TYPE | No | No |
| WEB SERVER | IP Address Num | The unique IP Address Number. | No | Yes |
| | Mailing Address Id | A number used to uniquely identifty a MAILING | No | Yes |
| | | ADDRESS. | | |
| | | This may be an e-mail address for the server | | |
| | | administrator or for the company that owns and | | |
| | | operates the server or it could be the physical | | |
| | | address for postal or shipment delivery. | | |
| | Web Server Cap UOM Cd | Uniquely identifies a unit of measure representing | No | Yes |
| | | the capacity of the web server. See Web Server | | |
| | | Capacity Meas attribute. | | |
| | | Examples: kilobytes per second; hits per second; | | |
| | | total active threads, etc. | | |
| | Web Server Capacity Meas | The number of http transactions that can be | No | No |
| | | handled by the Web Server per given unit of time | | |
| | | without a significant degradation in its | | |
| | | performance. May instead be measured with other | | |
| | | measures such as total active threads, kilobytes per | | |
| | | second, etc. | | |
| | Web Server Domain Name | The name of the Web Server's Internet domain as | No | No |
| | | registered as resolved from the IP address. | | |
| | | Example for web: www.ncr. | | |
| | | Text description of the IP address. This can be | | |
| | | accomplished using a DNS (Domain Name Server) | | |
| | | look up and some additional translation. For | | |
| | | example - | | |
| | | 123.34.451.006 (ip address)- | | |
| | | www.someportal.com (text)-Someportal inc (text | | |
| | | description) | | |
| | Web Server Hit Cnt | The number of hits (connections) this Web Server | No | No |
| | | has received. | | |
| | Web Server Id | A classification number for identifying web server | Yes | No |
| | Web Server Name | Name of the web server | No | No |
| | Web Server Port Num | The port utilized by the Web Server. | No | No |
| | | Example: port 80 | | |
| | | Weblog->Webserver_port | | |
| | Web Server Secure Ind | Designates if a Web Server is secure or non-secure. | No | No |
| | | Example: “Yes” - server is in secure mode; “No” - | | |
| | | server is in non-secure mode. | | |
| | Web Server Software Cd | Uniquely identifies the software being utilized by | No | Yes |
| | | the Web Server. | | |
| | Web Server Time Zone Cd | The unique code for a time zone. | No | Yes |
| WEB SERVER ACTIVITY | Web Server Client Delay Tm | The delay between the time the client receives a | No | No |
| | | data frame and requests for the next data frame, | | |
| | | listed in Msec. | | |
| | Web Server Delay Tm | The Web Server delay in handling a http/https | No | No |
| | | request, listed in Msec. | | |
| | Web Server End Dttm | The date and time on which operational metrics for | No | No |
| | | a Web Server ceases to be recorded. | | |
| | Web Server Hits Per Minute Cnt | Number of requests processed by the Web Server | No | No |
| | | in a minute. | | |
| | Web Server Id | A classification number for identifying web server | Yes | Yes |
| | Web Server Network Delay Tm | The delay experienced by the client due to network | No | No |
| | | traffic, listed in Msec. | | |
| | Web Server Non Secure Load Qty | The number of non-secured HTTP requests | No | No |
| | | handled by the Web Server. | | |
| | Web Server Refused Request Qty | Number of requests that could not be handled by | No | No |
| | | the Web Server. | | |
| | Web Server Request Aborted Qty | Number of requests that were cancelled by the Web | No | No |
| | | Server. | | |
| | Web Server Roundtrip Tm | Time between a client request to the instance when | No | No |
| | | the client receives the server response, listed in | | |
| | | Msec. | | |
| | Web Server Secure Load Qty | The number of secured HTTP requests handled by | No | No |
| | | the Web Server. | | |
| | Web Server Start Dttm | The date and time on which operational metrics for | Yes | No |
| | | a Web Server begins to be recorded. | | |
| | Web Server Status Cd | Uniquely identifies a web server status. | No | Yes |
| WEB SERVER SOFTWARE | Web Server Sofiware Cd | Uniquely identifies the software being utilized by | Yes | No |
| | | the Web Server. | | |
| | Web Server Software Name | The name assigned to Web Server Software. | No | No |
| WEB SERVER STATUS | Web Server Status Cat Cd | A unique identifier for the web server status | No | Yes |
| | | category. | | |
| | Web Server Status Cd | Uniquely identifies a web server status. | Yes | No |
| | Web Server Status Desc | Description of the status. | No | No |
| WEB SERVER STATUS | Web Server Status Cat Cd | A unique identifier for the web server status | Yes | No |
| CATEGORY | | category. | | |
| | Web Server Status Cat Desc | A textual description of the status category. | No | No |
| WEB SITE | Electronic Address Id | A number used to uniquely identifty an | No | Yes |
| | | ELECTRONIC ADDRESS. | | |
| | Owner Party Id | The owner of the web site. | No | Yes |
| | Web Site Content Cd | A unique code for a WEB SITE CONTENT TYPE | No | Yes |
| | Web Site Id | A unique identifier for the web site. | Yes | No |
| | Web Site Name | The name of the web site. | No | No |
| | Web Site URI Desc | The Uniform Resource Indicator which is a generic | No | No |
| | | category that includes both URLs (Uniform | | |
| | | Resource Locator) and URN (Uniform Resource | | |
| | | Name). | | |
| | | Example of URI would be: | | |
| | | “http://www.ncr.com” | | |
| WEB SITE CONTENT TYPE | Web Site Content Cd | A unique code for a WEB SITE CONTENT TYPE | Yes | No |
| | Web Site Content Desc | A description of the WEB SITE CONTENT TYPE | No | No |
| WEB SITE NAVIGATION | Nav Level Id | The unique identifier for an instance of the | No | Yes |
| | | NAVIGATION LEVEL entity. | | |
| | Parent Web Site Nav Id | Allows for a multi-level hierarchical structure. | No | Yes |
| | Web Site Nav Desc | Textual description of the single nodes web of the | No | No |
| | | web site hierarchical navigation structure. The | | |
| | | structure may be very similar to the web page | | |
| | | hierarchy of the web site. | | |
| | | Example: “Men's department”, “Men's accessories | | |
| | | category”, etc. | | |
| | Web Site Nav Id | The unique identifier for an instance of the WEB | Yes | No |
| | | SITE NAVIGATION entity. | | |
| WEB SITE SECTION | Web Section Type Cd | A unique code for a SECTION TYPE | No | Yes |
| | Web Site Id | A unique identifier for the web site. | No | Yes |
| | Web Site Section Desc | A description of the WEB SITE SECTION | No | No |
| | Web Site Section Id | A unique identifier for a WEB SITE SECTION | Yes | No |
| WEB SITE SERVER | Web Server Id | A classification number for identifying web server | Yes | Yes |
| | Web Site Id | A unique identifier for the web site. | Yes | Yes |
| WEB STORE | Web Store Id | Uniquely identifies a LOCATION. | Yes | Yes |
| | | Represents a virtual web site offering items or | | |
| | | services for sale. | | |
| WEB TEXT AD | Web Ad Id | The unique identifier for an ad. | Yes | Yes |
| | | An ad made for viewing on a web site. | | |
| WEB VISIT | Authenticated User Desc | The authenticated user ID passed in a request made | No | No |
| | | via HTTP SSL. | | |
| | | If the request was for a password-protected | | |
| | | document then this is the user ID used in the | | |
| | | request. | | |
| | Browser Id | The unique identifier for this specific web browser | No | Yes |
| | | installed on this specific piece of hardware. | | |
| | | Probably a cookie ID. | | |
| | Connect Speed Meas | The throughput of the actual internet connection. | No | No |
| | | Can be an average in the case of a variable speed | | |
| | | connection. | | |
| | | Example: 28.8 Kilobaud; 898 Kilobits/second | | |
| | Connect Speed UOM Cd | Uniquely identifies a unit of measure representing | No | Yes |
| | | the connect speed between the visitor's computer | | |
| | | and the network. See Connect Speed Meas | | |
| | | attribute. | | |
| | | Example: Kilobaud; Megabits per second, etc. | | |
| | IP Address Num | The unique IP Address Number. | No | Yes |
| | Referral Id | A coding method for classifying a REFERRAL. | No | Yes |
| | Screen Colors Num | The maximum number of colors capable of being | No | No |
| | | displayed by the Web Visitor's system, expressed | | |
| | | either in number of colors (16, 16.7 M), or bit size | | |
| | | (8, 24). | | |
| | Screen Resolution Cd | The unique code representing the horizontal and | No | No |
| | | vertical pixel display area of the Web Visitor's | | |
| | | monitor. | | |
| | Visitor Id Method Cd | A unique identifier for the means by which a Party | No | Yes |
| | | is identified for a Web Visit. There are three | | |
| | | possible values: IP address, cookie, and registered. | | |
| | Web Visit Id | Unique identifier for the VISIT. | Yes | Yes |
| WEIGHT BREAK | Weight Break Cd | Uniquely identifies a WEIGHT BREAK. | Yes | No |
| | Weight Break Desc | Narrative text describing the Weight Break. | No | No |
| WORK SHIFT | Work Shift Cd | Uniquely identifies a WORK SHIFT. | Yes | No |
| | Work Shift Desc | Narrative text describing the WORK SHIFT. | No | No |
| WORK SHIFT HOURS | Day Of Week Num | Uniquely identifies the day of the week (1-7) | Yes | Yes |
| | Shift Duration Tm | Indicates the length or duration of a work shift. | No | No |
| | | Note: A shift may in some cases end on the day | | |
| | | following the start time (when the shift spans | | |
| | | midnight) | | |
| | Shift Start Tm | Starting time of a work shift. | No | No |
| | Work Shift Cd | Uniquely identifies a WORK SHIFT. | Yes | Yes |
| WORLD REGION | World Region Cd | A unique number used to identifty a WORLD | Yes | No |
| | | REGION. | | |
| | World Region Name | The name assigned to the world REGION. | No | No |
| YIELD LEVEL | Yield Level Cd | A unique code that identifies the yield level | Yes | No |
| | Yield Level Desc | A textual description of the yield level. | No | No |

What is claimed is:

1. A relational database system for storing and managing information for a hospitality and gaming business; comprising:
a computer-implemented relational database; said information being organized within said relational database in accordance with a logical data model;
a subject area within said logical data model comprising a plurality of entities and relationships defining the manner in which information related to rewards given to casino customers in return for casino gaming activity is stored within said database.

2. The relational database system in accordance with claim 1, wherein said rewards comprise room upgrades, complimentary dinners, and complimentary entertainment.

3. The relational database system in accordance with claim 2, wherein said information related to rewards given to casino customers includes information concerning the issuance and redemption of said rewards.

4. A relational database system for storing and managing information for a hospitality and gaming business; comprising:
a computer-implemented relational database; said information being organized within said relational database in accordance with a logical data model;
a subject area within said logical data model comprising a plurality of entities and relationships defining the manner in which information related to casino player gaming sessions is stored within said database.

5. A method for managing information for a hospitality and gaming business, said method comprising the steps of:
establishing a relational database for storing and organizing said information; and
establishing a logical data model defining the manner in which said information is stored and organized within said relational database, said logical data model including:
a subject area comprising a plurality of entities and relationships defining the manner in which information related to rewards given to casino customers in return for casino gaming activity is stored within said database.

6. The method for managing information for a hospitality and gaming business according to claim 5, wherein said rewards comprise room upgrades, complimentary dinners, and complimentary entertainment.

7. The method for managing information for a hospitality and gaming business according to claim 6, wherein said information related to rewards given to casino customers includes information concerning the issuance and redemption of said rewards.

8. A method for managing information for a hospitality and gaming business, said method comprising the steps of:
establishing a relational database for storing and organizing said information; and
establishing a logical data model defining the manner in which said information is stored and organized within said relational database, said logical data model including:
a subject area comprising a plurality of entities and relationships defining the manner in which information related to casino player gaming sessions is stored within said database.
